(19) United States
(12) Patent Application Publication
(10) Pub. No.: US 2020/0165817 A1
(43) Pub. Date: May 28, 2020

(54) VARIABLE OVERLAPPING FRAMING MEMBER CONSTRUCTION

(71) Applicant: Dennis LeBlang, Desert Hot Springs, CA (US)

(72) Inventor: Dennis LeBlang, Desert Hot Springs, CA (US)

(21) Appl. No.: 16/354,081

(22) Filed: Mar. 14, 2019

Related U.S. Application Data
(63) Continuation-in-part of application No. 16/198,831, filed on Nov. 22, 2018.

(51) Int. Cl. E04B 2/58; F16B 17/00; E04C 3/32

(52) U.S. Cl. CPC E04B 2/58; E04C 3/32; F16B 17/004

(57) ABSTRACT

This application is an accumulation of various patent pending applications showing multiple configurations for connecting metal framing components together where the metal framing members are self-locking connectors that intersect, overlap, between other securing the metal support members together. The connections between the metal framing members uses various types of notches in the support members and notches in the metal framing member to secure metal framing together by using hook fingers, hook tongue, hook receivers, ledges, and tabs to secure the crossing members together forming the self-locking connections. The metal framing components have various longitudinal ends allowing where the longitudinal ends can have the same configuration or different configurations and still be an overlapping interlocking connection.

This application is a continuation-in-part application of application U.S. Ser. No. 13/398,243 filed on Feb. 16, 2012, now abandon and this application claims priority to the following CIP pending applications:

continuous-in-part pending application U.S. Ser. No. 16/198,831 filed Nov. 23, 2018 and continuous-in-part pending application U.S. Ser. No. 16/195,847 filed Nov. 19, 2018 and continuation-in-part pending application U.S. Ser. No. 15/724,137 filed Nov. 3, 2017 and now U.S. Pat. No. 10,442,136 Issued Sep. 24, 2019 that included provisional application U.S. 62/485,114 filed Apr. 13, 2017 (now expired) and provisional application U.S. 62/490,917 filed Apr. 27, 2017 (now expired) and provisional application U.S. 62/533,092 filed Jul. 16, 2017 (now expired) and; continuous-in-part pending application U.S. Ser. No. 15/449,250 filed Mar. 3, 2017 and; provisional application U.S. 62/264,033 filed Dec. 7, 2015 (now expired) and provisional application U.S. 62/274,134 filed Dec. 31, 2015 (now expired) and provisional application U.S. 62/294,756 filed Feb. 12, 2016 (now expired) and provisional application U.S. 62/298,762 filed Feb. 23, 2016 (now expired) and provisional application U.S. 62/308,520 filed Mar. 15, 2016 (now expired) and provisional application U.S. 62/345,153 filed Jun. 3, 2015 (now expired) and provisional application U.S. 62/385,932 filed Sep. 9, 2016 (now expired) and provisional application U.S. 62/399,434 filed Sep. 15, 2016 (now expired) and provisional application U.S. 62/378,615 filed Aug. 23, 2016 (now expired) and continuous-in-part pending U.S. Ser. No. 15/430,781 filed Feb. 13, 2017 that included provisional application U.S. 62/264,033 filed Dec. 7, 2015 (now expired) and provisional application U.S. 62/274,134 filed Dec. 31, 2015 (now expired) and provisional application U.S. 62/294,756 filed Feb. 12, 2016 (now expired) and provisional application U.S. 62/298,762 filed Feb. 23, 2016 (now expired) and provisional application U.S. 62/308,520 filed Mar. 15, 2016 (now expired) and provisional application U.S. 62/345,153 filed Jun. 3, 2015 (now expired) and provisional application U.S. 62/385,932 filed Sep. 9, 2016 (now expired) and provisional application U.S. 62/399,434 filed Sep. 15, 2016 (now expired) and; continuation-in-part pending application U.S. Ser. No. 15/295,172 dated Oct. 17, 2016 now U.S. Pat. No. 10,364,566 Issued Jul. 30, 2019 that included
provisional application U.S. 62/242,705 filed Oct. 16, 2015 (now expired) and provisional application U.S. 62/244,135 filed Oct. 20, 2015 (now expired) and provisional application U.S. 62/264,033 filed Dec. 7, 2015 (now expired) and provisional application U.S. 62/274,134 filed Dec. 15, 2015 (now expired) and provisional application U.S. 62/345,153 filed Jun. 3, 2016 (now expired) and; continuous-in-part of pending application U.S. Ser. No. 15/090,460 filed Apr. 4, 2016 that included provisional application U.S. 62/143,097 filed Apr. 4, 2015 (now expired) and provisional application U.S. 62/208,766 filed Aug. 23, 2015 (now expired) and provisional application U.S. 62/242,705 filed Oct. 16, 2015 (now expired) and; continuous-in-part of pending application U.S. Ser. No. 14/946,378 filed Mar. 3, 2015 and provisional application U.S. 62/083,276 filed Nov. 23, 2014 (now expired) and provisional application U.S. 62/139,913 filed Mar. 30, 2015 (now expired) and provisional application U.S. 62/170,269 filed Jun. 3, 2015 (now expired) and; provisional application U.S. 62/175,191 filed Jun. 12, 2015 (now expired) and; continuous-in-part pending application U.S. Ser. No. 13/398,243 filed Feb. 16, 2012 (now abandon) and;
provisional application U.S. 62/629,522 filed Nov. 22, 2011 (now expired) and provisional application U.S. 62/628,044 filed Oct. 24, 2011 (now expired) and continuous-in-part pending application U.S. Ser. No. 12/456,707 filed Jun. 22, 2009 now U.S. Pat. No. 8,161,699 issued Apr. 24, 2012
the disclosures of the above cited US Patent Applications and US Provisional Applications of the Applicant, including all drawings and all the specifications, are hereby incorporated by reference in their entireties into this US Patent Application.

### SPONSORED RESEARCH OR DEVELOPMENT

Not applicable

### PARTIES OR JOINT RESEARCH

Not applicable

### FIELD OF THE INVENTION

The present invention includes FIGS. 1-516 showing various configurations of metal framing components where the metal framing members use self-locking connectors that intersect, overlap, between other securing the metal support members together. The connections between the metal framing members uses various types of notches in the support members and notches in the metal framing member to secure metal framing together by using hook fingers, hook tongue, hook receivers, ledges, and tabs to secure the crossing members together forming the self-locking connections. The metal framing components have various longitudinal ends allowing where the longitudinal ends can have the same configuration or different configurations and still be an overlapping interlocking connection. The present application begins using FIG. 517 as the first figure discussing metal framing overlapping and then continues showing the various combinations of overlapping the metal framing longitudinal end configurations connecting metal framing together.

### BACKGROUND OF THE INVENTION

Light gauge metal framing have been used in the construction of buildings for many years, however interior and exterior metal framing has always been difficult to assemble as well as construct horizontal and diagonal bracing between support framing members because of the configuration of the support members like a C channel and poor energy efficient shear wall construction. The lip and flange of the C channel protrudes from the web making it difficult to make connections. When bracing members are installed between support members for additional strength, insulation became even more difficult to install as well as form a better insulated wall.

When assembling metal framed walls the vertical support members are not rigid until the bracing members or fasteners are added to help stabilize the support members from moving. In the past there have been attempts to stiffen support members by providing lateral bracing, drywall backing or bracing members between vertical support members.

The bracing members within the wall forming structure are generally required to connect support members together, however horizontal bracing members can be very long and next to impossible to connect horizontal bracing members to individual spacer blocks located between support members. In addition the bracing members are not used to form shear walls or diagonal framing with the walls or have the flexibility to form trusses having diagonally framing members.

Metal framing has developed computer systems to form pre-punched screw holes to designate how and where to install fasteners between metal framing. Different type usings of notches or shapes of bracing members have help speed up framing assembly. There have been no innovation developed allow metal framing to be connected without using fasteners and nothing has been developed where the spacer brace connects support members together using notches and ledges that form a self-lock connectors that fit together to form a fast an easy connection means to form metal framed wall panels without using fasteners at the support members. From the earliest USPTO provisional application filing back in 2011 the unique metal construction connections allow metal framing to be e quickly and easily without using fasteners thereby saving money in labor and material.

The early figures show the development of metal framing leading into the present application that shows the current—changes how metal framing bracing members connect to adjacent metal framing bracing members and changes how metal framing support members can connect to metal framing bracing members. The current application applies the background of the earlier figures into the interlocking technology presented in this application.

### DESCRIPTION OF PRIOR ART & CURRENT PENDING APPLICATIONS

Originally bracing members were placed loosely between metal framing support members with little to no support connection to the metal framing support members as well as the connection between bracing members. Sometime later clips were connected to continuous horizontal bracing channels by fasteners that also required another clip to secure the horizontal bracing channels to the support members with screws. A few attempts have been made to connect bracing members to other bracing members or bracing members to metal framing support members without fasteners.

Previously individual horizontal and diagonal connections between metal support members were used to connect metal framing bracing to metal support members including various interlocking between other bracing member and metal framing supports. Various individual mounting brackets are used to support trusses or horizontally brace support members. Many different shapes of horizontal bracing members are used to connect metal framing members together and include various grooves, tabs, bridging backing, notches to connect the metal framing members together. Some types of connections between support members use bent hooks, bent flanges, clamping tabs, anchoring hand rail system, adjustable braces or extended tabs to connect trusses. Bracing members are shown connecting support members together at corners, provide drywall backing and connect wall panels together. Different types of brackets, shapes, leg supporting connections and blocking are used to install support members together. Slotted holes at the top base plate have been used to compensate for vertical movement between vertical and horizontal support member. There is no prior art for U or W shaped clips with spacer braces to secure support members together. Some support members have been shown to have a rim around the hole for extra strength or to reduce thermal conductivity through the support member, but not used a part of a self-locking connector. Punch out tabs has been used as spacers or as tabs where the tabs have been used to support another object.

Many different types of connections having ledges at the top and bottom edges of the web or at any of the side edges of apertures in the web of the support members and where a crossing members have various types of hook fingers, hook tongues, hook receivers, interlocking notches or tabs from the punch out holes wrap-around the ledges that extend outward from the web of the support members. The wrap-around elements of the connection extend around the ledge and then continuous extending outward from the support member forming a flare shape. The flare shape allows the ledge to be inserted into the wrap-around elements by allowing the wrap-around to be slightly for the ledge to fit into. When the ledge is inserted into a crossing member at the top or bottom of the support member, the flanges have to be cut and notched in the flanges allowing the ledges to interlock into the notches of the spacer braces or crossing members. The ledge can be deep or as little as the thickness of a thread of a screw. The ledge can function as a lip of a spacer brace as a continuous length element equal or greater than the width of a spacer brace or can be small so the ledge is an array of ledge teeth that can penetrate a ledge hole and still form a self-locking connection. The self-locking framing members have many types of connections that wrap-around around the ledge. The metal framing members have many types of receivers and tongues configurations connecting and overlapping the longitudinal ends or intermediate connections of the framing members that and cross intersecting framing members having their receivers, tongues, fingers secure the ledge or notches of the framing members together.

This application relates to forming self-locking fixed or self-locking swivel connections between spacer braces as well as connecting longitudinal spacing-bracing members ends to an adjacent longitudinal spacing-bracing members whether the connection is within the hole opening in the support member or at the top or bottom member of the metal framing. The longitudinal spacing-bracing metal framing or spacer braces can be installed individually between support members or in multiple locations using the lip notches of the longitudinal spacing-bracing members. The spacer braces can have different configuration like double lip flanges with notches at the end of the lips or the notch installed through both lips. Other additional configurations showing bent webs, bent flanges and bent lips to form curved longitudinal spacing-bracing members. The configuration shapes of the spacer brace where the flanges and lips are bent at angles, but still conform to the reverse lip shape of the spacer brace. Another alternate shape is having the web of the space brace conform to the shape of the bottom edge of the hole having a notched-tab and the web of the spacer brace having a notched-tab allowing the side head of the web space brace to be installed in the notched-tab of the hole bottom edge. The various configurations of spacer braces can also be describe as having a curvilinear shape or undulating shape or multiplane planes forming a continuous shape. When the spacer brace has bends in the web, flanges and lips forming multi-plane connector such as a W-shape or M-shape configuration. The notched-tab can also be installed in the support member allowing the notched-tab to be installed through slot holes at the flanges or web to secure the spacer brace to the support members which is ideal for fabricating metal framing in a horizontal position then installed vertically. The bottom hole edge, side hole edge and the top hole edge has to be slightly smaller than the required dimension of the hole edge, especially since the structural calculations are based on a certain size hole for its structural capabilities. When installing metal framing the spacer brace can be installed diagonally between the horizontal spacer braces by using notched-tab receivers that can be installed in the lip notches or the horizontal spacing-bracing member and/or into the slot holes of the flanges of another spacing-bracing member. The spacer braces can also be installed as headers above doors or window where the header snaps into the cripple without using fasteners. Different variations of the shapes of the connecting members as well as the location and shape of the notches, ledges, tabs and notched-tabs are used between the members at the holes, punch-outs or indentations all determine the self-locking connections.

Other earlier patent applications have stated that the invention relates to forming self-locking connections between intersecting metal framing members having ledges at the top and bottom edges of the web or at any of the side edges of the holes in the web of the support members and where a crossing member has hooked fingers, hooked receivers or tabs from the punch out holes wrap-around the ledges that extend outward from the web of the support members. The wrap-around elements of the connection extend around the ledge and then continuous extending outward from the support member forming a flare shape. The flare shape allows the ledge to be inserted into the wrap-around elements by allowing the wrap-around to be slightly for the ledge to fit into. When the ledge is inserted into a crossing member at the top or bottom of the support member, the flanges have to be cut and notched in the flanges allowing the ledges to interlock into the notches of the spacer braces or crossing members. The ledge can be deep or as little as the thickness of a thread of a screw. The ledge can be a continuous length equal or greater than the width of a spacer brace or can be small so the ledge is an array of ledge teeth that can penetrate a ledge hole and still form a self-locking connection. The self-locking connection is formed when the wrap-around elements are wrapped around the ledge. The hooked receiver, hooked finger, W-shape & U-shape clips also form the wrap-around elements that secure the ledge.

### SUMMARY OF THE CURRENT INVENTION

This patent application shows multiple combinations of spacing-bracing members overlapping other spacing-bracing members between metal framing supports having similar longitudinal end configurations relative to size, shape, length and orientation for each longitudinal end configuration. The various spacing-bracing members overlapping other spacing-bracing members also vary by having the different longitudinal end configurations relative to size, shape, length and orientation for each longitudinal end configuration as well as the various combination connections between spacing-bracing members. For example a reverse lip spacer brace having lip notches can have a U shaper spacer brace at the opposing end allowing the smaller or larger spacer brace overlapping the opposing end of the adjacent spacer brace. The U shaped spacer brace with notches can be connected to the support member while the opposing end of an adjacent spacer brace would have a hook tongue extending into the receiver hole of the connector. The spacing-bracing members show various connecting combinations at the spacing-bracing members reflecting similar configuration connections, but applied differently while still having similar connection results for connecting spacing-bracing members to metal framing supports. The spacing-bracing members can be connected: at the top and bottom longitudinal ends of metal framing supports; between the apertures of the metal framing supports, between spacing-bracing members, between spacing-bracing members having pivotal ends; by notches in apertures in spacing-bracing members; by notches in metal farming supports; by brackets long or short. The apertures have many different combinations of aperture notches, so the spacer braces can be connected to the apertures using different configurations of the aperture notches. The notches can just be hole notches where the notches from the spacer braces engage into or the notches can be entire aperture hole notches, where the entire spacer brace fits into the aperture or hole protrusions and the spacer brace engages the aperture side edges, bottom edge or top edge of the aperture or at the hole protrusions. The spacing-bracing members can overlap adjacent spacing-bracing member by forming a checker-board pattern with the smaller width spacer-bracing members installed first between metal framing support members where the larger width spacing-bracing members overlap the narrower width bracing-bracing member between the metal framing supports. When the spacer brace configuration is reversed that is the U shape is facing upward, the larger space is installed first with the smaller width spacer brer overlapping the larger width spacer brace. In addition spacing-bracing members are connected by the chain reaction of larger width spacing-bracing longitudinal ends of one spacing-bracing member overlaps the adjoining spacing-bracing member having the Domino Effect of connecting spacing-bracing members to adjacent spacing-bracing members as well as the added effect of flange notches 126f installed in flanges 302b of the U shaped spacer brace 302 or the lip notches 126p or lip flange notches 126pf of reverse lip spacer braces 301 connecting the webs 42a of adjacent metal framing support members.

The first 516 figures were included in this application to eliminate any possible gaps that can occur between the FIRST TO FILE versus THE FIRST TO INVENT. To clarify this invention the first 516 figures were not published to minimalize copycats. Inventions are not easy to separate into the various USPTO categories and require additional applications to obtain specific independent and dependent claims. There are presently short Summary's, Figures and Specifications, however the specific Claims are shown in their respective applications. All the previous patent applications are lumped together in this application, so the short summaries can be intertwined between the various segments. Each section has a short description on the nature of that specific pending application.

The current patent application are shown starting at FIG. 517-FIG. 611. The patent application combines many different longitudinal overlapping end configurations that are joined together in this application making disclosures easier to interface between earlier figures.

Short Summary of FIG. 1-FIG. 93.

The horizontal spacing-bracing members are shown as U shape, V shape and a reverse lip bracing channels that span between metal framing supports. The longitudinal edges of the flanges, legs or lips have notches that extend into the side edges of metal framing supports. The side edges of the notches secure the horizontal bracing member into the metal framing support. The same shape spacing-bracing member are also shown as brackets being individual or overlapping adjacent spacing-bracing members or used as a coupling connecting two ends of two adjacent spacing-bracing members together or used to provide additional reinforcement for lateral movement between spacing-bracing members and the metal framing supports. A smaller or larger spacing-bracing member can fit over or under another spacing-bracing member providing the additional reinforcing or connection capability to other spacing-bracing members. The array of lip notches provides means to add additional metal framing supports within the same bracing-spacing member. The various sizes and shape of the support channels, horizontal bracing channels, holes in the web of the support channels and base plates all alter the shape of the spacer blocks and the shape of the horizontal bracing channels. The metal framing components can be install upside down by changing the orientation of the metal framing within the hole as well as changing the shape, width, size and angles of the holes in the support channels, horizontal bracing channels also change the shape of the spacer blocks and the type of material used to form the spacer blocks. The upward oriented spacing-bracing members occur when the flanges extend upward from the web allowing mechanical wiring can be installed in the trough between flanges. The horizontal bracing channels with the spacer blocks can be oriented face up or face down.

Short Summary of FIG. 94-FIG. 151

This section has interlocking spacing-bracing members connected to metal framing support members installed horizontally, vertically or diagonally between support members. The U shaped spacer brace or reverse lip spacer brace are shown connected to wood or metal framing supports having a web with flanges or side edges and where the flanges abut the framing member and where the web extends across the framing members. The connection at the metal framing supports the flanges abut the web with the web extending through the hole and bent across the opposing side of the web. The wood framing spacing-bracing member have the flanges abut the framing support member with the web crossing the framing support and bent on the opposing side of the support member. The spacing-bracing members can be installed with a vertically or horizontal oriented web and installed horizontally, diagonally or vertically across the support members. The spacing-bracing members for wood support member use teeth extending from the spacing-bracing members that extend into the wood support members. On the other hand the spacing-bracing members for metal support members have cut outs at the longitudinal ends at the hook fingers that extend through and around the holes securing the spacing-bracing member laterally to the metal framing supports. Multiple spacing-bracing members can be installed within the same hole and smaller spacing-bracing members can be inserted into larger width spacing-bracing members allowing the smaller spacing-bracing member to slide within the larger spacing-bracing. The flanges can be angular and correspond to angular holes side edges and the longitudinal flanges can have lips corresponding to the reverse lip spacer brace. The spacing-bracing members can be used as hold-down support at the longitudinal ends of the framing supports where the hook fingers wrap around the framing supports.

Short Summary of FIG. 152-FIG. 231.

The hook finger configuration at the longitudinal ends of the spacing-bracing member in—earlier figures are shown in these figures as a hook tongue at one end of the longitudinal spacing-bracing member and a hook receiver at the opposing longitudinal end. When the two adjacent spacing-bracing members are installed in tandem the longitudinal end having the hook tongue is inserted into the hook receiver of the longitudinal end of the adjacent spacing-bracing member. Additional intermediate framing members (not shown) can be installed between the longitudinal ends using some of the same notches.

The spacing-bracing members can connect vertical or horizontal support members together individually, diagonally and or in tandem between adjacent spacing-bracing members. The spacer braces can have a variety of shapes, U-shape, C-shape, J-shape or I-shape and can be connected to the support members in many different ways. The longitudinal ends of the spacing-bracing member having the hook tongue or the hook receiver longitudinal end at both longitudinal ends and the hook tongue ends can be connected to U-shaped clips or W-shaped clips that can be installed over or through the support members. The U or W shaped clips can also be oriented vertically, horizontally, through the hole, over the flange, over the web, under the web, connected to the ledge or not connecting the ledge of the support member. A spacer brace can be connected to the support member in tandem or as individual spacer braces so that six different spacer braces can interested adjacent to one another allow the structural capacity of the spacer braces to transfer their load capacity the same way horizontal and diagonal structural members of a bridge span together to form one unified structure.

The hook tongue are indented at the web and then extended parallel or bent perpendicular to the dorsal to the opposite side of the web in the support member either at the flange or at the hole in the web of the support member or into an engagement means of for connecting adjacent spacer braces. The hook tongue are typically perpendicular to the extension of the web for maximum strength, but can be at an angle to connect to diagonally oriented spacer braces and can have abrasive means on the ventral side for a tight fit.

Different Add-on spacer brackets are shown having the same U-shape as other spacer braces in order to have all the spacer braces interlock with each other. In addition, W and U shaped clips are shown as having hook receiver on one or both ends for the hook tongue of the spacer braces can fit into. The clips can be used in place of the U shaped hook receiver of the spacer brace. The clips can fit vertically or horizontally: in the holes of the support members; over or under the web of the support members; over the flanges of support members being wood or metal or individual or multiple spacer brace connections; between adjacent webs of support members; into triangle shape holes and still have two spacer braces connect to the clip.

Short Summary of FIG. 253-FIG. 282.

This group of figures uses ledges, punch out tabs and notches to secure spacing-bracing members to metal framing supports. U shaped clips or W shaped clips also use ledges, punch out tabs and notches to connect spacing-bracing members to the clips and the clips to the metal framing supports. The punch out tabs are used as a support means when the punch out tabs engages the web of the metal framing support. The punch out tabs are used as an engagement means when a hook tongue engages a hook receiver at a spacing-bracing member or at the various clips that are shown. The punch out tabs are used to form a receiver when the tab extends from the metal framing component desiring the receiver attachment allowing the hook tongue to engage into the punch out receivers. The punch out tabs from a receiver engage a punch out tab from a hook tongue will keep the tongue end engaged in the receiver from being pulled out of the receiver. The punch out tabs are a means to prevent a spacing-bracing member from an opposing movement when the two connecting metal framing components intersect each other. The punch out tabs when engaging a ledge from a support member allows another metal framing element like a look finger be the opposing end attachment means so prevent the punch out tab engagement with the ledge from moving in either direction of the engagement. The punch out tabs can engage the web of a metal framing support and where the web when bent forms at ledge and where the punch out tabs from one metal engages the web ledge of the metal framing support. The web ledge when intersecting another metal component can have notches in the flanges of the U shape spacing-bracing member to engage into the notches of the flanges. The flange notches can also have a crossing notch or ledge notch for the ledges from the web of the support member can engage into. Notches can also be installed at the longitudinal ends of flanges so the ledges extending for holes in the metal framing supports can engage the notches in the flanges and where the hook finger from the spacing-bracing member can extend through the hole to the opposing side of the web in the metal framing member. Many of the interlocking connections can be used as spaced apart connections and where the spaced connections can connected metal framing supports together and where the connects allow the spacing-bracing members to be connected together in tandem.

Short Summary of FIG. 283-FIG. 360.

This group of figures relates to forming self-locking fixed or self-locking sliding connections between spacer braces and support members without using fasteners to connect the two crossing metal framing members. Various shapes or configurations of spacer braces intersect the support members at the top or bottom of the support member and through the holes in the webs. The holes can have rims or ledges that extend from the side edges of holes to form ledge shafts or tabs. The tab ends can be bent to form bent tabs or notches can be installed in the tab to form notched-tabs. The notches, ledges, tabs and notched-tabs can be used to form many variations of self-locking connections between spacer braces intersecting support members as well as between the tongue ends and receiver ends of various shaped spacer braces. The spacer braces have various shapes along with bulges that have notches in the bulges or notches in the web, slide gaps, lips or holes to secure the spacer braces and support member together without having fasteners to secure the member together. The vertical or horizontal direction of the notches and the longitudinal direction of the spacer braces crisscross one another to form self-locking screw-less connections between framing members.

Spacing-bracing members connecting metal framing supports can be connected together in various ways. For example the hole in the metal framing supports can have the hole bottom edge formed as individual tabs and where the extended tabs are long enough to be inserted into a flange of a spacing-bracing member having slot holes for the extended tabs to fit into. If the extended tabs are very long, the extended tabs can be bent manually after the spacing-bracing member is installed into the hole or the end of the extended tabs can have a manufactured bent edge so the manufactured bent edge will automatically extend over the slot hole in the web of the spacing-bracing member. If the extended tabs are shorter they are less likely to bend so by installing notches at the sides edges of the extended tabs and the end of the tab or tab heads have a wider width and the tab heads will extend over the spacing-bracing member at the slot hole and the side edge notches. On the other hand, if the spacing-bracing member has a C shape with lips and the lips had lip notches, the extend tab from the hole bottom edge could engage the lip notches of the C shape spacing-bracing member. The hole side edges at the holes in the metal framing can have the web of spacing-bracing member engage under the notch with the flanges straddling the hole to stabilize the spacing-bracing members within the hole. Another alternative solution is to have the lips from reverse lip spacer braces having lip notches extend into the hole notches and the lip with the lip notch will keep the spacing-bracing member from moving vertically while the lip notches will keep the spacing bracing member from moving horizontally or any of the previously described clips extend into the web notches or hole notches. The ledges extending from the hole side edges can also be notched for securing spacing-bracing members.

The shape of the spacing-bracing member can vary causing the location and shape of the hole notch or web notch to have a different shape. For example the spacing-bracing member can have bulges at the flanges, at the web and flanges, at the lip and flanges and where the bulges can be solid or be notched meaning the intersecting edge will be notched or only a support for the notch. The hole notch does not have to be a horizontal notch, but a notch that is formed when the upper portion of the hole extends over the lower portion of the hole therefore forming a notch ledge where a spacing-bracing member can engage the notch ledge. In addition when spacing-bracing members are used for diagonal framing as shown in this application, the diagonal spacing-bracing member, the metal framing supports and floor mounted spacing-bracing members require modifications and additional pending applications.

Short Summary of FIG. 361-FIG. 401.

This group of figures is directed towards connecting support members to a longitudinal spacing-bracing framing member when passing through the hole of the support members individually or in tandem as well as at the top and bottom of the support members to the longitudinal spacing-bracing members. The wall configurations can be arched vertically or horizontally to have a serpentine curved wall configuration by having web and flange extension that interlock to the longitudinal end of adjacent spacer braces.

The spacing-bracing members are shown having a longitudinal channel shape spacing-bracing member with lips and lip notches. One longitudinal end has a hook tongue at the web end with the extension being bent to form the tongue end and while the opposing end has a hole receiver in the web near the opposing longitudinal end. When the spacing-bracing members are installed in tandem, the hook tongue from one spacing bracing-member is installed in the hole receiver of the adjacent bracing-spacing member and the lip notches in the lips engage the hole side edges of the metal framing support. The hook tongue and hole receivers are shown in various configurations and shown connected at the hole, top end and bottom end of the metal framing support, giving more flexibility on how the spacing-bracing member are connected. The lips can be double lips where the bend between the two lips can have the lip notch or the longitudinal edge can have the lip notch. The spacing-bracing member can have a break or cut in the web and flanges allowing the lip to bend vertically for various spacing-bracing sections to have a vertical movement or horizontally depending on the orientation of the spacing-bracing member. On the other hand a flange on one side of the spacing-bracing member can also be cut along with the adjacent lip and web in order for the spacing-bracing member to rotate in an opposing direction.

The various tongue arrangement at the web of the spacing-bracing member will rotate the spacing-bracing member horizontally or vertically when the hook tongue is located at the flange along with the corresponding receiver hole at the opposing end. Again by changing the hook tongue or receiver hole location the rotation between spacing-bracing member will change. The shape of the spacing-bracing member can vary where: no lips with notches are required; the flanges can be bent having opposite directional orientations; the flange have flange notches engaging the hole bottom edge; the flange with flange notches engage the bottom edge of the protrusion; the longitudinal flange engage the notch in the bottom of the protrusion; the longitudinal flange having the array of flange notches engaging the protrusion notches. In addition the protrusions can have protrusion notches at the side edges for alternative connection possibilities. The web of the spacing-bracing member can have a notch where the notch is a continuous notch where the longitudinal shape of the notch is a continuous longitudinal shape having a narrow opening that becomes wider when extending above the web of the longitudinal spacing-bracing member and continues so the opposing side of the notch is a mirror image of the continuous longitudinal shape notch shown on the opposing side. In addition, previous describe bulge notches shown in “781” are used here at the hole side edges.

Additional FIG's are shown use different configurations for the diagonal framing connections. The longitudinal continuous notch shown in one FIG. also shows the continuous notch used as part of the spacing-bracing member used as a header over a window or door opening. The continuous notch header shows the flanges being angular and where the angular flanges have slot holes so that an intersecting hole extension coming from the hole bottom edge of metal framing support the hole extension having a notched tab end (a wider head having a notch at the neck) can extend into the slot holes therefore the hole extension is shown having two notched tab ends that extend into the slot holes of each flange. Also the beam header is shown as a reverse lip spacing-bracing member where the lip with lip notches extend into the wide gaps of the metal framing support for the lip notches to engage the web notches in the web of the metal framing support. The window or door header is shown having another spacing-bracing member install in the same window header thereby increasing the strength.

Short Summary of FIG. 402-FIG. 442.

This group of figures also has notches, tabs, punch out tabs however these items can be used in many different applications creating different pending patent applications. The notches at the end of flanges can connect to ledges at the hole bottom edges, ledges formed at the web for the spacing-bracing member of a reverse lip spacer braces to fit into the web gaps of metal framing supports. In this application the web gaps are located in the both flanges of the reverse lip spacer brace and where the web notch engages the lip notches of the reverse lip spacer brace. The web notches are now claimed as well as the double or single flange gaps with notches to secure adjacent trusses where the truss has at least one lip or a reverse lip spacer brace as a chord of the truss or used when connecting metal framing supports when ledges have been used at the hole bottom edge. The lips at the chords are shown as having single lips, however the lips can be longer having an L-shape or having a C-shape (3 bends to form the lip).

The punch out tabs that have been explained in previous application are shown again in this application as well as when the punch out tab at the web of a U shaped channel crosses over the longitudinal ends of the metal framing support a longer punch out tab extends against one side plane of the web while the U shaped channel having groove or notches in the flanges secures the metal framing support horizontally while allowing the metal framing support to move vertically due to the variable live load applied against the horizontal U shaped channel. Previously shown in other application are bulge notches where here the bulge is shown in the flange of a U shaped channel, however the bulge is extending inward toward the web forming a notch when viewing from the external side of the U shaped channel. When an outward continuous bulge is installed on the exterior side and a bulge notch is formed along that notch, then the outer edges of the bulges has as a guide to confine the metal framing support member between that extending bulge. In addition the hook tongue explained in an earlier application is shown where the tongue portion extends into the receiver hole is shown having the ledge extended externally and where the receiver hole overlaps the extending over a bent ledge.

Short Summary of FIG. 443-FIG. 471.

This group of figures shows two adjacent spacer braces that span between support member that can have the same configuration or different configurations. Sometimes the configurations like the U shaped spacer brace or the reverse lip spacer brace can appear similar, however when intersecting each other at the hole in the support member the size of the components such as the web, flanges and lips will vary in width and length in order for the spacer braces to fit together. In previous patent applications hole notches, double lips and double notches have been used to connect the spacer braces to the holes at the support members. The notches in the spacer braces are shown to be only lip notches or lip flange notches. The longitudinal ends have the same end configurations or are different so as to overlap one another at the end configurations of the spacer brace. For example a notched tab end fits over or under an adjoining spacer brace having only lip notches: or a notched tab end connects to an adjoining spacer brace have a finger end with a tab: or a spacer brace having a finger end connected to an adjoining spacer brace having lip notches; or a spacer brace having lip notches and a receiver slot hole connected to an adjoining spacer brace having a hook tongue tor connection to the receiver slot hole; or the spacer braces can be reversed with the lips having lip notches engaging the notched tab extension, or the notched tab extension is inserted between the smaller sized hole attached to the larger sized hole, or the hook tongue can be oriented upwards for a supporting plate can secure two intersecting spacer braces; or flange notches secured at the hole bottom edge can be connected to the hooked tongue extending into the receiver slot hole; or protruding hole side edges having notches can secure a spacer brace with or without lips to the support member when the adjacent spacer brace has a hook tongue extending into the receiver slot hole; or hook fingers being extended into hole notches where the longitudinal ends of the flanges or longitudinal ends of the lips secure the hook finger of the spacer brace with the adjoining spacer brace being connected by a hook tongue extending into the receiver slot hole; or two adjoining spacer braces having a continuous web flange inserted into the hole bottom edge allowing one spacer brace to fit over an adjoining spacer brace either by altering the dimension of the upper and lower configurations or by having the hole bottom edge extend further into and through the upper spacer brace; or by adding web extensions at both ends where one end has a receiver hole and the opposing end has a hook tongue with an obstruction end to restrict vertical movement. The same configurations of overlapping a hook finger into a receiver slot hole can also be incorporated into full width spacer braces having the width equal the width of the support member. When the hole side edges have different orientations or angular sides the spacer brace configuration can be different as each flange can have a web-flange notch in each flange where the web-flange notch extends into the hole side edges and when the hole side edges have hole notches the spacer brace will also not have any horizontal and vertical movement. The layering of two adjoining spacer braces by overlapping the end configurations and installing hole notches at the sides or at the protrusions will eliminate the horizontal and vertical movement between spacer braces and the support members

I submitted additional patent applications where other types of notches have been developed and the shape and orientation of the longitudinal spacing-bracing members has varied as well as the size and shape of the hole. The lip notches engaging the hole side edges, notches in the web and side walls creates the understanding of connecting support members together without using fasteners and sets the pattern to expand the technology into additional patent applications.

The description of the drawings and the description via the claims sound different, but the FIG's appear the same. At the end of the figure description is a figure table of contents noting the embodiments to a number. After that figure table of contents is a claim glossary of terms relating to the figure numbers. Since the spacer brace can be used in so many different configurations and orientations, but are installed the same, the interlocking connections need to be claimed in a different manner.

Short Summary of the brackets & short spacing-bracing members as horizontal bracing members shown in FIG. 472-FIG. 516.

The brackets are shown overlapping U shaped channels where the brackets can overlap the configuration of the channels or also referred to later as spacing-bracing members or spacer braces. The shorter width reverse lip spacer braces is shown installed with the flanges extending upward and the lips extend into the side edge of the key hole. A smaller width spacing-bracing member can be duplicated to form spacing-bracing members. A wider width lip notch or lip flange notch can be incorporated into a spacing-bracing member where plates can be installed for additional strength or the extra width notch can be cut in the field to allow for that additional brace at the hole in the metal framing support. The FIG's have shown notches in the lips, notches in the flanges and notches partially incorporated with the lip and partially incorporated into the webs. In FIGS. 513-516 show the notch incorporated partially into the web extending through the flanges and lips while FIGS. 385, 452 and other figures show no flanges and lips just the notch at the web. The bracket configurations are meant to be incorporated into spacing-bracing members as an integral part of the spacing-bracing member. Since the bracket configurations typically are large and overlap the hole at the metal framing support member, the bracket is indented at the longitudinal ends. The longitudinal spacing-bracing member will have two bracket configurations that will support the spacing-bracing member between the metal framing supports. The width of the bracket will be wider so one spacing-bracing member can overlap the opposing smaller spacing-bracing member. The bracket shaped spacing-bracing member can be installed face up or face down (the flanges extending upward or flanges extend downward from the inside face of the web which is a component of the longitudinal spacing-bracing member. The notching configuration between the two longitudinal ends of the spacing-bracing member can be reproduced at intermediate interval locations so additional spacing-bracing members can be installed at metal framing supports. Some brackets are shown having additional punch outs that engage another spacing-bracing member and where those punch outs need intermediate interval slot holes for the punch outs to fit into.

The various bracing members have different configurations, orientation, location of the notches on the bracing members and some bracing members will cause the shape of the holes to change and how support members are secured and fit together. The various one, multi-plane or two piece interlocking brackets can be installed independently as part of the building structure or within spacer blocks to form an insulated or sound deadening building component. The bracing members pass between the holes in the web of the support members and brackets fit into, over and under bracing members become secured to the bracing and support members with notches, friction or fasteners that interlocks them together. Various combinations of notches in the bracing members and brackets can occur at: the lip of a reverse lip channel; at the corners of the web and the flanges of a U shaped channel: at the vertex of a V shaped bracing members; at the edges of a vertical plate for a bracket; at the flanges of a U shaped bracket and having a continuous slot at the top side or bottom side; at a bracket angle where the notches engage the lip of the support member and the bracket continues to wrap the lips and flanges of the support member; at a bracket that abuts the web of the support member, extends past the hole and forms an angle for a vertical plate to fit between the support member and the vertical plate forming a notch; at the sides of V shaped brackets fitting into V shaped bracing members; at the legs of the V shaped brackets for a vertical plate can engage the hole and installed at the web of support member; at multi-plane brackets where one side connects to bracing member, second side engages the lips and flanges of support member, and the third side having a notch engaging the lips of the support member. The notches in the bracing members and brackets can be reversed changing the shape of the support members, holes and the shape of the spacer blocks. The bracing members can be continuous with or without notches so the brackets can be installed in, over, under bracing members to be aligned with the adjacent hole in support members. The vertical oriented notches installed in the side edges of the hole can interlock into the horizontal oriented notches of brackets interlocking the two components together. Holes in a horizontal bracing member can aligned with the extend tabs of the punch out tabs to also interlock brackets and horizontal bracing channels together. The horizontal bracing channel or spacer brace spanning between two support members can have a C shape with the lips facing upward so extending tabs from punch out tabs can extend under the lips to eliminate screws between the bracket and the horizontal bracing channel or spacer brace.

The bracing members can be installed at an angle between the holes in the web of the support members. The bracing members may be installed with brackets that have angled notches so a one or two piece bracket can be installed to the bracing member or just secured to the support member. On the other hand the bracing member may have notches that are angled to engage the hole in the support member.

The brackets can be installed over a bracing members that is U shaped with the U facing down. The bracket has a notch at the hole in the web of the support member and/or at the lips of the support member. The bracket can have bent sides forming an angle securing the web or flanges of the support member.

The bracket configurations and connections to the holes in the support member have the same configuration as spacer bars, except spacer bars span between support members and connect to the holes within the support members. Each spacer bar has an extended end and a blunt end. The extended ends can connect to the blunt end or the hole in the support member and the blunt end can abut a flat plate, web of a support member or have a connection for the extended end to fit into. The spacer bars can just be twisted into place at the holes or screwed together between spacer bars.

A flat plate is used as part of the one and two piece bracket as well as a connector between elongated bracket members. The flat plate is usually installed as a vertical element in the various bracket members to give added strength to the connection in both the vertical and horizontal structural load capacity between the bracket members, flat plate and the support members. The flat plate can also be used as a shim that eliminates any gap that could occur by not having a tight fit between notches or other locations as shown in the various drawing figures. The flat plate can also be hammered into place by having a tab perpendicular to the flat plate. In addition, the flat plate can also have teeth that engage and extend on both sides edges of a hole in the support member to secure the brackets or bracing members to the support member. The teeth of the vertical plate engage both sides of the top of the hole and either the vertical plates moves to slide into the notches below in a bracket or bracing member or the bracket moves until the vertical plate vertical against the support member. The same method can also be used when the bracket is installed within the bracing member when used at an angle.

### A BRIEF DESCRIPTION OF THE DRAWINGS

A BRIEF DESCRIPTION OF THE DRAWINGS shown in FIGS. 1-93 discloses insulation blocks between metal support framing having longitudinal spacing-bracing members connecting the insulation blocks and metal support framing together are shown having several types of spacer braces, more specifically the reverse lip space brace having lip notches

FIG. 1 shows an isometric view of the structural insulating wall where the spacer blocks are wider than the support channels with a horizontal bracing channel or more specifically a longitudinal spacing-bracing member have a groove in the lip fitting into a trough of the foam spacers connecting to the support channels together along with the base plate connections to the foam spacers and support channels. The inner and outer boards form a thermal break gap, i.e. air space between the elements. The support channel shows an indentation in the web and the foam spacers have a vertical projection.

FIG. 2 shows a wall section of the longitudinal spacing-bracing member shown as a horizontal reverse lip channel connecting a hole in the support channel where the hole is below the horizontal reverse lip channel.

FIG. 3 shows the wall section of FIG. 2 with the trough below the horizontal reverse lip channel forming an electric/mechanical chase in a half wall.

FIG. 4 shows a wall section of the horizontal reverse lip channel upside down and the hole in the support channel is above the horizontal reverse lip channel.

FIG. 5 shows a wall section of FIG. 4 with the horizontal reverse lip channel upside down and the trough is above the horizontal reverse lip channel.

FIG. 6 shows an isometric view of the wall system using a face down horizontal reverse lip channel and the trough is above the horizontal reverse lip channel.

FIG. 7 is a plan view of FIG. 6.

FIG. 8 is a plan view of the reverse lip channel used as a support channel.

FIG. 9 is an isometric view of a half wall using the foam spacers with an exposed trough.

FIG. 10 is a plan view of FIG. 9.

FIG. 11 is an isometric view of an enlargement of structural insulating wall with the inner and outer boards shown in FIG. 1

FIG. 12 show an isometric view of a horizontal bracing channels as a round rod or a tube passing through the round hole in the support channel.

FIG. 13 shows an isometric view of a U channel as the support channel with the horizontal U channel as the horizontal bracing channel.

FIG. 14 shows an isometric view of a hat channel as the support channel with a rectilinear hole and a horizontal U channel.

FIG. 15 shows an isometric view of a reverse lip channel as the support channel, a rectilinear hole with a ledge around a portion of the hole with a horizontal U channel passing through the hole.

FIG. 16 shows an isometric view of a C channel with an oval hole and the horizontal U channel.

FIG. 17 shows and isometric view of the horizontal reverse lip channel with notches in the structural insulating wall.

FIG. 18 shows an isometric view of a support channel with a rectilinear hole and the horizontal reverse lip channel with notches.

FIG. 19 is an isometric view of a C channel as the support channel with a V hole with the V pointing downward and a blunt end at the vertex of the V hole.

FIG. 20 shows the isometric view of FIG. 19 of the C channel with a horizontal V channel having a V-leg notches in the bottom received in the C channel.

FIG. 21 is an isometric view of a C channel as the support channel with a V hole and the V pointing downward.

FIG. 22 shows the support channel of FIG. 21 with a horizontal V channel with leg notches at the edges engaging the hole in the support channel.

FIG. 23 is an isometric view of a C channel as the support channel with a V hole and the V pointing downward.

FIG. 24 shows the support channel of FIG. 23 with a longitudinal spacing-bracing member with corner notches in the web received in the blunt end.

FIG. 25 shows a wall section of the horizontal V channel pointing upwards and the trough is above the horizontal V channel.

FIG. 26 shows a wall section where the horizontal V channel is pointing downward and the trough is below and the horizontal tongue of the foam spacers requiring an extension.

FIG. 27 shows a wall section where the horizontal V channel is pointing downward.

FIG. 28 shows the wall section with on V hole and the V is pointing downward.

FIG. 29 is a wall section showing the horizontal V channel is wider and has a notch requiring an extension of the horizontal tongue, while another section shows the horizontal V channel within the size of the V hole and lastly where the horizontal V channel is bent with notches.

FIG. 30 show the same horizontal V channels however the V is pointing downward.

FIG. 31 shows a wall section with the horizontal U channel facing downward.

FIG. 32 shows a plan view of the wall section in FIG. 31.

FIG. 33 shows a corner connection of two wall panels and the coupling between them connects the two wall panels together.

FIG. 34 shows a plan view the foam spacer is formed from different material and the support channel has an indentation in the web.

FIG. 35 shows the plan view separated by the C channel and the two foam spacers.

FIG. 36 shows an isometric view of a C channel with an indentation in the web having a partially tapered hole pointing downward to a blunt end at the vertex.

FIG. 37 show the C channel of FIG. 36 with a horizontal reverse lip channel received in the C channel with the lip notches engaging the C channel.

FIG. 38 shows a plan view of FIG. 37 showing the lip notches and flares at the lips engaging the V hole.

FIG. 39 shows an enlargement of the support channel with an indentation and the vertical projection of the spacer block fitting into the indentation and the gap between the inner and outer walls.

FIG. 40 shows a perspective view of the spacer block intersecting the C channel and horizontal bracing channel forming a gap.

FIG. 41 shows a wall section of FIG. 40 where the horizontal tongue fits into the trough.

FIG. 42 shows a perspective view of the spacer block intersecting the C channel and the horizontal reverse lip channel.

FIG. 43 shows a wall section of FIG. 42 where the horizontal tongue fits between the flanges of the horizontal reverse lip channel and the trough is below the horizontal bracing channel.

FIG. 44 is an isometric view where one side of the structural insulating core has projections overlapping the flange on one side and the opposite flange having no projections.

FIG. 45 is a plan view of FIG. 44.

FIG. 46 is a plan view of FIG. 47.

FIG. 47 is an isometric view of the of the reverse lip support channel as a support channel where the projection of the foam spacer overlaps one flange and not the other flange.

FIG. 48 is an isometric view of a hat support channel as the support channel with both sides of the foam spacer overlaps the sloped flange and a short horizontal U channel connecting the foam spacers.

FIG. 49 is an isometric view of a U channel as a support channel and a horizontal U channel as a bracing channel and where the groove side of the foam spacer overlaps the flange and extends beyond the flange onto the adjacent foam spacer and the other side does not overlap the flange.

FIG. 50 is a plan view of FIG. 49.

FIG. 51 is a plan view of FIG. 48

FIG. 52 is an isometric view similar to FIG. 49, except here the tongue shape of the foam spacer also has the projection of the foam spacer with the extension that rests on the adjacent foam spacer and the opposite of the foam spacer has no overlap.

FIG. 53 is an isometric view similar to FIG. 52 except both sides of the foam spacers have projections and extensions over the U channel and the round hole is used for a round rod to connect two foam spacers together.

FIG. 54 shows an isometric of two foam spacers stacked above each other shows the vertical project, troughs and the vertical hole in the short foam spacer.

FIG. 55 is similar to FIG. 54 except one side of the foam spacer has a projection and the other side does not.

FIG. 56 shows an isometric of the structural insulated core where an electric chase with a cover on top of the lower horizontal reverse lip channel.

FIG. 57 shows an enlargement of a reverse lip channel with lip notches stacked inverted to another reverse lip channel with lip notches engaging the support member for the electric chase passing through the rectangular hole.

FIG. 58 shows an isometric view of the horizontal U channel turned downward having notches with the foam spacer having the tongue fitting into the horizontal bracing channel.

FIG. 59 shows a wall section with the horizontal U channel facing downward into the horizontal tongue with the inner and outer boards.

FIG. 60 shows a similar wall section as FIG. 59 except the overlapping projections of the foam spacer at the flanges.

FIG. 61 shows a floor section of the foam spacer similar to FIG. 10.

FIG. 62 shows a similar floor section to FIG. 61 with an extension added to the projection of the foam spacer.

FIG. 63 shows the floor section sliding together with the support channels.

FIG. 64 shows the structural insulating core wall with horizontal bracing channels and longitudinal spacing-bracing members with grooves.

FIG. 65 is an isometric view of horizontal beam, column and another wall forming structure interlocking between each other as well as the horizontal bracing channel in the middle of the spacer insulation.

FIG. 66 shows a building elevation with various wall panels including concrete beam and wall molds configurations with intermediate spacer channels between the column molds, corner L shaped column molds at the corners of the wall forming structure.

FIG. 67 shows the tongue and groove assembly at the structural insulation core.

FIG. 68 shows a plan view with the tongue and groove assembly using the reverse lip channel at the structural insulating core.

FIG. 69 show a plan view with the tongue and groove assembly using the C channel at the structural insulating core.

FIG. 70 shows an isometric view of a thinner tongue and groove foam spacer with a C channel wall structure.

FIG. 71 shows the base plate at the floor with grooves in the flanges connecting to the support channels.

FIG. 72 is a plan view showing the thinner tongue and groove foam spacer using a C channel as the structure component of the wall.

FIG. 73 shows an isometric view of precast wall mold when the concrete is poured over the structural insulating core.

FIG. 74 shows and enlarged view of the column and beam in the precast wall when the concrete is poured face up.

FIG. 75 shows a wall section with the structural insulating core and the ICF mold forming a concrete beam.

FIG. 76 shows a wall section with the structural insulating core and a larger ICF mold forming a wide concrete beam.

FIG. 77 shows a wall section with the structural insulating core and an extended ICF block mold forming a wide concrete beam.

FIG. 78 shows a plan view of an ICF mold between two structural insulating cores forming a concrete column.

FIG. 79 shows a plan view of an ICF mold between two structural insulating cores forming a concrete column.

FIG. 80 is an isometric view of the reverse lip channel with a pair of notches including flares at each lip for engaging a least two support channels.

FIG. 81 is an isometric view of a C channel in FIGS. 1,6, & 9 with the horizontal reverse lip channel of FIG. 8 in the C channel, the notches of the horizontal reverse lip channel engaging the side edges of the hole in the web of the C channel.

FIG. 82 shows a cross section through the longitudinal spacing-bracing member at the rib impressions.

FIG. 83 shows a cross section through the longitudinal spacing-bracing member at the recessed grooves.

FIG. 84 is an isometric view of a U channel coupling inserted in the open channel of two horizontal reverse lip channels.

FIG. 85 is an isometric view of a U channel coupling where two horizontal reverse lip channels are inserted into the open channel of the coupling between the flanges and web of the U channel coupling.

FIG. 86 shows a one piece multi-plane bracket having a bottom side, two vertical sides with notches at the horizontal lips engaging the hole of the support member install between the webs of a bracing member being U shaped with the web of the bracket fasten to the bracing member.

FIG. 87 is the same as FIG. 86 except the one piece multi-plane bracket shown as a reverse lip shape with notches at the lips is installed in the hole of the support channels first and the bracing member being U shaped facing upwards is installed between the flanges of the bracket.

FIG. 88 is the same FIG. 112.

FIG. 89 is an enlargement of FIG. 88 and showing the reverse lip channel 156.

FIG. 90 shows a narrow width hole where the lips notches 126p and the flange notches 126fg extend into the hole side edges along with a coupling or smaller width horizontal spacing-bracing member also having notches connecting two adjacent reverse lip spacer channels.

FIG. 91 shows a smaller width reverse lip spacer channel having the lip notches and flange notches used as a coupling, bracket and or from a cut off reverse lip spacer brace. The drawing is larger so the grooves are more noticeable.

FIG. 92 shows the longitudinal reverse lip channel showing the lips with the lip notches extending into the top and bottom edges of the hole, but still referred as the holes side edges.

FIG. 93 shows a wider hole that shows a wider web of the longitudinal spacing-bracing channel. On the other hand another longitudinal spacing-bracing channel shows a wider web and wider lips so the lip notches can fit into the hole top edge and the hole bottom edge as the reverse lip channel has its lip resting on the hole side edges.

BRIEF DESCRIPTION OF THE DRAWINGS in FIGS. 94-151 showing various types of horizontal spacing-bracing members connected between metal support framing, but typically emphasizing the U shape spacer brace installed in wood framing and metal support framing for walls and trusses. The horizontal spacing-bracing members are shown as floor anchor bolt framing, horizontal metal framing and brackets spanning between holes of metal support framing as well as wood framing connections having teeth, notches.

FIG. 94 is an elevation showing the nine clouds formations where each cloud represents a different spacer brace application: individual spacer braces, spacer braces connecting to adjacent spacer braces, diagonal spacer braces, offset diagonal spacer braces, opposite pointing diagonal spacer braces, X framing spacer brace, truss head, floor trusses and a solid fire stop spacer braces.

FIG. 95 shows a downward oriented U shaped spacer brace connecting the holes of adjacent spacer braces.

FIG. 96 shows a downward oriented U shaped spacer brace with alternative spacer brace shapes including ridges in the dorsal and hook finger shapes, lips at the ends of the flanges and double thick flange.

FIG. 97 shows a downward oriented U shaped spacer brace with U shaped finger ends.

FIG. 98 shows U-shaped spacer brace in a horizontal position with its downward oriented flanges having the jagged edges and the hook fingers having abrasive protrusions on its inside surface.

FIG. 99 shows a U-shaped spacer brace in a horizontal position with its flanges oriented upward with bent flaps engaging one surface of the support member and the downward oriented hook finger engaging the opposite side of the support member.

FIGS. 100A. 100B & 100C shows the steps required in order to install six spacer braces intersecting a one hole in the support member.

FIG. 101 shows an enlargement of the six spacer braces intersecting in one hole however the horizontal spacer brace is shown as a continuous horizontal bracing channel for clarification and a reverse lip brace with notches in the lips are secured to the sides of the hole and the reverse lip brace has angles notches for the top sides of the diagonal spacer braces could be installed in the angled notches.

FIG. 102 shows how the spacer braces are oriented horizontally but are installed diagonally between support members where the hook fingers extend through the holes of adjacent support members.

FIG. 103 shows the spacer braces installed diagonally with the hook tongues overlapping each other at the web of the support member.

FIG. 104 shows the horizontal, diagonal spacer braces installed together to form a truss joist.

FIG. 105 shows a truss joist using metal framing where the top cord has a horizontal web and the bottom chord having a vertical web connected by spacer braces.

FIG. 106 shows the same configuration as FIG. 101 except two spacer braces are used in lieu of only one.

FIG. 107 shows eleven different space brace configurations each oriented differently on the vertical support member with some spacer braces passing through triangular or square shaped holes and others passing over the flanges of the support member.

FIG. 108-110 show three different spacer brace configurations passing through the triangular shaped hole shown in FIG. 107.

FIG. 111 shows three wood horizontal joists or the bottom chord of the truss joist where the spacer braces connect the horizontally oriented support members together either horizontally at the top or bottom edges or as a diagonal between support members.

FIG. 112 shows three horizontally oriented metal support members being connected at the top, bottom or through the holes of the support members as well as being connected diagonally.

FIG. 113 shows a cross section or a wood truss joist having spacer braces connecting the top and bottom chords of the truss joist and the spacer braces used as horizontal or diagonal lateral bracing between truss joists.

FIG. 114 shows a similar cross section of a truss joist as FIG. 113 however the horizontal support members are vertical oriented metal members with the spacer braces being the vertical or diagonal chords or the lateral bracing between the truss joists.

FIG. 115 shows the U-shaped spacer brace in a vertical position with jagged edges at the ends of the flanges and punched teeth extending from the web into the support member.

FIG. 116 shows both a wood and C channel as the support member with one diagonal spacer brace being attached by fasteners and other spacer brace with its jagged edges at the flanges and punched teeth extending from the web into the support member along with a horizontally oriented spacer brace passing through the hole of the support member.

FIG. 117 shows a truss joist where the horizontal support members are wood with one spacer brace oriented vertically and the other diagonally both having jagged edges at the flanges and the punched teeth extending into the support members.

FIG. 118 shows a similar configuration as FIG. 117 except the wood support members are oriented vertically and the diagonal spacer brace is bent so the hook finger is perpendicular to the support member.

FIG. 119 shows the spacer brace as a beam connecting between support members with cripple type support member defining the window or door opening.

FIG. 120 shows an enlargement of the punched hole teeth at the extension and the jagged edges at the flange ends.

FIG. 121 shows the beam with jagged edges at the end of the finger and the double flange.

FIG. 122 shows an enlargement of FIG. 121 at the connection of the framing member.

FIG. 123 shows the end of the finger as a U-shape being connected to the lip of the support member when being used as a beam.

FIG. 124 shows an enlargement of the connection at the support member.

FIG. 125 shows the spacer brace as a beam for C channels using U-shape or L-shapes at the ends of the fingers supporting the beam.

FIG. 126 shows an enlargement of the connection in FIG. 125.

FIG. 127 shows an isometric view of two vertically oriented spacer braces installed on opposite sides of the same hole in a vertical oriented support member.

FIG. 128 shows an enlarged view of each end of the spacer brace when intersecting holes as shown in FIG. 127.

FIG. 129 shows an isometric view of a spacer brace at the intersection of an outside corner using wood support members.

FIG. 130 shows an isometric view of spacer braces connecting wood support members at an outside corner.

FIG. 131 shows an isometric view of a spacer brace at the intersection of an outside corner using metal support members.

FIG. 132 shows an isometric view of spacer braces connection metal support members at an outside corner where the end of the spacer braces have a tongue side and a receiver side for connecting spacer braces in tandem.

FIG. 133 shows an isometric view of an outside corner having a vertically oriented spacer brace located on the outer edges connecting the wood support members from two intersecting wall panel sections.

FIG. 134 shows the same isometric view as FIG. 129, however a diagonal spacer brace is installed on the outside side edges of the wood support members where the spacer brace has its dorsal oriented vertically and the ventral flanges are full depth.

FIG. 135 shows the same isometric view as FIG. 129 except the spacer brace has an L-shaped hook finger connecting the lip of an adjacent wall panel and a C-shaped hook finger attaching the lip of different oriented metal framing members of another wall panel.

FIG. 136 shows the same isometric view as FIG. 131, however a diagonal spacer brace is installed on the outside side edges of the metal support member where the spacer brace has its dorsal oriented vertically and the ventral flanges are full depth.

FIG. 137 shows an isometric view of a spacer brace that is shown in FIG. 128, however the spacer brace has a U-shape channel where the dorsal fits into the ventral side of a C-shape channel that is slightly larger for the smaller U-shape channel to fit into. One end of the spacer brace has a finger and the oppose end has a U-shape hook that fits around an adjacent wall panel.

FIG. 138 shows an isometric view of the telescoping spacer brace fitting together as shown in FIG. 133.

FIG. 139 shows an isometric view of a partial wall using wood support members with a spacer brace connecting three wood support members with notched flanges and the ends having fingers that wrapped around the side of the wood support members. Another spacer brace below is the same as above except the web of the spacer brace is oriented horizontally and the hook fingers are connected between the wood support members.

FIG. 140-142 shows an isometric, section and plan view of a spacer brace and the hold-down connecting adjacent metal support members at the floor.

FIG. 143-145 shows an isometric, section and plan view of a spacer brace and the hold-down connecting adjacent wood support members at the floor.

FIG. 146 shows an isometric view of a one piece hold-down spacer brace-bracket between metal framing with the hook finger connecting the opposite side of the support member.

FIG. 147 shows an isometric view of a one piece hold-down spacer brace-bracket between wood framing with the hook finger connecting the opposite side of the support member.

FIG. 148 shows an isometric view of a one piece hold-down spacer brace-bracket between metal framing without the hook finger.

FIG. 149 shows an isometric view of a one piece hold-down spacer brace-bracket between wood framing without the hook finger.

FIG. 150 shows a fold out profile of a one piece hold-down spacer brace-bracket shown in FIGS. 146 & 147.

FIG. 151 shows a fold out profile of a one piece hold-down spacer brace-bracket shown in FIGS. 148 & 149.

A BRIEF DESCRIPTION OF THE DRAWINGS in FIGS. 152-231 showing typically a U shape horizontal spacing-bracing member having a hook receiver for a hook tongue to fit into. A double hook receiver on each side of the metal or wood framing member enables the longitudinal ends with hook tongue to engage the hook receivers. Other variations of hook tongue and hook receivers are incorporated into this application.

FIG. 152 is an elevation showing the nine clouds formations where each cloud represents a different horizontal or vertical orientations of the spacer braces, clips or bracket applications and some clouds having many different application connections: individual spacer braces, spacer braces connecting to adjacent spacer braces, diagonal spacer braces, offset diagonal spacer braces, opposite pointing diagonal spacer braces, X framing spacer brace, truss head, U & W clips, spacer braces connecting to clips, floor trusses and a solid fire stop spacer braces between the support members of a framed wall for a building.

FIG. 153 shows a downward oriented U shaped spacer brace with alternative spacer brace shapes including ridges in the dorsal and hook tongue shapes, lips at the ends of the flanges where one on has either a hook finger or hook tongue end and the opposite end has a hook receiver end.

FIG. 154 shows eleven different space brace configurations each oriented differently on the vertical support member with some spacer braces passing through triangular or square shaped holes and others passing over the flanges of the support member.

FIG. 155 shows a horizontally oriented downward facing spacer brace with a U shaped hook receiver passing through the hole of the support member for a spacer brace with a downward L-shaped hook tongue to fit into.

FIG. 156 shows a vertically oriented spacer brace with it U-shaped hook receiver extending over the flange of vertical support members for a spacer brace with its L-shaped hook tongue to fit into.

FIG. 157 shows an isometric view of two horizontally oriented spacer braces connected at the hole in the web of the metal framed support members where the spacer braces are shown in tandem.

FIG. 158 shown an isometric view of a horizontal oriented I shaped space brace passing between the holes in the metal framing connecting in tandem to each other.

FIG. 159 shows a horizontally oriented web of the J shaped spacer brace being connected in tandem.

FIG. 160 shows the spacer brace having a downward oriented U shape hook receiver side and an upward oriented hook tongue side for a spacer brace used at a floor.

FIG. 161 shows the spacer brace being mounted at the floor between two support members where one end has a hook receiver end and the opposing end is a hook finger at the starter end.

FIG. 162 shows a spacer brace with a finger end and a receiver end at the top of a support member.

FIG. 163 shows a two piece spacer brace assembly at the floor where one end has a hook finger and the opposing end has a hook receiver end with a separate hold-down installed in the ventral side of the spacer brace.

FIG. 164 shows an add-on hook clip with a U-shape profile being attached to a U shaped channel.

FIG. 165 shows an add-on hook clip having only its end attached to horizontal bracing channel.

FIG. 166 shows an add-on hook clip having a downward oriented third side of the hook clip.

FIG. 167 shows the W-shaped clip having a hook receiver on both sides of the bottom edge of the web of a support member.

FIG. 168 shows the U-shaped clip having only one hook receiver side and the opposite end secured to the web at a hole or the top end of the support member at the web.

FIG. 169 shows the W-shaped clip having hook receivers on both sides of the hole or top edge of the support member at the web.

FIG. 170 shows a horizontally oriented U-shaped clip having a hook receiver on one side with an anchor space over two support members and a hook finger over the opposing end.

FIG. 171 shows a vertically oriented W-shaped clip having the web anchored to the vertical face of the support member with hook receivers at each end with a hook tongue of an adjacent spacer brace being connected.

FIG. 172 shows an vertically oriented add-on hook receiver clip having the anchor space extended over the flange of a support member connected onto the cut-off end of the horizontally installed with a vertically oriented web of the adjacent spacer brace with the adjacent spacer brace having the hook tongue cut from the web and flanges of the adjacent spacer brace.

FIG. 173 shows the vertically oriented add-on hook receiver clip as shown in FIG. 172 but with having flanges that extend the add-on hook receiver clip away from the face of the support member.

FIG. 174 shows a J-shaped spacer brace having both end having hook tongues with a hook clip having both upward oriented U-shaped hook ends on each side with the throat passing firming through the hole of the support member.

FIG. 175 shows the I-shaped spacer braces having both ends having hook tongues that extend longer than the width of the I-shaped spacer braces with a hook clip having both upward oriented U-shaped hook ends on each side with the throat passing firming through the hole of the support member

FIG. 176 shows a plan view of the hook clip having the U-shape hook ends extending outward on both sides of the flange or wood support member and shown with the hook tongues of the spacer braces being installed into the U-shaped hook ends.

FIG. 177 shows an elevation of six spacer braces installed over the flange or wood support member by a long hook clip.

FIG. 178 shows a side elevation of a support member having triangular shaped holes where a combined J-shaped and reverse lip shape for a hook clip that has its lips with notches engage the diagonally oriented side band of the triangular hole and the opposite oriented sides have U-shaped hook ends engaging the web of the support member and the angular band of the triangular shaped hole.

FIG. 179 shows a close up view of the triangular hole with the hook clip described in FIG. 178.

FIG. 180 shows a plan view of the support member with the hook clip installed in the triangular hole as shown in FIGS. 178 & 179.

FIG. 181-183 show three different spacer brace configurations passing through the triangular shaped hole shown in FIG. 154.

FIG. 184 shows an elevation of the support member at the web with its triangular shaped hole having a J-shaped spacer brace where the web and the upward oriented flange have notches engaging the angular band at the hole in the support member and the downward oriented flange having a notch at its lower edge that engages another edge of the triangular hole.

FIG. 185 shows a plan view of the L-shaped spacer brace passing through the triangular hole as shown in FIG. 184.

FIG. 186 shows an isometric of the L-shaped spacer brace passing through the triangular shaped hole as described in FIGS. 184-185.

FIG. 187 shows an elevation of the triangular shaped hole with a hook clip having a combination J-shaped at the throat and the U-shape hook receiver on both sides of the web of the support member.

FIG. 188 shows a section through the triangular shaped hole with the notches shown on the upper and lower flanges and web.

FIG. 189 shows a plan view of the hook clip showing the location of the notches engaging the angular band of the hole in the support member.

FIG. 190 shows the same section as FIG. 188, however two spacer braces with the tongue sides are about ready to be installed into the hook clip described in FIGS. 36-38.

FIG. 191 shows a photograph of the web side of a vertical support member having a triangular shape hole with a W-shape clip with the hook receiver extending over the hole.

FIG. 192 shows a photograph of the interior side of the vertical support member showing the lips and flanges with a triangular shape hole with its projecting rims at the web with a W-shape clip with it flanges and the hook receiver extending over the rim of the hole.

FIG. 193 shows a schematic view of a construction assembly using spacer braces spanning between two support members having the anchor space between the hook finger end and the flanges engage the support member.

FIG. 194 shows an schematic view of a construction assembly using spacer braces spanning between two support members have a hook finger on the left end with a hook receiver end on the right side end.

FIG. 195 shows an schematic view of a construction assembly using spacer braces spanning between two support members have a hook finger on the left end with a hook receiver end on the right side end.

FIG. 196 shows an schematic view of a construction assembly using spacer braces spanning between two support members having the anchor space of a W-clip engage the support member with the hook receiver on the right side end engaging the hooked tongue of the spacer brace with a hook receiver end on the right side end.

FIG. 197 shows an schematic view of a construction assembly using spacer braces spanning between two support members having the anchor space of a W-shaped clip engage the support member with the hook receiver on the right side end engaging the hooked tongue of the spacer brace with a hook tongue end on the right side end engaging the hook receiver of on the left side of the W-clip with its anchor space engaging the support member.

FIG. 198 shows an schematic view of a construction assembly using spacer braces spanning between two support members having the anchor space of a U-shaped clip engage the support member with the hook receiver on the right side end engaging the hooked tongue of the spacer brace on the left side end with a hook tongue on the right side end engaging the hook receiver side of the U-shaped clip where the anchor space between the hook finger and hook receiver engage the right support member.

FIG. 199 shows an schematic view of a construction assembly using spacer braces spanning between two support members having the anchor space of a U-clip engage the support member with the hook receiver on the right side end engaging the hooked tongue of the spacer brace with the spacer brace extension passing over the support member where the anchor spacer is between the flanges and the hook receiver extending over the right side of the support member.

FIG. 200 shows an schematic view of a construction assembly using spacer braces spanning between two support members having the anchor space of a U-shaped clip engage the support member with the hook receiver on the right side end engaging the hooked tongue of the spacer brace and the right side of the spacer brace has a hook tongue that engages the left side of a hook receiver or a W-clip where the anchor space engages the support member.

FIG. 201 shows a schematic view of a construction assembly using the middle spacer brace having a hook tongue at each end and connected to adjacent spacer braces where the hook receivers extends over the support member on both the left and right sides and the side edges of the flanges on the first and third spacer braces engage the opposite sides of the web of the support members.

FIG. 202 shows a schematic view of a construction assembly using two adjoining spacer braces where each spacer brace has a hook tongue end on one side and a hooked receiver on the opposite end and connected to the support members having the ends of the flanges abut one side of the web and the interior side of the hook receiver abut the opposite side of the web being connected by the anchor space of the extension at the web.

FIG. 203 shows a schematic view of a construction assembly using combination of spacer braces spanning over two support members where the left side is connected to the hook receiver of a U-shaped clip and the right side is has the ends of the flanges abut the one side of the web and the interior side of the hook receiver abuts the opposite side of the hook receiver end.

FIG. 204 shows a schematic view of one of many possible combinations of a spacer brace assembly where a truss joist is formed using horizontal and diagonal spaces braces between support members.

FIG. 205 shows an isometric view of a W-shaped clip having dimples protrude from the first and third legs of the hooked receiver.

FIG. 206 shows an isometric view of a W-shaped clip have rounded edges at the web of the W-shaped clip and the second leg of the hooked receiver.

FIG. 207 shows a similar view of a W-shaped clip in FIG. 206 except here are flared end at the third legs of the hooked receiver.

FIG. 208 shows a similar view of a W-shaped clip in FIG. 207 except here the third leg of the hooked receiver has an indentation compressing the first and third legs closer together.

FIG. 209 shows a similar view of a W-shape clip in FIG. 208 except here the first leg of both hooked receiver have an indentation compressing the both first legs closer together.

FIG. 210 shows an isometric view of the W-shaped clip in FIG. 205 without the dimples however here horizontal ridges form an abrasive planar surface connection.

FIG. 211 shows an isometric view of an I shaped spacer brace having horizontal ridges in the hook receiver end and the adjacent I shaped spacer brace having horizontal ridges in the hook tongue along with punch out teeth extending from the web.

FIG. 212 shows an isometric view of horizontal oriented support member having triangular holes showing a U shaped spacer brace connected to a W-shaped clip along with a vertically oriented spacer brace having the tab of the punch out holes secured to the ledge of the triangular shaped hole and a U shaped spacer brace having the hooked tongue inserted into the slotted hole in the web and another U shaped spacer brace connected to the lip of a horizontal C channel.

FIG. 213 shows three wood horizontal joists or the bottom chord of the truss joist in FIG. 229 where the top edge of the support member show the U-shaped hook receiver with the L-shaped hook tongue attached as well as an angular oriented spacer brace.

FIG. 214 shows three metal support members with the top edge of the support member showing the U-shaped hook tongue with the L-shaped hook tongue attached into the U-shape hook receiver. Two spacer braces are downward oriented and the left spacer brace is upward oriented, however the L-shape hook tongue of the upward oriented spacer brace fits into the U-shaped hook receiver of the downward oriented spacer brace.

FIG. 215 shows a U-shaped spacer brace where the flanges extend upward from the web and the exterior side is bent downward at the bottom edge of the hole with a receiver have a U-shape for a tongue to fit into.

FIG. 216 shows a U-shaped spacer brace where the flanges extend downward from the web and the extension on the interior side extends downward forming a receiver being U-shaped for a tongue having the flanges turned inward forming a flap for the receiver.

FIG. 217 shows two U-shaped spacer braces where the lower U-shaped spacer brace has the flanges oriented downward while the upper U-shaped spacer brace has the exterior side fitting above the lower U-shaped spacer brace for a tongue to fit into the slot hole of the lower spacer brace.

FIG. 218 shows an upward oriented U-shaped spacer brace having the exterior side at the bottom edge of the support member hole with an upward receiver for the tongue having two flaps bent inward to fit into the receiver.

FIG. 219 shows a C-shaped spacer brace having the flanges bent inward on the interior side of the spacer brace.

FIG. 220 shows a vertically oriented spacer brace with the lips extending outward having a tough extending into the slot of an adjoining spacer brace.

FIG. 221 shows the vertically oriented C-shaped spacer brace where the flaps are flanges turned inward and abut the lip.

FIG. 222 shows the vertically oriented U-shaped spacer brace having a double flange and where the outer portion of the double flange extends past the web for the tongue to fit between the flaps and the web.

FIG. 223 shows the U-shaped spacer brace extending over the support member with a finger wrapped around the hole and having punched out hooks where a tongue is installed into and flaps connecting the support member.

FIG. 224 shows the tongue and flap as one piece extending from the tongue.

FIG. 225 shows the receiver having flaps at the sides extending outward forming a gap for a tongue to fit into with the extension fitting over the bottom edge of the hole.

FIG. 226 shows the same configuration as FIG. 225 however the extension is fitting over the flange of a support member.

FIG. 227 shows the U-shaped spacer brace with the U-shape hook receiver at one end and an adjacent spacer brace with its L-shape hook tongue extending into the U-shape hook tongue.

FIG. 228 shows a section through the spacer brace at the U shaped hook receiver and the L-shape hook tongue intersecting.

FIG. 229 shows a truss joist where the horizontal support members are wood with one spacer brace oriented vertically and the other diagonally both having jagged edges at the flanges and the punched teeth extending into the support members.

FIG. 230 shows a similar configuration as FIG. 229 except the wood support members are oriented vertically and the diagonal spacer brace has the U-shaped hook receiver with the adjacent spacer brace having an L-shaped hook tongue for connection.

FIG. 231 shows a similar configuration as FIG. 229 except metal framing is used and two spacer braces are used in the bottom chord.

A BRIEF DESCRIPTION OF THE in FIGS. 232-282 shows how a side projection or ledge extends from a hole in the metal framing supports and punch-out tabs can create an interlocking framing connection between the metal framing support and the spacing-bracing member.

FIG. 232 is an elevation showing the nine clouds formations where each cloud represents a different configuration means for securing crossing members together by using either ledges, notches and punch-out tabs between the support members to form different self-locking framing connections between metal framed wall components for a building.

FIG. 233 shows an isometric view of the W-shaped clip wrapped around the flange of the support member being secured by the lip and a slot hole in the web and the ledges at the top end and bottom end of the support member as well as at the hole.

FIG. 234 shows an isometric view of the W-shaped clip in a horizontal orientation having a hook receiver on both sides of the W-clip with the tabs extended from the punch out tabs.

FIG. 235 shows a cross section view of the U-shaped clip installed at the a hole in a support member having a ledge on the bottom edge and overhangs the right side of the web.

FIG. 236 shows a cross section view of the W-shaped clip installed at the hole in a support member having a ledge on the bottom edge with the hook receivers on both sides and where one side has a hook tongue of U shaped spacer brace positioned to be installed in the hook receiver.

FIG. 237 shows a cross section of a spacer brace having the hook receiver end installed over the ledge extending on the right side of the web and the opposed end of an adjacent spacer brace having a hook tongue end positioned to be installed into the hook receiver end with each end having punched out tabs that interlock between each other and the tab of the punch out tab on the first leg of the hook receiver engage the underside of the ledge at the hole.

FIG. 238 shows a cross section of a U-shaped clip installed over the web of the support member ledge at the top end of a support member being secured by the punch out tab under the ledge.

FIG. 239 shows a cross section of a W-shaped clip installed over the web of the support member with the tab of the punch out tab engaging the ledge and a hook receiver end with its punch out tabs shown adjacent to the hook tongue of an adjacent spacer brace along with its punch out tabs ready to be locked together with the tabs in the hook receiver.

FIG. 240 shows a similar cross section as FIG. 237 however the ledge is facing the opposite direction.

FIG. 241 shows a similar cross section as FIG. 238 however the ledge is facing the opposite direction and the U-shaped clip is resting on the web of the support member.

FIG. 242 shows a W-shaped clip installed in the ledge gap with the tab securing the ledge and the hook tongue of the adjacent spacer brace ready to be installed against the protruding tabs of the punched out tabs of the hook receiver.

FIG. 243 shows a W-clip installed over the bottom and top ledges of the hole in the support member and four diagonal spacer braces having the hook tongue ends installed into the hook receiver ends of the W-clips.

FIG. 244 shows a diagonal spacer brace with the hook receiver end passing through the hole over the ledge and an adjacent diagonal spacer brace with its hook tongue end connecting to the hook receiver end of the adjacent spacer brace along with another diagonal spacer brace with the hook receiver end passing through the hole over the ledge and an adjacent diagonal spacer brace with its hook tongue end connecting to the hook receiver end of the adjacent spacer brace.

FIG. 245 shows an I-shaped spacer brace with the hook receiver end passing through the hole onto the ledge at the bottom edge of the hole in the support member with the ledge extending away from the hook receiver end with the tab of the punch out tab extending under the ledge and engaging the bottom edge of the ledge.

FIG. 246 shows a plan view of a W-shaped clip installed over the flange of a C channel having hook tongues installed into the hook receivers on both sides of the W-shape clip.

FIG. 247 shows a plan view of a U-shaped clip installed over the flanged of a C channel having one side hook over the lip of the support member and the opposite side having a bent hook extend into the hole in the web of the support member with a hook tongue end of a spacer brace.

FIG. 248 shows an isometric view of a U-shaped clip spanning over the end of two support member connected at the web and ledges and the tabs of the punch out tabs in the U-shaped clip.

FIG. 249 shows an isometric view of a W-shaped clip at the base of the support member connected by the ledge and the tabs of the punch out holes along with the hook tongue of the spacer brace connecting to the hook receiver ends of the W-shaped clip.

FIG. 250 shows an isometric view of an intermediate connection of a U shaped spacer brace passing through the hole of the support member having the tabs of the punch out holes connect to the ledge along with notches in the flanges connecting the ledge and web of the support member.

FIG. 251 shows a cross section of FIG. 250.

FIG. 252 shows a plan view of FIG. 250.

FIG. 253 shows an isometric view of an intermediate connection of a U shaped spacer brace passing through the hole of the support member having the tabs of the punch out holes connect to the ledge along with the flanges having notches in the flanges of the spacer brace for the web of the support member to brace too.

FIG. 254 shows a cross section of FIG. 253.

FIG. 255 shows a plan view of FIG. 253.

FIG. 256 shows an isometric view of an intermediate connection of a U shaped spacer brace passing through the hole of the support member having the tab of the spacer brace secured under the ledge of the support member.

FIG. 257 shows a cross section of FIG. 256.

FIG. 258 shows a plan view of FIG. 256.

FIG. 259 shows an isometric view of an intermediate connection of a U shaped spacer brace passing under the web of the support member having the tab of the spacer brace secured over the ledge of the support member.

FIG. 260 shows a cross section of FIG. 259.

FIG. 261 shows a plan view of FIG. 259.

FIG. 262 shows an isometric view of an intermediate connection of a U shaped spacer brace passing through the hole of the support member having two tabs within the same punch out hole with one tab engaging the ledge and the opposing tab engaging the back side along with the flanges having notches in the flanges of the spacer brace for the web of the support member to brace too.

FIG. 263 shows a cross section of FIG. 262.

FIG. 264 shows a plan view of FIG. 262.

FIG. 265 shows the ledge at the top, bottom and on the side edges of the hole in the web of the support member.

FIG. 266 shows the ledge being inserted into the ledge gap of the flanges of the U shaped spacer brace as well as the tab of the punched out holes in the web.

FIG. 266 shows and enlargement of the ledge being inserted into the notch gap of the flanges.

FIG. 267 is similar to FIG. 266 however the gap is inserted into the flanges only half way into the depth of the flanges.

FIG. 268 shows an isometric view of the U shaped spacer brace passing through the hole of the support member having the bottom edge as a ledge engaging the U shaped spacer brace at the notch gap in the flanges.

FIG. 269 is an isometric view of an enlargement of FIG. 268 where the notch and notch gap are shown in the flange of the U shaped spacer brace having the dorsal side facing upward with the flanges extending downward from the web.

FIG. 270 shows an isometric view of a U shaped spacer brace with the receiver end having a receiver of three legs pass over a ledge and the flanges with the notch and notch gap forming another receiver end for the ledge to be inserted into.

FIG. 271 shows an array of floor joists except a spacer brace at the bottom left corner shows the ledge of the floor joist intersect the notch gap of the spacer brace.

FIG. 272 is an enlargement where the U shaped spacer brace passing through the hole of the support member having the bottom edge as a ledge engaging the U shaped spacer brace.

FIG. 273 shows an isometric view of a U shaped spacer brace being installed on the vertical side edges shown as a ledge at the holes in the support members and where the U shaped spacer braces on installed on both vertical side edges of the hole of a support member.

FIG. 274 is an enlargement at the intersection of the ledge in the support member and the notch gap in the flange of the spacer brace.

FIG. 275 shows an intermediate support member having a ledge at the bottom edge being inserted into the notch gap of the flanges and the tab from the punch out holes wraps-around the ledge at the end of the support member.

FIG. 276 shows the same profile as FIG. 274, however the support members are oriented horizontally as a floor joist and the U shaped spacer brace is oriented vertically as a ledger or sometimes referred to as a rim joist.

FIG. 277 is an enlargement of FIG. 276.

FIG. 278 shows the spacer brace facing downward passing through the hole of an intermediate support member with the flanges engaging the a ledge at mid-height together with the wrap-around tab from the punched out tab self-locking into the ledge.

FIG. 279 shows the end of a downward facing spacer brace passing through the hole of a support member where the flanges engage the ledge at mid-height having a notch on the flange to rest on and the receiver end passing over around and under the ledge so the first leg of the receiver can extend outward again in front of the ledge before bending again to form the second leg.

FIG. 280 is similar to FIG. 234, however only one punched out tab is shown and used as a support under the ledge.

FIG. 281 is an irregular shape hole having a continuous rim extending around the hole edges leaving a narrow edge in the corner where the W-Clip could be inserted into the rim of the hole if the rim had a notch or the W-clip was bent to create a notch to form a secure connection.

FIG. 282 shows a U shaped spacer brace extending through the hole in FIG. 281 where the bottom edge of the rim penetrates the first leg of the hook receiver.

BRIEF DESCRIPTION OF THE DRAWINGS in FIGS. 283-360 shows how the spacer braces with and without lips or lips with notches connects to metal framing supports as a fixed or sliding connections when installed at the bottom, middle or top of the metal framing supports.

FIG. 283 shows an isometric view of four support members having various configurations and crossing members all having various self-locking connections using support tabs, notched-tabs and openings with notches. The support tabs can be ledge tabs, hole tabs, web tabs, L-shaped tabs, hook receiver tabs, key tabs, punch-out tabs, wrap-around tabs, notched-tabs or bent tabs that can be installed in holes, slot holes, hole notches, lip notches, flanges slot holes, web slot holes, raised slot holes, receiver slot holes, bracing holes, tab holes, rim notches, bulge notches, slide notches, clip notches and that can be installed vertically, horizontally or diagonally using the different configured support members and crossing members.

FIG. 284 is an isometric of the ledge or its components consisting of a tooth shaft extending through the tab hole in the web of the U shaped spacer brace allowing the end of the ledge tab to extend above the web.

FIG. 285 shows a vertical section through the hole shown in FIG. 284.

FIG. 286 shows a plan view of the U shaped spacer brace shown in FIG. 284.

FIG. 287 has a ledge shafts penetrate the slot holes and the ledge tabs are bent after the shafts penetrates the slot holes.

FIG. 288 is a cross section of FIG. 287.

FIG. 289 is a plan view of FIG. 287.

FIG. 290 is similar to FIG. 287 except the spacer brace rests on the hole bottom edge and the left tab has an indentation forming a notch creating a notched-tab securing the horizontal spacer brace at the hole.

FIG. 291 shows the hole having only one notched-tab where head of the notched-tab with rounded edges.

FIG. 292 shows the tabs in the punch out tabs are shown allowing vertical movement at intermediate support members along the space brace at the top of a framing structure.

FIG. 293 shows a hole at the web with a web shaft and web tab where the web tab is longer than the web shaft.

FIG. 294 shows the W shaped clip with the hook receiver end on both sides of the hole having a notch at the web for the web shaft and web tab to fit into.

FIG. 295 shows two holes notches in the key hole and two ledge shafts in the middle of the larger hole along with two hole notches that intersect a reverse lip spacer brace with lip notches.

FIG. 296 is similar to FIG. 13 except a U shaped spacer brace is installed at a diagonal in the hole notches at the key hole and a vertical oriented U shaped spacer brace is installed at a diagonal between the notched-tabs on the right side of the hole.

FIG. 297 shows an isometric view of a U shaped spacer brace having its hook receiver end pass through the hole so the hole notch at the extension fits into hole notches at the side edges and the second leg of the hook receiver end shows receiver notches on both side edges so the tongue end of an adjacent U shaped spacer brace can fit into the gap between the first and third leg of the hook receiver end and the hook tongue with the tongue shaft and the tongue tabs fit into the receiver notches at the second leg of the hook receiver end.

FIG. 298 shows a similar isometric view, however the U shaped spacer brace has the bottom edge of the tongue end having two notched-tabs shown as tongue shafts with tongue tabs located near the middle so the two tongue tabs fit into the receiver slot holes in the second leg of the hook receiver end.

FIG. 299 shows a U shaped spacer brace at the top and bottom ends of the support member where the lower U shaped spacer brace has the dorsal side against the floor and has slotted holes of the flanges where the slotted hole lower edge is level with the ventral side of the web of the U shaped spacer brace and the reverse occurs on the top U shaped spacer brace. The top and bottom edge of the web of the support member shown as a C channel has a gap where the flange fit between and also has a horizontal extension referred to as a web shaft with a web tab where the web tab has the gap between the web and the web tab. The web tab is longer so the web tab can be inserted into the slot holes having the longer edge bind against the slot hole. At the upper U shaped spacer brace a web tab is shown extended through the slot hole and is bent at the slot hole for an even stronger connection.

FIG. 300 shows the floor spacer brace similar to FIG. 17 however the top spacer brace shows slotted holes at the web and web tabs extending from the support member extending through the slot holes.

FIG. 301 shows a vertically oriented support channel also referred to as a floor joist intersecting a vertically oriented U shaped spacer brace sometimes referred to as a rim joist where the webs of both members intersect at the web so that the web of the C channel has a pair of web shafts with web tabs that can fit through the slot holes of the U shaped spacer brace so the gaps fits between the flanges of the U shaped spacer braces.

FIG. 302 shows an front elevation view of a W-shaped clip where the top side of the web is inserted into the notches of the rim of the triangular shaped hole along with the notches at both sides of the second leg.

FIG. 303 shows a plan view of the W-shaped clip where the web is inserted into the notches on both sides of the rim with the notches on the outer edge of the second leg of the hook receiver end.

FIG. 304 shows an elevation of a triangular shaped hole with a reverse lip spacer brace where the lips have horizontally oriented notches of the reverse lip spacer brace meet the vertically oriented notches at hole rim have notches so that the horizontal oriented notches intersect the vertically orient notches with the protruding side edges the protruding side edges of the horizontal oriented side edges eliminating any horizontal and vertical movement between notches.

FIG. 305 shows the plan view where the reverse lip spacer brace passes through the triangular shape hole so that only the horizontally oriented holes straddles both side of the hole rim which is also angular being a triangular shaped hole therefore making the notches not a rectilinear shape which would occur had the hole been a rectilinear shape and the hole rim also has the notch that straddles the top and bottom edges of the lip of the reverse lip spacer brace.

FIG. 306 shows a partial view of a metal framed wall with two reverse lip spacer braces at the top and bottom with a support member connected between spacer braces.

FIG. 307 shows an enlargement of the support member intersecting the reverse lip spacer brace.

FIG. 308 shows an enlargement of the reverse lip spacer brace where the support member self-locking connection occurs.

FIG. 309 shows an isometric of a reverse lip spacer brace within a hole and using a hook finger, bent flap and ledge shaft to secure the end.

FIG. 310 shows an isometric of a reverse lip spacer brace installed diagonally through the hole.

FIG. 311 shows an isometric view of the tabs passing through the web slot holes of the reverse lip spacer braces then getting bent after passing through.

FIG. 312 shows an isometric of a C shaped spacer brace at the top and bottom of a wall using the self-locking slide and fixed connections.

FIG. 313 shows an isometric of the U shaped spacer brace at the ceiling using the flange bulge notch as the sliding connecting and the reverse lip spacer brace at the floor using the lip notch and the web notch to form a self-locking fixed connection.

FIG. 314 shows a wall section at the ceiling with a U shaped spacer brace where the flange bulge has a flange bulge notch for the support channel to slide through.

FIG. 315 33 shows a wall section at the floor with a U shaped Spacer Brace where the flange bulge has a flange bulge notch for the support channel to slide through.

FIGS. 316-323 shows various spacer brace bulge notches and flange bulges when intersecting the support member.

FIG. 324 shows the bulge of the spacer brace insert into the hole notch at the lower corners of the hole in the support member.

FIG. 325 shows the bulge having a bulge notch where the side edge hole fits into and the lip of the space brace fits into the hole notch of the web in the support member.

FIG. 326 shows an isometric view of FIG. 325 where the bulge notch fit into the side edge of the hole and the lip from the spacer brace fits into the hole notch of the web in the support member.

FIG. 327 shows a similar isometric view of FIG. 325 however the flange and lip form obtuse angles.

FIG. 328 shows the same isometric view of the spacer brace 45 except the side-edges of the hole are inserted to the depth of the back of the notch allowing the spacer brace to be inserted into the deeper side-edges of the hole.

FIG. 329 shows an isometric view of FIG. 327

FIG. 330 shows a perspective view of the dorsal side of the support member with the receiver end of the spacer brace extending through the receiver notch into the key hole tabs at the key hole.

FIG. 331 shows the ventral side of the support member with the extension having a receiver notch for the key hole tabs to fit into and the top edge of the hole shows a web receiver having the tongue of the spacer brace extending through the notches on the bottom edge of the web receiver for the two bent tabs.

FIG. 332 shows a W-Clip having clip notches that extend on both sides of the W-Clip for the key tabs to fit into.

FIG. 333 shows the same W-Clip as FIG. 332 and a web hook receiver at the top edge of the hole with the tongue tabs for the diagonal spacer brace above passing through the receiver notches at the bottom of the web receiver.

FIG. 334 shows the similar spacer braces in FIG. 313 however here the top and bottom of the support member shows bracing holes having a key hole and key tabs on both sides of the key hole.

FIG. 335 an irregular shape hole have a continuous rim extending around the hole edges leaving a narrow edge in the corner where the W-Clip could be inserted into the rim of the hole if the rim had a notch or the W-clip was bent to create a notch to form a secure connection.

FIG. 336 shows a U shaped spacer brace extending through the hole in FIG. 335 53 where the bottom edge of the rim penetrates the first leg of the hook receiver.

FIG. 337 shows the hook tongue intersecting a hook receiver where the hook receiver also has receiver tabs that extend around a hole or lip and the tongue tabs overlap the receiver tabs.

FIG. 338 is an enlargement of the diagonal space brace being installed into a C-shaped spacer brace with its extended flange and notched-tab inserted into the flange hole as shown in FIG. 304.

FIG. 339 is an enlargement of the diagonal spacer brace and the support member intersecting the C-shaped spacer brace shown in FIG. 304.

FIG. 340 is an enlargement of the diagonal spacer brace being installed into a C-shaped spacer brace shown in FIGS. 338 & 341 except the web of the diagonal space brace has an indentation at the lips of the horizontal spacer brace and a notched-tab extension has a notched-tab at the end that is inserted into the raised slot hole at the web of the horizontal spacer brace.

FIG. 341 shows the diagonal spacer brace intersecting the horizontal spacer brace as shown in FIG. 340 however the a vertical support member is shown intersecting the horizontal spacer brace also having notched-tab indentation at the web with a notched-tab extension having a notched—tab at the end inserted into the raised slot hole.

FIG. 342 shows an enlarged view of the vertical support member inserting the horizontal spacer brace as shown in FIG. 304 where the web of the support member is indented at the raised area of the web and a notched-tab is extended into the slot hole.

FIG. 343 shows an enlarged view of the vertical support member inserted into two diagonally oriented notches at the raised web as shown in FIG. 304 where the web has a ½ notched-tab inserted into one of the diagonally oriented notches and another ½ notched-tab is inserted into the opposite diagonally oriented notches on the opposite side of the raised web.

FIG. 344 shows notched-tab having rounded edges and the crossing member having slot holes.

FIG. 345 shows only the notched tab as shown in FIG. 344.

FIG. 346 shows a C shaped spacer brace as a crossing member having notches at the lips being supported at the hole bottom edge of the support member where the notches in the lips are secured at the notch of the notched-tab at the hole bottom edge.

FIG. 347 is similar to FIG. 346 except the notched-tab in located at the top edge of a support member and the crossing member is a C shaped spacer brace having the dorsal side even with the top edge of the support member and the notched-tab is the anchor space at the ventral side of the web of the crossing member.

FIGS. 348 & 349 are similar to FIGS. 340 & 341 except the hooked tongue is V-shaped.

FIG. 350 is similar to FIGS. 297 & 298 except the V-shape tongue is used therefore the hooked receiver is slightly different shape.

FIGS. 351 & 352 shows a reverse lip spacer brace extending through a V shaped hole having a blunt end and also connected by lip notches and hole notches.

FIGS. 353 & 354 shows a V shaped hole having a V shaped spacer brace with a notched-tab at the vertex and FIGS. 355 & 356 show the V shaped spacer brace being connect by holes notches and leg notches. FIGS. 357 & 358 also use the V shaped hole but the notched-tabs extend from the angular hole bottom edge.

FIG. 359 shows two spacer braces having notched-tab ends overlapping and intersecting at a notched hole.

FIG. 360 shows two spacer braces intersecting a notched hole where one end has the extension engaged in the notched hole with the finger extending over the bottom edge having a web-slot hole for the opposite end of an adjacent spacer brace having a notched-tab end engage the web-slot hole.

A BRIEF DESCRIPTION OF THE DRAWINGS in FIGS. 361-401 shows the spacing-bracing members overlapping and connecting each other forming curvilinear metal framing structures for walls and ceiling undulating either vertically or horizontally at the top, middle and base of the metal framing structure. Additional framing connections as shown for diagonal metal framing connection, window and door framing headers as well as forming panelized metal framing panels for even faster field assembly connections.

FIG. 361 shows an isometric view of four support members having various configurations and crossing members all having various self-locking connections using support tabs, notched-tabs extending from hook tongues at the webs or notched-tabs extending from hook tongues at the flanges into receiver holes at the webs of flanges, or notched-tabs extending from the hole bottom edges into web slot holes or into lip notches of a C shaped spacer braces. Web notched-tabs at the longitudinal end of adjacent spacer braces can overlap adjacent spacer braces at the holes in support members, Diagonal reverse lip spacer braces with lip notches can have lip-notched receivers attached to lip notches or can be attached at the flange receiver slot holes at the opposing ends. Notched-tab can extend from the web of the support member into the slot holes of the reverse lip spacer braces or the flanges slot holes at both flanges. The spacer braces can have bend in the web, flanges or lips of the spacer braces to obtain short radius curves. Headers over doors and windows can be installed with the base spacer brace bearing into the cut out with notches in the cripple at the base of the opening. Notches can be installed protruding from the hole edges so different configured spacer braces can be installed in the hole side edges without using lip notches and spacer braces can be smaller and can slide between the flanges of a larger spacer brace.

FIG. 362 shows an elevation of a standard metal framed wall or a metal framed wall that has a curvilinear shaped wall using different framing components to form the curved wall.

FIG. 363 shows an elevation of the metal framed where the top spacer brace is undulating vertically creating an arched looking framed wall showing door and window framed opening with a curvilinear top spacer brace plate.

FIG. 364 shows the space brace being connected to an adjacent spacer brace having one end engaged at the hole with a hook tongue having a notched-tab extend into the slot hole receiver. A round receiver hole shows the opposing end having angular extension allowing the spacer brace to be angled horizontally for an undulating framing wall.

FIG. 365 is similar to FIG. 361 except the spacer brace is shown as a reverse lip spacer brace having a web, two longitudinal walls with extending longitudinal lips with notches extending inward from the free edge with the lips facing upward and the web extension being a hook tongue with the notched-tab facing upward with both webs having an extension having tapered sides for the notched-tab to fit into the receiver hole forming the vertical wall can have an undulating wall configuration.

FIG. 366 is similar to FIGS. 364 & 365 showing a U shaped spacer brace where the flanges extend on the outside edges of the vertical flanges of the support member, but the extensions of the longitudinal spacer braces are shorter so the notched-tabs with the receiver holes are between the vertical support members allowing the undulating wall to pivot in the receiver holes having the notched-tabs be the pivots. In FIGS. 364 & 365 the notched-tabs extending through the receiver holes, however the width of the spacer brace in FIG. 366 shows is wider than the width of the support members and the extensions at the receiver hole and the hook tongue are tapered so the notched-tabs can pivot for a curved wall.

FIG. 367 shows the shows the same reverse lip spacer brace as shown in FIG. 368 except the right side shows an angled lip and flange where the lip flange and lip notch can be installed face up or face down.

FIG. 368 shows the reverse lip spacer brace having the angled flange with a flange notch or slot hole where the key hole bottom edge and the key hole have their edges fit into the flange slot hole in the flanges along with the lip notches of the reverse lip spacer brace at the holes side edges reverse lip spacer brace hole opening fits into the slot hole and the lip has an extension and the extension has a lip notch to secure the reverse lip spacer brace.

FIG. 369 shows the reverse lip spacer brace having the bottom side on a floor with the support members and a diagonal spacer brace intersecting at the lip notches where the notched-tab extends upward from the hook tongue at the web with the receiver hole is at the opposing end of the web.

FIG. 370 is similar to FIG. 369 except the notched-tab is directly attached to the web having the extension at the notch and the notched-tab extends upward and the opposing web has the extension with the receiver hole.

FIG. 371 shows the same profile of the reverse lip spacer brace in FIG. 370 except the reverse lip spacer brace is facing downward and the lip notches are installed in the hole notches at the hole side edges and the notched-tab at the longitudinal end of the web is extending upward and the receiver holes at the opposing end has a web extension where the receiver holes are located so an adjoining reverse lip spacer braces with its notched-tab can fit into the receiver hole and the adjacent reverse lip spacer brace can be oriented at a diagonal. FIG. 364 shows a hole notch at the lip notch so the lip notch can be secured vertically in the hole notch.

FIG. 372 shows the space brace with the lip notches at the free end of the lip connected to the hole notches in the hole side edge in the support member with a hook tongues extending from the flanges with notched-tabs at the longitudinal end being inserted into the hole round receivers at the pivot points for the adjacent spacer brace to be turned upward or downward.

FIG. 373 is similar to FIG. 372 except the notched-tabs at the longitudinal ends extends outward and the receiver holes are located on the flange extensions.

FIG. 374-375 show a longitudinal cross section of a spacer brace and FIG. 375 shows a cross section of the reverse lip spacer brace, except here the lip has a double lip where the double lip extends upward and the lip notches are at the side edges of the lip notches the engage the web of the support member above the hole notches.

FIG. 376-377 is similar to FIGS. 374 & 375 except FIGS. 376 & 377 shows the double lip with the free edge facing downward and the lip notches engage the bottom edge of the hole notches.

FIG. 378 shows the L-shaped notch with slope side at the bottom end of the support member of a U shaped support member and is fitting into the interior side of the C shape support member where the top end has a reverse profile of the L-shaped notch, with a curving profile where the web and flanges have an open cut and the lips are allowed to bend. The left lip shows the lip notch with flare ends, another lip notch where the lip notch is extended into the flange notch.

FIG. 379 shows a similar profile as FIG. 377 except here the web and lips have been removed and the flanges are allowed to bend so the spacer brace can be curved but in a horizontal orientation.

FIG. 380 is similar to FIG. 379 except here the spacer brace has a C shaped profile and the lip notches are oriented inward toward between the opposite side lips.

FIG. 381 show the flange extension or the hooked tongue with its notched-tab extending inward toward the opposing lip for the notched-tab to fit into the receiver hole on the flange of the adjacent spacer brace.

FIG. 382 shows two different longitudinal connections, one with the flange extensions overlap the flanges and another where the hook tongue has a notched-tab at the end to be inserted into the receiver hole at the opposing end of an adjacent spacer brace.

FIG. 383 shows the web having a notched-tab at the end of the web of the support member and another aspect of the invention shows the web and lips of the crossing spacer brace having bent webs and lips so the spacer brace can be angled or bent between the support members forming a curved concave profile at the top of the metal support channel.

FIG. 384 shows the web of the support member having a notched-tab profile at the interior side edge of the two L-shaped gaps where the web notches fit into the lip notches of the longitudinal spacer braces where the flanges have slot holes for the head of the notched-tabs can fit into.

FIGS. 385-388 shows different views of the notched-tab at the ends of the spacer brace most clearly shown in FIG. 385 having the web extend through the holes of the support member with notches extend around both side planes of the hole with the head of the notched-tab extending through to the opposite side of the hole opening. When the head of each notched-tab extends through the hole in opposite directions, the notched-tabs are basically level between each other and secured together by the notches in the notched-tab. On the other hand FIG. 386 shows an elevation of the hole in the support member with some of the various hole edge configurations that the notches could show. The inside edges of the hole can vary in shape and location depending on the shape of the spacer brace and where the hole notches in the protrusion are located. The protrusions and notches accomplish the same function as they both keep the spacer brace lodged in the hole notches or the side or bottom edges of the hole.

FIGS. 389-391 shows how the hole side edges or protrusions can extend into the hole side edges to form other spacer brace configurations. The figures show how the bulges between the web and the flanges can create an indentation to secure the spacer brace into the hole side edges or how the bulges can have an indentation or notch to slide within the hole side edges and how the flanges can be bent and the lip also bent to create a different configuration of the spacer brace.

FIGS. 392-394 show the lip notched receiver section being connected to a smaller and larger reverse lip spacer braces where the spacer brace in FIG. 392 is being connected to the upper spacer brace at the notched lips and the spacer brace in FIG. 394 is being connected into the flange slot holes of the larger reverse lip spacer brace.

FIGS. 395 & 396 shows the reverse lip spacer brace having slot holes in the flanges and FIG. 396 shows the lip notched-receiver having receiver notches to connect to the lip notches in FIG. 395. FIGS. 392-396 are similar except sometime the lip notched-receiver would be connected from the top side and the notches would be connecting to the lip notches. On the other hand the lip notched-receiver would be connected from the bottom side of a spacer bracer and the notches of the notched-receiver would be extending into the slot holes in the flanges.

FIGS. 397-398 shows the reverse lip spacer braces show the lips extending upward and downward at an angle to additional strength for the lip notched receiver, plus have the reverse lip spacer brace shown as a bracket to allow the bracket to slide so the lip notched receiver can have a tighter fit and be connected with fasteners.

FIG. 399 shows a wall support member having a spacer brace passing through the hole and another spacer brace at the floor, however another reverse lip spacer brace is between the flanges that can slide between the flanges and where the lips can be connected to a diagonal spacer brace forming a tight fit.

FIG. 400 shows the reverse lip spacer brace being installed into the support member where the reverse lip spacer brace is used as a header above a door or window and the flange is shown deeper. The web of the reverse lip spacer brace is shown having a raised web with slot holes for a cripple and a support member are joined both being C channels, but where the web of the cripple is shown having a notched-tab that extends into the slot holes of the header.

401 is similar to FIG. 400, however the reverse lip spacer brace as the header does not have a raised web and the cripple is shown having a cut-out with web notches at the sides for the web and flanges can fit into the cut-out and the lip and lip notches can fit into the web notches of the cripple.

A BRIEF DESCRIPTION OF THE DRAWINGS shows FIGS. 402-442.

FIG. 402 shows an isometric view crisscrossing metal framing members highlighting various figures described within the cloud formations. Many different configurations or variations are shown throughout this application, where each cloud represents a different configuration means for securing crossing members together by using either ledges, notches and punch-out tabs between the support members to form different self-locking framing connections between metal framed wall components for a building.

FIG. 403 is an enlargement at the intersection of the ledge at the longitudinal ends of the spacer brace at the support member and the notch gap in the flange of the spacer brace connecting intermediate support members.

FIG. 404 shows the end of a downward facing spacer brace passing through the hole of a support member where the flanges engage the ledge at mid-height having a notch on the flange to rest on and the receiver end passing over around and under the ledge so the first leg of the receiver can extend outward again in front of the ledge before bending again to form the second leg.

FIG. 405 shows the U-shaped spacer brace connected to two vertical support members using teeth and fasteners extending from the extensions with the flanges edges having notched teeth and a slot hole from connecting hook tongues from adjacent spacer braces.

FIG. 406 is similar to FIG. 405 shown with a gap notch with teeth at the flange gap notch with a punch-out tab in the hook receiver at one end and the hook tongue with punch-out tabs to interlock and extend into.

FIG. 407 shows a C-shaped spacer brace with the extension having a hook tongue with a J-shape end at the hook tongue.

FIG. 408 is similar to FIG. 407 except the left spacer brace is a reverse lip channel with the lips extending outward from the web, but having a J-shape hook tongue with teeth and an adjacent spacer brace having double flanges an L-shaped finger having teeth with the extension having a slot hole for the hook tongue to fit into.

FIG. 409 is similar to FIG. 407 however the extension is longer and a V-shape hook receiver.

FIG. 410 is similar to FIG. 407 however the extension is longer and the hook tongue has a V-shape hook tongue and an adjacent space brace has a slot hole with a ledge extending from its side edge for the V-shape tongue to engage over ledge.

FIG. 411 shows an isometric view of the U shaped spacer brace passing through the hole of the support member having the bottom edge as a ledge engaging the U shaped spacer brace at the notch gap in the flanges.

FIG. 412 is an isometric view of an enlargement of FIG. 439 where the notch and notch gap are shown in the flange of the U shaped spacer brace having the dorsal side facing upward with the flanges extending downward from the web.

FIG. 413 shows an intermediate support member having a ledge at the bottom edge being inserted into the notch gap of the flanges and a tab from the punch out holes wraps-around the ledge at the end of the support member.

FIG. 414 shows the ledge at the top, bottom and on the side edges of the hole in the web of the support member.

FIG. 415 shows the ledge being inserted into the ledge gap of the flanges of the U shaped spacer brace as well as the tab of the punched out holes in the web.

FIG. 416 shows and enlargement of the ledge being inserted into the notch gap of the flanges.

FIG. 417 is similar to FIG. 402 however the gap is inserted into the flanges only half way into the depth of the flanges.

FIG. 418 shows a plan view of a W-shaped clip installed over the flange of a C channel having hook tongues installed into the hook receivers on both sides of the W-shape clip.

FIG. 419 shows a plan view of a U-shaped clip installed over the flanged of a C channel having one side hook over the lip of the support member and the opposite side having a bent hook extend into the hole in the web of the support member with a hook tongue end of a spacer brace.

FIG. 420 shows an enlargement of the two cross-crossing spacer braces shown in FIG. 422.

FIG. 421 shows a truss using two reverse lip spacer braces as the top and bottom chords with wider C channels as vertical support members along with reverse lip spacer braces as diagonal braces connecting the lips of the top and bottom chords of the truss.

FIG. 422 shows an enlargement of the reverse lip spacer brace shown in FIG. 421 as the bottom chord of the truss with the flanges of the U-shaped spacer brace interlocking with the lips of the bottom chord.

FIG. 423 shows a raised web at the bottom chord with raised web notches for the web notched tabs of the support member to fit into.

FIG. 424 shows ledges installed in the web at the top plate of the support member, the bottom edge of the hole and punch-out tabs at the bottom edge of the support member for the flange gaps with flange notches can connect to the ledges or tabs to secure the horizontal and vertical metal framing members together.

FIG. 425 shows a proprietary shape of an reverse lip spacer brace being connected to an enlarged shaped flange gaps and flange notches.

FIG. 426 shows an proprietary shaped angle having an enlarged lip being connected to an enlarged shaped flange gap and flange notch.

FIG. 427 shows an isometric view of an intermediate connection of a U shaped spacer brace passing through the hole of the support member having the tabs of the punch out holes connect to the ledge along with the flanges having notches in the flanges of the spacer brace for the web of the support member to brace too.

FIG. 428 shows a cross section of FIG. 427.

FIG. 429 shows a plan view of FIG. 427.

FIG. 430 shows an isometric view of an intermediate connection of a U shaped spacer brace passing through the hole of the support member having the tab of the spacer brace secured under the ledge of the support member.

FIG. 431 shows a cross section of FIG. 430.

FIG. 432 shows a plan view of FIG. 430.

FIG. 433 shows an isometric view of an intermediate connection of a U shaped spacer brace passing under the web of the support member having the tab of the spacer brace secured over the ledge of the support member.

FIG. 434 shows a cross section of FIG. 433.

FIG. 435 shows a plan view of FIG. 433.

FIG. 436 shows an isometric view of an intermediate connection of a U shaped spacer brace passing through the hole of the support member having two tabs within the same punch out hole with one tab engaging the ledge and the opposing tab engaging the back side along with the flanges having notches in the flanges of the spacer brace for the web of the support member to brace too.

FIG. 437 shows a cross section of FIG. 436.

FIG. 438 shows a plan view of FIG. 362.

FIG. 439 shows the tabs in the punch out tabs are shown allowing vertical movement at intermediate support members along the space brace at the top of a framing structure.

FIG. 440 is similar to FIG. 439 as the vertical movement is shown using flange bulges with indentations forming a flap bulge equal to the width of the support member and receiver slot hole having ledges for the tongue of an adjacent spacer brace can be secured by the curvilinear ledges whether at the top or bottom of the support member.

FIG. 441 shows is a duplicate of FIG. 283.

FIG. 442 shows FIG. 283 in earlier FIG's.

A BRIEF DESCRIPTION OF THE DRAWINGS shows FIGS. 443-471 having various types of overlapping spacer braces used to connect spacer braces through the holes in the support members as well as various configurations of the spacer braces to interlock the spacer braces together to make the connections to the support members.

FIG. 443 shows an upward oriented U shaped reverse lip spacer brace connecting adjacent support members and overlapping an adjacent spacer brace connecting the lip notches to the support members at the holes.

FIG. 444 shows an upward oriented U shaped reverse lip spacer brace having angular flanges connecting adjacent support members and overlapping an adjacent spacer brace connecting the lip notches to the support members at the holes.

FIG. 445 shows a downward oriented U shaped reverse lip spacer brace overlapping an identical adjacent spacer brace connected at the lip notches to the holes of a support member.

FIG. 446 shows two downward adjacent oriented spacer braces having the lower oriented spacer brace with a lip-flange notch engaging the hole bottom edge with the upper oriented spacer brace having only lip notches engaging the hole side edges.

FIG. 447 shows upward oriented reverse lip spacer braces connected at the hole by a notched tab web extension and connected by an overlapping adjacent spacer brace having lip notches.

FIG. 448 shows an upward oriented reverse lip spacer brace having lip notches and a longitudinal end with a notched tab web and an opposing end having the notched tab end with the end portion of the tab extending downward over the hole bottom edge.

FIG. 449 shows an upward oriented reverse lip spacer brace connected together like FIG. 443 between spacer blocks with projections that overlap the web of the support member.

FIG. 450 shows an upward oriented reverse lip spacer braces connected at the hole with lip notches and connected to an adjacent spacer brace by having slot holes in the web so the adjacent reverse lip spacer brace with a hook tongue can connect to the slot hole at the first reverse lip spacer brace.

FIG. 451 is an enlargement of FIG. 447 shown connecting two spacer blocks together.

FIG. 452 is an enlargement of FIG. 451.

FIG. 453 shows an upward oriented U shaped spacer brace with notches at bottom and sides engaging the hole sides that overlaps an adjacent spacer brace with a notched tab extension at the web that engages the sides of the hole.

FIG. 454 shows an upward oriented U shaped spacer brace with notches at the bottom and sides engage the hole sides and an adjacent spacer brace with an upward hook engage the flat plate that is fastened to the support member.

FIG. 455 shows a downward oriented U shape spacer brace with the flanges and web being indented at the hole and the web extending over the hole bottom edge with the opposing end of an identical U shaped spacer brace having the flanges and web being indented at the hole, however the web extension has a hook tongue extending upward that overlaps the first U shaped spacer brace for connecting a bracing plate to the support member.

FIG. 456 shows downward U shaped spacer brace with notch in flanges engage hole bottom edge with an identical U shaped spacer brace having the opposing end having an indentation at flanges and web with web extension having a hook tongue overlap the web of the first U shaped spacer brace extending downward into the receiver slot hole.

FIG. 457 shows two adjacent upward oriented U shaped spacer braces connecting to a support member with the web of the longitudinal end having flange notches connected to the underside of a hole protrusion with the opposing end having a web extension with a hook tongue for insertion into a receiving hole in the web of the adjacent spacer brace along with 2 diagonal oriented U shaped spacer braces where the hook finger end connection has an extension that engages the hole top edge at the hole notch while the lower diagonal orie60ed U shaped spacer brace has a notch tab end connection that engages the hole side edges.

FIG. 458 shows two downward oriented U shaped spacer braces where both longitudinal end shows indented flanges and web where one end has a hook finger where the extension is inserted into the holes notches and the opposing end has a hook tongue where the extension overlaps the first spacer brace with the hook tongue having a curvilinear tip for inserting into the receiver slot hole.

FIG. 459 shows a similar configuration as FIG. 458 except the reverse lip spacer braces are shown with the lips and hook finger support the reverse lip spacer brace at one end with the hook tongue at the opposing end has the extension overlapping the adjacent spacer brace.

FIG. 460 shows two reverse lip spacer braces overlapping the hole bottom edge with a continuous web flange notch allowing the first reverse lip spacer brace to extend lower into the continuous web flange notch an adjacent spacer brace to overlap the first reverse lip spacer brace. or using an alternate solution of having the hook tongue extend into a receiver slot hole.

FIG. 461 shows the two reverse lip spacer braces overlapping and engaging the hole bottom edge as shown in FIG. 460.

FIG. 462 shows and enlargement of FIG. 443.

FIG. 463 shows a deeper web flange notches where the lower reverse lip spacer brace has a deeper flange for additional strength or allowing for the hole bottom edge to be longer for a different configuration or the deletion of the lips with notches.

FIG. 464 is similar to FIG. 465 except the flanges does not overlap the support member, but only is aligned with the flanges of the support member.

FIG. 465 shows a horizontal bracing member having extension with a hook finger and the opposing end having a hook tongue with the extension overlapping an adjacent horizontal bracing member connected to the receiver slot hole, but having and extending flanges that overlap the flanges of the support member.

FIG. 466 shows the end connection of a reverse lip spacer brace where the longitudinal end of the lip and the hook finger or hook receiver engage both sides of the support member.

FIG. 467 shows the end connection of a U shaped spacer brace having a flap engage one side the web of a support member and a hook finger or hook receiver engage the opposing side of the support member.

FIG. 468 shows the end connection of a U shaped spacer brace having the flanges and web indented so the longitudinal ends engage one side of the web of a support member with the hook finger or hook receiver engage the opposing side of the support member.

FIG. 469 is similar to FIG. 467 however the section is taken through an intermediate connection of a support member where the lips have lip notches and each flange has a flange-web notch where the flange-web notch and lip notches engage the hole at the web of the support member.

FIG. 470 shows two reverse lip spacer braces stacked above each other with the overlapping reverse lip spacer brace having a wider web with a wider lip to engage the hole side edges, plus the lower reverse lip spacer brace has a receiver slot hole for the overlapping reverse lip spacer brace having a hook receiver with a notched tab tip.

FIG. 471 shows two overlapping U shaped spacer braces having a continuous web-flange notches that engage the hole side edges of the support member along with a hook tongue where the tongue is a notched tab that extends upward through a slot hole into the adjacent U shaped spacer brace.

A BRIEF DESCRIPTION OF SOME DRAWINGS with some of the various types brackets and short spacer braces used to connect several spacer braces together.

FIG. 472 shows an isometric view of the structural insulating wall where the spacer blocks are the same width as the support members and bracing members fit into a trough or on the horizontal projections of the spacer blocks connecting to the support members, bracing members, brackets, and plates together along with the base plate connections to the spacer blocks and support members. The inner and outer boards form a thermal break gap between the elements. The isometric view shows 10 clouds or cut away areas at the intersections of the support members, bracing members, one or two piece brackets and the intersection two spacer blocks. The bracing members have many shapes with notches that fit into different shape holes of the support members. Some clouds show brackets that fit within or around the bracing members with notches connecting the support member. In other cases, a bracket fitting into or over the bracing members also having notches having single plane or multi-plane configurations that engage the holes or lips of the support member to form a rigid metal framing structure. The following figures show enlargements of the cloud drawings and additional variations of the bracket connections and spacer block connections.

FIG. 473 shows a one piece bracket having a multi-plane configuration having a top side attached to two vertical sides and horizontal sides with end notches that engages the lips of the support member and fasten at the top side to the downward facing bracing member.

FIG. 474 shows a one piece bracket that can be L shaped where the first side has notches on both side edges engaging the hole in the support member and has a pair of notches engaging one half of the support member at the lips and one half of the notch formed by the second side bent perpendicular to the first side fastened at the lips or bent again onto the flanges of the support member and fasten to the bracing member facing downward.

FIG. 475 shows the same isometric view as FIG. 474 however one leg is secured by a fastener to the web of the bracing members.

FIG. 476 shows a multi-plane one piece bracket connecting to the U shaped bracing members facing downward and the opposite end of the bracket is a U shaped bracket attached at the lip or flange of the support member.

FIG. 477 shows the multi-plane one piece bracket without the spacer blocks as shown in FIG. 476 and the isometric view is from the interior of the support member.

FIG. 478 shows the multi-plane one piece bracket where one side connects the top side of the bracing member and the other side connecting the web of the support member by forming a ½ notch at each side of the one piece bracket.

FIG. 479 is an isometric view of the trough in the spacer blocks where a bracing members is shown U shaped facing upwards with a one piece multi-plane bracket shown as reverse lip shape fitting between the flanges of the bracing member so the notches at the lips engaging the edges of the hole and the bracket is fastened to the bracing member.

FIG. 480 shows an isometric view of the reverse lip channel as a bracing member with notches at the lips engaging the edges of the hole of the support member.

FIG. 481 shows the same bracing member as a reverse lip channel having notches in the lip engaging the edge of the hole, however the hole in the support member is V shaped at the bottom and the web and flanges of the bracing member are notched securing the bracing member to the hole along with the trough of the spacer blocks located below the bracing member.

FIG. 482 shows a bracing member as V shaped with the lips having notches that engage the holes where the holes in the support member is V shaped with the arrow shape pointing downward and also having a blunt point and the bracing member having a notch at the vertex for the blunt end of hole to fit into.

FIG. 483 shows a bracing member shown as a U shaped channel facing downward onto the horizontal tongue of the spacer blocks where a one piece multi-plane bracket shown as reverse lip shape with a notch at the lips fits over the bracing member and engaging the sides of the hole in the support member.

FIG. 484 shows a bracing member having a reverse lip shape and downward facing over the horizontal tongue of the spacer block installed between the webs of the support members with a one piece bracket shown as a vertical plate connecting to a continuous groove at the web and partially into the side flanges and connected to the support member.

FIG. 485 is also a multi-plane one piece bracket having an L shape where the bracket is in reverse with the vertical leg on the opposite side of the hole in the support member.

FIG. 486 is an enlargement of the intersection of the hole and bracket except a vertical side is extended past the hole allowing a vertical plate to fit between the vertical side and the web of the support member forming a two piece bracket assembly.

FIG. 487 shows a one piece multi-plane bracket having a bottom side, two vertical sides with notches at the horizontal lips engaging the hole of the support member install between the webs of a bracing member being U shaped with the web of the bracket fasten to the bracing member.

FIG. 488 is the same as FIG. 487 except the one piece multi-plane bracket also a reverse lip shape is installed in the hole of the support members first and the bracing member being U shaped facing upwards is installed between the flanges of the bracket.

FIG. 489 shows the bracing member having a V shape pointing downwards fitting into a hole being V shaped in the support members and a one piece multi-plane bracket being V shaped with notches in both sides engaging the hole in the support members and fastened to the bracing members.

FIG. 490 shows is similar to FIG. 489 except the bracket is installed into the hole of the support member first and the bracing member being V shaped pointing downward are connected to each other.

FIG. 491 shows a U shaped bracing member with the sides facing upwards and a U shaped bracket with its sides fitting into the U shaped bracing member and its top side having notches in the sides and top side for a flat plate to fit into the notches and fastened to the web of the support member.

FIG. 492 shows a two piece bracket installed in a bracing member where the bracing member is U shaped facing upwards and the first piece of the two piece bracket is U shaped facing downward having a notch at the top side for flat plate of the two piece bracket to fit into and fasten to the web of the support member.

FIG. 493 shows a bracing member that is V shaped pointing upwards with a notch at the vertex and the one piece bracket is a flat plate that is secured into the notch and fastened to the web of the support member.

FIG. 494 shows the V shaped bracing member pointing upwards and the first piece of the two piece bracket also being V shaped pointing upwards fitting over and fastened to the bracing member with the first piece of the bracket having a notch at the vertex where the second piece being a flat plate engages the notch and fastened to the web of the support member.

FIG. 495 is the same as FIG. 494 except the flat plate has sloping sides to conform to the angle of the first piece of the two piece bracket.

FIG. 496 and FIG. 497 shows the second piece of the two piece bracket is a flat plate with teeth that extend on both sides of the top side edges of the hole of the support member and installed into a vertical position by sliding the first piece to align with the web of the support member.

FIG. 498 shows the same two piece bracket configuration as FIG. 494 along with the second piece of the two piece bracket having a flat plate with teeth installed into vertical position by sliding the first piece to align with the web of the support member.

FIG. 499 shows the same configuration as FIG. 471 except the flat plate with teeth extend into both sides of the top side edges of the hole and the bottom edge of the flat plate slide into the notches of the bracing member and the flat plate is fasten to the web of the support members.

FIG. 500 is similar to FIG. 481 however the notch in the first piece of the two piece bracket is notched to one side of the notch engages only one side of the hole in the support member and the other side of the notch is larger as it penetrates the side edges and lip of the first piece and the flat plate of the second piece secures the opposite end of the notch.

FIG. 501 has a long first piece of a two piece bracket used having two sets of notches in the side edges, one set of notches engaging the flat plate and the other set of notches engaging the web of the U shaped second piece with both of the second pieces attached to the support member.

FIG. 502 is an enlargement of FIG. 500 except a grommet has been added that fills an area between the bottom of the flat plate, the two side edges and the bottom side of the first and second piece of the two piece bracket.

FIG. 503 is the same configuration as FIG. 487 except the hole in the support member has a lower hole connected to a larger hole for a smaller width bracing channel to fit through and a smaller size U shaped bracket with extending lips, so the lips with notches can fit into the side edges of the smaller sized hole.

FIG. 504 shows a two piece bracket where the first piece is U shaped with the top side extended to form an angle and fits over a bracing member where the U shape faces downward and the first piece fits over the bracing member and the angle piece connects to the second piece at the web and the side edges abut the lips and may extended around the flanges of the support member.

FIG. 505 is similar to FIG. 498 except the first piece has notches at the end of the side edges that engage the hole of the support member and the vertex has notches on both side edges that engage the web of the second piece of the two piece connector as well as extend over the flanges of the support member.

FIG. 506 shows a bracing member that is U shaped downward facing onto the horizontal tongue of the spacer block with first piece of a two piece bracket that is U shaped facing down fitting over the top side of the bracing member and having a groove on its topside for the second piece having a web to fit into the groove and extend over the flanges of the support member.

FIG. 507 shows an isometric of the spacers blocks with tongue and groove connections between the support members overlapping and extending past the flange of the support member along with the horizontal tongue and depression between spacers blocks for the bracing members being V shaped pointing upwards with a notch at the vertex for the one piece bracket to engage the notch and secured at the flanges of the support member and the horizontal tongue of the spacer block fitting under the bracing member.

FIG. 508 shows a butterfly shape of a reverse lip bracket having notches in the lips connected to the side edges of the hole and lip of the support member.

FIG. 509 shows a reverse lip bracket having notches in the lips connected at the side edges of two adjacent support members.

FIG. 510 shows vertical notches in the side edges of the hole that interlock into the horizontal notches of the lips of the reverser lip bracket plus a downward extended tab shown inserted into the tab hole of the horizontal bracing channel.

FIG. 511 shows an L-shaped bracket similar to FIG. 477 except extended tabs are into the tab holes of the horizontal bracing channel.

FIG. 512 shows an L-shaped bracket similar to FIG. 478 except here the vertical leg extends across the hole in the support member rather than the lips and flanges of the support member.

FIG. 513 shows a horizontal bracing channel with its ventral side facing downward spanning over the hole of a support member with a reverse lip bracket having its ventral side inserted over the horizontal bracing channel having a vertical notch at the side edges of the hole and horizontal notches at the lips of the reverse lip bracket along with extended tabs inserted into the tab holes of the horizontal bracing channel.

FIG. 514 shows a combination of FIGS. 511 & 514 along with the interlocking vertical and horizontal notches and the extended tabs inserted into the tab holes.

FIG. 515 shows an isometric of a butterfly bracket connected at the side hole edges by intersecting hole notches and bracket-flange notch along with an extended tab with arm tabs that are secured at the lips of the bracing channel.

FIG. 516 is an enlargement of the butterfly bracket with the arms tabs on the extended tab of the punch out tab.

### [[Sb8c]]

A BRIEF DESCRIPTION OF THE DRAWINGS in this pending application U.S. Ser. No. 16/354,081 explains how overlapping spacing-bracing members have dimensional changes when adjacent spacing-bracing members overlap. Many of the features used in the longitudinal end of one spacing-bracing member and another feature is used at the opposing longitudinal spacing-bracing member while still being overlapped or engaging the side edge of the opening of metal framing supports. In addition the longitudinal spacing-bracing members are reverse being the same configuration is shown having the web supported above the hole bottom edge or the web resting on the hole bottom edge. Many alternative configurations are shown including the spacing-bracing member installed within the base channel, irregular shape spacing-bracing members with notches being additionally supported by projections extending from apertures. In addition FIGS. 591-594 shows the reverse lip spacer brace in other configurations.

FIG. 517 shows overlapping spacer braces having different width webs, flanges and lips in relation to the notches in the lips

FIG. 518 shows V-shaped angles having the same dimensions and overlapping one another with the angled sides intersecting the side edges of the hole in the notch at the angled sides.

FIG. 519-604 show metal framing elevations of different spacer brace configurations with lips having notches as shown in a corresponding sectional view of the overlapping spacer braces connected to support members by lip notches while overlapping and stacked above each other.

FIG. 519-521 shows an elevation, enlargement and section of metal framing connected by spacer braces having two different widths at the web for the larger spacer brace to be stacked above a narrower spacer brace using alternate spacing.

FIG. 522-524 shows an elevation, enlargement and section of metal framing shows the same metal framing between support members except the spacer braces are reversed with the web are resting on the aperture bottom edges.

FIG. 525-527 shows an elevation, enlargement and section of metal framing shows the same metal framing between support members however one end of the spacer brace shows the web being wider overlapping the narrower width web of the lower spacer brace allowing the larger width web always fitting over a smaller width web or in this case the smaller width web into the larger width web.

FIG. 528-530 shows an elevation, enlargement and section of metal framing having the same width webs of two upper and lower overlapping spacer braces installed having an overlapping end to end pattern where the first end fits over the second end of the lower overlapping spacer brace forming a continuous overlapping pattern between support members.

FIG. 531-533 shows an elevation, enlargement and section of metal framing having the same configuration as FIGS. 528-530 except the lip notches are extending into the flanges forming a continuous lip flange notch.

FIG. 537-539 shows an elevation, enlargement and section of metal framing similar to FIGS. 531-533 except the spacer brace has the flanges extending downward toward the hole bottom edge with the lips and the flanges having a continuous notch with the flanges of the upper spacer brace resting on the flanges of the lower flanges both spacer braces being the same width.

FIG. 540-542 shows an elevation, enlargement and section of metal framing similar to FIGS. 525-527 except the upper spacer brace has a receiver hole in the web where the lower spacer brace has a hook tongue being an extension from the web with a tongue shape extending into and through the receiver hole.

FIG. 543-545 shows an elevation, enlargement and section of metal framing similar to FIGS. 540-542 except the spacer braces have their flanges and lips facing downward toward the aperture bottom edge with the lip notches engaging the apertures side edge and the web having an extension with a tongue extending downward into the receiver hole in the web of the lower spacer brace.

FIG. 546-548 shows an elevation, enlargement and section of metal framing with the webs of the overlapping spacer braces having different web widths and where the web of the support member has the aperture bottom edge extend through receiver holes in the webs of the upper and lower spacer braces having the hole bottom edge or ledge shaft extend through the web receiver holes connecting both spacer braces.

FIG. 549-551 shows an elevation, enlargement and section of metal framing where two overlapping spacer braces meet with spacer brace having the smaller width web has a receiver hole near the support member and the larger width overlapping spacer brace has a hook tongue with an extension over the smaller spacer brace with the tongue end extending into the receiver hole.

FIGS. 552-554 shows an elevation, enlargement and section of metal framing is similar to FIGS. 549-551 except the spacer braces are the same size at both longitudinal ends when overlapping a second spacer brace where the tongue extending upward from the lower spacer brace web into the receiver hole of the upper spacer brace.

FIGS. 555-557 shows an elevation, enlargement and section of metal framing is similar to FIGS. 552-554 except the upper spacer brace does not overlap the lower spacer brace and the tongue from the lower spacer brace extends upward into the extension from the upper spacer brace having a receiver aperture allowing the upper spacer brace to move laterally between spacer braces.

FIGS. 558-560 shows an elevation, enlargement and section of metal framing two spacers braces having the different width ends overlap each other where each longitudinal end has a receiver aperture and where a tongue extends upward or downward engaging both ends of the overlapping spacer braces and both lips notches can engage the aperture in the metal framing support.

FIGS. 561-563 shows an elevation, enlargement and section of metal framing is similar to FIGS. 558-560 except the lower spacer brace has the tongue extending upward into the receiver aperture in the web of the upper spacer brace with the web of the upper spacer brace having an extension with a notch to engage the side edges of the aperture in the metal framing support being continuous between other spacing braces.

FIGS. 564-566 shows an elevation, enlargement and section of metal framing where the spacer braces overlap the aperture in the metal framing support having the longitudinal ends being of different width where the lower wider spacer brace has the tongue extending upward from the web of the receiver aperture in the web of the upper spacer brace.

FIGS. 567-569 shows an elevation, enlargement and section of metal framing is similar to FIGS. 555-557 except the longitudinal ends has a web extension has an aperture for the tongue of the upper spacer brace to be inserted into and the upper spacer brace is allowed to swivel at the tongue and the width of the spacer braces can be equal or variable in width.

FIGS. 570-572 shows an elevation, enlargement and section of metal framing is similar to FIGS. 567-569 except the shape of the spacer braces are U-shape with bent flanges with flange notches in the longitudinal ends and having different widths when overlapping each other. Lips with notches can be installed at the longitudinal ends of flanges. The upper spacer brace has a web aperture for the tongue of the lower spacer brace to fit into. A protrusion is shown extending from the aperture side edges of the metal support member overlapping the upper spacer brace at the web. The spacer braces are installed with the wider longitudinal end being installed over the lower narrower width longitudinal end.

FIGS. 573-575 shows an elevation, enlargement and section of metal framing is similar to FIGS. 563-565 except the spacer braces being connected to the pair of slot holes with web notch at the web of the longitudinal end of the metal framing support with the lip notches engaging the web notches and the spacer brace fitting snuggly into the U channel base connecting adjacent metal framing supports.

FIGS. 576-578 shows an elevation, enlargement and section of metal framing that is similar to FIGS. 573-575 except the hook tongue with the extension and tongue connects to the upper spacer brace not at the metal framing support but anyway in between metal framing supports.

FIGS. 579-580 shows an elevation, enlargement and section of metal framing shows the same framing connection in FIGS. 573-575 however the U channel base is located at the ceiling rather than the floor and the configuration is reversed.

FIGS. 581-583 shows an elevation, enlargement and section of metal framing shows the same framing connection as FIGS. 573-575 however the reverse lip spacer brace has a reverse lip bracket with its flanges fitting over the overlapping connection and still having the notches of the bracket engaging the metal framing support.

FIGS. 584-586 shows an elevation, enlargement and section of metal framing shows the same framing connection as FIGS. 581-583 however the reverse lip spacer brace has the flanges extending upward from the web and has a reverse lip bracket fitting between the flanges with the notches of the bracket engaging the metal framing support.

FIGS. 587-589 shows an elevation, enlargement and section of metal framing shows a similar framing connection as FIGS. 564-568 however the lower spacer brace has an extension from the web with the tongue extending upward from the floor with the upper spacer brace having a receiver aperture with a rim ledge in the web for the tongue to wrap around the rim ledge with the upper spacer brace with its lip notches extending into the web notches in the metal framing support with the two spacer braces separate so the tongue can be rotated within the receiver aperture.

FIGS. 590-592 shows an elevation, enlargement and section of metal framing that is similar framing connection as FIGS. 587-589 however the lower spacer brace has a shorten extension at the tongue as there is not a rim ledge at the upper spacer brace.

FIGS. 593-595 shows an elevation, enlargement and section of metal framing uses a U shape spacer brace with flange notches having a T-shape rather than the L-shape previously described as the aperture has ledges that can be turned to face either direction therefore the T-shape notches has more flexibility when being installed.

FIGS. 596 & 597 shows an elevation and enlargement of metal framing where the two U shape spacer braces overlap each other with the flanges extending upward away from the web and where the flange notches extending into protrusions extending from the aperture at the metal framing supports with the flange notches engaging the underside of the protrusions. FIG. 598 appear the same, however the U shape spacer brace has the flanges extending into the bottom edge of the aperture in the metal framing supports and the flange notches have an additional horizontal notch where the horizontal notch extends into the ledges of the aperture in the metal framing support. In addition, protrusions extend from the hole side edges securing the U shaped spacer braces from moving vertically.

FIGS. 599-601 shows an elevation, enlargement and section of metal framing shows a W-shape spacer brace where the end of the flanges have a notch and where the notches extend into the bottom edge of ledges protruding from the hole side edges and where the spacer braces being of different widths to overlap and fit into adjacent W-shape spacer braces. On the other hand a reverse lip spacer brace can be used as the lower spacer brace fitting into the side edges of the metal framing support side edges with the W-shape clip fitting into the bottom edge of the ledges extending from the aperture of the metal framing support.

FIGS. 602-604 shows an elevation, enlargement and section of metal framing having a combination of several spacer braces as the shape is similar to a reverse lip spacer brace having bent flanges and where the flanges and the web have an acute angle that penetrates the aperture side edges with a hole notch and where the aperture side edges and the aperture bottom edge have another notch for the lip notches to extend into while the upper reverse lip spacer brace uses only the lip notches to engage the aperture side edges and the lower spacer brace has the extended web with an upward extending tongue to engage the opposing end of the adjacent spacer brace having a hole receiver in the web for the lower tongue to fit into.

FIG. 606 shows two adjacent reverse lip spacer braces having sloped flanges being of equal width and overlapping at the hole of a metal framing support. When this occurs the friction of the sloped flanges of the upper reverse lip spacer brace binds the slopped flanges of the lower reverse lip spacer brace together than the upper reverse lip spacer brace cannot fit tight against the lips leaving a gap between the webs and lips of both reverse lip spacer braces. On the other hand in FIG. 605 a light gauge material is used to form the reverse lip spacer braces and when a force like a hammer is applied to the web of the upper reverse lip spacer brace the flanges will bend outward as well as the lips requiring that the upper reverse lip spacer brace have deeper notches that extend into the flanges in order to secure the upper reverse lip spacer brace to the hole side edges.

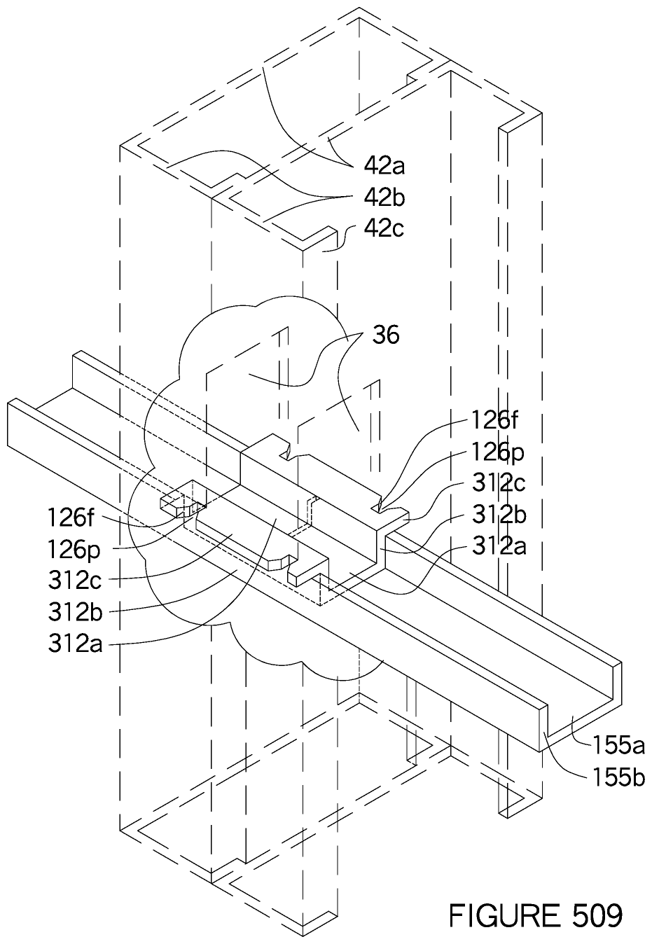

FIG. 605 shows an isometric drawing of a reverse lip brackets with lip notches extending into the hole side edges of two adjacent metal framing supports. The reverse lip brackets can also be overlapped as previously shown in other FIG's. In FIG. 509 the reverse lip brackets have been used to reinforce the U shaped bracing channel connection between two metal framing supports. When the reverse lip brackets are longer in length, the reverse lip spacer brackets are referred to as reverse lip spacer braces.

FIG. 607 & FIG. 608 show a U shaped spacer brace having flange gaps with web notches engaging the ledge or also referred to as the rim at a triangular hole where the bottom edge is shown as having a diagonal hole bottom edge that requires a long flange and a short flange to engage the back edge of the ledge and the front edge of the ledge being the front face of the hole in the metal framing support. Additional spacer braces can overlap each other as shown in FIGS. 593-596. FIG. 68 shows the flange having a lip where the lip notch engages the ledge.

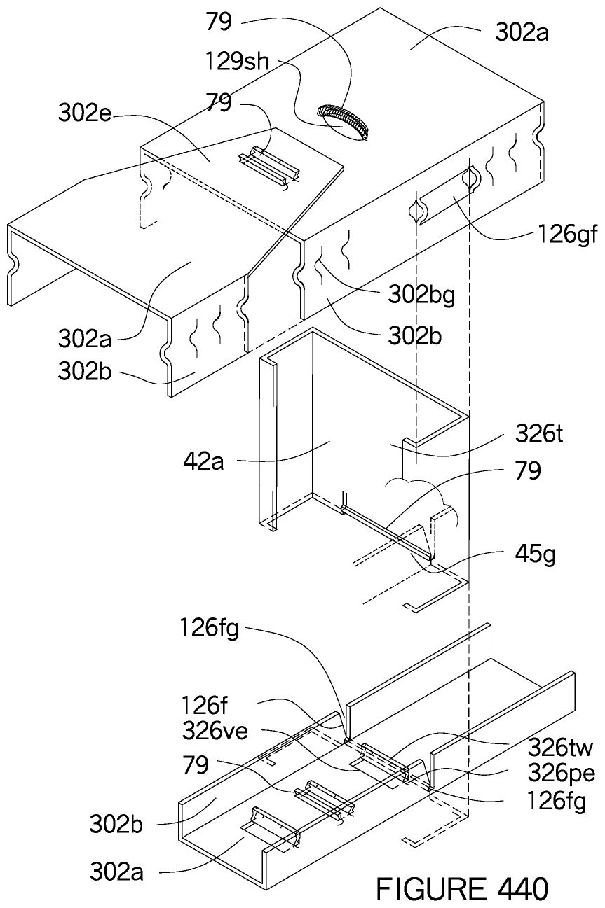

FIG. 609 is similar to FIGS. 440 & 588 where a receiver hole has a ledge and the ledge having a curvilinear shape and where a hook tongue having the tongue end wrap around the curvilinear shape of the ledge interlocking the two elements together and still allowing the hook tongue to rotate within the receiver hole.

FIG. 610 shows the reverse lip bracket spanning between two adjacent metal framing support members with the lip notches engaging the hole side edge being similar to FIG. 509 where the reverse lip bracket was spanning between two adjacent metal framing support nestled between the flanges of a U shaped channel also spanning in the holes between adjacent metal framing supports

FIG. 611 shows as similar configuration as FIG. 509 except the free edges of the lip at the reverse lip spacer brace are tapered and the web of the reverse lip spacer brace has a notched tab end in the punch out tab with the notched tab end extending into a slot hole at the web of the U shape channel, therefore interlocking the notched tab end into the slot hole of the U shaped channel and still being secured by the lip notches into the hole side edges.

FIGS. 1-FIG. 93—A DESCRIPTION OF THE PREFERRED EMBODIMENTS show metal support framing having longitudinal spacing-bracing members connecting metal support framing with rigid blocks between the metal support framing are shown having several types of spacer braces, more specifically the reverse lip space braces with lip notches overlapping other reverse lip spacer braces with notches or brackets with and without lip notches are shown connected to adjacent metal support framing.

FIG. 1 shows an isometric drawing of the structural insulating core 111 where the left side shows the wall assembled and the right side shows the various wall components separated. The right side shows the support channel as a C channel 42 with the longitudinal spacing-bracing channel shown as a horizontal reverse lip channel 156 passing through the hole 36 in the web 42a of the C channel 42. The horizontal reverse lip channel 156 has a lip notch 126p in the lip 156c as shown in the enlarged view of FIGS. 18 & 80 that secures the horizontal reverse lip channel 156 to the web 42a of the support channel. The lip 156c rests on top of the trough 132 formed in the middle of the foam spacer 55 and the flanges 156b fit into the trough 132 which is below the horizontal reverse lip channel 156 forming an electrical/mechanical chase within the trough 132. Another foam spacer 55 is shown above the horizontal reverse lip channel 156 where a horizontal tongue 55t of the foam spacer 55 fits between the flanges 156b and against the web 156a of the horizontal reverse lip channel 156. All the foam spacers 55 within FIG. 1 are shown deeper than the length of the web 42a of the support channel shown as a C channel 42 and extend beyond the flanges 42b. The foam spacers 55 all have a tongue shape 55a that fits between the lips 42c and abut the webs 42a of the C channels 42. The opposite side of the spacer block is referred to the groove side where a vertical projection 55vp is shown. The C channel 42 on the right has an indentation 42i in the web 42a so the vertical projection 55vp can fit into the indentation 42i of the C channel 42. The base plate 120 passes through the short foam spacer 55s and the base plate 120 has a vertical-flange notch 126vf in the flange 120b where the web 42b of the C channel 42 slides into the vertical-flange notch 126vf. The left side of FIG. 1 shows the wall panel consisting of the structural insulating core 111 assembled together with the rigid board 50 and rigid insulation 51 are the inner and outer rigid boards that define the outer surfaces. Since the foam spacers 55 extends beyond the flanges 42b of the C channel 42 a gap 45 is shown on both sides of the C channel 42 when the rigid board 50 and rigid insulation 51 is installed over the structural insulating core 111. Neither the rigid board 50 and rigid insulation 51 touches the C channel 42 leaving gap 45 function as a thermal break and therefore heat or cold are not transmitted directly through the C channel 42 also shown in the enlargement FIG. 18. The C channel 42 shown on the left does not have an indentation 42i in the web 42a of the C channel 42.

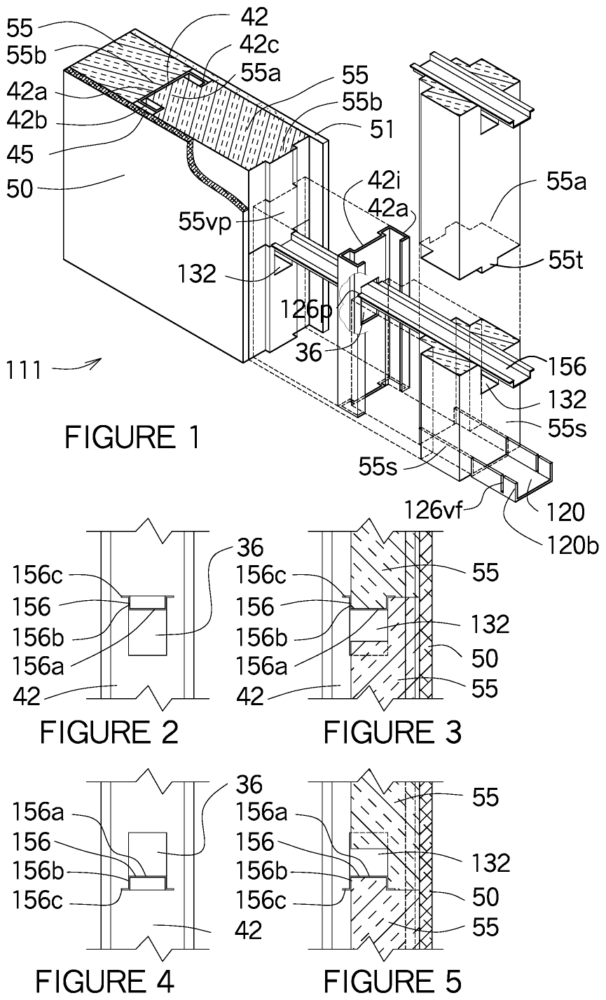

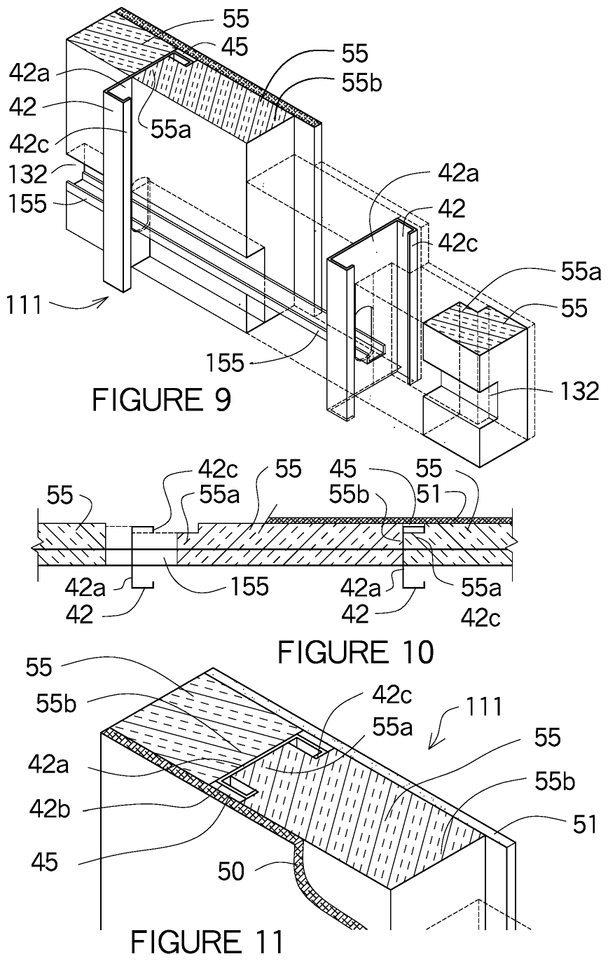

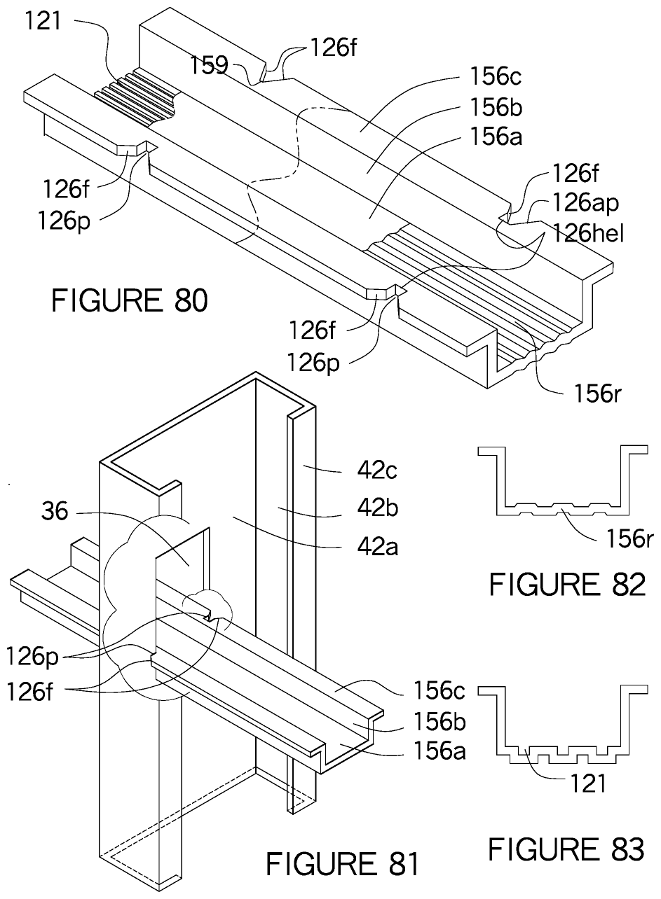

FIGS. 2-5 shows the longitudinal spacing-bracing member as a horizontal reverse lip channel 156 and used where the foam spacers 55 are not the full thickness of the C channel 42 as shown in FIGS. 9 & 10. FIGS. 2 & 3 show the longitudinal spacing-bracing member as a horizontal reverse lip channel 156 also shown in FIG. 80 where the flanges 156b and the web 156a form a U shape with the interior side facing up which is contrary to FIGS. 4 & 5 where the exterior side is facing upward with the web 156a is above and the flanges 156b and lip 156c are below or installed in reverse of FIGS. 2 & 3. When installing the horizontal reverse lip channel 156 with the interior side has U shape facing up, the hole 36 is below the exterior side of the horizontal reverse lip channel 156 and therefore the trough 132 is also below the horizontal reverse lip channel 156. Since the foam spacer 55 is not the full thickness of the C channel 42, the trough 132 is open on one side leaving the electric chase be exposed on one side. The foam spacer 55 extends past the C channel 42 as shown in FIG. 1 and the rigid board 50 is also installed on the structural insulating core 111. As explained above, the horizontal reverse lip channel 156 the interior side is facing downward leaving the hole 36 above the horizontal reverse lip channel 156. When the interior side of the horizontal reverse lip channel 156 is facing upward the horizontal tongue 55t is inserted into the U shape from the foam spacer 55 above, while if the U shape is facing downward the horizontal tongue 55t is inserted into the U shape from the foam spacer 55 below.

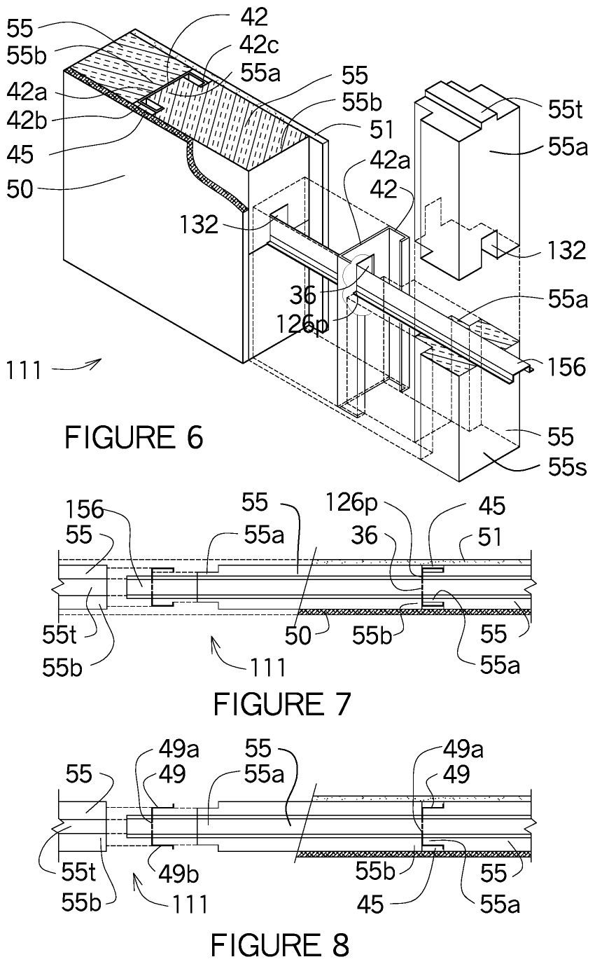

FIG. 6 is similar to FIG. 1 except the longitudinal spacing-bracing member shown as a horizontal reverse lip channel 156 is turned upside down, that is the exterior side of the web 156a is on top with the lips 156c extending downward to the bottom edge of the hole 36 in the web 156a. The foam spacer 55 is shown separated from the short foam spacer 55s below. When the foam spacer 55 is placed onto the short foam spacer 55s, the horizontal tongue 55t is on the top of the foam spacer 55 so the horizontal tongue 55t can fit into the U-shape and between the flanges 156b of the horizontal reverse lip channel 156 and the lips 156c rest onto the short foam spacer 55s below. The foam spacer 55 above the horizontal reverse lip channel 156 has a trough 132 that is equal to the web 156a of the horizontal reverse lip channel 156a and the flanges 156b fits into the trough 132 making a tight connection between the two and the remainder of the trough 132 above the horizontal reverse lip channel 156 is used as an electrical/utility chase. When passing through the web 42a of the C channel 42, the lip notches 126p in the lip 156c fit into the web 42a at the side edges of the hole in the support channels to form the structural insulating core 111. The foam spacer 55 is also wider than the support channel and extends beyond the flanges 42b of the C channel 42 as shown in FIG. 11. The assembled structural insulating core 111 is shown on the left side of the isometric drawing and the rigid board 50 and rigid insulation 51 is shown attached to the structural insulating core 111. Fasteners 37 can be installed through the rigid board 50 and rigid insulation 51 directly into the flanges 42b of the C channel 42 leaving a gap 45 between them. If the rigid board 50 and rigid insulation 51 was glued to the structural insulating core, the assembly would be consider a SIP known as a Structural Insulated Panel and could be manufactured into various lengths and heights.

FIG. 7 is a plan view of FIG. 6 which shows the relationship of the longitudinal spacing-bracing member shown as the horizontal reverse lip channel 156. The lip notch 126p is shown fitting between the web 42a of the C channel at the hole 36 therefore the lip notch 126p locks in the adjacent support channels shown as C channels 42. Since the horizontal reverse lip channel 156 is used, the foam spacer 55 has the horizontal tongue 55t on top of the foam spacer 55 so the horizontal tongue 55t can fit between the flanges 42b and against the web 42a. The plan view also show the foam spacer 55 interlocking into the C channel 42 and how the foam spacers 55 create the gap 45 when the foam spacers 55 fit into the C channel 42.

FIG. 8 shows the same plan configuration as FIG. 7 except a reverse lip support channel 49 is used as the support channel between the foam spacers 55. Since the lip 49c extends outward away from the web 49a or in an opposite direction of a C channel 42 shown in FIG. 7. The foam spacer 55 is wider than the depth of the reverse lip support channel 49 and slightly longer than the lip 49c so the rigid board 50 and rigid insulation 51 do not touch the reverse lip support channel 49. The web 49a is perpendicular to the flanges 49b so the rigid board 50 and rigid insulation 51 so fasteners can be attached to the flanges 49b.

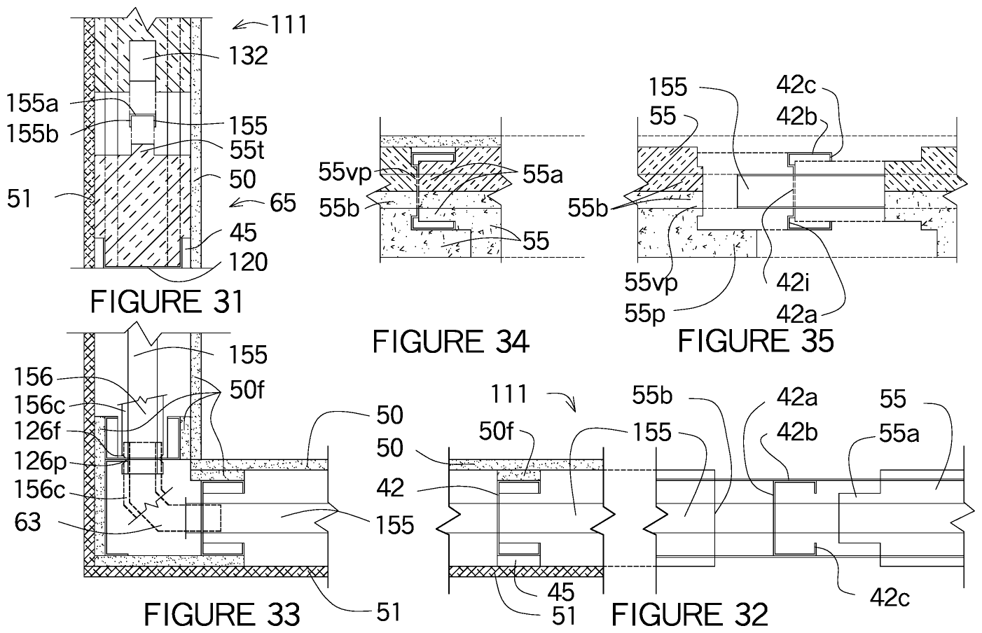

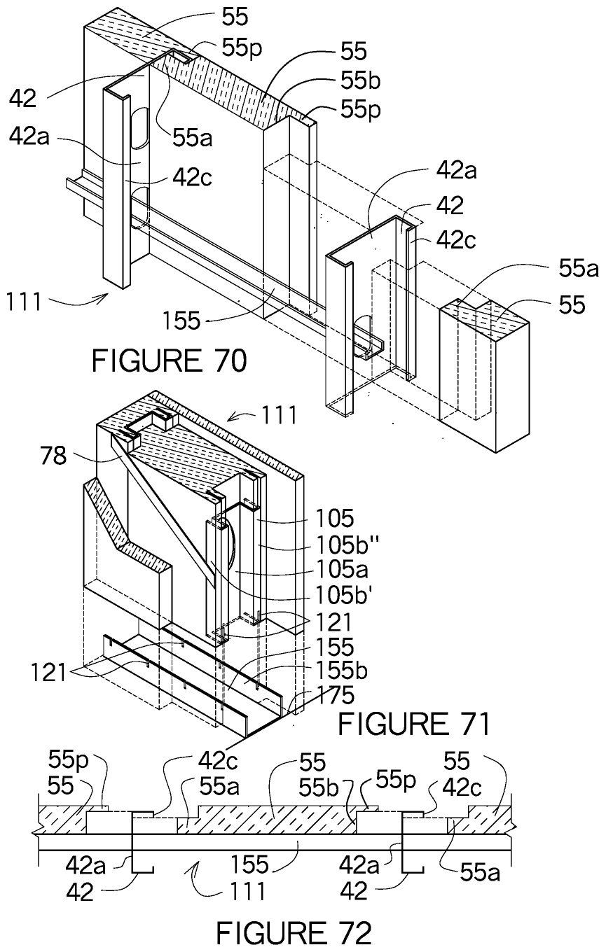

FIG. 9 shows an isometric drawing and FIG. 10 a plan view of a half wall where the foam spacers 55 do not extend the full width of the support channels shown as a C channel 42. The previously mentioned longitudinal spacing-bracing member showed lip notches 126p used to secure the member to the edges of the hole 36, however in FIG. 9 the horizontal U channel 155 passes through the holes 36 in the web 42a. The foam spacer 55 has a tongue shape 55a that abuts the web 42a and the lip 42c of the C channel 42. The width of the spacer block shown as foam spacers 55 extends over the hole 36 in the support channel and the other side extends past the flange 42b. The opposite end of the foam spacer 55 shows the groove shape 55b abutting the web 42a of the adjacent support channel and also extend over the hole 36 and past the flange 42b. The foam spacers 55 in FIG. 11 do not extend over the flanges on both sides of the C channel 42 form, but form gaps 45 when the rigid board 50 extends over the foam spacers 55. The exposed C channels 42 show the horizontally oriented trough 132 above the horizontal bracing channel shown as a horizontal U channel 155 open to the interior for easy access to the horizontally oriented trough 132 similar to FIGS. 70 & 72. The different configuration of the horizontal U channel 155 is shown in FIG. 31 which can be used in FIG. 9 to connect two spacer blocks together. By reversing the horizontal U channel 155 as shown in FIG. 31 the flanges 155b are shown below the web 155a which allows the horizontal tongue 55t from the foam spacer 55 below to interlock into the horizontal U channel 155.

FIG. 11 shows an enlargement of the structural insulating core 111 at the gap 45 shown in FIGS. 1, 6 & 9. The wall sections in FIGS. 2-8 shows the longitudinal spacing bracing channel as a horizontal reverse lip channel 156, but both the horizontal bracing channels have similar configurations.

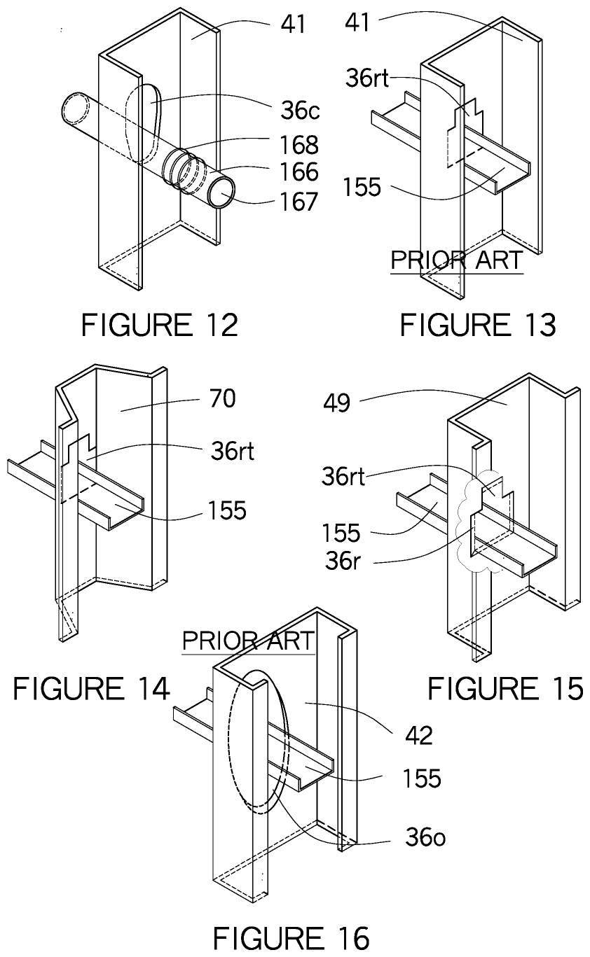

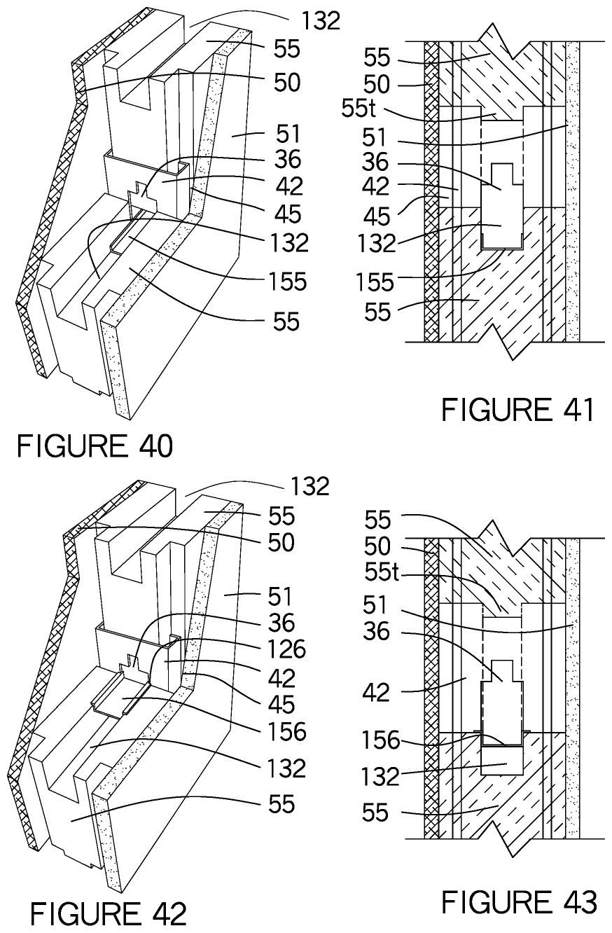

FIGS. 12-16 different support channels and different horizontal bracing channels. FIGS. 12 & 13 show U channels 41 as the support channel and FIG. 14 a hat channel 70, FIG. 15 a reverse lip support channel 49 and FIG. 16 a C channel 42. All the various support channels all serve the same function of supporting a wall panel. The holes 36 in the various support channels have different shapes to accommodate the shapes and function of the horizontal bracing channels. FIG. 12 shows a round hole 36c at the bottom of the hole 36 to accommodate the round rod 166 or a hollow tube 167. Both the round rod 166 or hollow tube 167 are shown having small ridges 168 that would engage the sides of the rectilinear hole 36rt. FIG. 13-15 show a rectilinear hole 36rt where the horizontal bracing channels are a horizontal U channel 155 or a longitudinal-spacing-bracing channel shown as a horizontal reverse lip channel 156 also shown in FIG. 18 & FIG. 40. FIG. 16 shows an oblong hole 36o where the horizontal U channel 155 just rests into the oblong hole 36o. FIG. 15 shows a rectilinear hole 36rt, however the side edges of the rectilinear hole 36rt have ledges 79. Some metal framing has holes 36 that have a ledge 79 around the edge shown as 79. The ledges 79 occur when the side edges of a hole 36 are large and the hole 36 side edges need additional strength, these ledges 79 can angle as much as a 45 degree angle causing the lip notches 126p explained in some later figures to be angled to accommodate the ledges 79. In FIG. 15 the ledges 79 make the rectilinear hole 36rt smaller and the horizontal U channel 155 is now supported by the ledges 79. The lip notches 126p in FIG. 81 would then be angled in order for the ledges 79 to be inserted into the lip notches 126p.

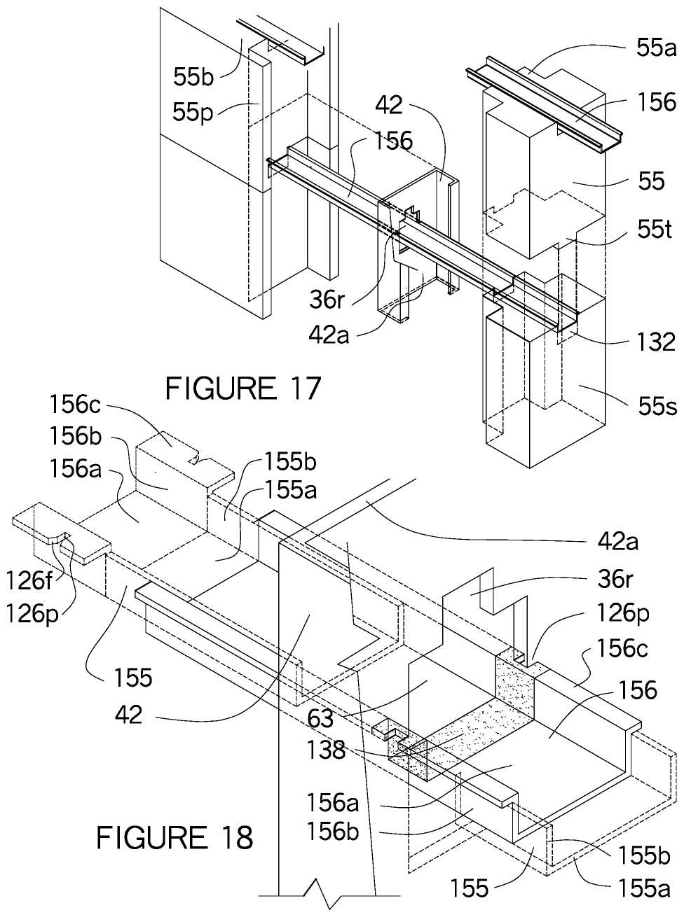

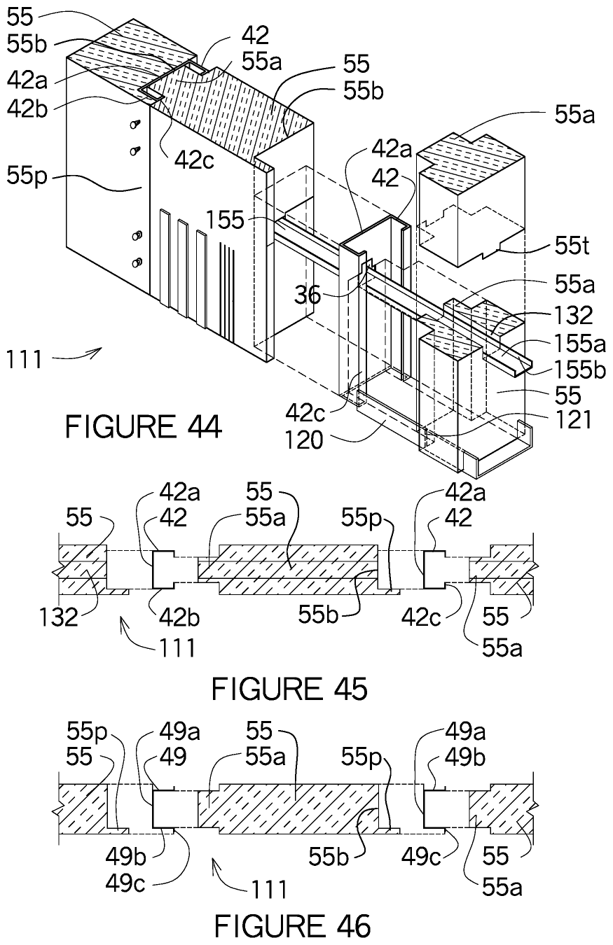

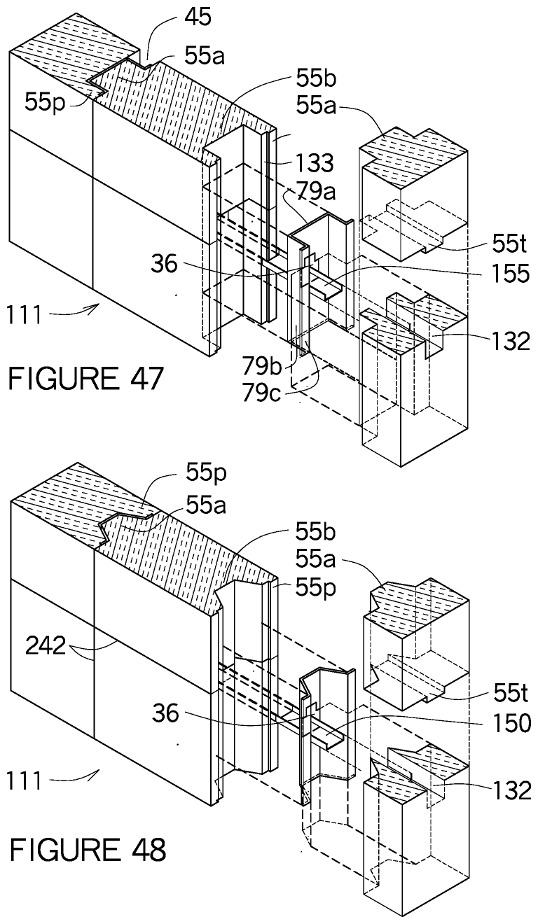

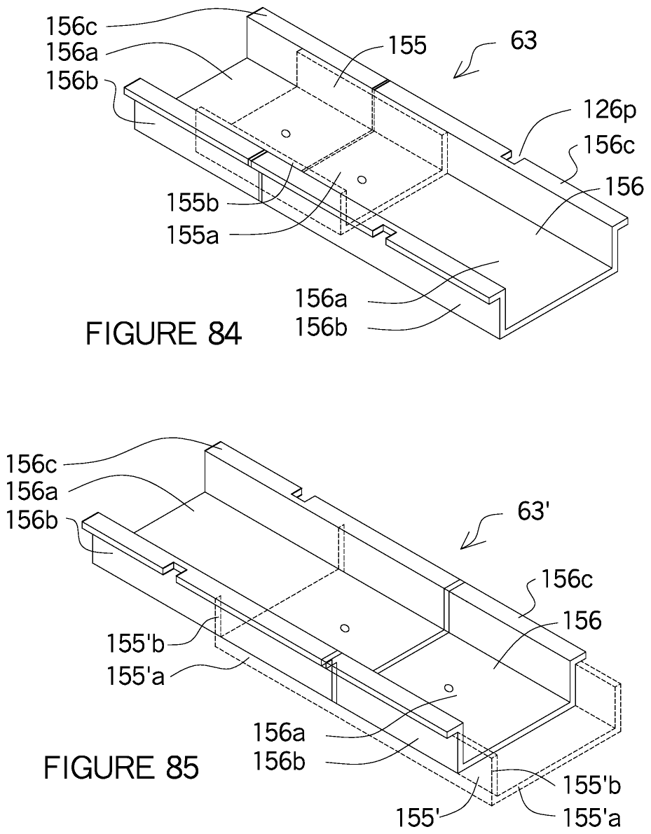

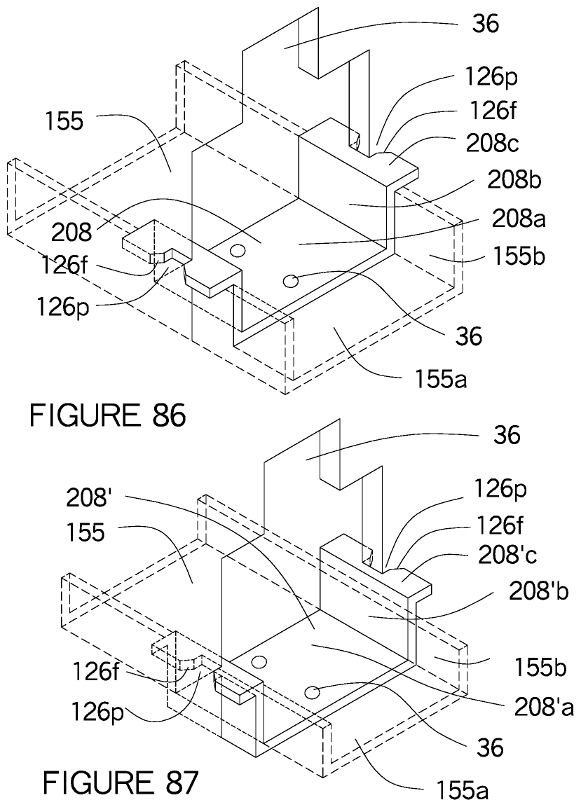

FIG. 17 is similar to FIG. 1 except the foam spacers 55 have projections 55p that overlaps the flanges 42b of the support channel shown as a C channel 42. Various other projections 55p are shown in FIGS. 44, 47 and 49. The longitudinal spacing-bracing member is shown as a horizontal reverse lip channel 156 with the exterior side of the lip 156c resting on the top of the short foam spacer 55s and the web 156a and flange 156b having the interior side fit into the horizontal tongue 55t and exterior side fit into the trough 132. An enlargement of the horizontal bracing channel 156 is shown in FIGS. 18 & 30 where the lip notches 126p fit into the web 42 through the rectilinear hole 36rt securing the foam spacer 55 with the C channel 42 to the horizontal reverse lip channel 156. An enlargement of the horizontal reverse lip channel 156 is shown in FIG. 18 with lip notches 126p that fit into the web 42 through the rectilinear hole 36rt securing the foam spacer 55 with the C channel 42 to the horizontal reverse lip channel 156. The horizontal reverse lip channel 156 does not have to span between multiple support channels, but can be shorter in length and installed as a multi-plane bracket 128 also shown in FIGS. 86 & 87 or as a coupling 63 also shown in FIGS. 84 & 85.

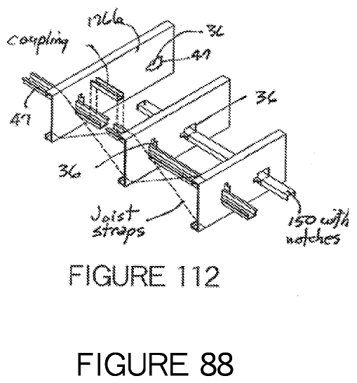

FIG. 18 shows how the reverse lip channel 156 can be connected to another horizontal bracing channel either using a horizontal U channel 155 or a horizontal reverse lip channel 156. similar to FIGS. 88 & 89. The lip notches 126p in the lips 156c are the key elements to secure the horizontal bracing members to the hole edges without using fasteners (not shown). It's like clothing you can mix and match. An installer can use a reverse lip channel 156 having vertical longitudinal flanges with another reverse lip channel 156 having angular longitudinal flanges 156b both have lip notches 126p, but the hole 36 is smaller than the width between lip notches, so the lip notches 126p have be cut to provide a deep lip notch 126p and continued in to the flanges 156b referred to as a flange notch 126fg. In another case the hole 36 in the support member is too large, then a coupling 603 or a bracket size with wider lips 156c with lip notches 126p to be installed into the hole side edges 36se at the support member. The stacked reverse lip channels 156 are then just fasten together with fasteners (not shown). Sometimes the reverse lip channels 156 are facing downward with the lips 156c against the hole bottom edge 36be, then the bracket or coupling would be fitting over the widest distance between flange 156b along with wider lips 156c and deeper lip notches 126p. There are probably 20-40 different variations of that connection when changing the hole configuration, the hole size and a number of other factors. Whether the horizontal bracing channel is a U channel 155 or a reverse lip channel 156 channels are installed into the hole 36 at an angle so the flanges 155b can fit tight against the hole side edges 36se or the lip notch 126p can be installed into the hole side edges 36se at the lip 156c on one side, then continually rotate the horizontal bracing channel to align with the lip notch 126p on the opposite side. In FIG. 18 the horizontal reverse lip channel 156 is shown as a coupling 63 that is secured to the web 42a of the support channel by lip notches 126p and connects to two other horizontal bracing channels 155 (shown dotted) on either side of the horizontal reverse lip channel 156. The horizontal U channel 155 on the left side rests on the web 156a and between the flanges 156b and is connected to the coupling 63. The opposed end of the coupling 63 shows another horizontal U channel 155 installed under the coupling 63 so the web 155a and flanges 155b are on the inside of the coupling 63 shown as a horizontal reverse lip channel 156. A coupling 63 connects two horizontal bracing channels, however this same horizontal reverse lip channel 156 can be a multi-plane bracket 128. A multi-plane bracket 128 functions differently than a coupling 63. A horizontal bracing channel shown as a horizontal U channel 155 passes through the hole 36 of the support channel on to another support channel and the multi-plane bracket 128 fits over the horizontal U channel 155 and the lip notches 126p of the multi-plane bracket 128 fit into the holes 36 of the support channel. The multi-plane bracket 128 is shown shaded to differentiate between the coupling 63 and the multi-plane bracket 128 which is shorter in length. The multi-plane bracket 128 fits into and between the flanges 155b and web 155a of the horizontal U channel 155. The coupling 63 and multi-plane bracket 128 can be used with the flanges 156 facing upward or downward. On the far left a U channel 155 is shown installed inside a reverse lip channel 156 between the flanges 156b and the lips 156c. with the lip notches 126p are installed at the hole side edges 36se. and secured by fasteners (not shown). Instead of installing the U channel 155 another reverse lip channel 156 can be install between the flanges 156c if the reverse lip channel is slightly smaller or the flanges 156b are angled and secured to the hole side edges 36se with lip notches 126p. The lip notches 126p secure the horizontal bracing channels to the support members and by changing sizes, shapes, orientation there are probably 50 different solutions which is impossible to display into this application, but still very easy for competitors to see all the alternative solutions.

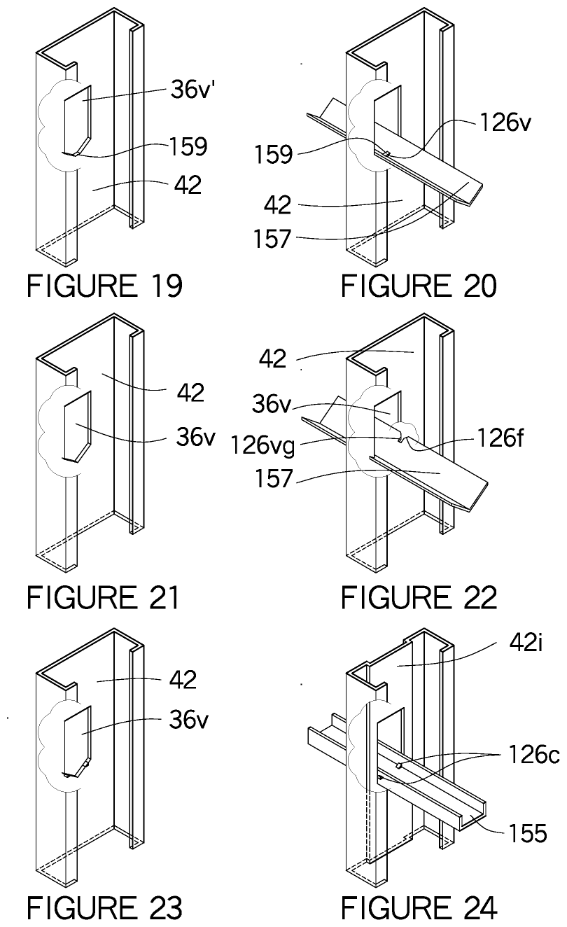

Referring to FIGS. 19-20, the support channel, also known as a C channel 42, has a V-shaped hole 36v with the bottom edge having V-shaped bottom walls ending in a blunt end 159 which is adapted to receive longitudinal spacing-bracing member shown as a horizontal V channel 157. The width of the horizontal V channel 157 is slightly less than the width of V-shaped hole 36v and the horizontal V channel 157 slides right into the V-shaped hole 36v. The bottom of the horizontal V channel 157 has two or more spaced apart vertex notches 126v in the vertex of the member. The vertex notches 126v receive the blunt end 159 of the member to prevent horizontal movement of the horizontal V channel 157 within and between support channels. The vertex is the point of intersection of the two sides of the horizontal V channel 157.

Referring to FIGS. 21-24, the support channel also known as the C channel 42, has a V-shaped hole 36v with V-shaped bottom walls adapted to receive the longitudinal spacing-bracing member shown as a horizontal V channel 157. The width of the horizontal V channel 157 is slightly less than the width of V-shaped hole 36v and the width of the horizontal V channel 157 is larger than the width of V-shaped hole 36v. The horizontal V channel 157 has v-leg notches 126vg spaced along the diagonal side walls of the horizontal V channel 157 that extends inward from the edges. The distance between the closest ends of each pair of v-leg notches 126vg being less than the width of the V-shaped hole 36v. The horizontal V channel 157 is received within V-shaped hole 36v by rotating the horizontal V channel 157 longitudinally.—The height of the diagonal side walls are usually the same but can vary if the angle of the V-shaped is different. When the v-leg notches 126vg are aligned with the wall of the web of C channel 42, the horizontal V channel 157 is turned 90 degrees with the vertex of the member pointing downward. The side edge of the hole at the web 42 of the C channel 42 receives the v-leg notches 126vg; this secures the horizontal V channel 157 with the C channel 42.

Still referring to FIG. 21-24, the support channel shown as C channel 42 having an indentation 42i, but has an indentation at the web 42a for strengthening. This feature is optional in the present invention. The V-shaped hole 36v in indentation 42i is identical to the V-shaped hole 36v in support channel 42 (See FIGS. 21-23). The support channel being a C channel 42 receives horizontal U channel 155. The horizontal U channel 155 has corner notches 126c located on the corners where the flanges 155a and web 155b intersect. The corner notches 126c in each corner are opposite one another. The corner notches 126c engage the wall of the web 42a at the point where the bottom edge of the hole wall angles inward to form the V. This engagement prevents the support channel from moving horizontally.

Many of the previous figures show several support channels and the longitudinal spacing-bracing member having various notches engaging the V-shaped hole 36v in the adjacent support channels. FIGS. 21 & 23 both show the pointed configuration in the V-shaped hole 36v at the bottom of the V-shaped hole 36v. The horizontal V channel 157 rests in the pointed configuration of the V-shaped hole 36v and the V-leg notches 126vg & corner notches 126c engage into the V-shaped hole 36v. FIG. 22 also have the exterior side of an elongated V-shape body in cross section having first and second longitudinal walls joined at the vertex of the V-shaped body. The exterior side fits into the V-shaped hole 36v having the same oriented configuration however the V-leg notches 126vg occur at the side edges of the longitudinal sides of the V-shaped body. The V-leg notches 126vg have a flare 126f at the side edges which is wider than the V-leg notches 126vg in order for the side edges of the V-shaped hole 36v to slide into the V-leg notches 126vg easier. The wider the opening of the flare 126f the easier the V-leg notches 126vg have in engaging the side edges of the V-shaped hole 36v. FIG. 24 shows the longitudinal spacing-bracing member as a horizontal U channel 155 having an elongated web 155a with first and second longitudinal wall edges being connected and extending upward away from the web 155a forming first and second longitudinal walls are shown as flanges 155b forming a U-shape. When the horizontal U channel 155 is inserted into a V-shaped hole 36v, corner notches 126c in the web 155a and the flanges 155b form continuous corner notches 126c between the longitudinal web 155a and the longitudinal walls of the flanges 155b at the corner notches 126c. The bottom side edges that extend from the V-shaped holes 36v penetrate the corner notches 126c from the exterior side and extend into the interior side of the horizontal U channel 155. A reverse lip channel 156 with lip notches 126p can be used instead of the horizontal U channel 155 for additional horizontal support at the support channels. FIG. 23 indicates where the corner notches 126c from the horizontal U channel 155 would set on the bottom edges of the V-shaped hole 36v.

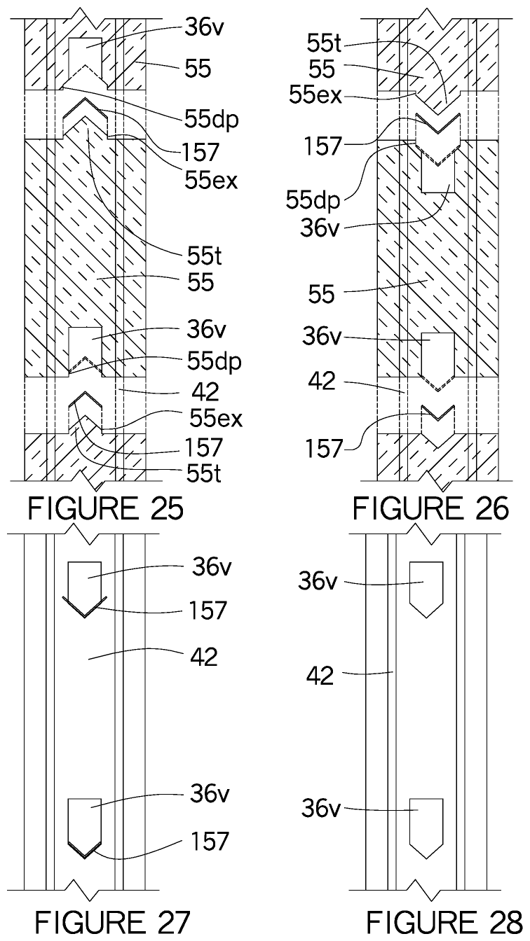

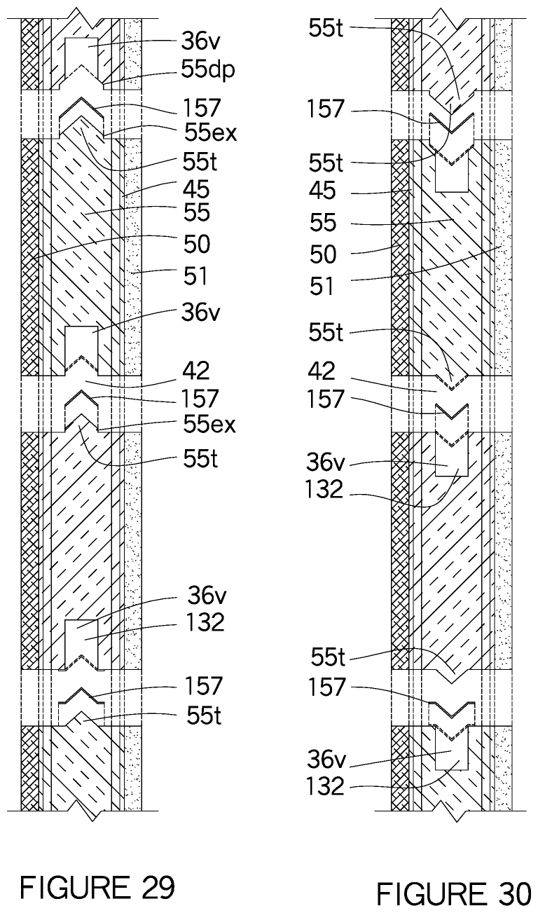

FIGS. 25-30 show different variations locations of the V-shaped hole 36v and the foam spacers 55. FIGS. 25 & 29 shows the horizontal V channel 157 shown with the interior side configuration pointing upwards. When the pointed configuration is pointed upward, the trough 132 is above the horizontal V channel 157 and the horizontal tongue 55t is also pointed and fits into the horizontal V channel 157. The horizontal tongue 55t has a foam extension 55ex to the horizontal tongue 55t to form a better interlocking fit between two foam spacers 55. The trough 132 is shown rectilinear with a trough depression 55dp to accommodate the horizontal tongue 55t has an foam extension 55ex, however a pointed configuration could also be used in the V-shaped hole 36v and within the foam spacer 55. The upper horizontal tongue 55t is wider to accommodate the V-leg notches 126vg in the horizontal V channel 157, however the trough 132 is narrower to fit the size of the V-shaped hole 36v. FIG. 28 shows the V-shaped hole 36v with the pointed configuration pointing downward and FIG. 27 shows the horizontal V channel 157 in two sizes, that is the larger horizontal V channel 157 having corner notches 126c and a bent flange in FIGS. 29 & 30. Elderson at ClarkDietrich has many patent variations of the V channels 157 with notches 126 and overlapping channels that are shown in this applications, where the horizontal V channels 157 has the V-shape pointing upward, while the LeBlang application shows the hole bottom edge 36be having different shapes as well as the vertex of the V channels 157. FIG. 26 shows both sizes of the horizontal V channels 157 being installed in the foam spacers 55. When the horizontal V channels 157 have the pointed configuration pointing downward, the trough 132 is better when installed below the horizontal bracing channel 157 so the horizontal tongue 55t can fit into the horizontal V channel 157. The horizontal V channel 157 in the lower wall section shows a bent flange with a V-leg notches 126vg on the horizontal V channel 157. When using that configuration the horizontal tongue 55t fits into the V configuration of the horizontal V channel 157, however a foam extension 55ex is not used making the connection between spacer blocks less secure.

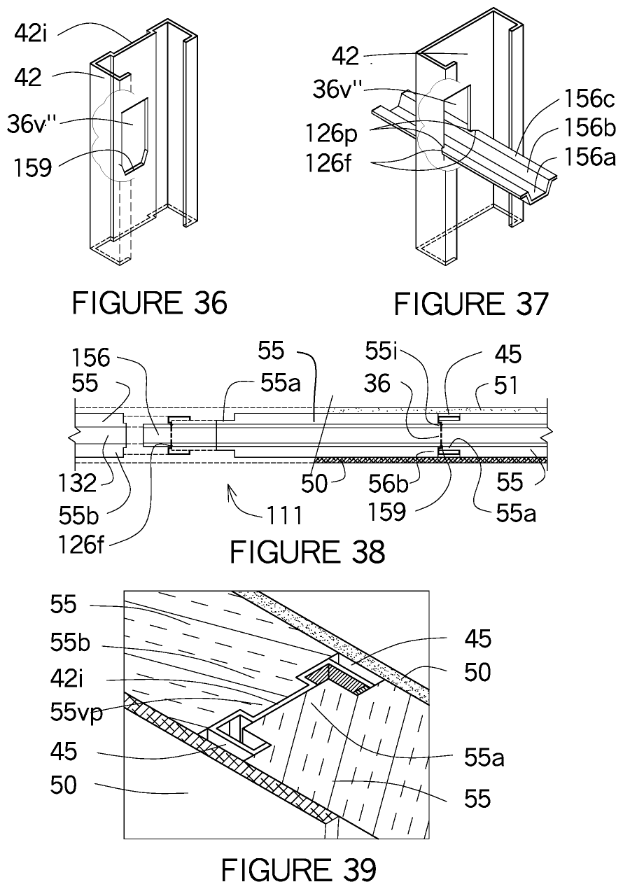

FIGS. 31-39 shows the support channel with an indentation 42i in the C channel 42 allowing for a better connection at the tongue shape 55a and groove shape 55b in the foam spacers 55. FIG. 31 shows a wall section using the a horizontal U channel 155 with the web 155a and flanges 155b having its interior sides facing downward over the horizontal tongue 55t in the lower foam spacer 55 with the trough 132 in the upper foam spacer 55. The rigid board 50 and rigid insulation 51 are shown on both sides of the foam spacer 55 as shown in FIG. 1. The base plate 120 is shown attached to the flanges 42b of the C channel 42 leaving a gap 45 between the inner and outer boards. FIGS. 32 & 33 shows a plan view of the wall panel and the gap 45 that is formed when the foam spacer 55 extends past the C channel 42 and the rigid board 50 and rigid insulation 51 are attached to the foam spacer 55. FIG. 33 shows a rigid board filler 50f attached to the flanges 42b of the C channel 42 in the area occupied by the gap 45 at the corner of where two wall panels intersect in order to make a more solid connection. A coupling 63 or the connection between stacked horizontal reverse lip channel 156 or horizontal U channels 155 can be a smaller or larger in size as shown on the right side or as a horizontal reverse lip channel 156 either used as a connection between straight member or at corners, that are angled or L-shaped and fits between the flanges when fitting over or under a horizontal spacing-bracing channel. The connection between two different widths of reverse lip channels 156, the reverse lip channels 156 can have the longitudinal ends of a connecting reverse lip channel 156 have two different sizes or shapes of longitudinal ends to fit into the different sized reverse lip channels 156. The coupling 63 can be square shaped a rectilinear appearance, angular (as shown) or curved in order to make a direct connection between the two wall panels. In addition, when the horizontal reverse lip channel 156 are connecting two adjacent support members, the lip notches 126p will have to be cut or trimmed wider to accommodate both support members. There are many ways to manufacture a curved U-shaped channel 155 or reverse lip channel 156 including the curved web, side walls and lip configurations. FIG. 35 shows two different half sections of the foam spacer 55 with each half section shown as two different materials. In addition, one side of the foam spacer 55 has the foam spacer 55 extending past the flange 42b causing a gap 45 as shown in FIG. 11 and the opposite side of the foam spacer 55 shown with an a projection 55p and the foam extension 55ex at the groove shape 55b as well as a vertical projection 55p. The vertical projection 55vp projects from the foam spacer 55 into the indentation 42i of the C channel 42. FIG. 36 shows an indentation 42i in the web 42a of the C channel 42 with a V-shaped hole 36v″. The V-shaped hole 36v″ has a larger blunt end 159, however the blunt end 159 is different than in FIG. 19 as the blunt end 159 and the angular side edges of the V-shaped holes 36v″ are used to support the longitudinal spacing-bracing member shown as a horizontal reverse lip channel 156 having an elongated web 156a with first and second angular edges being connected and extending away from the web 156a forming first and second longitudinal walls are shown as flanges 156b in FIG. 37. The flanges 156b can also be bent inward with longitudinal lips extending away from longitudinal walls, is shown in other patent pending applications but not shown in this application. The free side edges of the lips 156c have notches 126 cut inward from the free side edges. At the free side edges of the lips 156c a flare 126f is shown at the lip notch 126p to form a wider opening into the lip notch 126p. The horizontal reverse lip channel 156 is shown passing through a V-shape hole 36″ having the bottom edge or blunt end 159 parallel to the web 156a of the longitudinal spacing-bracing member where the side edges of the two lip notches 126p are resting on both side edges of the hole 36 at the web 42a. FIG. 24 shows the web 156a horizontal to the lips 156c with the flanges 156b having angular side edges similar to/the V-shaped hole 36v within the support channels. As shown in the previous figures the longitudinal spacing-bracing members connect support channels together whether installed as a continuous longitudinal spacing-bracing member or stacked upon each other when connecting to the same support member. The longitudinal spacing-bracing member with angular flanges can be stacked between the vertical flanges 156b of a rectilinear longitudinal spacing-bracing member having more vertical flanges 156b and having a checker board pattern of installation always installing the angular flange 156b between the more vertical flanges 156b. FIGS. 38 & 39 show the wall panel and an enlargement of the gap 45 with the indentation 42i in the C channel 42 along with the rigid board 50 and rigid insulation 51. The plan view in FIG. 38 also showing the lip 156 having the flares 126f on both sides of the lip notches 126p when intersecting the at the hole 36.

FIGS. 40 & 41 show and enlarged view of the horizontal bracing channel shown as a horizontal U channel 155 fitting into the bottom of the trough 132 and the hole 36 in the support channel shown as a C channel 42. The foam spacers 55 are shown with the gap 45 between the C channels 42 and the rigid board 50 and the rigid insulation 51. The horizontal tongue 55t fits into the trough 132 in FIG. 41 but when the longitudinal spacing-bracing member shown as a horizontal reverse lip channel 156 in FIG. 43 the horizontal tongue 55t fits into the interior side of the horizontal reverse lip channel 156. When using the horizontal reverse lip channel 156 the trough 132 is best located below the horizontal reverse lip channel 156 in order to have the horizontal tongue 55t fit between the flanges 156b for a snug fit.

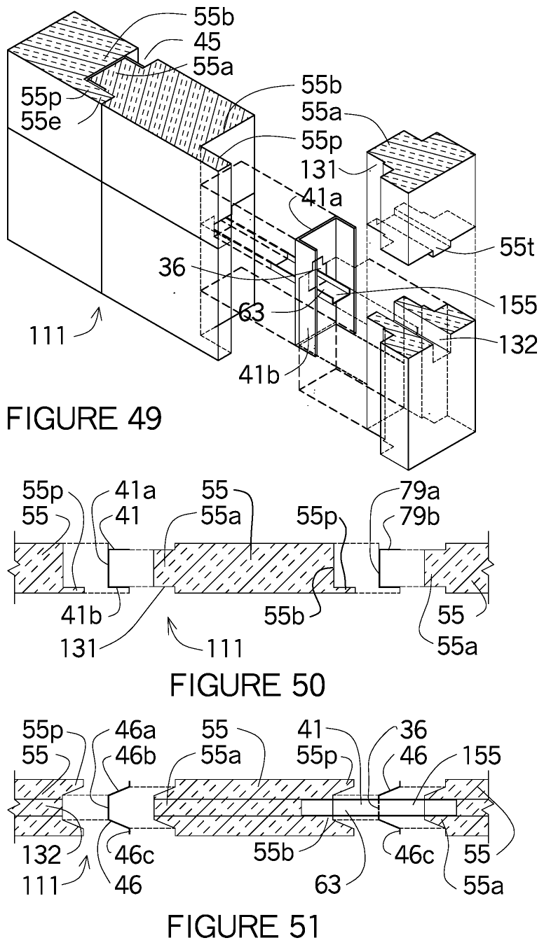

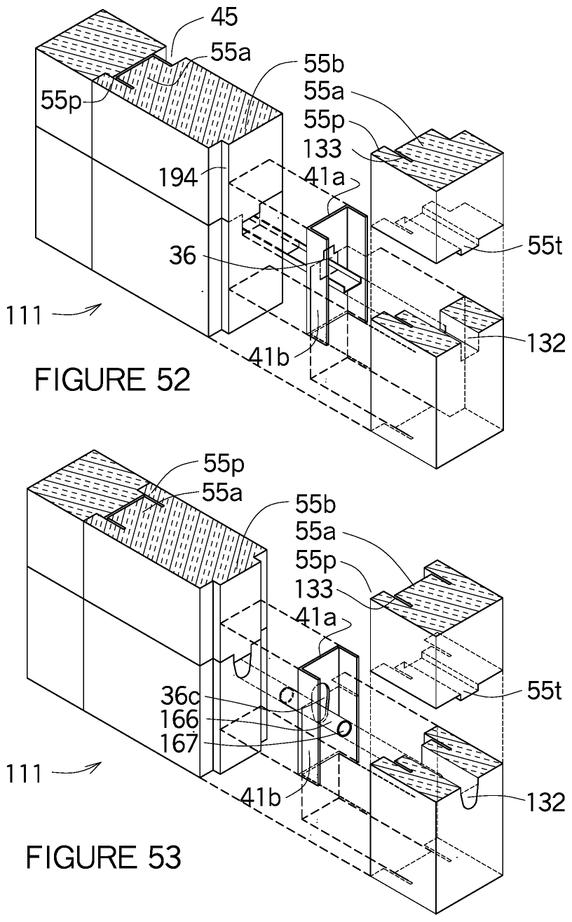

FIGS. 44-53 shows various structural insulating cores 111 with projections extending over one flange of the support channels similar to the projections shown in FIGS. 34 & 35. In FIGS. 44 & 45 the projection 55p extends over the flange 42b of the C channel 42, but stops at the end of the flange 42b by the lip 42c. The base plate 120 has a groove 121 in the foam spacer 55 for the flange 120b of the base plate 120 fits over the flange 42b of the C channel 42. FIG. 45 shows a plan view of FIG. 44, showing the trough 132 at the top of the foam spacer 55. FIGS. 46 & 47 show a plan view and isometric view of the support channel as a reverse lip support channel 49 where the projection 55p stops at the lip 49c and the opposite side has no projection. FIGS. 48 & 51 show an isometric view and a plan view of the hat support channel 70 as support channels. The hat support channel 70 and the reverse lip support channel 49 have a lip 70c & 49c where the projections 55p overlap the support channels. The hat support channel 70 works well if the spacer block is load bearing like a concrete block since the sloped slides do not allow drywall or other rigid boards 50 and rigid insulations 51 (not shown) to be fastened to the hat channel 70. Since the support channel and horizontal bracing channel interlock with each other, the foam spacers 55 can be installed with or without mortar 242 between the foam spacers 55. FIG. 51 shows a horizontal bracing channel overlapping both foam spacers 55 and secures the support channel shown as a hat channel 70 interlocking all three together. FIGS. 49 & 50 shows the projection 55p extending over the flange 41b and to the indentation 41i of the adjacent spacer block. The projection 55p is shown on the groove shape 55b of the foam spacer 55 like as shown in FIGS. 34 & 35. FIG. 52 shows the groove shape 55b and the projection 55p on the same side of the foam spacer 55 and FIG. 53 shows the projection 55p on the opposite side of the foam spacer 55. FIG. 53 shows round hole 36c with the horizontal bracing channel shown as round rod 166 along with the trough 132 conforming to the round rod 166 where the rides shown in FIG. 12 interlock the support channel, round rod 166 or hole tube 167 and foam spacer 55 interlock together.

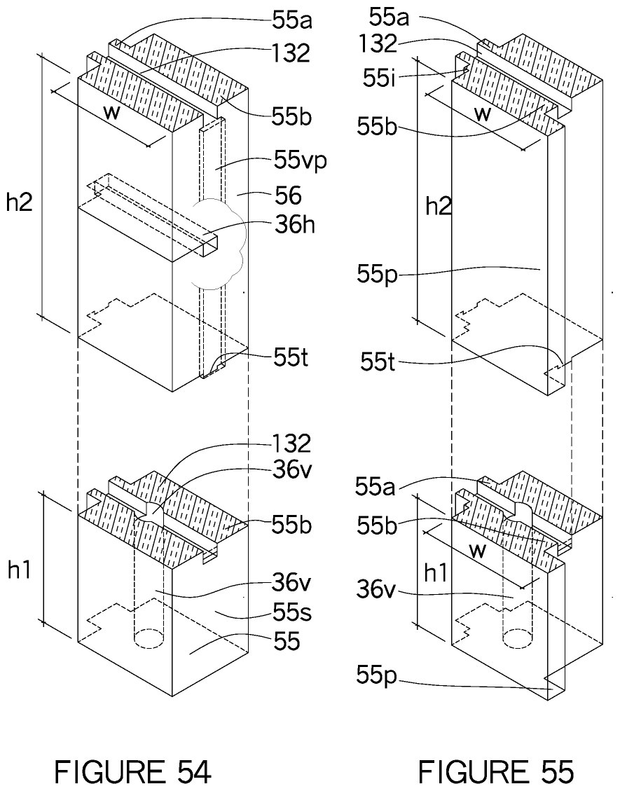

FIGS. 54 & 55 shows enlarged views of the foam spacer 55 and the short foam spacer 55s. FIG. 54 shows the foam spacer 55 with no projections so the foam spacer 55 extends past the support channels so a gap 45 (not shown) is between the support channels. The vertical projection 55vp of the foam spacer 55 extends into the indentation 42i of the C channel 42. FIG. 55 shows the projection 55p on one side of the foam spacer 55 and a foam indentation 55i on the opposite side allowing the projection 55p to fit into an adjacent foam spacer 55. Both FIG's the width W is the distance between adjacent foam spacers 55 blocks 56 and the height h1 and h2 show the height of each foam spacer 55 & 55s. Both FIGS. 54 & 55 show a V-shaped hole 36v in the short foam spacers 55s.

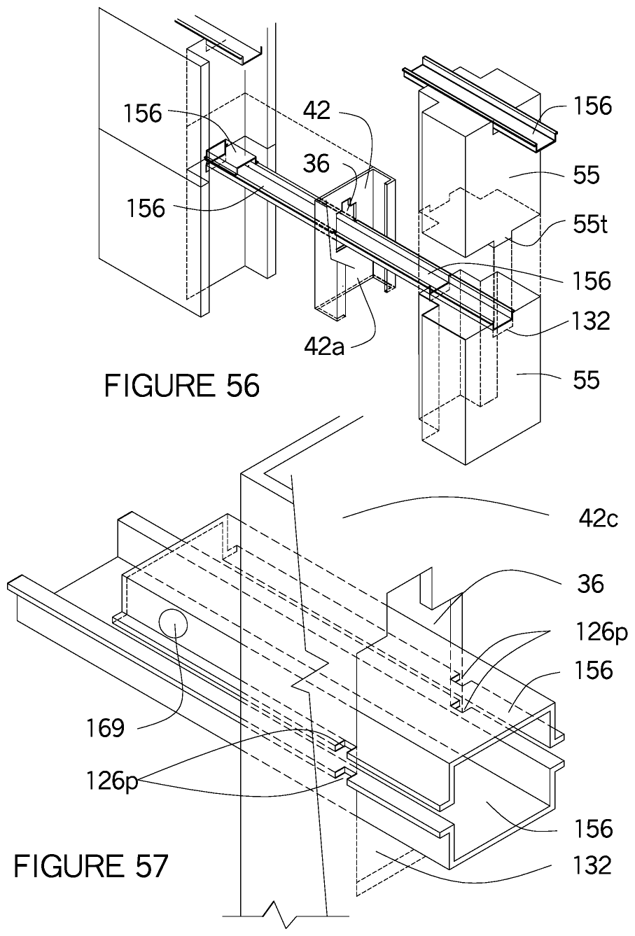

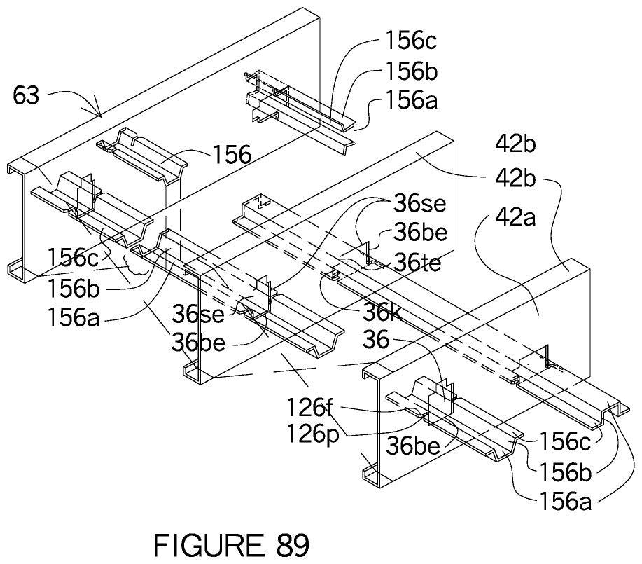

FIG. 56 shows foam spacer 55 connected by a longitudinal spacing-bracing member and the support channel shown as a C channel 42 with a hole 36. The longitudinal spacing-bracing member is shown as a horizontal reverse lip channel 156 where the exterior side of the web 156a fit into the trough 132 with the flanges 156b abutting the sides of the trough 132 and the lips 156a resting on top of the foam spacer 55 so the horizontal reverse lip channel 156 is facing upwards so the flanges 156b and the web 156a form are exposed forming a U shape with the lip notches extending on both side planes at the hole 36 in web 42. In FIG. 57 another horizontal reverse lip channel 156 is installed upside down over the first horizontal reverse lip channel so the lips 156c abut each other and their respective lip notches 126p are touching each other forming a cover over the first horizontal reverse lip channel 156. The top horizontal reverse lip channel 156 shows a punched hole 169 so electric conduits (not shown) can be attached. In addition, the upward facing reverse lip channel 156 can be installed between several support member and the next reverse lip channel 156 is installed downward between several support members. As shown in FIG. 37 a reverse lip channel 156 with its angular longitudinal sides or flanges 156b can also be installed within the upward facing reverse lip channel 156 also shown in FIG. 89. In FIG. 33 shows a plan view with over two horizontal bracing-spacing member crossing at the hole 36 in the support member. Many different variations of the horizontal spacing-bracing member can be combined to make; a V-shape with lip notches, a U shape angled with lip notches, a U shape with lip notches, and a horizontal spacing member with angled flanges fitting into a V shape with lip notches. The hole openings are manufactured in three different sizes causing the flanges to have flange notches 126f along with lip notches 126p, plus the web 156a. Longitudinal walls and lips can have multiple sides when creating grooves or ribs plus the reverse lip channel can be installed right side up or upside down.

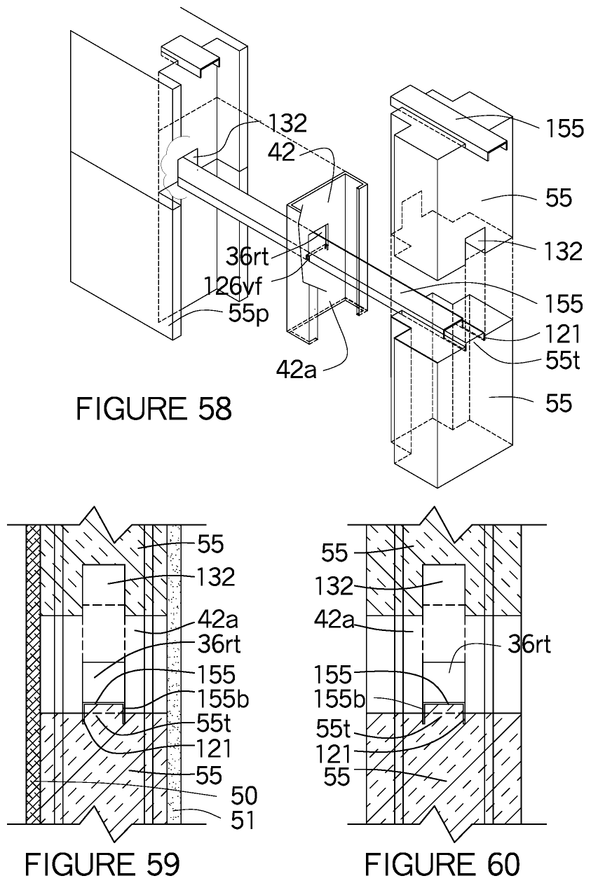

FIGS. 58-60 shows a horizontal bracing channel as a horizontal U channel 155 facing downward as shown in FIG. 31-33 however here the flanges 155b have vertical-flange notches 126vf fit into the bottom edge of the rectilinear hole 36rt. A groove 121 is installed adjacent to the horizontal tongue 55t so the flanges 155b can fit into. The trough 132 is above the horizontal bracing channel and is large enough for the horizontal U channel 155 can fit into. FIG. 59 show the wall section with the inner and outer walls shown as rigid board 50 and rigid insulation 51 and FIG. 60 is shown with the projections 55p.

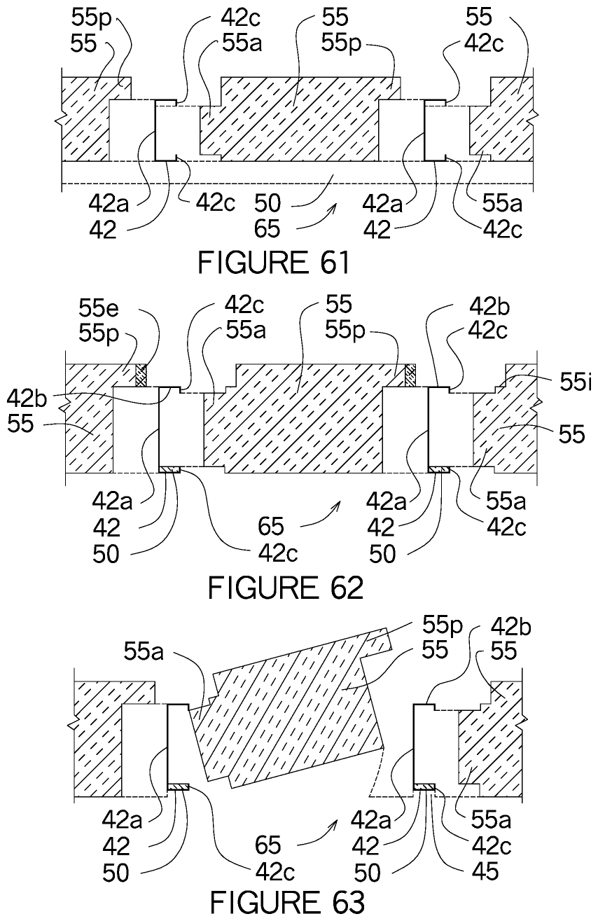

FIG. 62 is a roof section or a wall section of the structural insulating core 111 shown in FIGS. 9, 10 & 34 and is similar to the plan view shown in FIG. 61 except the C channels 42 are shown horizontally where a floor joist or ceiling joist application would require deeper web 42a, since the structural capacity of the C channels 42 would typically require to have a greater strength. In FIG. 62 the wall panel 65 shows the foam spacer 55 to be the full depth of the C channels 42 and the foam spacers 55 fits against the webs 42a and against the lip 42c and rests on the rigid board 50. The opposite side of the foam spacers 55 rests against the web 42a of the adjacent C channel 42 and above the flanges 42b. FIG. 61 also shows that the projection 55p is longer similar to FIG. 58 where the foam extension 55ex is shown and is shown extending longer than the width of the flange 42b forming a greater thermal break in the foam spacer 55 and the C channel 42. The support channel in the structural insulating core can be formed with wood blocking 72 or the C channel 42.

FIG. 63 is the same section as FIG. 62; however the bottoms of the foam spacers 55 are shown deeper than the C channels 42. The additional depth of the foam spacers 55 forms a gap 45 between the C channels 42 and a finished ceiling (not shown). In addition, the foam spacers 55 are shown sliding into position in the wall panel 65. Since the foam spacers 55 do not have a projection 55p on the underside of the foam spacers 55, the foam spacers 55 can slide into position after the C channels 42 have been installed instead of installing the C channels 42 at the same time as the foam spacers 55.

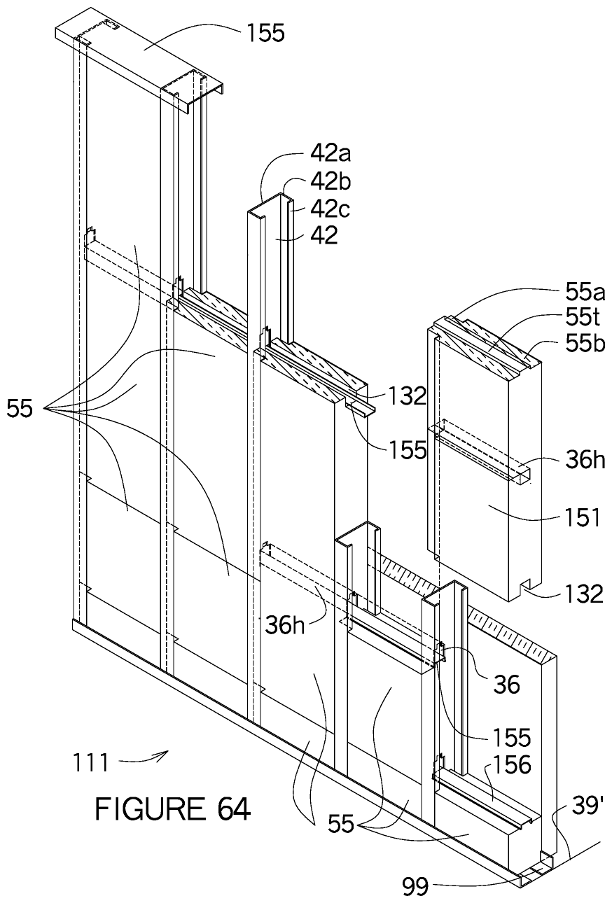

FIG. 64 shows an isometric view of the structural insulating core 111 where the depth of the foam spacers 55 are the same as the width of the support channels shown as C channels 42. Previous figures have shown the foam spacers 55 with different thicknesses, some overlapping and or protruding the C channels 42. The left side of the foam spacer 55 is referred to as the tongue shape 55a where the foam spacer 55 is installed against the lip 42c extending the depth of the flange 42b and abuts the web 42a of the C channel 42 and the opposite side or groove shape 55b of the foam spacer 55 abuts the web 42a of an adjacent C channel 42. Since not all foam spacers 55 may not want to extend the full height of the structural insulating core 111, the foam spacers 55 can abut between each other by connecting together the horizontal tongue 55t of one foam spacer 55 fits into a trough 132 of another foam spacer 55. The trough 132 can be the depth of the horizontal tongue 55t or can be extended deeper to allow of mechanical/utilities to pass through the trough 132 which is larger in size. The spacer blocks 55 shown in FIG. 64 uses different height foam spacers 55. A-//f//oam spacers 55 are shown at the concrete floor 39′ between each of the support channels are short in height and all have a flat bottom with a horizontal tongue 55t on the top of the foam spacer 55. Two different types of horizontal bracing channels are shown; the upper horizontal bracing channels are shown as a horizontal U channel 155 with its flanges 155b extending upward from the web 155b with the exterior sides fitting into the trough 132 while the longitudinal spacing-bracing member shown as a reverse lip channel 156 is shown face down so the interior side fits onto the horizontal tongue 55t and the lips having notches engage the side edges of the hole 36. Both types of horizontal bracing channels pass through the holes 36 of adjacent support channels with the foam spacer 55 between the support channels. The adjacent foam spacer 55 also shows a medium height foam spacer 55 above between support channels and connected together with another horizontal U channel 155 on top of the foam spacer 55. All the foam spacers 55 have a trough 132 at the bottom that fits over the horizontal U channel 155 at the foam spacers 55 below. The foam spacer 55 above the first foam spacer 55 shows a horizontal hole 36h in the middle of the foam spacer 55 spanning the length of the foam spacer 55 between the support channels. The horizontal hole 36h is located where the adjacent foam spacers 55 have the horizontal bracing channel passing between foam spacers 55. The horizontal bracing channels can be installed on one foam spacer 55 and extended through the holes 36 of the C channels 42 and on to the horizontal tongue 55t of the adjacent foam spacer 55. The extending horizontal bracing channels only need to be secured to the horizontal tongue 55t a short distance, just enough to secure the adjacent foam spacers 55 on either side of the extending horizontal bracing channels. Horizontal bracing channels can be installed in short segments that is staggered every other foam spacer 55 just enough to secure the foam spacers 55 together. The foam spacer 55 can be reversed as discussed earlier that is with the trough 132 on top of the foam spacer 55 and the horizontal tongue 55t located at the bottom of the foam spacer 55. The horizontal holes 36h can be cut with a hot wire or can be molded with the hole 36h formed into the foam spacer 55 at the time of molding the foam spacer 55.

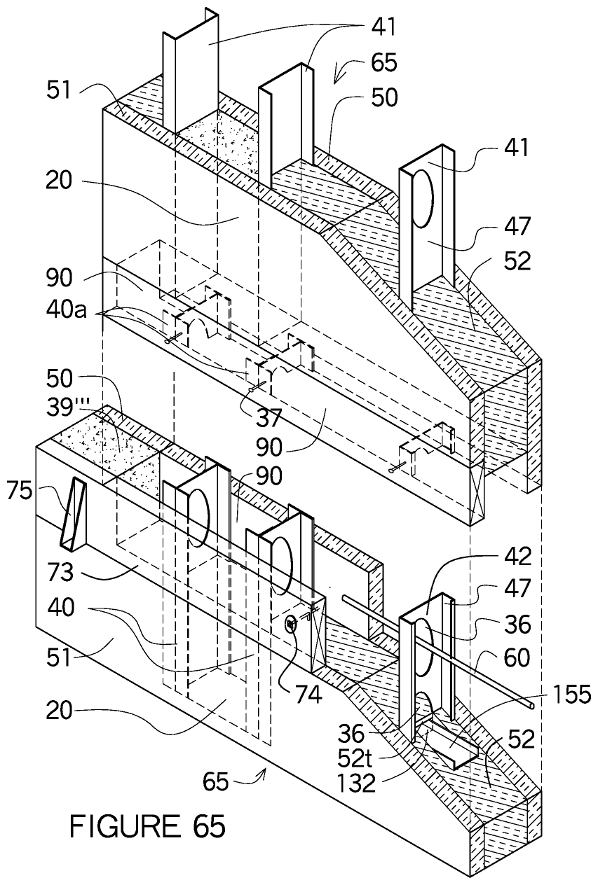

FIG. 65 is a wall section showing two wall panels 65 that is wall panel 65 is installed above another wall panel 65. The wall panel 65 consists of a rigid board 50 and rigid insulation 51 along with the spacer insulation 52 between the outer surfaces. The wall panel 65 is shown with a column mold 20 and horizontal beam mold 90 intersecting at the top of wall panel 65. In wall panel 65, the spacer insulation 52 is shown stopping at the bottom of the beam mold 90. The wall panel support channel shown as an H channel 40 forms column mold 20 then passes through the beam mold 90 then extending above the wall panel 65. The extension above the lower wall panel 65 is shown in ghost in the wall panel 65 and when wall panel 65 is resting above the lower wall panel 65, fasteners (not shown) connect the rigid board 50 and rigid insulation 51 to the H channels 40 of wall panel 65. Horizontal steel reinforcing 60 can be installed through the holes 36 in the H channel 40 at the beam mold 90 and at the spacer channel 47 of the beam mold 90. The wall panel 65 is shown with U channels 41 as supports for the column mold 20 and is used as a spacer channel 47 in the middle of the spacer insulation 52. The U channels are shown shorter at wall panel 65 above in order to allow for the column mold supports of H channels 40 to be secured with fasteners 37 through the rigid board 50 and rigid insulation 51 thereby connecting the two wall panels 65 together. The column mold 20 can be filled with concrete 39 prior to wall panels 65 being installed. The beam mold 90 can be filled with concrete 39 at the same time as the column mold 20 or the beam mold 90 can be filled with concrete 39 when the column mold 20 is filled with concrete 39. In wall panel 65, a wood ledger 73 is attached directly to the H channels 40 within the column mold 20 and the spacer channel 47. Anchor bolts 74 are attached directly to the wood ledger 73 and placed within the beam mold 90. The metal joist hanger 75 is attached to the wood ledger 73. A similar light gauge metal joist and metal ledger joist (not shown) can also be in lieu of the wood ledger. Another added feature is to install wood blocking 72 at a floor line or where horizontal support is required between panels as shown in wall panel 65. The lower portion of wall panel 65 shows a horizontal U channel 155 as the horizontal bracing along with the horizontal trough 132 and the horizontal tongue 55t also shown in FIG. 64.

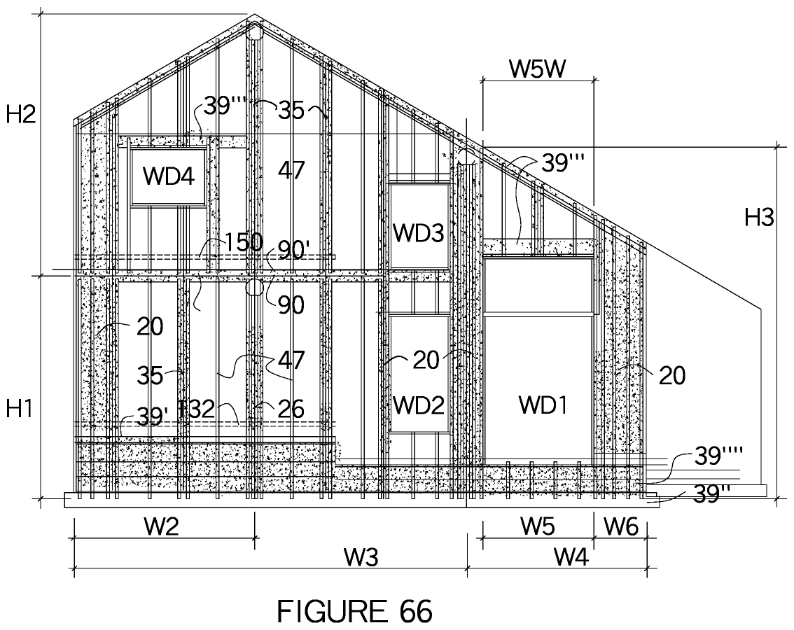

FIG. 66 shows a building elevation with various wall panels of concrete beam and column molds configurations (shown dotted) with intermediate support channels between the column molds. When constructing a building using wall panels, each wall panel requires a different number even though the wall panels are a variation of the previously described wall panels 65. The wall panels shown in this drawing can be as narrow as 4′-0″ wide shown as W1 to intermediate panel widths shown as W2 to full width walls shown as W3. The height H1 of any of the W1, W2 or W3 wall panels could be from the footing 39″, including the concrete foundation 39″ to the beam mold 90 at the second floor. Wall panels are sometimes manufactured from column centerlines or from large window jambs depending on the size of the windows. The wall panel W4 is shown in the middle of column mold 20 to the end of the wall mold 32 and extending from the footing 39″, including the foundation 39′″ to the roof referring to height H3. On the other hand, smaller sections like a foundation wall panel W5 is easier to handle without using a crane (not shown) to install the foundation wall panel W5. Another example would be wall panel W6 as part of an L column mold 20 or a window header mold W5W which incorporated a concrete beam 39′″ at the roof line as well as above the door/window WD1. The interlocking panel connection shown in FIG. 65 is shown at the beam molds 90. On the other hand, the wall panel W2 could be two stories high by making the panel heights H1 and H2 as all one panel height. This particular building showed the concrete columns 35 close together, therefore there are not many spacer channels 47. An entire building could be built using only spacer channels 47, as shown in previous figures or in combinations with the column and beam molds 20 & 90. The column mold 20 is shown wider as it depends on the spacing between window/door WD1 & WD2 as well as any floor or roof beams that would affect the size of the column mold 20. The column mold 20 shown at the left and right corners of the building are wider due to wind loads or other structural conditions. Since a concrete beam 39′″ is located between the building floors above, a window header like a concrete beam 39′″ is not required. The wall panels 65 show the horizontal trough 132 with the horizontal bracing channel are both shown in ghost, however any of the support channels, holes, horizontal bracing channels can be used as well as the foam spacers 55 and spacer insulations 52 can be used.

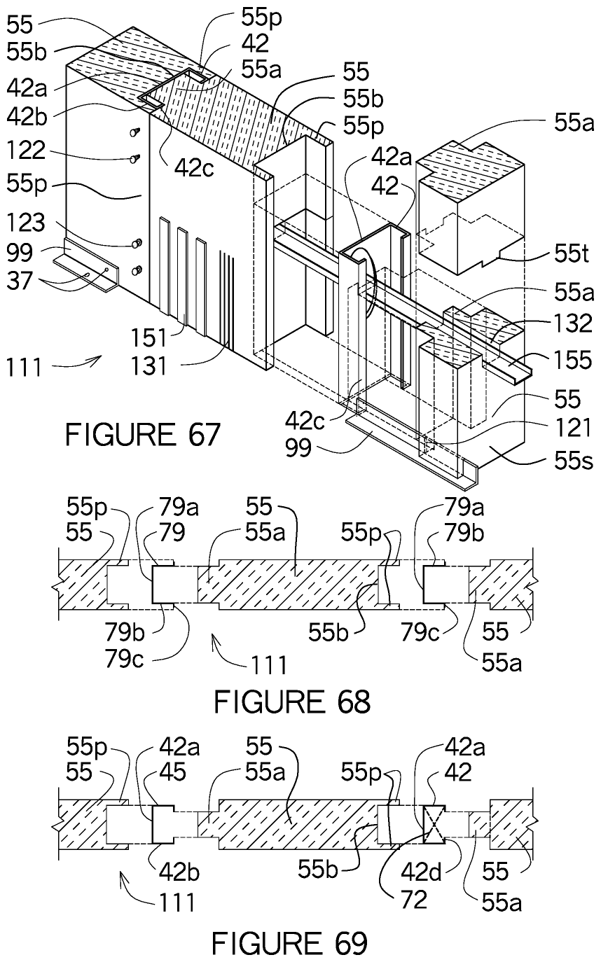

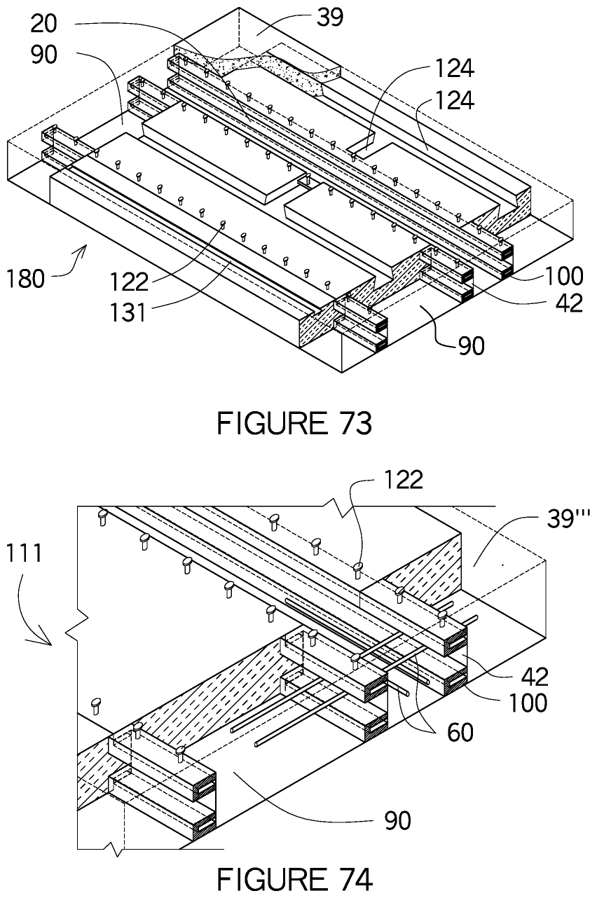

FIG. 67 shows an isometric drawing of the structural insulating core 111 consisting of two C channels 42 and four foam spacers 55 that are wider than the C channels 42. The foam spacer 55 between the C channels 42 abuts the web 42a at the tongue shape 55a of the foam spacer 55 and the foam spacer 55 abuts the lip 42c at the C channel 42 on the left. The opposite end of the foam spacer 55 has the groove shape 55b where the web 42a of the C channel 42 fits into. Since the foam spacers 55 are wider than the C channels 42 the excess foam spacer on both sides of the C channel 42 forms a projection 55p that overlaps both flanges 42b. The tongue and groove configuration shows how the foam spacers 55 can easily fit together between the C channels 42. The projections 55p of the foam spacers 55 can easily be screwed or glued to the C channels 42. The webs 42a can easily be glued to the foam spacers 55 creating a stronger structural insulating core 111. FIG. 68 also shows the foam spacers 55 and C channels 42 in a separated position prior to securing the foam spacers 55 together creating a structural insulating core 111. In FIG. 69 the C channel 42 can be wood blocking 72, however the tongue shape 55a is not required in the foam spacer 55. The structural insulating core 111 can be used as an independent wall; an interior core for of the columns and beam molds previously described; and as a forming structure in a precast wall which is described in FIGS. 44 & 73-74. A screw 122 and double headed fastener 123 are shown secured through the foam spacer 55 at the projection 55p or into the insulating foam 100 to connect precast concrete walls to the structural insulating core 111 shown in FIG. 73-74. Attaching the screw 122 and/or the double headed fastener 123 to the structural insulating core 111 provides as thermal break with the C channels 42 as well as providing a means of securing a structural insulating core 111 to concrete as shown in FIG. 73. Also shown are drainage channels 151 that protrude from the structural insulating core 111 to create an air space should it be required when some exterior surface finish materials (not shown) are applied over the structural insulating core 111. In addition a recessed groove 121 is shown on the exterior face of the structural insulating core 111 to allow water drainage between the structural insulating core 111 and various stucco applications. Since the structural insulating core 111 is a solid wall, two methods are shown to secure the structural insulating core 111 to a floor 175. Base plate angle 99 is shown attached to the C channel 42 at the flange 42b and the floor 175; however a groove 121 is cut into the structural insulating core 111 at the base plate angle 99. Another method is to install the base plate angle 99 on the surface of the structural insulating core 111 and connect to the flange 42b of the C channel 42 using a fastener 37 and thereby having a thermal break between the C channel 42 and the base plate angle 99. A trough 132 is shown in the middle of the structural insulating core 111 and is aligned with the holes 36 of the C channel 42 for use as an electrical chase within the structural insulating core 111. In some cases the trough 132 is required to be metal channel (not shown) for compliance with some electrical codes. In addition, the trough 132 can be used to install a horizontal bracing channel shown as a horizontal U channel 155 connecting the C channels 42 within the structural insulating core 111. Usually the holes 36 within the C channels 42 are spaced 24″ apart so the trough 132 could be installed to align with the holes 36 therefore making the foam spacers 55 be shorter pieces rather than the full height of the wall. The horizontal U channel 155 is shown within the trough 132 passing through the holes 36 within the C channels 42 and into the adjoining spacer insulation 55. The C channels 42 and the horizontal bracing channel can also be shorter in length and used as brackets to secure four adjacent spacer insulations 55 together. When the four short foam spacers 55s intersect the horizontal tongues 55t of two short foam spacers 55s fit into the troughs 132 of the two short foam spacers 55s below; plus the horizontal bracing channel connects the two short foam spacers 55s together as well as the C channel 42 because the horizontal U channel 155 has a hole 36 in the web 42a locking the C channel 42 with the tongue shape 55a and the groove shape 55b together. The short foam spacers 55s can be installed together without support channels since the tongue shape 55a and the groove shape 55b interlock between short foam spacers 55s as well as the horizontal U channel 155 within the troughs 132 plus the horizontal tongues 55t fitting into the troughs 132 together form a structural insulating foam core wall.

FIG. 68 shows a plan view of FIG. 67 except here two reverse support lip channels 49 are used between three foam spacers 55. The reverse support lip channel 49 is similar to the C channel 42 in FIG. 7, except the lip 49c is bent in the opposite direction as the lip 42c. The tongue shape 55a fits against the web 49a of the reverse lip support channels 49 and the groove shape 55b fits against the adjacent reverse lip support channel 49 at the web 49a and the projection 55p of the foam spacer 55 fits against the flanges 49b and abuts the lip 49c. Since the structural insulating core 111 has a snug fit between the reverse lip support channels 49 and the foam spacers 55, the wall panel can be glued together. The reverse lip support channel 49 and the C channel 42 have the same physical characteristics since the lip 49c & 42c function in the same way giving the reverse lip support channel 49 the same strength as the C channel 42. In addition, the reverse lip support channel 49 can smaller and use as a horizontal bracing channel where ever it has been used.

FIG. 69 is similar to FIG. 1 except the three foam spacers 55 of the structural insulating core 111 have projections 55p that overlap the flanges 42b of the C channel 42 also shown in FIG. 67. The foam spacers 55 extends beyond the webs 42a of the adjoining C channels 42 enough to create a thermal break and cover the C channels 42 with the same projection 55p. The open portion of the C channel 42 has a lip 42c where the tongue shape 55a fits between and a horizontal bracing channel (typically used to connect adjacent C channels within the building industry) plus the opposite end of the foam spacer 55 also fits between the webs 42a of the adjacent C channel 42. Since the foam spacer 55 overlaps and fits between the webs 42a of the C channel 42, the projection 55p and the foam spacer 55 are wall insulations as well as a wall sheathing material, both the foam spacer 55 and a wall sheathing material can all be made together as one material. FIG. 69 is a plan view of the wall panel shown in FIG. 67 with the tongue shape 55a and groove shape 55b and the projection 55p of the foam spacer 55 between the C channels 42. In FIG. 69 wood blocking can be used to replace the C channel 42, however the tongue shape 55a of the foam spacer 55 and the horizontal bracing channel are not required.

FIG. 71 is an isometric view structural insulating core 111 showing the double flange channel 105 being attached to a standard base plate shown as a horizontal U channel 155 typically used in light gauge metal framing. The horizontal U channel 155 is attached to the floor 175, and the double flange channel 105 is connected to the flange 155b of the horizontal U channel 155. The base plate, however is different because the horizontal U channel 155 has a groove 121 cut in the flange 155b and another groove 121 in the double flange channel 105 at the returning flange 105b″ and these grooves 121 are cut 16′ & 24″ OC in the base plate in order to easily attached them together without measuring. Also the horizontal U channel 155 is wider than width of the web 105a of the double flange channel 105. The groove 121 is in the middle of the returning flange 105b″ and corresponds to the groove 121 in the double flange channel 105 and the groove 121 in the foam spacer corresponding to the base plate. The wider base plate and the wider spacer insulation creates a thermal break between the flanges 105b′ and 105b′″ of the double flange channel 105. Now only the grooves 121 come in contact with the turning flange 120b″ of the horizontal U channel 155. In addition, diagonal bracing 78 is shown installed on the surface of the foam spacer 55 connecting the array of double flange channels 105.

FIG. 73 shows an isometric view of the precast mold 180 where the concrete 39 is poured on top of the structural insulating core. Any of the previous described structural insulating cores 111 with either the spacer insulations, foam spacers 55 or supporting channel configurations can be used to form a precast mold 180. The previously described wall molds were first erected vertically then the hardenable material was poured into the wall molds, that is into the column and beam molds, while here the precast molds are laid horizontally and then the hardenable material is installed into the molds. The structural insulating core shown here is similar to FIG. 71, however the rigid board 50 is not required and concrete 39 is used instead as the exterior wall material. The rigid insulation 51 shown in FIG. 71 can be used as the bottom of the precast mold 180 or a forming bed typical used in precast construction can be used. The C channels 42 of the structural insulating core is shown extending into a beam mold 90 at the ends of the wall panel. The insulating foam 100 fits over the C channel 42 at the bottom of the beam mold 90 so drywall (not shown) or other materials can be attached after the concrete 39 has cured. Screws 122 or double headed fasteners (not shown) are attached through the structural insulating core into the C channel 42. In addition a recessed groove 121 is installed to additionally secure the structural insulating core to the concrete 39. Also additional strength can be added to the wall panel by installing a rib 124 parallel to the C channel 42 and another rib 124 can be installed perpendicular to the C channel 42 in the structural insulating core. The ribs 124 add additional strength to the concrete 39 allowing the C channels 42 to be spaced further apart. The precast mold 180 is complete when the wall panel form side boards (not shown) are installed. Additional steel reinforcing (not shown) is installed in the beam molds 90 and the column mold 20 and concrete 39 is poured over and into the precast mold 180 when the precast mold 180 is in a horizontal position. Since the concrete 39 passes through the holes 36 (not shown) in the C channel 42 of the beam mold 90, the C channel 42 is secured to the structural insulating core. In addition, ribs 124 and grooves 121 are also installed on the structural insulating core to add additional bonding strength to the concrete 39 bonding to the structural insulating core. When the ribs 156r and recessed grooves 121 are added to the structural insulating core, the screws that are secured to the C channel 42 might not be required to secure the concrete 39 to the structural insulating core. Many of the other previously described wall molds or structural insulating cores can also be used to form the precast mold 180.

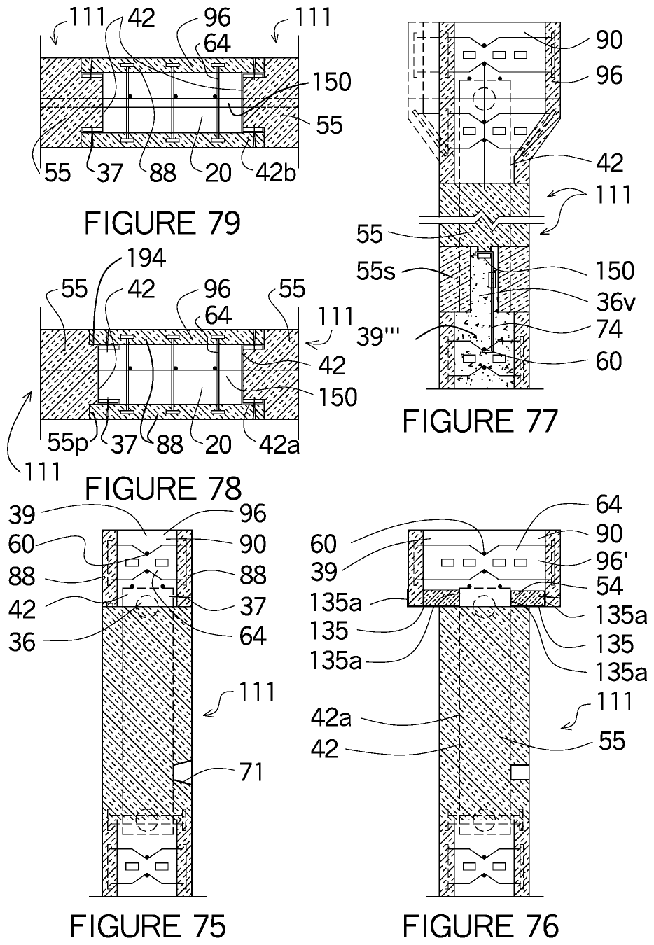

FIG. 74 through FIG. 79 shows various configurations of the ICF block molds 96 attached to the structural insulating core 111. In FIG. 74 is a wall section showing the beam mold 90 is placed above to the structural insulating core 111. The C channel 42 with holes 36 extending into the beam mold 90 and attached with a fastener 37 through the rigid foam block faces 88 of the ICF block mold 96. When concrete 39 is poured into the beam mold 90, the C channel 42 will be secured into the concrete 39. In addition a horizontal bracing channel can be installed as part of the structural insulating core 111. The horizontal bracing channel would be installed between the typical connector 64 of an ICF block mold 96 and therefore would be installed between one ICF block mold 96 and an adjacent ICF block mold 96 (not shown) connect the connectors 64 of the respective ICF block molds 96.

FIG. 80 shows an longitudinal spacing-bracing member as a horizontal reverse channel 156 having an elongated web 156a with first and second parallel edges being connected and extending away from the web 156a forming first and second longitudinal walls are shown as flanges 156b. The flanges 156b are bent inward with longitudinal lips extending away from longitudinal shown as lips 156c. The free side edges of the lips 156c having lip notches 126p cut inward from the free side edges. At the free side edges of the lips 156c a flare 126f is shown at the lip notches 126p to form a wider opening into the lip notches 126p. At one lip notch 126p, the flares 126f at the side edges have a blunt edge 159. Various types of configurations or impressions can be installed with the longitudinal spacing-bracing member like ribs 156r (shown in elevation in FIG. 82) and recessed grooves 121 (shown in elevation in FIG. 83) which both are shown having an internal side and an external side. In FIG. 81 the lip notches 126p and the flares 126f occur on both side edges of the lip 156c when the reverse lip channel 156 is installed into a hole 36. Since the lips 156c are wider than the width of the hole 36, the longitudinal spacing-bracing member is tilted at an angle so the lips 156c can pass into the hole 36. As the lips 156c pass along the side edges of the hole 36, the flare 126f having its sides angular, that is the flare 126f is wider than the lip notches 126p, will force the horizontal reverse lip channel 156 by gravity into the flare 126f and will force the lip notches 126p to rotate and engage into the side edges of the hole 36. The longitudinal spacing-bracing member will be secured into the hole 36 when the side edges of the lip notches 126p engages the planar sides of the web 156a. On the other hand, the lip notches 126p can be angular as some holes 36 are manufactured as punched holes 169 which have a rim 36r around the hole 36 that is angular similar to the rim 36r as shown in FIG. 15. The rim 36r is sometimes referred to as a ledge 79.

In FIG. 83 the web 156a is shown having three grooves 121 protruding into the web 156a and three ribs 156r protruding outward from the bottom side of the web 156a. However if the grooves 121 were deeper the three groove 121 would be considered to have 13 sides. Obviously by installing one large groove in the web 156a, the web 156a would then be considered to have 5 sides (three horizontal sides and two vertical sides. The web 156a, longitudinal sides 156b and lips 156c can also have additional sides even though it would still be considered a reverse lip channel 156. Many different shapes are presently being manufactured with additional profile bends in the web, flanges and lips whether a U shaped channel 155 or the reverse lip channel 156 to increase the strength of metal channel framing. In FIGS. 80-83, the notches and flares 126f in the longitudinal spacing-bracing member can have various widths, depths, lengths, flares or angles of notches at its open end of the lips. In addition, the longitudinal spacing-bracing members can be inverted that can change the appearance and function. Sometimes the lip notches 126p could be connecting two crossing members within the same lip notches 126p. If the horizontal loading of a support member has extensive wind pressure in one direction, then a longer lip notch 126p would be required maybe eliminating the flare edges 126f and extending the notches into the longitudinal sides and even the web. You might have to increase the lip 156c strength by forming a double lip edge. Sometimes a longer length of the notch is required due to excessive horizontal loading in one direction making one side edge longer that the other side edge or one side could have a flare edge 156f and the opposing side does not have a flare. The longitudinal spacing-bracing members can be installed in the support members at an angle through the holes 36. The width of the lip notches 126p would be wider as they pass through the hole 36 at an angular lip notch 126ap and the lip notches 126p might have to be cut at an angle for an easier installation or maybe just eliminate the parallel side edges of the lip notches 126p and just have the flare edge notch 126f converge to a point. Manufacturing is that easy there will also be a blunt end 159 at the converging point to secure the crossing member into the lip notch 126p. The flare edge notch 126f will probably only be strong enough to temporarily secure the longitudinal spacing-bracing member until drywall is secured, but is still better than the embossed dimples used presently to secure the longitudinal spacing-bracing members together. Another aspect of the invention is whether the longitudinal spacing-bracing member has the U-shape facing upward or downward or whether the lip notches 126p extend into the longitudinal sides 156b and/or web 156a or are aligned with the side edges of a key hole 36k. The longitudinal spacing-bracing members with their notches reduce lateral and or vertical movement. Various types of hole configurations and longitudinal bracing-spacing orientations can also be used to form many different lip, web and longitudinal notches combinations.

FIGS. 84 & 85 are similar in that a horizontal U channel 155 is used as a coupling 63 and 63′ that connects two longitudinal spacing-bracing members shown as horizontal reverse lip channel 156. In FIG. 84 the longitudinal spacing-bracing member shown as a horizontal reverse lip channel 156 has the interior side of the web 156a and the flanges 156b of both horizontal reverse lip channels 156 facing upwards. The interior side of the coupling 63 comprises the open side of horizontal U channel 155 having the exterior side of the web 155a and flanges 155b being inserted into the interior side, the open side, of the horizontal reverse lip channels 156 where the web 155a of the horizontal reverse lip channels 156. In FIG. 85 the interior side of the coupling 63′ comprises of the open side of the horizontal reverse lip channel 156 and the horizontal U channel 155′. The exterior side of web 156a and the flanges 156b are received in the open side, the interior side, of U channel 155′ so the exterior side of the web 156a is juxtaposed against the interior side of the web 155′a of the horizontal U channel 155′. The horizontal U channels 155 and 155′ are secured to the horizontal reverse lip channels 156 with metal screws, nut and bolts, or like fixtures.

FIG. 86 shows the horizontal bracing channel as a horizontal U channel 155 where the interior side is facing upwards typically spanning between the holes 36 in the support channels shown as C channel 42. A multi-plane bracket 138 is shown in FIG. 18, but is shown here as a multi-plane bracket described as a reverse lip bracket 208 having the exterior side fitting between the interior side of the flanges 155b of the horizontal U channel 155 so that the lip notches 126p on both sides of the lips 208c engage the side edges of the hole 36 and extend past the edge of the hole 36 along with the flares 126f that are angled. The flares 126f are angled so the reverse lip bracket 208 can glide into the side edges of the hole 36 easily as the reverse lip bracket 208 is inserted in a vertical orientation and then rotated into a horizontal orientation so the lip notches 126p engage the side edges of the holes 36. The horizontal bracing channel and the reverse lip bracket 208 are additionally secured by fasteners between the webs 155a & 208a thereby securing the horizontal bracing channel, the reverse lip bracket 208 and the hole 36 together at the support channel. The multi-plane bracket 138 can also be used to connect two horizontal bracing channels together. FIG. 87 is similar to FIG. 86, however the reverse lip bracket 208 shown with its lip notches 126p are installed in the hole 36 of the support channels first, then the web 155a of the horizontal U channel 155 are installed between the two parallel flanges 208b of the reverse lip bracket 208 are secured together at their webs 155a & 208a. The multi-plane bracket 138 is rotated into the hole 36 with the lip notches 126p engaging the side edges of the hole 36. The reverse lip bracket 208 and the horizontal U channel 155 can be reversed, where the interior sides are turned downward so the web 155b & 208b extend downward from the web 155a & 208a. The horizontal U channel 155 in both FIG's can also be a reverse lip channel 156 that has the lip 156c with the lip notch 126p at the free end and a reverse lip bracket 208 can also be a reverse lip channel 156. When the reverse lip channels 156 overlap each other, the notches at the end of each reverse lip channel 156 intersect the same hole and the lip notches are indented from the ends. In addition a reverse lip channel 156 with sloped flanges and lip notches can fit into or over another reverse lip channel 156 with rectilinear flanges and lip notches.

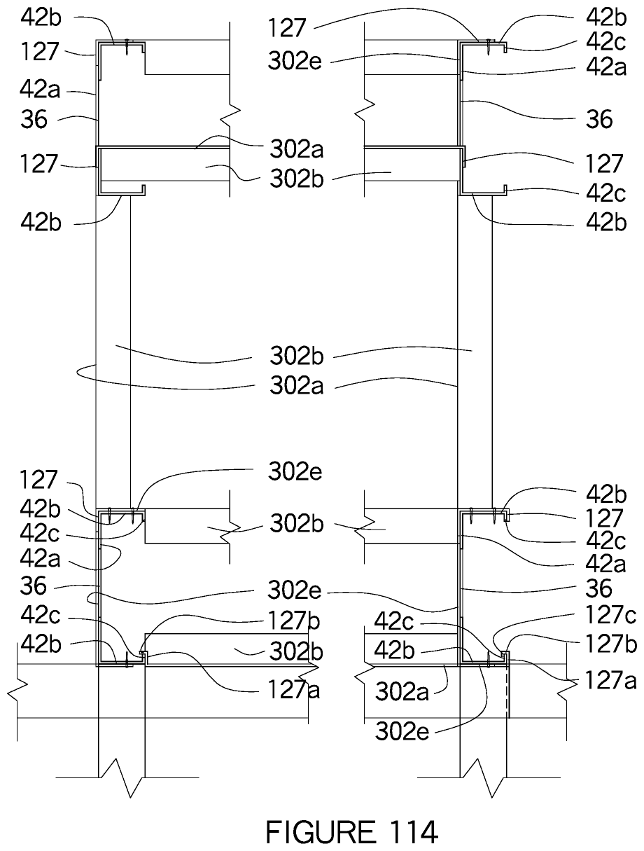

FIG. 88 shows several C channels that can form a wall or roof system and being connected by joist straps (shown in ghost) which have been used to stabilize C channels from turning or twisting. C channels 42 are used as the C channels in FIG. 112. The holes 36 are oriented vertically so the reverse lip channel 156 passes through the web 42a in a horizontal position, that is the lip notches 126p in the reverse lip channel 156 are installed in a horizontal position. On the other hand, when the hole 36 is oriented horizontally the reverse lip channel 156 is oriented vertically so the lips 126p are projected vertically as shown in FIG. 114. In addition, the reverse lip channel 156 does have to be installed in shorter segments; a coupling can be used to connect two reverse lip channels 156 together. The coupling can be U shaped of a flat plated within the reverse lip channel 156 between the two flanges 156b and against the web 156a; or another reverse lip channel 156 that has a smaller web 156a along with longer lips 156c in order to fit within the reverse lip channel 156; or lastly just a reverse lip channel 156 or a U channel 155 that is larger that fits around both of the reverse lip channels 156 needing a coupling 63. The hole 36 in a horizontal position shows the horizontal bracing channel 150 passing through the holes 36 of the C channels 42, however the horizontal bracing channel 150 has notches 150n in the flanges 150b that fit into the holes 36 of the metal floor joists 176b. The notches 150n do not extend the full depth of the flange 150b so the flange 150b has part of the flange 150b still connected to the web 150a. The flange notches 126fg allow the reverse lip channel 156 to extend below the hole bottom edge 36be allowing an adjacent reverse lip channel 156 to overlap the lower reverse lip channel 156 at the flange notches 126fg and lip notches 126p. The flange 150b can be cut full depth, but when doing so allows the horizontal bracing channel 150 can bend easier when placing the horizontal bracing channel 150 into place. By installing the notches 150n in the horizontal bracing channel 150, the C channel 42 will not bend or twist easily.”

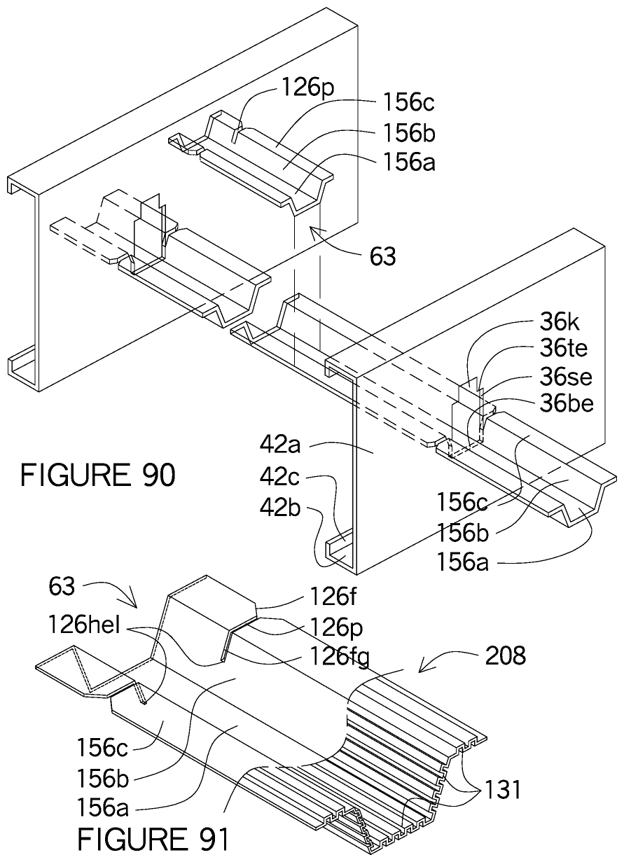

FIG. 89 shows an enlargement of FIG. 88 where three horizontal floor joists are shown a C channels 42 having different size holes and orientations. The shortest floor joist at the front shows two different size holes 36 in the web 42a of the C channel 42 also shown in FIGS. 90 & 93. The bottom left hole 36 shows a standard width holes with a reverse lip channel 156 where the web 156a is support at the hole bottom edge 36be and the lip notches 126p are installed inward from the longitudinal outside edges so the hole side edges 36se can be installed into the lip notches 126p. The front hole 36 shown in the middle and left C channels 42 shows a narrower width hole 36 where the web 156a appears shorter and the lips 156c are also narrower. The lip notches 126p extends the full width of the lip 156c and continues about a half of the width of the flange 156b. The distance between the back edge of the notches equals the width of the hole 36. The metal framing industry tries to maintain a standardize hole width, however the hole width comes in three sizes and the key hole is also used as another width size. So the standard U channel 155 does vary in width and so will the reverse lip channel 156 vary in width at the web, flanges and lips including the length of the lip notches 126p and flange notches 126fg or any other notches used to connect into the hole. The various widths of the webs at a reverse lip channel 156 can have the longitudinal ends of two adjoining reverse lip channels 156 having different widths, therefore the longitudinal ends of a connecting reverse lip channel 156 or a coupling 63 can have two different sizes at each longitudinal end.

FIG. 89 shows an enlargement of FIG. 88 where three horizontal floor joists are shown a C channels 42 having different size holes and orientations. The shortest floor joist at the front shows two different size holes 36 in the web 42a of the C channel 42 also shown in FIGS. 90 & 93. The bottom left hole 36 shows a standard width holes with a reverse lip channel 156 where the web 156a is support at the hole bottom edge 36be and the lip notches 126p are installed inward from the longitudinal outside edges so the hole side edges 36se can be installed into the lip notches 126p. The front hole 36 shown in the middle and left C channels 42 shows a narrower width hole 36 where the web 156a appears shorter and the lips 156c are also narrower. The lip notches 126p extends the full width of the lip 156c and continues about a half of the width of the flange 156b. The distance between the back edge of the notches equals the width of the hole 36. The metal framing industry tries to maintain a standardize hole width, however the hole width comes in three sizes and the key hole is also used as another width size. So the standard U channel 155 does vary in width and so will the reverse lip channel 156 vary in width at the web, flanges and lips including the length of the lip notches 126p and flange notches 126fg or any other notches used to connect into the hole. If the longitudinal spacing-bracing channels 156 are reversed with lips 126p and flanges oriented downward then the hole bottom edge 36be would be supporting the back edge of the notch at either the flanges 156b or at the web 156a.

In FIG. 90 two adjacent longitudinal spacing-bracing channels are shown end to end passing through a smaller width hole 36. The smaller width hole requires a longer notch using the full depth of the lip 156c and a portion of the flange 156b in order to increase the horizontal resistance created by a wind force and possibly increasing the gauge of the metal to reduce the horizontal wind force or distribute the vertical load from weight of the building structure. When the reverse lip channel 156 has lip notches 126p and angle flanges 156b plus flange notches 126fg extending into the angled flanges 156b, the end of the flange notches 126fg are shown as heel notches 126hel wherein distance between the heel notches 126hel on one flange and the distance between the heel notch 126hel on the opposing flange 156b is the width of the hole 36 in the support member. There are many obvious solutions a Structural Engineer would use including: a smaller reverse lip channel 156 that fits at the interior between the flanges; underneath the two reverse lip channels 156 outside around the flanges 156b; install one lip notch 126p into a hole 36 at one end and the opposing end attached to the adjacent reverse lip channel 156; install a multisided bracket at each hole; or just install another reverse lip channel 156 with lip notches 126p between the two support members. Also when the reverse lip channel 136 has flange notches 126fg along with lip notches 126p the angular oriented flanges 136b will engage the hole bottom edge 36be and assuming the adjacent reverse lip channel 136 is stacked above connecting the same hole 36 the lower reverse lip channel 136 having the same profile but the lip 156c only has lip notches 126p the upper reverse lip channel will have its lips 156c resting on the hole bottom edge with its lips extending horizontal at the same plane of the hole bottom edge 36be. So by having flange notches 126fg the first reverse lip channel 156 is set lower at the hole bottom edge 36be than the second reverse lip channel having its lips 156c resting on the hole bottom edge 36be. FIG. 91 shows an enlargement of a coupling 63 or an enlargement of the reverse lip channel 156, but also shows grooves 131 installed at the web 156a, flanges 156b and lips 156c for additional lateral strength. A longer reverse lip channel 156 with notches 126p or 126fg could just to cut at the job site to just fit any particular size. The grooves 131 extending longitudinally the full length of the reverse lip channel 156 and being interrupted with lip notches 126p and flange notches 126fg typically spaced 16 or 24 inch spacing with the notches indented from the ends in order to overlap the adjacent longitudinal spacing-bracing channels. When the reverse lip channel 156 has the lips notches 126p and flanges notches 126fg facing downward the flange notches 126fg engage the hole bottom edge 36be of the reverse lip channel 156, on the other hand when the reverse lip channel 156 is facing upward the flange notches 126fg will engage the hole side edges 36se.

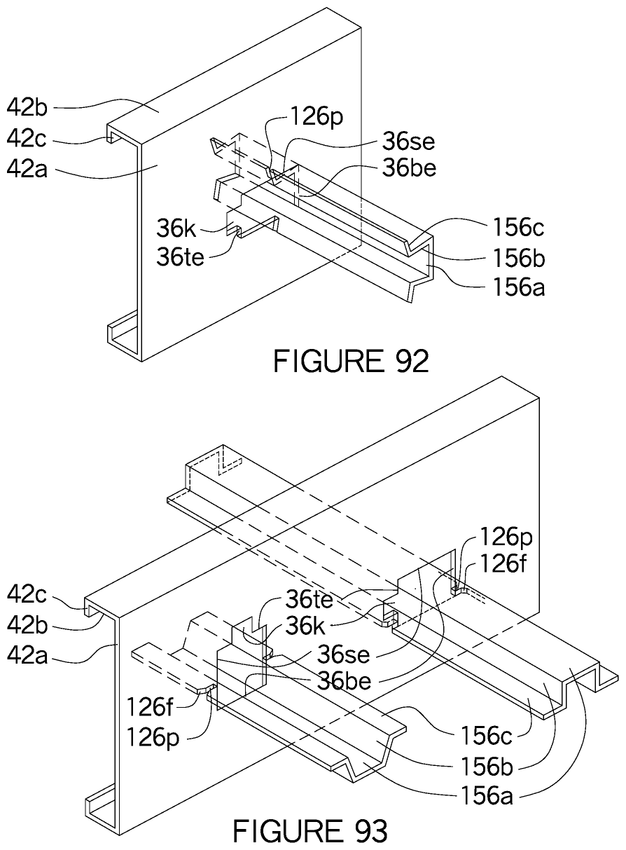

In FIGS. 89, 92 & 93 show the other three holes 36 oriented horizontally that is the width is the vertical dimension and the length in the horizontal direction including the depth of the grooves and the gauge of the metal framing members. One hole shows the reverse lip channel 156 where the lip notches 126p extend into the hole top edges and the hole bottom edges 36be. The left C channel 42 shows the reverse lip channel installed vertically where the lip notches 126p extend into the hole side edge 36se as shown in FIG. 92.

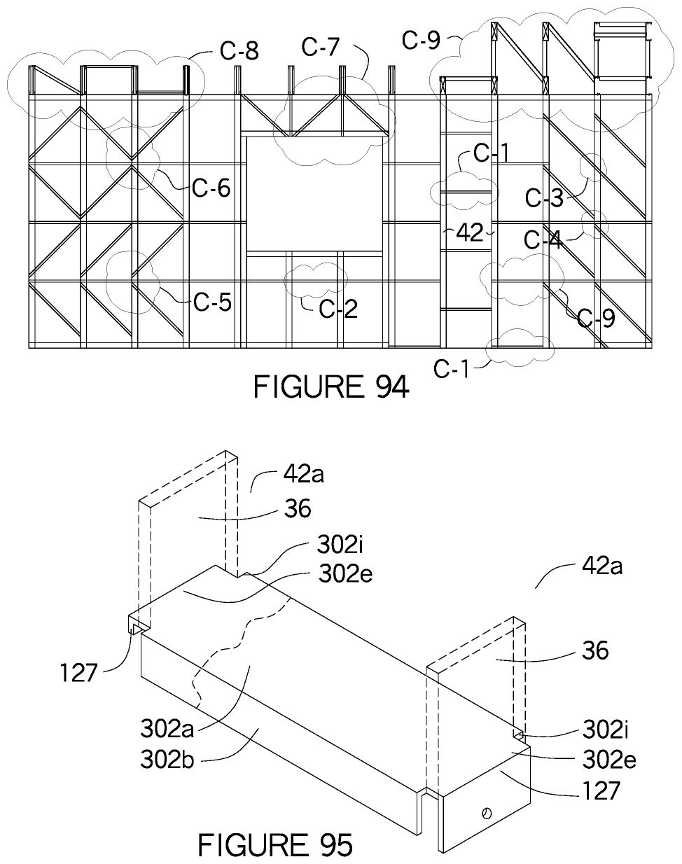

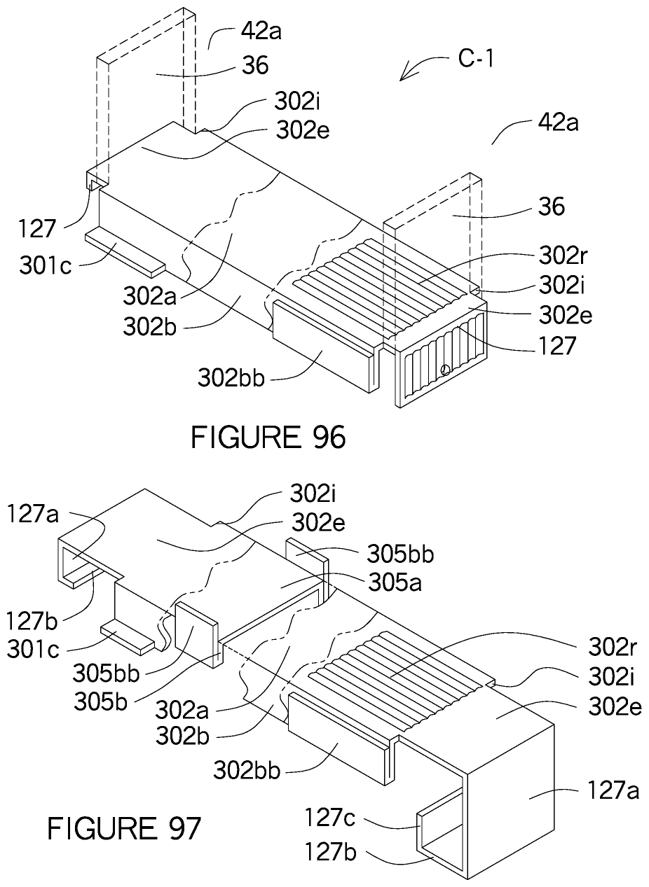

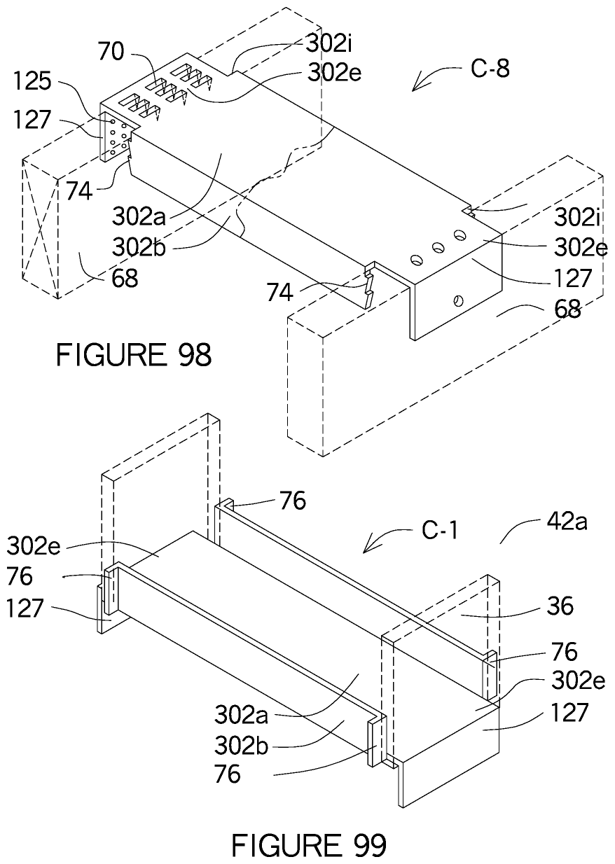

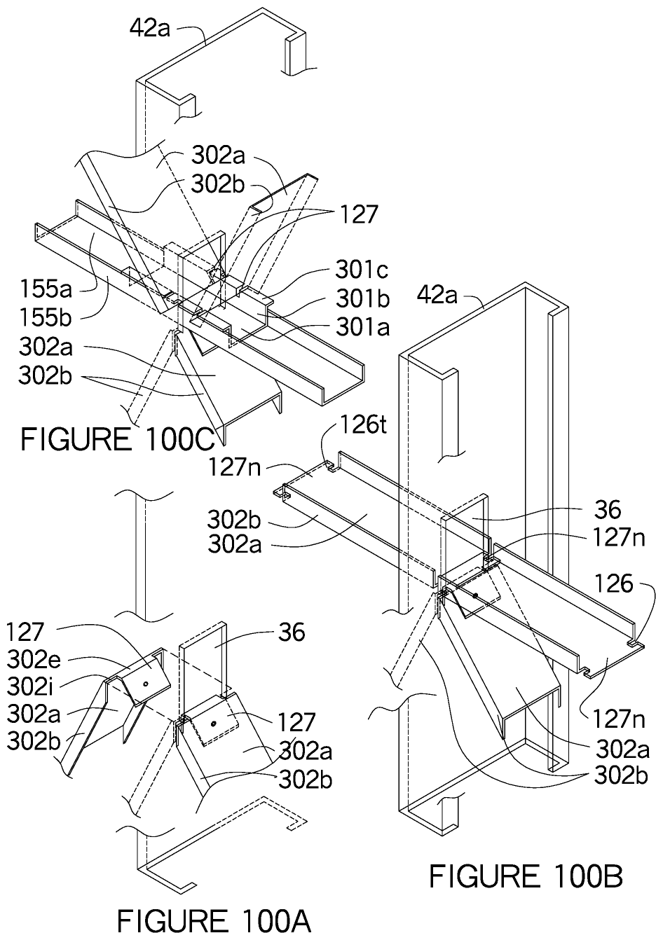

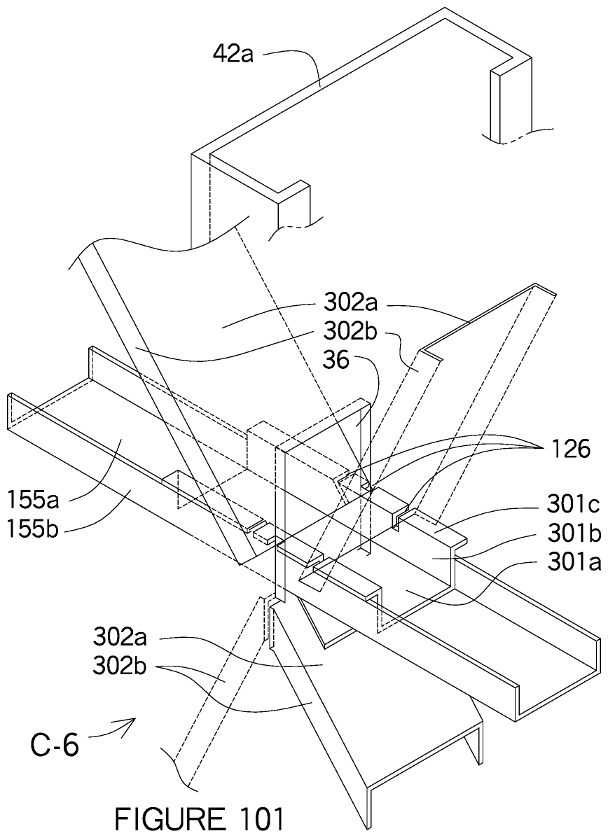

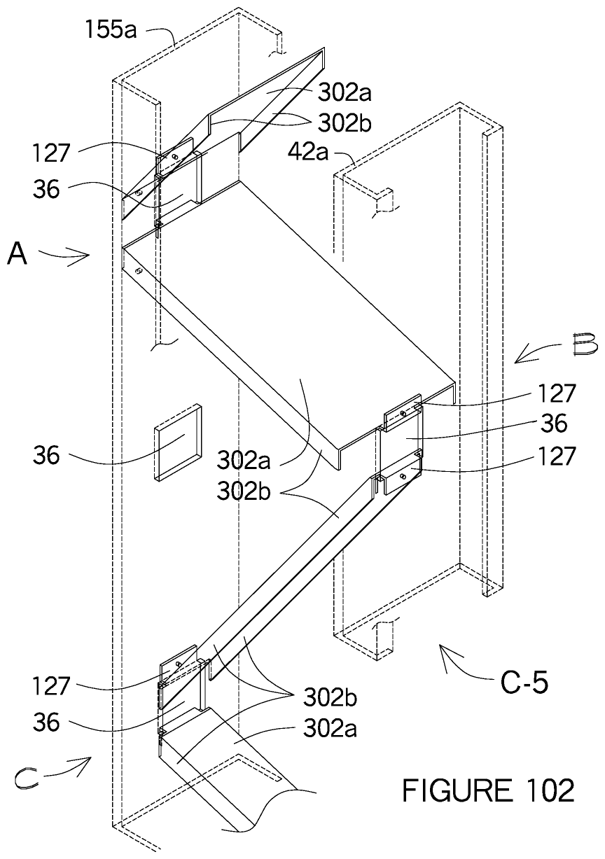

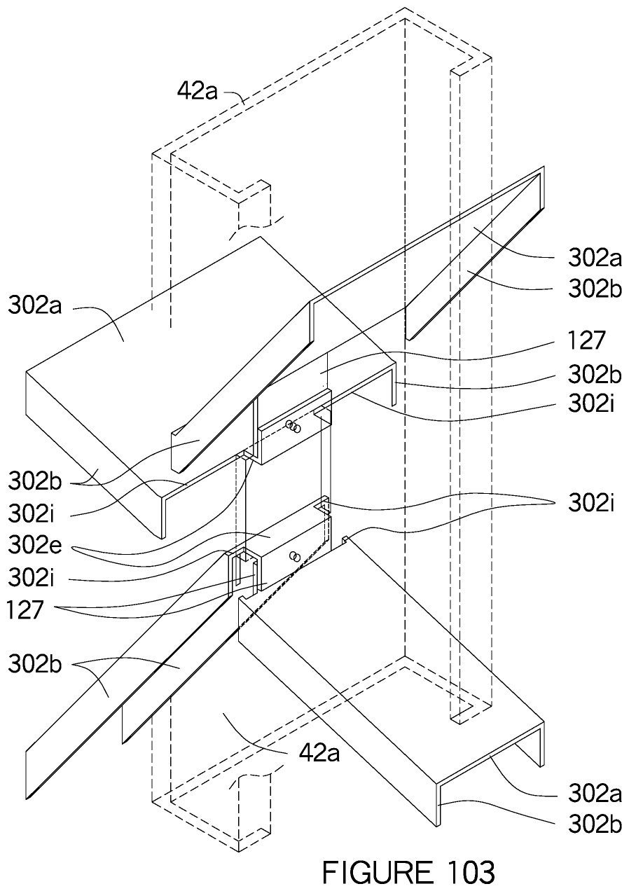

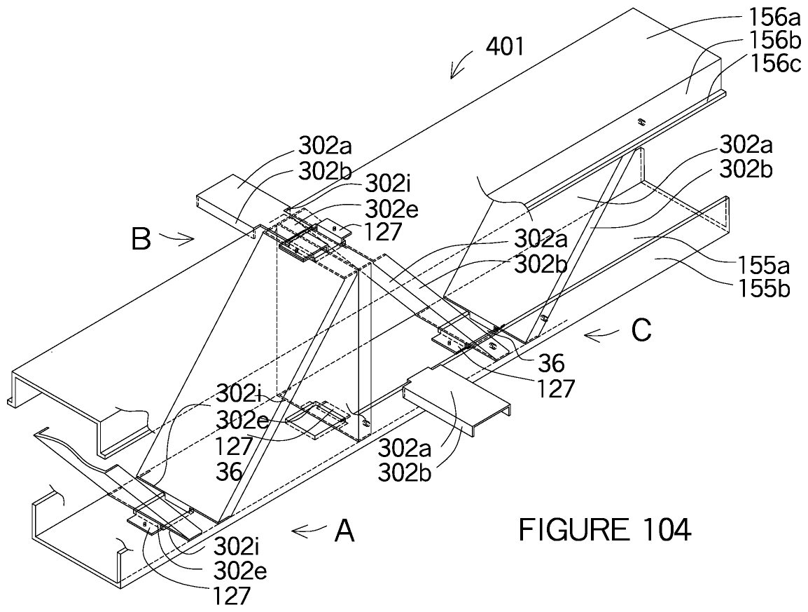

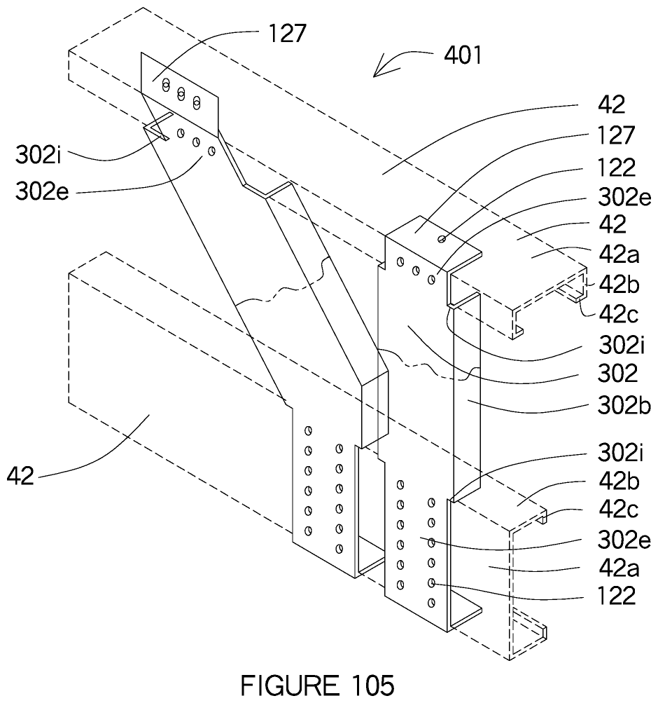

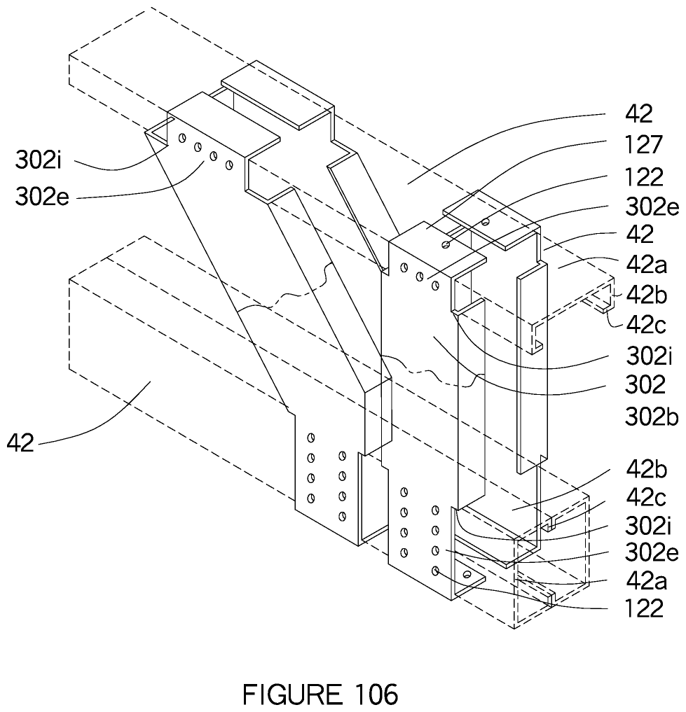

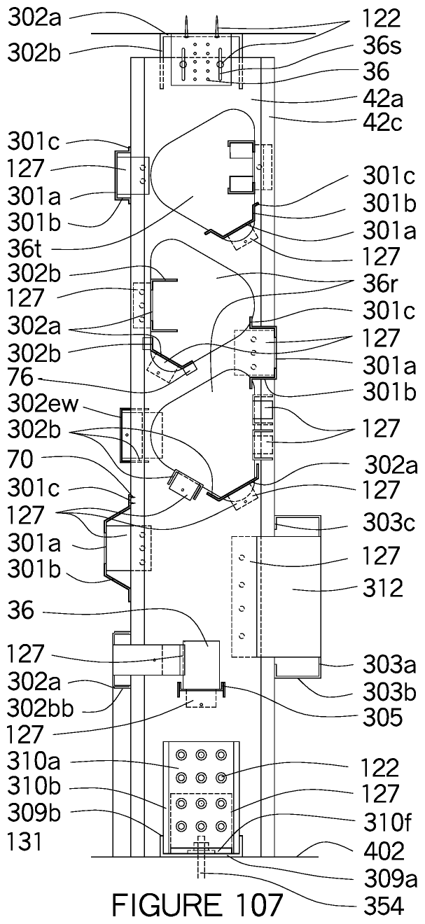

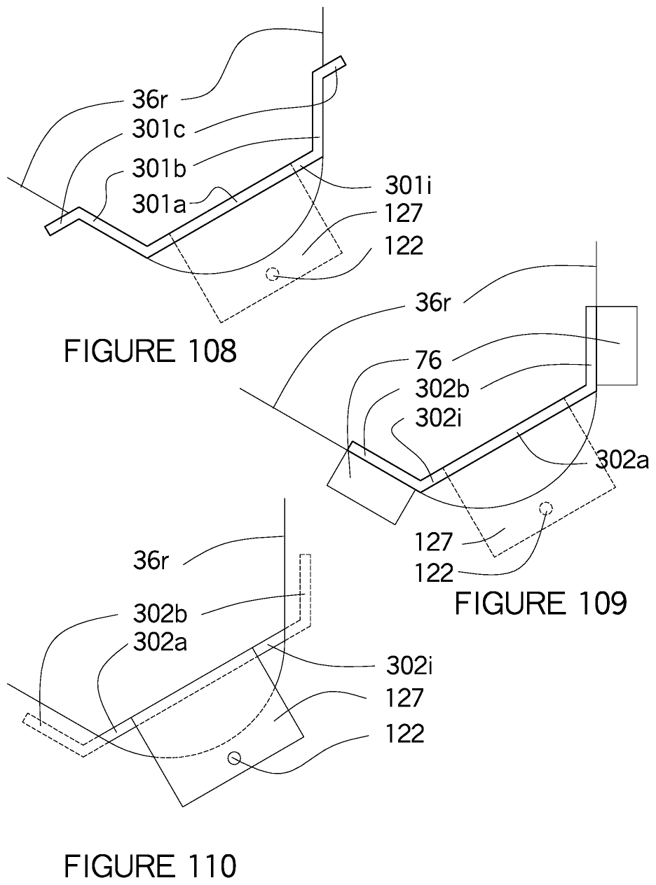

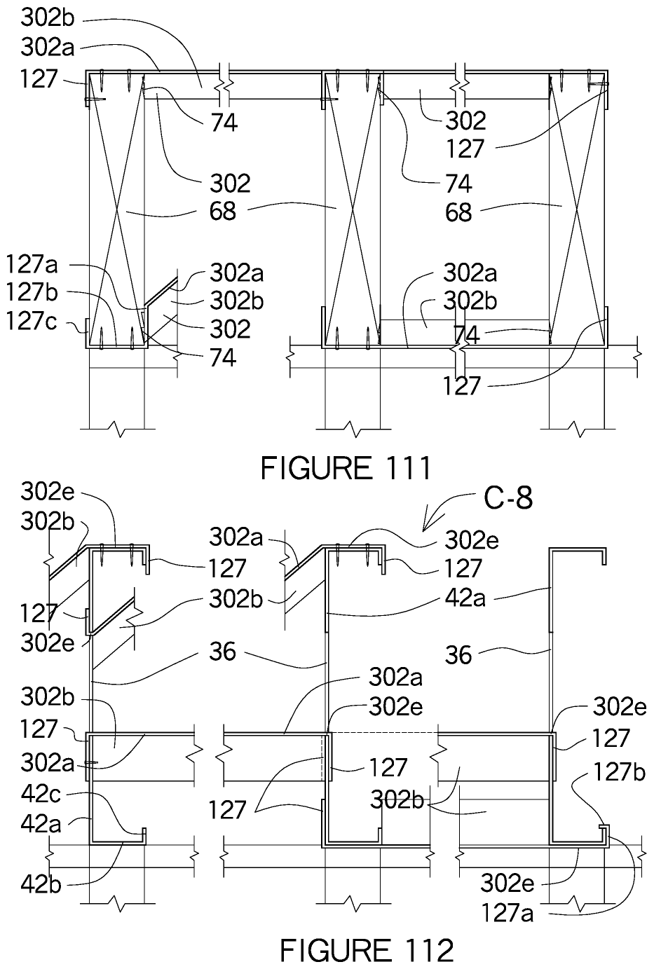

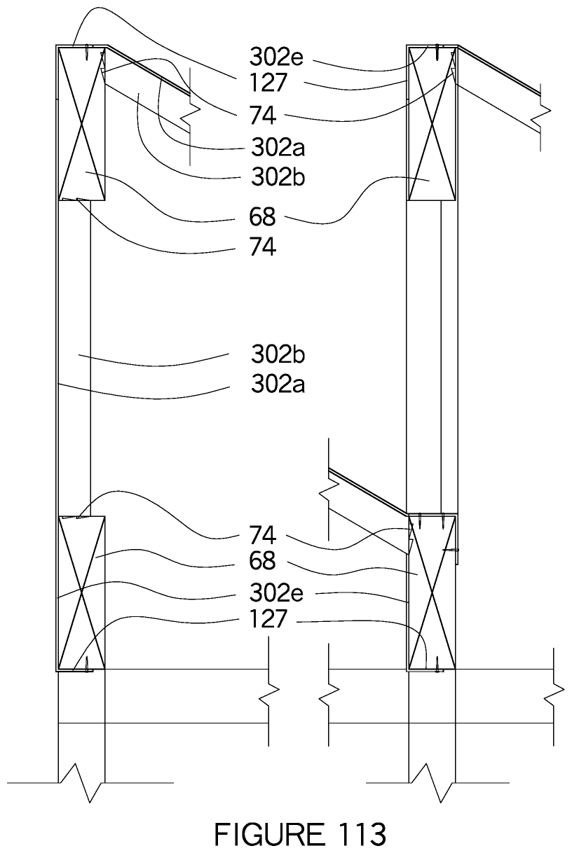

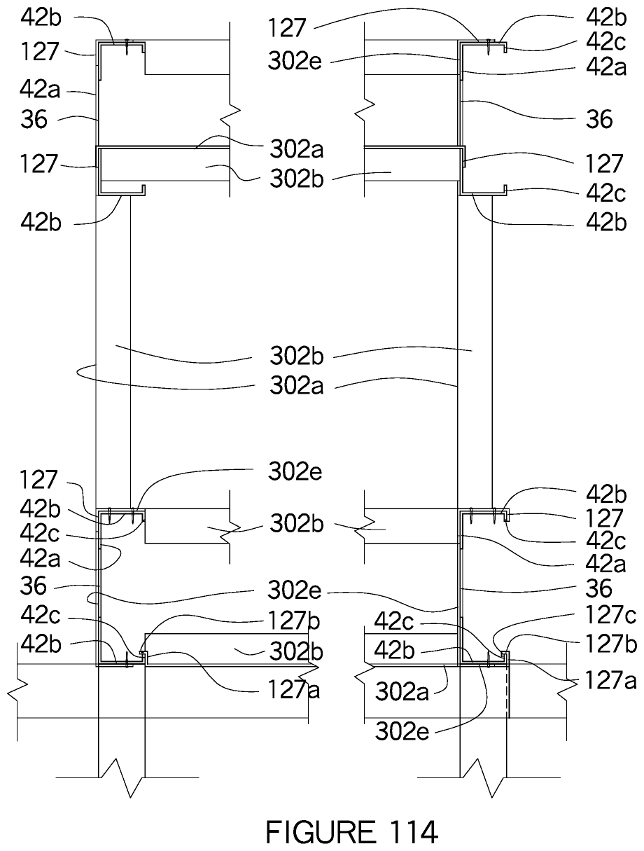

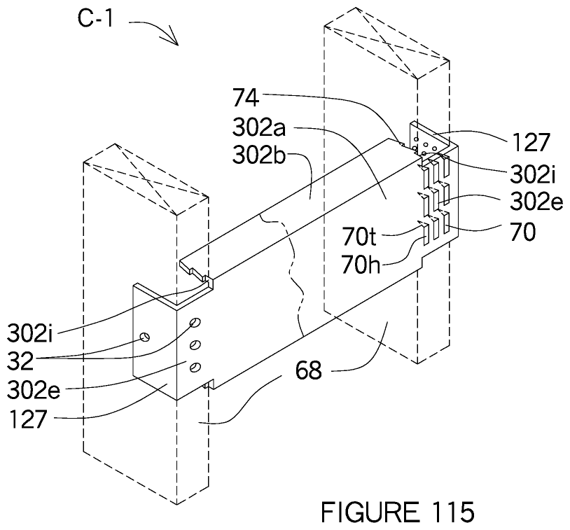

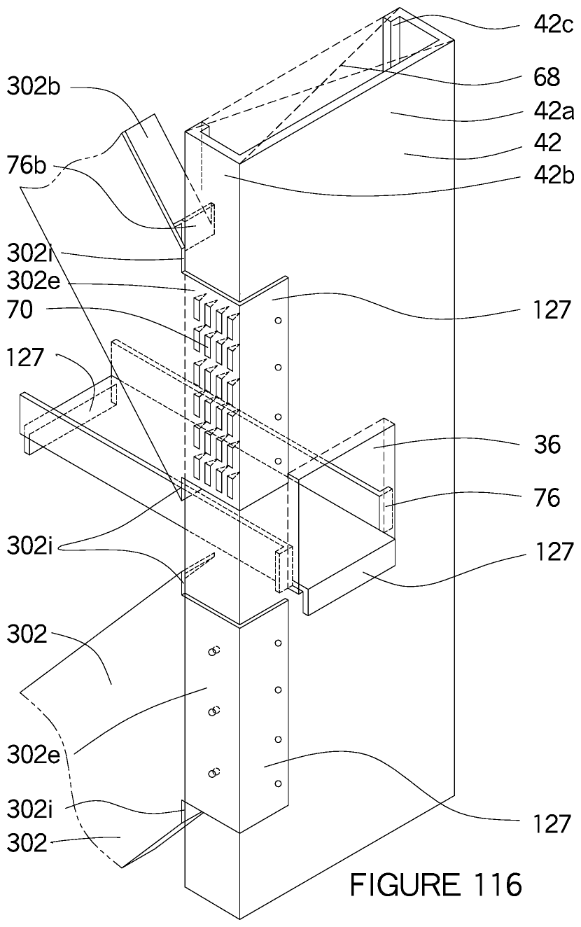

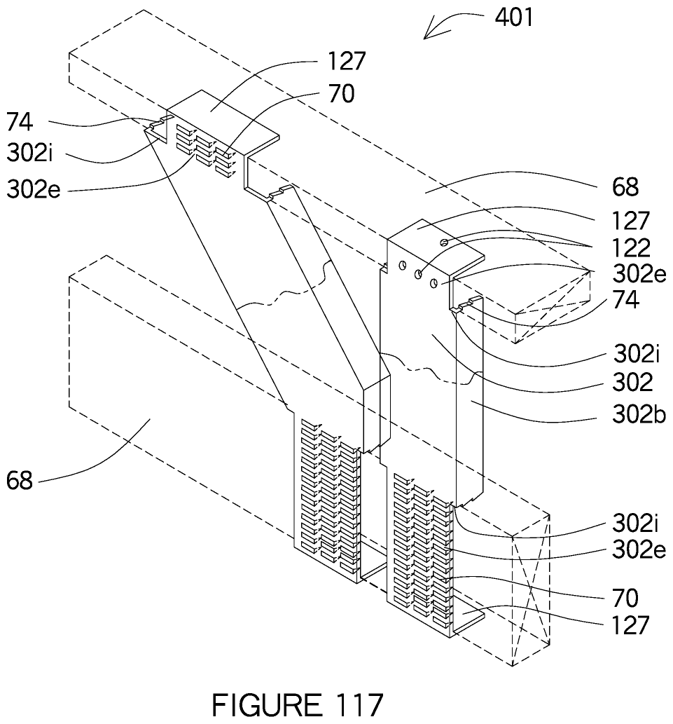

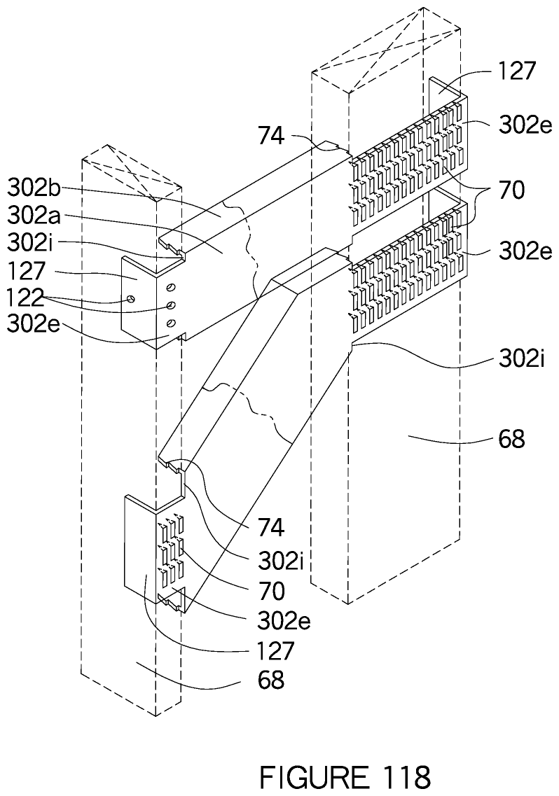

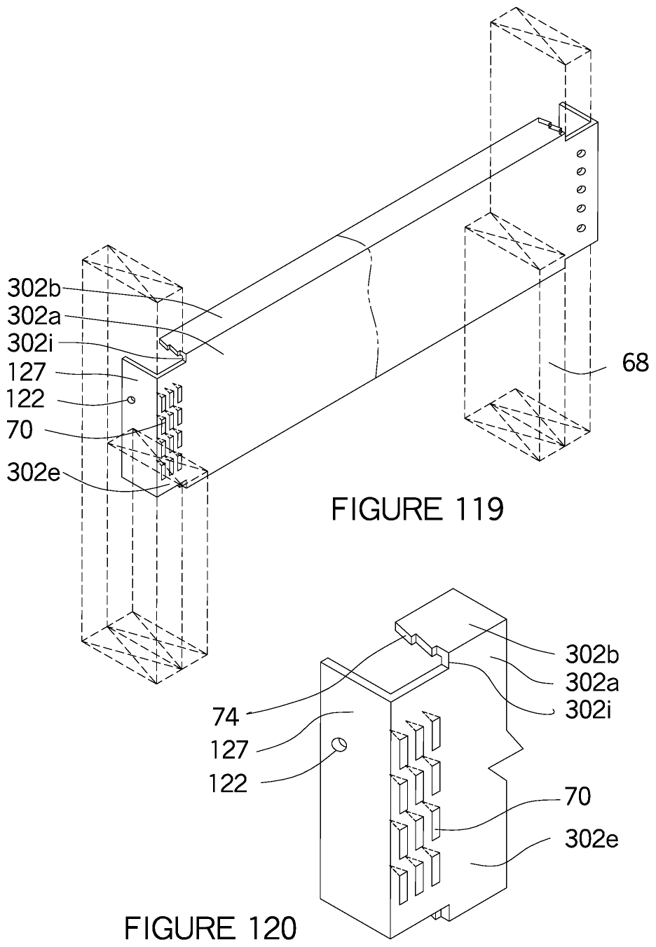

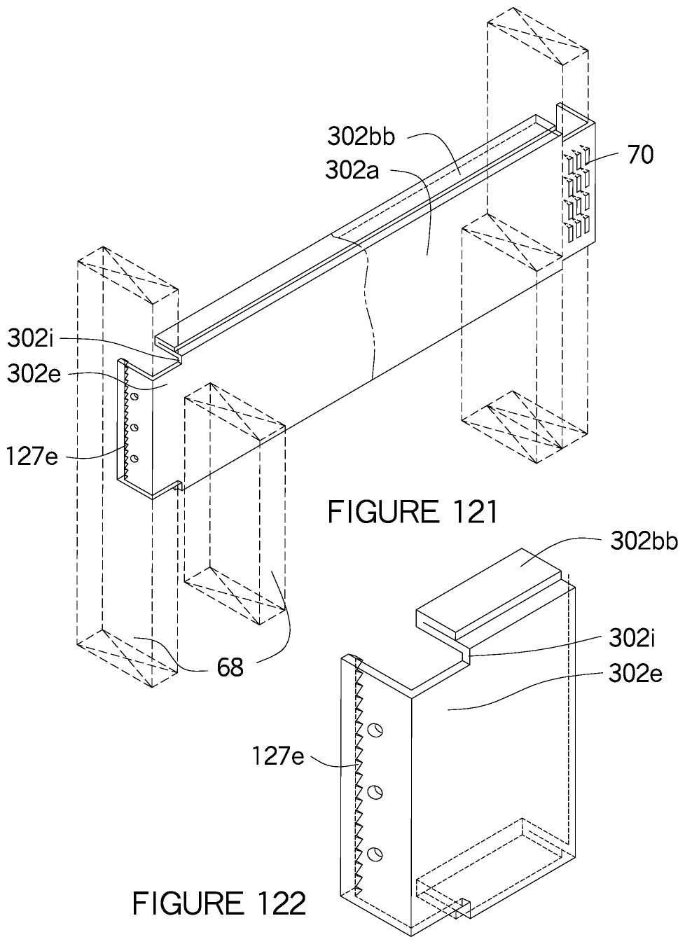

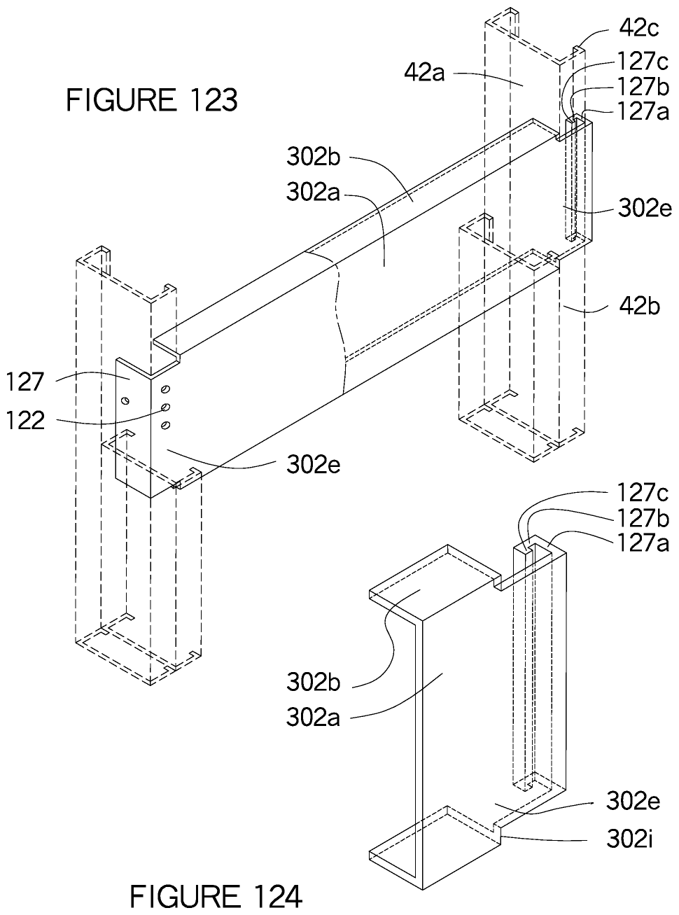

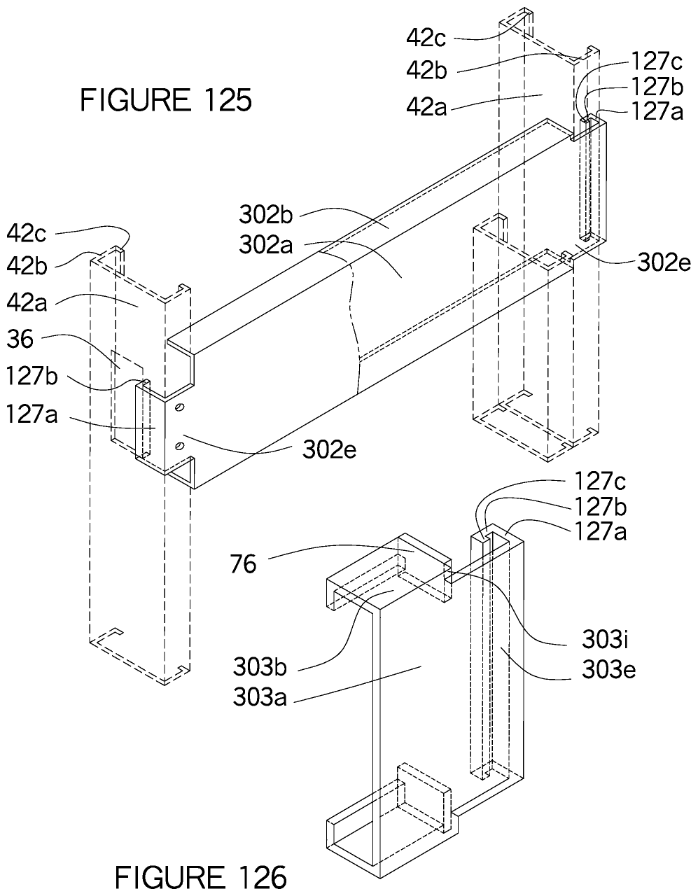

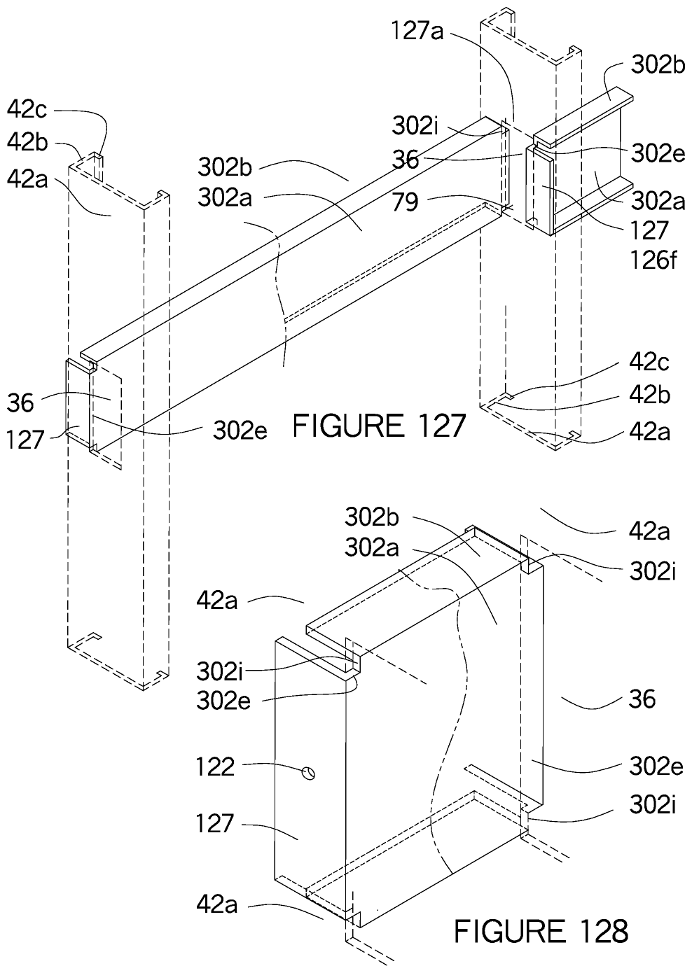

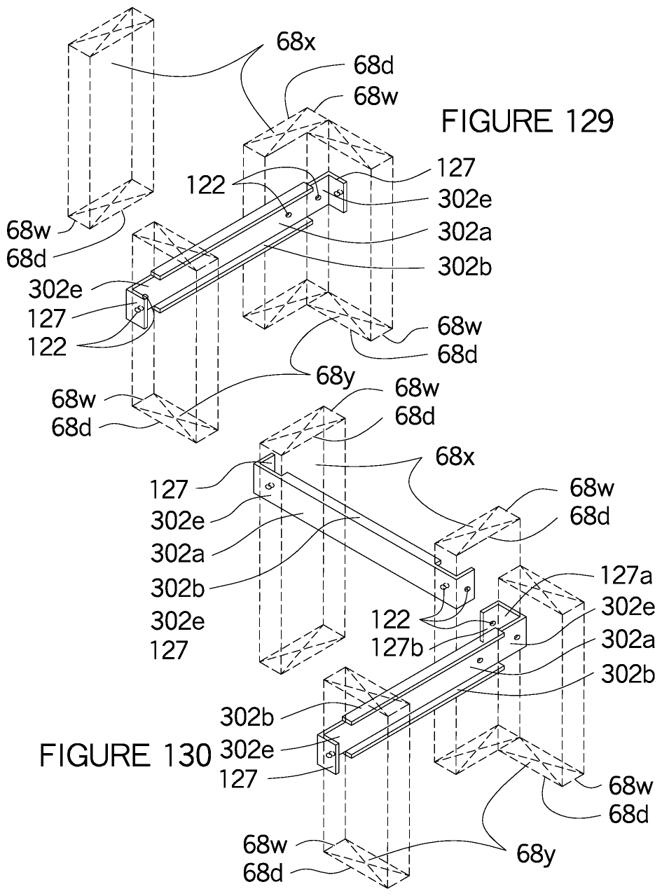

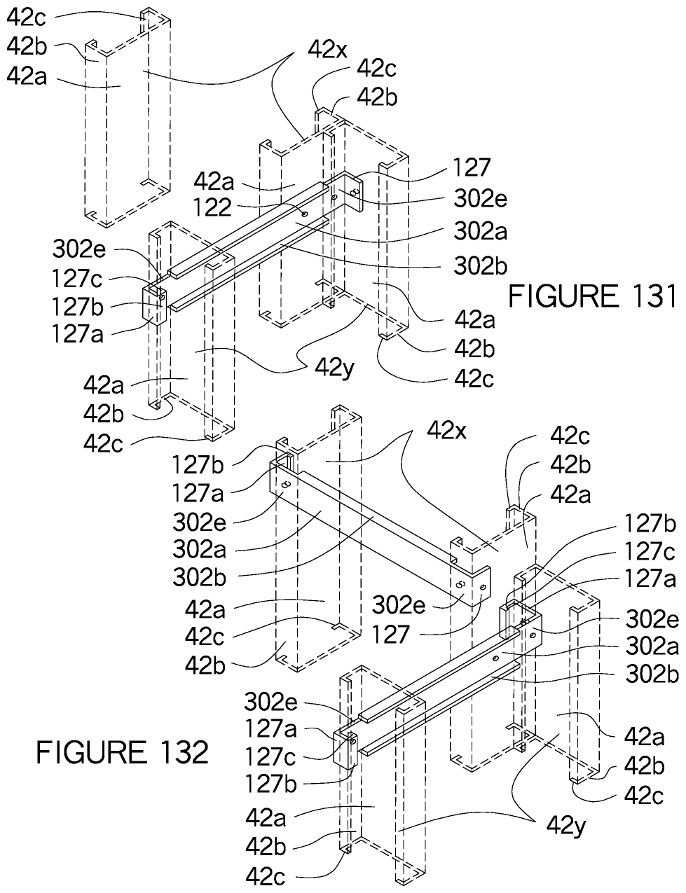

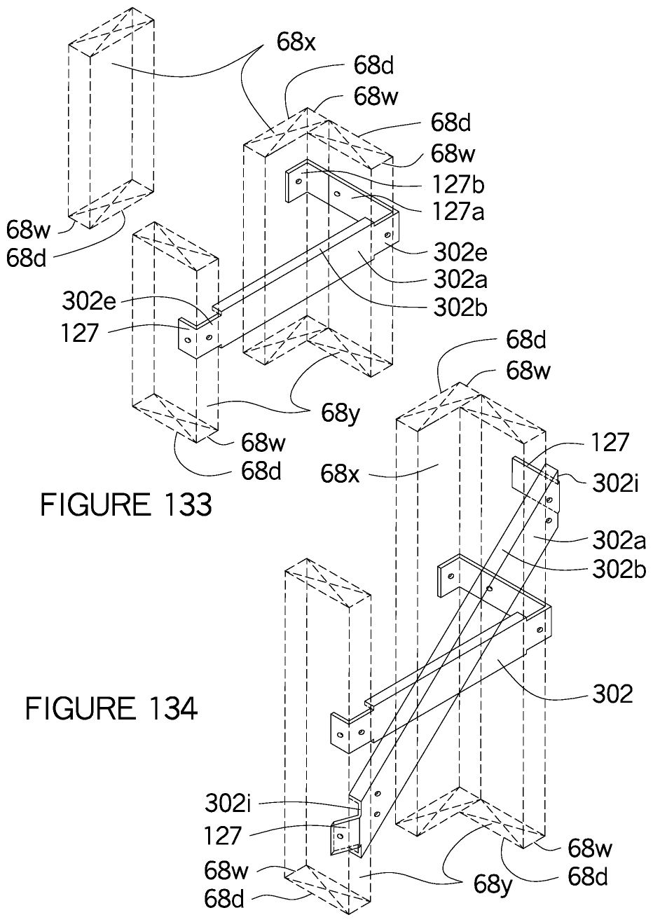

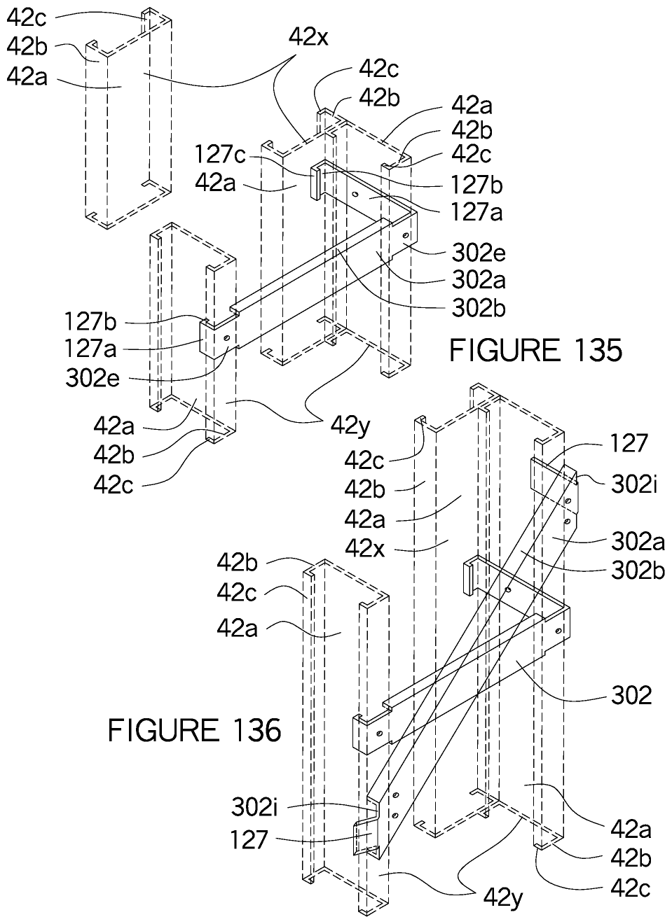

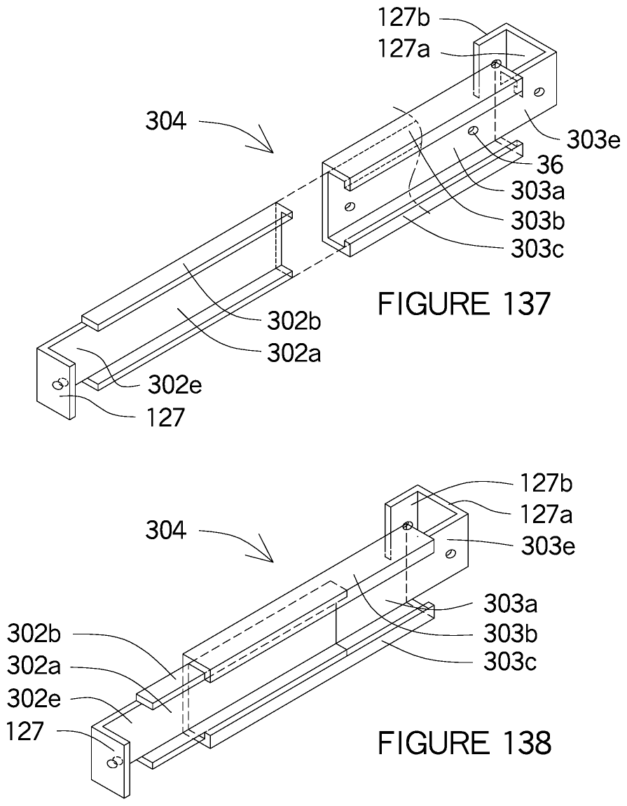

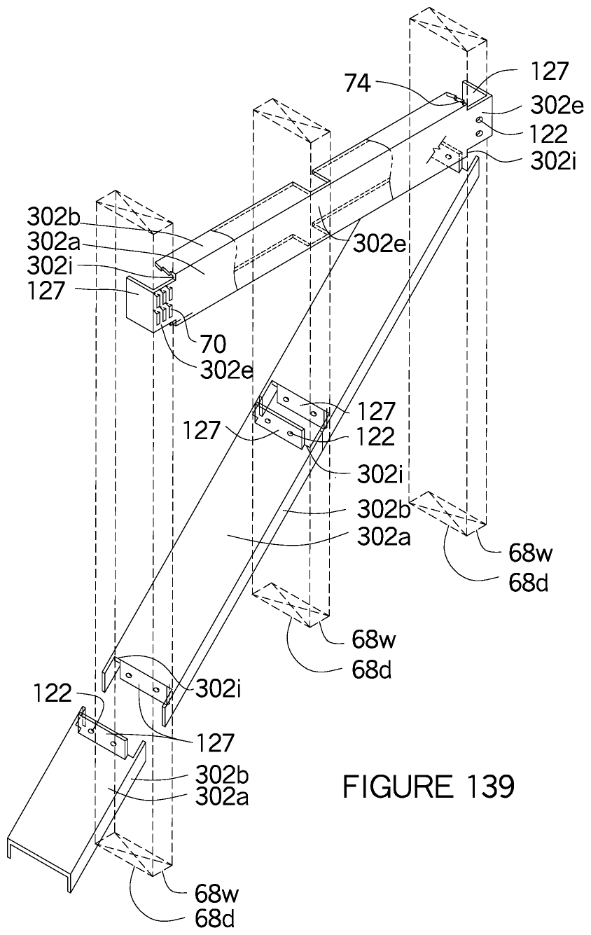

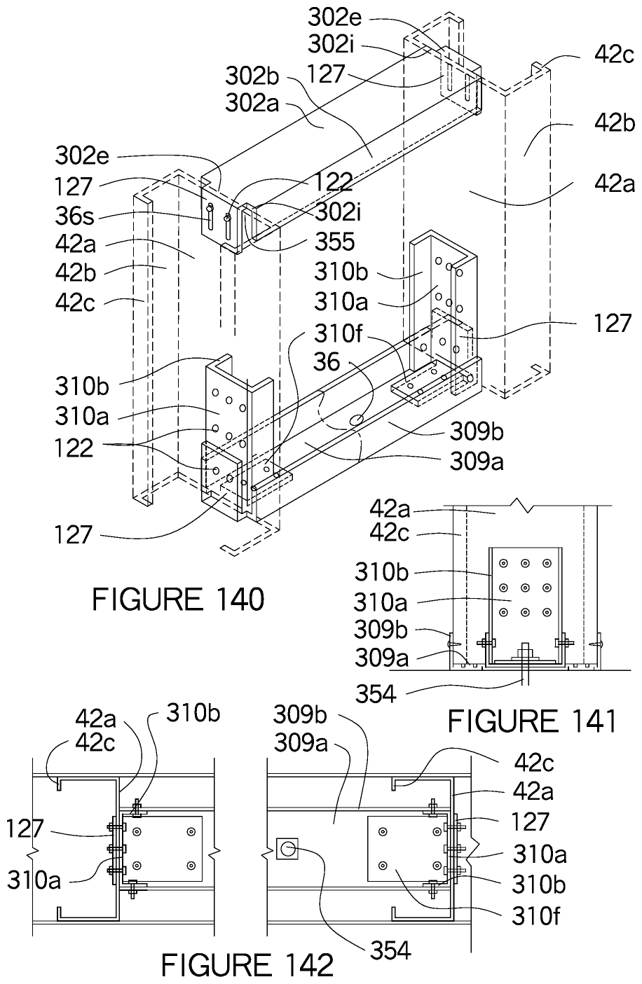

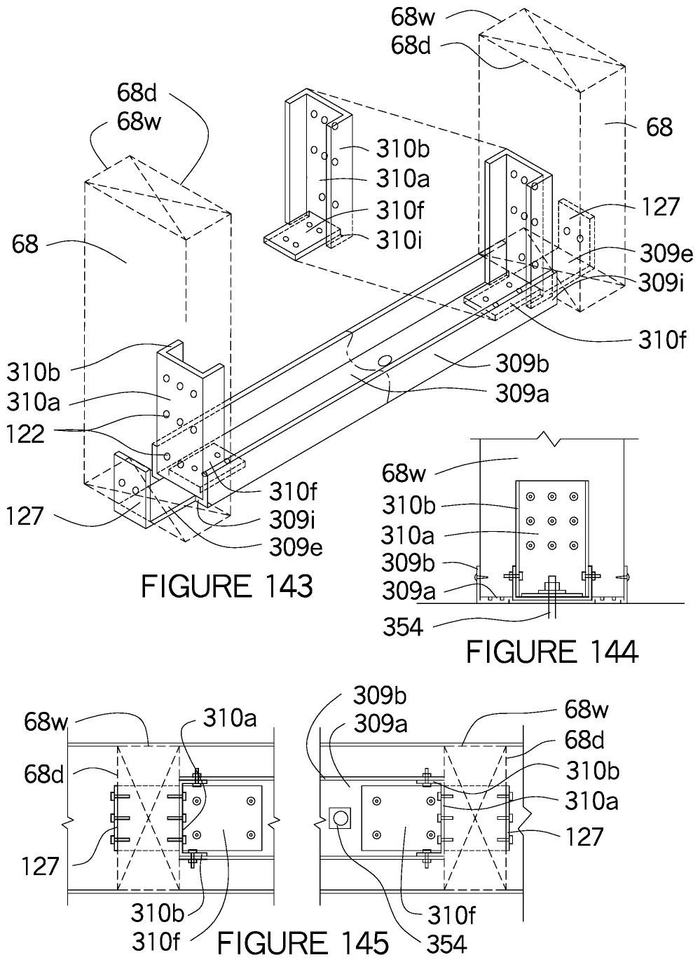

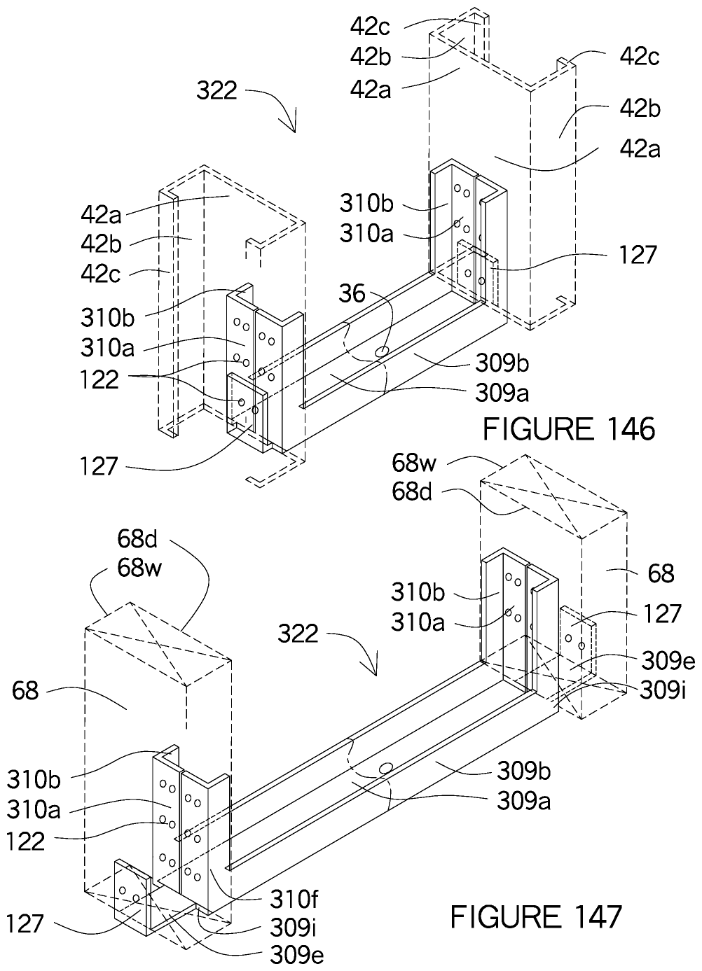

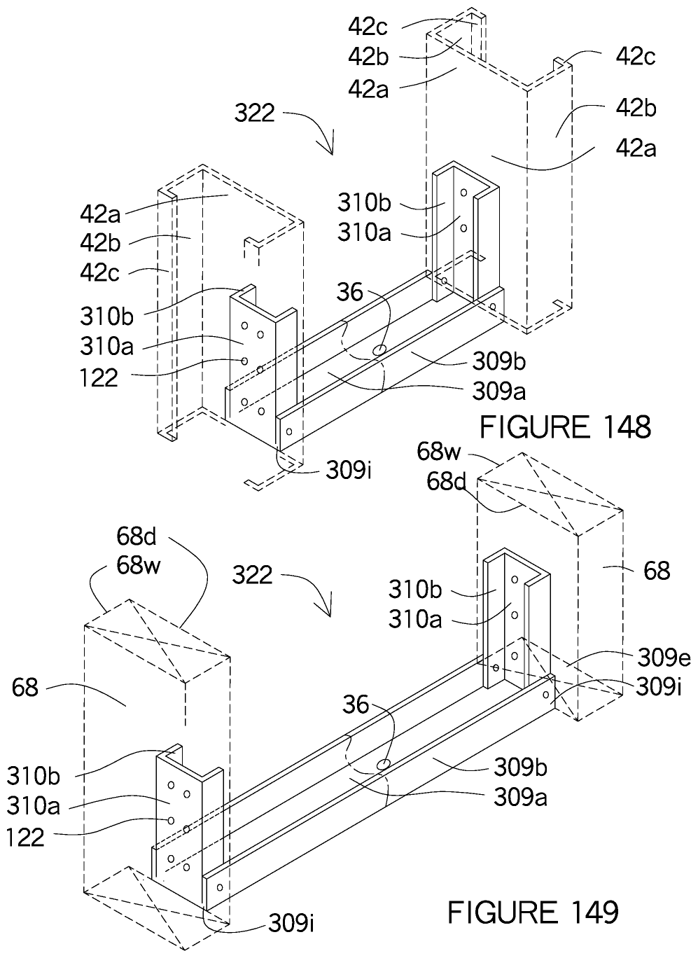

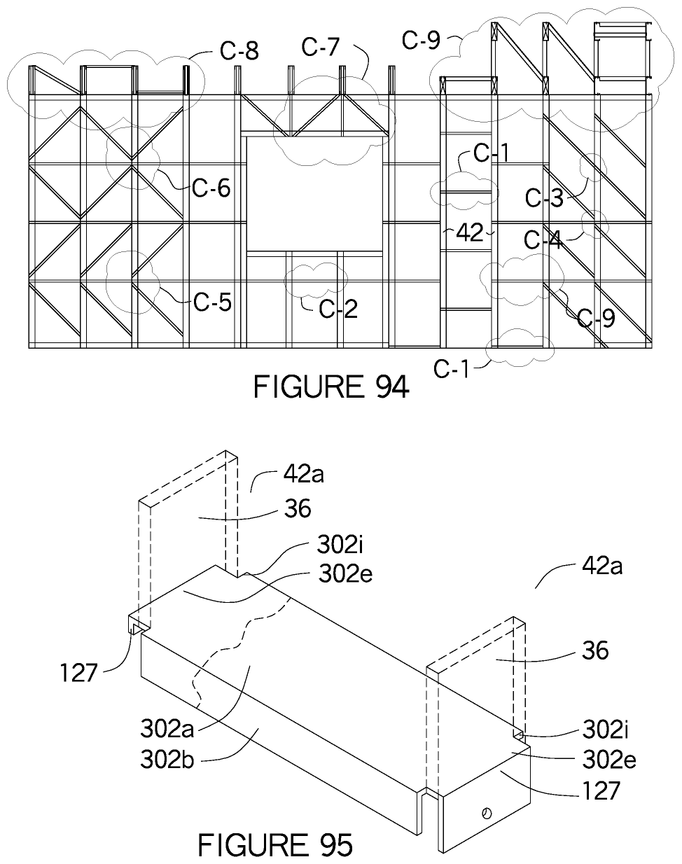

A DESCRIPTION OF THE PREFERRED in FIGS. 94-151 showing various types of horizontal spacing-bracing members connected between metal support framing, but typically emphasizing the U shape spacer brace installed in wood framing and metal support framing for walls and trusses. The horizontal spacing-bracing members are shown as floor anchor bolt framing, horizontal metal framing and brackets spanning between holes of metal support framing as well as wood framing connections having teeth, notches.

FIG. 94 shows an elevation of a metal or wood framed wall showing various clouds or cut away areas of the spacer brace configurations explained in the various figures noted in the drawings. C-1 could be a horizontally oriented spacer brace spanning between the holes in metal support member or spacer braces mounted on the flanges of wood or metal framing or hold down spacer braces mounted on the floor. C-2 could be a continuous spacer brace spanning between intermediate support members at the hole or on the flanges, or individual spacer braces installed in a continuous line in the holes or on the flanges between support members or individual spacer braces installed on both side edges of the hole. C-3 could be spacer braces installed over the flanges or through the holes of wood or metal support members to form a continuous diagonally oriented spacer braces. C-4, C-5 & C-6 show spacer braces mounted on the top and bottom edge of the hole and through the middle of the hole in a metal support member or could be spacer braces mounted between support members or over their respective flanges. C-7 is similar to C-4; C-5 & C-6 except here the configuration is forming a beam above a window. In C-8 the horizontal support members could be wood or metal with the spacer braces used as vertical and diagonal cords to form floor joists and shown with lateral bracing at the top, bottom and connects at the lips of the support members. In C-9 wood floor joists are shown as well as truss joists using wood or metal support members having spacer braces as vertical and diagonal chords of truss joists as well as horizontal and diagonal lateral bracing at the top, bottom or through the holes of the support members. The spacer braces have same characteristics but are used in different applications.

FIG. 95 shows a single spacer brace as shown as C-1 or C-9 in FIG. 94 of an isometric of a downward oriented U shaped spacer brace 302 with the web 302a having the dorsal side at the top side with two parallel flanges 302b extending ventrally downward from the web 302a and shown installed in a hole 36 (shown in ghost) at the web 42a between support channels shown as a C channels 42. In FIG. 94 the cloud formation C-1 has the support member shown vertically and in C-9 the support member is horizontal, but in both cases the U shaped spacer brace 302 is shown passing through a hole 36. The U shaped spacer brace can be equal in width of the hole 36 or wider than the hole 36. The web 302a has an indentation 302i, with an extension 302e so the hook finger 127 fits against the bottom edge of the hole 36 and against the web 42a of the support member. The web 302a and the parallel flanges 302b fit against the opposite edge of the web 42a forming an indentation 302i securing the U shaped spacer brace 302 to the hole 36. The hook finger 127 can be longer so a fastener can be used to secure the hook finger 127 to the web 42a or to another hook finger 127 should one hook finger 127 be installed over another hook finger 127 as shown in FIGS. 94 & 94 when installed at an angle. The single spacer brace can also be used as a base plate at the floor as shown as C-1 in FIG. 94. The U shaped spacer brace 302 can be used as a spacer to evenly space the support members within the wall framing or as a full width base plate typically used in building construction.

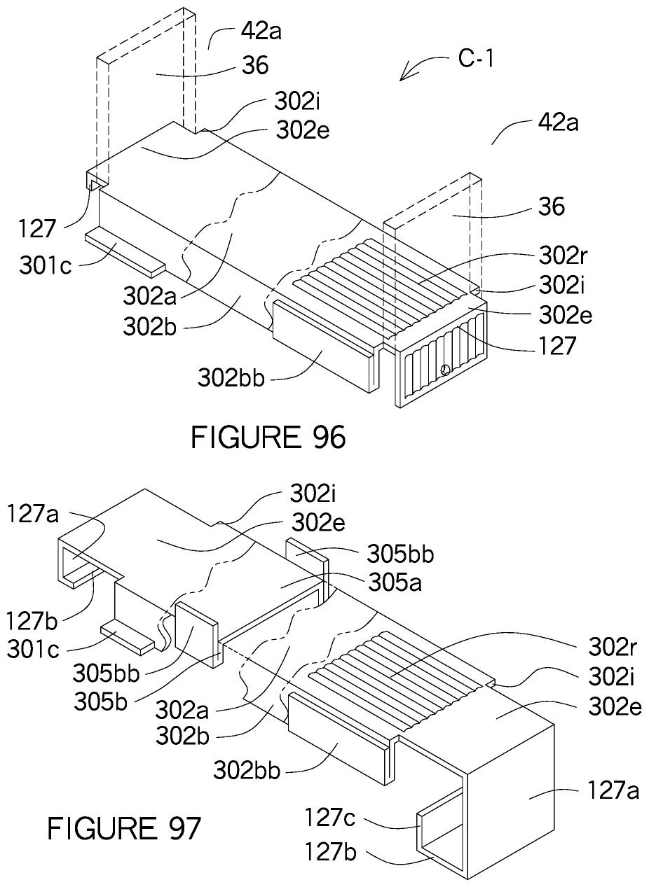

FIG. 96 and FIG. 97 show an isometric drawing of a spacer brace having different configurations. One variation shows a downward oriented U shaped spacer brace 302 having an elongated body with a web 302a having two flanges 302b extending downward from the ventral side of the web 302a. The U-shaped spacer brace 302 is shown where the dorsal is oriented horizontally and two flanges 302b extend downward from the ventral side. Another variation shows a reverse lip spacer brace 301 having a U shape with a lip 301c extending from the bottom edge of the flange 30bb in an outward direction away from the web 301a and better shown as a reverse lip brace 301 in FIG. 94. Another variation of the U shaped spacer brace 302 has the flange 302b shown as a double flange 302bb where the flange 302b is bent twice to increase the strength. Another variation shows an I shape spacer brace 305 where the flanges 305b and 305bb are slightly different than the reverse lip brace 301 as the flange 305b extends downward from the web 305a then bents upward to form flange 305bb, but extends above the web 305a forming an I shape at the both flanges. By forming grooves, indentations or ribs 302r in the direction of the elongated spacer brace the metal surface is broken and the ribs 302r will increase the strength of the elongated spacer brace. The thickness of the metal to form the spacer brace can increase in thickness to increase the strength of the spacer brace. The left side shows and an indentation 302i extend from the flanges 302b and into the web 302a where the web 302a has an extension 302e with a hook finger 127 extending ventrally downward forming an L-shaped hook where the first leg is 127a and the second leg 127b for an L-shape. The right side shows a U-shape at the end of the hook finger 127 where the first leg is 127a, then bent again shown as 127b, then bent upwards shown as 127c. The L-shape can be used where the hook finger 127 extends into the hole 36 in the web 42a of a support member and the U-shape can be used where the hook finger 127 extends around the lip 42c of the support member.

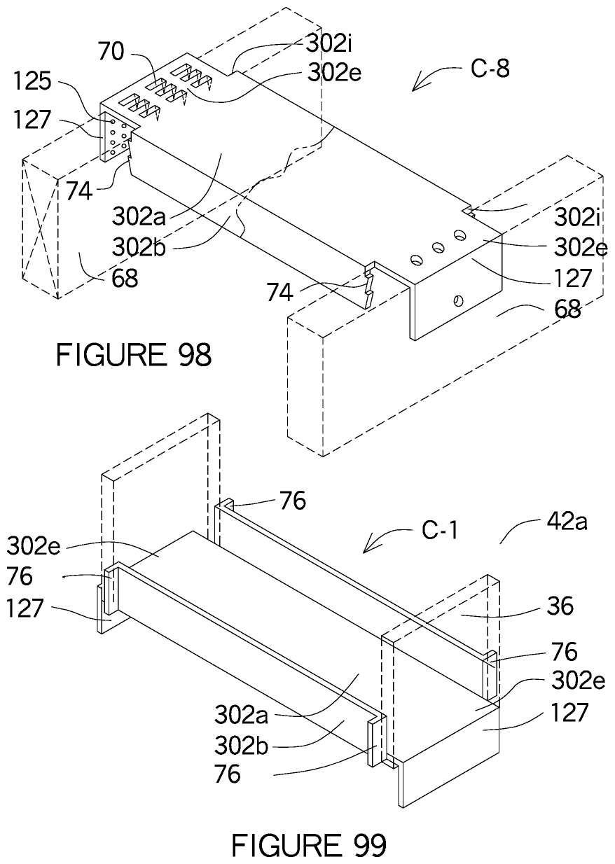

FIG. 98 is similar to FIG. 94 except the wood framing members 68 are oriented horizontally instead of vertically as shown in FIG. 1 in C-8 at the rafters or truss joists. The U-shaped spacer brace 302 has the dorsal horizontally oriented and the flanges 302b extend ventrally downward with the jagged edges 74 penetrating the wood framing members 68. The dorsal side of the web 302a can have holes for nails to penetrate the wood framing members 68 or punched hole teeth 70. The ventral side of the hook finger 127 has dimples 125 as an abrasive means for a better connection since wood framing members 68 usually have an uneven surface. Punched hole teeth 70 are shown on the dorsal side of the extension 302e in the U-shaped spacer brace 302 so the teeth 70t for the punched hole 70h can penetrate the wood framing member 68.

FIG. 99 is similar to FIG. 95, however the U-shaped spacer brace 302 is facing upward and the web 302a has the dorsal side on the bottom side. When the width of the U-shaped spacer brace 302 is equal or narrower than the width as the hole 36, the web 302a is narrower than the bottom edge of the hole 36 and the extension 302e passes through the hole 36 then bent over the bottom edge of the hole to form an hook finger 127. There is no indentation 302i since the width of the web 302a is smaller than the width of the hole 36. The flanges 302b extend upward from the web 302a of the U-shaped spacer brace and the ends of the flanges 302b have a flap 76 that is bent so the sides of the flaps 76 brace against the web 42a of the support members.

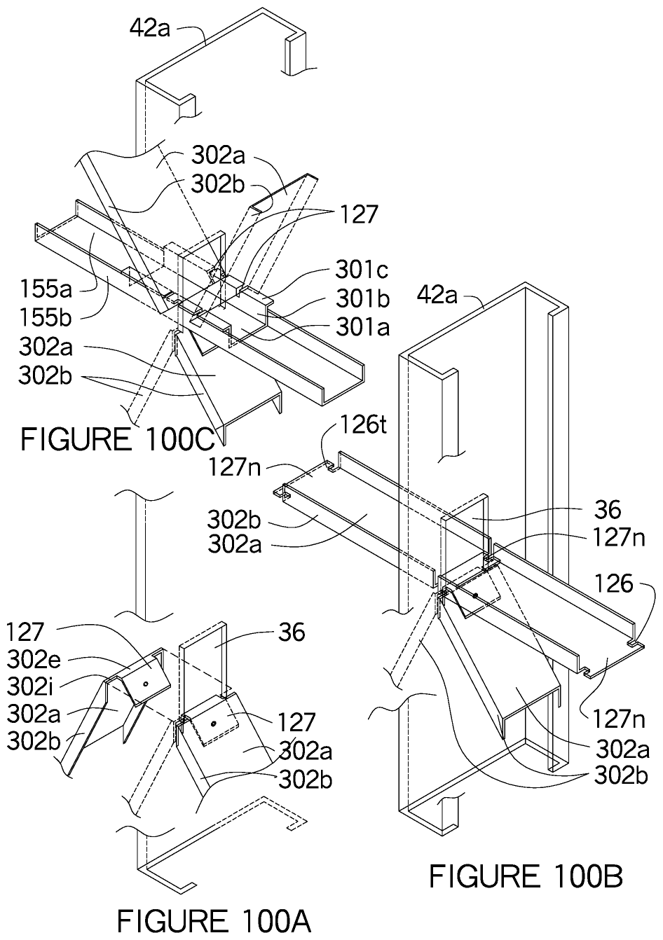

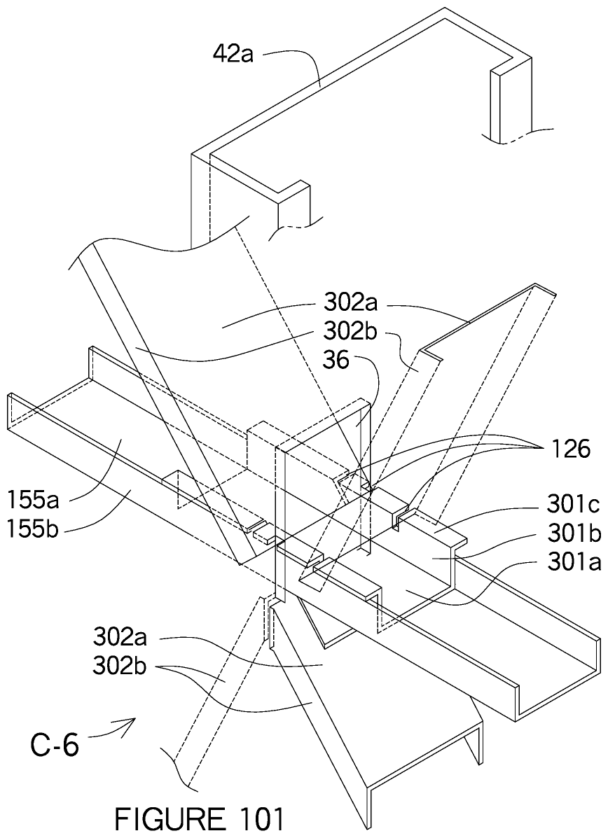

FIGS. 100A, 100B & 100C is similar to C-5 & C-6 in FIG. 94 as the spacer braces are shown diagonally installed in the metal framed wall where six intersecting U shaped spacer braces 302 intersect at the same hole 36 and all the U shaped spacer braces 302 are wider than the hole 36. In order to show the U shaped spacer braces 302 being continuous FIG. 100A, 1006 & 100C show an enlargement of three different holes 36 in the support members as additional U shaped spacer braces 302 intersect at the holes 36 in the support member. The diagonally oriented spacer braces 302 are shown having the dorsal side of the web 302a with its top side facing upward with the two parallel flanges 302b extending ventrally downward along with a horizontally oriented spacer brace 302 having the web 302a on the downside with the two parallel flanges 302b extending ventrally upward. FIG. 100A shows two diagonally oriented spacer braces where the right U shaped spacer brace 302 has the extension 302e and hook finger 127 passes through the hole 36 with the hook finger 127 bent parallel to the web 42a of the support member and the left U shaped spacer brace 302 has the extension 302e and hook finger 127 pass over the right U shaped spacer brace 302 with the right hook finger 127 fastened to the top side of the right U shaped spacer brace 302. FIG. 100B shows the two upward facing horizontally oriented U shaped spacer braces 302 having the dorsal side on both ends of the bottom side of the web 302a of each U shaped spacer brace 302 having notches 126 at the end or notch-web fingers 127n. The notch-web finger 127n passes through the hole 36 and the end of the notches 126 has tabs 126t at the end that give support to the notches 126 when extending past the hole 36. The notch 126 is formed by installing the notch 126 at the side edges of the web 302a leaving the notch 126 having the web 302a on one side and the opposite side having a tab 126t be the remaining end of the notch-web finger 127n. The notch-web finger 127n of the adjacent horizontally oriented U shaped spacer brace 302 is placed over the notch-web finger 127n of the first horizontally oriented spacer brace 302 with its notch 126 and tab 126t engaging the hole 36. Since the horizontally oriented U shaped spacer braces 302 are wider than the hole 36 the edges of the web 42a and two parallel flanges 302b abut the web 42a for the support member as well as the tab 126t at the end of the notches 126. FIG. 100C and enlarged as FIG. 101 shows a upward orient bracing member shown as a horizontal bracing channel 155 passing through the hole 36 with the dorsal side of the web 155a as its bottom side with the two parallel flanges 155b extending ventrally upward. A one piece multi-plane brace 301 having the dorsal side of the web 301a and the two parallel flanges 301b placed within the horizontal bracing channel 155 so the dorsal sides of the web 301a and flanges 301b abut the top side or ventral side of the web 155a and flanges 155b leaving the lips 302c extending over the top edge of the flanges 155b so the web 24a can be inserted into the notches 126 in the lip 301c securing the one piece multi-plane brace 301 into place at the hole 36. The upward facing one piece multi-plane brace 301 also has angular oriented notches 126 installed in the lips 301c and the upper side of the two parallel flanges 301b forming continuous notches 126. Diagonally oriented U shaped spacer braces 302 have their web 302a with its dorsal side facing upward on its top side into the diagonally oriented notches 126 and where the opposite end is shown being installed in FIG. 100A. FIG. 101 shows an enlargement of FIG. 100C. Whether the spacer braces or U shaped or reverse lip shapes, upward facing or downward facing the spacer braces are interchangeable as well as most of the interlocking connections at the hole 36.

FIG. 101 is similar an enlargement of FIG. 100C. The support member is shown as a U channel 155 and the web 155a has the hole 36. All the horizontal oriented and diagonal spacer braces 302 are shown with the width of the webs 302a fit between the parallel flanges 155b and the diagonally oriented spacer braces 302 have indentations 302i, extensions 302e and hook shapes upward or downward oriented connect to the top or bottom edge of the hole 36 or connect to the web 302a of the adjacent diagonal spacer brace 302. The horizontal oriented spacer braces 302 have the same notch 126 and tab 126t configuration as described in FIG. 100C.

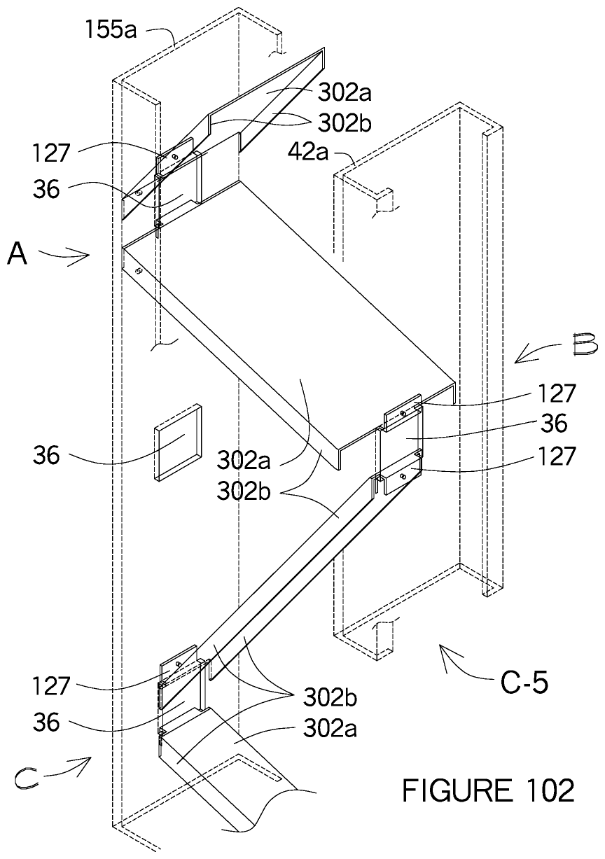

FIG. 102 shows two diagonal spacer braces 302 spanning between the holes 36 of two support members shown as a C channel 42. The U shaped spacer brace 302 face downward with the dorsal side being on the top side with the two flanges 302b extending ventrally downward. The end of each U shaped spacer brace 302 has the hook fingers extending through the hole 36 with the extension 302e abutting the top or bottom edge of the hole 36 with an indentation 302i occurring at the hole 36 where the web 302a is wider than the hole 36. The isometric drawing shows two support members as C channels 42 with holes 36 in the web 42a with downward facing U shaped spacer braces having the dorsal on the top side shown as web 302a and two flanges 302b extending outward and spanning between the holes 36 at a diagonal. The hole 36 in Drawing A shows a U shaped spacer brace 302 spanning from the bottom edge of hole 36 to the upper edge of hole 36 in Drawing B. Another U shaped spacer brace 302 spans from the bottom edge of hole 36 in Drawing B to the upper edge of hole 36 in Drawing C. Each of the U shaped spacer braces 302 are wider than the width of the hole 36 and the extension 302e with a hook finger 127 pass through the hole 36, that is bent either upward or downward and are fastened to the web 42a of the support member. The configuration of the hole 36 allows for a continuous horizontal bracing member or spacer brace to pass through the hole 36 adding additional horizontal structural bracing between support members.

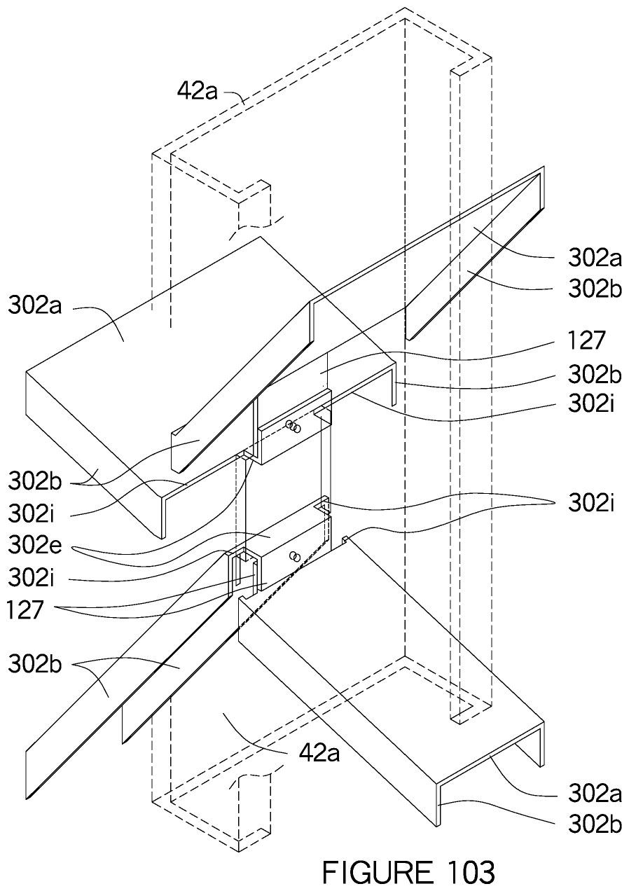

FIG. 103 also shows the diagonally oriented U shaped spacer braces 302 however two additional diagonally oriented U-shaped spacer braces 302 have been add plus the hole 36 could have additional horizontal spacer braces added. The diagonally oriented U-shaped spacer braces 302 have the dorsal on the top side have a web 302a and two flanges 302b extending downward. The upper left U-shaped spacer brace 302 shows the an indentation 302i at the flanges 302b and at the web 302a leaving and extension 302e extend through the hole 36 and bent at the hook finger 127 upward and the right U-shaped spacer brace 302 also has the indentation 302i and extension 302e so the hook finger 127 can be bent downward and fastened together. The lower left U-shaped spacer brace 302 shows the an indentation 302i at the flanges 302b and at the web 302a leaving and extension 302e extend through the hole 36 and bent at the L-shaped hook finger 127 downward and the right U-shaped spacer brace 302 also has the indentation 302i and extension 302e so the L-shape hook finger 127 can be bent upward and fastened together. Since the L-shape hook finger 127 aligns with the flange 302b an indentation 302i occurs at the web 302a. Since both U shaped spacer braces 302 intersect at the same top or bottom edges of the hole 36 the extensions 302e and the ends of the hook finger 127 overlap each other and will become fastened together after being installed.

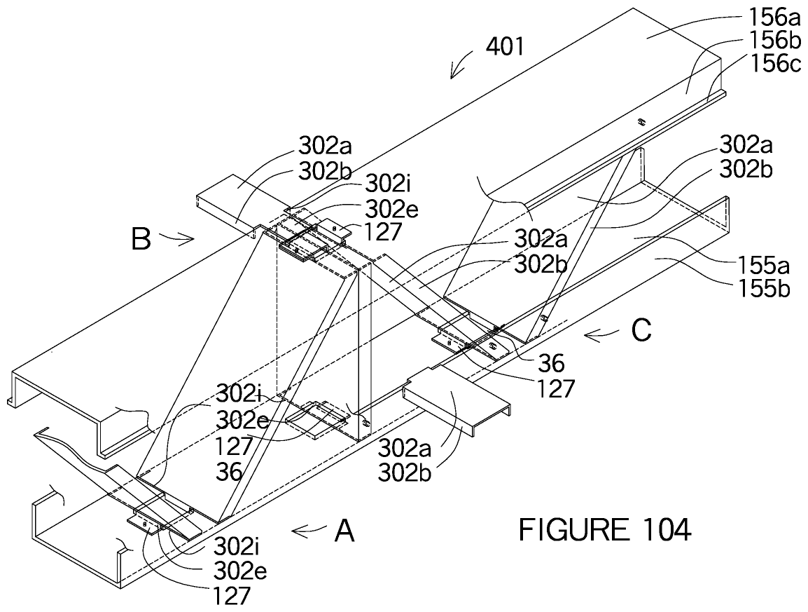

FIG. 104 is an isometric view of a horizontally oriented truss joist 401 which can be used as a window or door header shown as vertical wall framing in FIG. 10 and shown in the elevation of FIG. 94. The horizontally oriented truss joist 401 is shown having diagonally oriented U shaped spacer braces 302 span between holes 36 in the horizontally oriented support members shown as a C shaped channel 42 having a horizontally oriented web 42a with two vertically oriented parallel sides 42b with lips 42c extending inwardly from the parallel sides for additional strength if required. The width of the U shaped spacer braces 302 are wider than the width of the hole 36 and only the extension 302e and the hook shape extend through the hole 36 where the hook finger 127 braces the web 42a on one side and the ends of the top side 302a or bottom side 302d of the U shaped spacer brace 302 plus the ends of the two parallel sides secures the U shaped spacer brace 302 to the horizontally oriented support member. A vertically oriented U shaped spacer brace 302 (shown in ghost) are required to be wider than the diagonally oriented U shaped spacer braces 302 in order to fit around the two parallel sides 302b with the extensions 302e and the hook finger 127 fitting through the holes 36 and engaging the hole 36 at the hook finger 127 and the edges of the top sides 302a or bottom side 302d and the two parallel sides fitting against the web 42a. The vertical spacer brace is sometimes required to distribute the structural load forces within the truss joist.

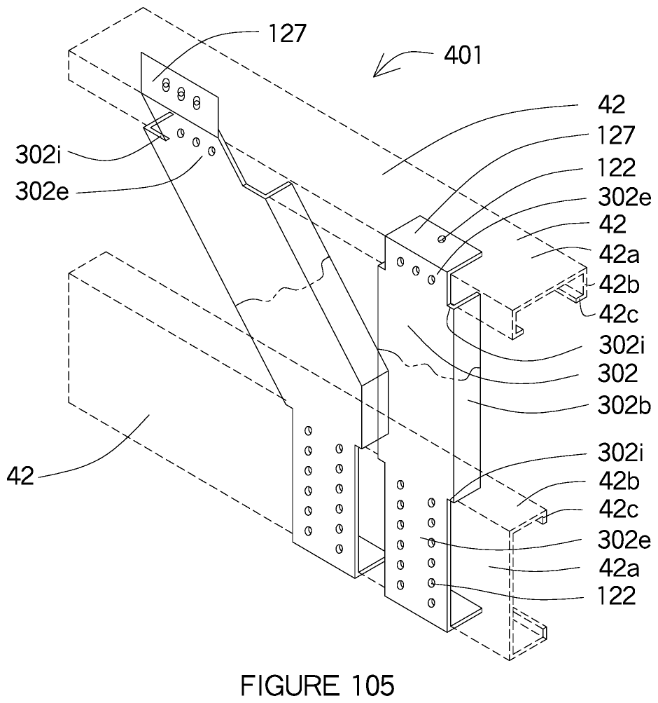

FIG. 105 is similar to FIG. 105 as they are both truss joist 401; however the FIG. 105 uses metal framing member as the support members. The top chord (shown in ghost) shows a C channel 42 with the dorsal side having a web 42a oriented horizontally with two sides extending vertically with lips 42c extend horizontally inward to each other and are parallel to the web 42a. The lower chord (shown in ghost) of the truss joist 401 shows a C channel with a vertical dorsal having a web 42a with two sides extending outwardly connected with lip extending inwardly toward each other. The U-shaped spacer braces 302 connect the top and bottom chords where the dorsal sides are vertical and have a web 302a with two extending sides 302b that abut the ventral side of the lip 42c of the upper chord and the top side of flange 42b of the bottom chord. The web 302a of the U-shaped spacer brace 302 has an indentation 302i and an extension 302e that extends over the upper chord flange 42b and the web 42a of the lower chord and both the hook finger 127 wraps around the chords of the truss joist 401 at the top side 42a of the horizontally oriented chord and the bottom side flange 42b of the bottom chord. The diagonally oriented spacer braces continually are placed between the top and bottom chords at repeating intervals until the truss joist 401 has reached its designated length. The left diagonally oriented U-shaped spacer brace 302 shows the top chord of the truss joist 401 having the extension 302e and the hook finger 127 extended parallel to the direction of the spacer braces rather than perpendicular as previously shown.

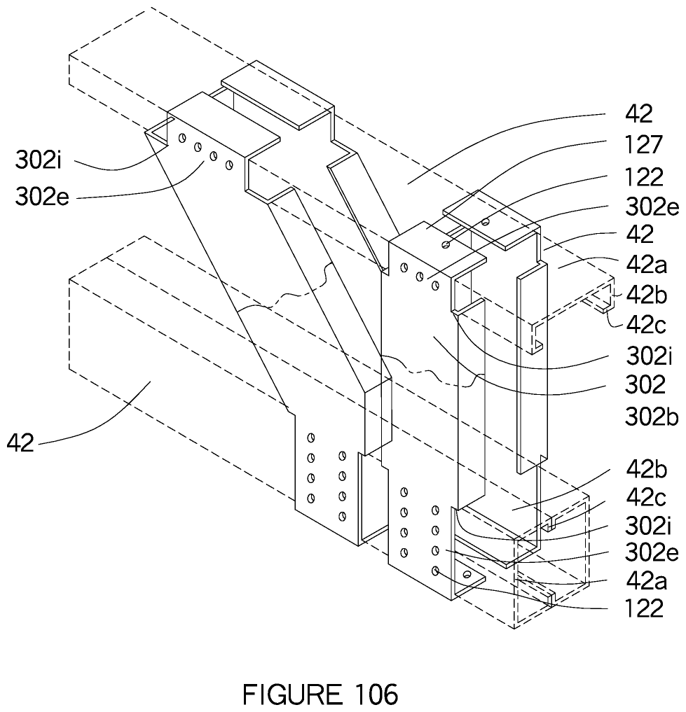

FIG. 106 is a double of FIG. 105. The lower chord (shown in ghost) has another horizontal C channel 42 adjacent to the first C channel where the lips 42c abut each other. Since the top chord (shown in ghost) is orientated horizontally that is the dorsal is horizontal rather than vertical, the second U-shaped spacer braces 302 can be installed as described in FIG. 105.

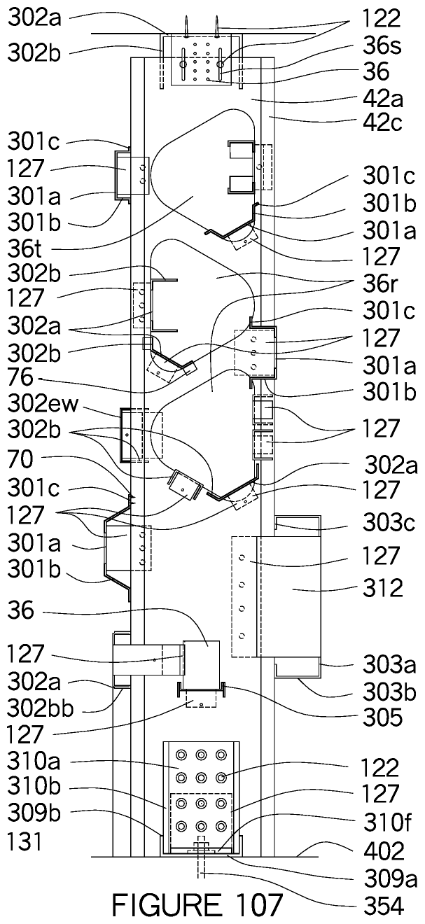

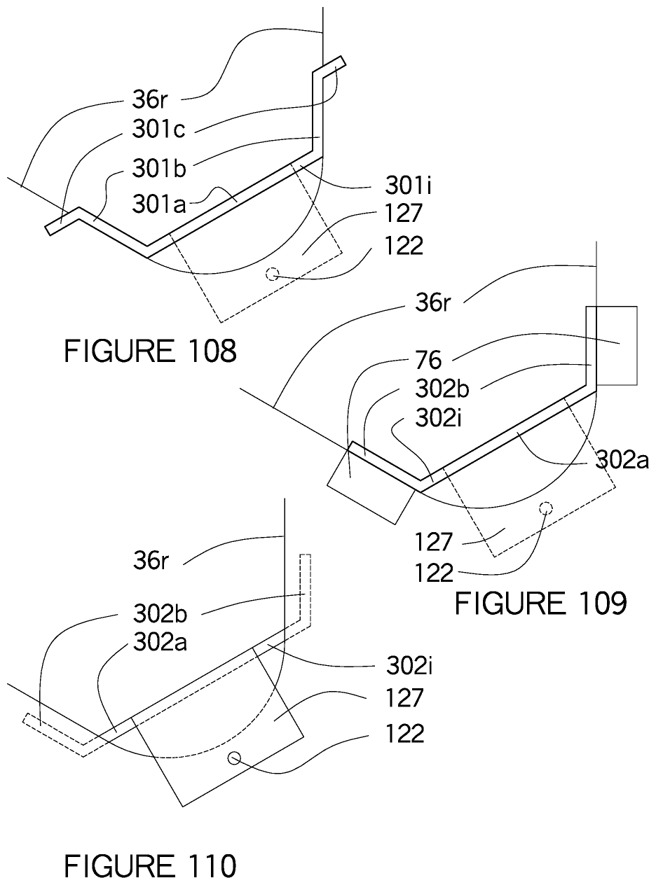

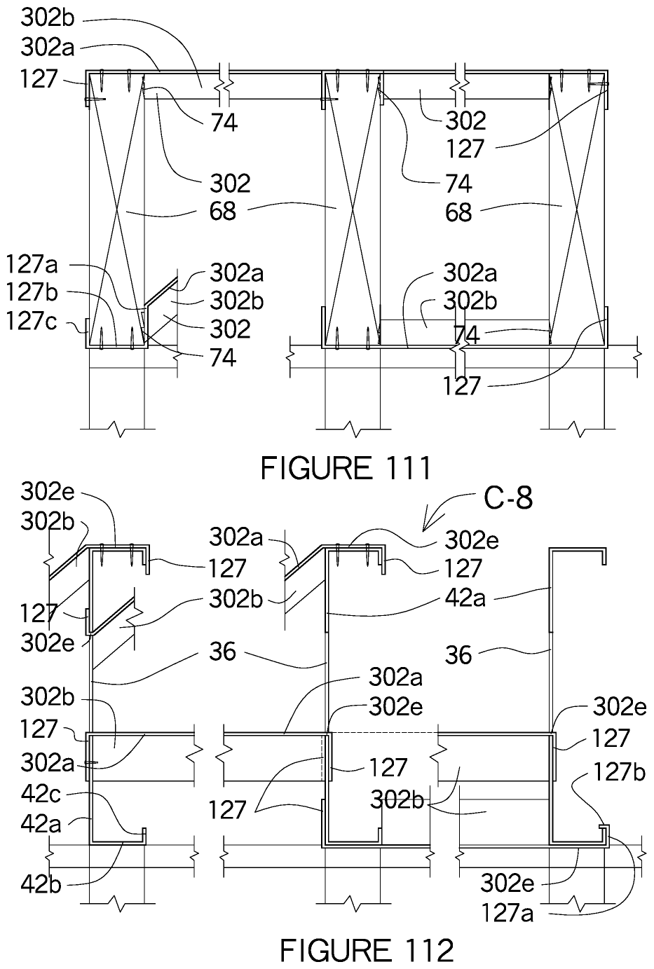

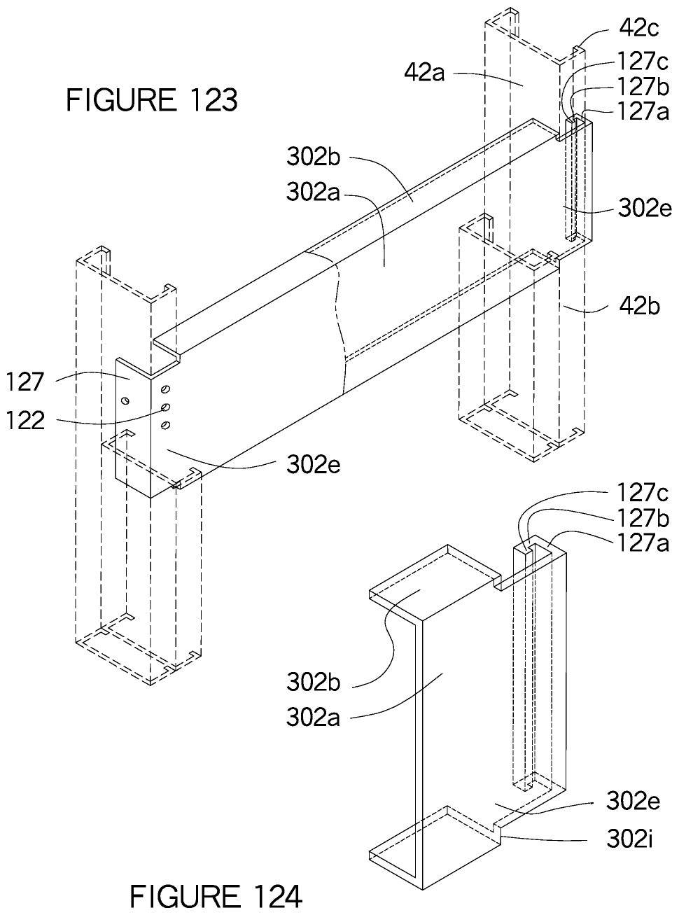

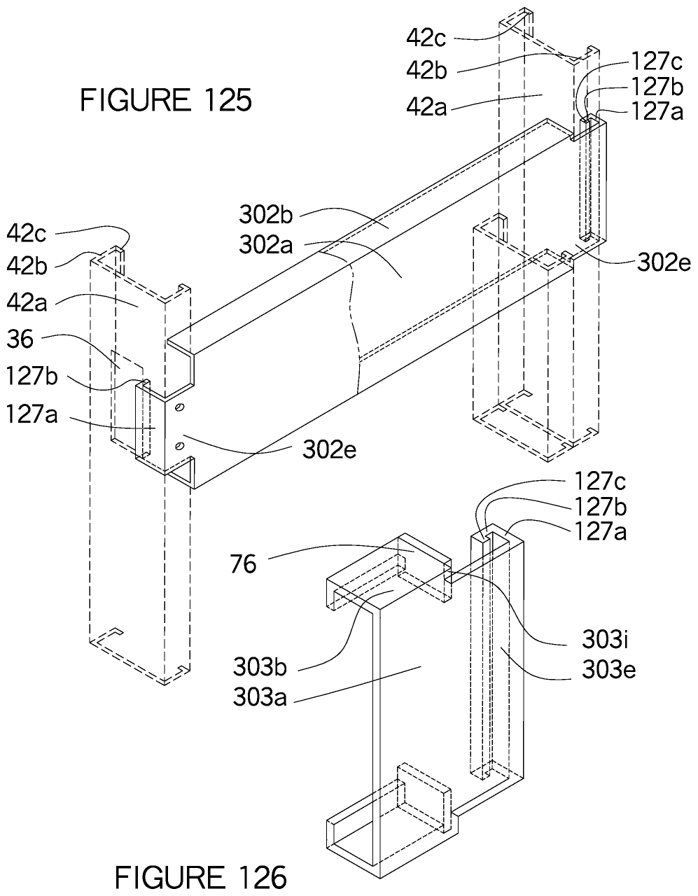

FIG. 107 is a cross section through a metal framed wall showing numerous sizes and shapes of spacer braces being attached to a C channel 42. The spacer braces are oriented vertically, horizontally or at an angle and can be mounted within the hole or on the exterior surface or flange 42b usually secured to the web 42a by the hook fingers 127. The holes 36 within the web 42a are usually rectangular in shape, however a triangular shape hole 36t is also shown showing three various spacer braces in FIGS. 108-110. The U-shaped spacer braces 302 near the bottom show one U-shaped spacer brace 302 where the dorsal is oriented on the top side and the sides are extending downward while the other U-shaped spacer brace 302 the dorsal is oriented on the bottom side and the sides 302b are extending upward. The reverse lip spacer brace 301 on the right side of the support member is installed so the extension 301e (not shown) at the web 301a can extend over the flange 42b so the hook finger 127 can be connected to the web 42a of the support member. On the left side the reverse lip spacer brace 301 is installed so the lips 301c are supported at the flange 42b. The reverse lip spacer brace 301 also on the left by further down the wall, shows the side 301b at an angle like a hat channel shape. Just below is a U-shape spacer brace 302 that shows a double flange 302bb and the edge of the double flange 302bb is against the flange 42b of the support member. In addition, the U-shape spacer brace 302 shows a light weight line below the U-shape spacer brace 302 which references that the U-shape space brace 302 is shows the spacer brace has been installed diagonally over the support members. The hook finger 127 shown on the U-shape spacer brace 302 with the double flange 302bb is a hook finger 127 having an L-shape where the hook portion extends over the edge of the hole 36 as shown in FIGS. 125 & 156. The lower triangular hole 36t shows three U shaped spacer braces 302 one shown at an angle and two shown on the right vertical edge where one U shaped spacer brace 302 is spanning away and another is spanning forward. A C-shaped spacer brace 303 has its dorsal vertical where the lips 303c are installed on the flange 42b of the C-channel 42 with a hook finger 127 having three sides wrapped around the lip 42c and the flange 42b. The extension 303e does not need to be connected to the flange 42b of the C channel 42 since the hook finger 127 connects this end of the C-shaped spacer brace 303. The end of the hook finger 127 can have an additional two or three side add at the end of the hook finger 127 so the C-shaped spacer brace 303 must first connect the C-shape to the lip 42c then rotate the C shaped spacer brace 303 almost 180 degrees until the extension 303e is at the flange 42b of the adjacent support member. Also see FIGS. 123-129 where the hook finger 127 forms an L or C shape. The metal framed wall has a U-shape spacer brace 302 with its dorsal side anchored to the floor 401 with an anchor bolt assembly 354 that is connected through a hole 36 in the web 302a. The U-shaped space brace 302 shows the flanges 302b abutting the web 42a of the support member shown as a C channel 42. The opposing side of web 42a has the ventral side of the hook finger 127 mounted with fasteners to the web 42a. If the support member were wood framing members 68 the web 302a and flanges 302b would be similar to other previously described connections for wood construction. The floor mounted U-shaped spacer brace 302 also referred to as a hold-down spacer brace 309 can also be mounted at the top of the wall making the same connections to the support members and the horizontal plate at the top of the wall as shown in FIGS. 111-114. Some building codes require that the support members should have a gap between the top plate and the end of the top edge of the web 42a & flange 42b of the support member in order for floor joists above to deflect. When this occurs the fasteners 122 are installed in the slot holes 36s and the spacer brace 302 is allowed to move in an up and down motion as the web 302a is secured to the support member above.

FIGS. 108-110 show three different spacer braces being connected at a triangular shape hole 36t shown at the web 42a of a C channel 42. The reverse lip spacer brace 201 shows the dorsal side at an angle so the web 301a and sides 301b can fit into the triangular shape hole 36r, however the lips 301c act as a flap 76 as shown in FIG. 16 where the ends of the lips 301c abut the web 42a on one side and the web 301a has an indentation 301i and then an extension 301e so the hook finger 127 can extend over to the opposite side of the web 42a and the ventral side of the hook tongue 128 can abut the web 42a and fastened by a screw 122 into the web 42a. FIG. 16 shows the web 302a and the side 302b extending through the triangular shape hole 36t and flaps 76 that extend away the angular oriented sides 302b. The flaps 76 are rectilinear in shape and are perpendicular to the sides 302b. FIG. 110 shows an elevation of the U-shaped spacer brace 302 where the hook finger 127 is fastened with screws 122 on the viewers side of the web 42a, the extension 302e is the thickness of web 42a of the support member and the indentation 302i, web 302a and the side 302b is on the opposite side of the web 42a. Some spacer braces are attached to the web 42a or by the hook finger 127. None of the holes 36 show a lip or also described as a rim (not shown) at the edge of a hole 36 in the web 302a. Some metal framing manufacturers leave a rim at the edge of a hole 36. The rims, holes 36, or lips 302c of C-shaped channels 42 can have L-shaped or U-shaped fingers on the various spacer braces as shown in FIG. 126.

FIG. 111 shows three wood joists as wood framing members 68 (shown with light weight lines) where the top surface of the wood framing members 68 show a U-shaped spacer brace 302 (in section) being connected together. The dorsal side is on the top side of the U-shaped spacer brace 302 and the sides 302b extend downwardly from the web 302a. The U-shaped spacer braces 302 are staggered next to each other and therefore look like the U-shaped spacer braces 302 are over lapping. The end of each side has engagement means of a hook finger 127 that engage on side of the wood framing member and the edges of the sides 302b abut the wood framing member on the opposing side. The edges of the sides 302b are shown with jagged edges 74. At the bottom of the left wood framing member 68 shows a U-shaped spacer brace 302 at a diagonal where the dorsal is on the top side shown as the web 302a with the flanges extending downward. The web 302a is shown having a hook finger 127 where side 127a is bent down, side 127b is horizontal and side 127c is vertical encasing the bottom side of the wood framing member 68 on three sides. In addition, the flanges 302 from the U-shaped spacer brace 302 have jagged edges that extend into the wood framing member 68. On the right side shows the same U-shaped spacer brace 302 that is on the top side of the wood framing members 68, however the web 302a with its extension 302e on the ventral side at the bottom edge of the wood framing members 68 and the flanges 302b and hook finger 127 are extending upward.

FIG. 112 shows three horizontal support members as C channels 42 having a vertical dorsal as a web 42a with two horizontally extending flanges 42b and with lips 42c. The left support members shows a diagonally oriented dorsal of U-shaped spacer brace 302 having the top side as a web 302a with extending downward flanges 302b. The extension 302e that extends from the web 302a is bent at angle parallel to the flange 42b and bent at the hook finger 127 over the lip 42c. An diagonally oriented U-shaped spacer brace 302 is shown connecting the left C channel 42 to the middle C channel 42 at the top edge of the hole 36 in the web 42a of the C channel 42. The diagonally oriented U-shaped spacer brace 302 has the dorsal on the top side shown as the web 302a with the extension 302e passing through the upper edge of the hole 36 for the hook finger 127 to be bent upward and secured to the web 42a of the support member. The left C channel 42 shows a horizontally oriented U-shaped spacer brace 302 having the dorsal on the bottom side where the web 42a is horizontal and the flanges 42b are extending upward. The web 302a has the extension 302e passing through the bottom edge of the hole 36 and the hook finger 127 extends downward over the web 42a. The middle and the right horizontal support members have a hole 36 at the bottom edges of the hole 36. A U shaped spacer brace 302 is shown spanning between the adjacent horizontally oriented support members where the web 302a has the dorsal side facing upward with the flanges 302b extending ventrally downward where the right side has the ends of the flanges 302b abut the web 42a of the support member with the extension 302e extending into and over the hole 36. The hole 36 is large enough so two U shaped spacer braces 302 can pass through the same hole, however the U shaped spacer braces are aligned adjacent to one another and therefore alternate between support members forming a checkerboard pattern. The same is true should the U shaped spacer brace 302 want to be installed diagonally that is one end attached at the bottom edge of the hole 36 and the opposite end attached at the top of the support member. This type of arrangement again requires a larger size hole 36 so two U shaped spacer braces 302 could be installed on the bottom edge of the hole 36. At the bottom of the C channel 42 a U shaped spacer brace 302 where the extension 302e passed over the flange 42b and the first leg 127a of the hook finger 127 is bent over the lip 42c with the second leg 127b extending over the edge of the lip 42c with the flanges 302b abutting the web 42a of one support member and the lip 42c of an adjacent C channel 42 with the opposite end having the extension 302e extend under the flange 42b and bent upward forming the hook finger 127 abutting the web 42a of the second C channel 42.

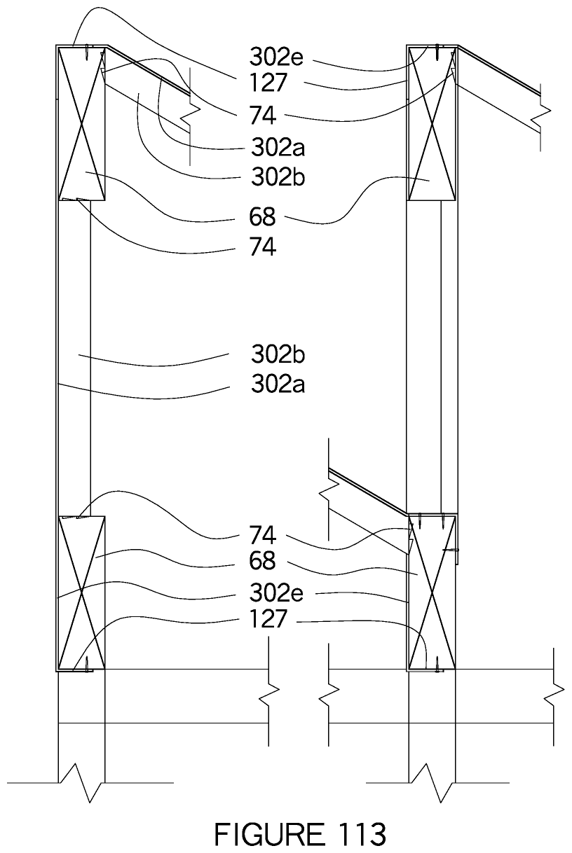

FIG. 113 shows a truss joist where the support members are shown as wood framing members 68. The wood bracing members 68 can be parallel or angular like a scissor truss. The left truss joist shows the U-shaped spacer brace 302 in section where the web 302a, extension 302e and hook finger 127 are shown darker as well as the wood framing member 68. The U-shaped spacer braces 302 can be angular parallel to the wood framing members 68. The right truss joist shows the U-shaped spacer braces 302 in elevation with the wood framing members 68 shown in section. Diagonal lateral bracing is shown between the two truss joists as the U-shaped spacer brace 302 where the extension 302e is bent to form to the angle of the wood framing members 68 and bent again at the hook finger 127. The U-shaped spacer braces 302 shown in FIG. 20 can be used to connect the truss joists.

FIG. 114 shows two truss joists where the support members are C channels 42 where the web 42a is oriented vertically with the flanges 42b extending horizontally and the lips 42c are vertical extending inward to each other. The support members are located on the top and bottom chord of each truss joist with U-shaped spacer braces 302 are installed vertically and diagonally between support members as shown in FIGS. 103, 105, 107 & 108 where the flanges 302b abut the flanges 42b and the webs 302a have an extension 302e that extends over the web 42a with hook fingers 127 extending over the top and bottom flanges 42b of the support member. Three U-shaped spacer braces 302 are shown horizontally between truss joists and are used as lateral bracing between the truss joists. At the top and bottom chords a U-shaped spacer brace 302 is shown where the dorsal is on the top side and the flanges 302b extend downward with their vertical edges abutting the lip 42c and web 42a. The webs 302a have an extension 302e extend over the top flanges 42a some secured directly into the flanges 42b while others have the hook finger 127 extend over the webs 42a and or lips 42c. The U-shaped spacer braces 302 can be installed diagonally between the top and bottom support members or diagonally along the top or bottom chords along the flanges 42b when the truss joists are installed in an array. A third U-shaped spacer brace 302 that is oriented downward is installed in the hole 36 at the web 42a of the C channel 42 used as the support member. The edges of the flanges 302b abut the webs 42b with an extension 302e passing through the hole 36 and the ventral side of the hook fingers 127 abut the web 42a on the opposite side of the web 42a from the flanges 302b. At the bottom of the truss joists a U-shaped spacer brace 302 also referred to in the building trades as the top plate which connects the vertical support members similar to the U-shaped spacer brace 302 shown at the floor in FIG. 101 to the top end of the support members. Since the U-shaped spacer brace 302 is upside down the dorsal side is abutting the truss joists and the hook fingers 127 are resting on the dorsal side. The right side shows a hook finger 127 with a U-shape having the first leg 127a extend from the extension 302e ventrally upward against the lip 42c extending over the top edge is leg 127b then leg 302c extends over the back side of the lip 42c of the lower horizontal chord of the truss joist while the left hook finger 127 has the first leg 127a extend upward from the web 302a against the lip 42c then extend over the top edge of the lip 42c forming an L-shape that is also wrapped around the lip 302c of the adjacent lower horizontal chord of the truss joist. The fingers of the top plate can also just be hook finger 127 connecting the webs 42a of the bottom horizontal chord. Another option is have one U-shape spacer brace 302 attach to the support members of the wall framing members and another U-shaped spacer brace 302 attach to the truss joist where the webs 302a or each U-shaped spacer brace has their dorsal side attached back-to-back where one set of flanges 302b extend downward and another set of flanges 302b extend upward. A U-shaped spacer brace 302 is shown at the top of the truss joists.

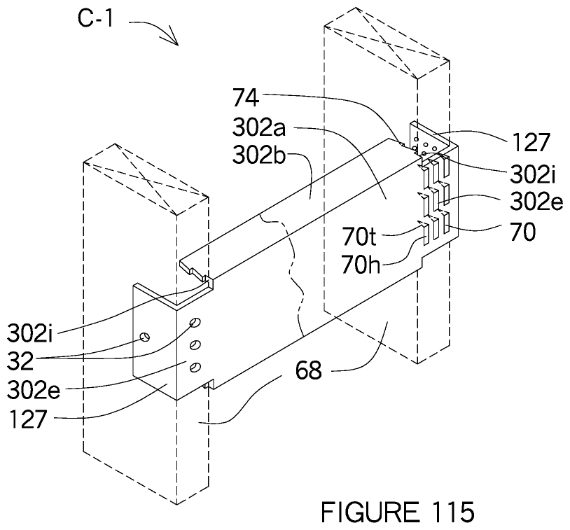

FIG. 115 has a U-shaped spacer brace 302 that is installed with the web 302a in a vertical orientation and installed with the ventral side installed over the vertically oriented wood framing members 68. In FIG. 115 the U-shaped spacer brace 302 is shown as an independent spacer brace connected between two support members. The web 302 has two flanges 302b extending outwardly with jagged edges 74 at the ends of the flanges 302b that penetrate into the wood framing members 68 and the webs 302a have indentations 302i and an extensions 302e that extends over the surface of the extension 302e on both wood framing members 68 and the hook finger 127 of the spacer brace 302 is bent parallel to the angle of the wood framing member which is typically 90 degrees. In this figure the web 302a is oriented vertically so the ventral side of the U-shaped spacer brace 302 is against the vertically oriented wood framing members 68 and the ventral side of the hook finger 127 abuts the side edges of the wood framing member 68. Fasteners are secured through the extensions 302e and the hook fingers 127 to secure the wood framing members 68. Punched hole teeth 70 are shown on the dorsal side of the extension 302e in the U-shaped spacer brace 302 so the teeth 70t for the punched hole 70h can penetrate the wood framing member 68. In addition, the hook finger 127 on the right side of FIG. 115 can have bumps, abrasions or any other means to create friction between the ventral side of the hook finger 127 at the wood framing member 68.

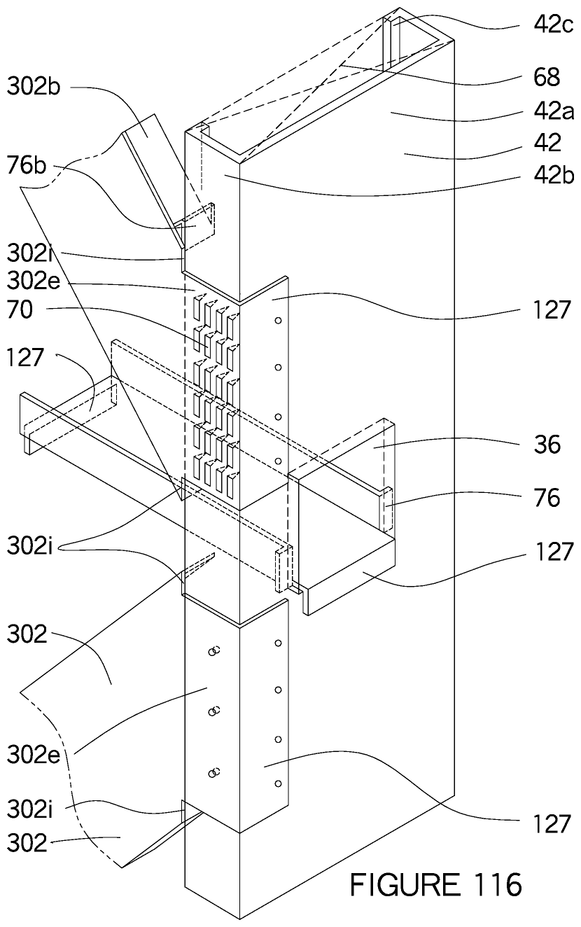

FIG. 116 shows an isometric view of a vertical support member either a C channel 42 or a wood framing member 68. Two diagonal framing members both shown as a U-shaped spacer brace 302 where the dorsal side is shown as a vertical orientation with the web 302a extending over the flange 42b of the C channel 42. The upper U-shaped spacer brace 302 is shown for a wood framing member 68, with the extension 302e showing the punch hole teeth 70. The diagonally oriented flanges 302b are shown with a bent flap 76b that extends longer and reinforces the flanges 302b and the extension 302e extends onto one side of the wood framing member 68 and the hook finger 127 extending over the opposite side of the wood framing member 68. The downward diagonally oriented U-shaped spacer brace 302 is shown with fasteners extending into the flange 302b and web 302a of the C channel 42. Between the two diagonal U-shaped spacer braces 302 is a horizontally oriented U-shaped spacer brace 302 shown in FIG. 115.

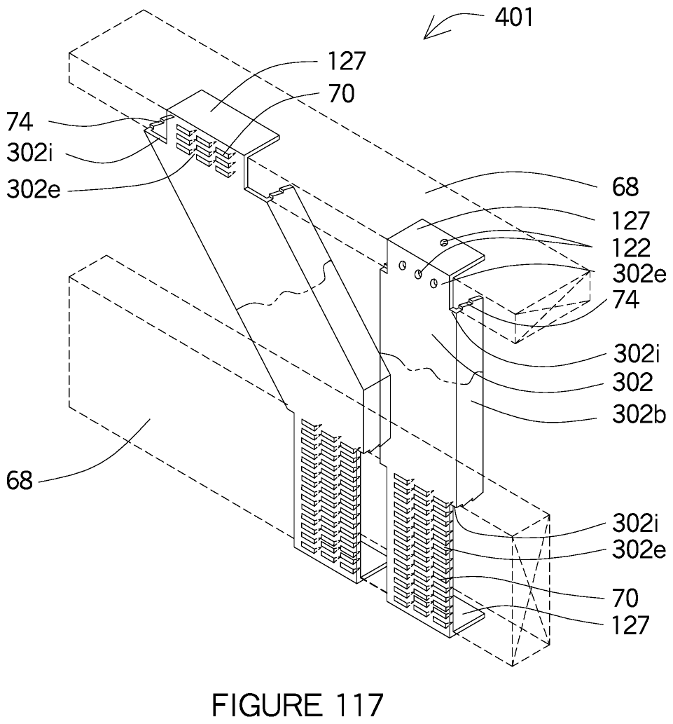

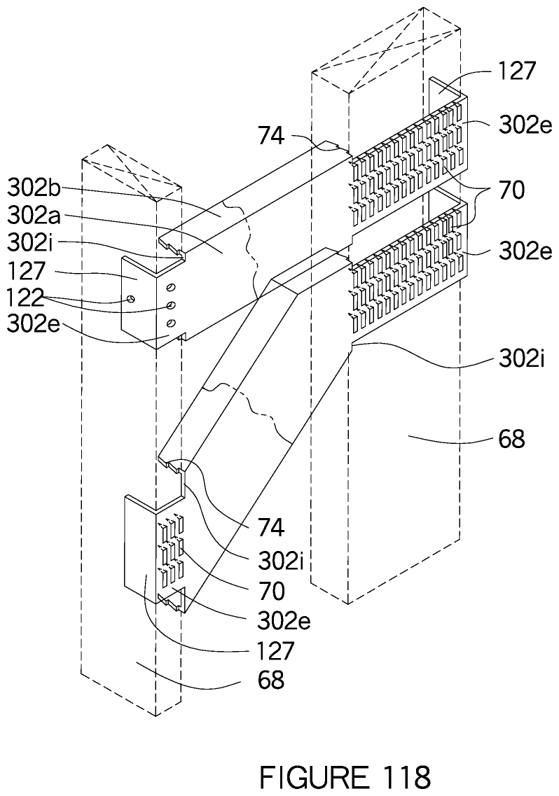

FIG. 117-118 are similar except in FIG. 118 24 the wood framing members 68 are shown as horizontal support members to form truss joists 401 that are shown in C-8 in FIG. 94. Truss joists 401 are typically joists that have a horizontal top and bottom chord (shown in ghost) shown as wood framing members 68 and diagonal chords connect the top and bottom chords shown in FIGS. 117 & 113 as U-shaped spacer braces 302. In FIG. 25 the wood framing members 68 (shown in ghost) are vertical support members for a wood framed wall and the U-shaped spacer braces 302 are used as lateral and diagonal bracing between the support members. The wood support members 68 in FIG. 117 are shown parallel to each other for a floor joist, however if the top member was at an angle a triangular truss could be formed using different length U-shaped spacer brace 302. Since the truss joist 401 are designed to have only one top and bottom chord, the U-shaped spacer braces 302 are independent braces where the dorsal side of the hook finger 127 is vertical and the sides 302b extend outwardly from the web 302a where the top and bottom ragged edges 74 engage to wood framing members and the web 302a is indented 302i and the extension 302e with the punched hole teeth 70 penetrate the wood framing member 68 and the hook finger 127 wraps around the top or bottom side of the wood framing members 68. Screws 122, nails or the punched hole teeth 70 can be used to connect the spacer braces to the wood framing members 68. FIG. 118 shows the same configuration as FIG. 117 except the wood framing members 68 are oriented vertically. The web 302a is oriented vertically and the sides 302b extend ventrally horizontally or diagonally away from the web 302a.

When the wall construction is oriented vertically the diagonal oriented U-shaped spacer braces 302 are now typically referred to in the building industry and diagonal bracing which is used to reduce horizontal forces such as wind against a building and the horizontal oriented spacer braces are referred to as lateral bracing. These spacer braces or any of the spacer braces described can be U-shaped, C-shaped or C-shaped where the lips extend outward on the dorsal side of a U-shaped spacer brace 302.

When the spacer braces are installed diagonally above a door or window the spacer braces are referred to as beams. These beams can have a truss like construction as shown in FIG. 94 can act like a truss as shown in C-7.

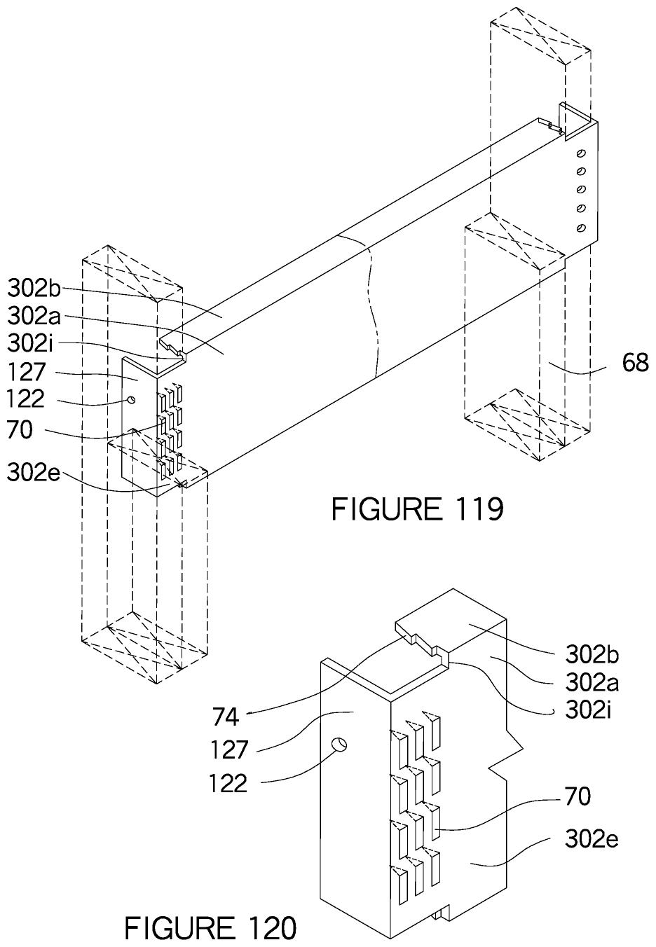

FIG. 119-120 shows the dorsal of a U-shaped spacer brace 302 vertically oriented and spanning between wood framing members where the wood framing member 68 have a tall member and a short member (typically called a cripple within the construction industry) which usually indicates a wood framed opening for beam. The beam is shown having the dorsal vertically oriented with the ventral side of the web 302a and the extension 302e abutting the outer surface 68a with the hook fingers 127 connected to the inner sides of the wood framing members 68. Both ends of the U-shaped spacer bars 302 are connected to the taller member of the wood framing members 68. The extensions 302e on the left side show the punched hole teeth 70 extending from the dorsal side into the wood framing members 68 and the right end shows holes 36 on the extensions 302e and hook finger 127. The jagged edges 74 are shown at the ends of the sides abutting the wood framing members 68.

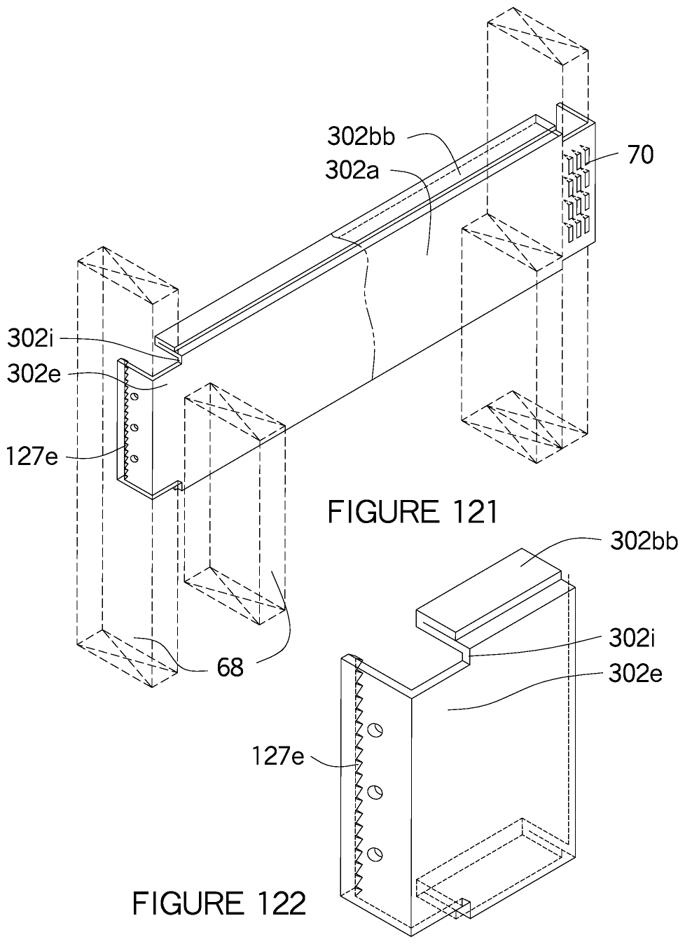

FIG. 121-122 are similar to FIGS. 119 & 120, however the sides have a double flange 302bb and the hook finger 127 has an abrasive edge 127e.

FIG. 123-124 are similar to FIG. 119 except the vertical oriented support members are C channels 42 having a web 42a with extending flanges 42b and lips 42c extending inward. FIG. 123 shows the hook finger 127 on the right end of the U shaped spacer brace 302 having the first leg 127a abut the lip 42c then abut against the edge of the lip 42c then turn again so the third edge is on the backside of the lip 42 forming a U-shaped that wraps around the lip 42c of the C channel 42. To install the U-shape spacer brace 302, one aligns the right end of the U-shape at the hook finger 127 to be parallel to the lip 42c. Once the U-shape of the hook finger 127 is engaged at the lip 42c, the U shaped spacer brace 302 is rotated 90 degrees toward the vertical oriented support members on the opposite end of the metal framed opening for the beam. The extension 302e and hook finger 127 are then connected by fasteners to the opposing metal support members. FIG. 124 shows the enlargement of the U-shape configuration of the hook finger 127.

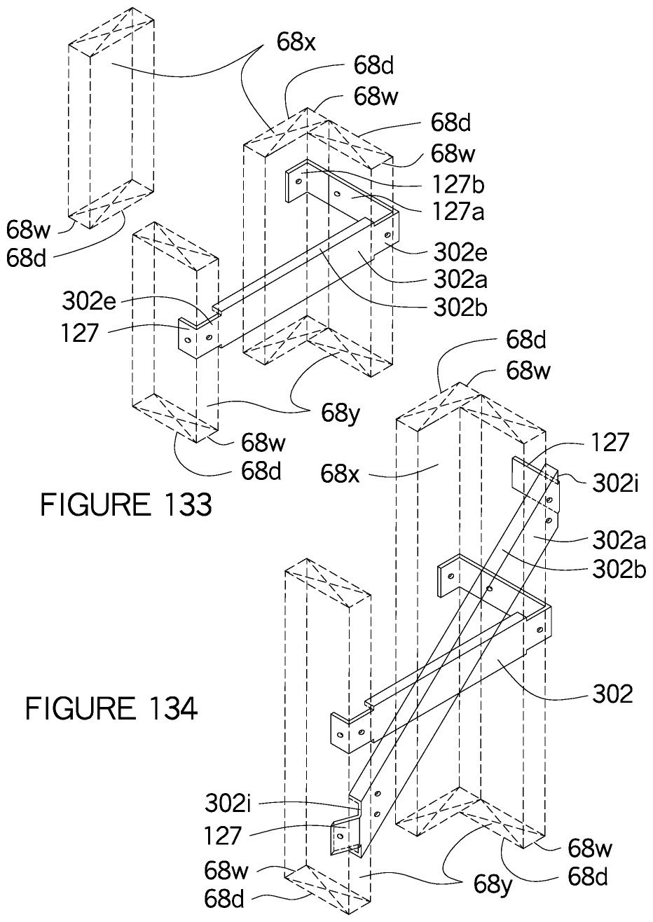

FIG. 125-126 are similar to FIGS. 123 & 124 as the right end of the U-shaped spacer brace 302 has the U-shape at the hook finger 127, however the U-shaped spacer brace 302 rotates 90 degrees the left side has the flanges 302b abut the lip 42c with the extension 302e fitting over the flange 302b and the first side 127a of the hook finger 127 extends over the web 42a and the second side 127b extends into the hole 36 in the web 42a of the C channel 42 being the support member for the metal framed beam opening. FIG. 133 shows an enlargement of right end of the hook finger 127 attached to the extension 303e of a C shaped spacer brace 304 and shows flaps 76 turned ventral inward from the flanges 303b that would rest against the web 42a if they were shown in FIG. 125.

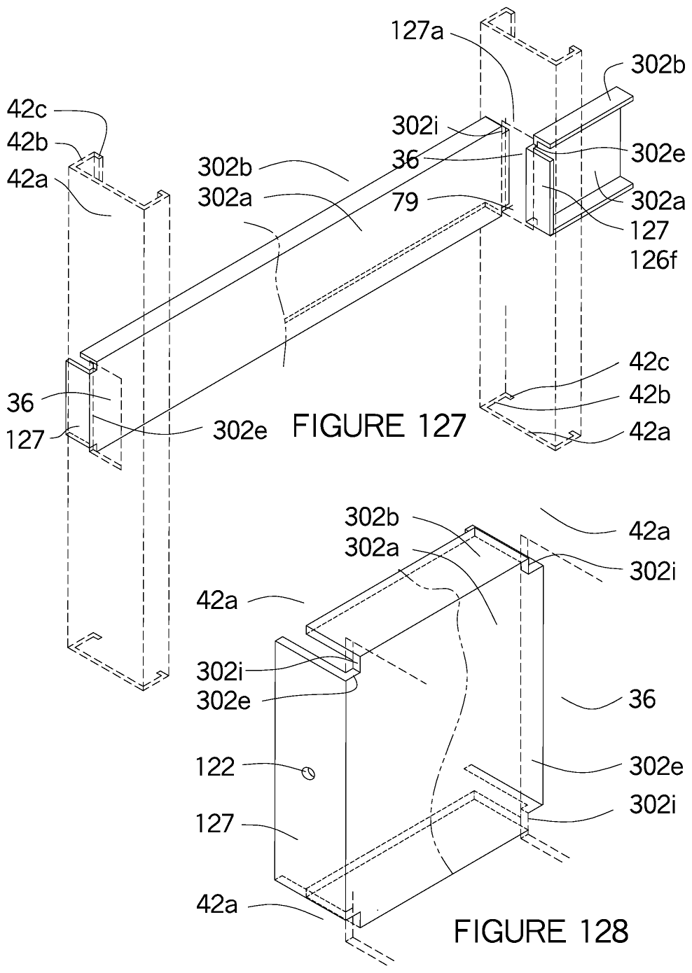

FIG. 127 is an isometric view of two vertically oriented U shaped spacer braces 302 installed horizontally between the holes 36 of adjacent vertical support members so the U shaped spacer braces 302 are installed alternating between the vertical side edges of the holes 36 by allowing each hole 36 to have one U shaped spacer brace 302 spanning between adjacent U shaped spacer braces on the right side on the rear vertical side edge of the hole 36 and between the adjacent U shaped spacer brace on the left side on the front vertical side edge of the hole 36 allowing the U shaped spacer braces 302 to be staggered between the front and rear vertical sides edges of the holes 36. The vertical support member is shown as a C channel 42 having a vertical web 42a with flanges 42b extending ventrally out from the web 42a with lips extending ventrally inward parallel to the web. The U shaped spacer braces 302 have webs 302a where the dorsal sides face inward with the ventral sides facing the vertical side edges of the holes 36 and the ventral sides have flanges 302b extending from the web 302a. One end of the U shaped spacer braces have the ends of the flanges abut the web 42a of the vertical oriented support member. The flanges 302b and the web 302a has an indentation 302i with an extension 302e that extends over the web 42a at the hole 36 so a hook finger 127 can have the first side 127 extend ventrally over the bottom edge of the hole 36. The opposing end of the U shape spacer brace has its flanges 302b abut the web 42a at the hole 36 of the adjacent support member so the flanges 302b engage the web 42a. The end of the flanges 302b abut the web 42a so a hook finger 127 can extend ventrally over the web 42a of the adjacent support member also shown in the enlarged FIG. 128 When the hook finger 127 of the opposing end of the U shaped spacer brace 302 is secured, the U shaped spacer brace 302 is rotated toward the hole 36 so the edges of the flanges 302b engage the web 42a and the hook finger 127 extends over the side edge of the hole 36 securing the U shape spacer brace 302 to the side edge of the hole 36. Another U shaped spacer brace 302 can be installed on the opposite vertical side edge of the hole 36. The top and bottom edges of the hole 36 can also have the U shaped spacer braces 302 have the dorsal sides oriented horizontally through the holes 36 of adjacent support members which was explained above and previously shown in FIGS. 100-104. Fastener 122 can be installed at the hook finger 127, but are optional depending on the structural stress exerted on the holes.

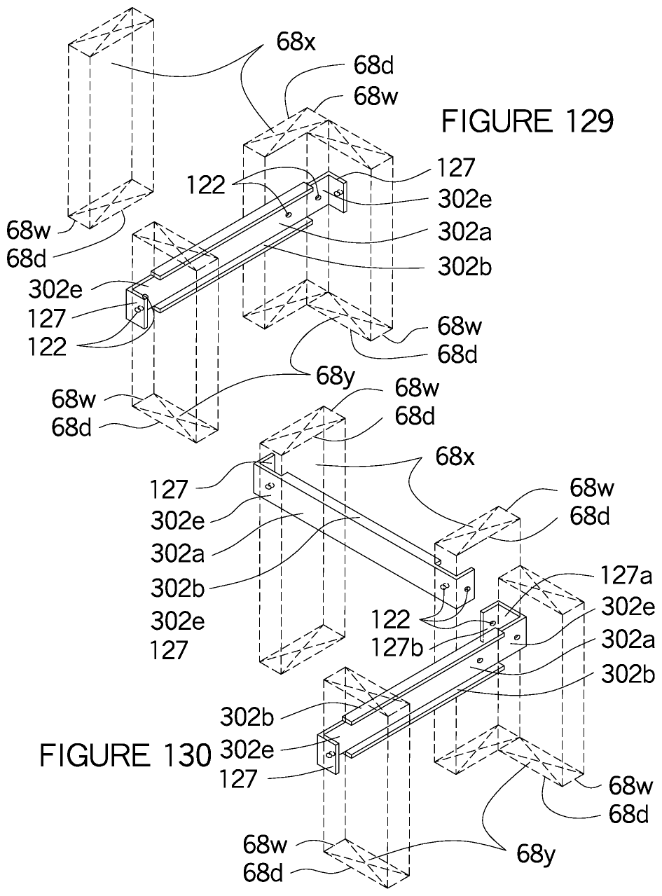

FIG. 129 shows a U shaped spacer brace 302 installed horizontally between the vertical support members shown as wood support members 68 and oriented in a Y direction and referred to as wood studs 68y. The U shaped spacer brace 302 has a web 302a oriented vertically with the flanges extending ventrally horizontally from the web 302a. At both ends the web 302a has an extension 302e where the ventral side extends over the width side 68w of the wood support member 68 of the wood studs 68y. The flanges 302b of the U shaped spacer brace 302 abut the depth side 68d of the wood support member 68 and the hook finger 127 is bent to align with the depth side 68d on the opposite side of the support member. Fasteners 122 can be installed on the hook fingers 127 into the depth side 68d or at the extensions 302e into the width side 68w of the wood studs 68y. The U shaped spacer brace 302 is shown oriented in a Y direction, however another set of wood studs 68x are oriented in an X direction referred to as 68x. When constructing a wood framed building, a corner of a building is formed when wood studs 68x are oriented in an X direction and another group of wood studs 68y are installed in a Y direction. The isometric drawings shows a corner intersection where the depth side 68d of the wood studs 68x abut the width side 68w of the wood studs 68y. In this case the U shaped spacer brace 302 has the dorsal side of the web 302 abut the depth side 68d of the wood studs 68x which allows for a fastener 122 to be connected to the depth side 68d of the wood stud 68w. Usually drywall (not shown) is attached to the width sides of the wood studs 68x and 68y. By having the U shaped spacer brace 302 located at the inside corner connecting the wood studs 68x and 68y drywall can now be connected to the dorsal side of the web 302a without having to add another wood stud 68y at the inside corner.

FIG. 130 is similar to FIG. 127 as they both an X & Y direction of the wood studs 68x & 68y and the U shaped spacer brace 302, however in FIG. 128 35 the U shaped spacer brace 302 is shown installed on the wood studs 68x instead of the wood studs 68y. In addition, the U shaped spacer brace 302 shown on the right side of the wood studs 68w an L-shaped is formed at hook finger 127 where the side 127a has the dorsal side extend over the width 68w of the wood studs 68x and extend partially over the depth 68d. The U shaped spacer brace 302 is first installed on the wood studs 68y then the wood studs 68x is installed into the L-shape of the hook finger 127 and additionally secured by fasteners 122 from the ventral side of the web 302a into the depth side 68d of the wood stud 68x forming a corner connection between the wood studs 68x and 68y.

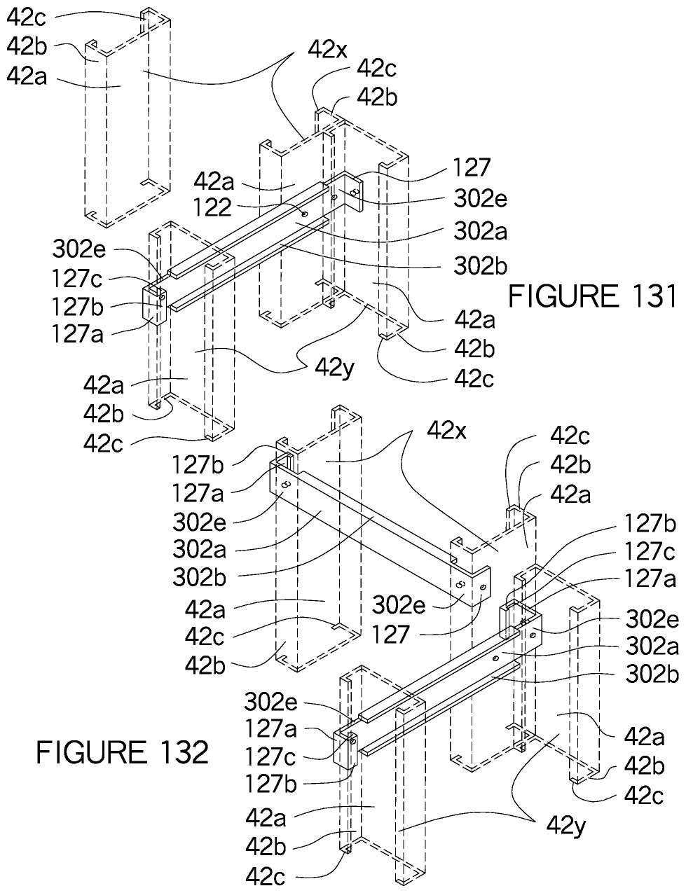

FIG. 131 is similar to FIG. 127 except the wood studs 68x and 68y are now C channels 42 shown as metal studs 42x and 42y. The U shaped spacer brace 302 has a vertical oriented web 302a with flanges 302b extending ventrally horizontally so the end edges of the flanges 302b abut the web 42a of one metal stud 42y and the opposite end edges abut the lip 42c of the adjacent metal stud 42y. The right side has an extension 302e extend from the web 302a with the ventral side abutting the flange 42b and a hook finger 127 bent ventrally horizontally abutting the web 42a of the metal stud 42y at the corner intersection. The opposite end of the U shaped spacer brace 302 the web 302a is extended across the flange 42b at the extension 302e and then bent ventrally forming first side 127a against the lip 42c and then second side 127b is bent around the edge of the lip 42c forming an L-shape. The L-shape is usually installed at the edge of the lip 42c first, and rotated around so the extensions 302e engage both flanges 42b of both metal studs 42y and the web 42a of the metal stud 42y at the corner. The web 302a is connected by fasteners 122 to the web 42a of the metal studs 42x.

FIG. 132 is similar to FIG. 128 and FIG. 129 except that the wood studs 68x & 68y are shown as metal studs 42x & 42y and one end has a hook finger 127 that is L-shaped. The U shaped spacer brace 302 shown attached on the metal studs 42y has both ends shown as hook fingers 127 with a U-shape. The U shape spacer brace 302 has a vertical oriented dorsal where the ventral side of the extensions 302e abut the flanges 42b of the metal studs 42y and the flanges 302b abut the web 42a and lip 42c of the metal studs 42y. The left side shows the first side 127a abut the lip 42c and the second and third side 127b & 127c wrap around the lip 42c. The opposite side has the first side bent outward on the dorsal side to abut the flange 42b of the metal stud 42x then the second and third side 127 & 127 wrap around the lip 42c of the metal stud 42x. The web 302a has fasteners 122 that connected to the web 42a of the metal stud 42x. The U shaped spacer brace 302 is first attached to the metal studs 42y, then the metal stud 42x can be twisted into place by rotating the lip 42c of the metal stud 42x around second and third sides 127b & 127c of the hook finger 127.

FIG. 133 shows the U shaped spacer brace 302 wrapped around the outside perimeter of the wood studs 68y oriented in the Y direction and the adjoining wood stud 68x oriented in the X direction. The U shaped spacer brace 302 has the web 302a oriented vertically with the flanges 302b extending ventrally horizontally so the flanges 302b can abut the depth sides 68d of the wood studs 68y. The web 302a on the left side has an extension 302e extend over the width side 68w on the ventral side and the hook finger 127 attaching to the depth side 68d. The opposite end has the extension 302e protruding over the width side 68w with the hook finger 127 bent ventrally forming an L-shape where the first side 127a abuts the depth side 68d of the wood stud 68y and continue over the width side 68w of the wood stud 68x and the second side abutting the depth side 68d of the wood stud 68x. The U shaped spacer brace 302 connects two different oriented wood studs 68x & 68y together on the outside edges versus the inside edges as shown in the previous figures.

FIG. 134 shows the same U shaped spacer brace 302 wrapped horizontally around the wood studs 68x & 68y at an outside corner. FIG. 132 also shows a diagonal U shaped spacer brace 302 with a vertical oriented dorsal installed over a horizontal U shaped spacer brace 302. The diagonally installed U shaped spacer brace 302 shows a vertical dorsal with the flanges 302b extending horizontally on the ventral side spanning between two wood studs 68y with the longitudinal edges resting on the width sides 68w of the wood studs 68y. The ends of the flanges 302b and an indentation 302i occurs at the corners of the wood studs 68y so hook fingers 127 can extend onto the depth side 68w of the wood studs 68y. The left hook finger 127 is shown at an angle, however in reality the side edges of the hook finger 127 is parallel to corner made by the intersecting sides of the web 302a and flanges 302b. Since the U shaped spacer brace 302 is installed at a diagonal the bent finger 127 is bent at an angle. On the other hand, the hook finger 127 on the right side has the edges cut at an angle, so when the hook finger 127 is bent the hook finger 127 will appear perpendicular to the vertical orientation of the wood studs 68y.

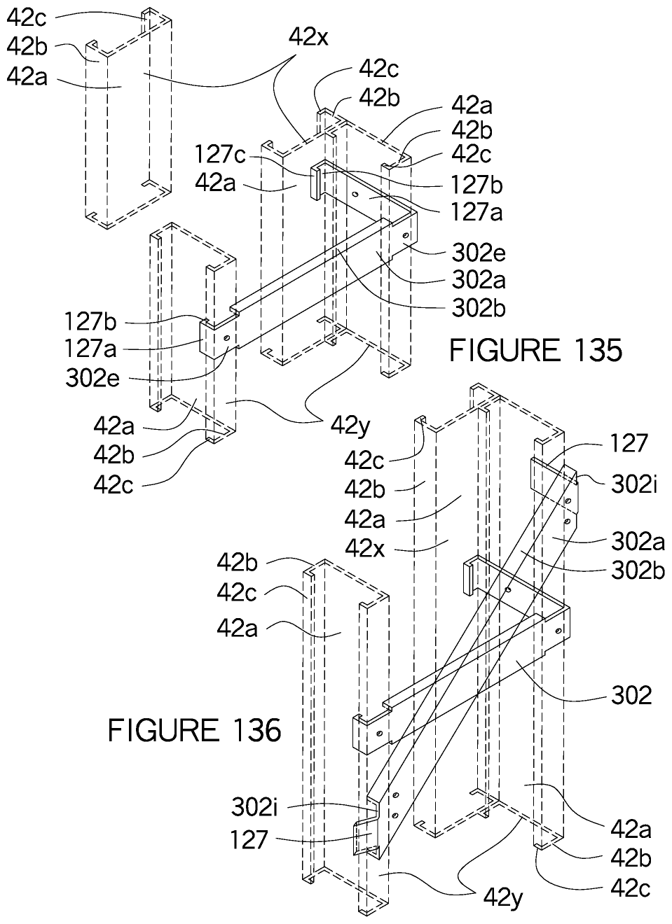

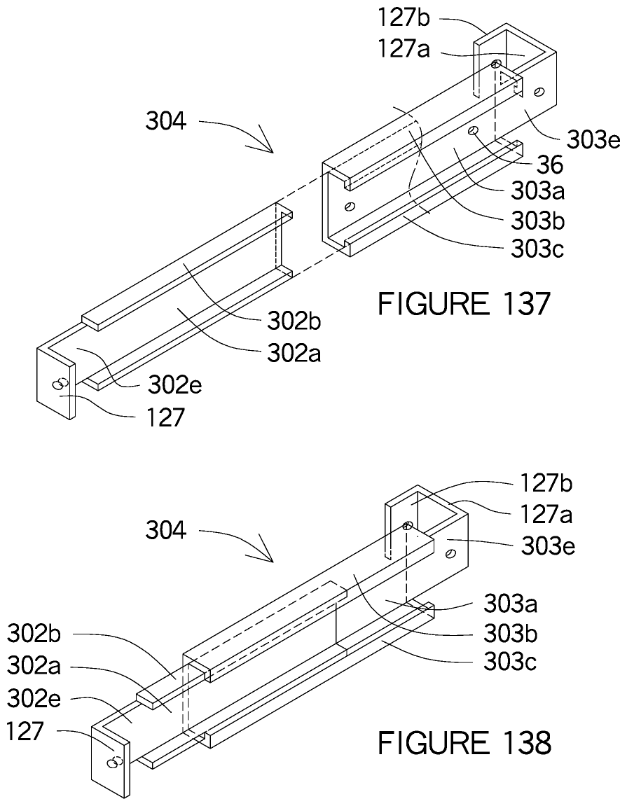

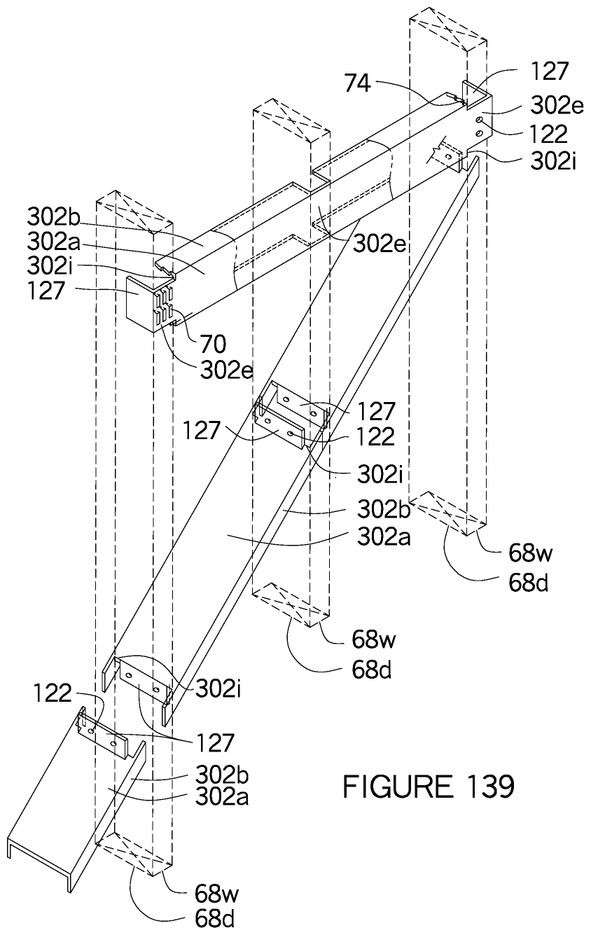

FIG. 135-136 are similar to FIGS. 131 & 132 38 & 39 except metal studs 42x and 42y are used. The same hook fingers 127 being L-shaped or U-shaped that were described in FIG. 137 have been used in these figures as well as the diagonally installed U shaped spacer brace 302 as used in FIG. 139.

FIGS. 137-138 are the same adjustable spacer brace 304 shown in FIG. 135 except the left end shows the hook finger 127 as just single sided and here the adjustable spacer brace 304 shows two separate component that slide between each other. The left side of the adjustable spacer brace 304 shows a U shaped spacer brace 302 having a vertically oriented web 302a with flanges 302b extending horizontally from the ventral side along with an extension 302e and hook finger 127 bent ventrally at one end. The right side shows a C shaped channel 303 having a vertically oriented web 303a with two flanges 303b extending horizontally on the ventral side with lips 303c bent inward toward each other having a hook finger 127 extend from the web 303. The

U shaped spacer brace 302 fits between the flanges 303b and the web 303a & lips 303c of the C shaped spacer brace 303 with enough clearance so that the U shaped spacer brace 302 can move freely within the ventral sides of the C shaped spacer brace 303. The left end shows the extension 302e with a hook finger 127 extending ventrally while the opposite end of the adjustable spacer brace 304 shows the C shaped spacer brace 303 with the extension 303e extending from the web 303a and the hook finger 127 bent outwardly on the dorsal side having the first side 127a perpendicular to the dorsal and the second side 127b bent back again on the dorsal side forming an L-shape at the hook finger 127. Holes 36 are located on the dorsal side of the C shaped spacer brace 303 so fasteners (not shown) or other engagement means can be used to secure the adjustable spacer brace 304 together.

FIG. 139 shows an isometric view of three wood studs 68y, however here the U shaped spacer braces 302 has the web 302a oriented horizontally, but are installed at a diagonal between the wood studs 68y. The U shaped spacer braces 302 are shown with the dorsal side up and the flanges 302b extending downward from the ventral side. The ends of each U shaped spacer brace 302 has an indentation 302i with a hook finger 127 extending from the web 302a extending either upward or downward so fasteners 122 can be installed through the hook fingers 127 into the depth side 68d of the wood studs 68y. The flanges 302b are slightly longer and extend to the middle of the width side 68w so one-half of each flange 302a is connected to the wood stud 68y. The upper U shaped spacer brace 302 is installed horizontally between the three support members where the web 302a is oriented vertically with the ventral side extending toward the wood studs 68y. The middle intermediate support member has an extension 302e extend over the width side 68w of the U shaped spacer brace 302 with the flanges 302b having its edges against the depth side 68w of the wood stud 68y. At each end the flanges 302b abut the depth side 68d of the wood stud 68y and the ventral side of the extension 302e extends over width side 68w with the hook finger 127 extending ventrally against the depth side 68d of the wood stud 68y.

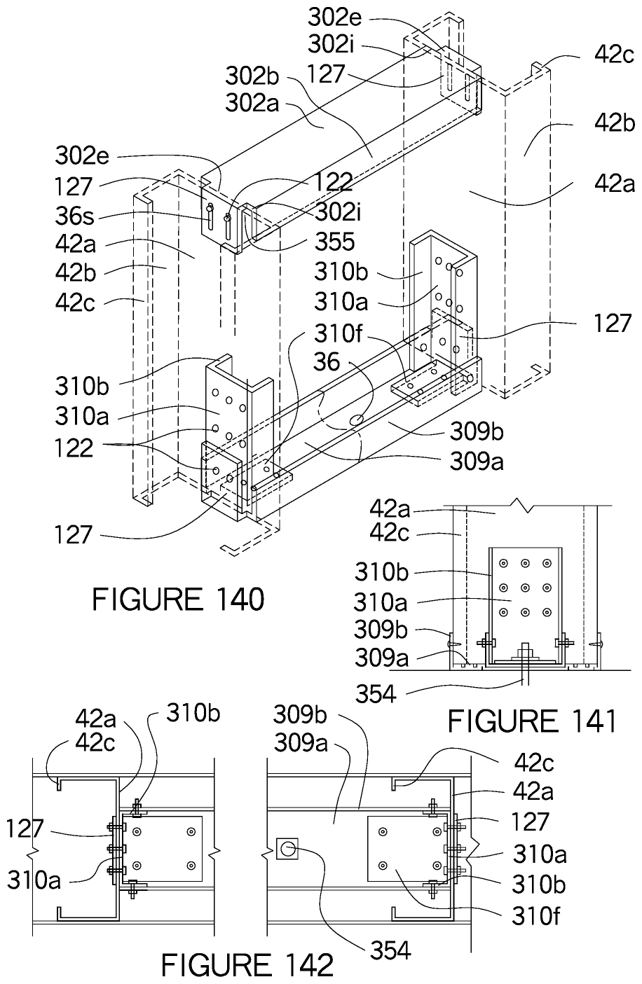

In FIGS. 140-142 at the base of the support member is a horizontally oriented hold-down spacer brace 309 attached to the concrete floor 39′ along with the hold-down bracket 310. The hold-down spacer brace 309 sometimes referred to as a base plate is the same as a U shaped spacer brace 302 as previously explained except the dorsal side is attached to the concrete floor 39′ and has a hole 36 in the web for an anchor bolt 354 to be secured to the web 302a. The hold-down spacer brace 309 and the hook fingers 127 are attached to the web 42a of the C channel as shown in FIGS. 138-140. A base plate can be installed the full width of the support member as shown in FIG. 139 or two angles can be installed on both sides of the hold-down spacer brace 309 where each angle (not shown) would replace a flange 302b and about one-half the width of the web 302a if so desired. The hold-down spacer brace 309 spans between adjacent support member where the flanges 309b extends ventrally upward from the web 309a and abut the web 42a of the support members where the web 309a has an indentation 309i at the web 42a and an extension 309e from the web 309a passes under the web 42a of the C channel 42 where the hook finger 127 extends ventrally upward. The opposite side of the webs 42a where the edges of the flanges 309b abut the opposing side of the web 42a a hold-down spacer bracket 310 is installed between the flanges 309b. The web 310a of the hold-down spacer bracket 310 is installed against the web 42a of the C channel 42 having flanges 310b extend ventrally outward and connected to the flanges 309b of the hold-down spacer brace 309. An end plate 310f extends ventrally from the web 310a parallel to the web 309a of the hold-down spacer braces 309 where the web 309a & the end plate 310f are connected together. At the top of the support members the U shaped spacer brace 302 has the ventral side of the web 42a facing the support member with the flanges 42b abutting the web 42a with an extension 302e extending over the web 42a with the hook finger 127 extending downward over the web 42a. Slot holes 36s are shown in the hook finger 127 for fasteners 122 to be connected to the web 42a. The fasteners 122 are designed to secure the C channel 42 to the U shaped spacer brace 302, however when the U shaped spacer brace 302 is secured to a ceiling/floor above the support member is expected to move when weight or people or furniture (meaning live load & dead load) is applied to the structural member above that structural member will move. The C channel 42 are not installed tight to the U shaped spacer brace 302 so the fastener 122 can connect to the support member through the slot hole 36s for the C channel 42 is allowed to move. FIG. 142 47 shows an isometric view of the slot hole 36s at the top of the support member.

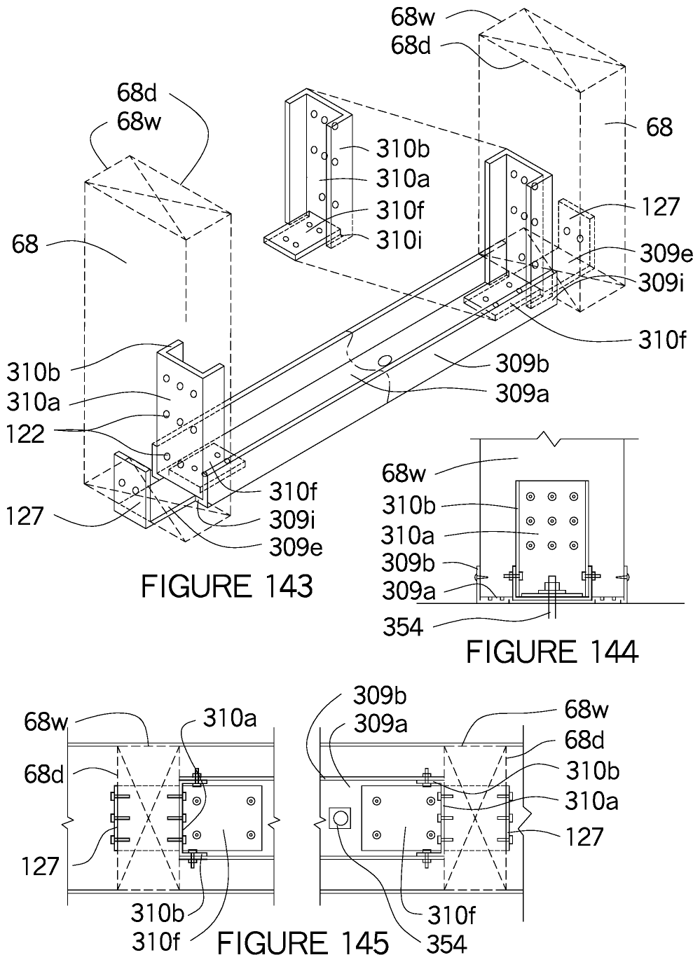

FIGS. 143-145 are similar to FIGS. 140-142 except wood support members 168 are used in lieu of the C channel 42 as the support members. The depth sides 68d of the wood support members 68 fit between the vertical edges of the flanges 309 of the hold-down spacer brace 309 and the opposite depth side 68d fits against the hook finger 127 of the hold-down spacer brace 309. The end of the wood support member 68 rest on the extensions 309e at both ends of the hold-down spacer brace 309 with the extensions 309e being the same length as the width side 68w of the wood support member 68. The web 309a of the hold-down spacer brace 309 is attached to the depth sides 68d of the wood support members 68. By having the hook fingers 127 and the hold-down brace 309 attach to the wood support members 68 with fasteners 122 through the depth sides 68d, the wood support members 68 are now connected to the wood support members 68 against the wood grain of the support members making the connection stronger than typical wood framing construction practices. The web 310a of the hold-down spacer bracket 310 can also be attached to the depth sides 68d of the wood support members 68 similar to the connection in FIGS. 101 47-49.

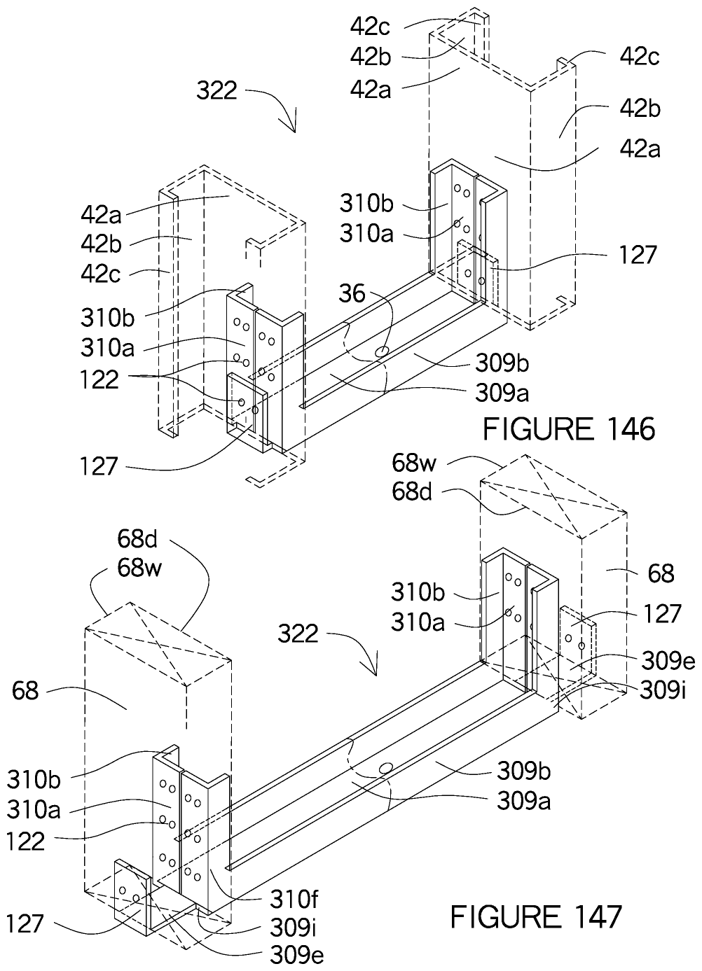

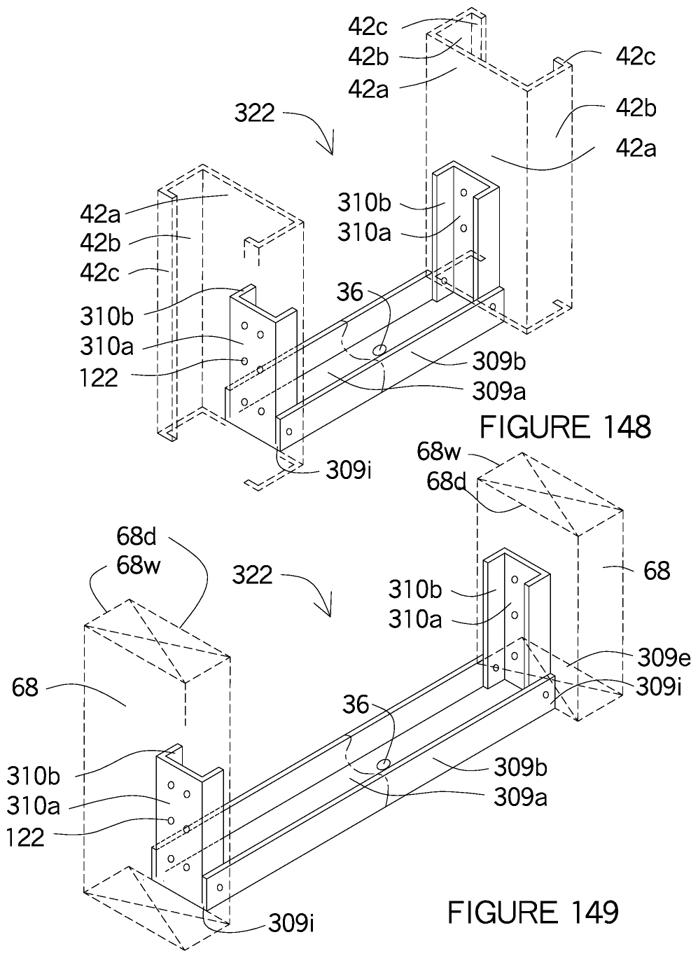

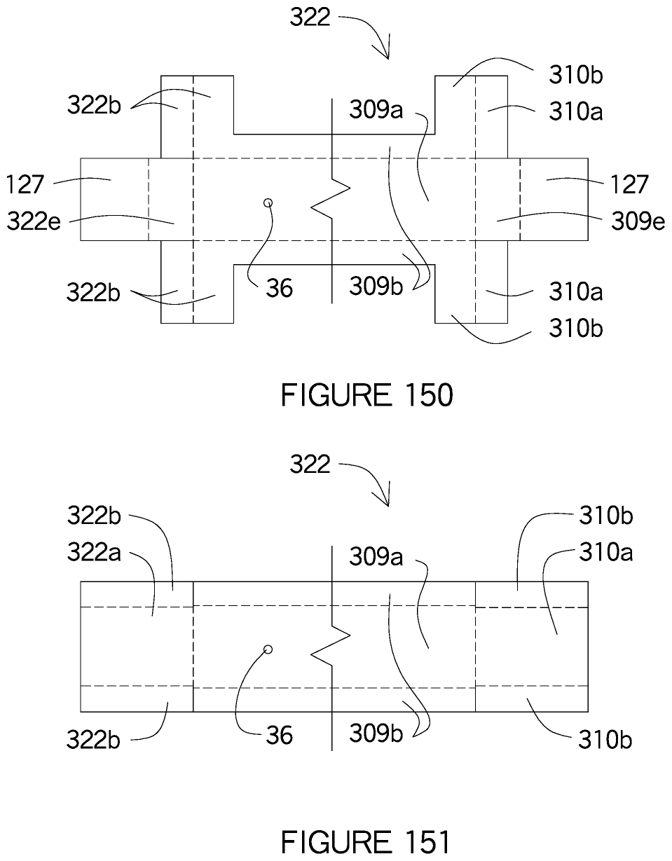

FIGS. 146-147 shows a one piece hold down spacer brace-bracket 322 consisting as one rather than the hold-down spacer brace 309 and the hold-down bracket 310 shown in FIGS. 140-145. The end of the one piece spacer brace-bracket 322 is best described as a cross shape when the outer edge profile is cut prior to being bent into shape and shown in FIG. 150 where the left side is numbered relative to the one piece spacer brace-bracket 322 and the right side is number relative to a hold-down spacer brace 309 and the hold-down bracket 310. The bottom stem of the cross consists of a web 322a and the flanges 322b. The arms of the cross shape are an extension of the flanges 322b equal to the length of the arms or when compared to the hold-down bracket 310 the arms are the combination of the web 310a and the flanges 310b as shown in FIG. 148. The top of the cross shape is the extension 322e and the hook finger 127. The solid lines in FIG. 150 are a cut surface and the dotted lines are where a bend occurs separating say a web 322a and the flange 322b. FIGS. 146 & 147 53 & 54 are the same one piece hold down spacer brace-bracket 322 except the extension 322e has different length. That is the width of the web 42a is the thickness of the metal material and the width 68w of the wood framing member 68 is the thickness of a wood framing support member. In both FIGS. 145 & 147 the edges of the flanges 522b abut against the support member and the extension 322e passed under the thickness of the support member and the hook finger engages the opposite side of the support members and is connected to adjacent support member by the web 322a and flanges of the U shaped spacer braces so the opposite end can abut the adjacent support member in the same fashion with the ends of the flanges 322b abut the web 42a of a C channel 42 or the depth 68d of the support member 68 so the extension 322e can pass under the support member to the opposite side of the support member.

FIGS. 148-149 show a different one-piece hold-down spacer brace-bracket 322 than in FIGS. 146-147 by eliminating the finger 127 and the extension 322e at both ends of the one-piece hold-down spacer brace-bracket 322. The bracket portion is different as previously explained, now the web 322a and flanges 322b are extended into the area previously occupied by the hook finger 127 and the extension 322e as shown in FIGS. 146-147. The outer edge profile drawing in FIG. 150-151 shows the figure numbers referring to the one piece hold-down spacer brace-bracket 322 on the left side of the figure and the right side, for explanation purposes, the figure numbers refer to a hold-down spacer brace 309 and the hold-down bracket 310. In FIG. 151 the outer edge profile is a simple rectangular shape where the middle portion reflects the hold down spacer brace 309 with its web 309a and the flanges 309b and the outside reflects the hold-down bracket 310 where the web 310a aligns with the web 309a and the flanges 309b align with the flanges 310b forming a simple rectilinear shape. The flanges 310b are bent in tighter so the flanges 310b can fit inside the flanges 309b. Even though the one piece hold-down spacer brace-bracket 322 is described as two different pieces, the brace-bracket is made of one piece, that is the web 322a is the same as web 309a and is continued as web 310a while the flanges 322b is the same as the flanges 302b and 310b, however the metal was cut so the flange 310b could overlap the flange 309b. As shown previously the solid line is referring to a cut when explained in FIG. 56 while the dotted line is referring to a bend when forming the one piece hold-down spacer brace-bracket 322.

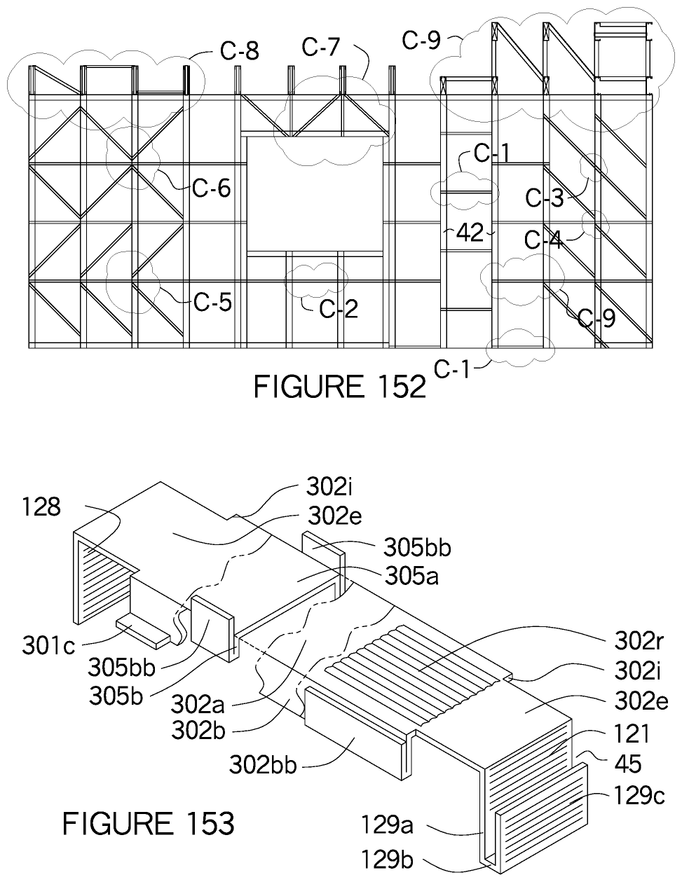

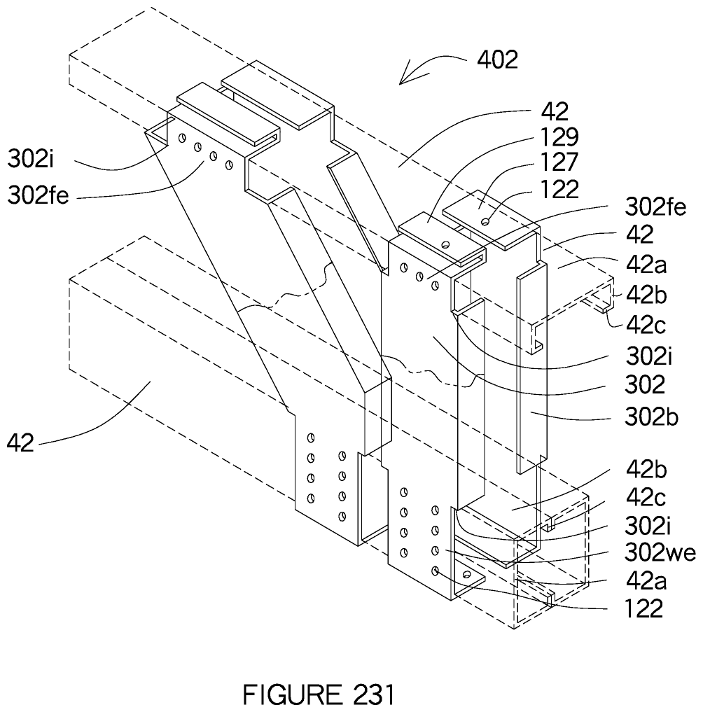

A DESCRIPTION OF THE PREFERRED in FIGS. 152-231 showing typically a U shape horizontal spacing-bracing member having a hook receiver for a hook tongue to fit into. A double hook receiver on each side of the metal or wood framing member enables the longitudinal ends with hook tongue to engage the hook receivers. Other variations of hook tongue and hook receivers are incorporated into this application.

The drawings show various types of connections using interlocking spacer braces, bracing clips, hook clips and bracing brackets that connect different building construction components together to form integrated building wall and floor assemblies using the light gauge metal framing. The spacer braces connect vertical or horizontal support members together individually, diagonally and or in tandem between adjacent spacer braces. The bracing clips, bracing brackets can be installed vertically or horizontally so the spacer braces can connect to them to also form diagonal spacer braces giving the flexibility to form a framing structure using wood or metal framing support members.

FIG. 152 shows an elevation of a metal or wood framed walling with various clouds or cut away areas to for various configurations explained in some of the following figures noted in the drawings. Spacer braces are used to connect support members together whether the support members are vertically or horizontally oriented and or whether the spacer braces have the webs oriented vertically or horizontally or whether the spacer braces are horizontal, vertical or installed at an angle. For example in C-4 the spacer braces can be installed on the flange of the support member or can be installed through the holes of the support member either horizontally or diagonally. When installed through the holes the spacer braces would be mounted on the top edge and bottom edge of the hole. The space braces can be connected using fasteners or no fasteners. The spacer braces can be secured vertically, horizontally and diagonally without using fasteners. The spacer braces can be connected directly to the support members or can be connected by using U-shaped clip or W-shaped clips. The spacer braces in C-7 is similar however here the spacer braces and support members are forming a truss beam using spacer braces as the connection cords of the truss beam as shown in C-8. Lateral bracing between truss beams can be horizontal or diagonal when making spacer brace connections. Spacer braces can be used as the top plate or bottom plate of a metal framed wall. When the spacer braces are used at the end or beginning or a tandem row of spacer braces a hooked finger end connection is used and when two tandem rows or short spacer braces are used the hook receiver and hooked tongue interlock and secure the spacer braces together. The shape of the holes in the support member could be triangular or rectilinear which might also affect the installation as well as the shape of the spacer braces having a C, I, J, U shape and whether the spacer braces have the interior side facing upward or downward.

FIG. 153 shows an isometric drawing of a spacer brace having different configurations. One variation shows a downward oriented U shaped spacer brace 302 having an elongated body with a web 302a having two flanges 302b extending downward from the interior side of the web 302a. The U-shaped spacer brace 302 is shown where the exterior side is oriented horizontally and two flanges 302b extend downward from the interior side. Another variation shows a reverse lip spacer brace 301 having a U shape with a lip 301c extending from the bottom edge of the double flange 301bb in an outward direction away from the web 301a and better shown as a reverse lip brace 301 in FIG. 167. Another variation of the U shaped spacer brace 302 has the flange 302b shown as a double flange 302bb where the flange 302b is bent twice to increase the strength. Another variation shows an I shape spacer brace 305 where the flanges 305b and 305bb are slightly different than the reverse lip brace 301 as the flange 305b extends downward from the web 305a then bents upward to form flange 305bb, but extends above the web 305a forming an I shape at the both flanges. By forming various fixation connection such as grooves 121, indentations or ribs in the direction of the elongated spacer brace the metal surface is broken and the ribs will increase the strength of the elongated spacer brace. The thickness of the metal to form the spacer brace can increase in thickness to increase the strength of the spacer brace. The left side shows and an indentation 302i extend from the flanges 302b and into the web 302a where the web 302a has an extension 302e. The extension 302e can be wide or narrow depending if the extension 302e is installed in a hole or over a flange as shown later in the figures. The extension 302e on the left end forms a hook tongue 128 and forms a hook receiver 129 on the right end. When two U shaped spacer braces 302 are connected in tandem, the hook tongue 128 fits into the gap 45 of a hook receiver 129 from an adjacent spacer brace. When the hook tongue 128 is connected to the support member and not installed into the hook receiver 129 it is referred to as a hook finger 127.

FIG. 154 is a cross section through a metal framed wall showing numerous sizes and shapes of spacer braces being attached to a C channel 42. Some spacer braces are attached to the web 42a or by the hook finger 127 or the hook receiver 129 that has a hook tongue 128 installed within the hook receiver shown here as a U-shaped hook receiver 129 when installed in tandem. The holes 36 within the web 42a are usually rectangular in shape, however a triangular shape hole 36t is also shown showing three various spacer braces in FIGS. 181-183. The U-shaped spacer braces 302 near the bottom shows one U shaped spacer brace 302 where the exterior side is oriented on the top side and the flanges 302b are extending downward while the other U-shaped spacer brace 302 the exterior side is oriented on the bottom side and the flanges 302b are extending upward. The reverse lip spacer brace 301 on the right side of the support member is installed so the web extension 301we (not shown) at the web 301a can extend over the flange 42b so the hook finger 127 can be connected to the web 42a of the support member. On the left side the reverse lip spacer brace 301 is installed so the lips 301c are supported at the flange 42b. The reverse lip spacer brace 301 also on the left by further down the wall, shows the side 301b at an angle like a hat channel shape. Just below is a U shape spacer brace 302 that shows a double flange 302bb and the edge of the double flange 302bb is against the flange 42b of the support member. In addition, the U shape spacer brace 302 shows a light weight line below the

U shape spacer brace 302 which references that the U shape space brace 302 is installed at an angle or diagonally over the flanges 42b of the support members. A C shaped spacer brace 303 is installed on the flange 303b where the lip 303c rests against the flange 42b and the hook finger 127 is secured to the web 42b. At the base is a horizontally oriented U shaped spacer brace 302 shown as a base plate of a framed wall where the exterior side is connected to a floor 401 by an anchor bolt 354 and explained as a hold-down 309 in FIGS. 161 & 163. The hold down 309 can be the full wide or less than full width of the support member. The web 302a extends under the support member shown as a C shape channel 42 where the hook receiver 129 is attached to the web 42a and the hook tongue 128 is attached into the gap 45 of the hook receiver 129. On the opposing end is a upper base plate where the exterior side is secured to a support structure and slot holes 36s are shown in the hook receivers 129 or hook fingers 127 where a fastener (not shown) is installed into the slot hole 36s and the C-channel 42 connection is allow to move should the support structure above moves. Other spacer braces are oriented at a diagonal within the triangular shaped holes 36t. Some spacer braces are secured at the lips 42c by U shaped hook receivers 129 having a U-shape or L-shape configuration.

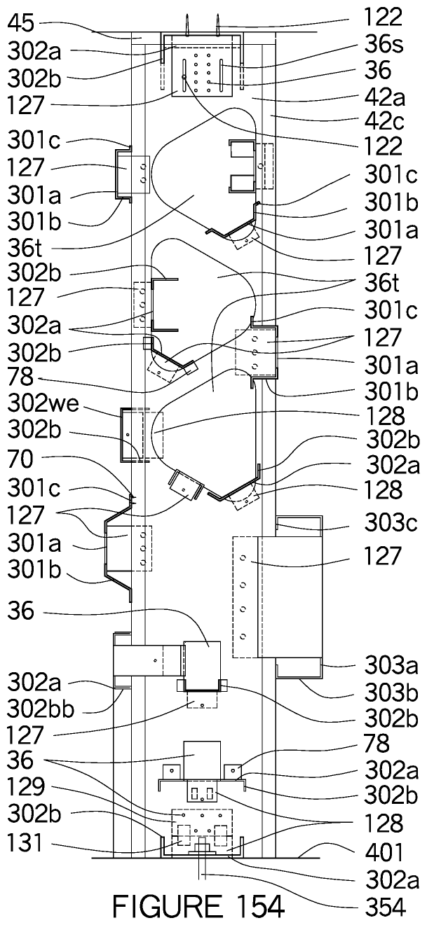

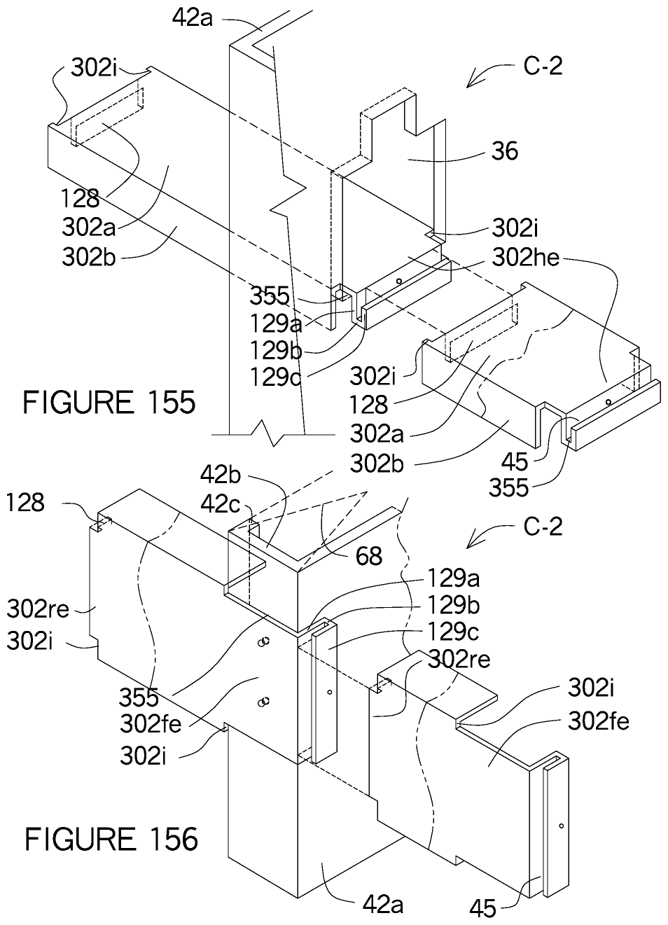

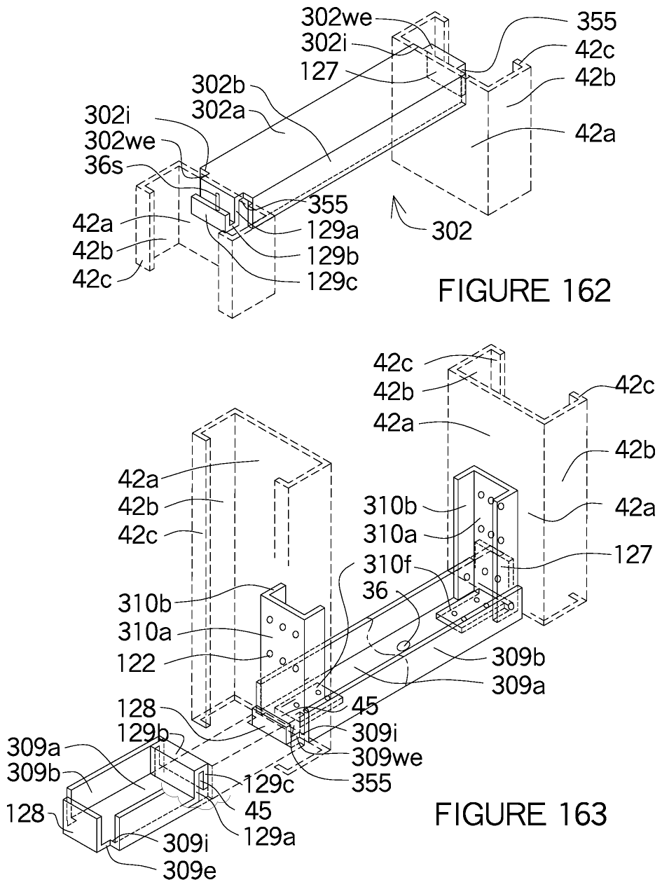

FIG. 155 shows an enlargement of a spacer brace in FIG. 152 or FIG. 154 between support members; however only one of the support members is shown. The U shaped spacer brace 302 having an elongated body with the exterior side shown as the web 302a with a interior side having two flanges 302b extending downward from the web 302a with both ends of the elongated U shaped spacer brace 302 having the side edges of the flanges 302b engaging the web 42a on both ends between the support members forming the first engagement connection between framing members. The U shaped spacer brace 302 is slightly narrower as only the flanges 302b abut the web 42a of the support member. On the right side the web 302a of the U shaped spacer brace 302 has an indentation 302i and a hole extension 302he when abutting the web 42a of the C channel 42 shown as the support member. When the hole extension 302he spans over the anchor space 355 and extends over the bottom edge of the hole 36 a hook receiver 129 is formed having a U-shaped configuration with the first leg 129a extends downward then bending 90 degrees forming a second leg 129b then bending 90 degrees again forming an upward oriented third leg 129c leaving a gap 45 between the first and third legs 129a & 129c forming the second engagement connection between framing members. By bending the first leg 129a on the opposite side of the web 42a from the end of the flanges 302b the U shaped spacer brace 302 is now engaged. To the right of the hook receiver 129 shows an another U shaped spacer brace 302 with a hook tongue 128 on the left side and the two flanges 302b extending beyond the hook tongue 128 so the two flanges 302b can extend beyond the hook receiver 129 and abut the web 42a of the support member. The hook tongue 128 extends downward from the web 302a over the third leg 129c of the hook receiver 129 into the gap 45. The hook tongue 128 extends downward from the web 302a over the third leg 129c of the hook receiver 129 into the gap 45 where another anchor space 355 exists when the hook tongue 128 rests on the gap side of the second leg 129b. The third engagement connection between framing members occurs when the hook tongue 128 fits into the gap 45 between the downward oriented first leg 129a and upward oriented third leg 129c thereby engaging two U-shaped spacer braces 302 together. In FIG. 162 the U shaped spacer brace 302 is shown as a top plate of a support member.

FIG. 156 also shows an enlargement of the U-shaped spacer brace 302 shown in FIG. 155; however the U-shaped spacer brace 302 is shown with the dorsal side in a vertical position shown with the web 302a resting against the flange 42b of the C channel 42 being the supporting member of the wall framing construction. The flanges 302b extend horizontally on the interior side of the U shaped spacer brace 302 and abut the lip 42c of the support member. The web 302b of the U shaped spacer brace 302 has an indentation 302i then a flange extension 302fe spans over the anchor space 355 that extends across the face the flange 42b of the support member. Since the U shaped spacer brace 302 has the exterior side in a vertical position, the hook receiver 129 is bent horizontally so the first leg 129a is bent parallel to the web 42a of the support member, then bent 90 degrees forming a second leg 129b then bending 90 degrees again forming an outward oriented third leg 129c leaving a gap 45 between first & third legs 129a & 129c. By bending the leg 129a at the lip 42c and on the opposite side at the web 42a the U shaped spacer brace is engaged on both sides of the support member. On the right side of the support member, another U shaped spacer brace 302 is shown having the hook tongue 128 on the left side that is formed by a receiver extension 302re where the receiver extension 302re extends over the third leg 129c of the hook receiver 129 and the hook tongue 128 fits into the gap 45 between the first leg 129a and third leg 129c thereby engaging two U shaped spacer braces 302 together. The vertical support members can be wood framing members 68 in lieu of the C channels 42.

FIG. 157 has downward oriented U shaped spacer braces 302 installed in tandem between the bottom edge of the hole 36 in the web 42a of the support member. The left U shaped spacer brace 302 has an indentation 302i at the flange 302b and web 302a with the web 302a extended at the hole extension 302he over the bottom edge of the hole 36 or anchor space 355 with the hook receiver 129 having its first leg 129a extend downward then the second leg bent 129b bent horizontally forming a gap 45 with the third leg 129c extending upward. The opposite end of another U shaped spacer brace 302 on the right has the indentation at the flange 302b so the web 302a can have a wide hook tongue 128w bent against the vertical edges of the flanges 302b for the wide hook tongue 128w can fit into the gap 45 and be connected at the holes with fasteners (not shown) to the web 302a forming a continuous diagonal connection between the hole 36 of adjacent support members.

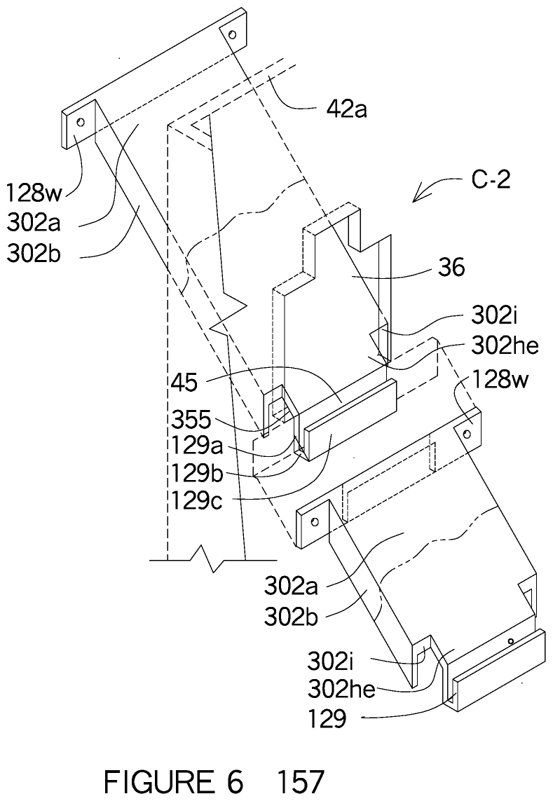

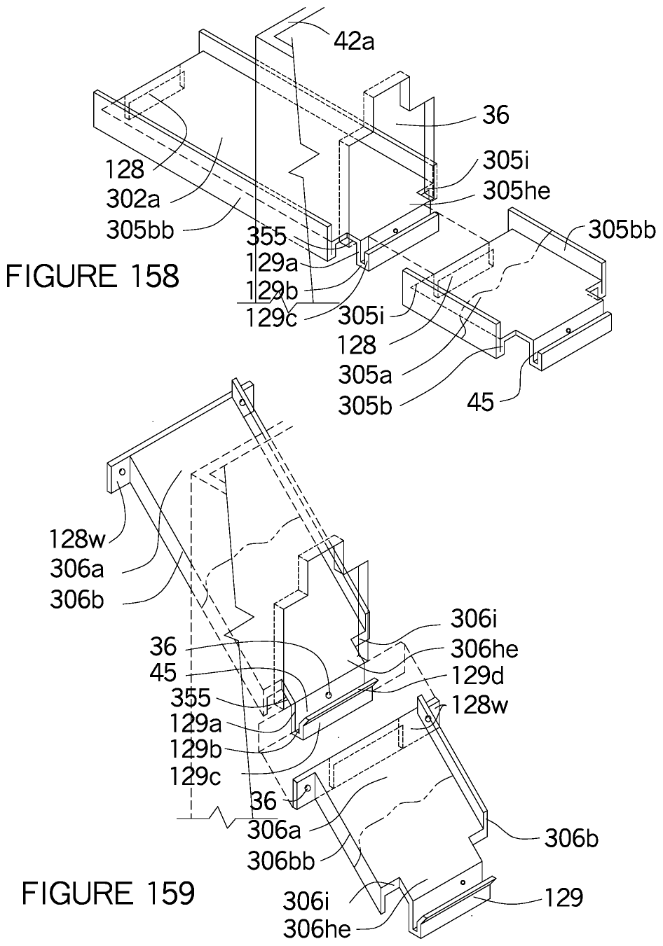

FIG. 158 show an I shaped spacer brace 305 spanning between support member shown as a C channel 42 where a hole 36 is installed in the web 42a and a hook receiver 129 has an indentation 305i with a hole extension 305he resting on the bottom edge of the hole 36 at the anchor space 355. The hook tongue 128 extends downward from the indentation 305i at the web 302a that extends into the gap 45 of the hook receiver 129. The flanges 305b & 305bb extend to the web 42a of the support member bracing the flanges 305b & 305bb tight against the web 42a and restricting the hook tongue 128 from moving horizontally out of the gap 45 and keeping the hook tongue 128 between the flanges 305b & 305bb creating another type of framing connection as a third engagement. The I shaped spacer brace 305 having the web 305a with the exterior side upwards with the flanges 305b extending downward and further extending the flanges 305b so the flanges 305bb extend upward above the exterior side of the web 305a of the I shaped spacer brace 305. The double flanges 305bb add additional strength and give added support should insulation be installed between the support members.

FIG. 159 shows a J-shaped spacer brace 306 where the hook tongue 128 is on the left side the hook receiver 129 is on the right side. The J-shaped spacer brace 306 has a downward oriented flange 306b connected to a horizontal oriented web 306a being connected to an upward oriented flange 306b. The J-shaped spacer brace 306 is shown passing through the hole 36, however the J-shaped spacer brace 306 is wider than the hole 36 in the support member shown as a C channel 42. The second engagement connection between framing members being the downward and upward flanges 306b and the web 306a are indented 306i at the hole 36 so the web 306a can have a hole extension 36he that rests on the lower edge of the hole 36 at the anchor space 355 and against the side edges of the hole 36. The hole extension 36he connect to the hook receiver 129 that is inserted through the hole 36 and where the first leg 129a extends downward from the bottom edge of the hole 36 then horizontally forming the second leg 129b the vertically forming the third leg 129c. The hook receiver 129 is formed by using the three legs 129a, b and c. The opposite end of J-shaped spacer brace 306 has a wide hook tongue 128w that fits into the gap 45 between the first and third legs 129a & 129c. The wide hook tongue 128w can be formed by cutting the flanges 306b prior to the bending the flanges 306b, then bending the hook tongue 128 leaving the wider sides being formed from the flanges 306b.

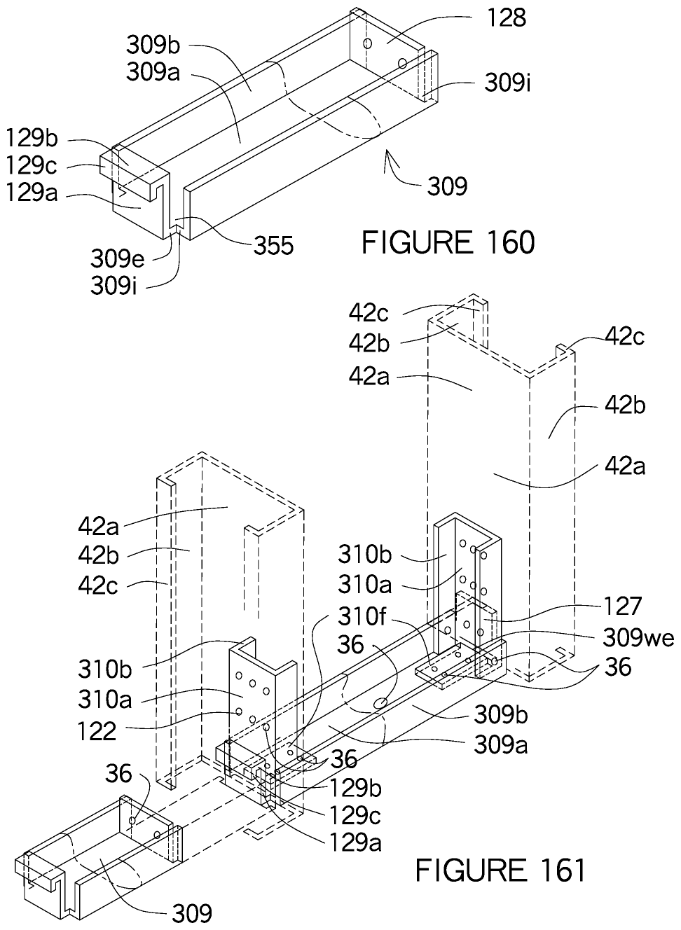

FIGS. 160 & 161 show a hold-down spacer brace 309 having a U-shape with the exterior side of the web 309a is against a floor where an anchor bolt (not shown) passes through the hole 36 in the web 309a and is anchored to the floor and the flanges 42b extend upward for the web 42a. In FIG. 161 the hold-down spacer brace 309 spans between two support members shown as C channel 42 having a web 42a with two flanges 42b extending upward from the web 42a. On the right side the flanges 42b abut against the web 42b of the support member and the web 309a has an indentation 309i and the web 309a has an extension 309e that extends under the web 42a of the support member and upward forming a hook finger 127 on the interior side of the web 42a of the support member and is secured by fasteners (not shown) in the holes 36. On the left side the hold-down spacer brace 309 also has its flanges 309b abut the web 42a of the support member being the first engagement connection and the web 309a has an indentation 309a and an extension 309e that passed under the web of the support member being the second engagement connection and the anchor space 355 of the support member. The hold-down spacer brace 309 on the left side is design to be connected to another hold-down spacer brace 309 in tandem so the left end has a hook finger 129 where the extension 309e is bent upward against the interior side of the web 42b of the support member forming the first leg 129a, then horizontally away from the web 42a forming the second leg 129b leaving a gap 45 for a third leg 129c to extend downward forming a U-shape. The same profile is shown in FIG. 198 except in FIG. 161 the profile is upside down in relation to FIG. 161. To the left of the hold-down spacer brace 309 is another hold-down spacer brace 309 that is described in FIG. 160. The hold-down spacer brace 309 is also U-shaped have a web 309a with two flanges extending interior upward from the web 309a. On the right side the web 309a has an indentation 309i that is set back from the vertical edges of the flanges 309b and the web 309a has a hook tongue 128 that extends from the interior side upward. The opposing end also has an indentation at the web 309a and an extension 309e with a hook receiver 129 having its first leg 129a extend upward with its second leg 129b extending horizontally for a gap 45 so the third leg 129c can extend downward. The hook tongue 128 from FIG. 160 is installed in the gap 45 between the first and third leg 129a & 129c as shown by the dashed lines into the hook receiver 129 in FIG. 161. The third engagement connection shows the hook tongue 128 fits into the hook receiver 129 at the gap 45 and between the flanges 309b so the hook tongue 128 cannot move horizontally out of the gap 45 eliminating the need for fasteners to secure the hook tongue 128 to the hook receiver 129. FIG. 160 also shows the hook receiver on the left side of the hold-down spacer brace 309. The web extension 309we at both the hook finger 127 and the hook receiver 129 is the anchor space 355 for the hold-down spacer brace 309 to be secured between the end of the flanges 309b and the hook finger 127 or hook receiver 129 in FIG. 161. On the other hand when the hold-down spacer brace 309 is in tandem, the web extension 309we is the second engagement connection to secure the web 42a of the support member between the hook tongue 128 or hook receiver 129 and the end edges of the flanges 309b. FIG. 161 shows a separate hold-down bracket 310 with a web 310a fitting against the web 42a of the support member with flanges 310b extending internally outward and its web 310a bent parallel to the floor forming an end plate 310f. The end plate 310f and flanges 310b can be fastened to the hold-down spacer brace 309 and against the web 42a of the support member.

FIG. 163 is similar to FIG. 161 as the hold-down spacer brace 309 on the right side are the same configuration, while on the left side shows the indentation 309i at the flange 309b and the web 302a with the web 309a having a web extension 309we pass under the web 42a of the support member forming the anchor space 355 and extend beyond the web 42a so a gap 45 is formed between the web 42a and the hook tongue 128 that extends upward. The gap 45 is required as the adjacent hold-down spacer brace 309 has a hook receiver 129 where the third leg 129c fits into the gap 45 as shown in FIG. 163. The hold-down spacer brace 309 can vary where the hook receiver 129 can have the third leg 129c extend downward with the flanges 309b being level with the third leg 129c in order for the hook tongue 128 to fit into the gap 45 and keep the hook tongue 128 stable between the two flanges 309b as shown in FIG. 163. On the other hand, FIG. 160 had the flanges 309b extend beyond the hook tongue 128 as described in FIG. 161.

FIG. 162 shows a U-shaped spacer brace 302 extending over the top edges of a support member shown as a C channel 42 where the interior side has the web 302a with its flanges 302b extending downward. The right side show the flanges 302b and web 302a indented with the flanges 302b abutting the web 42a of the support member. The web 302a has a web extension 302we that extends over the web 42a at the anchor space 355 for a hook finger 127 to extend downward against the opposing side facing of the web 42a. The left side shows the indentation 302i of the web 302a and the flanges 302b where the flanges 302b abut the web 42a of an adjacent support member. The web 302a of the U-shaped spacer brace 302 has another anchor space 355 at the web extension 302we where the first leg 129a of the hook receiver extends downward against the web of the support member also referred to as the second engagement mean connection. The second leg 129b extends outward parallel to the web 42a leaving a gap 45 for the third leg 129c to extend upward forming a U-shaped hook receiver 129. The U-shaped spacer brace 302 shows the hook finger 127 on the right side and the left side of the shows the hook receiver 129 which is the beginning of installing the U shaped spacer braces 302 in tandem. When the U shaped spacer brace 302 is secured to the ceiling or floor above with fasteners as shown in FIG. 154 and the longitudinal ends of the support members have a gap 45, the longitudinal end that is installed in the web extension 302we between the first leg 129a on the left end or the hook finger 127 on the right end plus the flanges 302b are allowed to slide up and down in the anchor spacer 355 at the web extension 302we. In order to be able to slide the flanges 302b and the first leg 129a or finger 129 are longer in length to allow for the support member to slide between the two surfaces. At the top of the wall the U shaped spacer brace 302 is secured to the ceiling by fasteners 122 and the longitudinal end of the support member has a gap 45 between the longitudinal end and the ceiling. The gap 45 allows the support member shown as a C channel 42 to move vertically should the floor or ceiling move. The slot holes 36s with a fastener 122 (not shown) are needed to secure the support member horizontally to the U shaped space brace 302 as shown in FIG. 162.

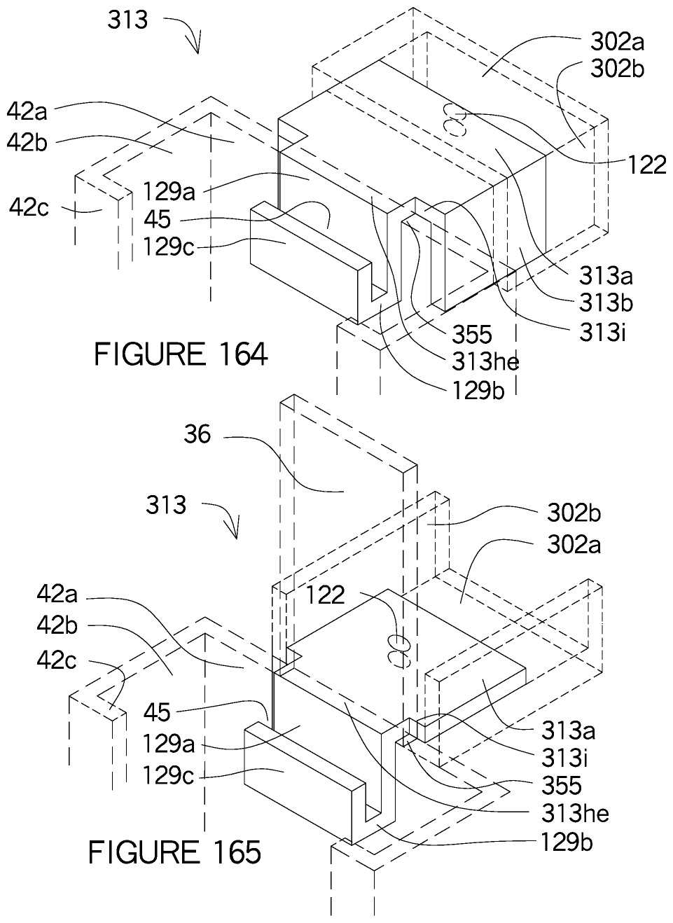

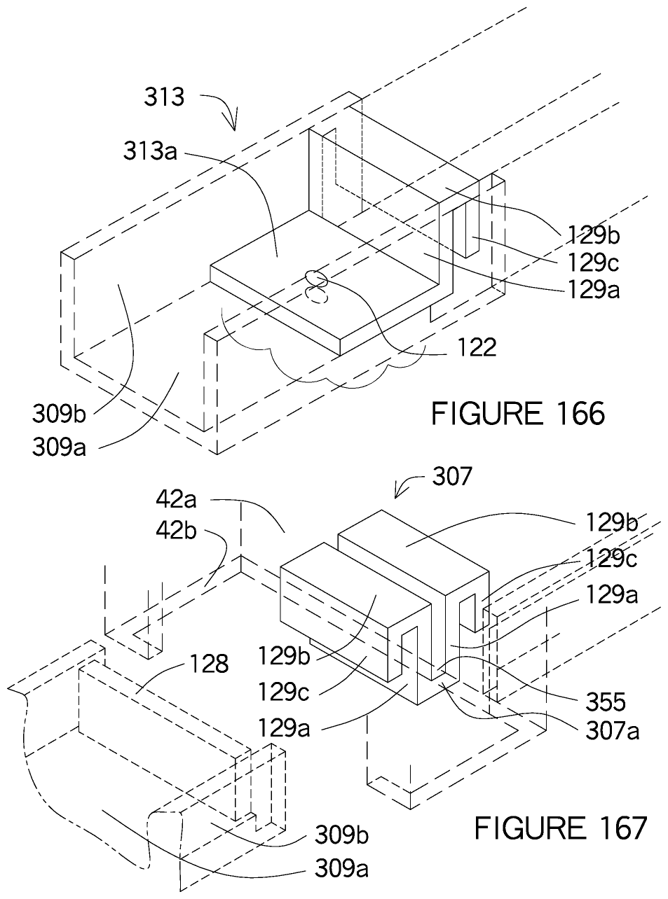

FIGS. 164-166 are add-on connectors 313 where I, C, J, W or hold-down spacer braces have been cut or altered so a hook receiver 129 can be added to the spacer brace in order to continue the spacer braces with a tandem connection. In FIG. 164 the add-on connector 313 has a U-shape with a web 313a and flanges 313b that fit into the interior side of a U-shape spacer brace 302 with is web 302a and flanges 302b fit tight against the exterior side of the add-on connector 313. FIG. 164 shows the web 313a and flange 313b protruding from the U-shape spacer brace 302. The add-on connector 313 has an indentation 313i at the web 313a and flanges 313b with the flanges 313b abutting against the web 42a of the support member. The web 313a has a web extension 313we that fits over the web 42a of the support member at the anchor space 355 where the first leg 129a of the hook receiver 129 extends downward against the opposing side of the web 42a then extending horizontally outward from the web 42a forming the second leg 129b with the third leg 129c extending upward leaving a gap 45 between the first leg 129a and the third leg 129c. In FIG. 165 the web 313a of the add-on connector 313 is installed directly over the web 302a of the U shaped spacer brace 302 so the web 302a, flanges 302b and the indentation 313i abut the web 42a of the support member and the web extension 313we rest upon the anchor space 355 with the first leg 129a extending over the support member. In FIG. 166 the web 313a of the add-on connector 313 is attached to the web 309a of the hold-down spacer brace 309 as shown as a one piece hold-down spacer brace 309 in FIG. 163.

FIGS. 167-170 show various W-shaped clips 307 or U-shaped clips 308 passing the through the holes 36 in the web 42a of the support members, over or under the web 42a of support members, connecting adjacent support members together and how the W-shaped clips 307 or U-shaped clips 308 connect to adjacent spacer braces.

FIGS. 167 & 169 show the same W-shaped clip 307 however in FIG. 152 the W-shaped clip 307 fits under the web 42a of the support member at the anchor space 355 with the hood receivers 129 are oriented with the gaps 45 opening downward and in FIG. 169 the web 42a of the support member fits under the web 307a at the anchor spacer 355 and the hook receivers 129 have the gaps 45 opening upward in the opposite direction. In FIG. 169 the W-shape clip 307 has a horizontally oriented web 307a where the web 307a is the extension that fits over the thickness of the web 42a of the support member and extends over both the vertical side edges of the web 42a so a hook receiver 129 can be installed on both sides of the web 42a of the support member and the first leg 129a extends downward against the web 42a with the second leg 129b extending outward from the web 42a forming a gap 45 where the third leg 129c extends upward forming a U-shape hook receiver 129 on both sides of the web 42a of the support member. The W-shape clip 307 is also shown passing over the hole bottom edge 36be of a support member engaging the hole side edges 36se. FIG. 167 shows the same W-shaped clip 307 however the web 42a of the support member fits on top of the ventral interior side of the web 307a and the exterior side fit against the floor and the hook receiver 129 has the U-shape turned downward. To the left of the W-shaped clip 307 shows the hook tongue 128 extending upward from the web 309a of the hold-down spacer brace 309. One of the third engagements described in FIGS. 196 & 197 shows the hook tongue 128 fitting into the gap 45 lodging the W-shaped clip 307 to the hook tongue 128. Any shape spacer brace can be used in and the hook tongue 128 for any spacer brace can fit into the W-shaped clip 307.

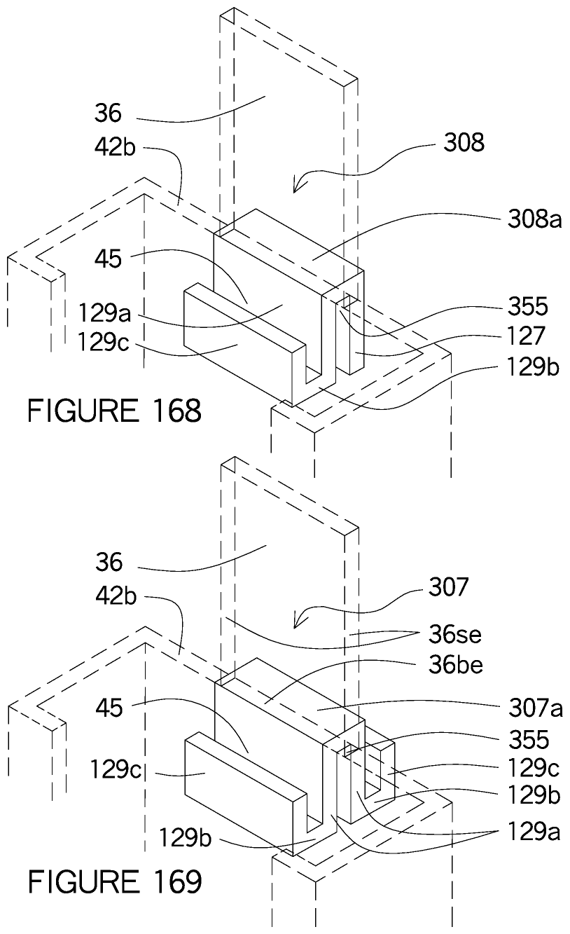

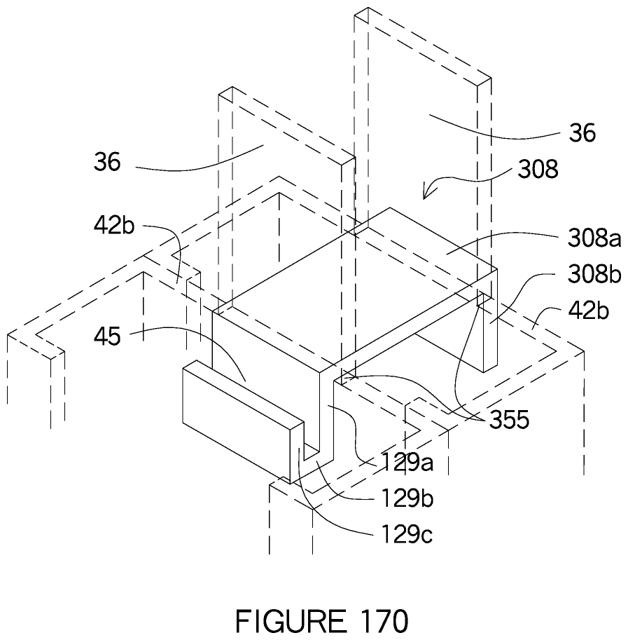

FIGS. 168 & 170 how the same U-shaped clip 308 however in FIG. 170 the U-shape clip 308 connects two adjacent support members together. FIG. 168 shows the U-shape clip 308 having a web 308a that extends over the thickness of the web 42a at the anchor space 355 and extending over both the vertical side edges of the web 42a so a hook finger 127 can be installed against the web 42a of the support member and the opposing end of the web 308a can be installed against the opposing side of the web 42a of the support member so the first leg 129a extends downward against the web 42a with the second leg 129b extending outward from the web 42a forming a gap 45 where the third leg 129c extends upward forming a U-shape hook receiver 129 on both sides of the web 42a of the support member. In FIG. 170 the same U-shaped clip 308 is shown, however the web 308a extends over the top of two webs 42a or the holes bottom edge 36be and shown as the anchor space 355 in the webs 42 of the support members. Many times a cripple support member (a less than full height support member is used together with a full height wall support member to frame a door or window opening) is adjacent to a support member for structural support when framing a wall.

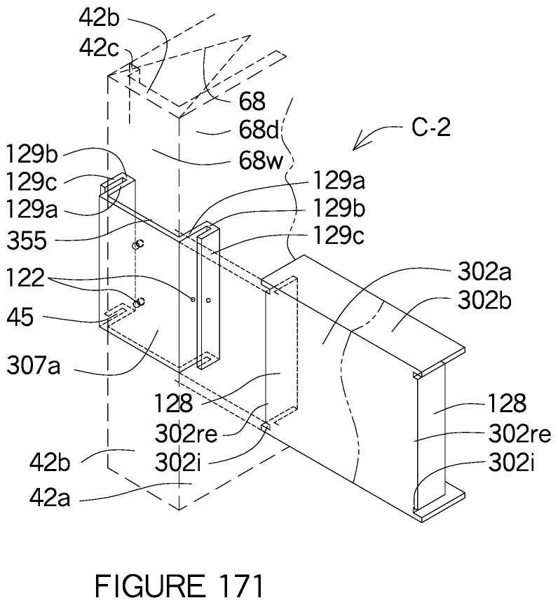

FIG. 171 is similar to FIG. 169 except in FIG. 171 the W-shaped clip 307 has a vertical oriented web 307a and the interior side has the anchor space 355 against the flange 42b of a vertical support member or against the width side 168w of a wood support member 168. The web 307a extends over the flange 42b or the depth side 168d of the wood support member 168. Both sides of the web 307a have the first leg 129a of the hook receiver 129 extend horizontally against the sides of their respective surfaces then vertically extending away from the first leg 129a forming a second leg 129b leaving a gap 45 for a third leg 129c to extend vertically toward the web 307a of the W-shaped chip 307. To the right of the W-shaped clip 307 shows a vertically oriented U-shaped spacer brace 302 where the web 302a is flush with the web 307a of the W-shaped clip 307 and the flanges 302b extend inwardly leaving the exterior side flush with the W-shaped clip 307. Both ends of the U shaped spacer brace 302 show hook tongues 128 extending internally from the web 302a having an indentation 302i with a receiver extension 302re that abuts the web 307a of the W-shaped clip 307 with a hook tongue 128. The hook tongue 128 is inserted into the gap 45 of the hook receiver 129 with the flanges 302b. bracing the side edges of the hook receiver 129 from moving horizontally within the gap 45. Since the W-shaped clip 307 and the U shaped channel 302 are oriented vertically, the W-shaped clip 307 needs to be secured at the web 307a and the hook receiver 129 and hook tongue 128 need to be fastened together with fasteners 122. A spacer brace having hook tongues 128 at both ends is also shown in a schematic drawing in FIG. 197.

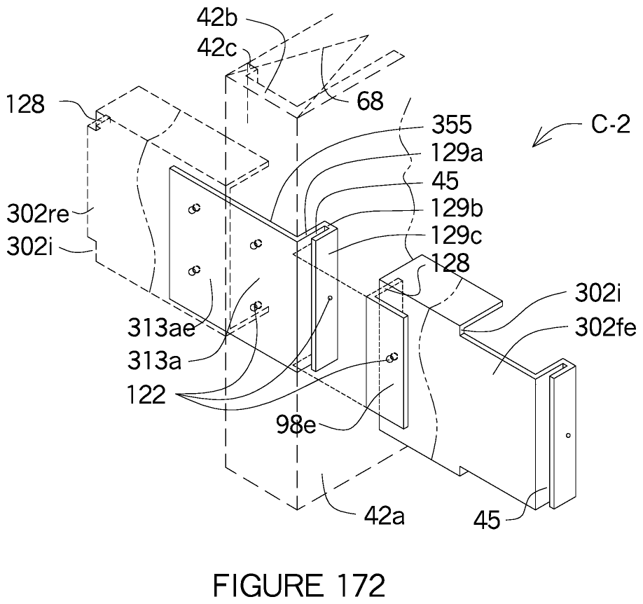

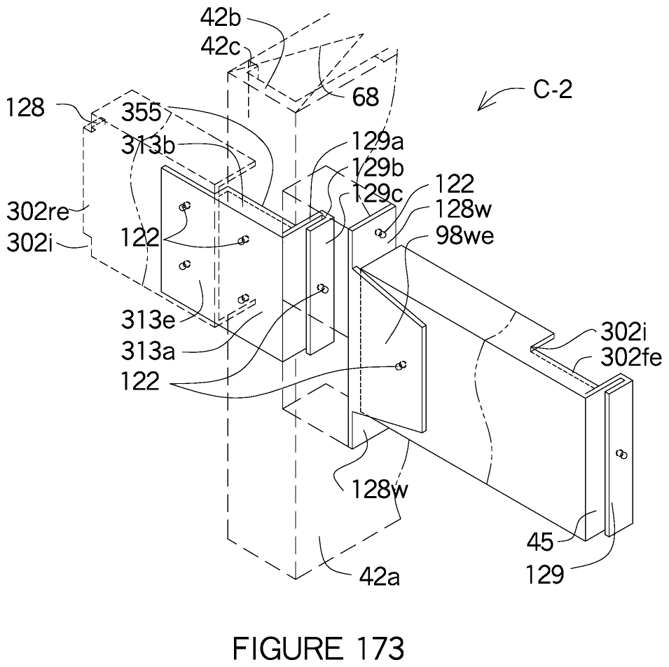

FIGS. 172 & 173 are similar as both are shown as add-on connectors 313 and are shown being connected to a vertically oriented U-shaped spacer brace 302 where the web 302a is vertically oriented with two flanges 302b extending horizontally. The right end of the U-shaped spacer brace 302 has the web 302a and flanges 302b abutting the vertical support member with the web 302a flush with the flange 42b of the C channel 42 or the width 68w of the wood framing member 68 and the left side shows an indentation 302i at the web 302a and flanges 302b where the web 302a has a receiver extension 302re for the hook tongue 128 shown bent internally. The add-on connector 313 in FIG. 173 is shown having the web 313a installed over the flange 42b at the anchor space 355 with the web extension 313we installed over the web 302a of the U shaped spacer brace 302. The right side shows the hook receiver 129 being attached to the web 313a so the first leg 129a is installed against the web 42a of the support member then turned 90 degrees forming the second leg 129b leaving a gap 45 between the third leg 129c and the first leg 129a. The add-on connector 313 is used where a standard length of a spacer brace is not available and is cut to accommodate another support member. If a spacer brace is cut it is easy to just cut the flanges 302b so the web 302a can be bent to form a hook tongue 129 or a bent angle 98 could be attached at the bent angle extension 98e to the web 302a with the opposing leg is a hook tongue 129.

FIG. 173 is similar to FIG. 172 however the U shaped spacer brace 302 extends away from the flange 42b of the support member so the add-on connector 313 extends outward from the flange 42 becoming the anchor space 355 as the web 313a has the bottom edge of the flanges 313b engage the flange 42a of the support member with the left side having a web extension 313we that overlaps the web 302a and is secured by a fastener 122 and the right side has a hook receiver 129 that has its first leg 129a with its interior side abut the web 42a of the support member then extending outwardly forming the second leg 129b leaving a gap 45 for the third leg again bent 90 degrees. The hook tongue 128 is formed by a bent angle 98 where the bent angle 98 is attached by fasteners 122 to the web 302 of the adjacent U shaped spacer brace 302, however the hook tongue is a wide hook tongue 129w where the ends extend past the width of the U shaped spacer brace 302 enough for fasteners 122 can be installed through the wide hook ends into the web 42a of the support member.

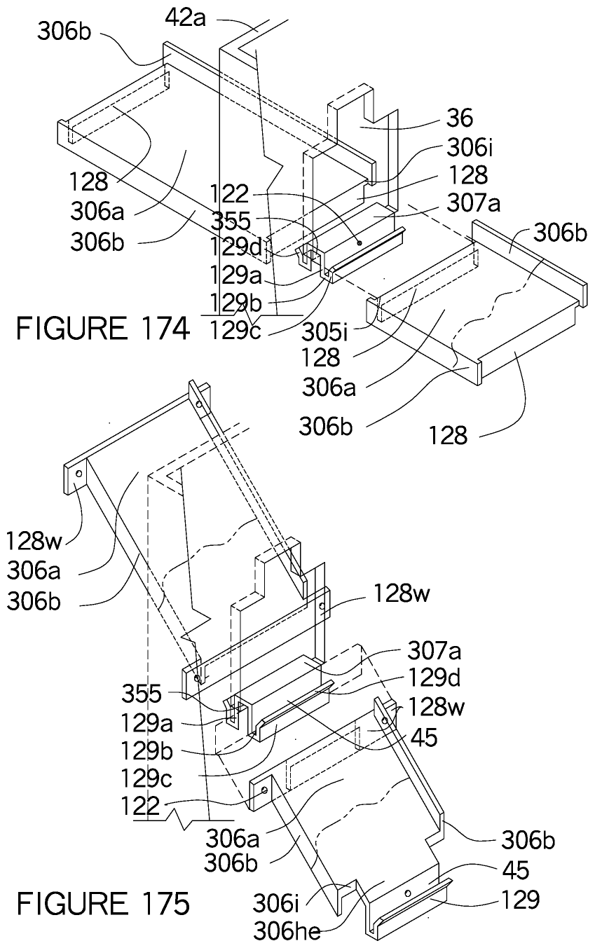

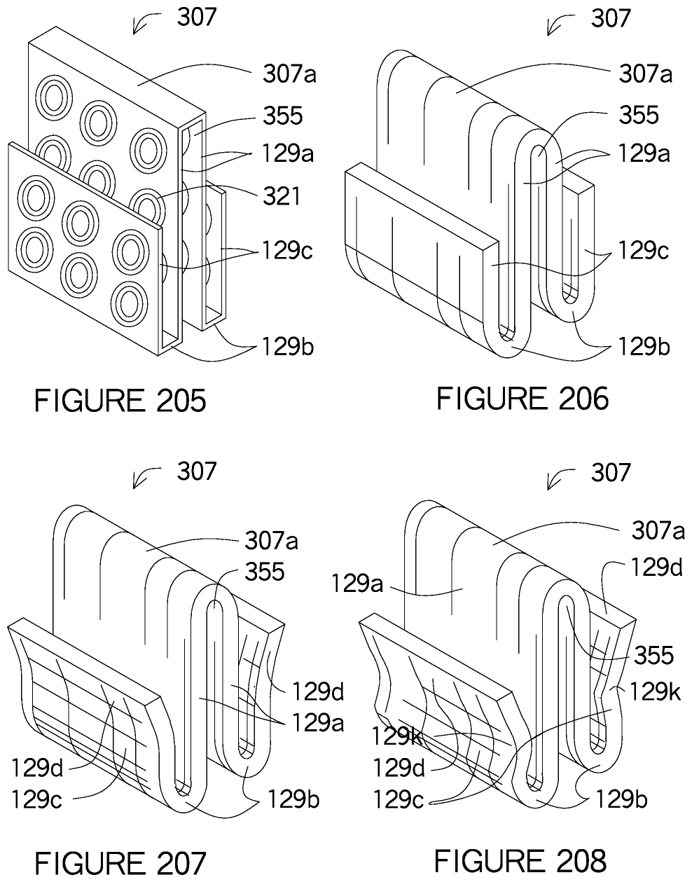

FIGS. 174 & 175 are similar to FIGS. 158 & 159 8 as the spacer braces are both horizontally oriented and both connect at the hole 36 of the support member. FIGS. 174 & 176 both show J-shaped spacer braces being connected to a W-shaped clip 307 at the hook tongue 128 of the hook receivers 129 and supported at the anchor space 355 in the hole 36. FIGS. 205-210 show various configurations of the W-shape clip 307 including the flare 129d shown here. FIG. 174 shows the hook tongue 128 at both ends as in FIG. 172 and the same configuration is shown in FIG. 197. FIG. 175 shows the wide hook tongues 128w similar to FIG. 159. By using the hook tongue 128 at both ends with a hook receiver 129 extending through the hole 36, a spacer brace can be installed in tandem between support member without having to use a full length spacer brace having a hook tongue and hook receiver at the end. Since the J-shaped spacer braces 306 is horizontal no fasteners will be required to secure the J shaped spacer brace 306 and the W-shaped clip 307 to the hole 36 as the side edges of the W-shape clip 307 will engage the side edges of the hole 36. On the other hand, FIG. 175 shows the J-shaped spacer braces 306 installed diagonally between alternating hole 36 in the webs 42a of two adjoining support members shown as C channels 42 (only one shown). The J shaped spacer braces 306 are shown with hook tongues 128 on both ends of the J shaped spacer brace 306, however the hook tongues are wide hook tongue 128w where the length of the wide hook tongue 128w is longer than the width of the web 306a so that a fastener 122 can be installed at the end of the wide hook tongue 128w to be fastened into the web 42a of the C channel 42. Since the J shaped spacer brace 306 has a wide hook tongue 128w at each end, the diagonal oriented J shaped spacer brace 306 can be installed between support members after the metal framed wall has been erected in order to provide additional stiffness to the wall construction should it be needed.

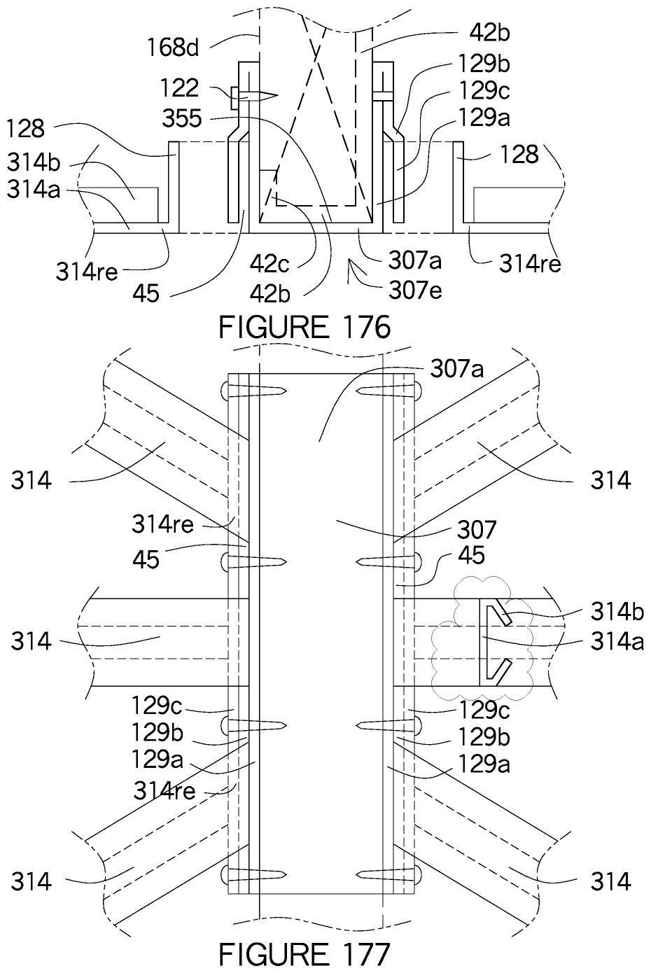

FIG. 176 is a plan view and FIG. 177 is an elevation view of an elongated W-shaped clip 307e. FIG. 177 shows 6 strap braces 314 intersecting the elongated W-shaped clip 307e where 3 braces are attached to each side of the hook receiver 129. The interior side of the web 307a is the anchor space 355 that abuts the flange 42a or the width 68w of a wood framing member for the elongated W-shaped clip 307e. The hook receivers 129 on both sides have the first leg 129a extending along the web 42a or lip 42c of the C channel 42 or the width side 68w of the wood support member 68 with the second leg 129b extending outward from the support member forming a gap 45 where the third leg 129c is bent parallel to the first leg 129a. A hook tongue 128 is shown going into the gap 45 having a receiver extension 314re extending from the web 314 of the strap brace 314. The strap brace 314 is shown having a cross section of the web 314a with flanges 314b bent about 135 degrees forming a narrow profile so insulation can more easily fit around the profile of the strap brace 314. In fact any of the vertical oriented flanges 314b shown on the previous figures can have the narrow profile of the strap brace 314. In FIG. 176 the section at the fasteners 122 does not show the gap 45 as the gap could be formed without the gap 45. When the fastener 122 is connected to both the first leg 129a and the third leg 129c together when the hook receiver 129 is installed in the gap 45, the fastener 122 acts as a stop and the fastener 122 is not able to move past the fasteners 122 when installed on both sides of the hook tongue 128

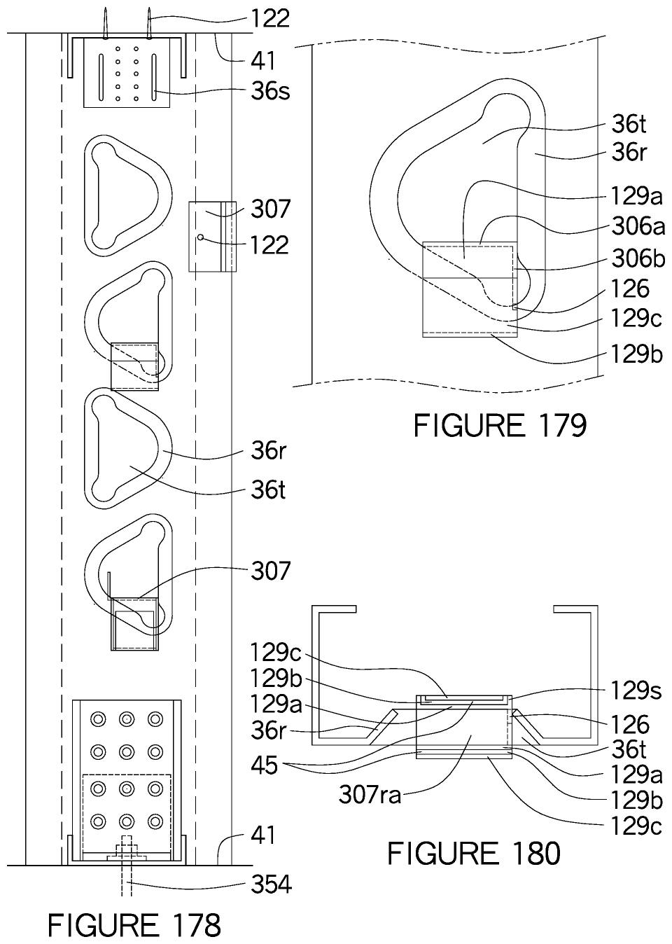

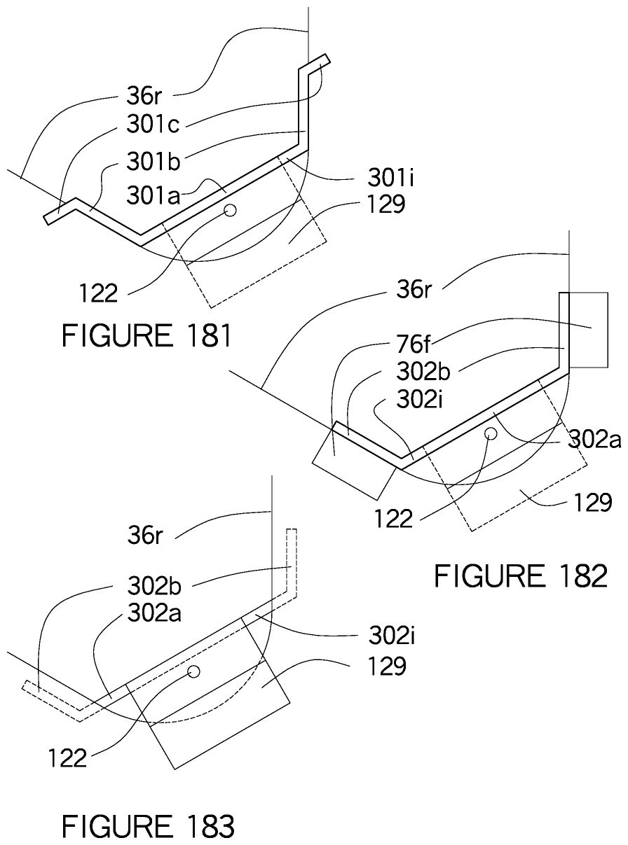

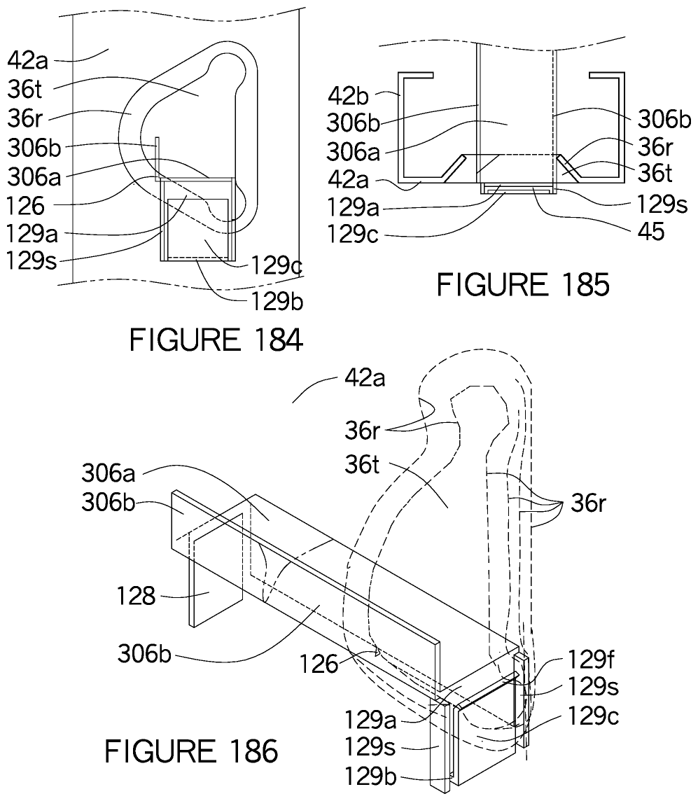

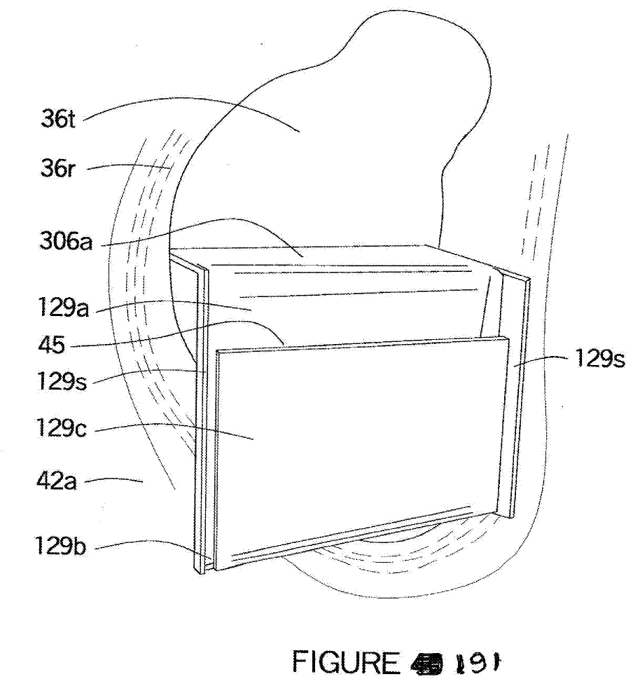

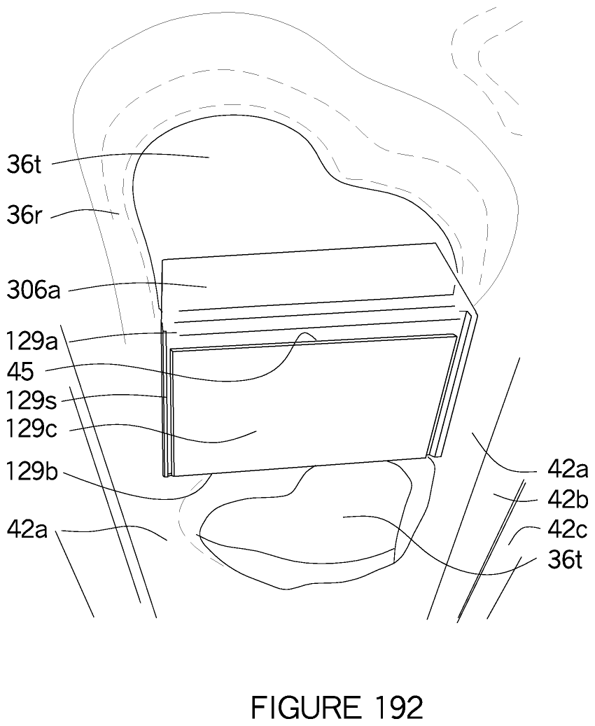

FIG. 178 shows a metal framing wall section with triangular shaped holes 37t with rims 36r with hold-downs spacer braces 309 shown in FIGS. 160-163 attached to the floor 141 with anchor bolts 354 or the floor 141 above at the top of the metal framing wall connected by fasteners 122. The different variations of the spacer braces or clips are shown in the triangular holes 36t and are shown in FIGS. 190 & 180 or in FIGS. 184-193. FIG. 179 shows an enlarged elevation view, FIG. 180 a plan view and FIGS. 191-192 perspective views of a horizontally oriented W-shaped clip 307 inserted into a triangular shaped hole 36t with rims 36r extending inward on the interior side of the C channel 42 on the side where the flanges 42b and lips 42c are also located. Some metal stud manufactures like to add rims to the edges of the holes to add strength and when doing so the rims 36r add depth to the triangular shaped holes 36t and are usually shown at an angle. When describing the W-shape clip 307 in FIG. 169 the web 307a is the depth of the rim 36r and the depth of the first leg 129a of the hook receiver 129 is long enough to extend to the bottom edge of the triangular shaped hole 36t on the exterior side. In the plan view shown in FIG. 180 the web 307a is the depth of the rim 36r of the triangular shaped hole 36t. The elevation view in FIG. 179 shows a downward extending flange 307b from the web extending beyond the bottom edge of the deepest point of the triangular shaped hole 36t. The W-shaped clip 307 can rest directly on the rim 36r or can be longer in order to form a notch 126 at the bottom edge of the flange 307b. The first triangular shaped hole 36t near the base of the metal framing shows a W-shaped clip also having a flange 307b extending upward from the web 307a, however the triangular shaped hole 36t is smaller at that side and the upward oriented flange 307b is not very long as shown in the photograph of FIG. 191 40. Since the triangular shaped hole 36t has such an irregular shape the first leg 129a of the receiver is very long in order to get support from the web 42a, therefore requiring the third leg 129c to be long to form the gap 45 and the second leg 129b as previously described. Since the rims 36r penetrate into the interior side a substantial distance it becomes difficult to support the hook tongue 128 into the hook receiver 129. As previously described the third leg and the first leg could be fastened together to form a stop so the hook tongue 128 does not slide out of the gap 45 off the hook receiver 129. Another method to keep the hook tongue 128 from sliding out of the hook receiver 129 is to have the side edges of the first leg 129a or the third leg 129c have a hook end stop 129s where the side edge are bent outward past the gap 45 to form a stop for the hook tongue 128 from moving. FIG. 191 shows a perspective view of the web 42a of a vertical support member having a triangular shape hole 36t with a W-shape clip 307 with the hook receiver 129 extending over the triangular shape hole 36t. FIG. 192 shows a perspective view of the ventral side of the vertical support member shown as a C channel with the web 42a, lips 42c and flanges 42b with a triangular shape hole 36t with its projecting rims 36r at the web 42a with a W-shape clip 307 with it flanges 307b and the hook receiver 129 extending over the rim 36r of the triangular shape hole 36t.

FIGS. 181-183 show three different spacer braces being connected at a triangular shape holes 36t (not shown with the rims 36r) shown in FIG. 154 in the web 42a of a C channel 42. The reverse lip spacer brace 301 in FIG. 181 shows the exterior side at an angle so the web 301a and sides 301b can fit through the triangular shape hole 36t, however the lips 301c act as a flap 76 as shown in FIG. 182 where the flaps 76 abuts the web 42a. The flaps 76 or the ends of the lips 301c abut the web 42a on one side of the web 42a and the web 301a of the reverse lip spacer brace 301 has an indentation 301i and then an hole extension 301he (not shown in this view, but required when extending through a hole 36) so the hook receiver 129 can extend over to the opposite side of the web 42a and the interior side of the hook tongue 128 can abut the web 42a and fastened by a screw 122 into the web 42a. FIG. 182 shows the web 302a and the flanges 302b extending through the triangular shape hole 36t and flaps 76 that extend away the angular oriented flanges 302b. The flaps 76 are rectilinear in shape and are perpendicular to the flanges 302b. FIG. 183 shows an elevation of the U shaped spacer brace 302 where the hook receiver 129 is fastened with screws 122 on the viewers side of the web 42a, the holed extension 302he is the thickness of web 42a of the support member and the indentation 302i, web 302a and the flanges 302b is on the opposite side of the web 42a. Some spacer braces are attached to the web 42a or by the hook finger 127 or the U shaped hook receiver 129 when installed in tandem.

FIGS. 184-186 shows a horizontally oriented J shaped spacer brace 306 in elevation in FIG. 184 33 with a plan view in FIG. 185 and a isometric view in FIG. 186. The J shaped spacer brace 306 shows the web 306a intersecting the triangular shape hole 36t with one side of the web 306a resting on the rim 36r and the opposite side of the web 306a abutting the vertical edge of the rim 36r with one flange 306b extending downward resting on the lower edge of the rim 36r. The left side of the web 306a can rest directly on the rim 36r or the rim 36r can have a rim notch 126rm for the web 306a to rest upon and another flange 306b extending upward for additional strength. Since the J shaped spacer brace 306 does not have flanges 306b that extend on both sides a hook receiver 129 to keep the hook tongue 128 from sliding out of the hook receiver 129, side edges between the first leg 129a or the third leg 129c have a hook end stop 129s where the side edge are bent outward past the gap 45 to form the end stop 129s for the hook tongue 128 from moving.

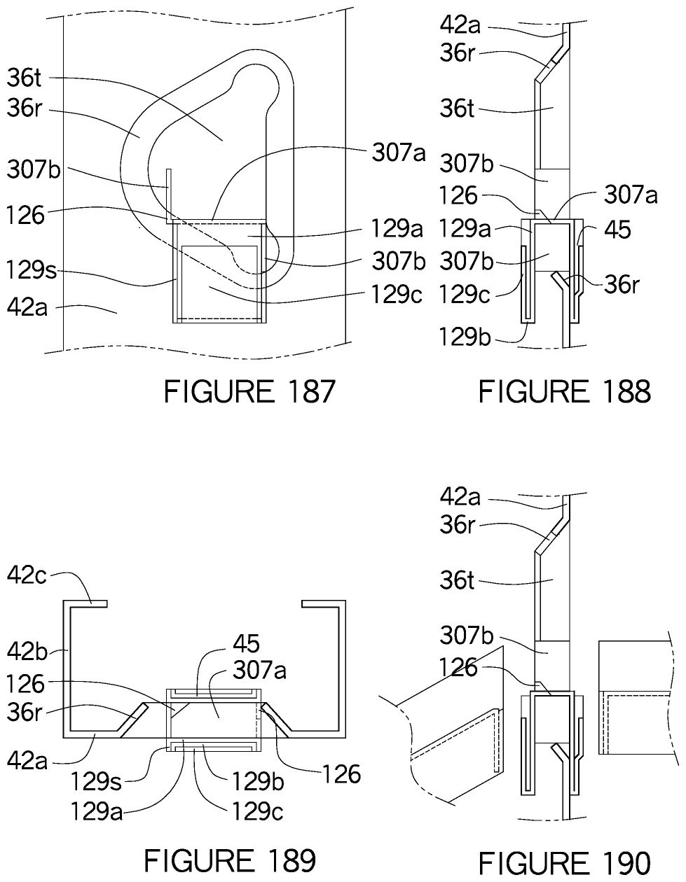

FIGS. 187-190 shows a horizontally oriented W-shaped clip 307 inserted into a triangular shaped hole 36t having rims 36r extending inward on the interior side of the C channel 42 on the side where the flanges 42b and lips 42c are located. FIG. 187 shows the W-shape clip 307 at the triangular shape hole 36t similar to the J shaped spacer brace 306 shown in FIGS. 184-186. A plan view is shown in FIG. 189 while FIG. 188 and FIG. 190 show the W-shaped clip 307 in section with FIG. 190 showing the hook tongues 128 of the J shaped spacer brace 306 intersecting the W-shaped clip 307 horizontally and diagonally into the hook receivers 129 at both ends of the W-shape clip 307.

FIGS. 187-192 shows a horizontally oriented W-shaped clip 307 inserted into a triangular shaped hole 36t having rims 36r extending inward on the interior side of the C channel 42 on the side where the flanges 42b and lips 42c are located. Some metal stud manufactures like to add rims to the edges of the holes to add strength and when doing so the rims 36r are usually at an angle and have a depth. When describing the W-shape clip 307 the web 307a spans the thickness or depth of the rim 36r of the triangular shape hole 36t and each side of the W-shape clip 307 has a hook receiver 129 extending from the each side of the web 307a. The first leg 129a on the exterior side of the web 42a is longer in length due to shape of the triangular hole 36t that is the first leg 129a extends over the bottom edge of the triangular hole 36t to give the W-shape clip 307 additional strength. The W-shape clip 307 has a flange 307b that extends internally and parallel to the vertical edge of the rim 36r and extends downward until the bottom edge rest on the bottom edge of the rim 36t. The internally extending flange 307b give the W-shape clip 307 stability since the bottom edge and the exterior dorsal side of the flange 307b rest against the rim 36r or can rest on a notch 126 cut at the rim 36r as shown in the cross section of the hole 36t in FIGS. 188 & 190. An end stop 129s is shown at the side edges of the first leg 129a of the hook receiver 129 which is required to keep the hook tongue 128 from sliding horizontally in the gap 45 between the first leg 129a and 129c as also previously explained in other figures. The end stops 129s could extend from the web 307a or from the first leg 129a. In FIGS. 188 & 190 one side of the hook receiver 129 shows the first leg 129a and third leg 129c pressed together should a fastener (not shown) be structurally required to secure the W-shape clip 307. FIGS. 187 & 189 also show another flange 307b extending externally above the W-shape clip for additional strength or stability if so required. FIG. 191 shows a perspective drawing the web 42a of a vertical support member having a triangular shape hole 36t with a W-shape clip 307 with the hook receiver 129 extending over the triangular shape hole 36t. FIG. 192 shows a perspective drawing of the interior side of the vertical support member shown as a C channel with the web 42a, lips 42c and flanges 42b with a triangular shape hole 36t with its projecting rims 36r at the web 42a with a W-shape clip 307 with it flanges 307b and the hook receiver 129 extending over the rim 36r of the triangular shape hole 36t.

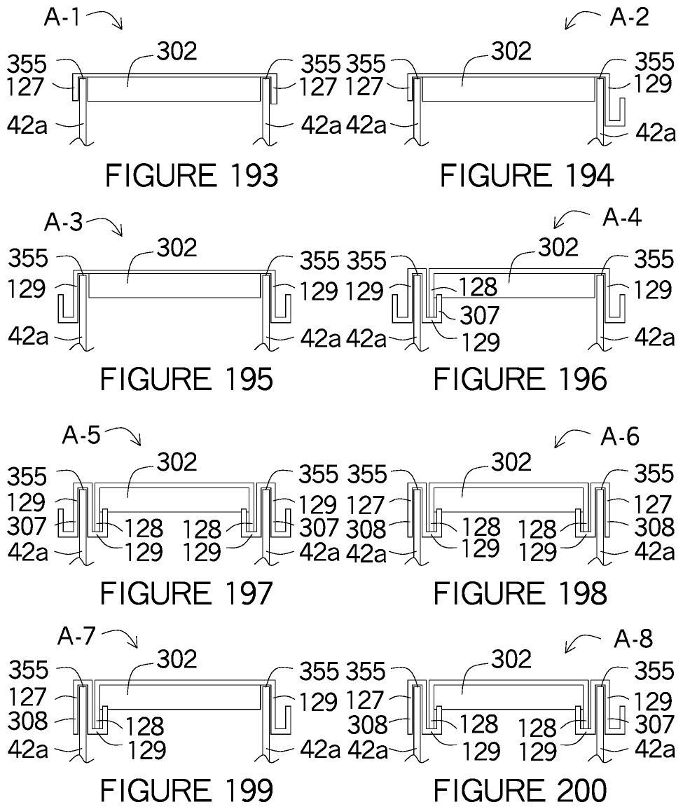

FIG. 193 shows a schematic view of a construction assembly A-1 comprising a U shaped spacer brace 302 spanning between the web 42a of two support members having the anchor spaces 355 on both ends engage the interior side of the hook finger 127 ends on the left side and the side edges of the flanges 302b engage the interior sides of the U shaped spacer brace 302 at the support member on the left side. The right side shows the reverse of the left side where the flanges 203b have the side edges of the U shaped spacer brace 302 engage the left side edge of the web 42a with the extension 302e (many different types of extensions are mentioned in the specifications) having its interior side being the anchor space 355 for the extension 302e to engage the support member and the interior side of the hook finger 127 engage the right side edge of the right web 42a.

FIG. 194 shows an schematic view of a construction assembly A-2 comprising a U shaped spacer brace 302 spanning between two support members where the left end of the U shaped spacer brace 302 has the interior side of a hook finger 127 engage the left side of the web 42a with the anchor space 355 resting on the support member with the flanges 302b engaging the opposite side of the web 42a while the right side of the U shaped spacer brace 302 has the flanges 302b engaging the left side of the web 42a with the interior side of the hook receiver 129 engaging the right side of the web 42a.

FIG. 195 shows an schematic view of a construction assembly A-3 comprising a U shaped spacer brace 302 spanning between two support members have a hook receiver 129 on the left end with a hook receiver 129 end on the right side end. The U shaped spacer brace 302 is secured to the web 42a where the interior side of the hook receivers 129 has the side edges of the flanges 302b between the web 42a with the interior side of the anchor space 355 engaging the top edge of the web 42a.

FIG. 196 shows an schematic view of a construction assembly A-4 comprising a U shaped spacer brace 302 spanning between two support members having the interior side of the anchor space 355 of a W-shaped clip 307 engage the top edge of the support member with the hook receiver 129 on the right side end engaging the hooked tongue 128 of the U shaped spacer brace 302 and the right support member engage the side edges of the flanges 302b on the left side of the web 42a and the interior side of the hook receiver 129 end engaging the right side of the web 42a.

FIG. 197 shows an schematic view of a construction assembly A-5 comprising a U shaped spacer brace 302 spanning between two support members having the anchor space 355 of a W-shaped clip 307 engage the support member with the hook receiver 129 on the right side end engaging the hooked tongue 128 of the U shaped spacer brace 302 with a hook tongue 128 end on the right side end engaging the hook receiver 129 of on the left side of the W-clip 307 with its anchor space 355 engaging the support member.

FIG. 198 shows an schematic view of a construction assembly A-6 comprising a U shaped spacer brace 302 spanning between two support members having the anchor space 355 of a U-shaped clip 308 engage the support member with the hook receiver 129 on the right side end engaging the hook tongue 128 of the U shaped spacer brace 302 with the opposite end of the U shaped spacer brace 302 also having a hook tongue 128 that engages the hook receiver 129 of the U-shaped clip 308 where the anchor space 355 has a hook finger 127 engaged on the opposite side of the support member.

FIG. 199 shows an schematic view of a construction assembly A-7 comprising a U shaped spacer brace 302 spanning between two support members having the anchor space 355 of a U-shaped clip 308 engage the support member with the hook receiver 129 on the right side end engaging the hooked tongue 128 of the U shaped spacer brace 302 with the opposite end of the U shaped spacer brace 302 having the ends of flanges 302b abut the support member with its anchor space 355 and the interior side of the hook receiver 129 abutting the opposite side of the web 42a.

FIG. 200 shows an schematic view of a construction assembly A-8 comprising a U shaped spacer brace 302 spanning between two support members having the anchor space 355 of a U-shaped clip 308 engage the support member with the hook receiver 129 on the right side end engaging the hook tongue 128 of the U shaped spacer brace 302 and the right side of the U shaped spacer brace 302 has a hook tongue 128 that engages the left side of a hook receiver 129 or a W-clip 307 where the anchor space 355 engages the support member.

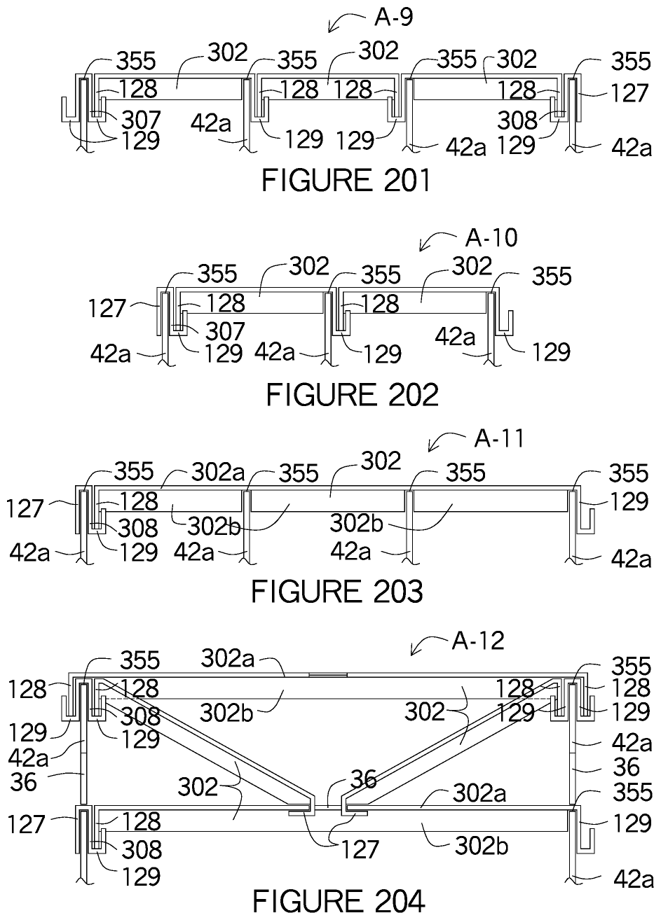

FIG. 201 shows a schematic view of a construction assembly A-9 comprising the middle U shaped spacer brace 302 having a hook tongue 128 at each end and connected to the adjacent U shaped spacer braces 302 where the hook receivers 129 extends over the web 42a of the support member on both the left and right sides and the side edges of the flanges 302b on the first and third U shaped spacer braces 302 engage the opposite sides of the web 42a of the support members.

FIG. 202 shows a schematic view of a construction assembly A-10 comprising two adjoining U shaped spacer braces 302 where each U shaped spacer brace 302 has a hook tongue 128 end on one side and a hooked receiver 129 on the opposite end and connected to the support members having the ends of the flanges 302b abut one side of the web 302a and the interior side of the hook receiver 129 abut the opposite side of the web 42a being connected by the anchor space 355 of the extension 302e at the web 42a.

FIG. 203 shows a schematic view of a construction assembly A-11 comprising a U shaped spacer brace 302 spanning over two support members where the left side is connected to the hook receiver 129 of a U-shaped clip 308 and the right side is has the ends of the flanges 302b abut the one side of the web 42a and the interior side of the hook receiver 129 abuts the opposite side of the hook receiver 129 end and the intermediate connections at the support members have the end of the flanges 302b abut both sides of the support member at the anchor space 355 of the web 302a.

FIG. 204 shows a schematic view of a construction assembly A-12 comprising a one of many possible combinations of U shaped spacer braces 302 assembly where a truss joist 402 is formed using horizontal and diagonal spaces braces between support members. This truss joist 402 has a U-shaped clip 308 with the hook receiver 129 protruding from the interior side of the support member where the hook receiver 129 end at the lower chord has a hook tongue 128 and the opposite end of the U shaped spacer brace 302 has the end of the flanges 302b abut the web 42a of the support member with the hook receiver 129 extend past the web 42a. The lower chord has a hole 36 at the web 302a where the hook finger 127 is attached to the interior side of the web 302a of the U shaped spacer brace 302. The upper chord of the truss joist 402 is formed by another U shaped spacer brace 302 where each end has a hook tongue 128 and is engaged into the outer most side hooked receiver 129 of the W-shaped clip 307 and the opposite sides of the W-clip 307 has a hook receiver 129 where the opposite end of the diagonal oriented U shaped spacer brace 302 is inserted into the hooked receivers 129. The horizontal U shaped spacer 302 has a wider web 302a so the diagonally oriented U shaped spacer brace 302 can be connected to the hooked receiver 129 of the W-shaped clip 307 at the upper horizontal chord.

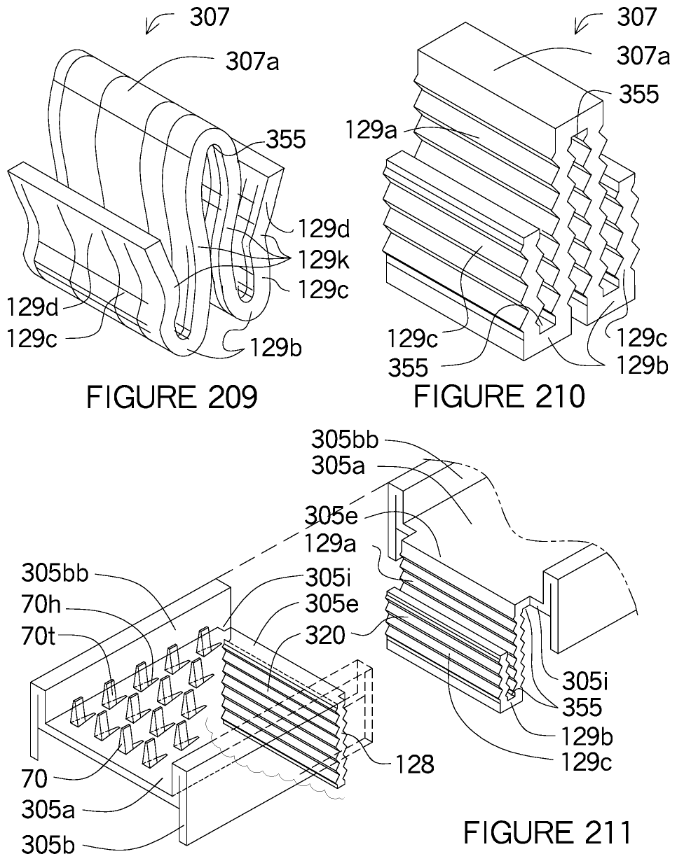

FIGS. 205-210 show different configurations or characteristics of the W-shaped clip 307 that will allow the W-shaped clip to have a tighter fit to the web 42a not shown in any of the figures. FIG. 205 is a similar U shaped spacer brace 307 having hooked receivers 129 on both sides with a first leg 129a extending downward from the web 307a having an outward second leg 129b and extending again upward forming a third leg 129c with a gap 45 between the first and third legs 129a & 129c. Dimples 321 are shown as one of many types of an abrasive planar surface showing a fixation connection which protrudes inward and outward in the gap 45 and inward between the first legs 129a. Other types of abrasive planar surfaces could be affected by the material used and whether the W-shape clip 307 is flexible enough to retain its shape after being moved. FIG. 206 shows a more curvilinear configuration of a fluid shape W-shaped clip 307 where the hook receivers 129 have a curved configuration between the web 307a and the first legs 129a and a curved configuration between the end of the first legs 129a through the second leg 129b to the start of the thirds leg 129c. FIG. 205 shows the same configuration as FIG. 206 except a flare 129d is shown at the end of the third leg 129c. FIG. 208 look similar to FIG. 207 except a kink 129k or indentation is shown on the interior side of the gap 45 between the first leg 129a and the third leg 129c so the kink 129k in the third leg 129c is tight to the first leg 129a. FIG. 209 is similar to FIG. 208 however here the W-shaped clip has a more fluid curvilinear configuration along with a double kink 129k where the first leg 129a of each receiver 129 are close to one another forming a tight connection between both sides of the web 42a (not shown) and again the same kink 129k between the first leg 129a and the third leg 129c. FIG. 210 shows the W-shaped clip having ridges 130 at the first and third legs 129a & 129c to increase the resistance by having more abrasive planar surfaces. FIG. 60 shows the hook receiver 129 with the ridges 130 attached to the end of the !-shaped spacer brace 305. At the left side of FIG. 211, another I-shaped spacer brace 305 is shown with the opposing end having the hook tongue 128 also shown having ridges 130. When the hooked tongue 128 is inserted into the gap 45 of the hook receiver 129 the ridges 130 will interlock between each other to increase a vertical resistance force that could separate the hook tongue 128 from the hook receiver 129. The hook receivers shown in FIGS. 206-210 with the dimples 321, ridges 130, kinks 129k or curvilinear configurations all contribute to adding resistance between the hook tongue and hook receivers and any of the hook receivers can be added as a hook receiver at the end of the any spacer brace. The hook tongue acts as a restraining plate that rest on the anchor space 355 at the interior of the gap 45 on the second leg 129b. The dimples 321, ridges 130, kinks 129a and the curvilinear shape of the hook tongue 128 interlocks with the hook receiver to increase the resistance between each other. The left side of FIG. 211 shows the tongue side of the I-shaped spacer brace 305 with punched hole teeth 70 extending upward from the web 305a. The teeth 70t extend upward from the punch hole 70h which forms a very abrasive surface connection to have insulation installed between metal framing from coming loose. In addition, the hook receiver 129 at the I shaped spacer brace 305 shows an extension 305e over the anchor space 355, however the extension 305e could extend over any hole, web or other previously describe anchor space 355. In order to have the flanges 305b abut the support member, the web 305a has an extension 305e that spans across the third led 129c of the hook receiver 129 allowing the hook tongue 128 with its abrasive planar surface to extend into the gap 45 of the hook receiver 129.

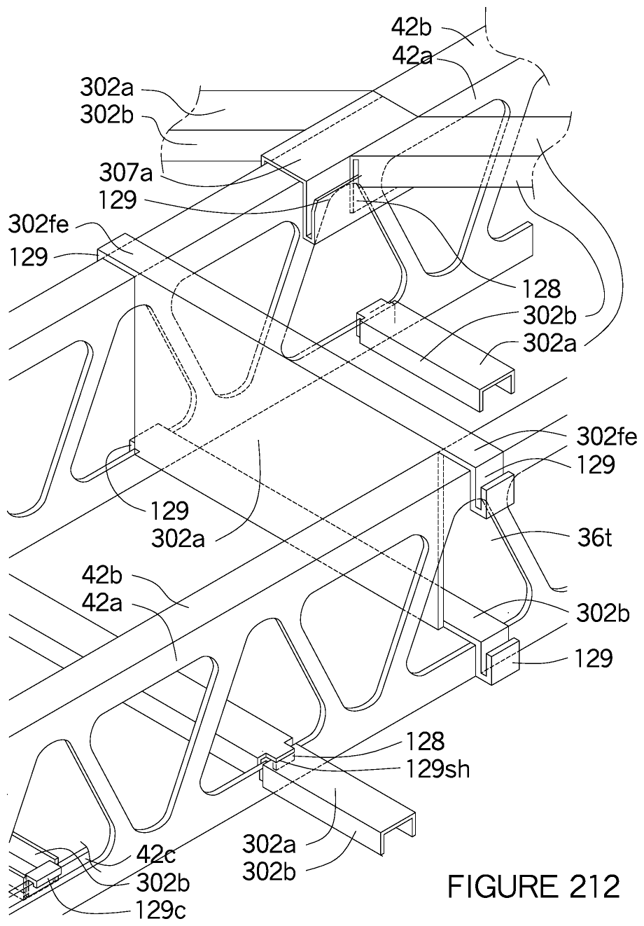

FIG. 212 an isometric view of floor or ceiling joists shown as horizontally oriented support members shown as C channels 42 having triangular shapes holes 36t and connected together by using U shaped spacer braces 302 having a web with two extending flanges. The bottom left side shows a U shaped spacer brace 302 with its interior side facing upward with the third leg 129c of the hook receiver 129 extend over the lip 42c so the exterior side is face down making an easy connection to the top plate or the top U shaped spacer brace 302 of a metal framed wall (not shown here but previously shown at the wall section in FIG. 178. The adjacent U shaped spacer braces 302 is shown connected to an another U shaped spacer brace 302 in tandem with the hook tongue 128 being installed into the slot hole receiver 129sh in the web 302a of the adjacent U shaped spacer brace 302. A larger U shaped spacer brace 302 is oriented vertically where the height or web 302a of the U shaped spacer brace 302 is equal to the height or the web 42a of the support member. The flange 302b has a flange extension 302fe at the flange 42b of the support member, however the lower flange extension 302fe extends over the bottom edge of the triangular shape hole 36t. At the top of the isometric drawing shows a W-shaped clip 307 where the web 307a extends over the web 42a of the support member. The W-shaped clip is slightly longer as two horizontally oriented U shaped spacer braces 302 are installed horizontally but are oriented at a diagonal as to provide diagonal bracing between the horizontally arrayed support members shown as a C channel 42. The U shaped spacer braces 302 have hook tongue 128 ends that fit into the hook receiver 129 ends of the W-shape clip 307 which is also shown in FIG. 197.

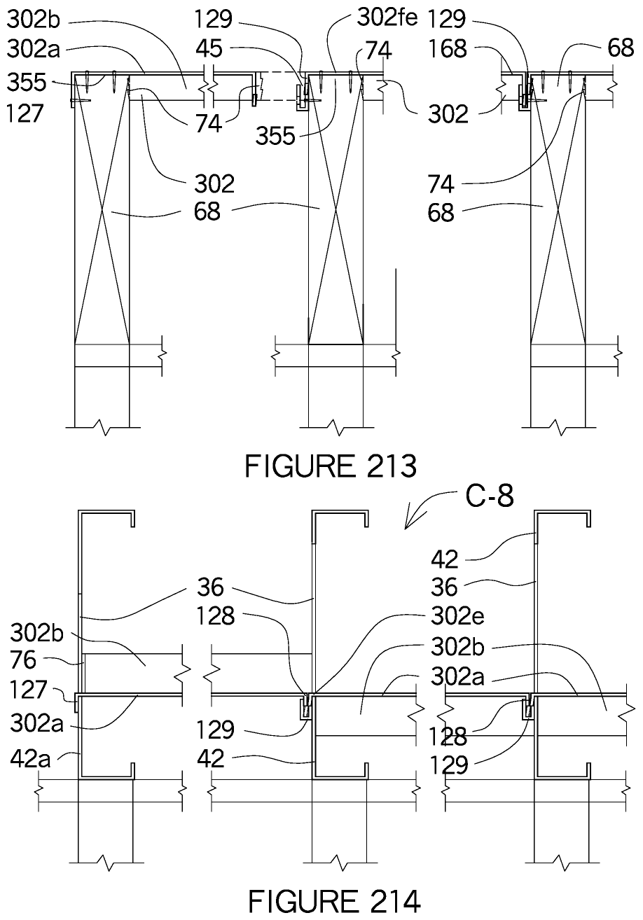

FIG. 213 shows three wood joists as wood framing members 68 (shown with light weight lines) where the top surface of the wood framing members 68 show a U-shaped spacer brace 302 (in section) being connected together. The exterior side is on the top side of the U-shaped spacer brace 302 and the sides 302b extend downwardly from the web 302a. The first engagement connection is where the edges of the sides 302b abut the wood framing member with the jagged edges 74. The second engagement connection is placing the flange extension 302fe over the horizontal edge of the width side 68w of the wood framing member 68 also referred to as the anchor space 355 with the hook receiver 129 being U-shaped. The third engagement connection is the installation of an adjacent spacer brace having a hook tongue 128 fitting into the air gap 45 of a hook receiver 129 shown on the top side of the right wood framing member 68. The right wood framing member 68 shows the second and third engagement connection attached to the width side 68w of the wood framing member 68 with the hook tongue 128 from an adjacent spacer brace attached into the hook receiver 129. The left wood framing member 68 shows the second engagement connection of the first U-shaped spacer brace 302 as a hook finger 127 installed over the wood framing member 68.

FIG. 214 shows three horizontal support members as C shaped channels 42 having a vertical exterior side at a web 42a with two horizontally extending flanges 42b and with lips 42c. The left C channel 42 shows a horizontally oriented U-shaped spacer brace 302 having the exterior on the bottom side where the web 42a is horizontal and the flanges 42b are extending upward. The web 302a has the hole extension 302he passing through the bottom edge of the hole 36 and the hook finger 127 extends downward over the web 42a. The middle U channel 42 shows the opposite end of the U-shape spacer brace 302 where the hook tongue 128 fits into the gap 45 from the hook receiver 129 being U-shaped that had passed through the hole 36 in the middle U-shaped spacer brace 302. The middle U-shaped spacer brace 302 has the exterior side on the top side and therefore the web 302 had the hole extension 302he and the hook receiver 129 being U-shaped connected to an upward oriented U-shape spacer brace 302. The isometric drawing in FIG. 212 showed a similar arrangement using the triangular shaped holes 36t.

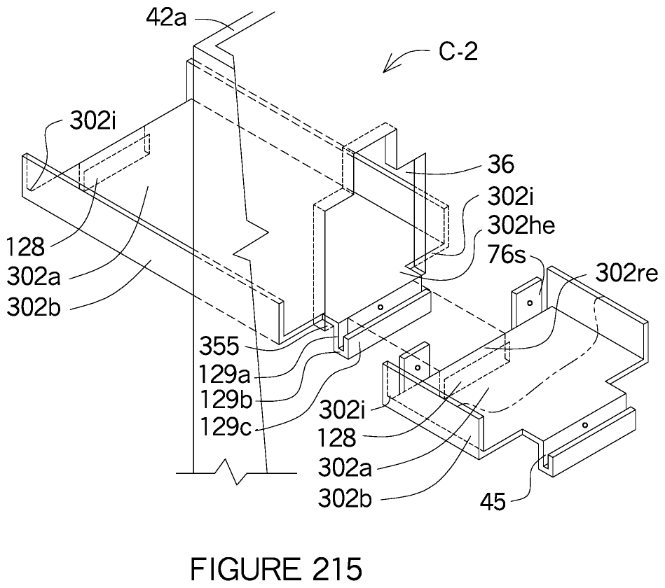

FIG. 215 is similar to FIG. 155 where the U-shaped spacer brace 302 was oriented downward while in FIG. 215 the exterior side is located on the bottom side where the web 302a has the flanges 302b extending upward from the web 302a. Both ends of the elongated U shaped spacer brace 302 has an indentation 302i at the flanges 302b and web 302a having the side edges of the flanges 302b and a portions of the webs 302a engaging the web 42a on both ends between the support members to form the first engagement connection. The U-shaped spacer brace 302 is wider than the hole 36 so the indentation 302i ends at the hole 36 and an hole extension 302he passes over the bottom edge of the hole 36 at the anchor space 355 with the hook receiver 129 installed on the opposing side of the web 42a. When the hole extension 302he extends over the bottom edge of the hole 36 the hook receiver 129 having a U-shape end has a downward oriented first leg 129a then bending outward 90 degrees forming a second leg 129b then bending upward 90 degrees again forming third leg 129c leaving a gap 45 between the first & third legs 129a & 129c forming the second engagement connection. On the right side of the support member or as shown here, another U-shaped spacer brace 302 is shown having the hook tongue 128 on the opposite end. The hook tongue 128 has a receiver extension 302re that extends over the third leg 129c of the hook receiver 129 that fits into the gap 45 between the downward oriented first leg 129a and upward oriented third leg 129c thereby completing the third engagement connection by engaging two U-shaped spacer braces 302 together. In addition, a flap 76 is shown extending upward from the receiver extension 302re on the tongue side of the spacer brace so the flap 76 can be installed against the web 42a of the support member for fasteners (not shown) can pass through the holes into the support member if so required.

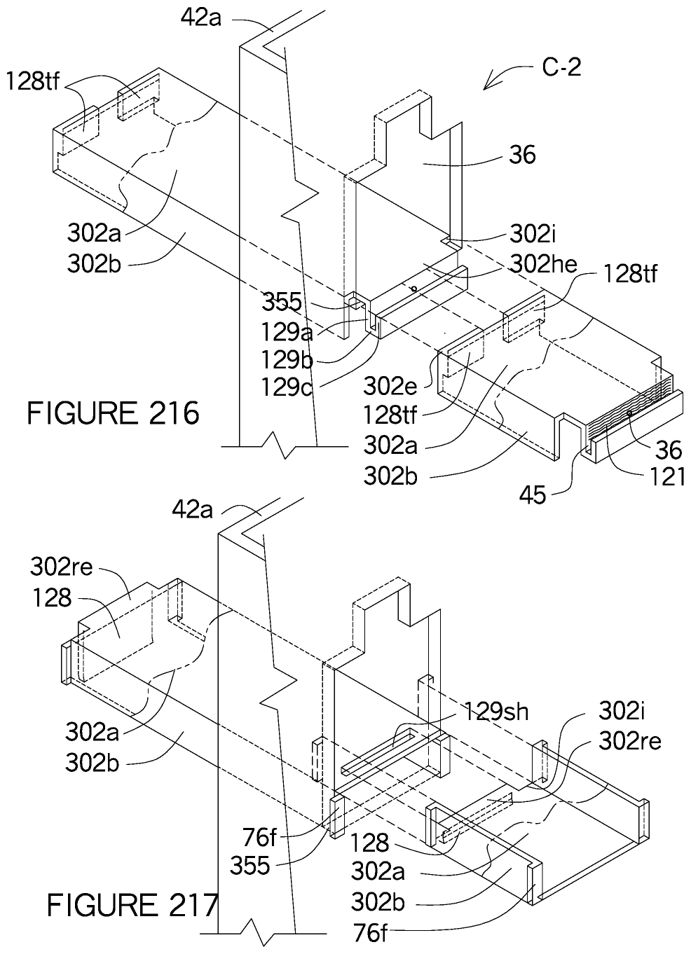

FIG. 216 is similar to FIG. 155 except the hook tongue 128 has two tongue flaps 128tf that extend inward toward on interior side from the flanges 302b. The tongue flaps 128tf have a similar function as the hook tongue 128 in FIG. 155; however in FIG. 216 tongue flaps 128tf fit into the gap 45 between the downward oriented first leg 129a and the upward oriented third leg 129c of the hook receiver 129 thereby engaging the U-shape spacer braces 302 together. As previously mentioned the U shaped spacer brace 302 has an indentation 302i for the hole extension 302he can be supported at the anchor space 355. In addition, the tongue flaps 128tf can have any type of fixation connection or abrasive planar surface as shown like the grooves 121 to secure the two U shaped spacer braces 302 together.

FIG. 217 shows two U-shaped spacer braces 302 fitting over each other. The lower U-shaped spacer brace 302 is downward oriented so the exterior side is on top. The upper U shaped spacer brace 302 is oriented upward where the flanges 302b extend upward from the web 302a. Both the lower and upper U shaped spacer brace 302 are the same width as the hole 36 and both spacer braces the flanges 302b with flange flaps 76f that extend outward. The flange flaps 76f on the U shaped spacer braces 302 make the spacer braces wider than the hole 36 so the U shaped spacer braces 302 have to be turned so the flange flaps 76f can extend to the opposing side of the web 42a. The lower U shaped spacer brace 302 has a slot hole receiver 129sh so the hook tongue 128 from the adjacent shape spacer brace 302 will extend downward into the slot hole receiver 129sh. The left side shows a receiver extension 302re that would pass through the hole 36 so the hook tongue 128 with its abrasive planar surface could extend into the slot hole receiver 129sh of an adjacent U shaped spacer brace 302 thereby connecting the two U-shaped spacer braces 302 together. The hook tongue 128 extending from the web 302a of one U-shaped spacer brace 302 into the slot hole receiver 129sh of an adjacent is another connection solution for connecting adjacent framing members together. In lieu of using the hook receiver 129 in FIG. 216 the flanges 302b would abut the web 42a on one side from the first U-shaped spacer brace 302 with the first leg 129a extending over the hole 36 with the slot hole receiver 129sh on the web 302a. The hook tongue 128 from the adjacent U-shaped spacer brace extends across the hole 36 and into the slot hole receiver 129sh on the first framing member and against the opposing side of the web 42a.

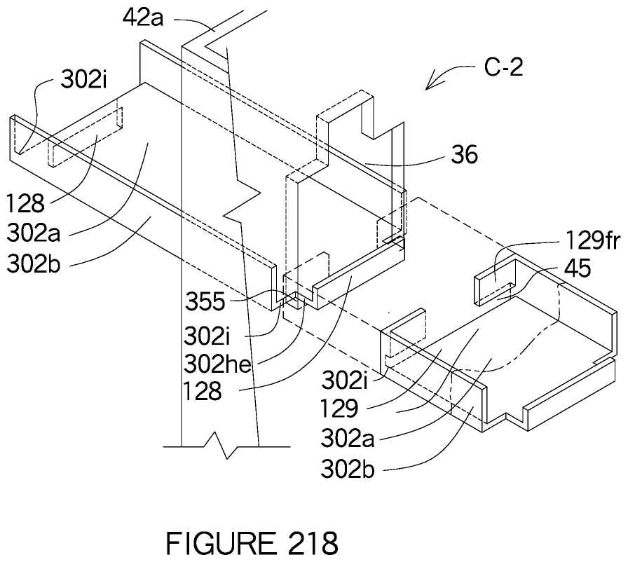

FIG. 218 is similar to a combination of some of the earlier U shaped spacer braces 302 where the exterior side is against the anchor space 355 on the bottom edge of the hole 36. FIG. 218 the indentation 302i has the hole extension 36he with a hook tongue 128 extending from the interior side upward and the opposing side of the U shaped spacer brace 302 has flange receivers 129fr extend inwardly from each flange 302b. The flange receiver 129fr extend far enough away from the web 302a so a gap 45 is formed the thickness of the hook tongue 128. The hook tongue 128 fits into the gap 45 so the hook tongue 128 is secured between the interior side of the flange receivers 129fr and the edge of the width of the web 302a. The opposing side of the flange receivers 129fr abuts the web 42a of the support member securing the flange receivers 129fr and hook tongue 128 by any type of fixation connection.

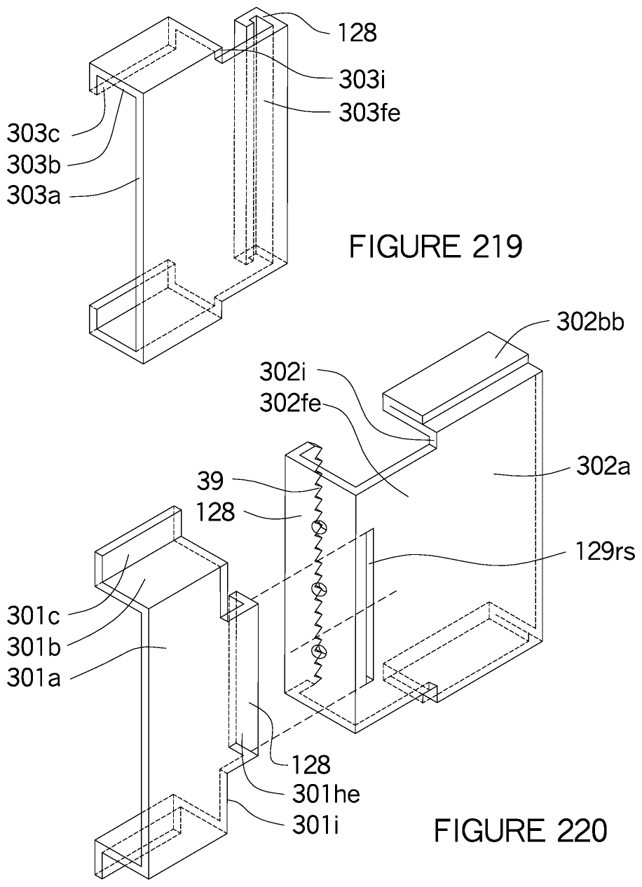

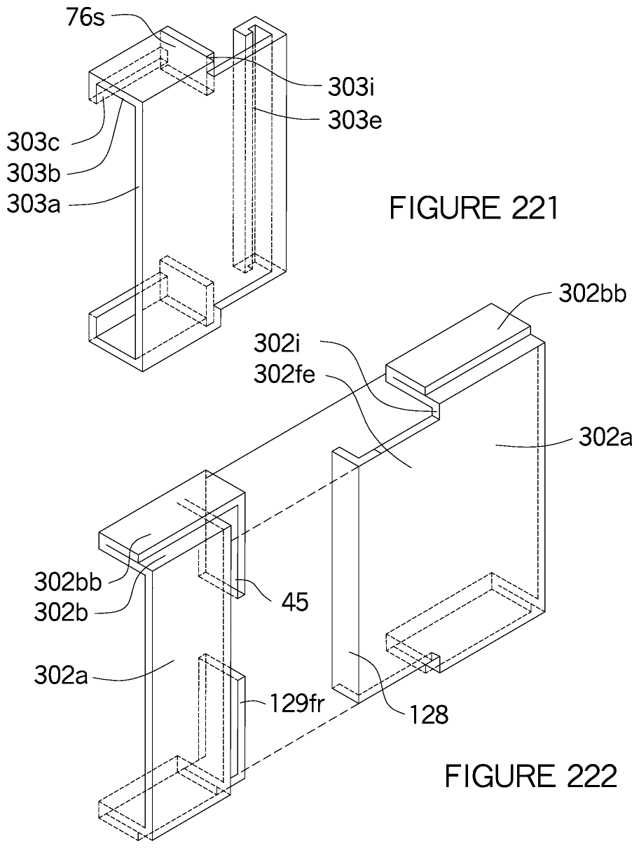

FIG. 219 shows a C shape spacer brace 303 where the exterior side is vertical and the interior side has flanges 303b extending horizontally to the lips 303c that extend inwardly forming a C-shape. An indentation 303i is formed at the flanges 303b and web 303a with flange extension 303fe where a hook tongue 128 is shown having a U-shape similar to FIG. 221.

FIG. 220 shows a reverse lip spacer brace 301 on the left side with a vertical orientation having a web 301a with flanges extending internally from the web 301a with lip 301c extending outwardly from the flanges 301b. The tongue side has an indentation 301i with a flange extension 301fe and a hook tongue 128 extending inward on the interior side. The vertically oriented adjacent U shape spacer brace 302 has double flanges 302bb extending internally with an indentation 302i and hole extension 302he. The hole extension 302he is slightly longer for a receiver slot hole 120rs where the hook tongue 128 has an L-shape end with an abrasive edge or fixation connection that would grip a support member placed against it. The interior side of the flange extension is the anchor space 355 and the receiver slot hole 120rs along with the hook tongue 128 become the third connection means.

FIG. 221 shows a C-shape spacer brace 303 where the flange 303b is bent internally so that the bent flange or support flap 78s rests against the lip 303c giving additional support to the support flap 78s.

FIG. 222 shows the U-shape spacer brace 302 with the double flange 302bb on both spacer braces. The left U-shape spacer brace 302 is the receiving end as the outer portion of the double flange 302bb is extended longer than the web 302a and the inner portion of the web 302b so a gap 45 exists when the outer portions of the double flanges 302bb are bent inward forming a flap receiver 129fr. The adjacent U-shape spacer brace has the indentation 302i at the web 302a and flanges 302bb with a flange extension 302fe and a hook tongue 128 bent inward so the hook tongue 128 can fit into the gap 45 between the web 302a and inner portion of the flange 302b and the interior side of the flange receiver 129fr. Not shown, however if the hook tongue 128 were L-shape or U-shape in other figures the ends of the hook tongue 128 would wrap around flange receiver 129fr.

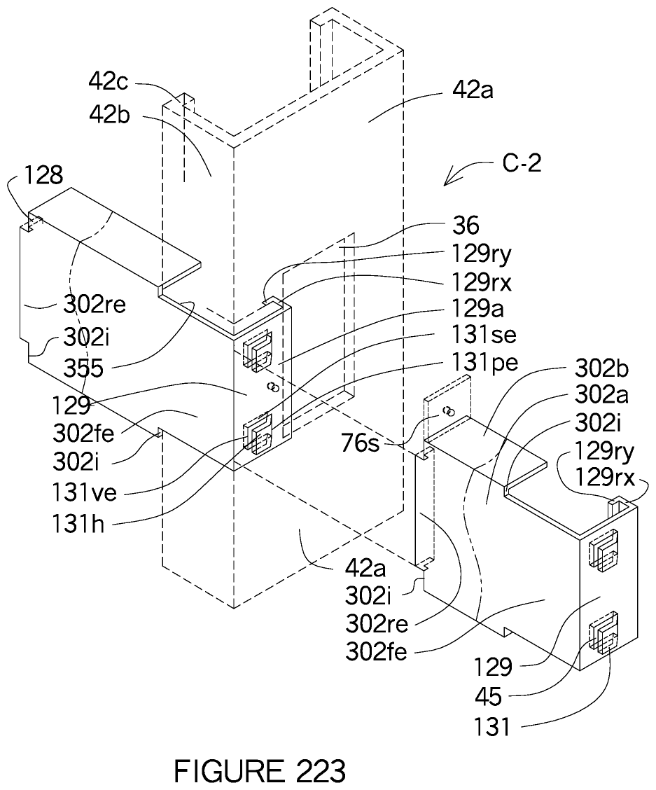

FIG. 223 shows vertically oriented U shaped spacer braces 302 being connected at a vertically oriented support member where the left U shape spacer brace 302 having flanges 302b that abut the lip 42c of the C shaped channel 42 at the indentation 302i so the interior side of the flange extension 302fe is the anchor space 355 that extends across the flange 42b to a hook receiver 129 where the first leg 129a is along the web 42a then turned 90 degrees across the side edge of the hole 36 at the receiver extension x axis 129rx the turned back to the receiver extension y axis 129ry on the interior side of the support member at the web 42a. The first leg 129a has punched out hooks 131 with a vented edge 131ve and two side edges 131se and a pivot edge 131pe where the hook 131h protrudes away from the pivot edge 131pe leaving a gap 45 for a hook tongue 128 to fit into. Two different hook tongues 128 are shown at each U shaped spacer brace 302. The left hook tongue shows the web 302a having a receiver extension 302re extend from the web 302a at the indentation 302i with the hook tongue 128 extending interiorly inward. The right U shaped spacer brace 302 shows the same hook tongue 128 however support flaps 76s extend outward from the flanges 302b along with a hole 36 should the support flaps be required to be fastened to the web 42a.

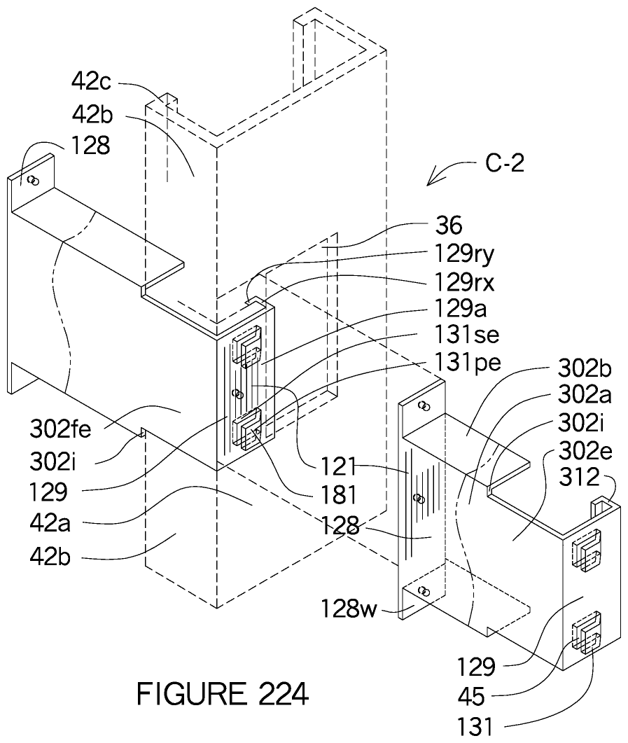

FIG. 224 is similar to FIG. 223 except the tongue side has a wide hook tongue 128 where both sides of the hook tongue is an extension of the flanges 302b forming the wide hook tongue 128w of hook tongue 128. The wide hook tongue 128w and the hook tongue 128 are one piece and are separated by cutting the end of the flanges 302b prior to bending the hook tongue 128. Groove 121 are shown in both the hook tongue 128 and the first leg 129a of the hook receiver 129 to provide a fixation connection over and above the punched out hooks 131 as shown in FIG. 213 that will resist any movement for the two U shaped spacer braces 302 from separating. The wide hook tongue 128w function similar to the support flap 76s in previous figures.

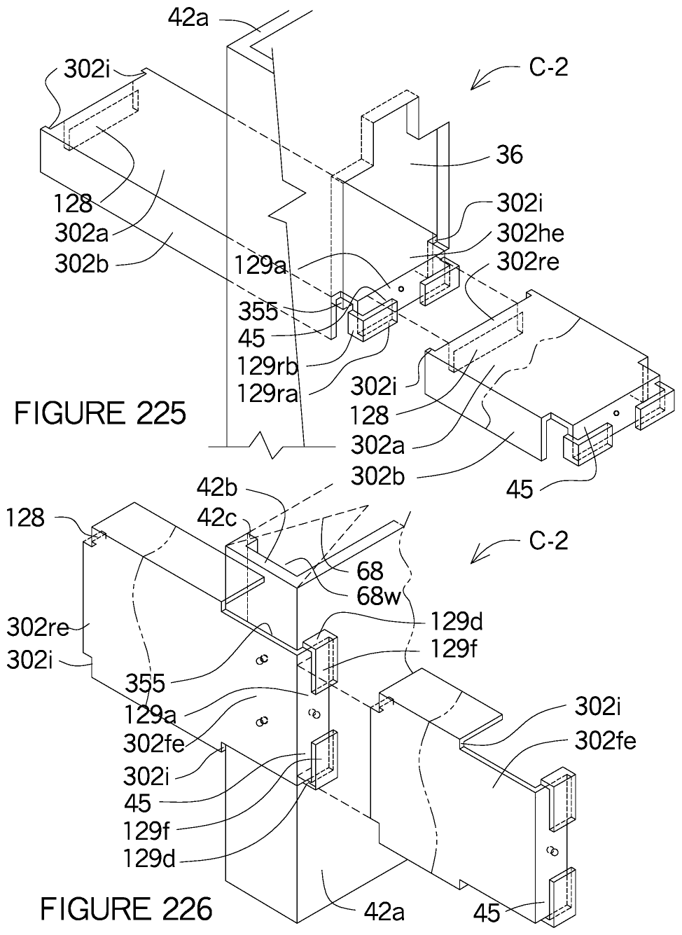

FIG. 225 shows the U-shape spacer brace 302 oriented horizontally where the flanges 302b extend downward from the web 302a. The flanges 302b and web 302a abut the web 42a of the support member at the indentation 302i that has a hole extension 302he that extends across the bottom edge of the hole 36 at the anchor space 355 where the hook receiver 129 has the first leg 129a extend downward over the opposing side of the web 42a. The downward oriented first leg 129a of the hook receiver 129 has receiver elbows 129rb that extend outward with the receiver arm 129rm extending in front of the exterior side of the hook tongue 129. The hook tongue 128 of the adjacent U-shaped spacer brace 302 has a receiver extension 302re that extends over the receiver arm 129rm and fits between the receiver arm 129ra, receiver elbow 129rb and the first leg 129a of the hook receiver 129 securing the hook tongue 128 and hook receiver 129 together. The hook tongue 128 could have an L-shape or U-shape end (not shown) that could wrap around a hole 36 as shown in FIG. 224.

FIG. 226 is similar to FIG. 225, except the U-shape spacer brace 302 is oriented vertically and the hole extension 302he has its interior side abutting the flange 42b of a C shape channel 42 and the anchor space 355 abuts the outer surface of wood frame members 68 at the width 68w or the flange 42b of a C channel 42 at the flange extension 302fe.

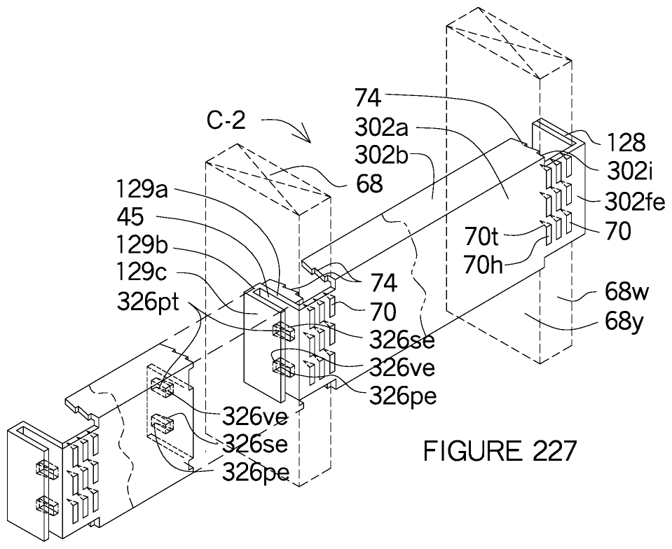

FIG. 227 shows the U-shaped spacer braces 302 installed with the interior side in a vertical orientation and installed over vertically oriented wood framing members 68. The web 302 has two flanges 302b extending outwardly with jagged edges 74 at the ends of the flanges 302b that penetrate the depth 68d into the wood framing members 68. The flanges 302b and webs 302a are indented at the depth 68w at the indentations 302i and the flange extension 302fe extends over width 68w of the wood framing member 68 also referred to as the anchor space 355 to the opposite side of the depth 68d for a hook receiver 129 having a first leg 129a then extended 90 forming the second leg 129b and extending parallel to the first leg 129a forming a gap 45 between the first leg 129a and the third leg 129c. Fasteners can be installed in the hook receiver 129 or at the extension 302e for a secure connection. Punched hole teeth 70 are shown on the exterior side of the extension 302e in the U shaped spacer brace 302 so the teeth 70t for the punched hole 70h can penetrate the wood framing member 68. The opposing end of the U-shaped spacer brace 302 shows the hook tongue 128 or when the adjacent U-shaped spacer brace 302 is installed, the hook tongue 128 fits into the hook receiver 129. Other types of receiver ends similar to the hook receiver 129 are shown in some of the other additional figures. In addition, the hook receiver 129 can have bumps, abrasions or any other means to create frictional connection between the interior side of the hook receiver 129 at the wood framing member 68 or metal framing members shown in other figures. Typically the U shaped spacer brace 302 is wider than the hook receiver 129 in order for the flanges 302b with the jagged edges 74 to extend into the wood framing member 68.

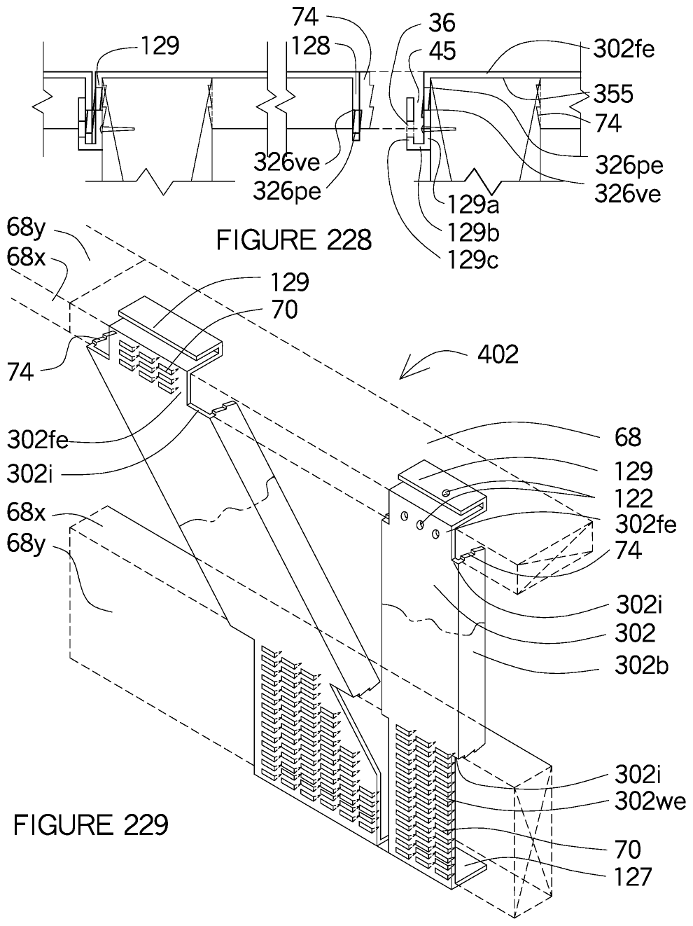

FIG. 228 is a vertical section of the isometric view in FIG. 227 where the U shape spacer brace 302 has the exterior side on the top side 302a with the flanges 302b extending interior downward. The jagged edges 74 are engages in the wood framing member 68 and the extension 302e extends over the top edge of the wood framing member 68 and the U shaped hook receiver 129 extends downward over the opposite edge of the wood framing member 68 as shown at the first leg 129a and extended horizontally forming the second leg 129b is then bent outward to form a gap 45 when the third leg 129c is bent upward. The adjacent U shape spacer brace show the opposite end having a hook tongue 128 that fits into the gap 45 of the hook receiver of an adjacent U shaped spacer brace 302. The jagged edges 74 of the flanges 302b are slightly longer that the hook tongue 128 so the jagged edges 74 can engage the wood framing member 68.

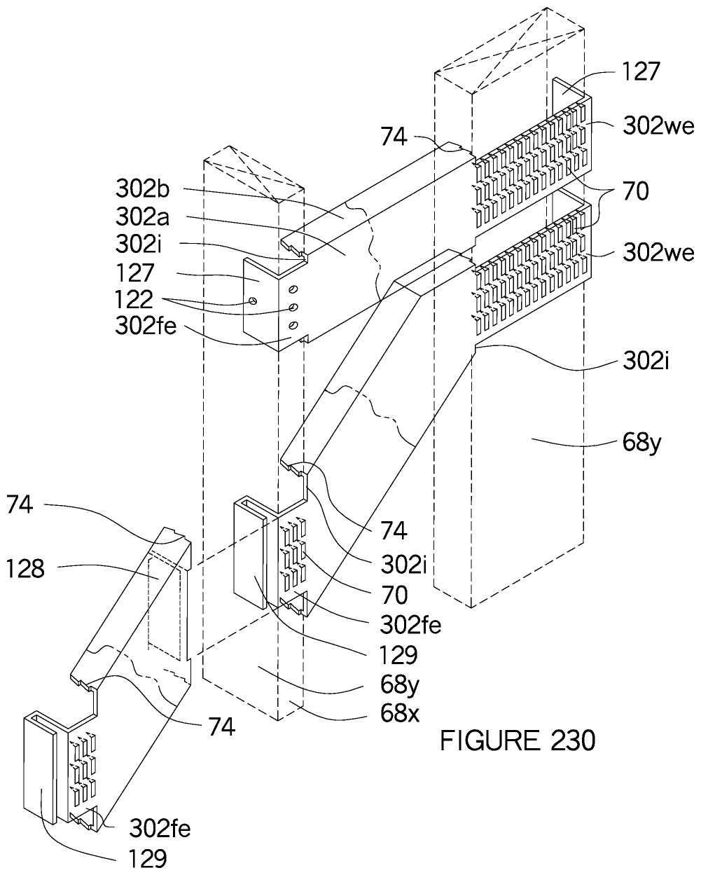

FIGS. 229-230 are similar except in FIG. 229 the wood framing members 68 are shown as horizontal support members to form truss joists 402 that are shown in C-8 in FIG. 152. Truss joists 402 are typically joists that have a horizontal top and bottom chord (shown in ghost) shown as wood framing members 68 and diagonal chords connect the top and bottom chords shown in FIG. 229 as U-shaped spacer braces 302. In FIG. 230 the wood framing members 68 (shown in ghost) are vertical support members for a wood framed wall and the U-shaped spacer braces 302 are used as lateral and diagonal bracing between the support members. The wood support members 68 in FIG. 229 are shown parallel to each other for a floor joist, however if the top member was at an angle a triangular truss could be formed using different length U shaped spacer brace 302. The truss joist 402 is shown to having horizontally oriented top and bottom chords and connected by vertically oriented independent U shaped spacer braces 302 where the web 302a intersects the top chord at the indentation 302i along with the end of flanges 302b having jagged edges 74 are extended into the depth 68d side of the top cord. The left U shaped spacer brace 302 is shown installed at a diagonal while the right U shaped spacer brace 302 is installed vertically. The web 302a extends at the flange extension 302fe at the width 68w side or anchor space 355 to the hook receiver 129 at the top chord while the bottom chord has a web extension 302we at the anchor space 355 fitting over the depth 68d side of the bottom chord. The flange extension 302fe and web extension 302we have punched hole teeth 70 where the teeth 70t extend into the top and bottom chords as well as the jagged edges 74. FIG. 230 is similar however instead of horizontal chords to form a truss joist 402, the support members are vertical as typically used to frame walls. The U shaped spacer brace 302 in FIG. 230 has their webs 302a oriented vertically, however one U shaped spacer brace 302 is installed horizontally and the other is installed diagonally. The diagonal U shaped spacer brace 302 on the right side having the depth 68d side having the web extension 302we and the left side have the width 68w side have the flange extension 302fe at the anchor spaces 355. Both the flange and web extensions 302fe & 302we have the punched hole teeth 70. The right side shows the web 302a having a bend so the web extension 302we fits over the depth 68d side perpendicular to the support member, while the left side shows the web 302 abut the support member at the directional angle of the U shaped spacer brace. One end of the U shaped spacer brace 302 has a hook finger 127 and the opposite end has a hook receiver 129.

FIG. 231 is similar to FIG. 229 as they are both truss joist 402; however the FIG. 166 uses metal framing members as the support members. The top chord (shown in ghost) shows a C channel 42 with the exterior side having a web 42a oriented horizontally with two sides extending vertically with lips 42c extend horizontally inward to each other and are parallel to the web 42a. The lower chord (shown in ghost) of the truss joist 402 shows a C channel with a vertical exterior having a web 42a with two sides extending outwardly connected with lip extending inwardly toward each other. The U-shaped spacer braces 302 connect the top and bottom chords where the exterior sides are vertical and have a web 302a with two extending sides 302b that abut the interior side of the lip 42c of the upper chord and the top side of flange 42b of the bottom chord. The web 302a of the U-shaped spacer brace 302 at the top chord has an indentation 302i and a flange extension 302fe that extends over the upper chord flange 42b with a hook receiver 129 extending over the web 42a. The bottom end of the U shaped spacer brace 302 has an indentation 302i and a web extension 302we that extends over the bottom chord web 42a with a hook finger 127 extending over the flange 42b. The diagonally oriented spacer braces continually are placed between the top and bottom chords at repeating intervals until the truss joist 402 has reached its designated length. The above description is referring to a single row of U-shaped spacer braces 302; however another row of spacer braces has been added. The lower chord (shown in ghost) has another horizontal C channel 42 adjacent to the first C channel where the lips 42c abut each other. Since the top chord (shown in ghost) is orientated horizontally that is the exterior is horizontal rather than vertical, the second U-shaped spacer braces can be installed as previously described.

The present invention of the unique spacer braces are so versatile that the spacer brace allows for a much easier and quicker installation of metal or wood framing wall, constructing wood or metal truss joists, installing horizontal and diagonal lateral bracing between wood or metal floor joists, installing hold-down spacer bracing at floors between wood or metal framing, installing horizontal and diagonal braces between wood or metal support members either between holes or at the flanges. The spacer braces are additionally secured to the support members when the hook fingers have U-shape of C-shape ends.

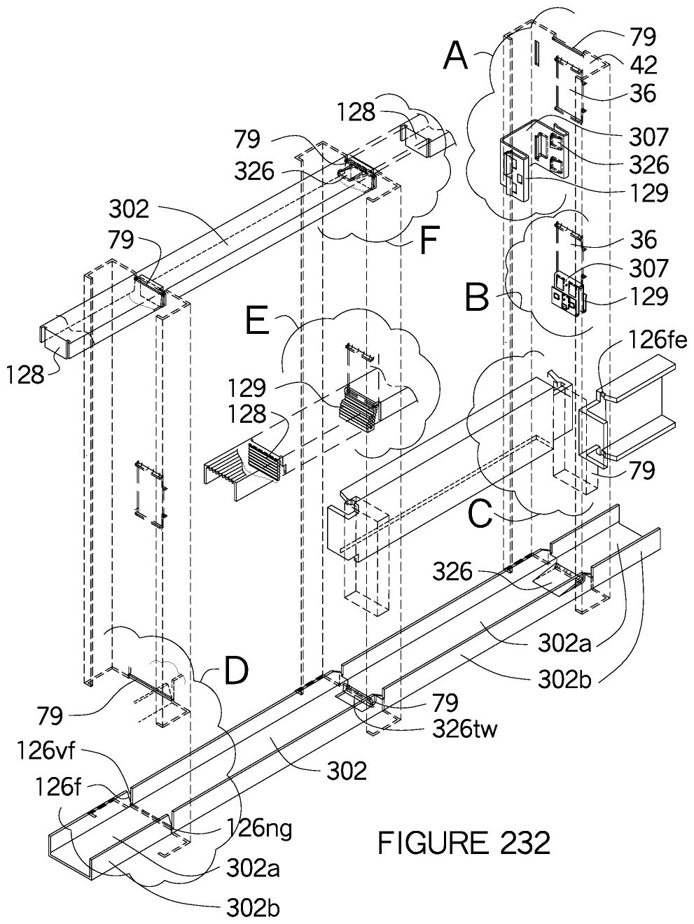

A DESCRIPTION OF THE PREFERRED EMBODIMENTS in FIG. 232 through FIG. 282 shows how a side projection or ledge extends from a hole in the metal framing supports and punch-out tabs can create an interlocking framing connection between the metal framing support and the spacing-bracing member.

The drawings show various types of connections using interlocking spacer braces, bracing clips, hook clips and bracing brackets that connect different building construction components together to form integrated building wall and floor assemblies using the light gauge metal framing. The spacer braces connect vertical or horizontal support members together individually, diagonally and or in tandem between adjacent spacer braces. The bracing clips, bracing brackets can be installed vertically or horizontally so the spacer braces can connect to them to also form diagonal spacer braces giving the flexibility to form a framing structure using wood or metal framing support members. Interlocking Thermal Insulating Blocks referred to as spacer blocks fit between the support members using the support members and spacer braces and their brackets and clips to secure the spacer blocks to the support members.

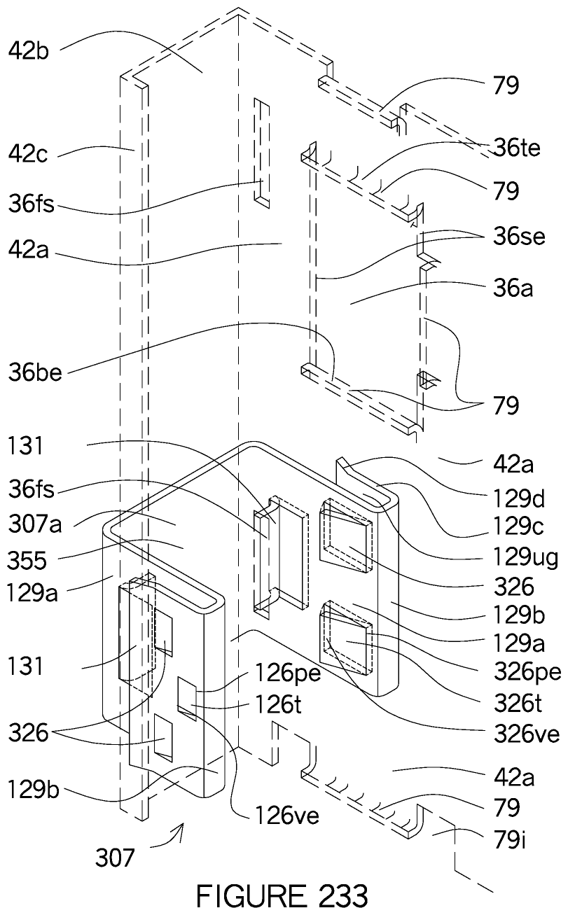

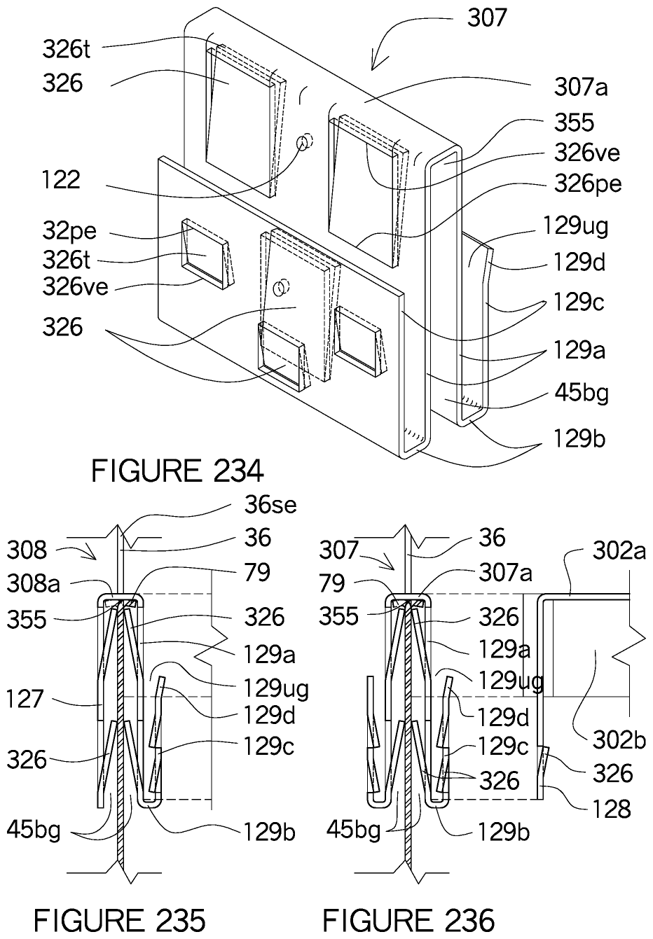

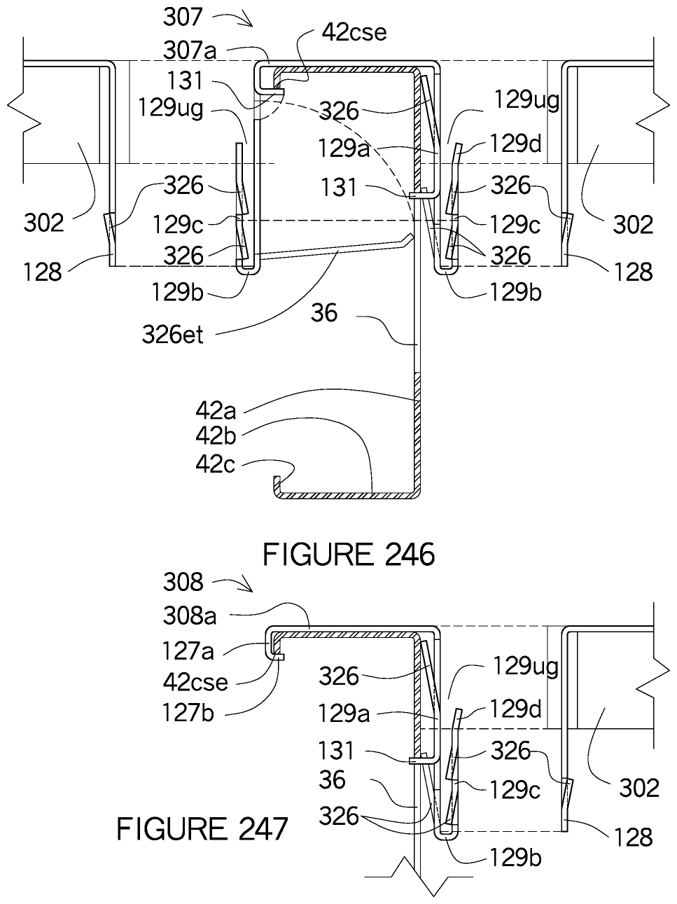

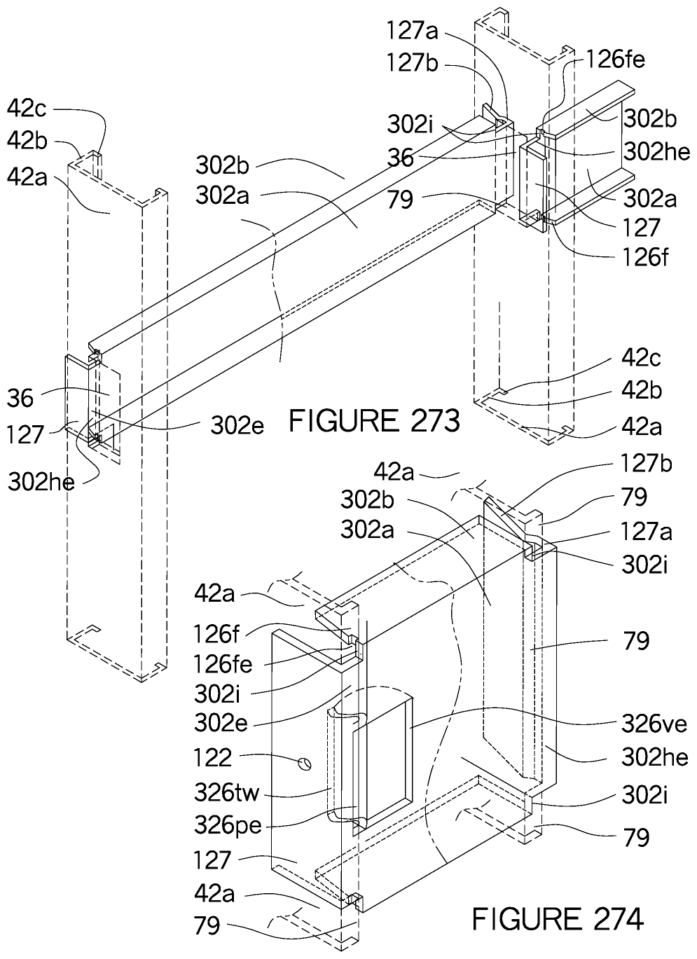

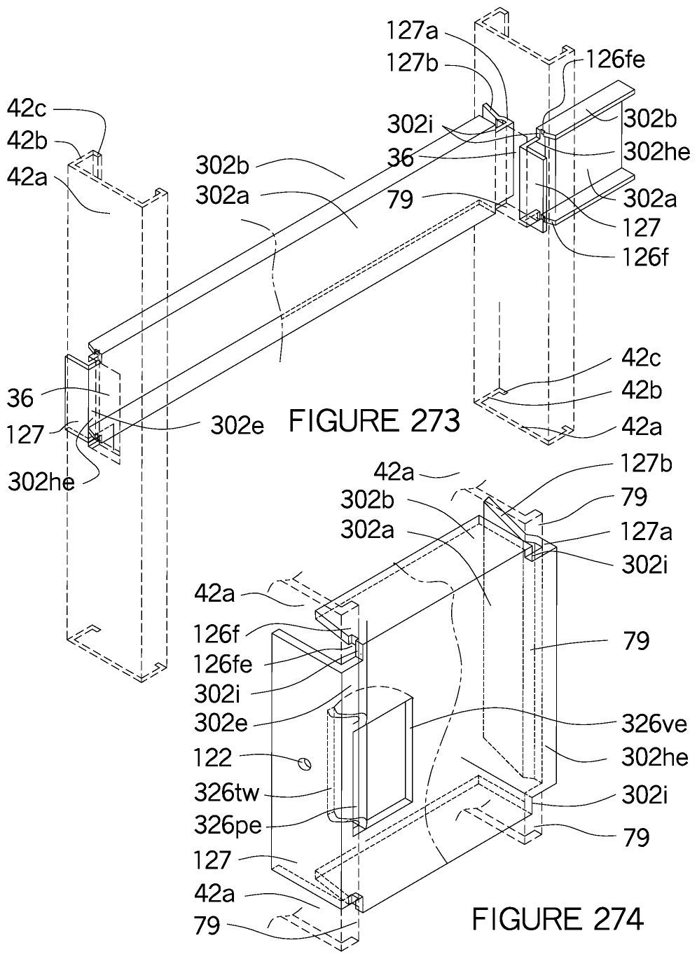

FIG. 232 shows an isometric view crisscrossing metal framing members highlighting various figures described within the cloud formations. Many different configurations or variations are shown throughout this application, for example Cloud A shows a hole 36 with ledges shown in FIGS. 233 & 268 along with a W-shaped clip 307 shown in FIGS. 246-248, 271 & 280 plus in Cloud B. Cloud B shows the W-shaped clip 307 installed in the hole 36 shown in FIGS. 234-244 as well as other figures having various configurations. Cloud C shows the U shaped spacer braces 302 installed vertically at the hole 36 as described in FIGS. 273-274. Cloud D shows three different configurations of how the ledge 79 is installed in vertical-flange notches 126vf or wrap-around tab 326tw or a tab 326t from a punched out tab 326 more fully described in about 10 figures. Clouds E & F show the hook tongue 128 installed within the hook receiver 129 along with punched out tabs 326 or ledges 79 with flange-edge notches 126fe.

FIG. 233 shows an isometric view of a vertical support member shown as a C channel 42 having a web 42a, flanges 42b and lips 42c. The web 42a shows a ledge 79 at the top end and bottom end of the web 42a as well as an ledge indentation 79i at the bottom edge. A slot hole 36s is shown setback from the flange 42b the same distance as the length of the lip 42c from the flange. A hole 36 is shown in the web 42a having ledges 79 at the hole bottom edge 36be, hole side edge 36se and the hole bottom edge 36be where the ledges 79 can be engaged to the tabs 326t of the punched out tabs 326. Near the bottom of the support member is a W-shaped clip 307 have its web 307a installed parallel to the flange 42b of the support member and has two hook receivers 129 attached at both ends with their ventral side wrapped around the web 42a and lips 42c of the support member also referred to as the anchor space 355. The hook receivers 129 have a first leg 129a that is parallel to the lip 42c or web 42a with a second leg 129b extending perpendicular then a third leg 129c extending back to the flange 42b and parallel to the first leg 129a leaving a gap 45 between the first leg 129a and the third leg 129c. Both the first legs 129a have punched out hooks 131 where one side is installed at the side edge of the lip 42c and the opposite punched out hooks 131 are inserted into the flange-slot hole 36fs along with additional punch out tabs 326 where the tab 326t will exert pressure on the web 42a to secure the W-shaped clip 307 to the support member. Additional punched out tabs 326 have their tabs 326t turned interior to apply pressure to the web 42a of the support member and slanted so the pivot edge 326pe is the pivot point for the tab 326t away from the vented edge 326ve. The slanted angle of the tab 326t allows the tab 326t to smoothly be inserted over the support member. The hook receiver 129 has a hook tongue 128 (not shown) inserted between the first and third legs 129a & 129c so the pivot edge 326pe of the tab 329t has the pivot end on the left side or pivot edge 326pe extending interior inward away from the vented edge 326ve or right side. The slanted angle of the tab 326t makes the hook tongue 128 easier to slide between the first and third legs 129a & 129c as shown in FIG. 232 when the W-shaped clip 307 is in a horizontal position.

FIG. 234 shows an isometric view of the W-shaped clip 307 which is used in FIGS. 236, 239, 242 and 243 except in FIG. 234 punched out tabs 326 have been installed. The W-shaped clip 307 is shown with two hook receivers 129 extending from both sides where each hook receiver 129 has a first leg 129a extending downward with a second leg 129b extending outward with a third leg 129c extending upward forming a gap 45 between the first and third leg 129a & 129c leaving an anchor space 355 on the interior side between the first leg 129a of each hook receiver 129. The first leg 129a has three punched out tabs 326 so the tab 326t extend interior inward so the pivot edge 326pe is the pivot point and the tab 326t is slanted inwardly from the vented edge 326ve. Three punched out tabs 326 also occur on the third leg 129c however here the pivot edges 326pe are on top end and the vented edges 326ve are on the bottom. The space between the first leg 129a of each hook receiver 129 and the third leg 129c has a gap 45 as shown in FIG. 236 for the hook tongue 128 to fit into. The upper punched out tabs 326 has the tabs 326t extending downward so the lower edge protrudes so when the hook tongue 128 from an adjacent U shaped spacer brace 302 is inserted into the gap 45, the tab 326t from the punched out tabs 326 will engage the tabs 326t from the third leg 129c. The punched out tabs 326 in the hook tongue 128 have the pivot edges 326pe on the bottom so the tab 326t can be inserted into the gap 45 and have the edge of the tab 326t at the vented edge 326ve engage the edge of the tab 326t at the vented edge 326ve from the third leg 129c of the hook receiver 129. The lower punched out tab 326 in the third leg 129c of the hook receiver 129 is there to help stabilize the hook tongue 128 when installed in the hook receiver 129. The W-shaped clip 307 shown in FIG. 236 shows the interior side of the web 307a installed in the anchor space 355 which is the over the bottom edge of the hole 36. The bottom edge of the hole 36 shows a ledge 79 which is a portion of the web 42a bent at an angle preferably 90 degrees to form a shelf. The ledge 79 is used to support the W-shaped clip 307 above and support the tab 326t from the punched out tab 326 shown in the first leg 129a of the hook receiver 129. The ledge 79 can be bent to extend to the left or right side of the web 42a and the tab 326t is used to secure the ledge 79 from being lifted above the ledge. The tabs 326t prevent the W-shaped clip 307 from moving horizontally and the tabs 326t on both sides of the hook receiver 129 allow the W-shape clip 307 to be installed in either direction. Since the W-shaped clip 307 is installed in the hole 36, the horizontal movement of the W-shaped clip 307 is engaged by the side edges of the hole 36 thereby eliminating any movement of the W-shaped clip 307 within the hole 36.

FIGS. 235, 238 & 241 show U-shape clips 308 where the top side is a web 308a and has a hook finger 127 extending from one side and a hook receiver 129 extending on the opposite side with and anchor space 355 between the hook finger 127 and the hook receiver 129. The hook finger 127 secures only one side of the U-shaped clip 308, however looks exactly like the first leg 129a of the hook receiver 129 in FIG. 236. The hook receiver 129, ledge 79 and the punched out tabs 326 all function the same as in FIG. 236 except as previously noted the U-shape clip 308 is used when no additional spacer braces are required to be connected in tandem.

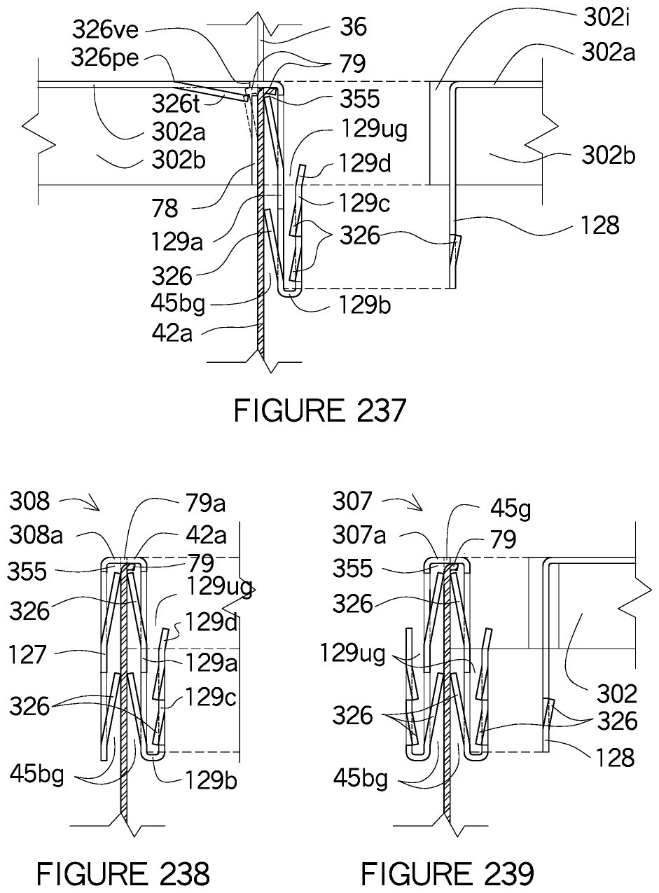

FIG. 237 is the opposing end of the U shaped spacer brace 302 shown in FIG. 236 where the opposite end was a hook tongue 128 and this figure shows a hook receiver 129 extending through the hole 36. The U shaped spacer brace 302 can be wider than the hole 36 where the flanges 302b abut one side of the web 42a of the support member or can be narrower than the width of the hole 36 where in this case a punched out tab 326 is shown at the web of the U shaped spacer brace 302. The punched out tab 326 has the pivot edge 326pe away from the hole 36 while the vented edge 326ve close to the hole 36 so the tab 326t can be slanted interior so the end of the tab 326t can extend under the ledge 79 that extends outwardly from the hole bottom edge 36be also shown as the anchor space 355. As explained later the ledge 79 can be the full width of the hole 36 or smaller as long as the tab 326t can support the U shaped spacer brace 302 from moving upwardly away from this secured connected. Even though the U shaped spacer braces 302 are equal to the spacing between support members, the hook receiver 129 passes over the web 42a and the hook tongue 128 is installed into the hook receiver 129.

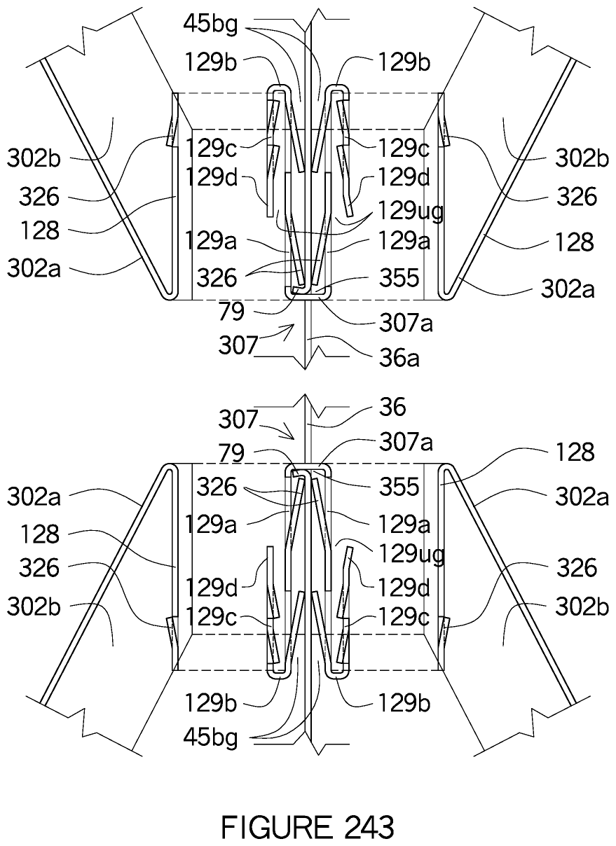

FIGS. 238-240 show the ledge 79 extending to the left or right allowing the clips or spacer braces to be installed in either direction. On the other hand FIGS. 241-242 show the U-shape clip 308 and the W-shaped clip 307 where the anchor space 355 is different. FIG. 242 shows the web 308a of the U-shaped clip 308 resting on the web 42a also referred to here as the anchor space 355 of the C channel 42 and the ledge 79 is slightly elevated leaving a ledge gap 45g under the ledge 79. On the other hand, in FIG. 243 the ledge gap 45g has the web 307a of the W-shaped clip 307 resting on the anchor space 355. Since the ledge 79 is bent outwardly, the ledge 79 can be wider than the W-shaped clip 307 which allows the web 307a to be installed in the ledge gap 45g. The same hook tongue 128 from FIG. 236 is installed except here the U shaped spacer brace 302 has the exterior side used as a base plate and is secured to a floor. It should also be noted that the ledge 79 is not occurring at a hole 36 as previously shown but at a floor line or at the top of a support member as shown in FIG. 233.

FIG. 243 is a combination of FIGS. 239 & 242 except two W-shaped clips 307 are installed one at the hole top edge 36te and another at the hole bottom edge 36be of the hole 36 and each edge is shown having a ledge 79. In addition, each hook receiver 129 shows a U shaped spacer brace 302 with their hook tongue 128 end ready to be installed into the gap 45 between the first leg 129a and the third leg 129c. The punched out holes 326 and the tabs 326t in both the third leg 129c and the hook tongue 128 are aligned so the tab 326t edges abut one another as so neither one can be removed vertically once installed into the gap 45. The W-shaped clip 307 cannot move horizontally in either direction because the W-shaped clips 307 are engage at the hole side edges 36se and the tabs 326t of the punched out tabs 326 engage the bottom edge of the ledge 79 that also presses against the sides of the web 42a of the support member to eliminate horizontal movement.

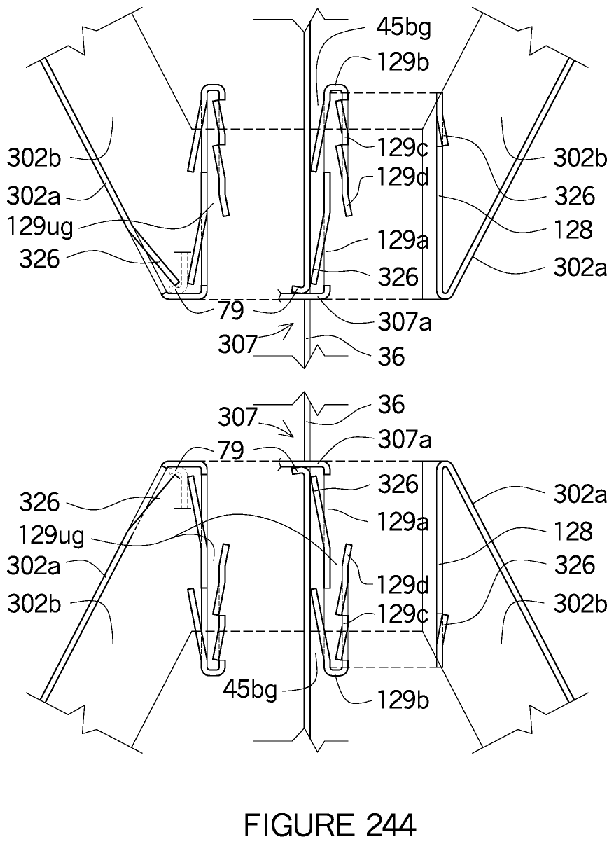

FIG. 244 is similar to FIG. 243 as four U shaped spacer braces 302 intersect at a hole 36 except here one U shaped spacer brace 302 has the hook receiver 129 end extend over the hole top edge 36te and the hole bottom edges 36be and the adjacent U shaped spacer brace 302 has the hook tongue 128 end secured into the gap 45 between the first leg 129a and the third leg 129c of the hook receivers 129 The U shaped spacer braces 302 are shown with angled hook receiver 129 and angled hook tongues 128. Referring back to FIG. 232 the diagonal spacer braces could be used in any one of the cloud formations from either FIG. 243 or FIG. 244 depending if a continuous U shaped spacer brace 302 was to be used or whether an X shaped metal framing configuration is desired. In addition the ledge 79 and punched out tabs 326 were used to stabilize the framing structure. Because of the angle of the U shaped spacer brace 302, the punched out tab 326 is shown in the web 302a so the vented edge 326ve has the tab 326t directed at the underside of the ledge 79 to secure the U shaped spacer brace 302 from sliding off the ledge 79.

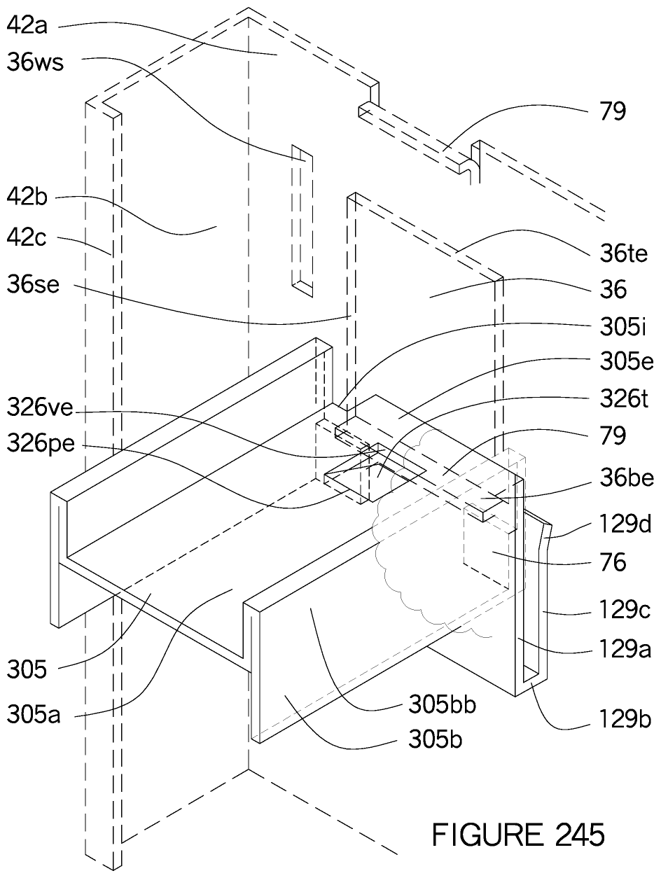

FIG. 245 shows an isometric drawings of an I-shaped spacer brace 305 which is shown wider than the hole 36 and where the hole 36 has a ledge 79 located on the bottom edge and the ledge 79 is not the full width of the hole bottom edge 36be. As in the previous figure a punched out hole 326 has the pivot edge 326pe away from the hole 36 and the vented edge 326ve close to the ledge 79 so the tab 326t can penetrate under the ledge 79 and two flaps 76 are show that extend from the flange 305b interior so the flaps 76 rest against the web 42a and under the ledge 79.

FIG. 246 is a plan view of FIG. 233 where the punched out hooks 131 wrap around the lip 42c and an extended tab 326et extends from the first leg 129a of the hook receiver 129 so the extended tab 326et can brace the hook receiver 129 on the interior side of the C channel 42. On the exterior side of the C channel 42 a hook receiver 129 extends from the web 307a, however here another punched out hook 131 is shown inserted into the hole 36 in the web 42a. The punched out hooks 131 and the tabs 326t from the punch out tabs 326 help secure the W-shaped clip 307 around the flange 42b. On both sides of the W-shaped clip 307 are the hook tongue 128 ends of the two adjacent U shaped spacer braces 302.

FIG. 247 is a plan view of a U-shaped clip 308 wrapped around the flange 42b of the C channel 42. Instead of the punched out hooks 131 in FIG. 246 the hook finger 127 end has the first leg 127a abut the lip 42c and the second leg 127b turn under the lip 42c. The U-shaped clip 308 has the hook finger 127 installed first so as to rotate the U-shaped clip 308 into place and the punched out tabs 326 with its tabs 326t press against the web 42a at the first leg 129 of the hook receiver 129 against the web 42a to allow the second punched out hook 131 to be installed into the hole 36 of the C channel 42. The hook tongue 128 from an adjacent U shaped spacer brace 302 is shown ready to be installed into the hook receiver 129.

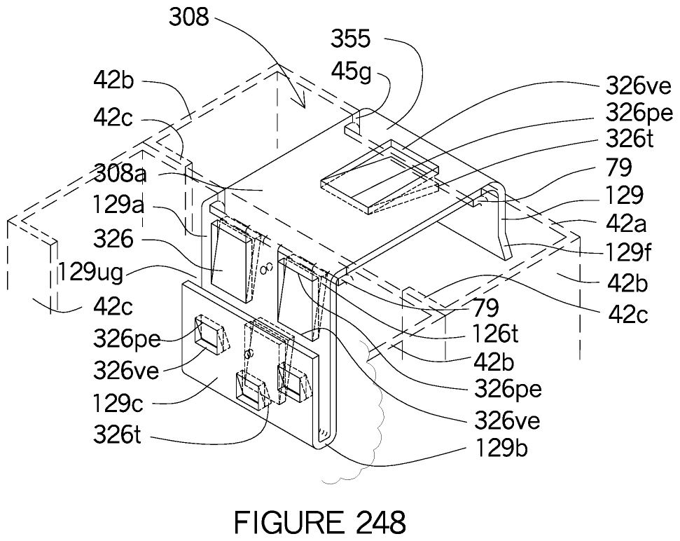

FIG. 248 is an isometric view where the U-shaped clip 308 fits over the top edge of two C channel 42 where the web 42a has a ledge 79 bent at the top edge of the web 42a. The ledge 79 is shown wider than the U-shaped clip 308 so the web 308a is inserted into the ledge gap 45g which will allow the exterior side f the U-shaped clip 308 to be level with the top edge of the support member shown as a C channel 42. Since the U-shaped clip 308 is spanning over two C channel both having the ledge 79 in the web 42a, the rear C channel 42 has a hook finger 127 extend over the web 42a of the rear C channel 42. A punched out tab 326 is shown in the web 308a where the pivot edge 326pe is in the middle between the two C channel 42 and the vented edge 326ve is near the ledge 79 so the tab 326t can extend under the ledge 79. The opposite end shows a hook receiver 129 extend over the closest C channel 42 where the first leg 129a extends over the interior side of the web 42a of the C channel 42 and the punched out tab 326 has the vented edge 326ve near to ledge 79, so again the tab 326t can extend under the ledge 79. The hook receiver 129 as previously described is engaged to the interior side of the web 42a of the C channel 42.

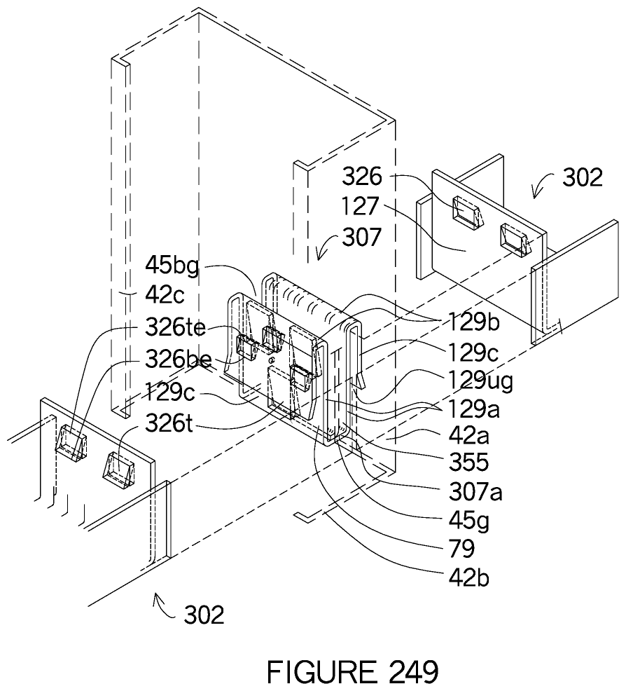

FIG. 249 is an isometric drawing of the sectional view shown in FIG. 242. The isometric view gives a clearer understanding on how the tabs 326t at the punched out tabs 326 at the U-shaped clip 308 fit together in the gap 45 between the first leg 129a and the third leg 129c of the hook receiver 129. In addition the hook tongue 128 is elevated slightly at the web 302a & flange 302b so the hook tongue 128 can be angled so the hook tongue 128 can slide into the gap 45 of the hook receiver 129. After the U shaped spacer brace 302 is installed into the W-shaped clip 307 at the hook receiver 129, the U shaped spacer brace 308 is anchored by an anchor bolt (not shown) to the floor or fastened by screws (not shown). When another support member is installed in a hook receiver 129, the gap 45 is open upward and can easily fit into the gap 45 similar to the schematic diagrams shown in the previous figures.

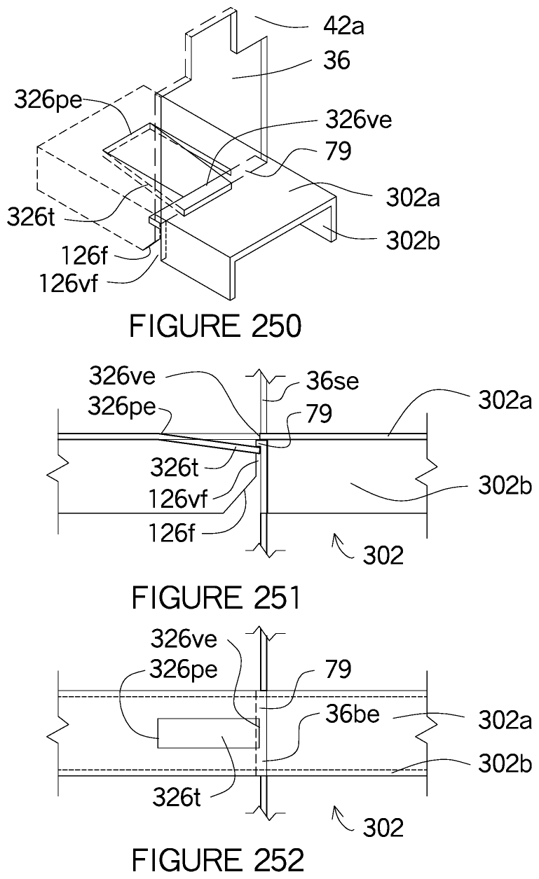

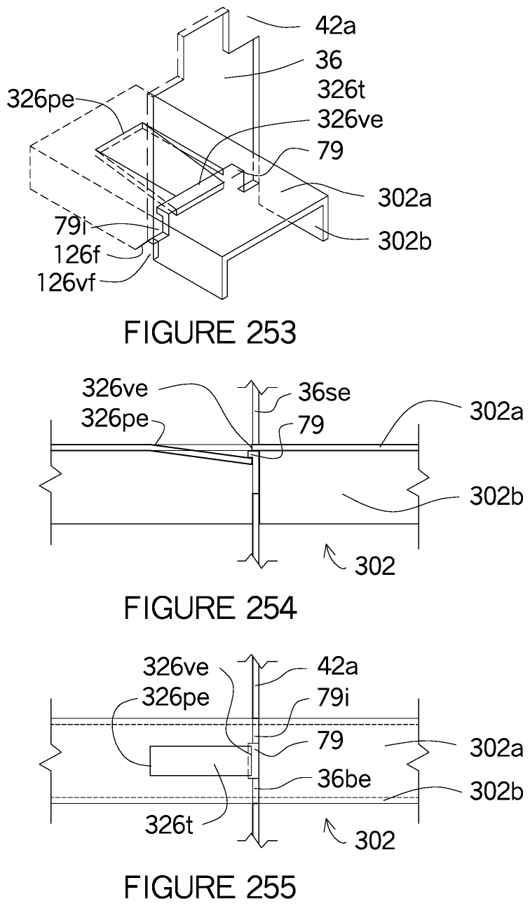

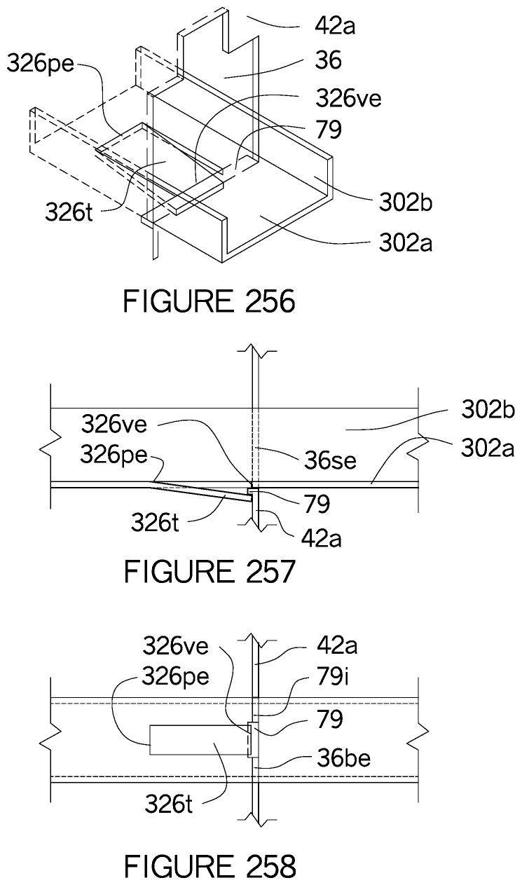

FIGS. 250 through 258 are similar as each group of three figures where each group shows an isometric drawing followed by a cross section and a plan view. FIG. 19 shows a U shaped braces 302 with the interior side facing the hole bottom edge 36be where a full width ledge 79 is shown. The web 302a shows the vented edge 326ve located near the ledge 79 so the tab 326t to be secured at the underside of the ledge 79. In addition, the flanges 302b are shown having the vertical flange notches 126vf the full depth of the flanges 302b to the depth of the top of the ledge 79 and a flare edge 126f. FIG. 253 is similar to FIG. 250 except here the ledge 79 is narrower than the width of the hole 36 so the ledge 79 is above the bottom edge of the hole 36 so the flanges 302b can slide into the flare 126f and secured into vertical-flange notch 126vf. FIG. 256 has the U shaped spacer brace 302 so the exterior side is against the ledge 79. The vented edge 326ve is near the ledge 79 so the tab 326t can be secured under the ledge 79. The ledge in FIG. 256 can be the full width of the hole 36 or shorter if desired. Any of the U shaped spacer braces 302 can have a ledge indentation 79i located close to the ledge 79 so the tab 326t from the punched out tab 326 can easily penetrate under the ledge 79 and the vertical-flange notches 126vf will not have to penetrate as high into the flange 302b.

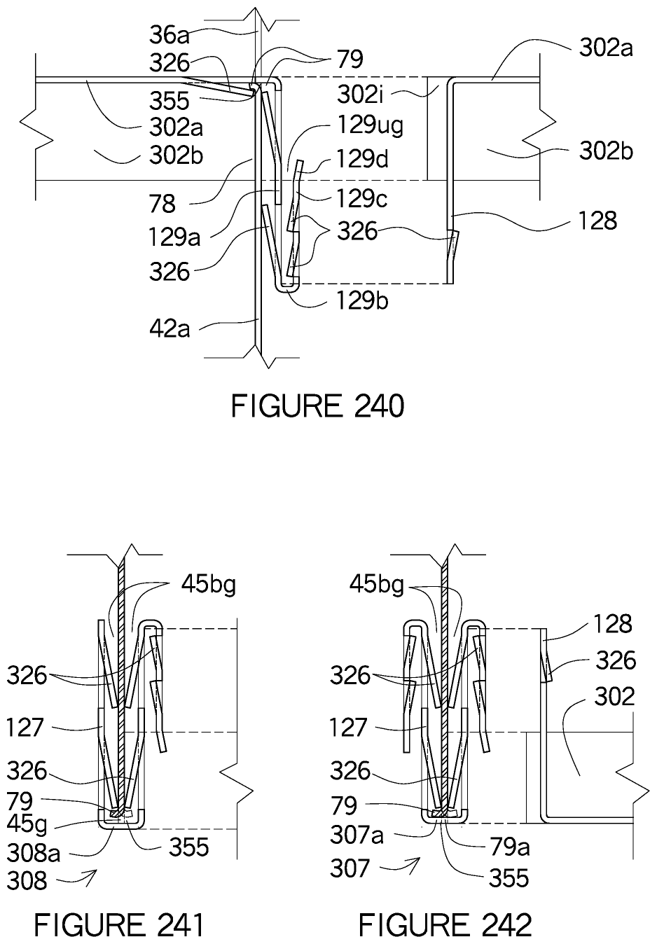

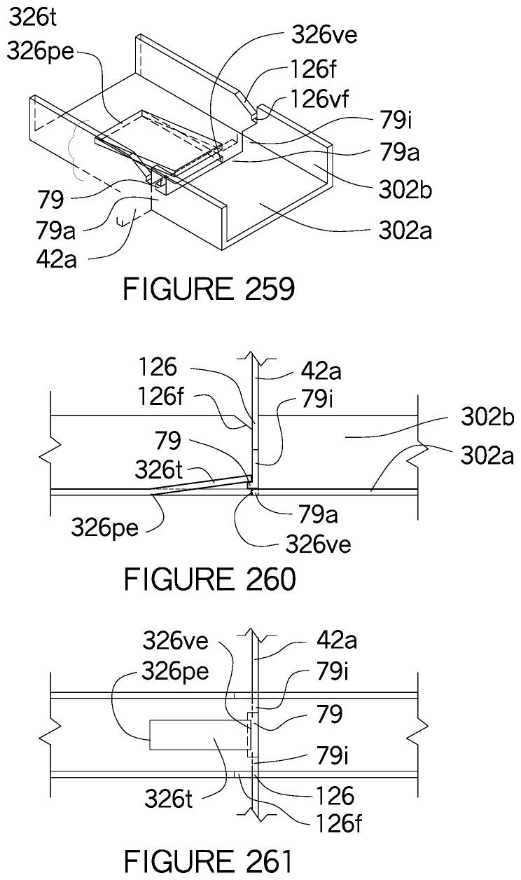

FIGS. 259-261 show an intermediate connection between the support member shown in FIG. 259 only as the web 42a of a C channel 42 and a spacer brace shown as a U shaped spacer brace 302. There can be several support members between the end of the hook receiver 129 of one spacer brace and the hook tongue 128 of an adjacent spacer brace form a longer spacer brace connection as shown in FIG. 232. FIG. 259 shows an isometric drawing of an intermediate connection of a U shaped spacer brace 302 intersecting a C channel 42 shown with only a portion of the web 42a shown. The U shaped spacer brace 302 is shown with the exterior side down facing a floor with the flanges 302b extending upward. The web 42a shows a ledge 79 at the bottom edge of the support member where a ledge space 79a when the ledge 79 is bent to form the ledge 79. The ledge space 79a is occupied by the web 302a of the U shaped spacer brace 302 and the ledge space 79a has a ledge indentation 79i on both sides of the ledge 79 and is indented to the height of the bottom edge of the vertical flange notch 126vf at the flanges 302b. The ledge indentation 79i can be the thickness of the flanges 302b allowing the ledge 79 to be wider between the two flanges 302b or narrower as shown here. Both flanges 302b show the vertical-flange notches 126vf with a flare 126f at one side edge of the vertical-flange notch 126vf where the web 42a is inserted into the vertical flange notches 126vf. When the U shaped spacer brace 302 is slid into the vertical-flange notches 126vf, the tab 326t of the punched out tab 326 extends over the top side of the ledge 79. The U shaped spacer brace 302 is secured when the tab 326t is over the ledge 79 and the web 302a is under the ledge 79 and is additional secured when the web 42a is secured into the vertical-flange notches 126vf and the side edges of the ledge indentation 79i is secured to the outside sides of the flanges 302b. FIG. 260 shows a section of the connection and FIG. 261 shows a plan view of the connection. FIG. 240 shows a similar wall section except the U shaped spacer braces 302 is shown at a hole 36 rather than upside down on a floor.

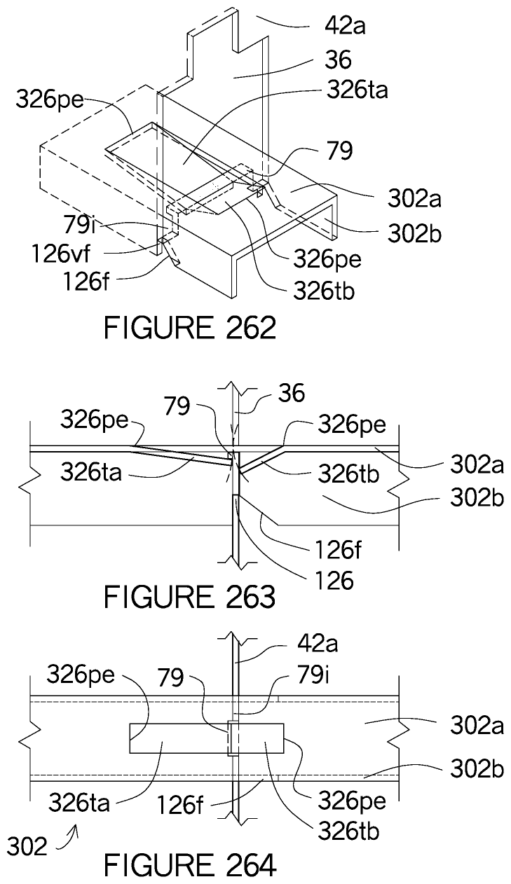

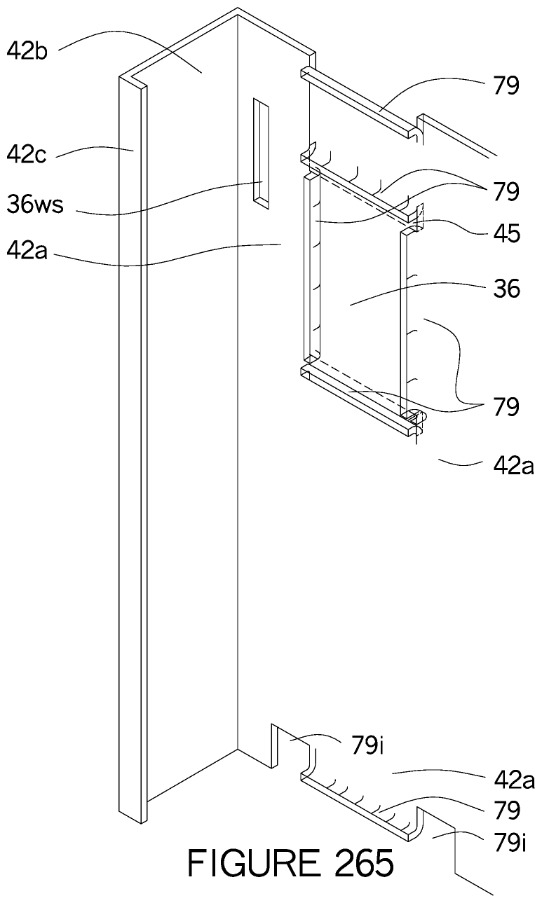

FIG. 262 is similar to FIG. 253 and shows a larger punched out tab 326 where two different tabs 326t as shown. The tab A 326ta is shown on the left side of the hole 36 having a pivot edge 326pe on the left side of the web 42a where the tab A 326ta has the end under the ledge 79 shown protruding outward to the left side. The tab B 326tb shown on the right side has its pivot edge 325pe on the right side of the web 42a and the end of the tab B 326tb also extends downward so the end of the tab B 326tb abuts the right side of the web 42a. Both the tabs A 326ta and tabs B 326tb have their side edges aligned and their front edge abut one another prior to being bent downward to their aligned positions as shown in section FIG. 263. Also shown in FIG. 263 are the flanges 302b of the U shaped spacer brace 302 having flares 126f at an angle to allow for the bottom edge of the hole 36 to fit into the vertical-flange notches 126vf on both sides. The vertical-flange notches 126vf are installed midway from the bottom edge of the flanges 302b so the top side of the ledge 79 can extend slightly higher to align to the interior side of the U shaped spacer brace at the web 302a. The flares 126f are installed on the opposite side of the hole 36 in FIGS. 253-256. The U shaped spacer brace 302 will likely be installed with a side motion so the tab A 326ta can be slide under the ledge 79 while at the same time the tab B 326tb can be pushed downward. FIG. 264 shows a plan view of a C channel 42 with the web 42a intersect the U shaped spacer brace 302. If the U shaped spacer brace 302 was reversed with the exterior side of the web 302a facing downward resting on the ledge 79, the tabs A 326ta and tabs B 326tb would have their vented side edges abut both sides of the web 42a eliminating any horizontal movement between support members and the vertical-flange notches 126vf would not be required.

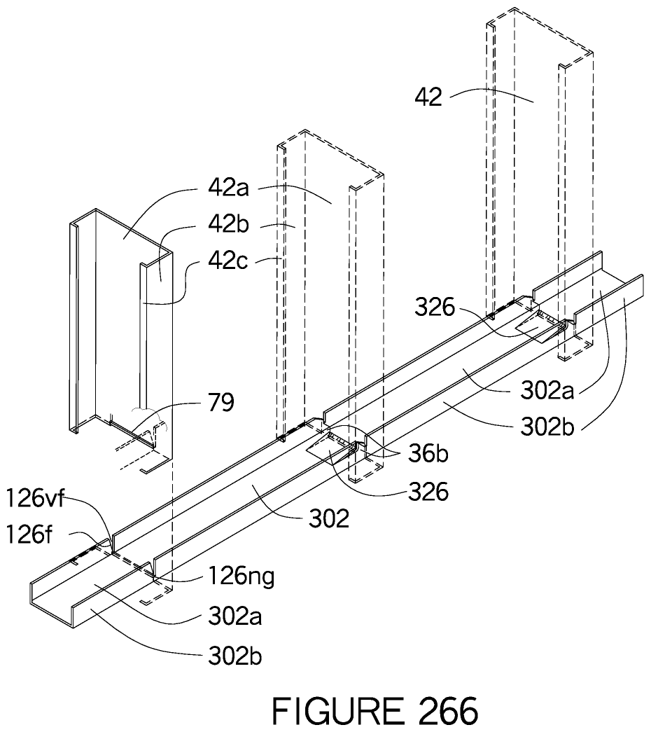

FIG. 265 shows an isometric view of a support member shown as a C channel 42 having a web 42a with flanges 42b extending interior inward with lips 42c extending interior parallel to the web 42 which is also shown in Cloud A & D in FIG. 232. The web 42a shows ledges 79 at the top, bottom and on all four edges of the hole 36. The ledge 79 at the top of the support member extends ventrally ventral inward with the width shown as wide as the hole 36 below; however the length of the ledge 79 can be any length as shown in other figures. The ledge 79 at the bottom of the web 42a in the support member is shorter and has a ledge indentation 79a on both sides of the punched out tab 326 extending interior inward located in the center of the web 42a, also shown in FIG. 266. The ledge indentation 79i are shown on both sides of the ledge 79 to allow the flanges 302b of the U shaped spacer brace 302 to pass through. The ledge 79 in the hole 36 shows the ledge 79 the top and bottom edge to be longer than the hole 36 width. The ledge 79 shown vertically at the hole 36 initially starts to bend at the side edges of the top and bottom ledges 79. The overlapping edges of the ledges 79 allow the ledges 79 to extend to each corner of the hole 36 rather than having a gap of no ledges 79 in the corners of the hole 36. Another hole shown as a vertical oriented web-slot hole 36ws is installed in the web 42a the edge of the lip 42c is setback the same distance from the web 42a. The web-slot hole 36ws is shown in FIG. 233 and is used to a W-shaped clip 307 extending over the flanges as shown in FIG. 233.

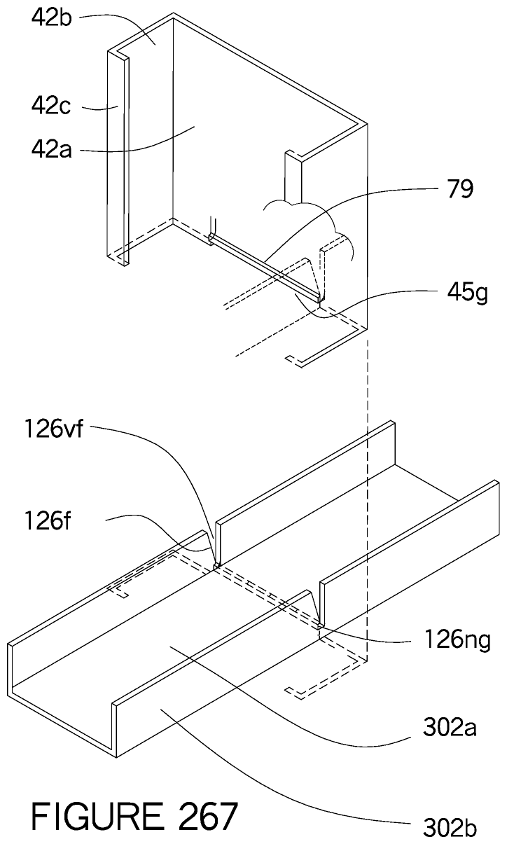

FIG. 266 is similar to FIG. 232 highlighted as Cloud D. The bottom edge of the support member shows the ledge 79 the full width of the U shaped spacer brace 302 and shown in the enlargement in FIG. 267. The U shaped spacer brace 302 is shown with the exterior side facing downward against a floor and its flanges 302b extend interior upward from the web 302a. The flanges 302b have vertical-flange notches 126vf on both flanges 302b with one side edge having a flared edge 126f with a notched gap 126ng for the ledge 79 to fit into. The ledge 79 is shown at the bottom edge of the web 42a of the support member. In FIG. 232 the underside of the ledge 79 is supported at the anchor space 355 on the web 302a of the U shaped spacer brace 302 leaving a ledge gap 45g between the underside of the ledge 79 and the bottom edge of the support member. As stated earlier the ledge 79 can be short, the depth of the treaded screw or greater depending on the pressure exerted on the ledge 79. If the ledge 79 is too long, then the ledge 79 would have to be longer than the support member in order for the ledge 79 to bear directly onto the 42a of the C channel 42.

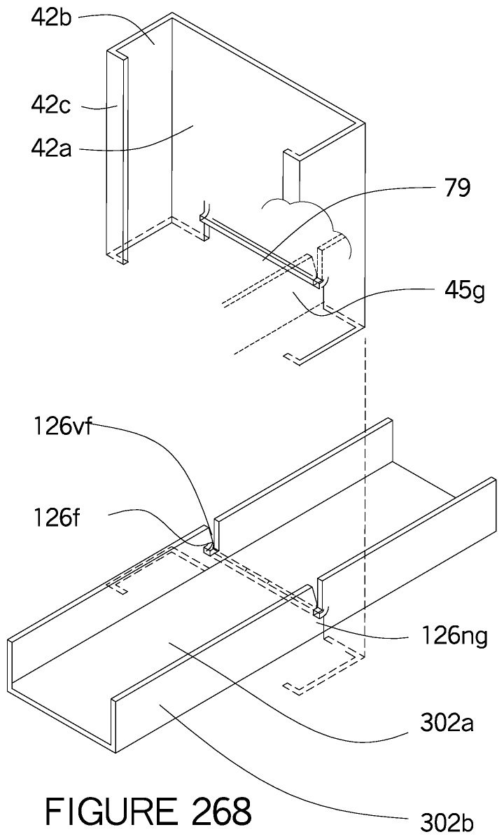

FIG. 268 is similar to FIG. 267, however the vertical-flange notch 126vf extends only partially into the flange 302b leaving a larger ledge gap 45g than in FIG. 267. The ledge 79 is elevated above the web 302a so the ledge 79 only has the two side flanges 302b at the notch gap 126ng to rest onto. The ledge 79 shown in FIG. 265 shows an indentation 79i in the web 42a so the web 42a of the support member at the ledge indentations 79i could rest onto the vertical-flange notches 126vf. An additional ledge 79 would have to be installed at the ledge indentation 79i in order for the ledge 79 to be installed into the notch gap 126ng.

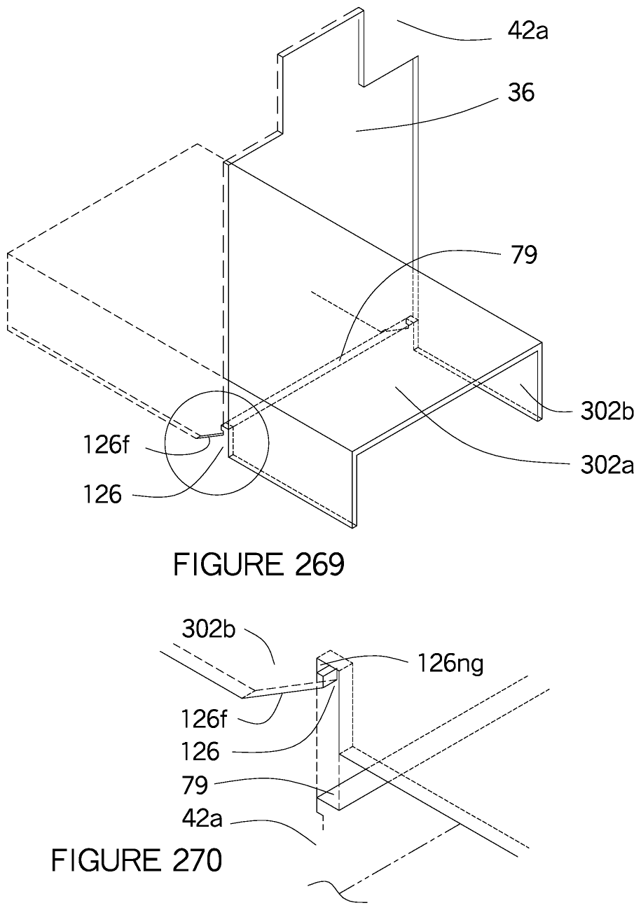

FIG. 269 also shows the shows the U shaped spacer brace 302 fitting into the hole 36 having the exterior side facing upward with the flanges 302b extending interior downward and where the flanges 302b have vertical-flange notches 126vf at the midway up into the flanges 302b. The hole 36 has a ledge 79 on the bottom edge and the flanges 302b have a notch gap 126ng at the end of the vertical-flange notch 126vf for the ledge 79 to fit into as also shown in the enlarged FIG. 270. The vertical-flange notches 126vf on both flanges 302b also have a flare edge 126f so the U shaped spacer brace 302 can easily slid into the vertical-flange notches 126vf.

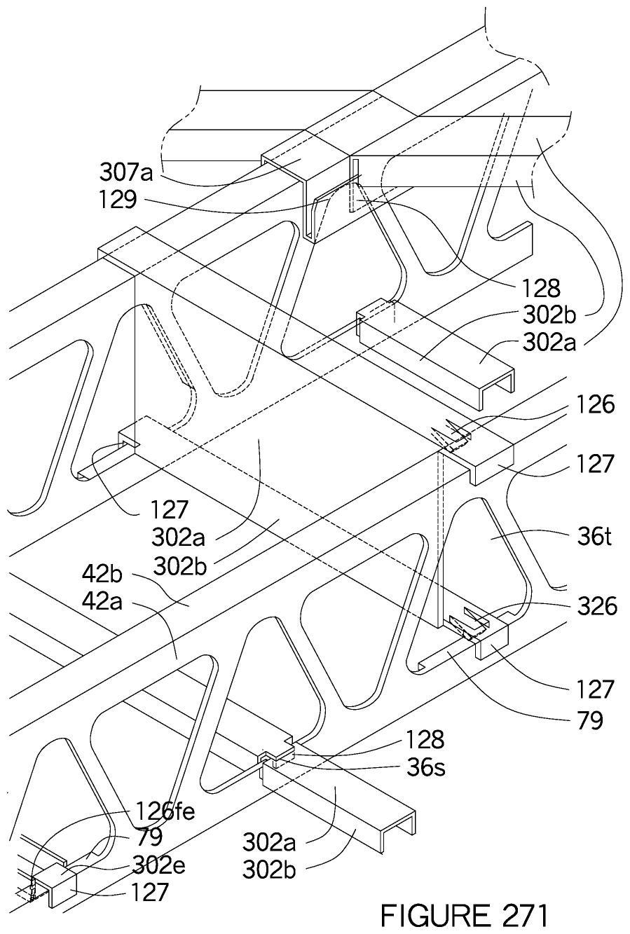

FIG. 271 is the same isometric as FIG. 232 except another shows a U shaped spacer brace 302 is shown at the bottom left corner. The U shaped spacer brace 302 shows the web extension 302we passing over the ledge 79 at the bottom edge of the triangular shape hole 36t with the hook finger 127 extending over the web 42a of the support members shown as horizontal floor joists. Again the flanges 302b with the flange-edge notch 126fe are engaging the edge of the ledge 79.

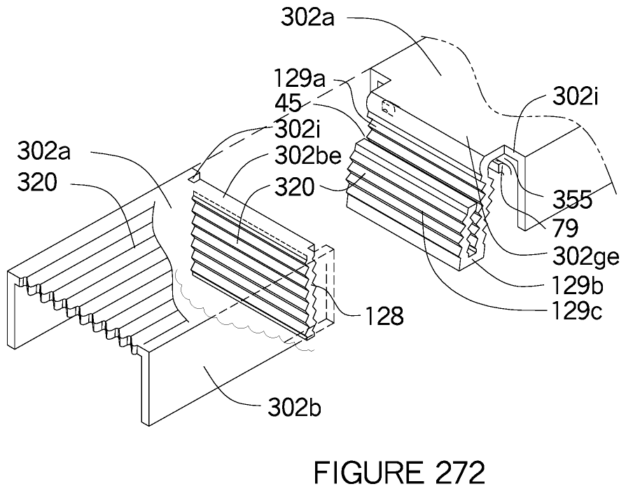

FIG. 272 shows a U shaped spacer brace 302 having the exterior side facing upward with the flanges 302b extending interior downward. The U shaped spacer brace 302 is shown broken where the hook tongue 128 is shown having horizontally oriented ridges 320 on the left with the flanges 302b extending beyond the hook tongue 128 where the edges of the flanges 302b would engage the web 42a (not shown). The right U shaped spacer brace 302 has the hook receiver 129 extending from the web 302a. The hook receiver 129 is shown with the first leg 129a extending downward from the web 302a then horizontally at the second leg 129b and third leg 129c extending vertically upward leaving a gap 45 between the first and third legs 129a & 129c. The hook tongue 128 fits into the gap 45. The hook tongue 128 and the first and third legs 129a & 129c all have horizontal ridges 320 so the ridges 320 can interlock between each other forming a self-locking connection between each other. FIG. 272 [[41]] shows the ledge 79 on the interior side of the U shaped spacer brace 302 under the ledge extension 302ge protruding outwardly from the web 42a toward the hook receiver 129. The ledge extension 302ge rests onto the ledge 79 and the hook receiver 129 extends over the ledge 79. Since a ledge 79 can occur at the top of a support member, not specifically at a hole 36, it is referred to as a ledge extension 302ge. Another self-locking connection occurs when the ledges 79 at the top, bottom or the support member or at the side edges of the holes 36, occupy the anchor space 355 at the ledge extension 302ge and the first leg 129a wraps-around the ledge 79 at the front side edge and bottom side edge then turns parallel to the web 42a, but extends slightly outward having a fluid shape similar to the W-shaped clip 307. The second leg 129b and third leg 129c including the flare 128d are shaped similar to the W-shaped clip 307. As explained earlier the side edges of the holes 36, side edges of the ledges 79 or the sides of the flanges 302b all restrict any horizontal movement of the U shaped spacer brace 302 at the support member. In addition the left U shaped spacer brace 302 the hook tongue 129 has a bend extension 302be at the web 302a for the hook tongue 129 to extend downward and the flanges 302b extend past the hook tongue 129 so the flanges 302b can abut the web 42a of the support member.

As discussed in FIG. 265 holes 36 can also have ledges 79 on the side edges and shown in FIG. 232 the U shaped spacer braces 302 are spanning between the side edge of the holes 36 in the support members. In FIG. 273 on the left ends of the U shaped spacer braces 302 show a hook finger 127 extending through the hole 36 where the flanges 302b engage the web 42a on one side and the hook finger 127 engaging the web 42a on the opposing side. The holes 36 show ledges 79 installed on the vertical side edges of the hole 36. The hook finger 127 has a hole extension 302he that extends over the ledges 79 and where the ledges 79 extend over the web 42a of the support members. The ends of the flanges 302b of the U shaped spacer braces 302 have flange-end notches 126fe for the ledge 79 to fit into. The hook finger 127 and the ledges 79 engaged into the flange-end notches 126fe for a self-locking connection to prevent any vertical movement of the U shaped spacer brace 302 engaging the support member. The right ends or the opposite end shows the hook finger 127 having a U-shape where the hook finger 127 extends over the ledge 79 so the first leg 127a wraps-around and extends over the front edge of the ledge 79 and under the ledge 79 then parallel to the web 42a of the support member then having an outward projecting flare. at the second leg 127b. The hook finger 127 with its U-shape supports the support member on one side of the web 42a and the flanges 302b abut the web 42a on the opposite side again forming a self-locking connection between the support member and the U shaped spacer brace 302. FIG. 274 shows an enlargement of both the self-locking connections. A fastener 122 is shown on one of the fingers 127, should an engineer specify a fastener 122 over and above the self-locking connection described. In addition the left side shows a punched out tab 326 on the web 302a close to the vertical oriented lip 79 at the hole 36. The punched out tab 326 has a wrap-around tab 326tw extending from the pivot edge 326pe just above the ledge 79 and bent inward at the vented edge 326ve having the wrap-around tab 326tw extending over the front edge of the ledge 79 then under the ledge 79 toward the interior side of the web 42a than veering away from the web 42a forming a flare at the end. The flared end of the wrap-around tab 326tw allows the wrap-around tab 326tw to bend around the ledge 79 and the bend of the wrap-around tab 326tw under ledge 79 secures the wrap-around tab 326tw from moving horizontally away from the vertically oriented ledge 79. FIG. 274 shows the hook fingers 127 on both ends of the U shaped spacer brace 302, however both sides could have the hook receivers 129 at both ends. The right end would then have the hook receiver 129 as shown in FIG. 272 where the ledge 79 protrudes outwardly from the web 42a toward the hook finger 127. The left end of the U shaped spacer brace 302 would then require the wrap-around tab 326tw from the punched out tab 326 to extend around the ledge 79. In other words, the wrap-around tab 326tw can be used on any type support member.

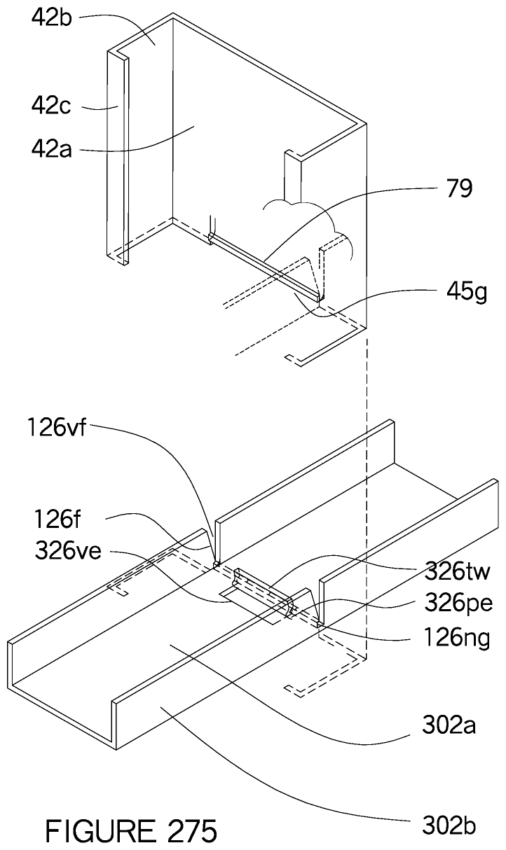

FIG. 275 is similar to FIGS. 265 & 266 where the U shaped spacer brace 302 has the exterior side facing downward and intermediate support members intersect the U shaped spacer brace 302. The ledge 79 is shown protruding outwardly on the interior side of the web 42a at the end of the support member. The length of the ledge 79 is shown the width of the U shaped spacer brace 302 and shown in FIG. 265 having a ledge gap 45g, however the ledge 79 can be any length in order for the web 302a of the U shape spacer brace 302 to fit into the flanges 302b. The flanges 302b has a vertical-flange notch 126vf for the web 42a to fit into and a notched groove 126ng for the ledge 79 to fit into when inserted into the U shaped spacer brace 302. The vented edge 326ve of the punched out tab 326 is located on the protruding side of the ledge 79 so the pivot edge 326pe can have the wrap-around tab 326tw extend over and under the protruding top, front and bottom edge of the ledge 79. The web 302a of one U shaped spacer brace 302 shows the web 302a having a wrap-around tab 326tw from the punched out tab 326 with the vented edge 326ve close to the ledge 79 so the wrap-around tab 326tw can be installed under the ledge 79.

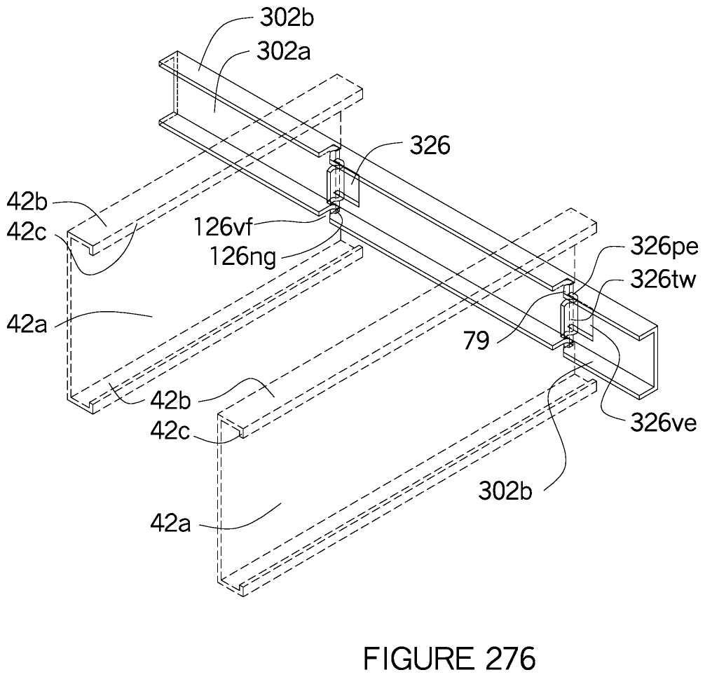

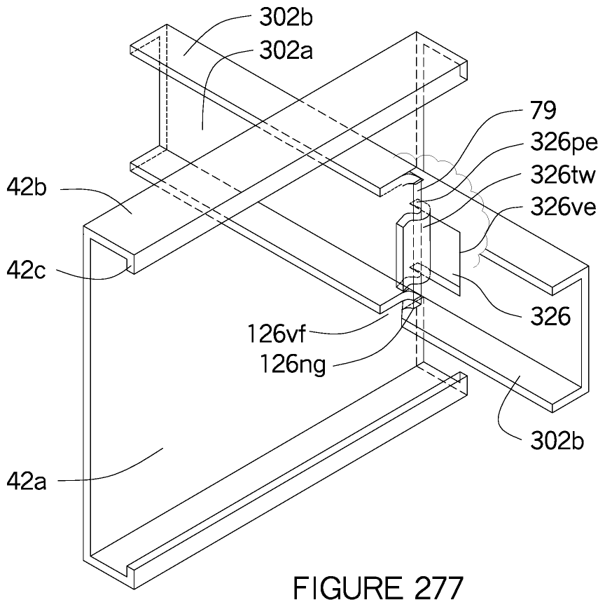

FIG. 276 shows an isometric of horizontal oriented floor joists also referred to as support members and are shown as horizontally oriented C channels 42 having a horizontally oriented web 42a with the interior flanges 42b and lips 42c forming a C-shape. The ends of the support members has a ledge 79 the same width as the crossing U shaped space brace 302 so the web 302a with flanges 302b extending from the interior side outward toward the C channel 42. The flanges 302b have a vertical-flange notch 126vf and a notch groove 126ng in the flanges 302b for the ledge 79 to fit into. The web 302a of the U shaped spacer brace 302 has a punched out tab 326 where the tab is a wrap-around tab 326tw that wraps around the ledge 79. Under the ledge 79 the pivot edge 326pe has the wrap-around tab 326tw extend over the front edge of the ledge 79 and wraps-around the ledge 79 securing the wrap-around tab 326tw to the U shaped spacer brace 302. The end of the wrap-around tab 326tw has a slight flare the extends outward from the web 42a making the ledge 79 fit between the wrap-around tab 326tw and the vertical-flange notches 126vf at the flanges 302b. FIG. 276 shows the support member using dashed lines for clarity purposes and FIG. 277 is an enlargement of FIG. 276. The U shaped spacer brace 302 can be the same height as the support member and therefore the additional punched out tabs 326 can be installed in the web 302a. When the U shaped spacer brace 302 is fully height a common term for that member is sometimes called a ledger.

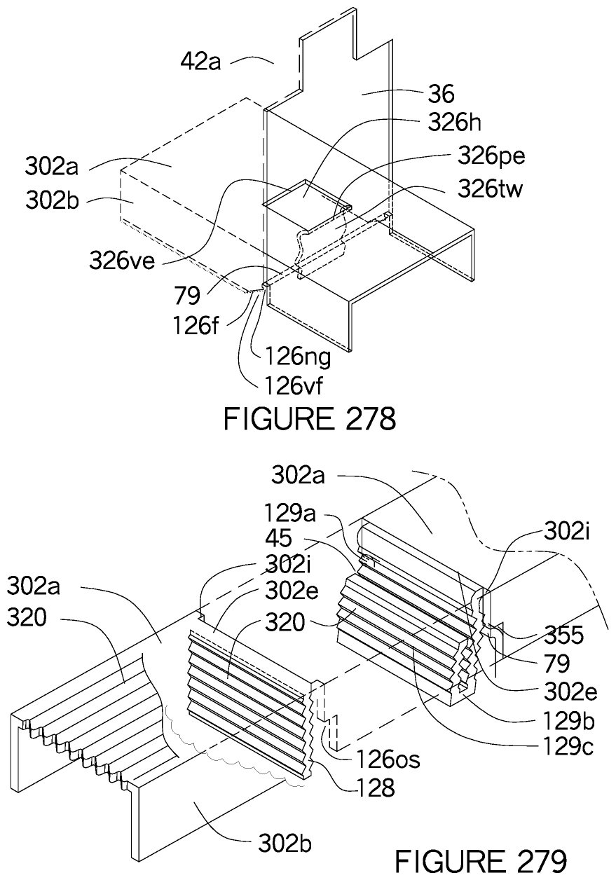

FIG. 278 shows an intermediate support member intersecting the U shaped spacer brace 302 at the hole 36 which is the same width of the hole 36. The U shaped spacer brace 302 has the exterior side facing upward with the flanges 302b extending from the interior side downward onto the ledge 79 shown at the bottom edge of the hole 36. The flanges 302b have a vertical-flange notch 126vf only extending partway into the flanges 302b with a flared edge 126f on one side and a notch groove 126ng at the end of the vertical-flange notch 126vf. A punched hole tab 326 is shown on the web 302a extending from the interior side downward where the wrap-around tab 326tw is aligned with the edges of the punched out tab hole 326h and the vented edge 326ve extends outward in the same direction as the overhanging ledge 79 with the wrap-around tab 326tw extends downward over the ledge 79 and then bent under the ledge 79 and then again away from the web 42a forming a flare. The outward projecting flare of the wrap-around tab 326tw allows the wrap-around tab 326tw to more easily pass around the ledge 79 allowing a portion of the wrap-around tab 326tw to be secured to the ledge 79. The depth of the vertical-flange notch 126vf does not penetrate the full depth of the flanges 302b as shown in both FIGS. 278 & 279.

FIG. 279 shows the end of a U shaped spacer brace 302 having a hook tongue 128 extending downward from the web 302a at the left U shaped spacer brace 302 with the ends of the flanges 302b abutting the web 42a of the support member. The U shaped spacer braces 302 on the left and right side of the support member have their interior sides facing downward with the flanges 302b extending from the webs 302a. The right U shaped spacer brace 302 has the flanges 302b having off-set notches 126os midway up the flanges 302b where lower portion rests against the web 42a and the off-set notches 126os rest on the top of the ledge 79 at the anchor space 355 and the hook receiver 129 has the first leg 129a extend downward past the front edge of the ledge 79 then indented inward under the bottom side of the ledge 79 then again away from the web 42a before the second leg 129b extends perpendicular then the third leg 129c is bent upward having a gap 45 between the first and third legs 129a & 129c then extend slightly outward away from the first leg 129a allowing then the hook tongue 128 to be inserted into the hook receiver 129. Both the hook tongue 128 and hook receiver 129 have ridge 320 that form an abrasive means to secure the hook tongue 128 and hook receiver 129 together. The self-locking connection of the flanges 302b pinned between the first leg 129a of the hook receiver 129 and the notch 126 and the first leg 129a of the hook receiver 129 having an in-out undulation in the first leg 129a is the opposing direction abrasive means. The undulation of the first leg 129a is probably equal to the thread of many screws to obtain the same abrasive means between the two surfaces.

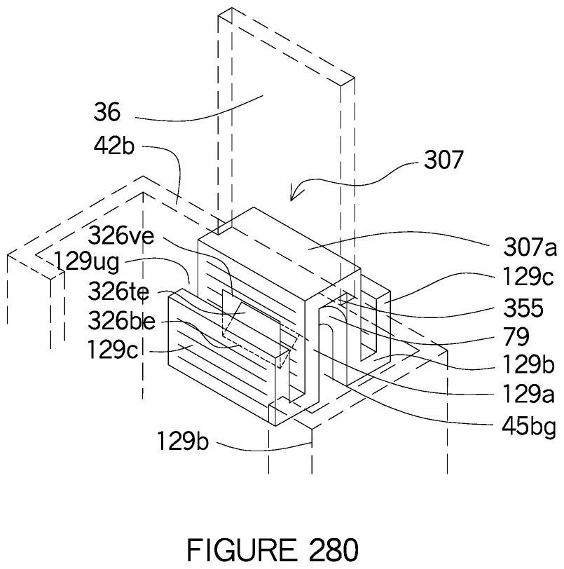

FIG. 280 shows the same W-shaped clip 307 as shown in an earlier provisional patent application, except here only one punched out tab 326t is shown and the first and third legs 129a & 129c or the hook receiver 129 are shown having horizontally oriented ridges 320 that would give an abrasive resistance to the hook tongue 128 which would also have the ridges 320.

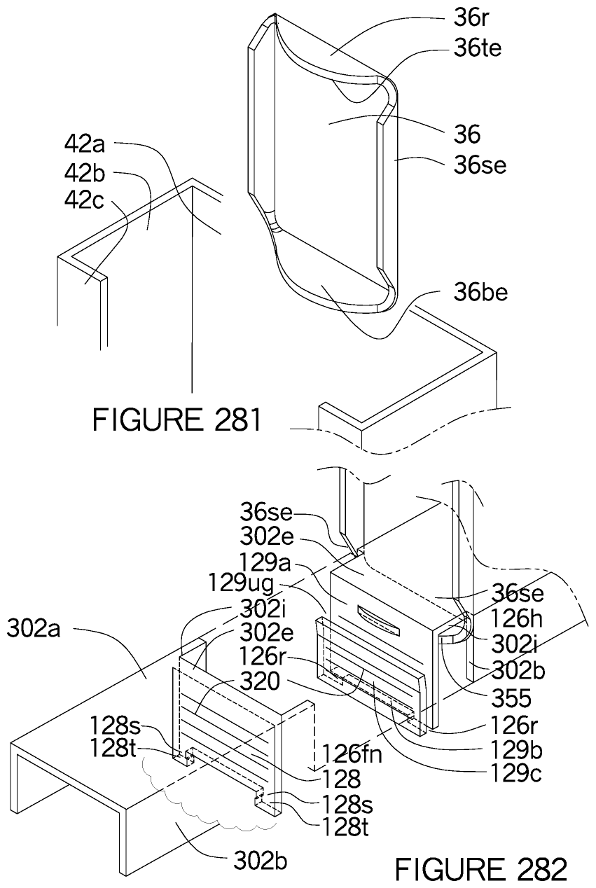

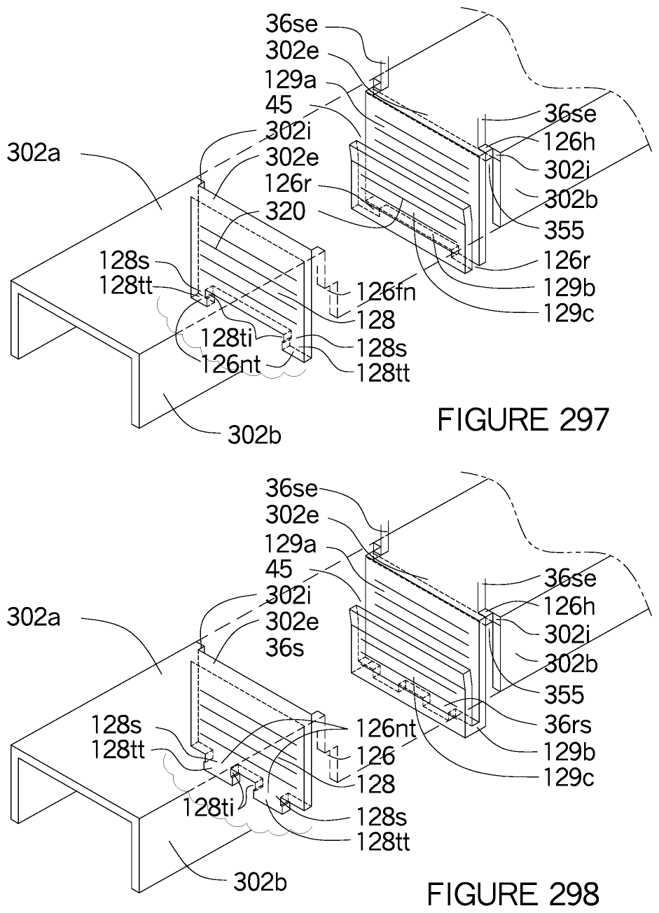

FIG. 281 shows a hole rim 36r having a rectilinear shape with a continuous shaped hole rim 36r extend from the web 42a of the support member and where the corners have a short depth at the hole rims 36r. FIG. 282 shows a U shaped spacer brace 302 extending through a hole 36 shown similar to the U shaped spacer brace 302 in FIG. 297, however the hole bottom edge 36be in FIG. 281 has an irregular shape configuration. The hook receiver 129 is shown extending over the irregular shape of the hole bottom edge 36be due to the shape of the hole rim 36r. The first leg 129a of the hook receiver 129 shows a receiver slot hole 36rs so the hole rim 36r can fit into. If the hook receiver 129 extends through the hole 36 in reverse, the flanges 302b would have notches 126 at the end side edges of the flanges 302b for the hole rim 36r could fit into will the hook receiver 129 would have extended over the hole bottom edge 36be against the web 42a. The hole rim 36r are very irregular so notches could be installed in the hole rim 36r to accomplish a similar self-locking connection.

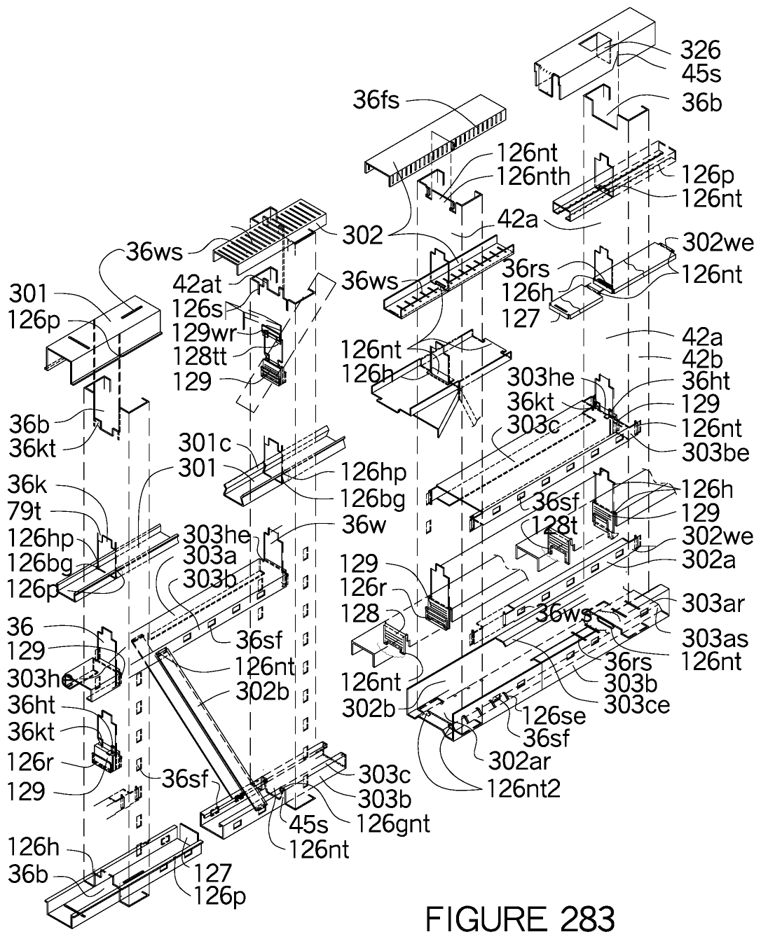

A DESCRIPTION OF THE PREFERRED EMBODIMENTS in FIG. 283 through FIG. 360 shows how the spacer braces with and without lips or lips with notches connects to metal framing supports as a fixed or sliding connections when installed at the bottom, middle or top of the metal framing supports. Other types of metal framing connections incorporating earlier applications have been included in this application and have required CIP U.S. Ser. No. 16/195,847 as well as future CIP's that have yet to be written.

FIG. 283 shows an isometric view of four support members having various types of connections using interlocking support members crossing spacer braces and bracing clips, hook clips all having various self-locking connections using support tabs, notched-tabs and openings with notches. The support tabs can be ledge tabs 79t, hole tabs, web tabs 42at, J-shaped gap tabs 45jt, hook receiver tabs 129t, key tabs 36kt, punch-out tabs 326, wrap-around tabs 326tw, notched-tabs 126nt, hook tongue tabs 128tt that can be bent after being installed in holes 36, slot holes 36s, hole notches 126h, lip notches 126p, flanges slot holes 36fs, web slot holes 36ws, receiver slot holes 36rs, bracing holes 36b, tab holes 36tb, rim notches 126rm, bulge notches 126g, slide notches 126s, clip notches 126c, lip notches 126p, receiver notches 126r and that can be installed vertically, horizontally or diagonally using the different configured support members and crossing members.

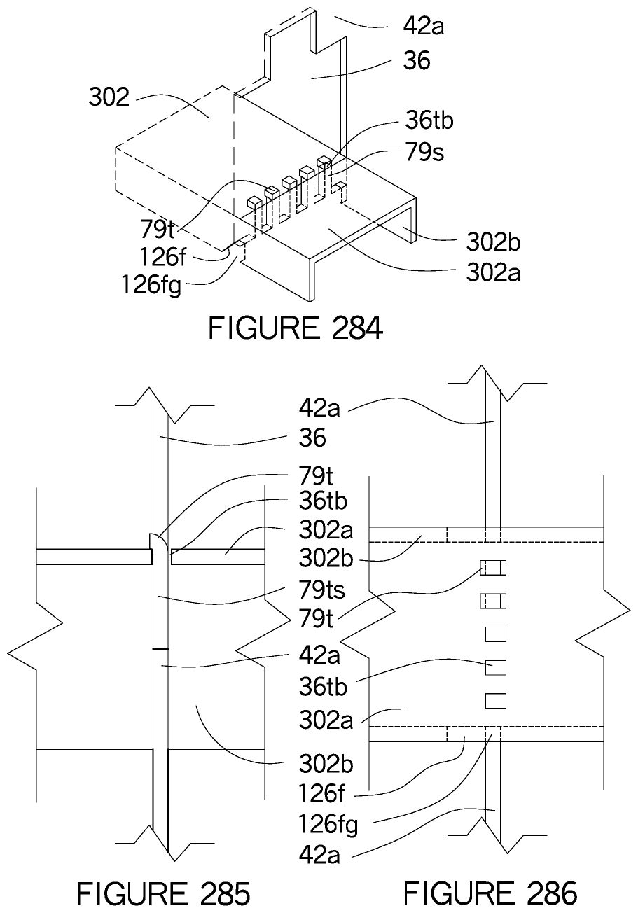

FIG. 284-286 shows another tongue and receiver combination where ledge tabs 79t extends from the bottom edge of the tab holes 36tb in the web 42a of a support member. An array of ledge tabs 79t extend upward forming a ledge shaft 79s that extends through the tab holes 36tb in the web 302a of the U shaped spacer brace 302. The ends of the ledge tabs 79t are slightly larger than the tab holes 36tb so the ends can extend over the tab holes 36tb allowing the ends of the ledge tabs 79t to retain the U shaped spacer brace 302 from moving vertically. On the other hand, the flanges 302b have flange notches 126fg that extend halfway the height of the flanges 302b of the U shaped spacer brace 302. When the U shaped spacer brace 302 is inserted into the hole 36 which is the approximate width as the hole 36, the flanges 302b are resting on the flange notches 126fg and the ends of the ledge tabs 79t are extending above the web 302a. The flange notches 126fg are shown having a flared edge 126f so the U shaped spacer brace 302 can bend and easily slide into place. The flange notches 126fg in the side walls keep the longitudinal U shaped spacer brace 302 from moving horizontally as the flange notches 126fg extend approximately half the height of the flanges 302b. The flange notches 126fg reduce the height of the ledge shafts 79s to reduce the horizontal bending stress of the ledge shafts 79s. FIG. 285 shows a vertical cross section with the ledge shafts 79s extend through the tab holes 36tb allow the wider end of the ledge tab 79t to secure the web 302a. FIG. 286 shows a plan view of the tab holes 36tb which are slightly larger than the ledge shafts 79s in order for the ledge-shafts 79s can bend slightly to allow for the wider end of the ledge tabs 79t to secure the web 302a.

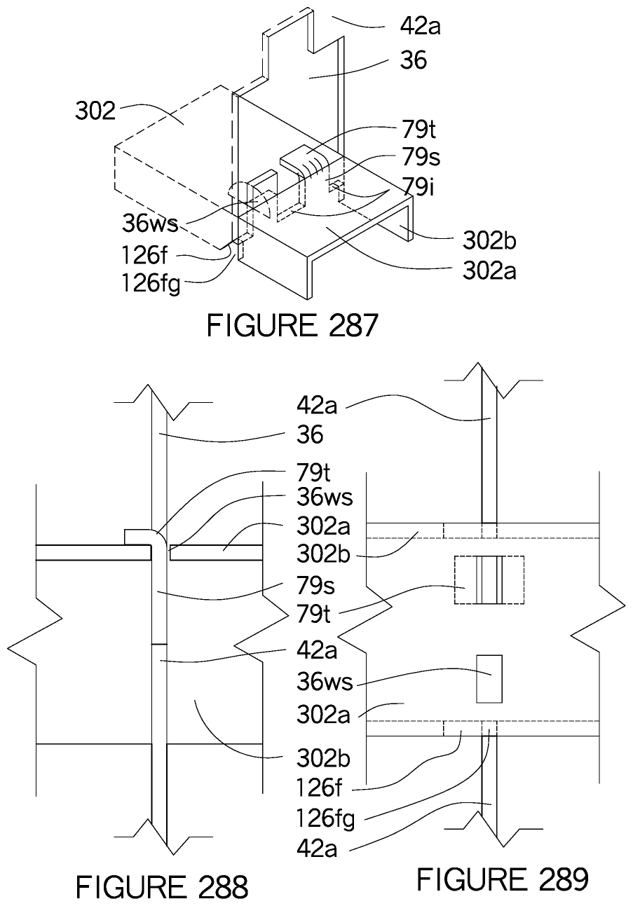

FIG. 287 shows an isometric view of a U shaped spacer brace 302 extending the width of the hole 36 having the interior side facing downward toward the bottom edge of the hole 36 at the web 42 of the support member. The flanges 302b have flange notches 126fg with flare edges 126f so the U shaped spacer brace 302 rests at the end of the flange notches 126fg. The bottom edge of the hole 36 has two ledge shafts 79s with ledge indentation 79i on either side so the ledge shafts 79s can extend through the web slot hole 36ws in the web 302a of the U shaped spacer brace 302. The ledge shaft 79s is long enough so the end of the ledge shaft 79s can be bent to form ledge tab 79t. The ledge tab 79t can be bent in both directions so the ledge tabs 79t cannot move side to side and the ledge tabs 79t with its bent side fitting firmly against the web 302a secures the U shaped spacer brace 302 from moving in a vertical movement between the bent edge of the ledge tabs 79t and the flange notches 126fg forming a self-locking connection. FIGS. 281 & 287 are similar as the U shaped spacer brace 302 is installed at an angle allowing the side walls of the flanges 302b with the flange notches 126fg side into the hole side edges 36se for a faster easier connection to the hole 36. The flanges 302b are installed first then the ledge shafts 79s are installed through the web slot holes 36ws. FIG. 288 shows the cross section and FIG. 289 shows a plan view of the self-locking connection. Since the ledge shafts 79s are long the excess length that extends through the web slot holes 36ws are bent after the ledge shaft 79s has been installed into the web slot holes 36ws.

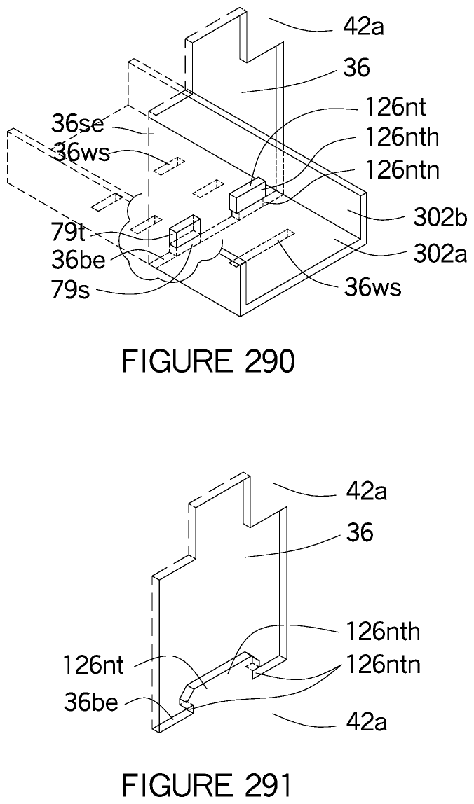

FIG. 290 is similar to FIG. 287 however in FIG. 290 the U shaped spacer brace 302 has the side walls of the flanges 302b extending away from the hole bottom edge 36be located in the web 42a of the support member referred to as a C shape channel 42. The web 302a is shown having web slot holes 36ws where the left web slot hole 36ws shows a ledge shaft 79s that extend from the hole bottom edge 36be. The left ledge shaft 79s is described as a ledge shaft 79s also shown in FIGS. 287-289. The right ledge shaft 79s is described as a notched-tab notch 126ntn when extending through the web slot holes 36ws and the ledge tabs 79t that extend above the web slot holes 36ws are the end or heads 126nth of the notched-tab 126nt. The head 126nth of a notched-tab 126nt is wider than the length of the web slot hole 36ws that forms the notched-tab notch 126ntn. The hole side edges 36se engage the outside plane of the flanges 302b of the U shaped spacer brace 302 from moving horizontally between the hole side edge 36se and the notched-tab notch 126ntn secures the inside and outside planes of the web 302b from moving horizontally within the hole 36 and vertically being secured by the head 126nth of the notched-tab 126nt. The notched-tab notch 126ntn of the notched-tab 126nt function the same as the ledge shaft 79s, except the ledge shaft 79s is only the height of the notch 126ntn therefore reducing any horizontal bending stress at the notch 126ntn. The ledge shafts 79s or notched-tabs 126nt from the first framing element of the web 42a can extend through the web slot holes 36ws of FIG. 287 then continue through the web slot holes 36ws of FIG. 290 to the underside of the head 126nth and/or bending the ledge shafts 79s after extending through the web slot holes 36ws of the second U shaped spacer brace 302 thereby securing both members together both horizontally and vertically. The lower the notches 126ntn are in relation to the hole bottom edge 36be the greater the leverage to produce a stronger notched-tab 126nt to reduce horizontal movement between support members.

FIG. 291 is similar to FIG. 290 except only one notched-tab 126nt without showing the U shaped spacer brace 302. The notched-tab 126nt is shown having rounded edges at the head 126ntn in order to more easily slide through the web slot holes 36ws. Since the head 126nth has the rounded edges, the U shaped spacer brace 302 might have to be installed ata slight angle in order for the head 126nth to pass through the web slot hole 36w. When only one notched-tab 126nt is used as in FIG. 290 only one web slot hole 36ws is required which is easier and faster to install. The notch 126ntn of the notched-tab 126nt does not have a ledge shaft 79s, but extends directly from the hole bottom edge 36be also referred to as the bottom shoulder of the hole notch 36be. Therefore the notch 126ntn is a configuration consisting of the hole bottom edge 36be, the depth of notch 126nt within the notched-tab and the head 126nth of the notched-tab 126nt forming the three side planes of the notch 126ntn.

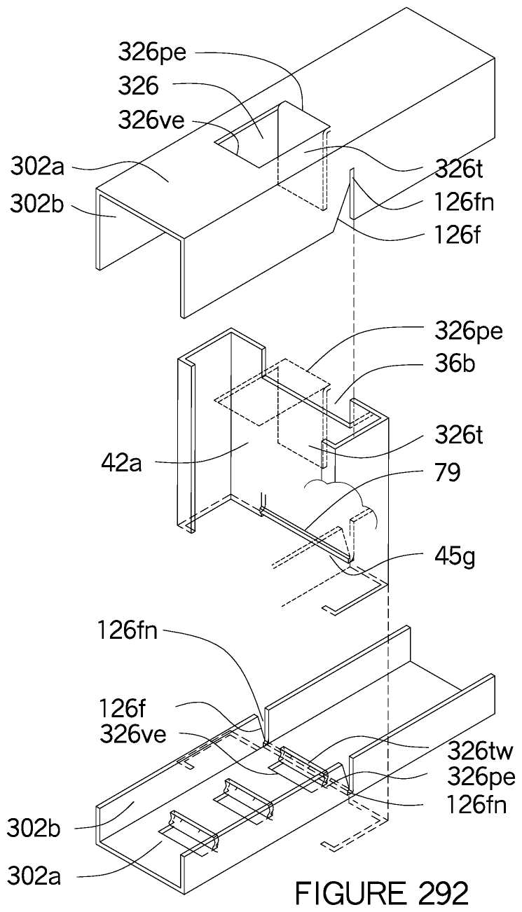

FIG. 292 shows the U shaped spacer brace at the floor with its exterior planar surface facing the floor and the interior side shows the flanges 302b extending upward from the web 302a. At the center of the U shaped spacer brace 302 shows a wrap-around tab 326tw extending from the pivot edge 326pe of the punch out tab 326 wrapping around the ledge 79 extending from the web 42a of the support member shown as a C channel 42. The ledge 79 is shown the same width as the U shaped spacer brace 302. The ends of the ledge 79 get inserted into the flange notches 126fn on both flanges 302b and the end of the ledge 79 is inserted into a notch gap 126ng. The one side of the flange notches 126fn has flare edges 126f so the web 42a can more easily fit into the flange notches 126fn. The wrap-around tab 326tw wraps around the ledge 79 just enough so that the inner side closed the web 42a can extend pass the ledge 79 than veer away from the ledge 79 leaving a sort of angular shape so the web 42a can extend past the wrap-around tab allowing the wrap-around tab to slight bend so the ledge 79 can become lodged into the flange notches 126fn and the notch gap 126ng. After the U shaped spacer brace 302 is installed at the floor another U shaped spacer brace 302 can be installed at the top end of the support members. The upper U shaped spacer brace 302 is shown so the support member can move vertically within the wall framing structure unless a fastener (not shown) is attached to the tab 326t and the web 42a. The top end of the C channel 42 shows the web 42a having a bracing hole 36b which is the same width as the U shaped spacer brace 302. The U shaped spacer brace 302 shows its flanges 302b extending inwardly downward from the web 302a. The flanges 302b have flange notches 126fn extending into the flanges 302b with one side having a flare edge 126f and the straight edge on the opposite side for a simple and easy connection. The U shaped spacer brace 302 is inserted into the bracing hole 36b so that the flanges 302b are inserted between the side edges of the bracing hole 36b, so the flange notches 126fn engage the bottom edge of the bracing hole 36b. When inserting the U shaped space brace 302, the web 302a has a punch out tab 326 with the tab 326t extending inwardly downward so that the tab 326t is against the web 42a on one side and the opposing side of the web 42a rests against the straight edge of the notch 126. When the U shaped spacer brace 302 has the exterior side web 302a secured to a floor joist above, the floor joist above (not shown) can bend due to earthquakes or increase floor loading (by live or dead loads) the U shaped spacer brace 302 will slid up and down between the tab 326t and the straight edge of the flange notch 126fn and will also not move sideways as the U shaped spacer brace 302 is wedged between the side edges of the bracing hole 36b of the support member. If the tab 326t was longer in length at the punch-out hole 326, fasteners (not shown) could secure the tabs 326t to the web 42a and if the wall framing structure would be panelized.

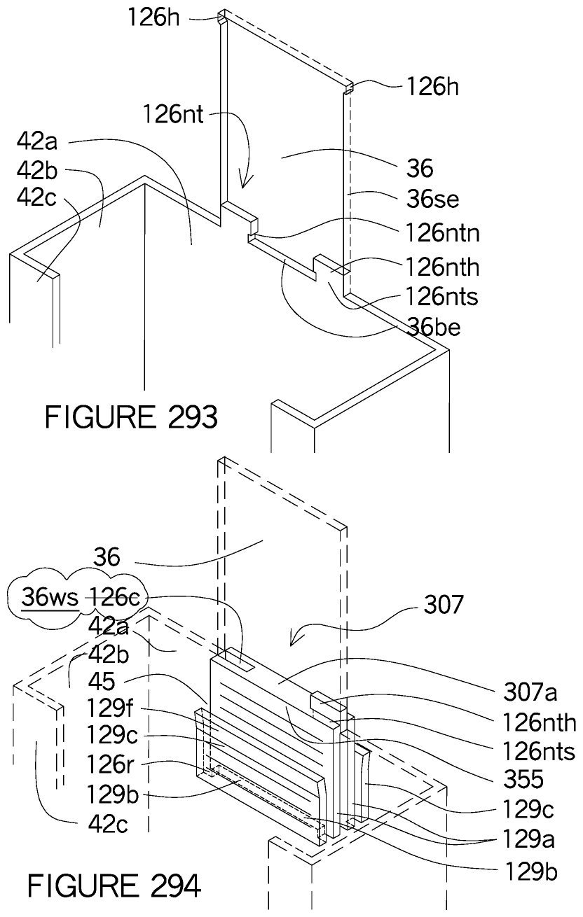

FIG. 293 shows an isometric view of a support member shown as a C channel 42 with a rectilinear shaped hole 36 at the web 42a also shown with hole notches 126h at the hole side edges 36se. The hole bottom edge 36be has two vertical oriented notched-tab shafts 126nts that extend above the hole bottom edge 36be with a notched-tab head 126nth above. The notched-tab head 126nth are slightly longer so that the notched-tab shafts 126nts form a notched-tab notch 126ntn with an indentation between the hole bottom edge 36be and the notched-tab head 126nth. The longer the notched-tab head 126nth the easier the notched-tab head 126nth are to bend as shown in FIG. 287.

FIG. 294 shows the notched-tab 126nt described in FIG. 293 on the right side of the hole 36. The hole bottom edge 36be is shown without the notched-tab 126nt as described above, however the right side shows the notched-tab 126nt extend above a W shaped clip 307. When a W shaped clip 307 is used at a hole 36 having the notched-tab 126nt, the web 307a of the W shaped clip 307 has a clip notch 126c at both sides of the web 307a at the vertical side edges of the hole bottom edge 36be. The notched-tab shafts 126nts and notched-tab heads 126nth are shown in FIG. 293 as extending from the hole bottom edge 36be, however the notched-tab shafts 126nts and notched-tab heads 126nth could also originate at the hole side edges 36se. The W shaped clip 307 has an anchor space 355 on the interior side of the web 307a at the hole bottom edge 36be where the two hook receiver 129 ends extend downward with the first leg 129a extending parallel to the web 42a of the support member then bending outward at the second leg 129b then back upward forming a gap 45 between the first leg 129a and the third leg 129c. When the interior side of the W shaped clip 307 is installed into the hole 36 the first legs 129a of each hook receiver 129 straddle the hole bottom edge 36be and the side edge of the web 307a gets inserted into the side edges of the notched-tab notches 126ntn with the notched-tab head 126nth extending over the exterior dorsal side of the web 307a securing the web 307a to the notched-tab 126nt and the hole bottom edge 36be. In FIGS. 284 & 287 the U shaped spacer brace 302 are installed at an angle allowing the side walls of the flanges 302b and the flange notches 126fg to slide into the hole side edges 36se for an easier connection to the hole 36. The ledge shafts 79s as well as the notched-tab heads 126nth are located adjacent to the hole side edges 36se. FIG. 294 shows notched-tab slot holes 126nts so the U shaped spacer brace 302 with the notched tabs 126nt or ledge shaft 79s fit directly into the notched-tab slot holes 126nts. The three sided notched-tab slot holes 126nts allow the flange notches 126fg to slide directly into the holes side edges 36se. The webg slot hole 36ws at the hole side edge 36se shows the opening having only three sided edges at the web 307a allowing for an easier connection into the hole 36.

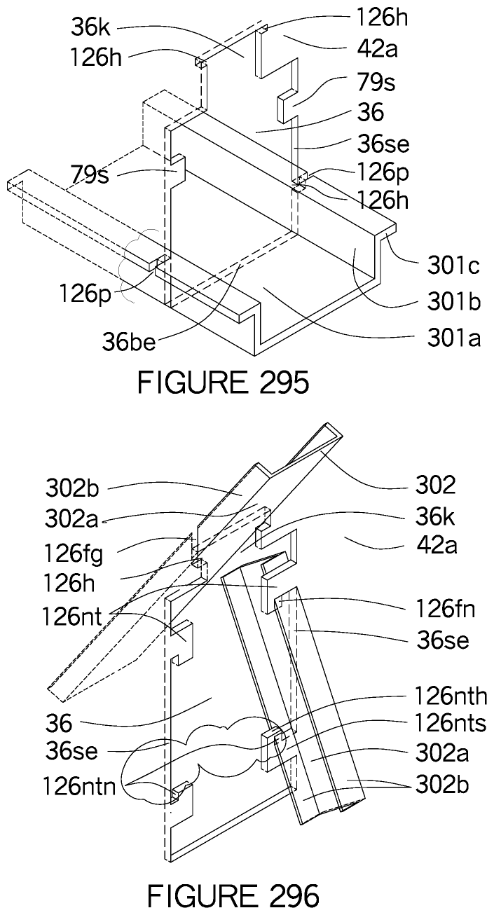

FIG. 295 shows a reverse lip spacer brace 301 with the exterior side of the web 301a resting on the hole bottom edge 36be with the flanges 301b extending upward and the lip 301c extending outward. Above the hole 36 shows a smaller size hole referred to as a key hole 36k where the key hole 36k becomes part of the hole 36. The side edges of the key hole 36k shows hole notches 126h cut into the web 42a where one edge of the hole notch 126h is an extension of the top edge of the key hole 36k. At the upper side of hole 36 shows two ledge shafts 79s that are used in FIG. 296 below. In addition, two additional hole notches 126h are installed on both the hole side edge 36se at the intersection of the lips 301c which have lip notches 126p installed at the outside side edges of the lip 301c. The reverse lip spacer brace 301 shows the horizontal oriented lip 301c with its lip notch 126p installed into the hole notch 126h where the hole side edges 36se are in a vertical orientation. The depth of the lip notch 126p is longer engaging the both planes of the web 42a and the hole notch 126h engages both top and bottom plane of the lip 301c thereby interlocking both vertically and horizontally forming a self-locking connection between the two notches. Before one the two notches are totally secure, the lip notch 126p on the opposing side lip 302c is engaged against the hole side edges 36se so the second lip notch 126p is continually being forced into the hole notch 126h until both lip notches 126p are secured into both the hole notches 126h by completing the self-locking connection of all four notches. The flanges 301b will bent until the lip notches 126p are installed into the hole notches 36h and then return back to their original configuration after being installed into the hole notches 36h. FIG. 283 shows many solutions for connecting adjacent spacer braces together. In FIG. 295 hole notches 126h are shown at the key hole 36k as well as at the hole side edges 36se. Additional pairs of holes notches 126h can be added at a hole 36 or in other locations so adjacent spacer braces can also connect support members together. By adding additional holes notches 126h within the same hole 36, two adjacent reverse lip spacer braces 301 can have their lip notches 126p connected to the same hole 36 using a separate pair of hole notches 126h. On the other hand if the hole notch 126h is larger, two adjacent reverse lip spacer braces 301 with their lip notches 126p can be inverted with the lip notches 126p installed into a wider hole notch 126h opening. In FIG. 358 the hole notches 126h are noted as double height in order to have two horizontal notched-tabs to be inserted into the same hole. In addition, the hole 36 can vary in size and smaller or larger width reverse lip spacer braces 301 can each have the lip notches 126p inserted into the same holes.

FIG. 296 shows a hole 36 and a key hole 36k near the hole top edge 36te. The hole notches 126h on both sides of the key hole 36k shows the width of the hole notch 126h slightly wider to accommodate the flange 302b having an angular orientation of the U shaped spacer brace 302. In addition the U shaped spacer brace 302 at the key hole 36k shows a flange notches 126fg engaging the hole top edge 36te. The self-locking connection is again made, but this time the top and bottom edges of the hole notches 126h at the key hole 36k and the outside plane of the flanges 302b form the self-locking connection. The hole 36 shows two notched-tabs 126nt at each of the vertical hole side edges 36se. A diagonally oriented U shaped spacer brace 302 is installed between the notched tab 126nt on the right side of the hole 36. The U shaped spacer brace 302 has the exterior side of the web 302a abutting the hole side edge 36se and the head 126nth of the notched tab 126nt extending over the flange 302b and where the notched-tab notch 126ntn extend into the flange notch 126fg connecting the notched-tab 126nt against the hole side edge 36se. A flange notch 126fg is shown in the flanges 302b so that flange 302b with its flange notch 126fg can be inserted into the ledge tab 79t and the opposing the web 302a & flange 301b can be pressured so the ledge tab 79t can be inserted into the flange notch 126fg forming another self-locking connection. Previously, ledge tabs 79t are shown with notches 126n or notched-tab 126nt are shown having a notched-tab notch 126ntn. The ledge tabs 79t as shown in FIG. 293 function the same as the notched-tabs 126nt as the key tabs 36kt. Holes 36 are shown with hole notches 36n and lips 302c show lip notches 126p and in FIG. 296 flange notches 126fg are shown.

FIG. 297 shows the self-locking connection between the hook receiver 129 at one end of one U shaped spacer brace 302 and the opposing end of another U shaped spacer brace 302 having the hook tongue 128 at the opposing end. The isometric view shows the U shaped spacer brace 302 abutting the hole 36 where the flanges 302 abut the web 42a on one planar surface at the indentation 302i in the hole side edge 36se and the extension 302e passes through the hole notches 126h occurring at the bottom corners of the hole 36 than passes over the anchor space 355 which is the hole bottom edge 36be and extends downward at the hook receiver 129 which formed a self-locking connection with the hole notch 126h. Since the extension 302e passes into the hole notches 36h, the U shaped spacer brace 302 has to be installed where one side edge of the extension 302e fits into the one hole notch 36h then the opposing side edge of the extension 302e is pressured to fit into the opposing hole notch 36h thereby securing the U shaped spacer brace 302 from moving vertically as well as horizontally within the hole 36. The hook receiver 129 has the first leg 129a extending downward along the web 42a plane, then turning outwardly at the second leg 129b then back upward at the third leg 129c forming a gap 45 between the first and third leg 129a & 129c. The second leg 129b shows receiver notches 126r at both the side edges. The receiver notches 126r at both sides of the second leg 129b function the same the web slot holes 36ws shown in FIG. 294 as they both have the head 126nth of a notched-tab 126nt extending through the holes. The adjacent U shaped spacer brace 302 shows a hook tongue 128 extending downward from the web 302a so that the hook tongue 128 fits into the gap 45 of the hook receiver 129. The hook tongue 128 shows a notched-tab 126nt comprising of the hook tongue 128, two tongue shafts 128s with a tongue tab 128tt extending from the tongue shafts 128s. The tongue tab 128tt is slightly longer so the tongue tabs 128tt can fit into the receiver notches 126r at both sides of the second leg 129b allowing the tongue tabs 128tt to extend over the bottom edge of the second leg 129b forming a self-locking connection between the hook tongue 128 and the hook receiver 129. The hooked tongue tabs 128tt can be long so the hooked tongue tabs 128tt can be bent either at the first or third legs 129a or 129c of the hook receiver 129 or are shorter and have a hook tongue tab-indentation 128ti to connect the hook receiver 129 and hook tongue 128 together.

FIG. 298 is the similar as FIG. 329 except the interlocking self-locking connection is slightly different. The second leg 129b has two receiver slot holes 36rs between the first leg 129a and the third leg 129c and the hook tongue 128 has two corresponding tongue shafts 128s and tongue tabs 128tt that fit into the receiver slot holes 36rs. The length of the hook tongue tab-indentation 128ti will depend how much pressure is required to insert the tongue tab 128tt through the receiver slot hole 36rs. When the tongue tabs 128tt are very long, the tongue tabs 128tt can be bent to secure the tongue tabs 128tt to the hook receiver 129 in lieu of using the hook tongue tab-indentations 128ti to secure the hook tongue 128 to the hook receiver 129. The notched-tab 126nt is slightly different than shown in FIG. 229 as the hooked tongue 128 has tongue shafts 128s having hook tongue tab-indentations 128ti on both sides of the tongue tabs 128tt.

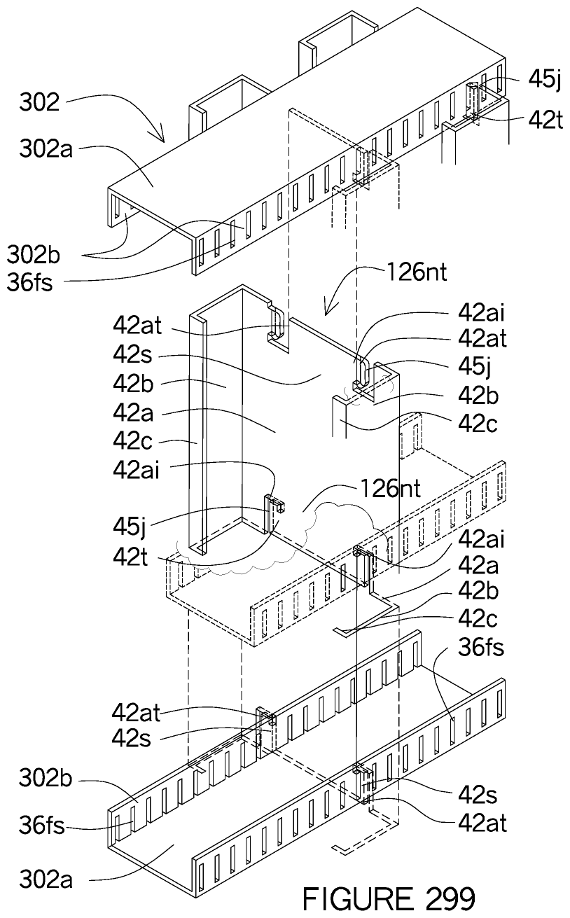

FIG. 299 has a U shape spacer brace 302 at the top and bottom of the support member have the same configuration that is they are both U shaped having two flanges 302b extending from the web 302a with an array of flange slot holes 36fs where the narrow edge of the flange slot holes 36fs are flush with the plane of the internal side of the web 302a. The top and bottom ends of the web 42a of the support member have a J-shape gap 45jt where the gap is a J-shaped. The vertical edge of the J-shape gap 45j is formed by the space occupied by the outside edge of the flange 302b. The internal side of the U spaced spacer brace consists of a web shaft 42s and a web tab 42at where the web tab 42at forms the bottom edge of the J-shape gap 45jt and the web shaft 42s forms the short vertical section of the J-shape gap 45jt and where the web shaft 42s is connected to the web 42a. The J-shaped gap 45j forms a J-shape because the flange 302b fits into the vertical space of J-shaped gap 45jt plus the web tab 42at fits into the slot hole 36s and when the first web tab 42at slides into the slot hole 36s the flange 302b will bend outwardly and the opposite J-shaped gap 45jt will have the opposite side flange 302b also bend until both the web tabs 42at pass through the flange slot holes 36fs allowing the web indentation 42ai to be logged between the interior and exterior side of the flange slot holes 36fs in both flanges 302b forming a self-locking connection between the web tabs 42at in the support member and the slot holes 36s in the U shaped spacer brace 302. If the web tabs 42at are long enough the web tabs 42at can be bent to form a stronger connection between the support member and the spacer brace.

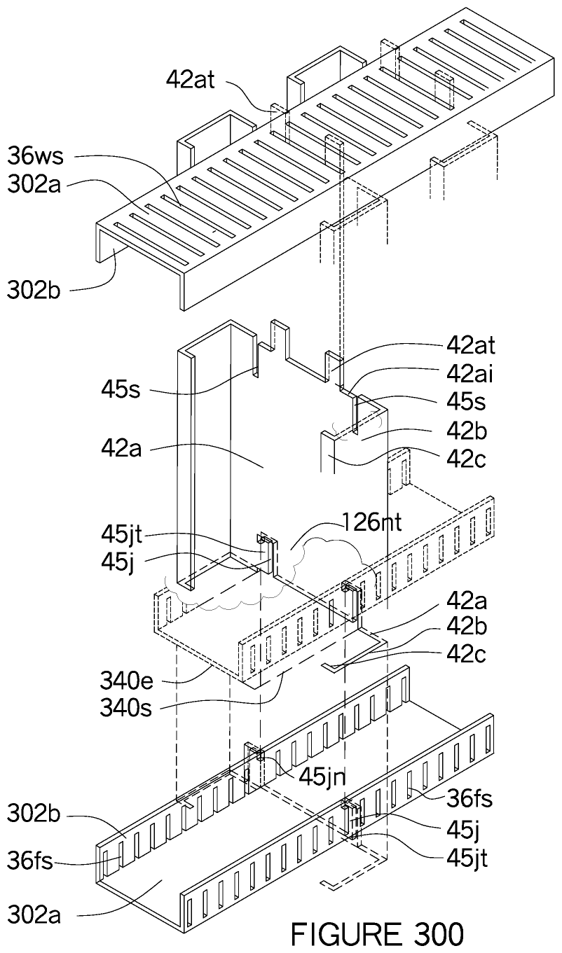

FIG. 300 shows several different ways to form bent tabs. At the top of the C channel web tabs 42at extend from the top edge of the web 42a and having a slight web indentation 42ai where the interior side of a horizontal U shaped spacer brace 302 having web-slot holes 36ws in the web 302a for the web tabs 42at to pass through an be bent horizontally forming another self-locking connection. The bottom end of the C channel showing U shaped spacer brace 302 (shown in solid lines) is the same configuration as FIG. 299 which only allows one J-shaped gap tab 45jt to be bent per U shaped spacer brace 302. Another version of a notched-tab 126nt is shown as a dashed configuration, with the two J-shaped gap tabs 45jt having the J-shaped gaps 45j configured in the same direction. The U shaped spacer brace 302 has the flange 302b inserted into the vertical portion of the J-shaped gap 45j and when the top edge of the flange slot holes 36fs becomes aligned with the hinged side of the J-shaped gap tabs 45jt are bent against the flange-slot holes 36fs forming a self-locking secured connection. The bottom flange and crossing member is showed and explained in FIG. 299 as well as FIGS. 341 & 342 that are similar.

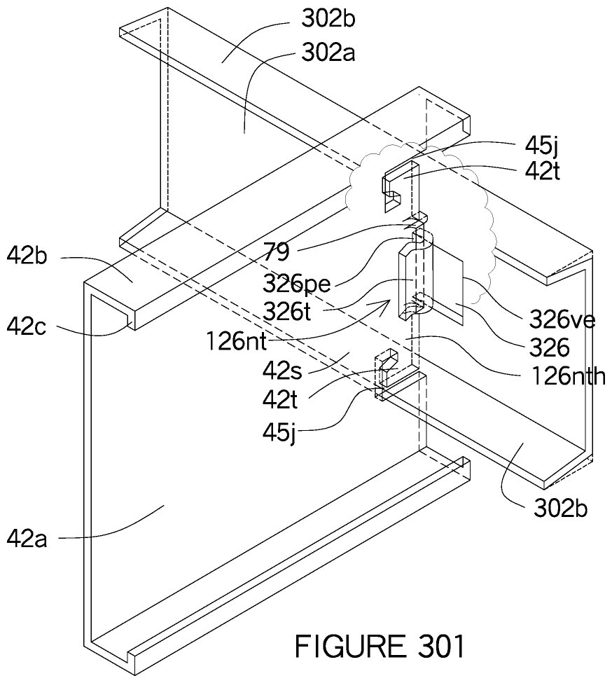

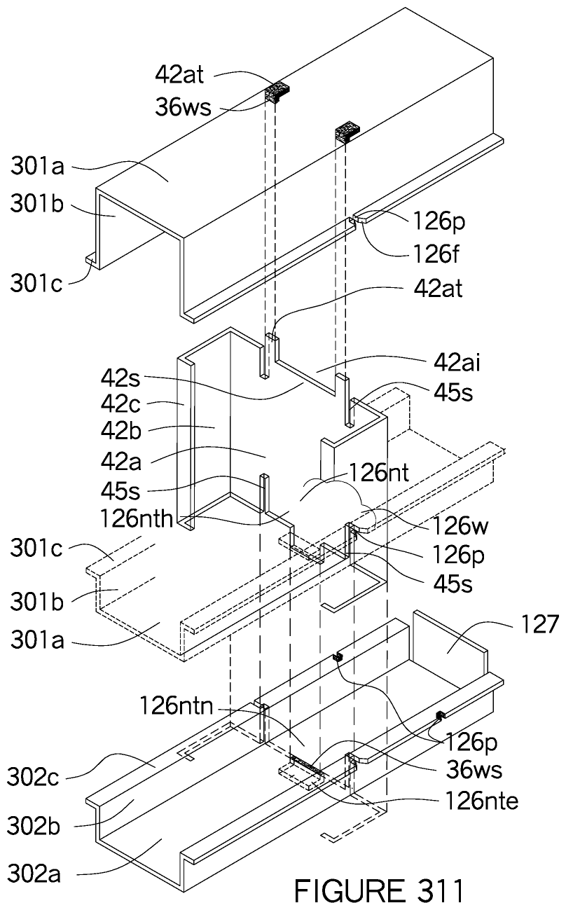

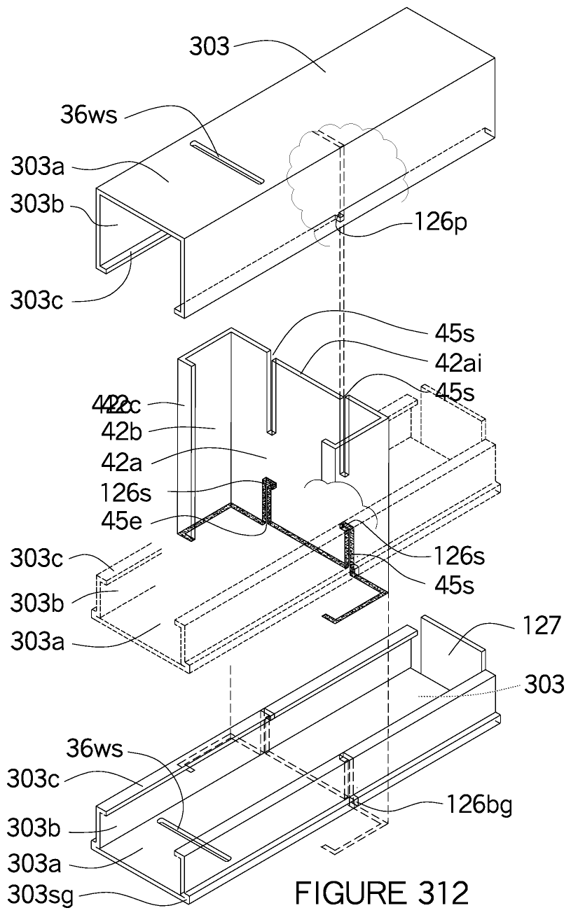

FIG. 301 shows the C channel 42 as a horizontal support member having a web 42a with two flanges 42b and lips 42c with the web 42a having a notched tab 126t at its end intersecting a horizontally oriented stringer. The stringer is a U shaped spacer brace 302 having a web 302a with slight canted flanges 302b extending outwardly at an angle. The notched-tab 126nt at the web 42a is a J-shape gap 45j as previously described in FIG. 300, however in FIG. 301 a ledge 79 has been added to the head 126nth of the notched-tab 126nt. The longitudinal edge of the web 42a is the end of the notched tab 126t has a ledge 79 similar to the ledge 79 in FIG. 292. The ledge 79 corresponds to the wrap-around tab 326 in the web 302a so the pivot edge 326pe is under the ledge 79 and the tab 326t at the vented edge 326ve wraps around the ledge 79 securing the vented edge 326ve against the web 42a. Because the flanges 302b are slightly angled it will be visually easier to install the web tabs 42at into the flange slot holes 36fs in the flanges 302b which again forms the self-locking connections between a stringer shown here as the U shaped spacer brace 302 and a floor or ceiling joist or support member shown here as a C channel 42. A similar J-shape gap 45j is shown in FIGS. 311 & 312 where a C shaped space brace 303 and reverse lip spacer brace 301 are used to secure the support member and stringer together.

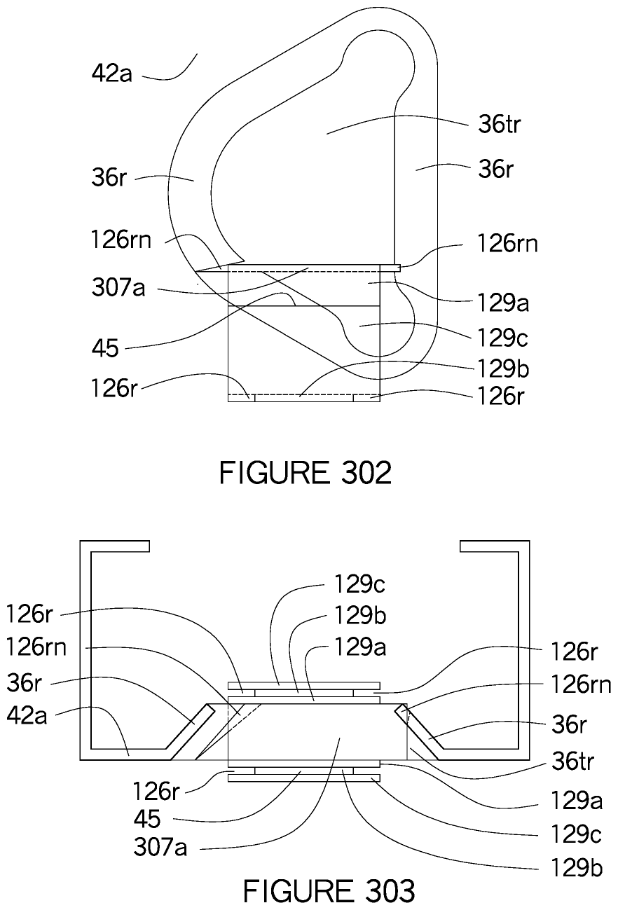

FIG. 302 shows a W-shape clip 307 having a web 308a that extends over the rim 36r at the triangular shaped hole 36tr having a hook receiver 129 shown extending over the interior and exterior side of the C channel 42. The first leg 129a is braced on the exterior side of the web 42a of the support member and the opposite first leg 129a extends over the rim 36a. Both side edges of the web 307a are inserted into the rim notches 126rn at each side of the rim 36r. The hole 36 and the rim 36r are angular in shape making it difficult to be inserted into the rim notches 126rm, however once the side edge of the web 307a is inserted into the diagonal oriented rim 36r the opposite side edge of the web 307a will snap into the rim notch 36rn on the opposing side similar to the method used in FIG. 297. FIG. 302 shows an elevation view of the triangular shaped hole 36tr and the rim 36r along with the hook receiver 129 passing through the triangular shaped hole 36tr. FIG. 303 shows a plane view of the W-shape clip 307 passing through the triangular shaped hole 36tr with the hook receiver 129 extending over the side plane of the web 42a and over the hole rim 36r at the first leg 129a then turning outward at the second leg 129b and then turning upward at the third leg 129c leaving a gap 45 between the first and third leg 129a & 129c where receiver notches 126n are located at their outside edges in FIGS. 297 & 298.

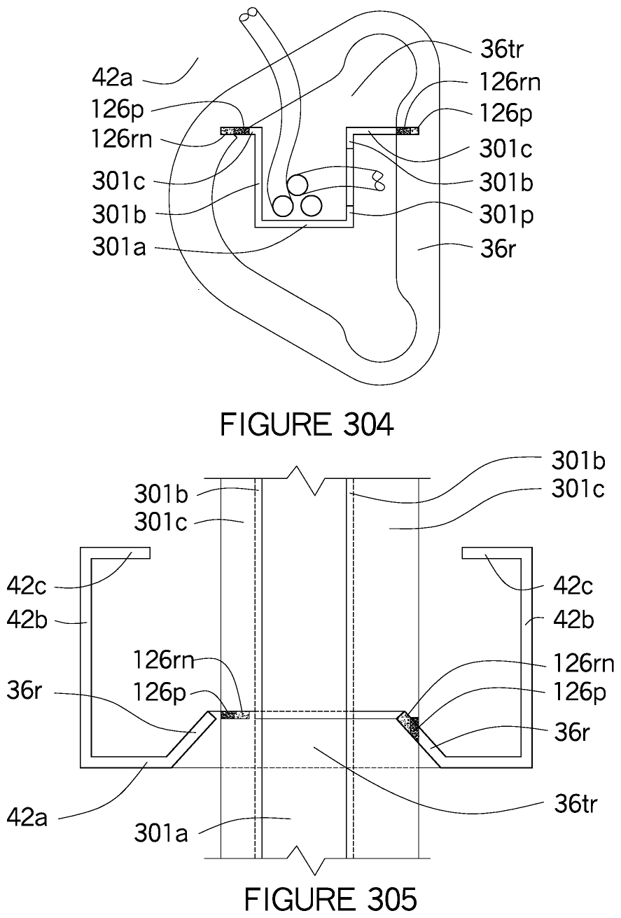

FIGS. 304 & 305 show the same triangular shaped hole 36tr as in FIGS. 303 & 304 except a reverse lip channel 301 is shown with a web 301a and extending flanges 301b and horizontal extending lips 301c where the lips 301c have lip notches 126p that extend into the rim notches 126rm shown in the rims 36r of the triangular shaped hole 36tr. Because the rims 36r are canted inwardly the area occupied by the rim notch 126r are an unusual shape. Again the interlocking self-locking connections are made when the lip notches 126p installed into the rim notches 126rm in the rim 36r by having the vertical oriented rim notches 126rm interlock to the horizontal oriented lip notches 126p creating the interlocking self-locking connections between the two members.

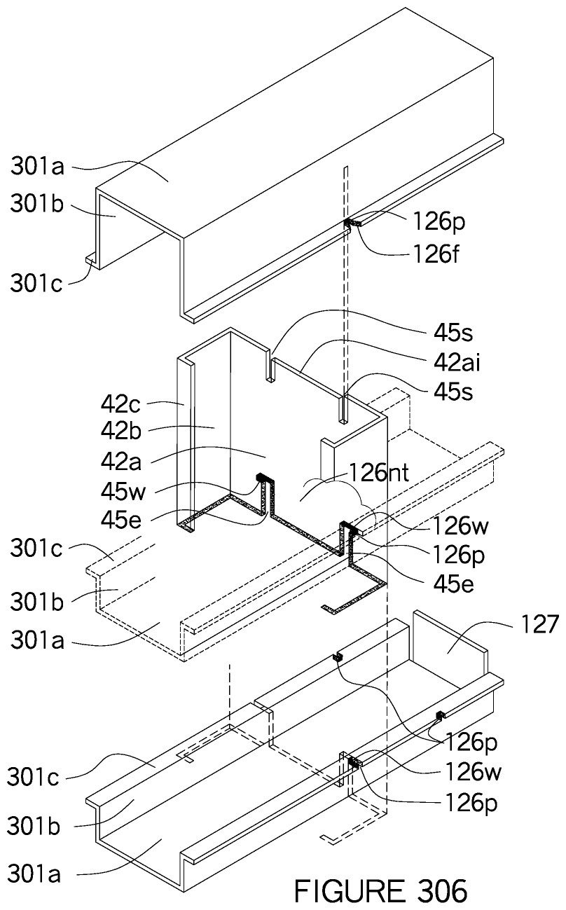

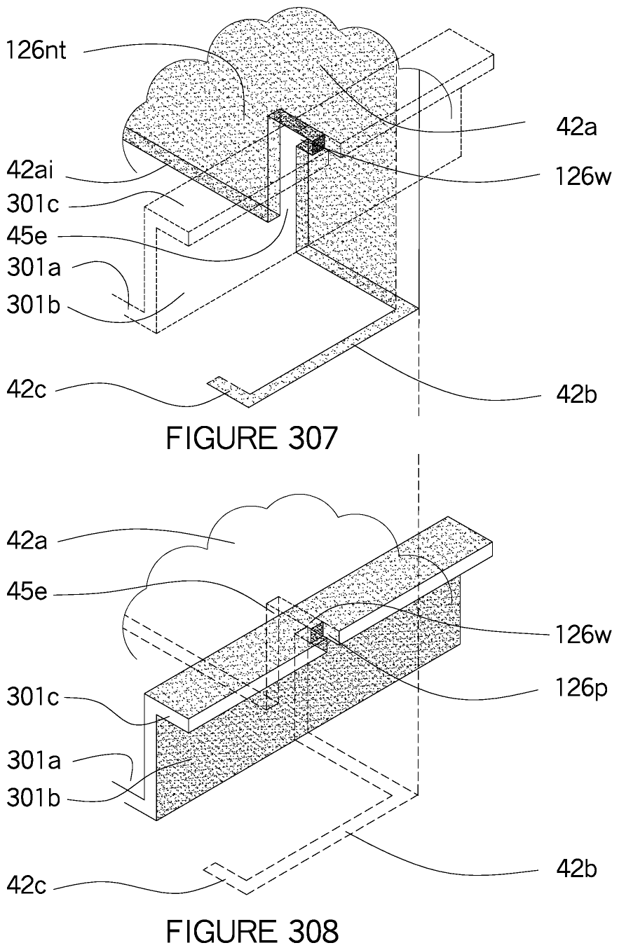

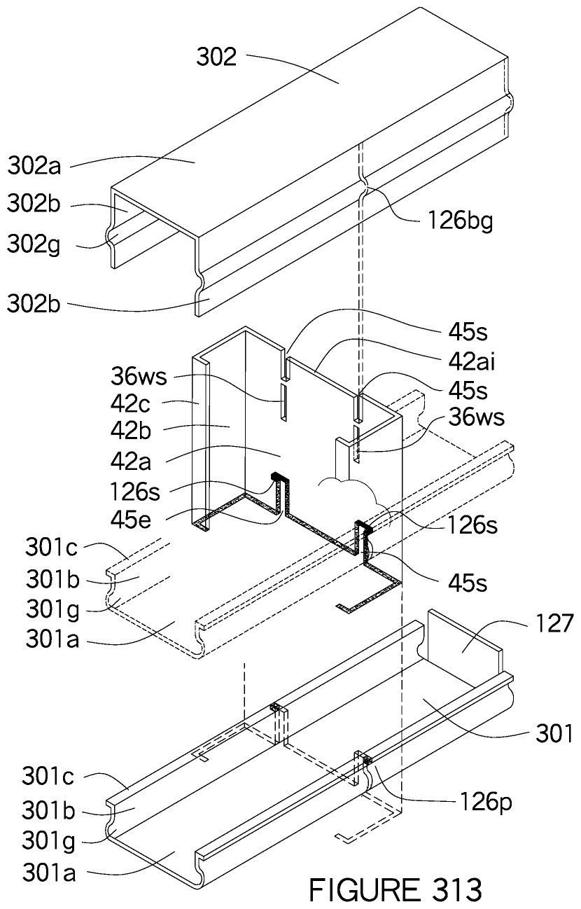

FIG. 306 shows two reverse lip spacer braces 301 connected by a support member shown as a C channel 42 has a web 42a with extending flanges 42b and outwardly extending lips 42c with longitudinal edges of the lips 42c having a lip notch 126p with a flare edge 126f. The reverse lip spacer brace 301 shown at the top edge of the support member is also shown in FIGS. 312, 313 & 333 and the reverse lip spacer brace 301 is shown in FIGS. 306-308 where the exterior side of the web 301a is against the floor. The support member is shown with the web 42a having two L-shaped gaps 126e where the flanges 301b and lip 301c would intersect the web 42a. The web 42a of the support member is narrow at the L-shaped gaps 45e and is wide enough for the flange 301b and lip 301c to slide into. The flange 301b will bent inward when the lip 301c and flange 301b are inserted into the narrow portion of the L-shaped gap 45e, The opposing L-shaped gap 45e will also be inserted at the same time. The lips 301c will become slanted downward as pressure is applied to insert the lips 301c into the L-shaped gap 45e. The lips 301c could be slanted initially in order to more easily fit into the L-shaped gap 45e. Once the lips 301c are completely inserted into the L-shaped gap 45e the lip 301c will flex back into their original position when the lips 301c reach the web notch 126w at the top of the L-shaped gap 45e. The web gap 45w is more clearly shown in FIG. 307 and the lip notch 126p is more clearly shown in FIG. 308. When the lip notch 126p is oriented to the longitudinal direction of the reverse lip spacer brace 301 and the web notch 126w which is oriented in the direction of the C channel 42 cross, the vertical and horizontal notches becomes a self-locking secured connection between the two framing members. The web 42a between the L-shaped gaps 45e at the bottom edge of the support member describes the notched-tab 126nt with the notched-tab notches 126ntn and head 126nth as previously described in other notched-tabs.

The second reverse lip channel 301 shown at the top of the support member in FIG. 306 shows the interior side extending downward toward the C channel 42. The reverse lip spacer brace 301 has the interior side of the web 301a abut the longitudinal edge of the web 42a. The web 42a shows an web-indentation 42ai where the 301a crosses the web 301a of the reverse lip spacer brace 301. The two slide gaps 45s shown at the top end of the web 42a has a narrow width wide enough for the flange 301b to slide into so the lip notch 126p can fit into and wrap around the both side planes of the web 42a of the C channel 42. When the exterior side of the reverse lip spacer brace 301 has the web 301a secured to a floor or structure above, the reverse lip spacer brace 301 is forced to move or bent when a vertical load is applied to the reverse lip spacer brace 301 then the lip notches 126p will slide vertically between side edges of the lip notches 126p at the top reverse lip spacer brace 301 forming a self-locking sliding connection between the two framing members.

FIG. 308 shows an isometric view of a reverse lip spacer brace 301 being terminated at the end of the hole 36 where the web 301a is extended to form a hook finger 127 that extends downward over the hole bottom edge 36be and the two lips 301c are show with lip notches 126p on the near side and the flanges 301b being wrapped around the far side of the hole side edges 36se. The near side of the lip notch 126p and the flap 76 will prevent the reverse lip spacer brace 301 from moving horizontally. The hook finger 127 and lip notch 126p prevent the reverse lip from moving horizontally. The whole notch 126h that support the lip notch 126p prevents the reverse lip spacer brace from moving vertically. Another alternative is the ledge shaft 79s (not shown), but described in FIGS. 304 & 305 that could fit above the lip 301c to secure the reverse lip spacer brace 301 at the lip and the hole bottom edge 36be secured the web 301a. In previous pending applications a ledge 79 (not shown) extends from the hole bottom edge 36be and the hook finger 127 can wrap around the ledge 79 to also secure the reverse lip spacer brace 301 from moving vertically.

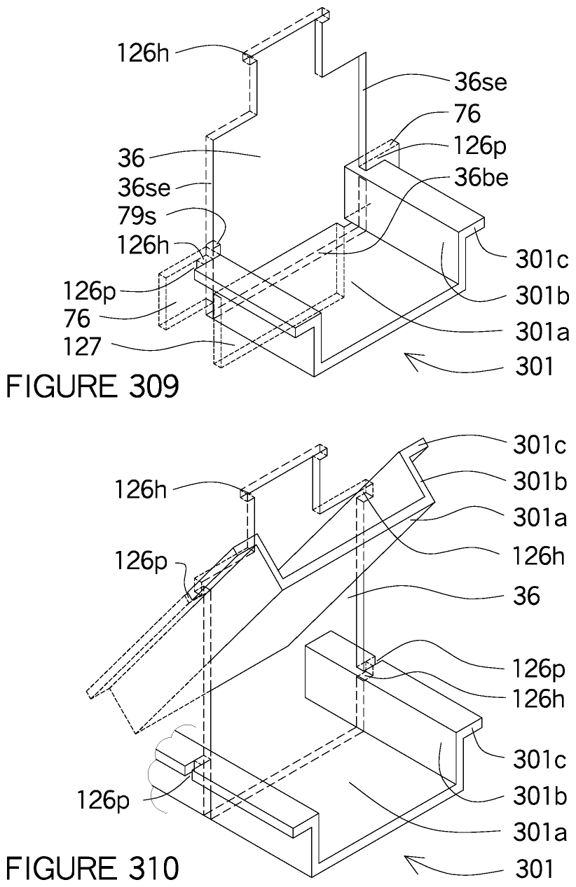

FIG. 309 shows an isometric view of a reverse lip spacer brace 301 installed diagonally passing through the hole 36. The lip notches 126p would typically be deeper since the lip notches 126p have to pass over the web notches 126w into the hole notches 36h so the lip 301c can still be supported in the web notches 126w.

FIG. 310 shows a similar isometric view as FIG. 306 except here a web shaft 42s is the anchor space 355 at the interior side of the reverse lip spacer brace 301 at the top of the support member while bottom of the support member has a web tab 42at at the head 126nth of the notched tab 126nt. The web tabs 42at extends through the web slot holes 36ws and the web tabs 42at can be bent or have a notch installed similar to the head 126nt of a shown in FIG. 290. This usually occurs when metal framing is assembled horizontally then erected vertically after the web tabs 42at are bent. The top reverse lip spacer brace 301 shows two web tabs 42at, while the bottom reverse lip spacer brace 301 shows the notched-tab 126nt as shown in FIG. 306.

The reverse lip channel 301 shown mounted at the floor can also be used at the top of the support members. Other types of spacer braces previously shown in previous pending patents can be installed as a diagonal or using any of the hole notches, rim notches, wrap-around tabs, the tabs from the punch out holes, the hook receiver with hook tongues and hook fingers.

FIG. 312 shows an isometric drawings of a C shaped spacer brace 303 where the exterior side of the web 303a is mounted typically by fasteners (not shown) against the underside of a floor or ceiling with the flanges 303b extending downward and the lips 303c turning ventrally inward and the longitudinal edge of the lips 303c has a lip notch 126p that occurs at a standard array spacing in alignment with the web 42a of an intersecting support member. The bottom of the wall shows another C shaped spacer brace 303 with the exterior side of the web 303 against the floor and connected by fasteners (not shown). The C shaped spacer brace 303 is shown having a sharp bulge 303sg at the intersection of the web 303a and the flanges 303b extending upward being connected to the lips 303c. The sharp bulge 303sg protrudes from the exterior side of the flanges 303b enough to have a bulge notch 126bg that is also in alignment with web 42a of the support member. After the C shaped spacer braces 303 are installed at the floor and ceiling the support members can be installed between the two C shaped spacer braces can now be installed. Each of the ends of the web 42a have L-shape gaps 45e also described as slide gaps 45s that correspond to the flanges 303b in both the top and bottom spacer braces and the web 42a has an web indentation 42ai so all the edges of the web 42a will rest on the interior side of a crossing member or on the same plane as the exterior side of the crossing member. The web 42a at the top of the support member is inserted vertically into slide gap 45s and moved horizontally until the web 42a is inserted into the lip notch 126p. Taking the support member and lifting the support member higher into the interior side of the web 303a, the bottom end of the web 42a of the support member will detect the slide gap 45s at the bottom edge of the support member. Since the C shaped spacer brace 303 at the floor has a lip 303c that is narrower than the slide gap 45s, the flange 303b will flex allowing the lip 303c having a longitudinal edge be allowed to enter the slide notch 126s at the end of the slide gap 45s, securing the lip 303c into the slide notch 126s. Once the web 42a is secured into the slide notch 126s the end of the web 42a of the support member can be installed into the bulge notch 126bg. A bulge notch 126bg can be any type of notch that can protrude from a flange in order form a notch that can be inserted into the web 42a of a support member. At the top and bottom C shaped spacer brace 303 the web 303a has a web slot hole 36s where the web slot hole 36ws is oriented so the length of the web slot hole 36ws is the width of the C shaped spacer brace 303. So when a fastener not shown is installed in the web slot hole 36ws the C shaped spacer brace 303 will be able to slide horizontally in the direction of the web slot holes 36ws.

FIG. 313 is similar to FIG. 312 except a U shaped spacer brace 302 has its exterior side of the web 302a mounted against the ceiling with its flanges 302b extending downward. A rounded shape bulge 302g is shown extending outward from the flange 302b and in the middle of the longitudinal oriented bulge 302g shows a bulge notch 126bg that is in alignment with the web 42a of the support member. The bottom reverse lip spacer brace 301 has the exterior side of its web 301a fastened (not shown) to the floor with its flanges 301b extending upward and its lips 301c extending outward. A bulge 301g is shown extending outward from the web 301a protruding outward from the flange 301b so a bulge notch 126g can be located in the bulge 301g aligned with the web 42a of the support member. Again the top and bottom spacer braces are mounted at floor and ceiling and the support member has its web 42a with its sliding gaps 45s inserted into the flanges 302b & 301b. The bottom end of the support member also has a slide gap 45s, but is shown with a slide notch 126s at the end and aligned so the slide notch 126s is on the flange sides of the slide gap 45s. After the web 42a is inserted in the flanges 301b at the slide gap 45s of the L-shaped gap 45e, then the lip 301c is inserted into the slide gap 45s and adjusted to fit into the two slide notches 126s in both slide gaps 45s and the support member is then slid horizontally so the web 42a can fit into the bulge notches 126bg. One end of the web 302a is bent to form a hook finger 127 at one end of the reverse lip spacer brace 301. At the top of the support member additional vertically oriented web slot holes 36ws are shown and are aligned with the slide gaps 45s above. Should a support member need to be cut shorter, the web slot holes 36ws would then be used as the slide gaps 45s. The left key tab 36k shows a notched-tab notch 126ntn at side edge of the key hole 36k similar to FIG. 293 that shows the notched-tab 126nt with the notched-tab notch 126ntn. A key tab 36k is part of the web 42a along with the shape of the hole 36, while the notched-tab 126nt at the hole side edge 36se is the key tab 36k separated from the web 42a. The key tab 36k and the notched-tab 126nt at the corner of the hole 36 are similar as the key tab 36k is bent at a diagonal while the notched-tab 126nt is bent horizontally.

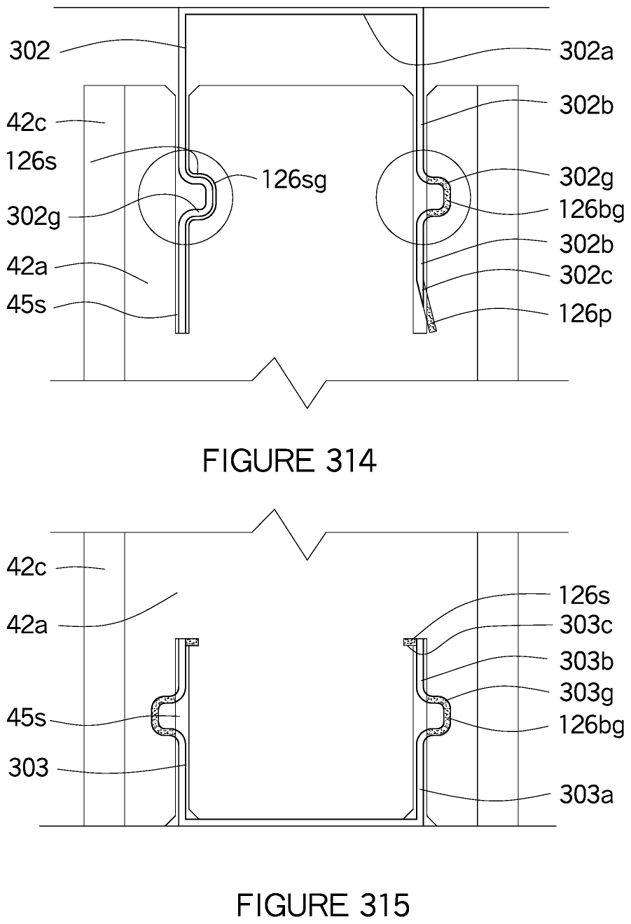

FIG. 314 shows a wall section through a longitudinal U shaped spacer brace 302 where the web 302a has the exterior side mounted against the ceiling with fasteners (not shown) and two flanges extending downward where the right flange 302b shows a bulge notch 126bg projecting from the exterior sides of the flanges 302b. As further explained bugles 302b with bulge notches 126bg are required on both flanges 302b for the U shaped spacer brace 302 to slide vertically in the slide gaps 45s. The bulge 302g have vertical oriented bulge notches 126g located at the slide gaps 45s so the sides of the vertically oriented bulge notches 126bg engage both planes of the web 42a of the support member. The bulges 302g can be located on the interior or exterior side of the U shaped spacer brace 302. The bulge notches 126bg are notched typically 16″ or 24″ on center and can have a flared edge to make it easier to insert into the slide gap 45s which is also shown to have a flared edge at the end of the support member. When bending occurs from a ceiling or floor member above, the slide gaps 45s located in the web 42a of the support members, allows the U shaped spacer brace 302 to move vertically by allowing the support member to slide vertically inward within the slide gaps 45s. On the left side the bulge 302g is shown extending inward on the ventral side of the U shaped spacer brace 302. In this case the left bulge 302g does not have a bulge notch 126bg in the bulge 302g, but a slide bulge notch 126sg is shown on the interior side of the slid gap 45s so the bulge 302g can be inserted into the slide notch 126s. By having the right slide gap 45s have a bulge notch 126bg and the left slide gap 45s having a slide notch 126s, the two different types of notches interlock the support member and the U shape spacer brace 302 together. Also in FIG. 283 41 a lip 302c is shown in lieu of the bulge 302g. When the lip 302c is turned so the lip 302c is extending on the exterior side the spacer brace has been referred to as a reverse lip spacer brace 301, however for explanation purposes the lip 302c has a lip notch 126p shown at the longitudinal end that engages the slide gap 45s similar to a previous FIG. 283.

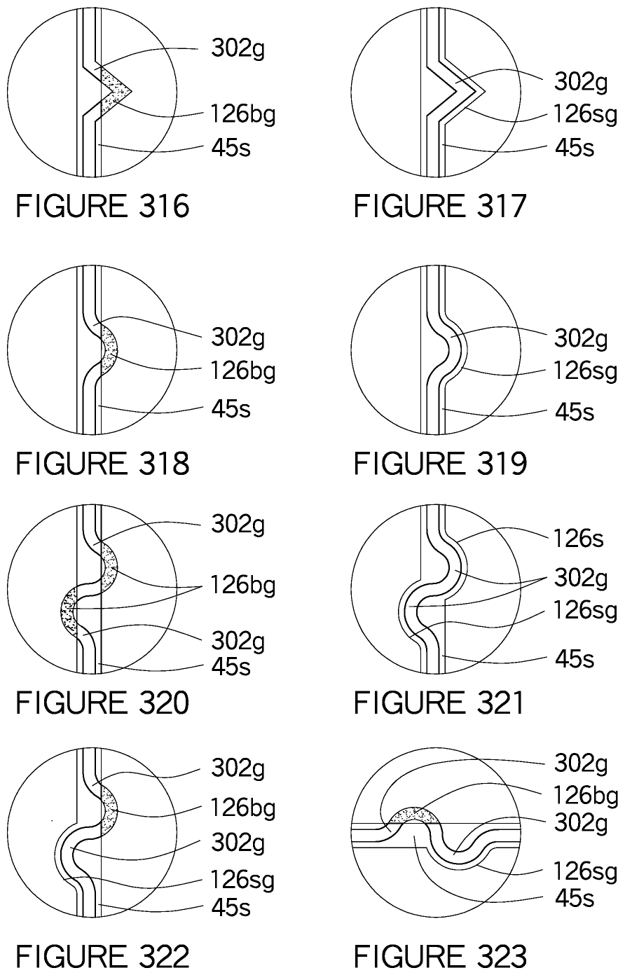

FIG. 315 shows the wall section in FIG. 283 extending to the floor line where the C shaped spacer brace 303 has the web 303a with its exterior side mounted at the floor by fasteners (not shown). The flanges 303b extend upward with the lips 303c extending interior from the flanges 303b. The flanges 303b also have the bulge 303g protruding on the external sides from the flanges 303b and have a bulge notch 126bg occurring typically 16″ or 24″ on center. The support member has the slide gap 45s at the bottom of the web 42a along with a slide notch 126s for the lip 303c to be inserted into. When the web 42a is inserted into the slide gap 45s the lip 303c along with the flange 303b will bend then the bulge notch 126g will engage the side planes of the web 42a at the slide gap 45s until the lips 303c are inserted into the slide notches 126s in the web 42a of the support member.

FIGS. 316-323 shows the cross section of various configurations of bulges that can be used to form the bulge notches 126bg located in the bulges 302g or slide notches 126s located in slide gaps 45s or holes notches 126h located in the holes of the support members. Only one flange is shown in the enlargements, however typically the bulges 302g are located on both flanges of the spacer brace. The bulges 302g can be located anywhere along the plane of the flanges and are located in a slide gap 45s of a web 42a of a support member. A U shaped spacer brace 302 is used where the bulge 302g extends wider than the slide gap 45s so a bulge notch 126bg can be formed on the exterior side of the bulge notch 126bg so both sides of the bulge slide notch 126sg engage both sides of the slide gap 45s. The bulges 302g can be located on either side of the slide gap 45s. FIG. 316 shows a pointed shape bulge 126g having a vertex where the two planes intersect with a bulge slide notch 126sg located where the web 42a of the slide gap 45s intersect the bulge slide notch 126sg and in FIG. 317 the pointed shaped bulge 126g does not have a bulge slide notch 126sg, but instead has a slide notch 126s so the bulge 302g can fit into and will be lodge into the slide notch 126s and will not move vertically within the slide notch 126s. FIGS. 318 & 319 are similar however the bulge 302g is like a half-circle shaped bulge and in FIG. 318 the bulge 302g has a bulge notch 126bg and in FIG. 328 46 the bulge 302g is continuous and the slide gap 45s has a slide notch 126s to fit into. FIGS. 320 & 321 are similar to FIG. 318 that is the bulge 302g is a combination of two bulges 302g as shown in FIG. 318 where one-half of the bulge 302g extends over the internal side of the slide gap 45s and the other half of the bulge 302g extends over the exterior side and both halves have the bulge notch 126bg that extends over the side plane of the slide gaps 45s. FIG. 321 is similar to FIG. 320 having two half bulges 302g each extending over the exterior and interior sides of the slide gap 45s, however both bulges 302g extend into the slide notches 126s of the slide gap 45s. FIG. 322 is similar to FIGS. 320 & 321 as the bulge 302g consist of two half bulges where one half bulge has bulge notch 126bg and the other half bulge has a slide notch 126s. FIG. 323 is the same as FIG. 322 except the slide gap 45s is horizontal rather than vertical and the half bulges are the same as in FIG. 322.

FIGS. 317-322 shows several different configurations of spacer braces crossing and passing through the hole 36 of a support member. At both sides of the key hole 36k shows two ledge tabs 79t that are formed by making a tab forming cut 251 along the hole side edge 36se to the hole top edge 36te. The ledge tabs 79t were previously described in FIGS. 295-298. FIG. 317 shows a U shaped spacer brace 302 that has a bulge 302g that first extends outward forming a half-circle shape then upward forming the flange 302b. The half-circle shape of the bulge 302g corresponds to the half-circle shape of the web-bulge notch 126wg for the bulge 302g to fit into as shown in FIG. 326.

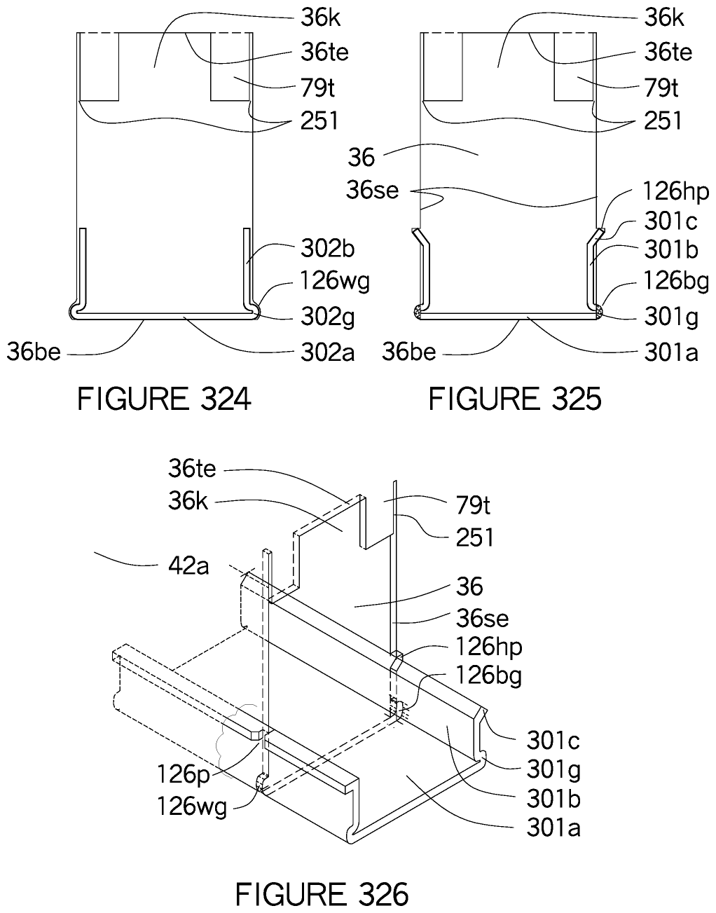

FIG. 325 is similar to FIG. 324 except the space brace is a reverse lip spacer brace 301 however they both have a half-circle shape at the bulge 301g. The bulge 301g is shown as a half-circle being vertically oriented having a bulge notch 126bg on the exterior side of the bulge notch 126bg for the hole side edges 36se to fit into. The flanges 301b extend from the bulge notch 126bg to the lips 301c that extend externally at an angle. The hole lip notches 126hp are vertically oriented and inset into the hole side edges 36se for the longitudinal edges of the lips 301c to be inserted into. The reverse lip spacer brace 301 is inserted into the hole 36 at a slight angle allowing the flanges 301b to bend where the bulge notches 126bg slide into the hole side edges 36se and the reverse lip spacer brace 301 is continually pressed downward until the lips 301c engage the both hole side edges 36se.

FIG. 326 shows a reverse lip spacer brace 301 having a web 301a with bulges 301g at each intersection of the flanges 301b with the left side having a horizontal oriented lip 301c and the right side having an angular oriented lip 301c. The left hole side edge 36se at the bottom corner has a web-bulge notch 126wg as shown in FIG. 324 for the bulge 301g to fit into and the left lip 301c has a lip notch 126p for the hole side edge 36se to fit into. The right side would typically have the same above described combination of self-locking connections on the opposing side of the reverse lip spacer brace 301. Another combination of self-locking connection is shown on the right side which is the same combination as shown in FIG. 325.

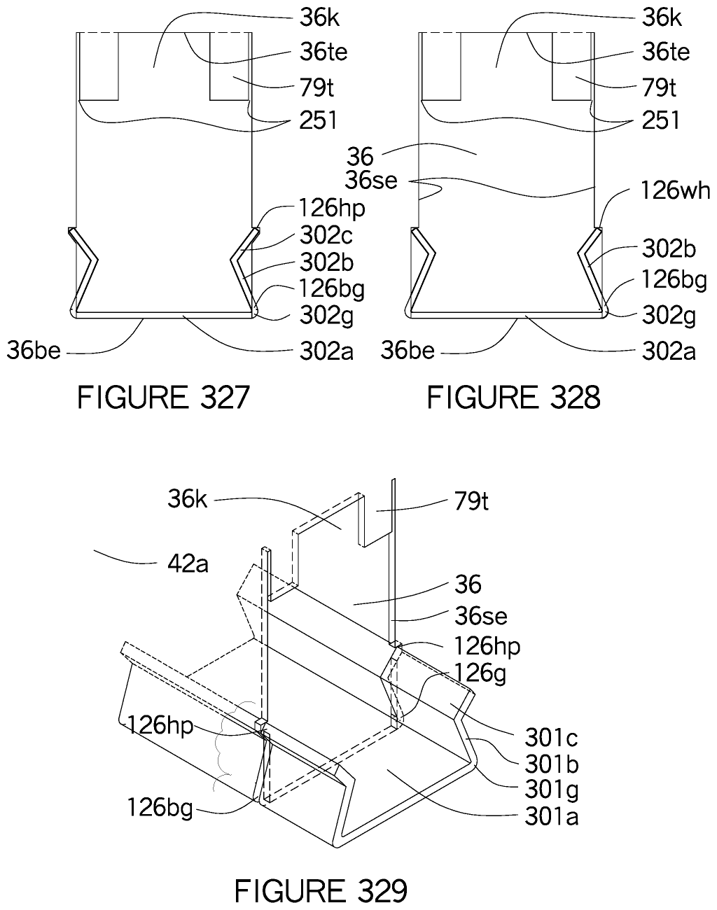

FIGS. 327-329 show a reverse lip spacer brace 301 having a web 301a with bulges 301g on both sides having flanges 301b extending ventrally inward at an angle from the bulges 301g then bending outward forming a lip 301c. In FIG. 327 the reverse lip spacer brace 301 passes through the hole 36 so the bulge notches 126bg intersect the hole side edges 36se and the longitudinal side edges of the lips 301c are inserted into the hole lip notches 126hp forming a self-locking connection with the hole 36. FIG. 328 has the same reverse lip spacer brace 301 along with the bulge notch 126bg at the bulge 301g. The hole lip notch 126hp is shown as a web notch 126w because the hole side edge 36se at the reverse lip spacer brace 301 is recessed rather than shown as a hole lip notch 126hp. The isometric in FIG. 329 has the same profile as FIG. 327.

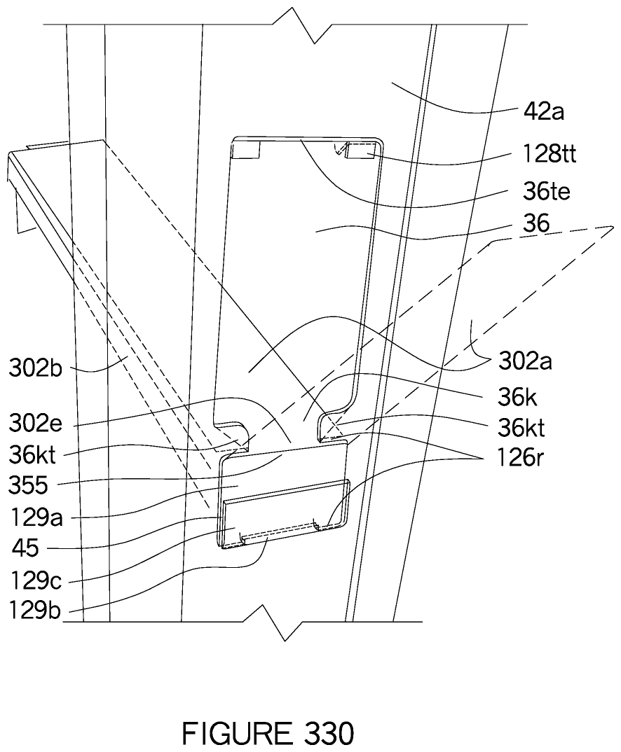

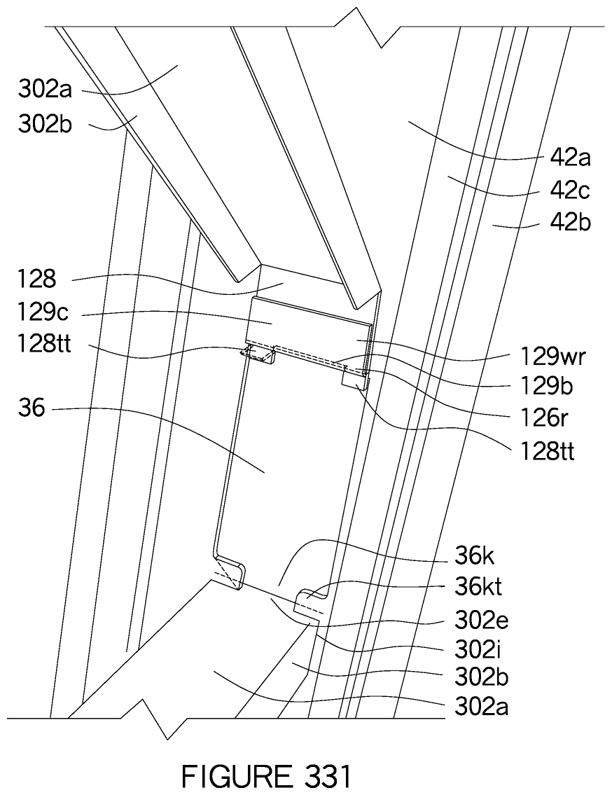

FIG. 330 shows a perspective view of the exterior side of the support member shown as a C channel 42 with a large shaped hole 36 and a key hole 36k below with key hole tabs 36kt on both sides of the key 36k. A U shaped spacer brace 302 with the exterior side of the web 302a facing upward and the extension 302e extending through the key hole 36k with the extension 302e and the flanges 302b abut the interior side on the web 42a. The extension 302e has receiver notches 126r on both side edges for the key tabs 36kt to fit into. The first leg 129a of the hook receiver 129 and the extension 302e abuts the interior side of the web 42a and the first leg 129a is bent inward downward against the exterior side plane of the web 42a. The second leg 129b extends away from the web 42a and is then bent vertically leaving a gap 45 between the first leg 129a and the third leg 129c. The second leg 129b has receiver notches 126r on both side edges similar to the hook receiver in FIG. 331. The key hole tabs 36kt form a triangular shape because the key tabs 36k are bent at an angle shown as a dashed line at the corner edges of the hole 36 and the edge of the key tabs 36kt where the extension 302e intersects the key tabs 36kt. At the hole top edge 36te two tongue tabs 128tt are shown extending downward from the hook tongue 128 shown in FIG. 330 with the right tongue tab 128tt bent.

FIG. 331 shows the interior side of the C channel 42 shown in FIG. 339 and the lower edge of the hole 36 shows the exterior side of a U shaped spacer brace 302 extending through the key hole 36k with the key-tabs 36kt shown ready to be bent. At the hole top edge 36te shows a hook receiver 129 shown as a web hook receiver 129wr where the exterior side of the web 42a is the same as the first leg 129a of a hook receiver 129. The second leg 129b is a continuation of the web 42a bent perpendicular to the web 42a and then bent vertically leaving a gap 45 between the third leg 129c and the web 42a. The second leg 129b has receiver notches 126r at both side edges for tongue tabs 128tt to pass through. The web hook receiver 129wr shows a U shaped spacer brace 302 with its hook tongue 128 extending into the gap 45 of the web hook receiver 129wr with its tongue tabs 128tt extending through the receiver notches 126r and where the left tongue tab 128tt is bent forming a secure self-locking connection between the U shaped spacer brace 302 and a web hook receiver 129wr.

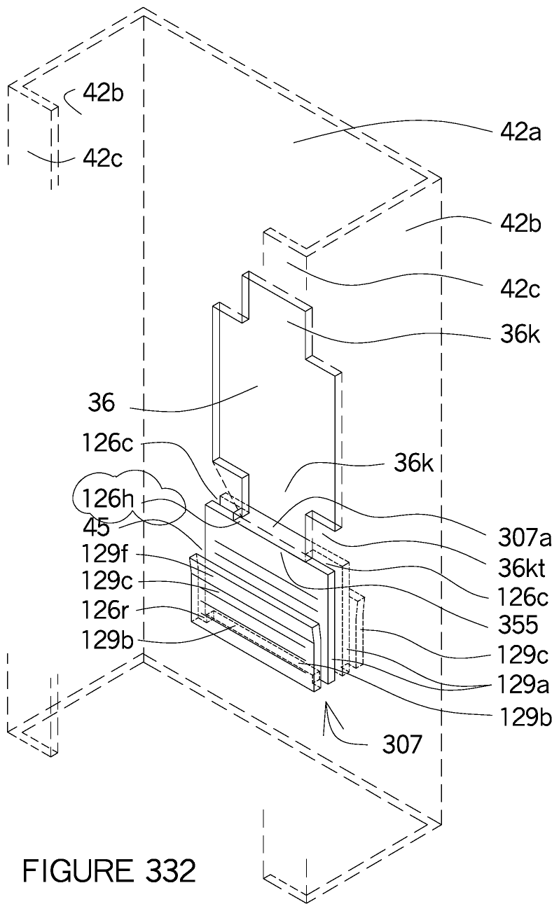

FIG. 332 shows an isometric view of a W-shaped clip 307 having a hook receiver 129 extending over exterior and interior sides of the web 42a of the C channel 42 and where the first leg 129a is against the plane of the web 42a and the second leg 129b extends outward with the third leg extending upward leaving a gap 45 between the first and third legs 129a & 129c. The web 307a of the W-shaped clip 307 shows clip notches 126c on both side edges of the web 307a for the key tabs 36kt to extend through the clip notches 126c to fit through and upon the interior side of the web 307a being secured into the anchor space 355, the key tabs 36kt are bent at an angle of least resistance allowing the W-shaped clip 307 to have a self-locking connection into the key hole 36k.

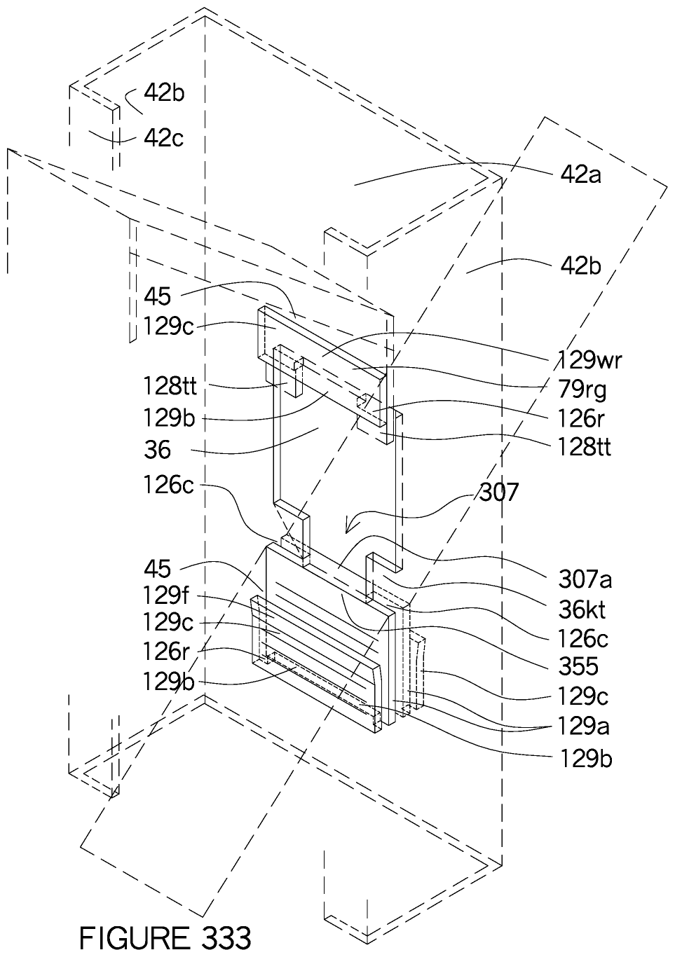

FIG. 333 shows an isometric view of the C channel 42 with the same W-shaped clip 307 shown installed at the key hole 36k as shown in FIG. 341 and the web hook receiver 129w as shown in FIG. 331. At the top of the hole 36 shows a web hook receiver 129wr that is formed from the web 42a of the C channel 42. When the hole 36 is manufactured the center section of the hole 36 is removed, however for a web hook receiver 129wr the first leg 129a is the web 42a of the C channel 42 and the second leg 129b and third leg 129c is the cut-away area of the web 42a that is discarded to create the hole 36. Therefore the second leg 129b is bent perpendicular to the web 42a with the third leg 129c extending upward leaving a gap 45 between the web 42a and the third leg 129c. A receiver notch 126r is installed at both the side edges of the second leg 129b of the web hook receiver 129wr for the two tongue tabs 128tt that are extending into the receiver notches 126r from the U shaped spacer brace 302 shown dotted.

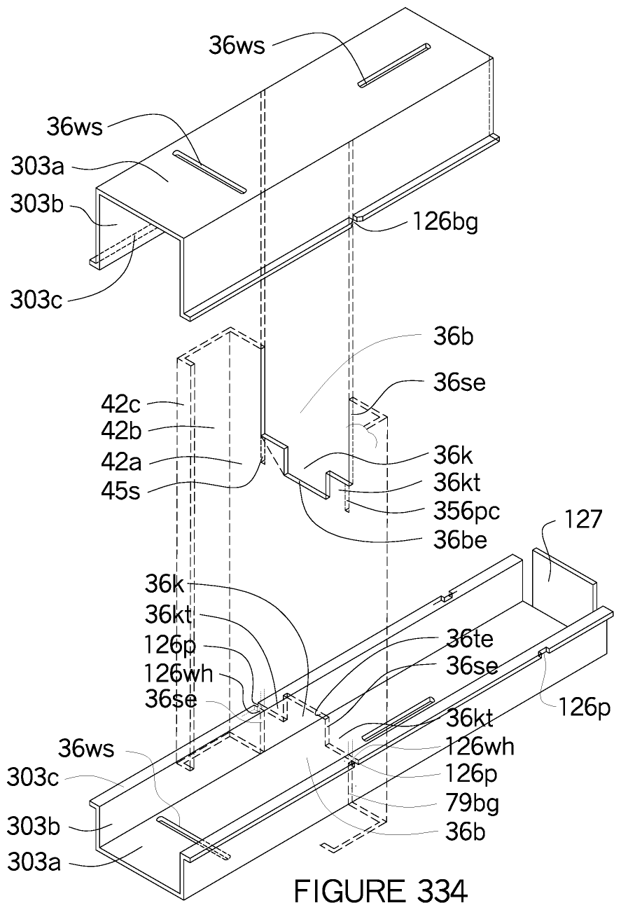

FIG. 334 is similar to FIG. 306 except a bracing hole 36b is shown between the previously described slide gaps 45s and the web indentation 42i is now shown as a bracing hole 36b with a key hole 36k and two key tabs 36kt form the hole bottom edge 36be. When the flange 303c from the reverse lip spacer brace 303 extends to the bottom of the slide gap 45s the web 302a would be flush with the exterior side of the reverse lip spacer brace 303. To form a recess base at the top or bottom of the metal framing the slide gap 45s is required to be shorter than the flange 303b then the flange 303b will extend beyond the top and bottom edge of the support member. The reverse occurs at the bracing hole 36b at the lower bottom edge of the web 42a where the key hole 36k and the two key tabs 36kt form the hole top edge 36te. with the side edges of the key hole 36k being the side edges of the key tabs 36kt. The bottom edge of the key tabs 36kt in the bottom bracing hole 36b shows a web-hole notch 126wh at both side edges of the bracing hole 36b for the lip notches 126p at the longitudinal side edge of the lips 303c for the reverse lip spacer brace 303. The web 303a shows web-slot holes 36ws extending in both a width and longitudinal direction for fasteners (not shown) to be installed into a floor.

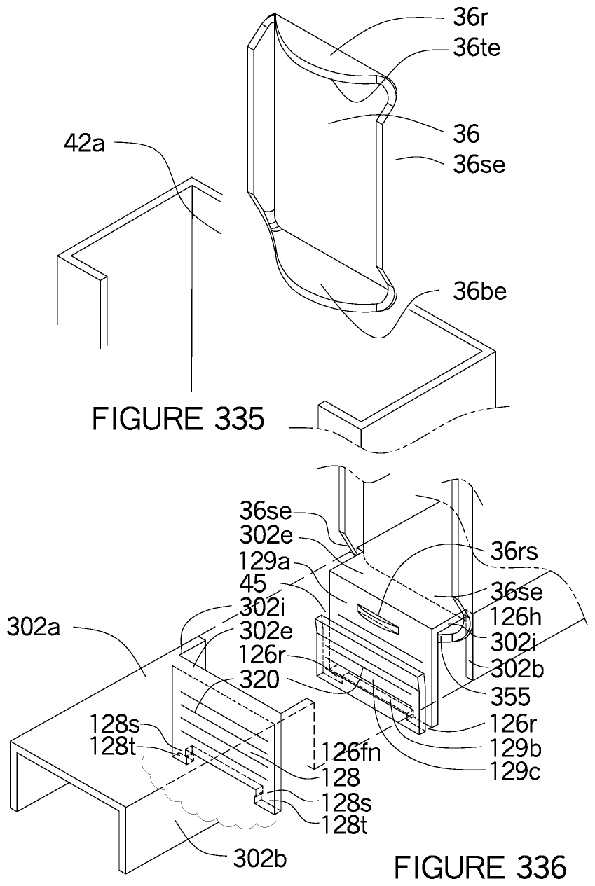

FIG. 335 shows a rectilinear shaped hole 36 having a continuous rim 36r extend from the web 42a of the support member and where the corners have a short depth at the rims 36r. FIG. 336 shows a U shaped spacer brace 302 extending through a hole 36 shown similar to the U shaped spacer brace 302 in FIG. 283, however the hole bottom edge 36be in FIG. 335 has an irregular shape configuration. The hook receiver 129 is shown extending over the irregular shape of the hole bottom edge 36be due to the shape of the rim 36r. The first leg 129a of the hook receiver 129 shows a receiver slot hole 36rs so the rim 36r can fit into. If the hook receiver 129 extends through the hole 36 in reverse, the flanges 302b would have notches 126 at the end side edges of the flanges 302 for the rim 36r could fit into will the hook receiver 129 would have extended over the hole bottom edge 36be against the web 42a. The rims 36r are irregular in shape allowing the rim 36r to extend through the receiver slot hole 36rs forming another similar self-locking connection.

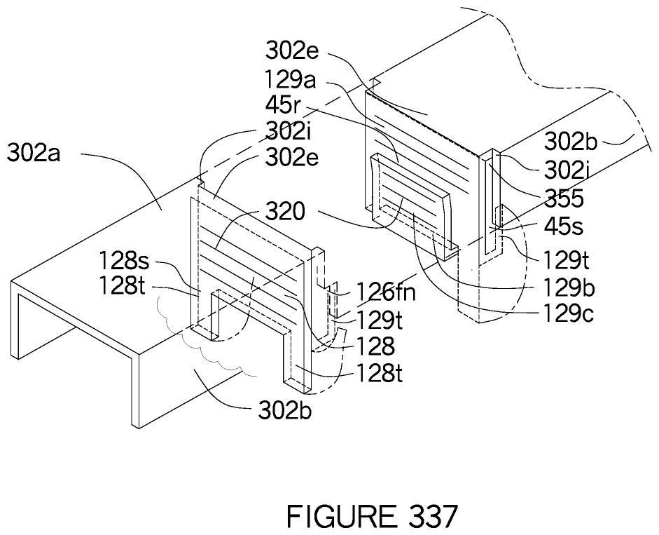

FIG. 337 shows a U shaped spacer brace 302 with it exterior side facing upward having a hook receiver 129 at the end with an adjacent U shaped spacer brace 302 having its hook tongue 128 ready to be connected to each other. In FIG. 283 a similar connection occurs between the hook tongue 128 fits into the hook receiver 129, except here the hook receiver 129 is not required since the hook tongue tabs 128t wrap around the bottom edge of the first leg 129a of the hook receiver 129. The hook tongue 128 still fits into the gap 45 between the first and third legs 129a & 129c, however in lieu of shorter tongue tabs 128tt the tongue tabs are longer and extend around the hook receiver tabs 129t.

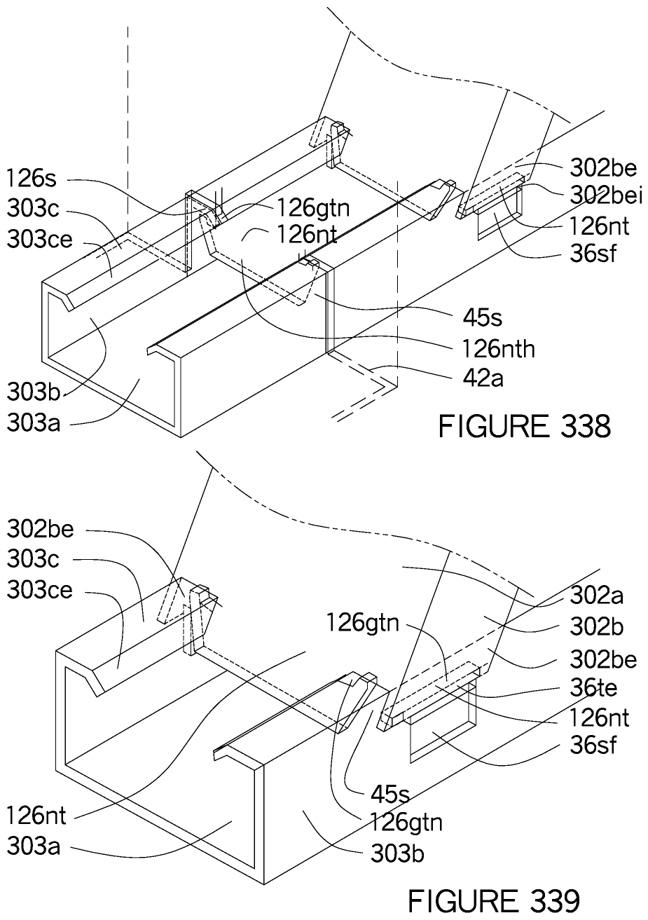

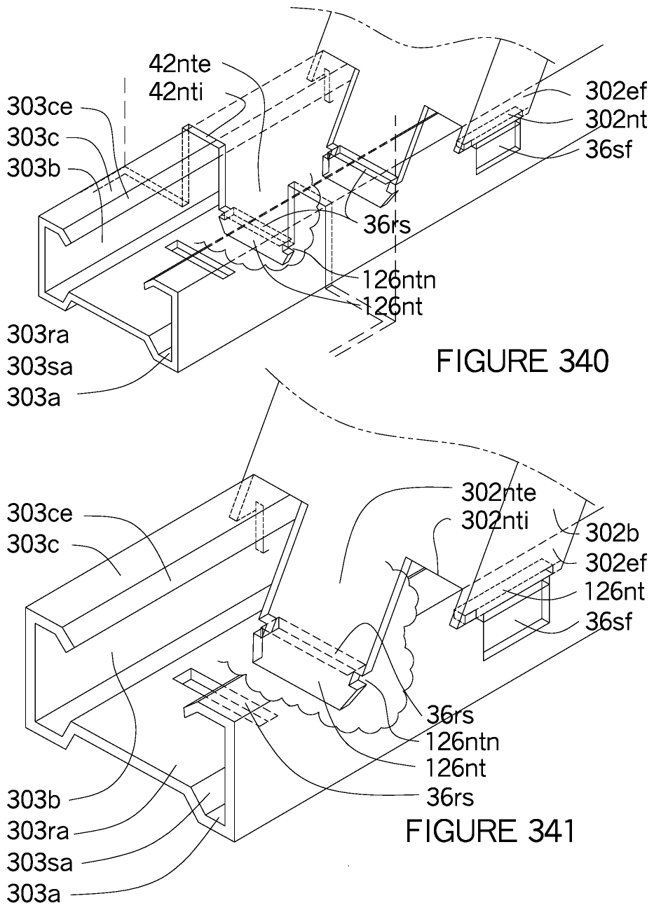

FIG. 338 shows an enlargement of FIG. 339 where the diagonal oriented framing member shown as a U shaped spacer brace 302 is installed into the horizontal C shaped spacer brace 302. The diagonal oriented U shaped spacer brace 302 is slightly wider than the horizontal oriented C shaped spacer brace 303 so the extended flanges 302be are flush with the exterior side of the flanges 303b. The extended flanges 302be form the beginning side of the notched-tabs 126nt so the extended flanges 302be can be bent to fit into the flange slot holes 36sf. The extended flanges 302be have an indentation 302bei at the hole top edge 36te so the head 126nth of the notched-tab 126nt can fit into and be secured at the flange slot hole 36sf. The web 302g of the diagonal U shaped spacer brace 302 has the same or similar notched-tab 126nt as described in FIGS. 340 & 341.

FIG. 340 is similar to FIG. 338 as they both show a vertical oriented C channel 42 and a diagonal oriented U shaped spacer brace 302 intersecting a horizontal oriented C shaped spacer brace 303. FIG. 340 shows the horizontal oriented C shaped spacer brace 303 having a raised web 303ra with sloped sides 303sa; however the web 303a is still resting on the exterior side against a floor. The raised web 303ra shows a raised slot hole 36rs oriented to be aligned parallel to the web 42a of the support member. The notched-tab 126nt starts as a notched-tab extension 42nte at the web 42a of the support member. The notched-tab extension 42nte is shown having an indentation 42nti that is indented around the lip 303c and the lip extension 303ce. The notched-tab extension 42nte has a notch 126ntn where the notched-tab 126nt intersects the raised slot hole 36rs and the head 126nth of the notched-tab 126nt extends through the raised slot hole 36rs. FIG. 340 also shows a similar diagonal oriented U shaped spacer brace 302 intersecting the horizontally oriented C shaped spacer brace 303 as shown in FIGS. 338 & 339.

FIG. 341 shows an enlarged isometric view of the diagonal oriented U shaped spacer brace 302 intersecting the C shaped spacer brace with the raised web 303ar. The web 302a has an indentation 302nti at the lips 303c and extended lips 303ce with the web 302a having an extension 302nte at the start of the notched-tab 126nt. The notched-tab 126nt at the raised slot hole 36rs has a notch 126ntn at the raised slot hole 36rs with the head 126nth extending through the raised slot hole 36rs to the exterior side of the raised web 303ra of the C shaped spacer brace 303.

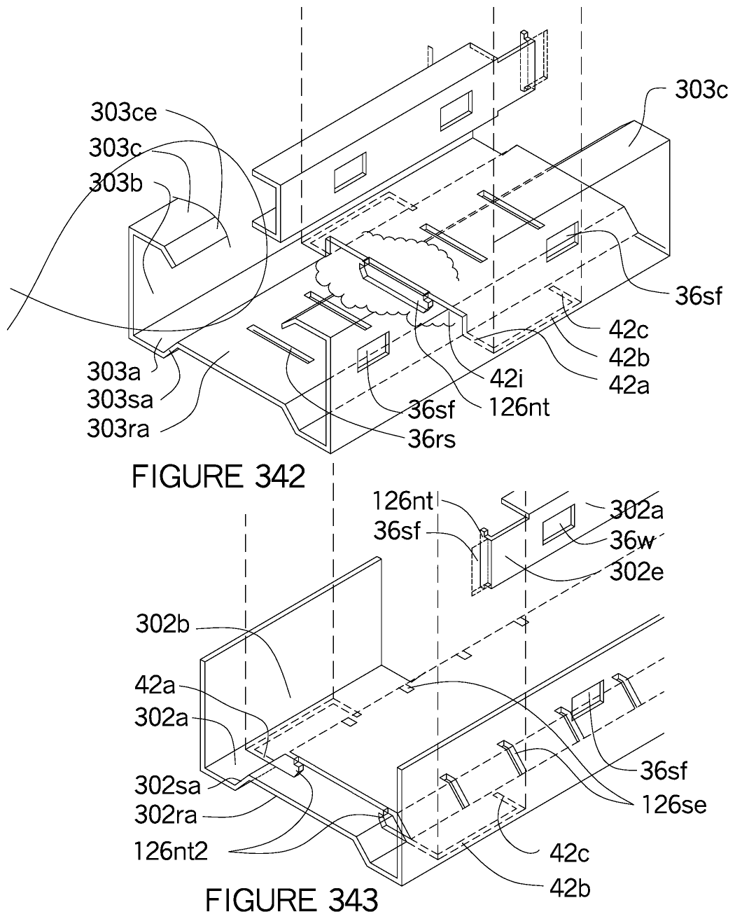

FIG. 342 also has the support member shown as a C channel 42 intersect the C shaped spacer brace 303 where the web 303 has a raised web 303ra with raised sloped sides 303sa, however here the left side of horizontal spacer brace is shown as a U shaped spacer brace 302 where the lips 303c & extended lips 303ce are removed and the right horizontal spacer brace is shown as a C shaped spacer brace 303 with lips 303c and extended lips 303ce. On the left side of the horizontal spacer brace the web 42a for the support member rests on the interior side of the web 303a while the right side the web 42a would be required to have an indentation 42i (but not shown here). Depending on the width of the vertical support member and the width of the horizontal spacer brace the bearing point or the anchor space 355 would vary. Should the support member fit into the interior side of the flanges the bearing point would be at the web 42a adjacent to the flanges and at the head 126nth of the notched-tab 126nt. When the raised slot holes 35rs are located in the middle of the raised web 303sa or 302sa, the notched-tab 126nt is aligned with the raised slot holes 36rs and the notches 126ntn of the notched-tab 126nt as similarly described in FIG. 352. FIGS. 289, 342 & 343 show vertical oriented slot holes 36s at the flanges of adjacent support members where a U shaped spacer brace 302 is shown spanning between adjacent support members. The U shaped spacer braces 302 are shown having notched-tabs 126nt extending from their webs 302a. The flanges 302b abut the webs 42a or lips 42c of the support member and the web extension 302e are part of the notch 126ntn of the notched tab 126nt as the web extension 302e wraps around the hole side edge 36se and the head 126nth becomes wider than the slot hole 36s and therefore becomes a notched-tab 126nt when extended through the slot hole 36s. Even though FIGS. 296 & 297 or FIGS. 342 & 343 show the notched-tab 126nt at the top or bottom edges of the web 42a in the support members, a smaller width U shaped spacer brace 302 with flange slot holes 36fs can be inserted into the hole 36 having the notched-tab 126nt extending from the holes bottom edge 36be. The notches 126ntn would be inserted from the bottom side of the U shaped spacer brace 302 rather than from above as shown in FIGS. 342 & 343.

FIG. 343 is similar to FIG. 341 as the horizontal spacer brace can be U shaped or C shaped as described above. FIG. 342 has sloped edge notches 126se at the raised sloped sides 303sa where the sloped edge notches 126se are notched at the sloped edges and slightly indented into the raised web 303sa to give additional bearing to the web 42a which is the beginning side of the notched-tab 126nt, but in this case it is a one-half notched-tab 126nt2 where one-half of the notched-tab 126 is located in the sloped edge notches 126se. The web 42a is the beginning side of the one-half notched-tab 126nt2 with the notches 126n being inserted into the side edge of the sloped edge notches 126se and the finish side being at the same plane as the interior side of the web 303a. Therefore notches 126n form the same function as the two one-half notched-tabs as the notches 126 secures two crossing members together.

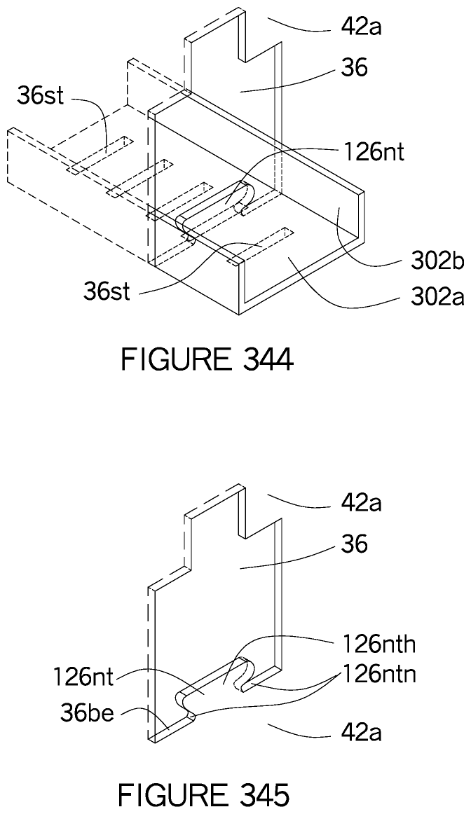

FIG. 344 is similar to FIGS. 290 & 291 except only one notched-tab 126nt is shown along with one slot-tab hole 36st. The notched-tab 126nt also shown in FIG. 345 is shown having rounded edges to be inserted easier into the slot-tab holes 36st.

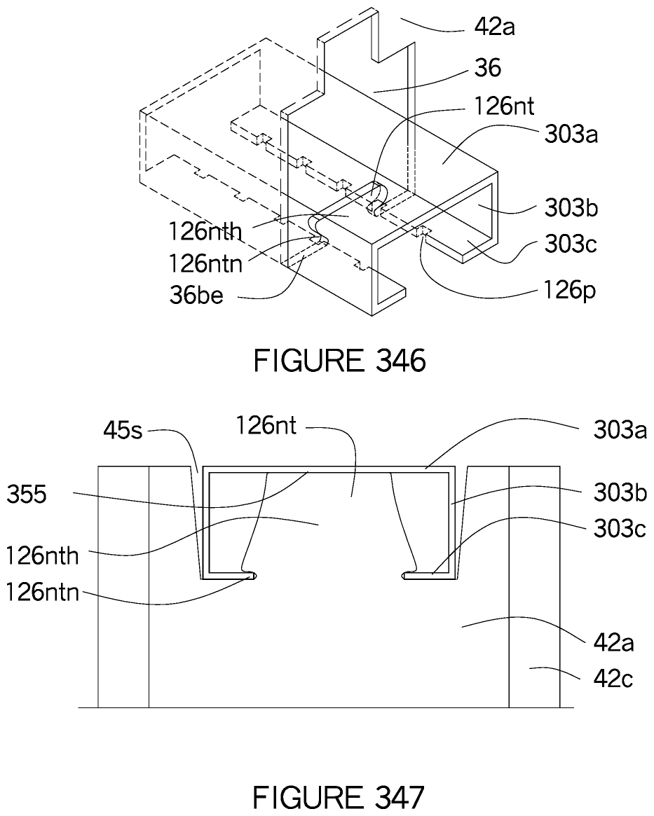

FIG. 346 is similar to FIG. 345 in spacer brace 14 (a previous application), however the C shaped spacer brace is smaller and passes through the hole 36 in a support member. The C shaped spacer brace is shown having the exterior side of the lips 303c supported on the hole bottom edge 36be with the side edges of the lip 303c extending against the notch 126n of the notched-tab 126nt. If the C shaped spacer brace 303 is required to be fixed a lip notch 126p needs to be installed so the C shaped spacer brace 303 will not be allowed to slide horizontally.

FIG. 347 is a sectional view but similar to FIG. 339 in the previous application, however the exterior side of the web 302a of the U shaped spacer brace 303 is shown even with the top edge of the support member and the notched-tab 126nt has it top edge being the anchor space 355 for the interior side of the web 303a to rest on. In addition the flanges 303b extend into the web-gap 45w allowing the lips 303c to flex and become engaged into the notch 126n of the notched-tab 126nt.

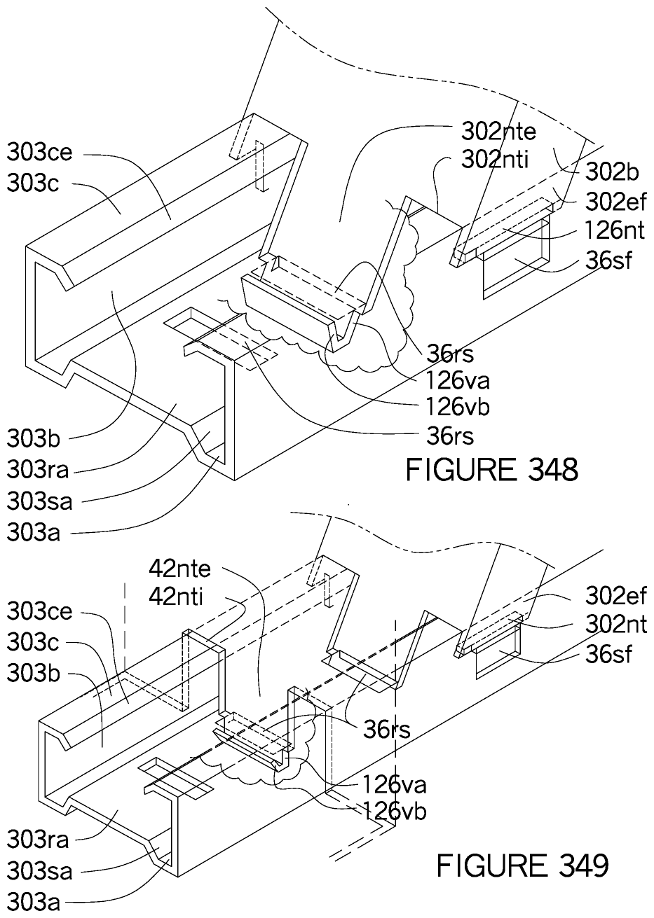

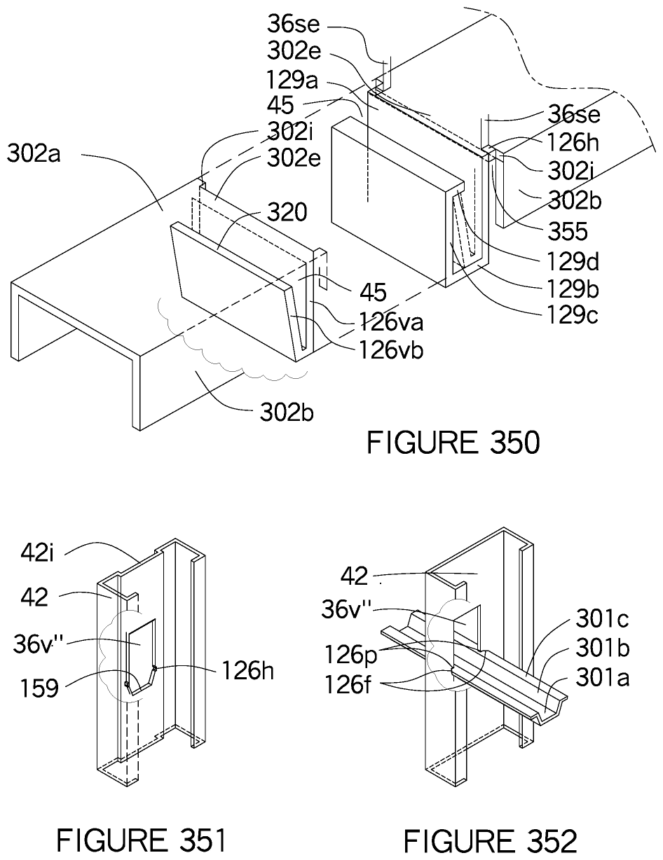

FIGS. 348 & 349 are similar to FIGS. 340 & 341 in spacer brace 14 (previous application) where the notched-tab 126nt extends through the raised slot hole 36rs, however in both figures the notched-tab 126nt is a V-shaped notched-tab 126v where the first leg 126va extends from the notched-tab extension 126nte but is narrower than the length of the raised slot hole 36rs forming the top edge of a notch type of connection. The second leg 126vb of the V-shaped notched-tab 126v is angled back in the direction of the raised slot hole 36rs so the end of the edge of the second leg 126vb abut the exterior side of the C shaped spacer brace 303 at the web 303a. Since the V-shaped notched-tab 126v is used, the raised slot hole 36rs should have edge extension that extends on the exterior side of the raised web 303ra. The edge extension is not shown but is similar to the fourth leg 129d of the hook receiver 129 shown in FIG. 350.

In FIG. 350 the hooked tongue 128 has a V-shaped notched-tab 126v having the first leg 126va extend downward from the web 302a with the second leg 126vb extending at an obtuse angle back to the interior side of the U shaped spacer brace 302. The V shape of the hooked tongue 128 is inserted into the hooked receiver 129 where the first leg 129a is extended from the hole extension 302he extending downward then extending horizontally at the second leg 129b then extending upward as the third leg 129c then turning again at the fourth leg 129d back toward first leg 129a leaving a gap 45 between the first leg 129a and the fourth leg 129d. The hooked tongue 128 referred to as a V-shaped notched-tab 126v extends into the hooked receiver 129 so the first leg 126a and second leg 126b become compressed together so when the V-shape is fully extended into the hooked receiver 129 the second leg 126b of the V-shaped notched-tab 126v springs back so the second leg 126b becomes lodged under the fourth leg 129d of the hooked receiver 129.

FIGS. 351-358 show different variations of a V-shaped hole 36v also described as V′ & V″″. A V-shaped hole 36v has the hole bottom edge 36be in a V-shape. In FIG. 351 the V-shaped hole V″ has the bottom edge oriented horizontally or the blunt end 159 of the V-shaped hole V″ while both the hole side edges 36se are at an angle similar to FIG. 355, in addition the vertical hole side edges 36se has hole notches 36h similar to other previous figures at the intersection of the hole side edges 36se and the angular side walls of the V-shaped hole 36V″. A reverse lip spacer brace 301 is shown having a web 301a abutting the blunt end 159 with the flanges 301b parallel with the angular side walls of the V-shaped hole 36″ and lips 301c extending externally having lip notches 126p extending into the hole notches 36h.

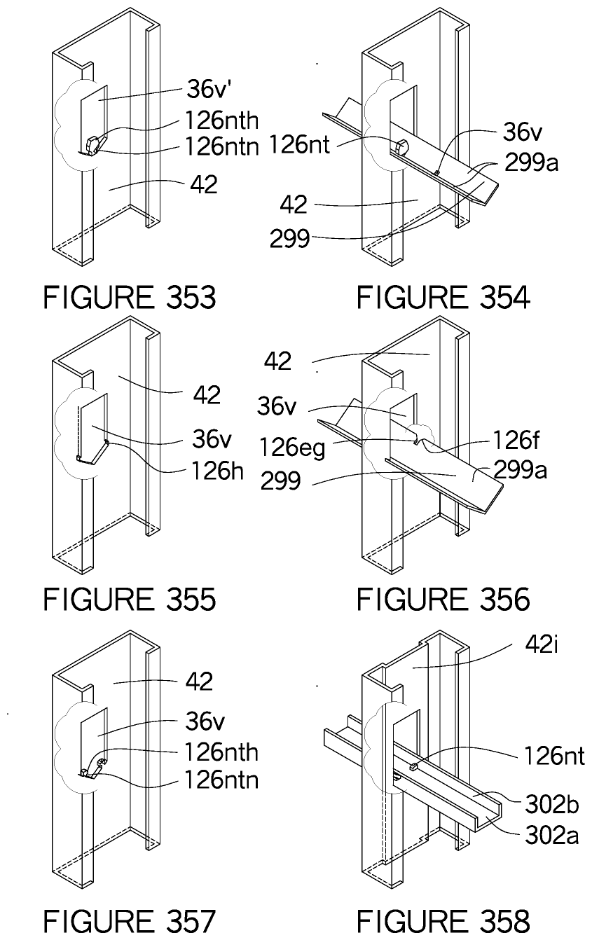

FIG. 353 is similar to FIG. 351 except the V-shaped hole 36v′ has a notched-tab 126nt at the vertex and does not have holes notches 36h. In FIG. 354 a V-shaped channel or V-shaped spacer brace 299 has two angular legs 299a that meet a the vertex of the angular legs 299a, however at the vertex a vertex slot hole 36v is installed so the notched tab 126nt can fit into. The notched tab 126nt is extended from the web 42a through the vertex slot hole 36v with the head 126nth being larger and taper so the head 126nth can slide into the vertex of the vertex slot hole 36v.

FIG. 355 is similar to FIG. 351 as the V shaped hole 36v has hole notches 36h at the angular oriented hole bottom edges 36be and the hole side edges 36se In FIG. 356 the V shaped spacer brace 299 has leg notches 126eg to fit into the hole notches 36h thereby eliminating any vertical and horizontal movement of the V shaped spacer brace 299.

FIG. 357 is showing a V shaped hole 36v′″ having a slightly different configuration where a notched-tab 126nt is shown at each of the angular oriented hole bottom edges 36be. In FIG. 358 a U shaped spacer brace 302 is installed in the V shaped hole 36v′″ and corner slot holes 36cs are installed at the intersection of the web 302a and flanges 302b on both side corner edges. The corner slot holes 36cs are large enough for the head 126h to fit through and become engaged at the notched-tab notch 126ntn of the notched-tab 126nt.

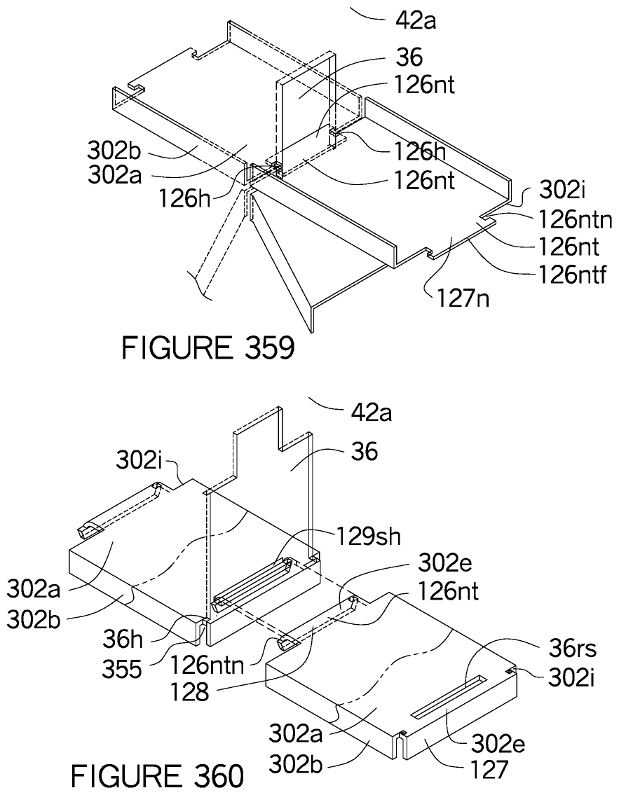

FIG. 359 shows a horizontally oriented U shaped spacer brace 302 intersecting a vertical oriented hole 36 in the web 42c of the C channel 42 from the left side and another U shaped spacer brace 302 intersecting the hole 36 from the right side. The ends of the U shaped spacer braces 302 have notched-tabs 126n that extend from the webs 302a at the indentations 301i forming a head 126nth greater than the width of the hole 36. When installing the web 302a and flanges 302b the notched-tab 126nt abuts one side plane of the web 42a of the C channel 42 at the indentation 302i with the web extension 302we passing through the hole side edges 36se extending from the web 302a over the hole bottom edge 36be then extending along the opposing side plane of the web 42 forming a notch 126ntn in the notched-tab 126nt to the end of the head 126nth of the notched-tab 126nt. In addition, hole notches 126h are installed at the hole side edges 36se to eliminate vertical movement and provide a stronger metal framing connections. The notched-tab 126nt passes through the vertical oriented hole notches 126n, notches 126ntn are installed on both side edges of the notched-tab 126. The adjacent U shaped spacer brace 302 also has the notched-tab 126 at each end along with the notches 126ntn at the notched-tabs 126nt. When two notched-tabs 126nt are installed over each other into the same hole notch 126h the notched-tabs 126nt are stacked above each other forming a hole notch 126h having a wider opening to accommodate two notched-tab notches 126ntn. The notched-tab notch 126ntn of the notched-tab 126nt has the web 42a as one side edge the web extension 302we as the second side edge and the head 126nth as the third side edge of the notched tab 126nt. Since the U shaped space brace 302 and the notched-tabs 126nt are wider than the width of the hole 36, the U shaped spacer brace 302 is installed at an angle installing one notched-tab notch 126ntn into the hole notch 36h at one hole side edge 36se then pushing the opposing notched-tab notch 126ntn into the opposing hole notch 126h on the opposing hole side edge 36se. The notched-tab 127nt could also be used at the end of a notched-finger 127n similar to FIG. 360 or as an extension of the web 302a having a notch 126n and now referred to as notched-tab notch 127ntn. As previously described, spacer braces vary in size, shape and connect differently between framing elements. The notched-tab 126nt can be installed as a connection means at the ends of any metal framing member needing a connection without requiring fasteners and an even stronger connection when holes notches 126h are used. In addition, the hole notches 126h and the lip notches 126p secure the support member to the crossing member without fasteners.

FIG. 360 shows two horizontal oriented U shaped spacer braces 302 connected together when passing through the hole of a support member having hole notches 126h at the hole side edges 36se with the bottom edge of the hole notches 126h being the at the hole bottom edge 36be. The web 302a and flanges 302b abut one side of the 42a of the C channel 42 at the indentation 302i with the web extension 302we passing through the hole bottom edge 36be and into the hole notches 126h so the hook finger 127 can extend downward over the hole bottom edge 36be and against the planar surface of the web 42a. At the web 302a a receiver slot hole 36rs that extends parallel to the web 42a less than the width of the hole 36 for an adjacent spacer brace to connect into. The opposing end also has the web 302a and flanges 302b abut the planar surface of the adjacent web 42a of another support member. The opposite end of a second U shaped spacer brace 302 has a web extension 302we with a notched-tab 126nt at the end which is installed over the hook finger 128 and web 302a of the first U shaped spacer brace 302. The web extension 302we is wider than the width of the receiver slot hole 36rs of the first U shaped spacer brace 302 so notches 126ntn can be bent and installed at the side edges of the web extension 302we and then inserted into the web slot hole 36we. The notched-tab 126nt in the web slot hole 36ws and the hole notches 126h and the hook finger 128, web 302a and flanges 302b engage the opposing end making a self-locking connection between the two U shaped spacer braces 302. Since the web 302a of the first framing member is installed in the hole notches 126h and abuts the support member at the web 302a, flanges 302b and the hook finger 127 the first framing member is secured within the opening of the hole 36.

When the notched-tab 126nt of the second framing member is inserted into the slot hole 36s of the first framing member, the notched-tab 126nt and slot hole 36s eliminates horizontal and vertical movement between spacer braces and support members having the notched hole 126h.

There are many different variations of the connections that have been shown in the figures and when discussed in the claims could be referred to as connectors. Since a notched tab 126nt could extend from a web or flange of either a support member or spacer braces the tab as explained in the claims is the first metal framing element. When a crossing member intersects say the notched tab, the notches of the notched tab engage an opening which could be the edge of a lip of a U or C shaped support or spacer brace as well as many of the different types of holes or notches that the notched-tab notch 126ntn would connect or engage too. Sometimes a notch for example a hole notch could be considered as a pocket to receive a crossing element that fits into the pocket. In addition sometimes the construction of the spacer brace being the web, flanges or lips are referred to as a wall. The notched-tab can be installed in various positions where a wall description can be considered is many different locations.

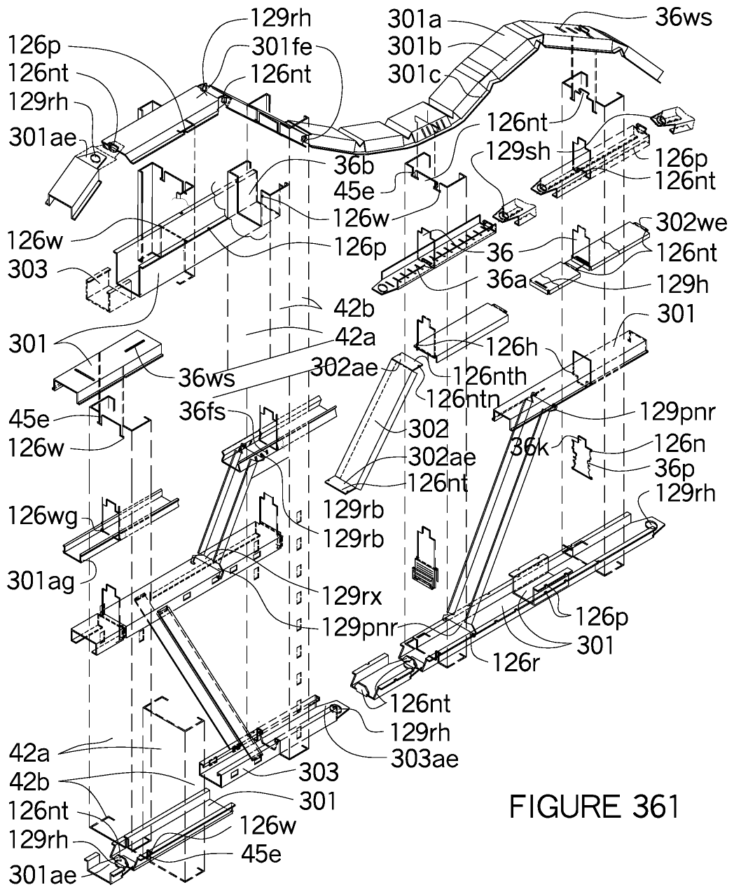

A DESCRIPTION OF THE PREFERRED EMBODIMENTS in FIGS. 361-401 shows the spacing-bracing members overlapping and connecting each other forming curvilinear metal framing structures for walls and ceiling undulating either vertically or horizontally at the top, middle and base of the metal framing structure. Additional framing connections as shown for diagonal metal framing connection, window and door framing headers as well as forming panelized metal framing panels for even faster field assembly connections.

FIG. 361 shows an isometric view of four support members having various configurations and crossing members all having various self-locking connections, using notched-tabs 126nt extending from hook tongues 128 at the webs 301a or the webs 301a or 302a with bent extensions 301ae or 302ae having notched-tabs 126nt ends overlapping holes 36 with or without hole notches 126h or notched-tabs 126nt extending from hook tongues 128 at the flanges 301b into receiver holes 129h at the webs 301a or flanges 301b, or notched-tabs 126nt extending from the hole bottom edges 36be into web slot holes 36ws or into lip notches 126p of a C shaped spacer braces 302. The notched-tabs 126nt at the ends of adjacent spacer braces at the webs of either 301a or 302a can overlap adjacent spacer braces at the holes 36 in support members. A diagonally oriented reverse lip spacer brace 301 with lip notches 126p can have lip-notched receivers 129pnr attached to lip notches 126p or can be attached at the flange slot holes 36fs at the opposing ends. Notched-tabs 126nt can extend from the web 42a of the support member into the web slot holes 36ws of the reverse lip spacer braces 301 or the flanges slot holes 36fs at both flanges 301b. The spacer braces can have bend in the web, flanges or lips of the spacer braces to obtain short radius curves. Headers over doors and windows can be installed with the base spacer brace bearing into the cut out with web notches 126w in the cripple at the base of the opening. Notches can be installed protruding from the hole edges so different configured spacer braces can be installed in the hole side edges without using lip notches 126p and spacer braces can be smaller and can slide between the flanges 301b of a larger spacer brace.

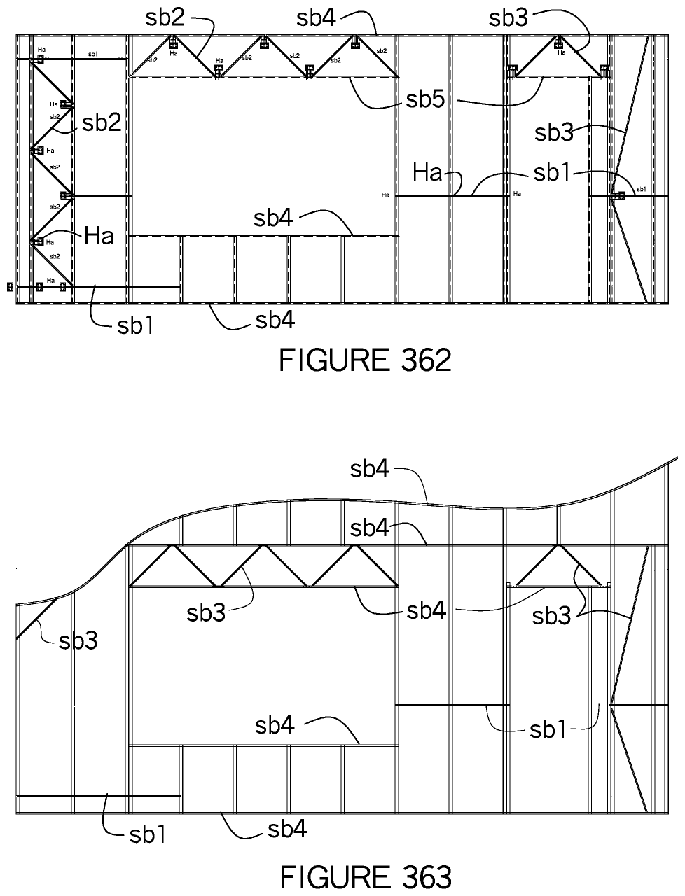

FIG. 362 shows the elevation view of a metal framed wall. The vertical support members are connected at the holes noted as Hb1 or 36 with various shaped spacer braces shown as sb1, sb2, sb3, sb4 or sb5 shown in other numerous views. The wall elevation could be a straight wall or the framed wall could have a curvilinear shape by installing the metal support members into a serpentine configuration. There are various ways to secure the horizontal bracing member to the support members so the spacer braces can form a curved wall. The spacer brace sb1 is shown as interior oriented spacer brace passing through any of the notch configurations shown through the drawings. The hole 36 can be configured in many different shapes with various hole notches 126h and or various spacer braces configurations.

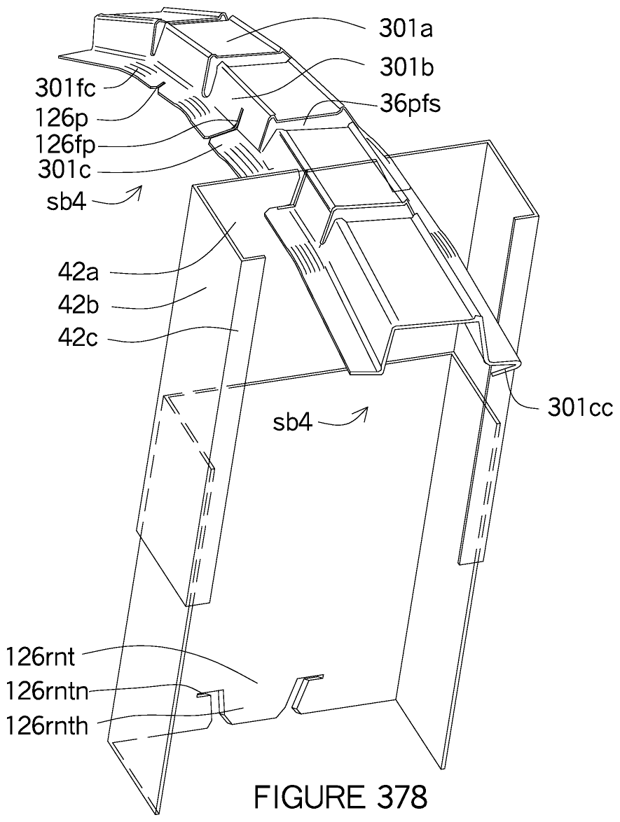

FIG. 363 shows a similar wall elevation as FIG. 362, however the top of the wall is arched in a vertical direction allowing the spacer braces to either be bent or have pivot points so the spacer braces can be connected to support members as shown in FIGS. 378 & 381. The pending application shows various arching at the top of wall with the other metal framing can connected as shown in FIG. 362.

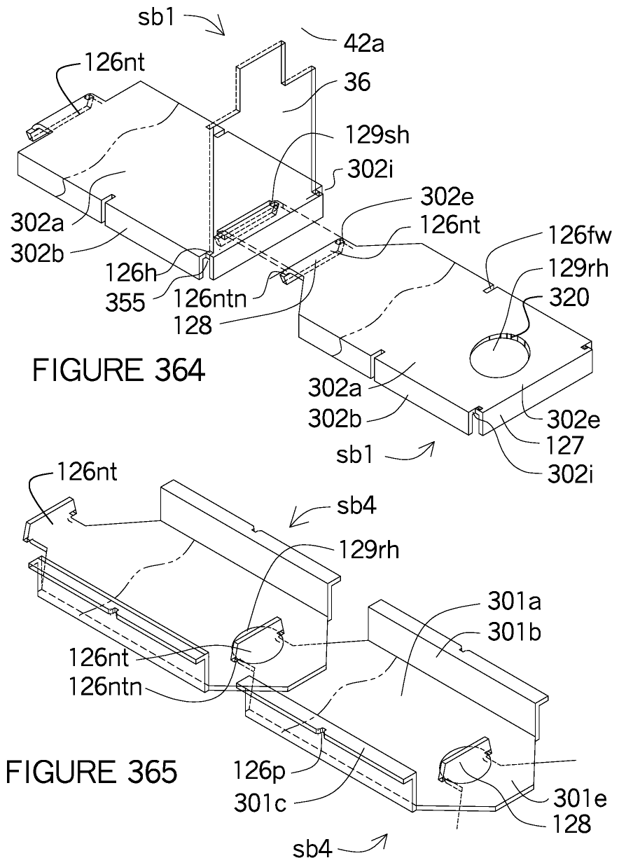

FIG. 364 shows two U shaped spacer braces 302 having a web 302a with two flanges 302b extending downward from the longitudinal sides of the web 302a. The left U shaped spacer brace 302 shows a notched-tab 126nt extending downward from the web extension 302we. The opposing end of the web 302a shows a receiver slot hole 129sh located near the hole bottom edge 36be. The web 302a is indented 302i at the hole 36 with the indentation 302i extending into the flanges 302b. The flanges 302b and the web 302a rest against the plane of the web 42a of the support member on one side and the web 302a, and the web 302a forms a hook finger 127 that extends over the hole bottom edge which is the anchor space 355 for the inside plane of the hook finger 127 to rest against from the opposing side of the web 42a from the support member. The right spacer brace 302 has a hook tongue 128 with a notched-tab 126nt extending downward, however the extension 302we has tapered side edges. The tapered side edges are angled so the notched-tab 126nt can fit into the round-hole receiver 129rh as shown in the web 302a on the opposite end of the right U shaped spacer brace 302. The round-hole receiver 129rh has ridges 320 at the side edges of the round-hole receiver 129rh. The ridges 320 are spaced at intervals to allow the notched-tab 126nt to fit between the ridges 320 to stop the notched-tabs from rotating. The right U shaped spacer brace 301 has the tapered side edges to rotate when the notched-tab 126nt is inserted into the round-hole receiver 129rh. Once the notched-tab 126nt is located at the proper angle between adjacent U shaped spacer braces 302 the head 126nth can be bent having the head 126nth being secured in the round-hole receiver 129rh. The web extension can be short or long and the receiver hole can be a receiver slot hole 129sh or a round-hole receiver 129rh so the notched-tab 126nt can be swiveled to be oriented at an angle. Additional round-hole receivers 129rh can be added to the web 302a so additional hook tongues 128 having notched-tabs 126nt (not shown) could be inserted from a crossing spacer brace from a perpendicular wall having support members. Any shape spacer brace could be used to form the pivotal configuration as explained above. For example (but not shown) a C shaped spacer brace 303 could be used and a notched-tab 126nt could be installed in the support member or the floor spacer brace could just have a groove at the flanges for the web 42a of a support member to fit into. The receiver slot hole 129sh with the notched-tab 126nt can be used as an end connections between abutting lengthy spacer braces between support members not just short segmented section to form curvilinear walls. When the U shaped spacer braces 302 are wider than the hole 36, the plane on both side of the hole 36 can be inserted into the flange-web notch 126fw in the flange 302b and web 302a of the spacer brace 302. If the spacer brace was a reverse lip spacer brace 301 the lip notches 126p would also give additional support at the hole 36 intersection. Another alternative solution in FIG. 364 shows the flanges 302b and the web 302a (referred to also as a web-flange notch 126fw that shows the hook FIG. 127 where the web 302a has an extension 301e that extended over the hole bottom edge 36be and the hook finger 127 extension downward. The hole bottom edge 36be and the hole side edge 36se form a hole notch 126h at the corners of the hole 36. When the web 302a of the U shaped spacer braces 302 extends into the hole notch 126h, the U shaped spacer brace 302 will not move up and down within the hole notch 126h.

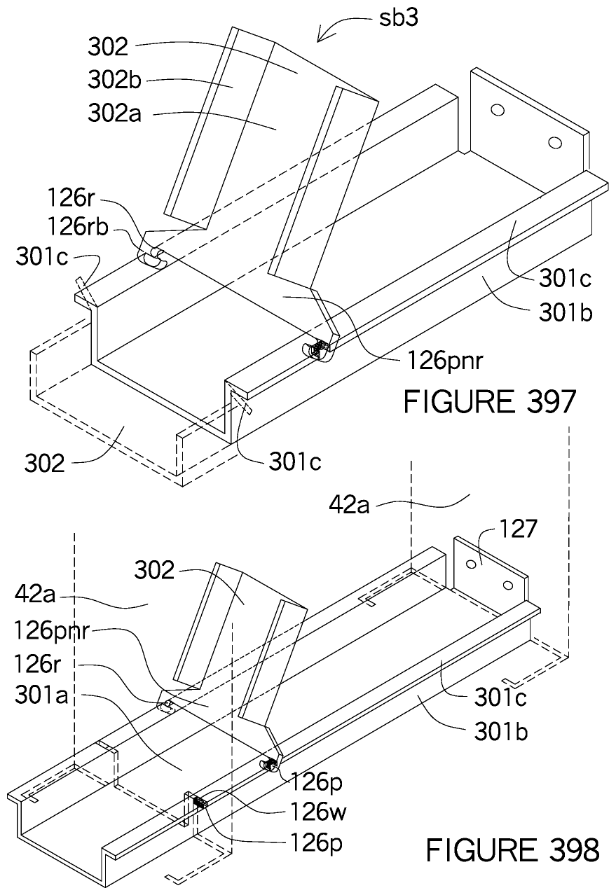

FIG. 365 is similar to FIG. 364 except the spacer brace is shown as a reverse lip spacer brace 301 where the underside of the web 301a is against a floor and the flanges 301b extend upward with lips 301c extending outward. The lips 301c are shown having lip notches 126p shown previously being installed in the web notches 126w of the support member. The reverse lip spacer braces 301 are shown having an extension 301e at both ends of the web 301a with the left end having a notched-tab 126nt extending upward with the opposite end having a round-hole receiver 129rh located near the extension 301e. Both extensions 301e are tapered so when the notched-tab 126nt is inserted into the round-hole receiver 129rh, the notched-tab 126nt is allowed to swivel within the round-hole receiver 129rh. The head 126nth can be bent once the reverse lip spacer brace 301 is oriented to the desired angle to then be secured to the floor for installation of the support members that fit into the lip notches 126p and into the web notches 126w in the L-shaped gap 45e. When completed drywall or other types of wall board can be mounted to the support members to form a curved wall. On the other hand, the hook tongue 128 and the receiver slot hole 129sh can be used at the end of a reverse lip spacer brace 301 in lieu of the notched-slide extension 126se at the web 301a that connects to hole side edge 36se as shown in FIG. 397.

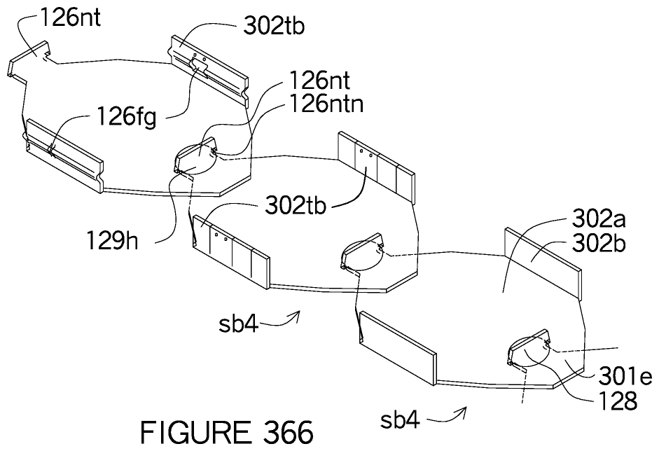

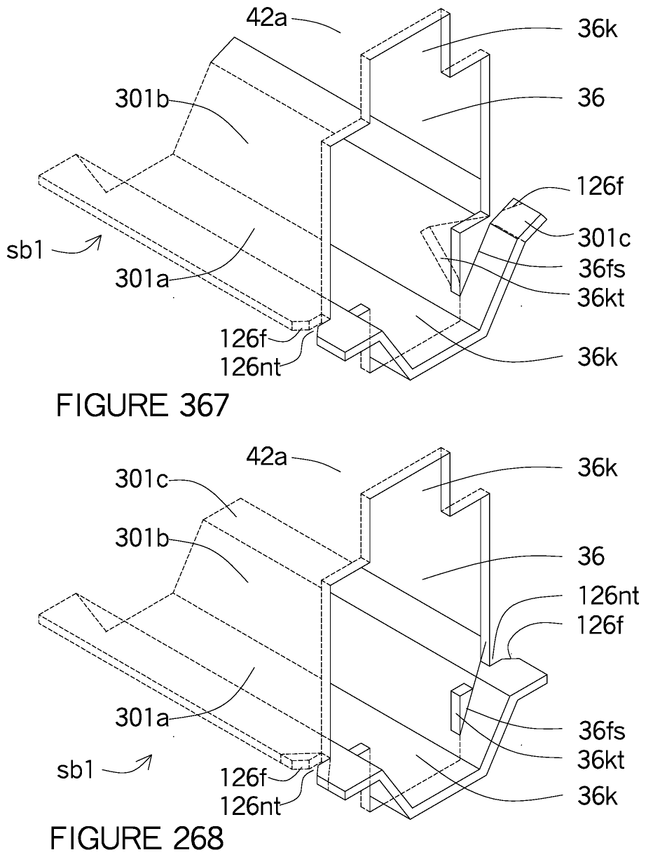

FIG. 366 is similar to FIG. 365 except a U shaped spacer brace 302 has a wider web 302a than the web 301a of the reverse lip spacer brace 301 in FIG. 365. The middle U shaped spacer braces 302 shows the base of a support member between the flanges 302b bearing on the web 302a of the U shaped spacer brace 302a. The U shaped spacer brace 302 can be manufactured in short segments or longer lengths where additional support members can be installed to the U shaped spacer brace 302 by fastening screws (not shown) from the support member flanges 42b into the flanges 302b of the U shaped spacer brace as standard metal framing are presently connected. The longitudinal ends of the U shaped spacer brace 302 are shown having web extension 302we extend from the webs 302a to notched-tabs 126nt extending upward from the hook tongue at one end and a receiver hole 129h installed in the web extension 302we at the opposing end. The web extensions 302we can have receiver holes 129h or notched-tab 126nt at both ends depending on the configuration of the wall framing. In addition, the flanges 302b can be formed as tabs 302bt that can be bent inward to secure the lip 42c and web 42a between the bent tabs or have a flange-bulge notches 126fg in the flanges 302b to a corresponding bulges in the flanges 42b of the support member to the flange-bulges notches 126fg in the flanges 302b of the U shaped spacer brace 302. The three short U shaped spacer braces 302 can be used to form serpentine curvilinear walls or just connecting different wall framing segments together.

FIG. 367 and FIG. 368 are similar as both are a reverse lip spacer brace 301 where the web 301a is resting on the hole bottom edge 36be, but at the bottom edge of the key hole 36k. Both FIG's show the angled flanges 301b and have lip notches 126p at the free edges of the lips 301c along with flare edge 126fe. FIG. 365 shows a flange slot hole 36fs in the middle of the flanges 301b so the hole bottom edge 36be and the side edge of the key hole 36k can fit into the flange slot holes 36fs. On the other hand FIG. 367 shows a large flange slow hole 36fs that extends from the flange slot hole 36fs into and through the lip notch 126p making a continuous flange-notch 126f. The right lip 301c in FIG. 367 is bent at an angle forming another angled flange or just called a lip 301c. The angled lip 301c gives additional flexibility.

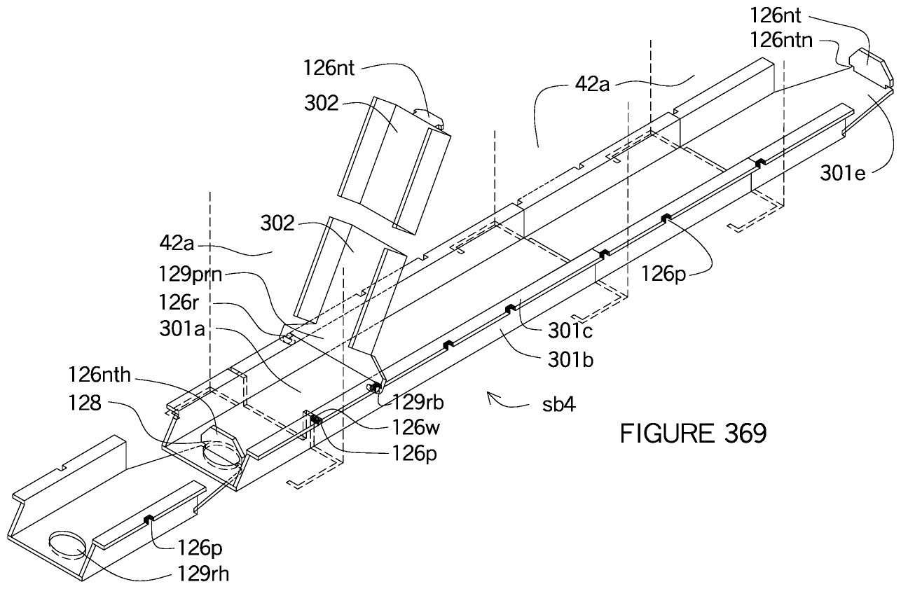

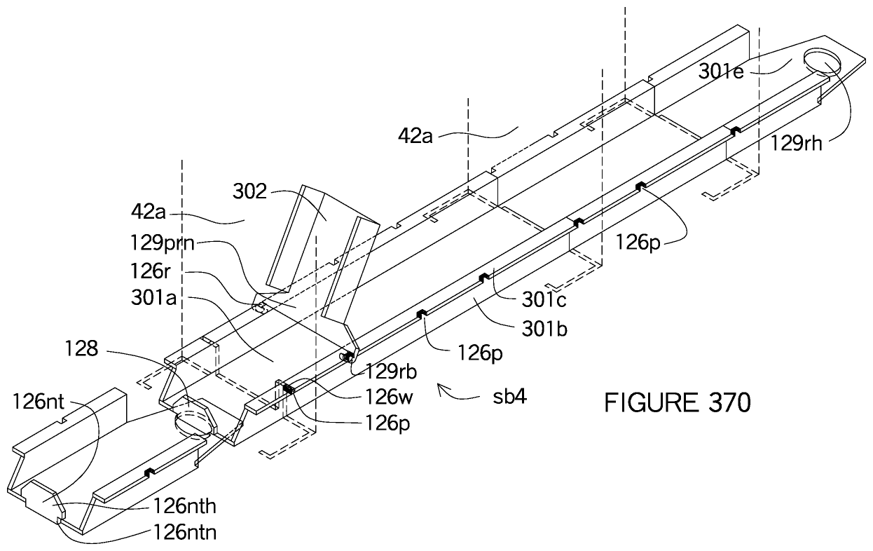

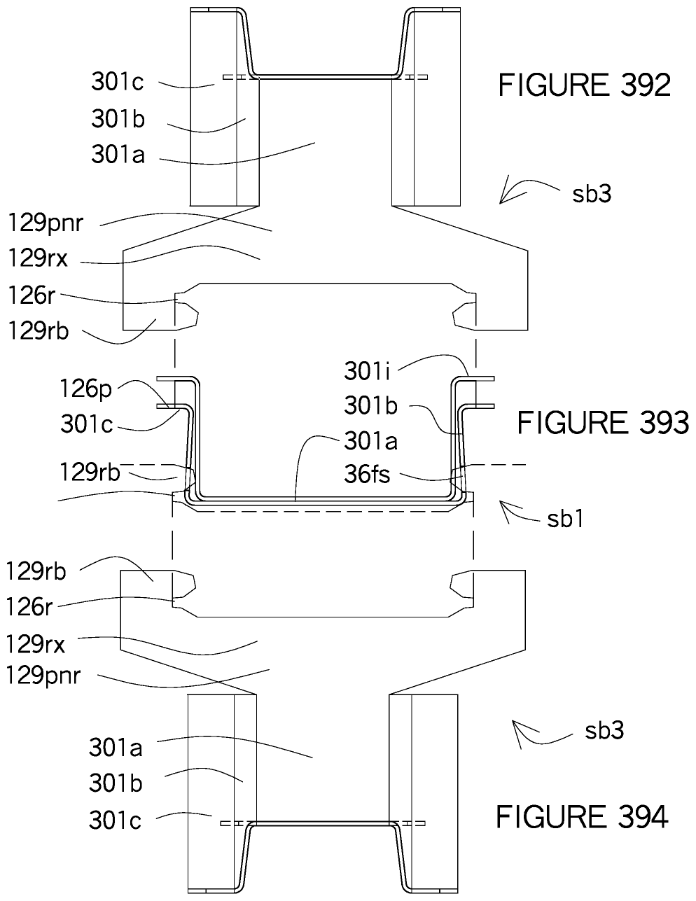

FIGS. 369 & 370 both show a horizontally oriented reverse lip spacer brace 301 having a longitudinal web 301a with the outside plane of the web 301a facing a floor with the side walls extending upward the length of the web 301a with lips 301c extending from the flanges 301b outward lips 301c and having lip notches 126p extending inward from the outer longitudinal edges. One end of the longitudinal web 301b shows an extension 301e with a hook tongue 128 having a notched-tab 126nt at the end extending upward with notches 126ntn and a notched-tab head 126nth being wider that width of the notched-tab 126nt so the notched-tab head 126nth extends over beyond the notched-tab notches 126ntn. The opposing end of the web 301a shows a round-hole receiver 129rh near the end of the opposing end. The round-hole receiver 129rh shows a notched-tab 126nt from an adjacent reverse lip spacer brace 301 extending above the round-hole receiver 129rh so the notched-tab notches 126ntn extend through the round-hole receiver 129rh so the notched-tab head 126nth extends above the web 301a with the top edge of the notched-tab notch 126ntn extending over the web 301b. The notched-tab head 126nth can be bent to allow for the adjacent reverse lip spacer brace 301 to be securely fixed to the web 301a. The edges of the receiver hole 129h has ridges to keep the reverse lip spacer brace 301 from moving. Support members are shown (in ghost) as C channels 42 being connected via the web gaps 45w and secured at the web notches 126w and the lip notches 126p of the reverse lip spacer brace 301. In addition a lip notched-receiver 129pnr is shown being connected to the lip notches 126p and further described in FIG. 392. FIG. 370 is similar to FIG. 369 except the pivot point of the notched-tab 126nt is at the end of the web 301a and the receiver hole 129h is located at the extension 301e with its tapering side edges at the opposing end of the web 301a. By located the notched-tab 126nt near the support member and directly attached to the web 301a the notched-tab 126nt has additional strength. Many notched-tabs 126nt are located along the lips 301c for additional support members or closer spacing of the support members. There are several lip-notched receivers that are shown in FIGS. 391-398 that will be explained later.

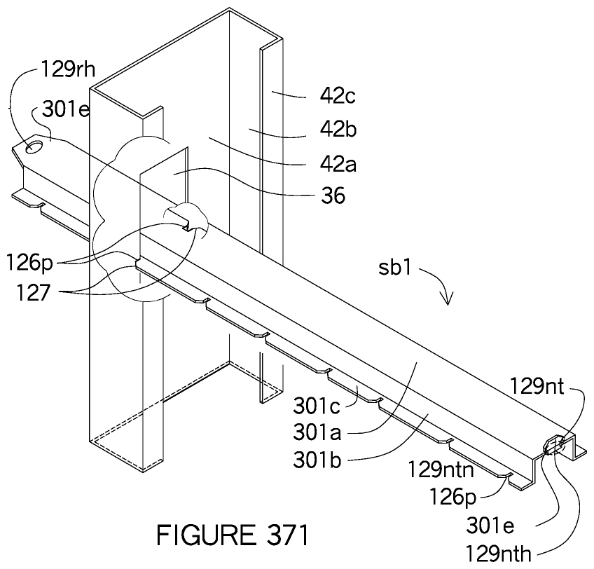

FIG. 371 shows the same profile of the reverse lip spacer brace 301 in FIG. 370 except the interior side if facing downward and the lips 301c are resting on the hole bottom edges 36be with the lip notches 126p extending into the hole notches 126h formed by the holes bottom edge 36be and the hole side edges 36se. The longitudinal reverse lip spacer brace 301 is shown having numerous lip notches 126p for addition support members to be installed into the lip notches 126p. At the longitudinal ends at the web 301a shows a nt-extension 126nte extending outward then upward toward the head 126nth of the notched-tab 126nt. The nt-extension 126nte becomes part of the nt-notch 126ntn and the nt-head 126nth becomes to top side of the nt-notch 126ntn of the notched-tab 126nt. The nt-extension 126nte not only connects the nt-head 126nth of the notched-tab 126nt, but is extended long enough for an adjoining reverse lip spacer brace 301 to extend over the notched-tab 126nt. The reverse lip spacer brace 301 shows the opposing end also having a web extension 301e, however the extension is the width of the web 301a then tapered to allow for a receiver hole 129h to be installed in the web extension 301ae. The receiver hole 129h extends over the notched-tab 126nt of an adjacent reverse lip spacer brace 301. The tapered sides of the web extension 301ae allows for the adjacent reverse lip spacer brace 301 to be horizontally oriented at an angle at the web extension 301a at the notched-tab 126nt. After installation of the notched-tab 126 into the receiver hole 129h the nt-head 126nth can be bent to more firmly secure the nt-head 126nth to the web 301a plus the receiver hole 129h has ridges 180 previously shown to additionally secure the notched-tab 126nt.

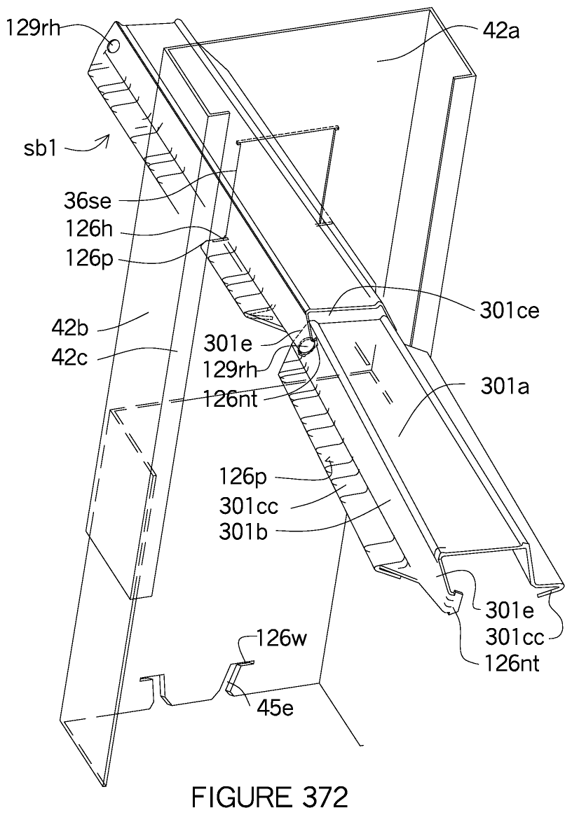

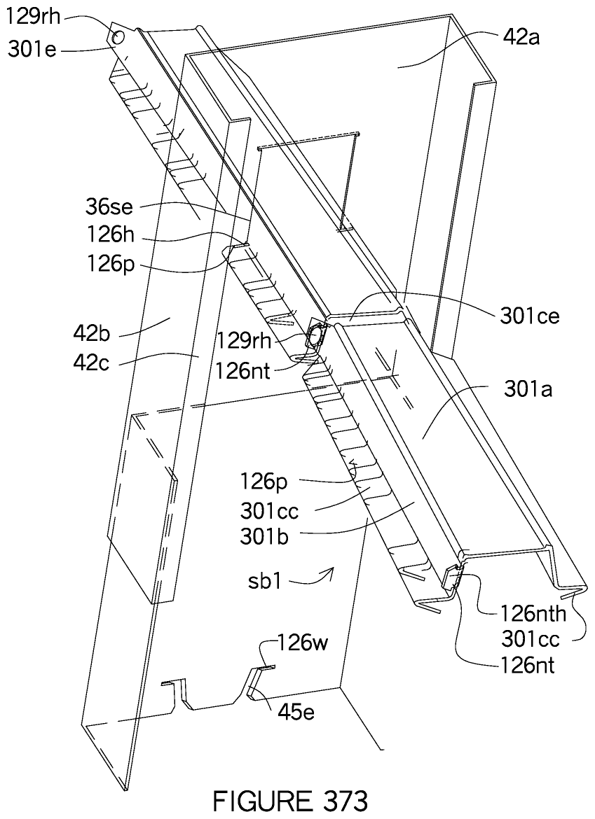

FIG. 371 is similar to FIGS. 372 & 373 as they are all longitudinal spacing-bracing members comprising a longitudinal web 301a with first and second opposing sides shown as flanges 301b extending the length of the longitudinal web 301a and being connected to the longitudinal lips 301c with lip notches 126p extending inward so the hole side edges 36se can extend into the lip notches 126p. FIG. 372 show the flanges 301b at an angle and the hole 36 is slightly smaller so the hole side edges 36se extend into the flange notches 126f as well as the lip notches 126p. The lip notches 126p in FIG. 373 shows the lip notch 126p at the end of the double lip 301cc as shown in FIG. 375, but the longitudinal lip 301c extends downward. In FIG. 371 the notched-tabs 126nt extended from the web 301 at the extensions 301e, but in FIG. 372 the notched-tabs 126nt extend from the flanges 301b at the flange extensions 301e. The flange extensions 301e are sometimes referred to as hook tongues 128 and are bent inward at the nt-notch 126ntn then extends wider at the nt-heads 126nth. The opposing end of the reverse lip spacer brace 301 shows receiver hole 129h at the flanges 301b for the nt-head 126nth to fit into the receiver hole 129h. The receiver hole 129h has grooves 131 at the side edges of the receiver hole 129h for the notched-tab head to have additional means of friction to secure the notched-tab 126nt into the receiver hole 129h. The receiver holes 129h has a vertical orientation, so when the notched-tabs 126nt are inserted into the receiver holes 129h, the notched-tab 126nt are pivot points so the reverse lip spacer brace 301 can be oriented at an angle. The reverse lip spacer braces 301 can be connected individually to each support member or several reverse lip spacer braces can be connected to form a continuous row of reversed lip spacer braces 301 by using notched-tabs 126nt and receiver holes 129h as the connection means to form an arched wall. FIG. 373 is similar to FIG. 372 except the notched-tab 126 has the hook tongue 128 at the edge of the flanges 301b and the notched-tab 126 extends outward. The receiver hole 129h at the opposing end is installed in the flange extension 301e so the notched-tab 126nt has room to pivot vertically upward or downward to the desired angle.

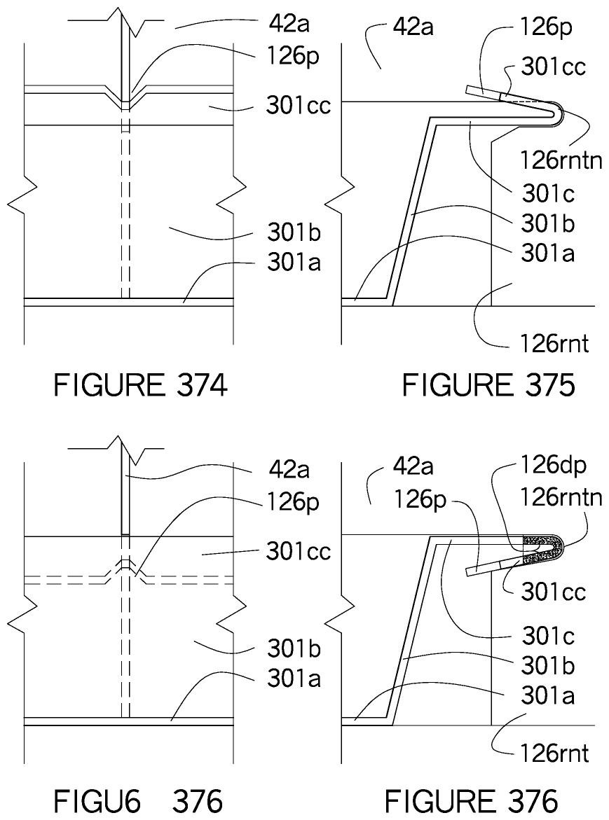

FIG. 374 is a longitudinal cross section of a reverse lip spacer brace 301 and FIG. 375 is a cross section of the reverse lip spacer brace 301 at the intersection of web notch 126w at the floor or a hole side edge 36se having a hole notch 126h at the web 42a of the support member. FIG. 374 shows the lip 301c having a double lip 301cc where the double lip 301cc extends upward so the free edge has a lip notch 126p engage into the upper edge of the web opening for the double lip 301cc to fit into. The lip notch 126p secures the reverse lip spacer brace 301 from moving horizontally engaging the web 42a of the support member above the web notches 126w shown in the L-shaped gap 45e of the support member and the bend of the double lip 301cc engages the web notch 126w to reduce vertical movement. The flange 301b is shown angular, but is not limited to that angle.

FIG. 376 and FIG. 377 are similar to FIGS. 374 & 375 except the double lip 301cc is facing downward toward the exterior side and the lip notches 126pp is double thick as both the upper and lower portion of the double lips 301cc have the lip notch 126p forming an extra strength lip notch 126p. The web notch 126w is larger since the double lip notch 126pp has each side of the double lip notch 126pp engage the side planes of the web 42a of the support member.

FIG. 378 shows the L-shaped gap 45e at the bottom end of the support member of a U shaped channel 41 has the exterior side fitting into the interior side of the C channel 42 also a support member where the top end also has an L-shaped gap 45e for a reverse lip spacer brace 301 to fit into. The reverse lip spacer brace at the top shows a cut edge 301ce at the web 301a and flanges 301b so the flexible lip 301fp and bend in a ventral direction to form a curving profile. FIG. 378 shows the lip notch 126p in the middle between short segments of the reverse lip spacer brace 301 for strength at the joint connection of the L-shaped gap 45e. On the other hand, should the support member be aligned at the flexible lip 301fp the lip might not require a lip notch 126p if the bend is at an acute angle that the support member would not move longitudinally along the direction of the reverse lip spacer brace 301.

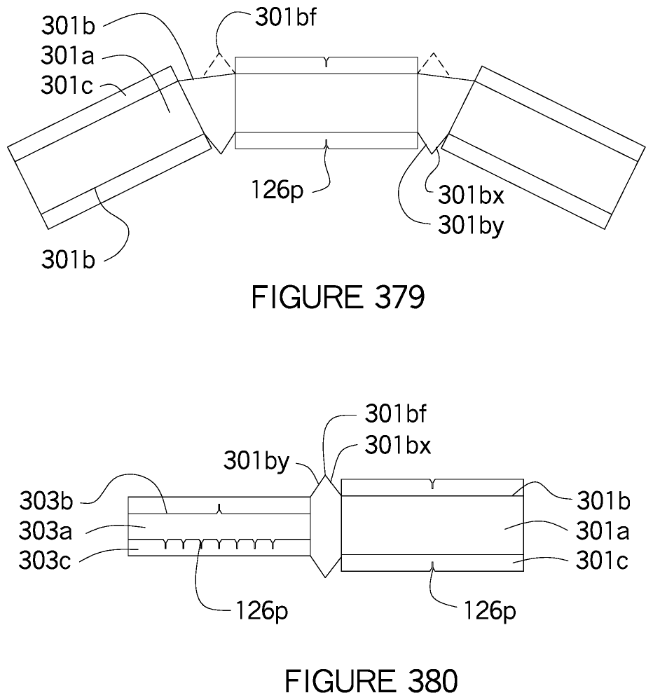

FIG. 379 shows a reverse lip spacer brace 301 where a horizontal movement can occur between segments of the reverse lip spacer brace 301. In FIG. 379 the cut edge 301ce occurs at the web 301a and the lip 301c allowing the flange to bend at the midpoint by installing a crease or notch (not shown) to allow the flange 301b to bend at a predetermined point. FIG. 379 shows a horizontal radial arch where the inside diameter is shown a bend at the flange x-plane 301bx and the flange y-plane 301by become at acute angles to the plane of the continuous segmented sections of the reverse lip spacer brace 301 while the opposing side flange 301b are shown in a straight line. The lip notches 126p are shown at the longitudinal exterior side edge of the lip 301c.

FIG. 380 shows a similar profile as FIG. 379 however one space brace is shown as a C shaped spacer brace 303 where again the flanges 303b bend and the web 303a and lip 303c have the cut to allow for the bending. In this case a notched-tab from the end of a support member would be inserted between the lips and inserted into the lip notches 126p at the longitudinal side edge of the lip 303c.

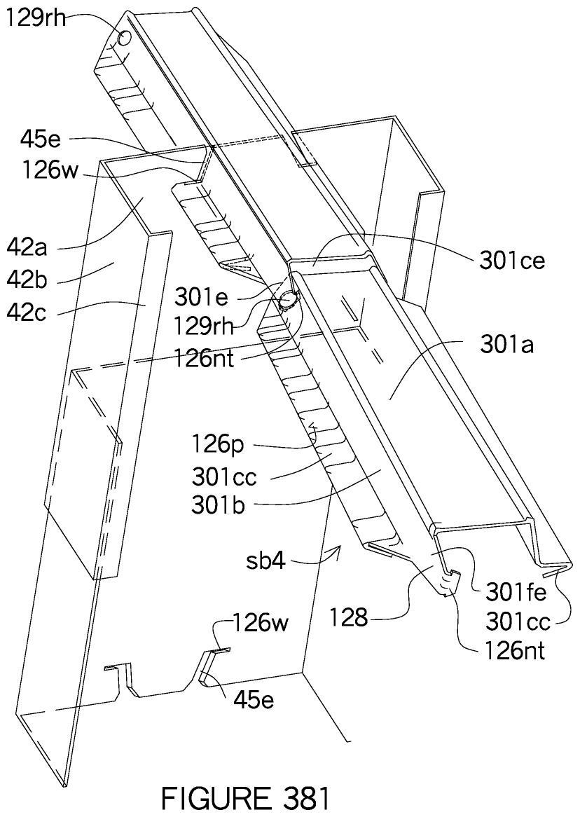

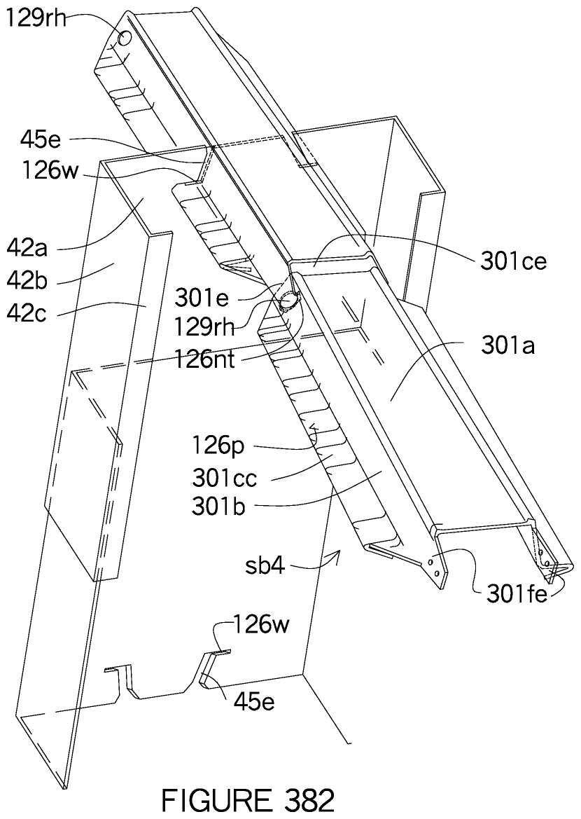

FIGS. 381 & 382 both show the reverse lip spacer brace 301 installed at the top end of the web 42a of the support member with the top plane of the reverse lip spacer brace 301 similar to the FIG. 361 where the reverse lip spacer brace 301 were installed in the hole 36 in the web 42a. The bottom edge of the web 42a shows the L-shape gap 45e along with the web notch 126w where the lip notch 126p fit into. Both FIG's show the double lip 301cc for extra strength. The notched-tab 126nt and the receiver holes 129h as shown in FIGS. 372 & 373 are shown at the top of the web 42a so the adjacent reverse lip spacer braces 301 can pivot at the notched-tabs 126nt. A smaller U channel is shown installed between the web 42a so the C channel 42 can more easily be installed in place. FIG. 382 shows one end having extensions 301e with holes so fasteners (not shown) can be installed through the flanges 301b of an adjacent spacer brace 301.

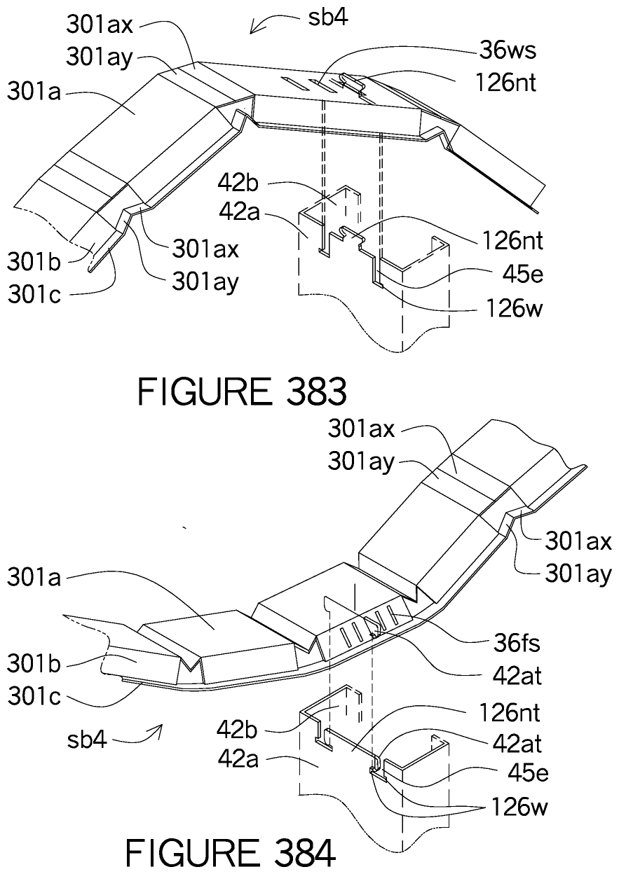

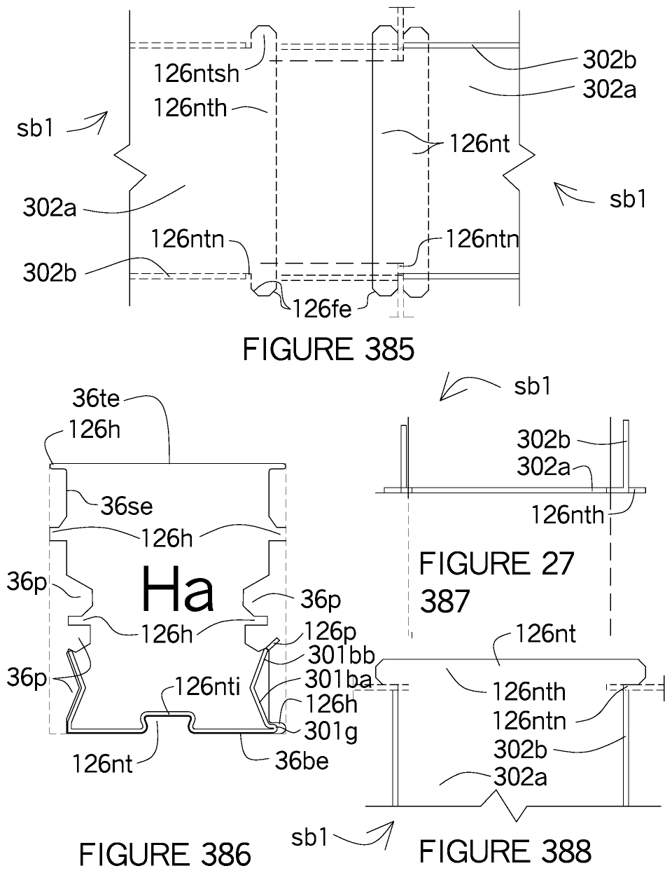

FIGS. 383 and 384 also show the reverse lip spacer brace 301 being connected to the end of the C channel 42. FIG. 382 shows the L-shaped gap 45e at the bottom edge of the web 42 along with the web notch 126w where the lip notch 126p is installed. In FIG. 384 the L-shaped gaps 45e have a web section between the two L-shaped gaps 45. The web section has the same profile shape as a notched-tab 126nt where another web notch 126w is shown at the bottom edge of the L-shaped gaps 45e. These sides of the L-shaped gap 45e has web tabs 42at that extend over web notches 126w forming a notched-tab 126nt at the web section between the two L-shaped gaps 45. These web-tabs 42at are part of the notched-tab 126nt. The reverse lip spacer brace 301 has the angled flanges 301b with flange slot holes 36fs. The web tabs 42at extend through the flange slot holes 36fs and if the web tabs 42at are long enough they could be bent across the flange slot holes 36fs making a tighter fit. FIG. 383 is similar to FIG. 384 except the web 301a of the reverse lip spacer brace 301 has web slot holes 36ws and the top edge of the web 42a of the support member has a notched-tab 126nt at the end that can extend through the web slot holes 36ws. The profile of the reverse lip spacer braces 301 are similar to FIGS. 379 & 380.

FIGS. 385-388 show two longitudinal U-shaped spacer braces 302 having a longitudinal web 302a with two side walls or flanges 302b extending from the longitudinal free edges the length of the web 302a with notched-tabs 126nt extending from the longitudinal ends. The notched-tabs 126nt can have extension 301ae or 302ae that can be bent as shown in FIG. 361. The notched-tab 126nt has previously been shown to extend from the web 301a or the flanges 301b extending directly from the web or flanges or from hook tongues 128 that extend into receiver holes 129rh. In FIG. 361 the web 42a in the support member shows notched-tabs 126nt extending through web slot holes 36ws in the web 301a or angled flanges 301ba having flange slot holes 36fs of the reverse lip spacer brace 301. FIG. 361 also shows the notched-tabs 126nt shown at the hole bottom edge 36be extending into web slot holes 36ws or lip notches 126p of longitudinal spacing bracing members. In FIGS. 385-388 25-28 the notched-tabs 126nt are shown overlapping at a hole 36 noted as shape Ha on the elevations in FIGS. 362 & 363. The notched-tabs 126nt are used to reduce vertical bending of the support members as well as lateral movement horizontally or diagonally within the wall framing. The nt-notches 126ntn within the notched-tab 126nt have the nt-notches 126nt parallel to both side edges of the plane of attachment. The nt-notches 126ntn can be formed by using the longitudinal edge of the flange 301b with the web 301a being the rear back edge of the nt-notch 126ntn and the opposing side of the flange 301b side edge, the nt-side head 126ntsh extends beyond the hole side edges 36se and around the side of the opposing side plane of the web 42a. The nt-side heads 126ntsh are the side edges of the notched-tab head 126nth that extend longer than the width of the opening or hole 36 and similar to the web tabs 42at as shown in FIG. 384. The nt-side heads 126ntsh can have rounded side edges or can have flare edges 126fe at the notched flange notch 126ntn and another flare edge 126fe at the longitudinal end of the notched-tab head 126nth. The nt-notches can also just have a deeper depth notch to form a stronger nt-notch 126ntn. The nt-notches 126ntn can have a greater depth, so that hole notches 126h can be installed into the hole side edges 36se to eliminate any vertical movement within the hole 36. The nt-notches 126ntn of the notched-tab 126nt fit into the back vertical side of hole notch 126h with the sides of the head 126nth extend wider than the depth of the hole notch 126h as shown in the plan view in FIG. 388 and the cross section view of the U shaped spacer brace 302 along with the plan view FIG. 385.

FIG. 386 shows the hole 36 with many different hole notches 126h and various configurations so the edges of a horizontal spacing-bracing channel can intersected any of the hole edges to secure the horizontal spacing-bracing member from moving vertically or horizontally within the hole 36 opening. The hole bottom edge 36be shows a notched-tab 126nt extending upward into the hole 36 from the web 42a of the support member. The outside plane of the web 302a of the reverse lip spacer brace 302 has a notched-tab indentation 126nti corresponding to a shadow profile of the notched-tab 126nt at the hole bottom edge 36be so the two metal crossing members interlock together. The size of the hole 36 in support members have standard hole dimensions, because the structural strength of the support member is based on a specific size of a hole. The hole variations are based on reducing the interior hole dimensions by adding protrusions, not by removing portions of the web 42a to form the hole 36 configurations. In other FIG's the reverse lip spacer brace 301 is shown in reverse with the lips 301c adjacent to the hole bottom edge 36be similar to FIG. 390. When this occurs the web 301a is installed below the hole protrusions 36p located at the hole side edges 36se securing the reverse lip spacer brace 301 within the hole 36 vertically and the lip notches 301c extending around the hole side edges 36se or hole bottom edge 36be secure the reverse lip spacer brace 301 from horizontal movement. The installation of the reverse lip spacer brace 301 under the hole protrusions 36p and along with the lip 301c or the lip notches 126p requires the bracing channel to be rotated between the hole edges allowing the reverse lip spacer brace to obtain better angled leverage for easier installation as well as give flexibility to the metal properties of the reverse lip spacer brace 301. The same configurations of the various notches and horizontal spacing-bracing members can be applied to other connection criteria used to hole the two crossing framing members together. So by making the hole smaller by adding hole protrusions 36p, the hole is now smaller, but large enough to install hole notches 36n in the hole protrusions 36p without have to retest the structural capacity of the support member. Some hole protrusions 36p use one side of the hole protrusion 36p as a hole notch 126h and the existing hole side edge 36se as another surface to form a hole notch 126h.

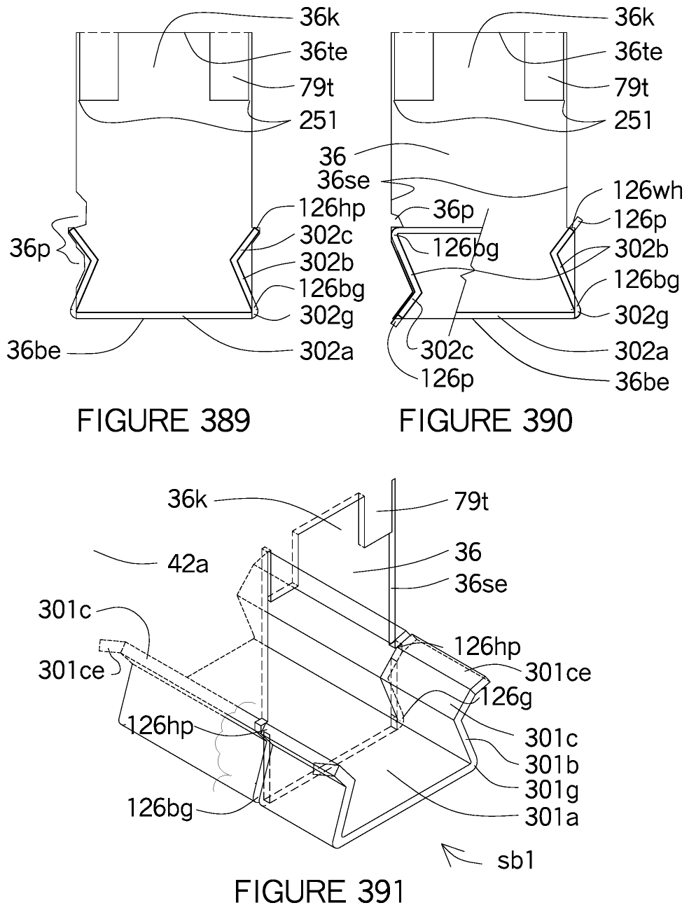

FIGS. 389 & 390 show two hole elevations and FIG. 391 shows an isometric view similar to the reverse lip spacer brace 301 shown in FIG. 386. An irregular shaped reverse lip spacer brace 301 is shown having the plane of the web 301a resting on the hole bottom edge 36be with the side planes extending upward at an angle sloping inward at an acute angle forming a bulge 301g at their intersection. The bulge 301g can be formed to have a bulge notch 126g where the web 301a and a portion of the flange 301b have a combined notch referred to as a bulge notch 126g or the bulge 301g has no notch at all. The longitudinal edge of the flanges 301b have lips 301c that bend outward toward the hole side edge 36se as shown in FIG. 389. The free edge of the lip 301c abuts a hole protrusion 36p as shown on the left hole side edge 36se or indented shown as a lip hole notch 126hp. The structural integrity of the hole 36 should be at the furthest indentation at the lip hole notch 126hp. The left side of the hole side edge 36se in FIG. 390 shows an inverted reverse lip spacer brace 301 as shown on the right hole side edge 36se also described in FIG. 386. By having the left side inverted, the web 301a have both the longitudinal sides extending downward and the flange-bulges 126fg at the corner of the flanges 301b and the web 301a and are braced by hole protrusions 36p that extend above the web 301a. The longitudinal sides have lips 301c extending the length of the flanges 301b with lip notches 12p extending inward from the free edges. The angled flanges 301b and lips 301c are the same on both the left and right sides of the holes 36. The left side is held in place by the lip notches 126p extending around both the side planes of the web 42a and the web 301a has its top plane fitting under the hole protrusion 36p keeping the reverse lip spacer brace 301 secured within the hole 36. In the isometric view FIG. 390 shows an extended lip 301ce that is also angled. The extended lip 301ce has the lip notch 126p extending inward from the free edge of the extended lip 301ce. FIG. 390 could also be a U-shaped spacer brace 302 having flange notches 126f extend into the hole protrusion 36p or on the hole bottom edge 36be, because the hole protrusion 36p gives the U-shaped spacer brace 302 an entirely new invention as the hole protrusion 36p keep the U-shaped spacer brace 302 from moving vertically within the hole 36.

FIGS. 392, 394 & 396 shows a plan view of the lip-notched receivers 129pnr being attached to a reverse lip spacer brace 301 shown in FIG. 361 FIGS. 393 & 395 reverse lip spacer brace 301 have the side planes extending upward from the web 301a at a slight inward angle and the flanges 301b have vertically oriented flange slot holes 36fs. The vertical flange slot holes 36fs are shown in FIG. 361 where the lip-notched receivers 129pnr are installed at a diagonal securing two horizontal spacing-bracing channels together to reduce shear between framing members. FIG. 392 shows a reverse lip spacer brace 301 with the longitudinal end is shown as a lip notched receiver 129pnr. The lip notched receiver 129pnr has the web 301a form a receiver extension 129rx which wraps around the lips 301c of a crossing reverse lip spacer brace 301 shown in section so the receiver notches 126r are secured into the lip notches 126p of the crossing reverse lip spacer brace 301. FIGS. 394 & 396 also show the lip notched receiver 129pnr, however the lip notched receiver 129prn is installed from the underside or the outside for the web 301a or the crossing reverse lip spacer brace 301. The receiver extension 129rx extends around the outside of the web 301a and receiver elbow 129rb extends into the vertically oriented flange slot holes 36fs while the opposing end could be secured to the lip notches 126p of the lips 301c as explained above.

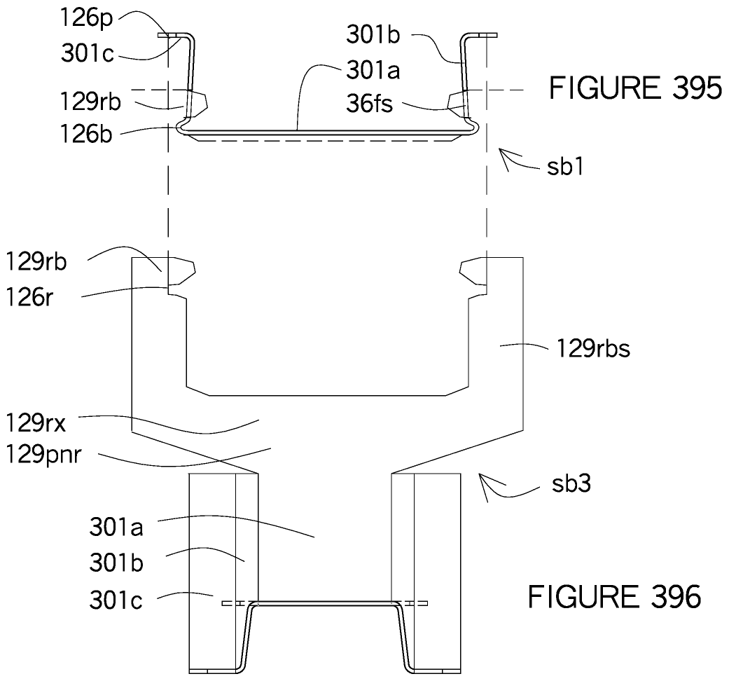

FIG. 396 is similar to FIG. 394 except the lip notched-receiver 129pnr has a stem 129rbs at the receiver elbow 129rb that extends around the flange 301b of a reverse lip spacer brace 301 shown in FIG. 395. The receiver-stem 129rbs can extend around a receiver bulge 129rb or pass through a bulge notch 126g for added strength and rigidity. The receiver stem 129rbs extends into the receiver notch 126r that is secured into the lip notch 126p at the lips 301c or the reverse lip spacer brace 301 shown in FIG. 394.

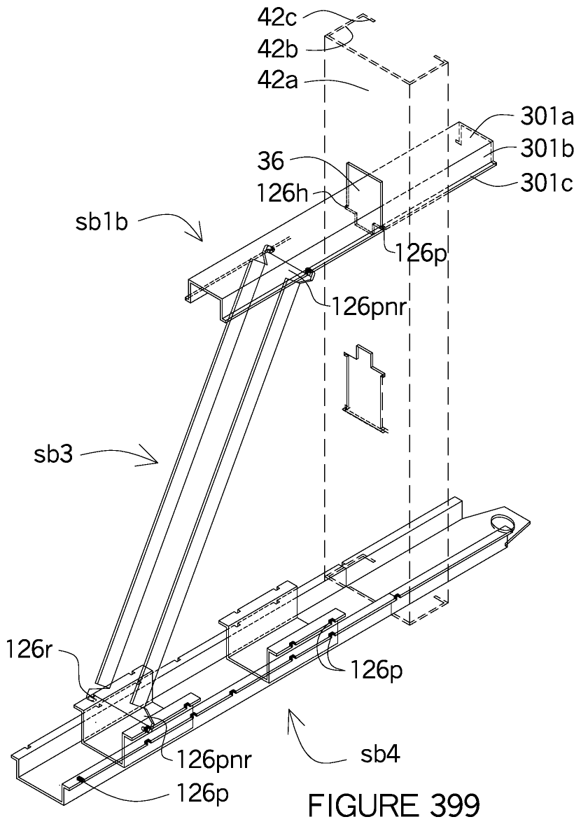

FIGS. 397-398 shows an isometric view of the longitudinal spacing-bracing member intersecting the support members at the web 42a of the C channel 42 as shown in FIGS. 369 &370. FIG. 398 shows the web 42a extend under the web 42a of the support member and connected by the hook finger 127 at the end of the reverse lip spacer brace 301. FIG. 397 shows an enlargement the of lip notched receiver 129prn with the receiver extension 129rx extend from the web 301a and the receiver elbow 129rb extend around the lips 301c so the receiver notches 126r extend into the lip notches 126nt of the reverse lip spacer brace 301. The lips 301c are shown bending at an angle upward or downward giving additional strength and resistance to the connection. In addition the reverse lip spacer brace 301 can be shorter for example as shown in FIG. 361 where the reverse lip spacer brace can slide between a larger U shaped spacer brace 302 to possibly make a tighter fit between the diagonal reverse lip spacer brace 301 and the U shaped spacer brace 302. FIG. 399 also shows another reverse lip spacer brace 301 passing through the hole 36 with the lip notches 126p interlocking to the hole notches 126h. Then the reverse lip spacer brace 301 continues through the hole 36 where the lip notches 126p at the underside of the reverse lip spacer brace 301 are connected to the receiver notches 126r in the lip notched receiver 129pnr completing a diagonal intersection between metal framing members.

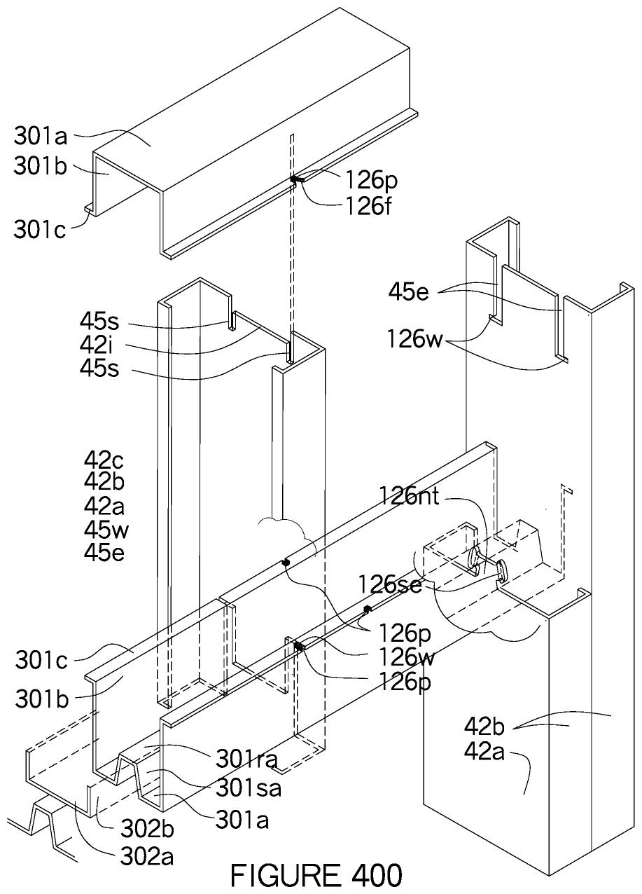

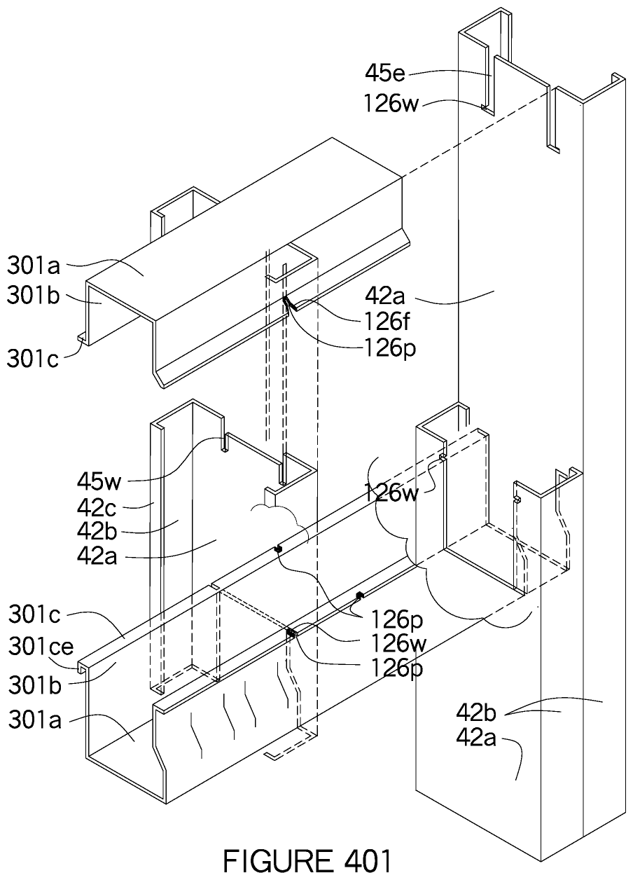

FIGS. 400 & 401 show two partial isometric views of metal framing members forming a beam between vertical support members. Both FIG's show C channels 42 as vertical support members with a shorter vertical support member known as cripples adjacent to both the vertical support members. The beam spans between the cripple and attaches to the support members. In FIG. 400 the beam is shown as a reverse lip spacer brace 301 having a web 301a with longitudinal extending flanges 301b and lips 301c extending outwardly and longitudinally from the flanges 301b. The web 301a of the reverse lip spacer brace 301 has a raised web 301ra with flange slot holes 36fs located on both the sloped web edges 302sa. The top edge of the web 42 of the support member has a notched-tab 126nt extending above the web 42a as shown in FIG. 383, however the nt-heads 126nth extend through the flange slot holes 36fs are similar to FIG. 384. In FIG. 401 the web 42a of the horizontal spacing-bracing member has the profile of a lip notch 126p at the outside plane of the web 301a which is the same shape of a lip notched receiver 129pnr. The notched-tab 126nt from the top of the support member would then extend into the profile of the notched-tab receiver 129nt in the web 301a of the reverse lip spacer brace 301. The vertical support members above the beam are connected in the web by the web gap 45w and the web notches 126w or the slide gap 45s as previously explained. In FIG. 401 the reverse lip spacer brace 301 shows the left lip 301c with a horizontal lip notch 126p that fits into the horizontal web notches 126w. In FIG. 400 the top end of the left spacer brace shows two slid gaps 45s in the web 42a and an indentation 42i so the C channel 42 can slide vertically within the slid gaps 45s and within in the lip notches 126p or the reverse lip spacer brace 301. The lip notches 126p in FIG. 401 on the right side shows downward sloping angled lip notches 126p with flares 126f for an faster and easier installation. On the other the lip notches 126p could have an acute angle at the lip notches 126 which would be stronger when connecting to acute angled web notches 126w. In FIG. 401, the cripple is shown as a reverse lip spacer brace 301 where one flange 301b has two bends in the flange 301b for extra strength. The lip 301c is shown having a lip extension 301ce extending downward also adding additional strength to the beam. In FIG. 401 the cripple has an indentation 42i for the web 301a and flanges 301b can fit into and the support member has web notches 126w for the lips 301c along with the lip notches 126p to fit into. The reverse lip spacer brace 301 can also be configured using bulges 301g or different hole variations can also change the shape of the header. Additional metal framing members can be added as inserts or flanges 301b and lips 301c could have additional framing bends to increase the strength. What is important is the reverse lip spacer brace 301 is connected to the shorter support member without using fasteners.

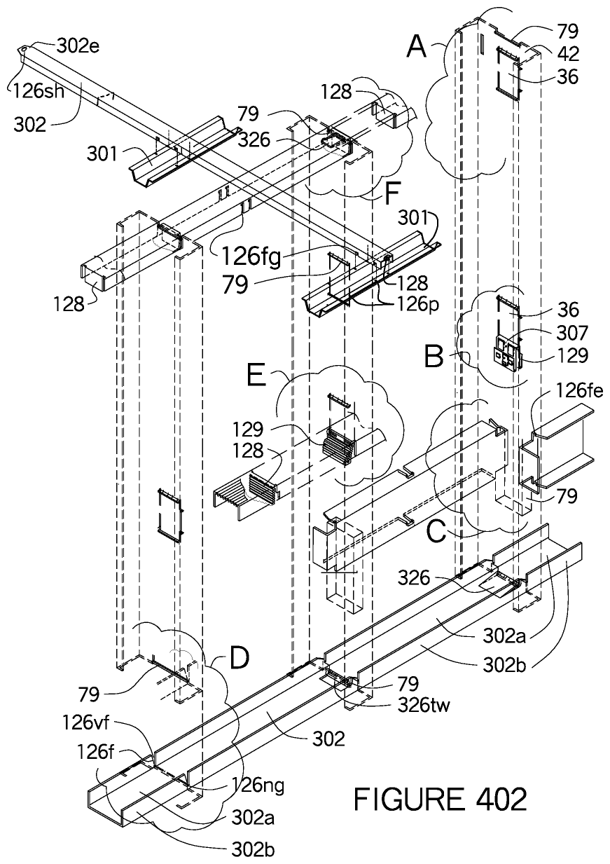

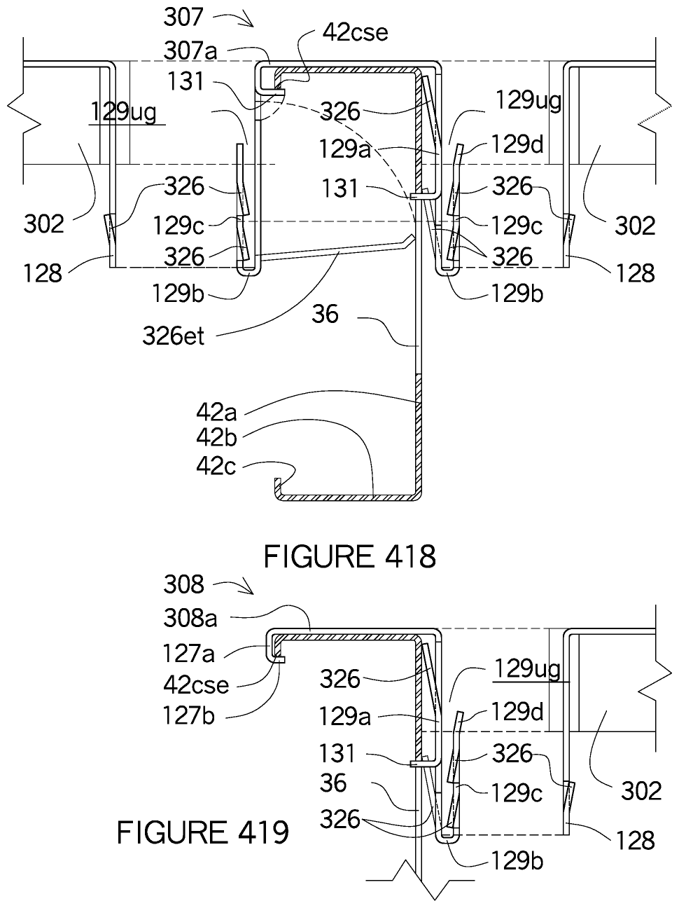

A DESCRIPTION OF THE PREFERRED EMBODIMENTS in FIG. 402 through FIG. 442 as well as other metal framing connections not previously disclosed

The drawings show various types of connections using interlocking spacer braces, bracing clips, hook clips and bracing brackets that connect different building construction components together to form integrated building wall and floor assemblies using the light gauge metal framing. The spacer braces connect vertical or horizontal support members together individually, diagonally and or in tandem between adjacent spacer braces. The bracing clips, bracing brackets can be installed vertically or horizontally so the spacer braces can connect to them to also form diagonal spacer braces giving the flexibility to form a framing structure using wood or metal framing support members. Interlocking Thermal Insulating Blocks referred to as spacer blocks fit between the support members using the support members and spacer braces and their brackets and clips to secure the spacer blocks to the support members.

FIG. 402 shows an isometric view crisscrossing metal framing members highlighting various figures described within the cloud formations. Many different configurations or variations are shown throughout this application, for example Cloud A shows a hole 36 with ledges for a W-shaped clip 307 shown in FIGS. 17 & 18 and at the top and bottom edge of the web in support members. Cloud C shows the U shaped spacer braces 302 installed vertically at the hole 36 as described in FIG. 2, but also shown in many wood vertical support members. Cloud D shows three different configurations of how the ledge 79 is installed in vertical-flange notches 126vf or wrap-around tab 326tw or a tab 326t from a punched out tab 326 more fully described in other figures. Clouds E & F show the hook tongue 128 installed using the hook receiver 129 along with punched out tabs 326 or ledges 79 with flange-edge notches 126fe. Between Clouds E & F a U shaped spacer brace 302 shows the reverse lip spacer brace 301 having lip notches connected to the hole side edges with a U shaped spacer brace 301 having flange notches 126fg engaging the lip notches 126p at the notched flange 126ng.

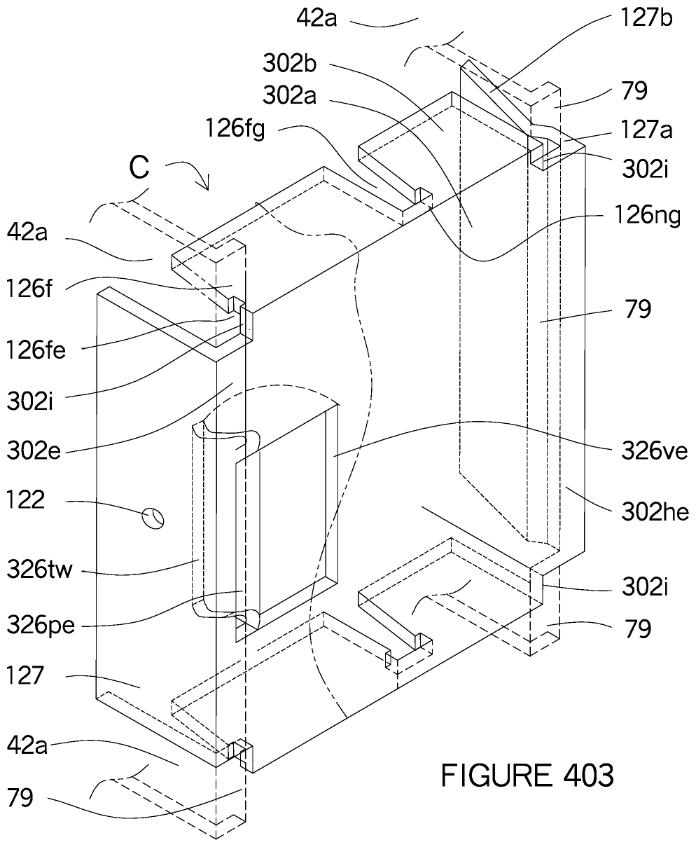

FIG. 403 shows a U shaped spacer brace 302 with a vertical oriented web 302a with the longitudinal side edges shown attached to the longitudinal flanges 302b with the longitudinal ends of the flanges abutting two adjacent support members at the web 42a. Cloud C in FIG. 402 shows three adjacent support members with two intersecting U shaped spacer brace 302 being connected at the right support member at a hole 36 in the support member. FIG. 403 is an enlargement of on U shaped spacer brace 302 where the hole side edge 36se have ledges 79 and with the left ledge 79 extending toward the longitudinal ends of the flanges 302b where the longitudinal ends have flange end notches 126fe engage the side edge of the ledge 79. into the flange end notches 126fe. The opposing end of the longitudinal flanges 302b abut the web 42a of the support member. The web 302a shows the left extension 302e having an indentation at the flanges 302b and web 302 with the extension 302e being a part of the hook finger 127 with the finger portion braced against the opposing side of the web 42a and ledge 79. The right end having the extension 302e that overlaps the adjacent hole 36 having the ledge 79 so the hook finger 127 can wrap around the side edges shown as 127a of the ledge 79 and extend outward away shown as a flare shape 127b around and under the ledge 79 for an easier connection. This connection between support member limits the number of an array of support members and other types of longitudinal end connections between support member. Additional U shaped support member connections can be used at the longitudinal ends to form in tandem connections. A flange notch 126fg is shown in the flanges where additional support members can be connected to the U shaped space brace 302 as noted and described in later FIG.s where one or two flange notches 126ng can be incorporated into the same flange notch 126fg should the web 42a of two adjacent support member have flanges 302b extending in opposite directions.

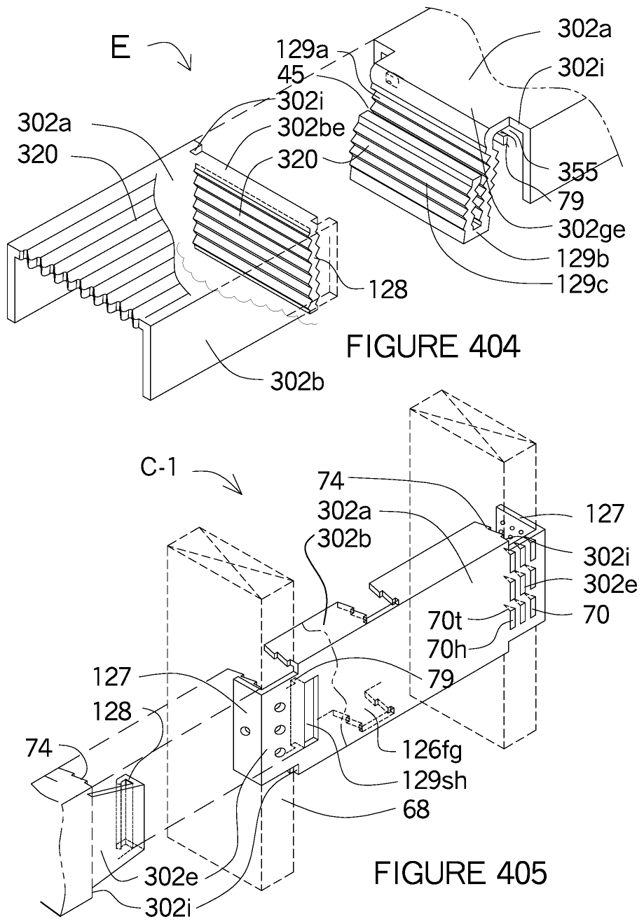

FIG. 404 shows two intersecting U shaped spacer braces 302 intersecting a the support member with the end of the left U shaped spacer brace 302 having a hook tongue 128 extending downward from the web 302a at the left U shaped spacer brace 302 with the longitudinal ends of the flanges 302b extending around the hook receiver against the web 42a of the support member. The right U shape spacer brace 302 has the hook receiver 129 extend through the hole 36 with the ledge 79 extending away from the web 42 of the support member toward the hook receiver 129. The hook receiver 129 has a bend in the first leg 129a so part of the first leg 129a is engaged under the protruding ledge 79 from the hole 36. The hook receiver 129 is similar to the hook finger bent around the ledge 79 as shown in FIG. 403. Both the hook tongue 128 and hook receiver 129 have ridges 320 that form an abrasive means to secure the hook tongue 128 and hook receiver 129 together. The self-locking connection of the flanges 302b pinned between the first leg 129a of the hook receiver 129 and the notch 126 and the first leg 129a of the hook receiver 129 having an in-out undulation in the first leg 129a is the opposing direction abrasive means. The undulation of the first leg 129a is probably equal to the thread of many screws to obtain the same abrasive means between the two surfaces. In an earlier pending applications like FIG. 350 in U.S. Ser. No. 15/430,781 shows hole notches 36n and various other hook receivers 129 and hook tongues 128 all designed to eliminate vertical and horizontal movement between the U shaped spacer brace 302 and the support member.

FIG. 405 is similar to FIG. 402 shown in pending application U.S. Ser. No. 14/946,378 except the wood framing members 68 are oriented vertically instead of horizontally as shown in FIG. 402 in C-8 at the rafters or truss joists. The U-shaped spacer brace 302 has the web 302a oriented horizontally and the flanges 302b extend inwardly toward the opposing side edge of the wood framing member with the longitudinal ends of the flanges 302b having jagged edges 74 penetrating the wood framing members 68. The web 302a can have holes for nails to penetrate the wood framing members 68 or punched hole teeth 70. The interior side of the hook finger 127 has dimples 125 as an abrasive means for a better connection since wood framing members 68 usually have an uneven surface. Punched hole teeth 70 are shown on the exterior side of the extension 302e in the U-shaped spacer brace 302 with the teeth 70t from the punched hole 70h extending inward to penetrate the wood framing member 68. In FIG. 139 in U.S. Ser. No. 14/946,378 shows a flange extension 302e extending across the wood framing member 68 and the longitudinal ends of the flanges 302b are shown with jagged edges 74. The flanges have flange notches 126fg for intermediate wood framing members 68. The U shaped spacer brace 302 also shows how another U shaped spacer brace 302 can be connected in tandem by having a receiver slot hole 129sh with a ledge 79 extending from the side edges of the receiver slot hole. The opposing end of the U shaped spacer brace 302 or the adjacent U shaped spacer brace 302 shows the longitudinal ends of the flanges 302b having jagged edges 74 with the web 302a having an extension 302e forming a hook tongue 128 with a J-shape end that extends around the ledge 79 of the receiver slot hole 129sh.

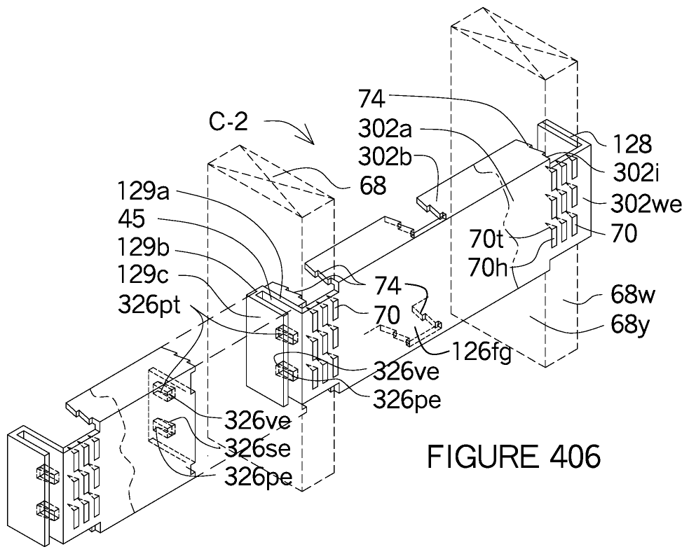

FIG. 406 shows the U-shaped spacer braces 302 in FIG. 402 installed with the interior side of the web 302a has an extension over the vertically oriented wood framing members 68. The web 302 has two flanges 302b extending outwardly with jagged edges 74 at the ends of the flanges 302b that penetrate the depth 68d into the wood framing members 68. The flanges 302b and webs 302a are indented at the depth 68w at the indentations 302i and the flange extension 302fe extends over width 68w of the wood framing member 68 also referred to as the anchor space 355 to the opposite side of the depth 68d for a hook receiver 129 having a first leg 129a then extended 90 forming the second leg 129b and extending parallel to the first leg 129a forming a gap 45 between the first leg 129a and the third leg 129c. Fasteners 122 (not shown) maybe installed in the hook receiver 129 or at the extension 302e for a secure connection. Punched hole teeth 70 are shown at the web extension 302we in the U shaped spacer brace 302 so the teeth 70t for the punched hole 70h can penetrate the wood framing member 68. The opposing end of the U-shaped spacer brace 302 shows the hook tongue 128 or when the adjacent U-shaped spacer brace 302 is installed, the hook tongue 128 fits into the hook receiver 129. Other types of hook receivers 129 or hook tongues 128 are shown in FIG. 402 that could also be interchanged with the present application. In addition, the hook receiver 129 or hook tongue 128 can have bumps, abrasions or curvilinear or any other means to create frictional means between the ventral side of the hook receiver 129 at the wood framing member 68 or metal framing members shown in other figures. Typically the U shaped spacer brace 302 is wider than the hook receiver 129 in order for the flanges 302b with the jagged edges 74 to extend into the wood framing member 68.

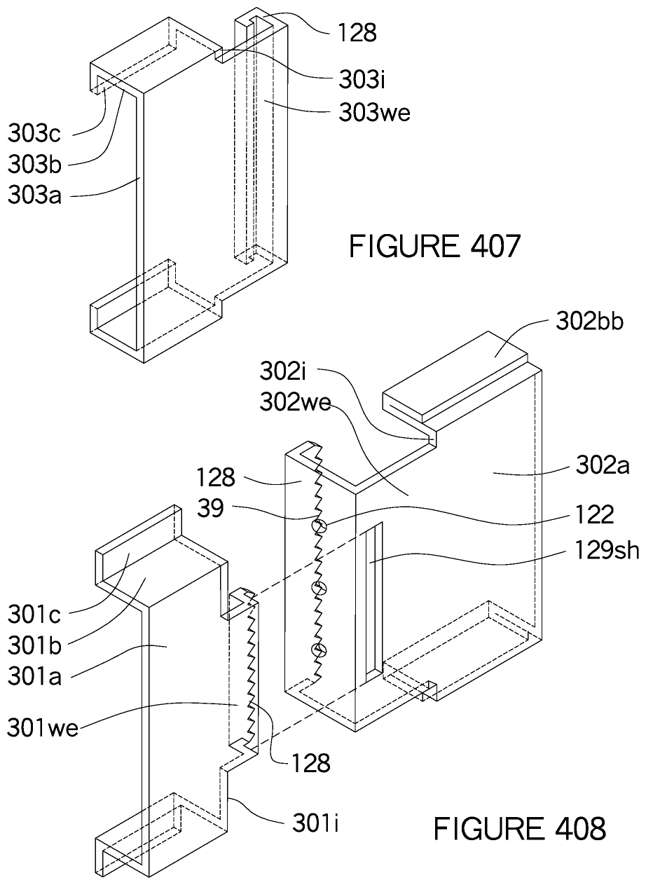

FIG. 407 shows an enlargement of the longitudinal end connection between a C shape spacer brace 303 oriented horizontally where the web 303 has an extension 303e that would extend over the side edge of a hole 36 or over the flange 303b or other types of spacer braces where a hook tongue 128 can extend into a receiver slot hole 129sh. The longitudinal end connection between a C shape spacer brace 303 is oriented horizontally over where the extension extends over exterior side or a vertical side or a support member and where the C shaped spacer brace 303 has flanges 303b extending horizontally and the lips 303c that extend inwardly forming a C-shape. An indentation 303i is formed at the flanges 303b and web 303a with an web extension 303we where a hook tongue 128 is shown having a U-shape similar to FIG. 408 where the U-shape engages the ledges 79 or the side edges of the slot hole receiver 129sh.

FIG. 408 shows a cut-off section of the reverse lip spacer brace 301 on the left side with a vertical orientation having a web 301a with flanges extending inward from the web 301a with lips 301c extending outwardly from the flanges 301b. The hook tongue 128 extends inwardly toward the receiver slot hole 129sh of an a U shaped spacer brace 301. The hook tongue 128 has an indentation 301i with an web extension 301we and a hook tongue 128 extending inward on the inside of the U shaped spacer bracer 301 and then extending outward with jagged edges 74 toward the wood support member 68 (not shown). The vertically oriented web 302a of an adjacent U shape spacer brace 302 has double flanges 302bb with the first flange extending from the web 302a extends inwardly and then bent 180 degrees creating a second flange with an indentation 302i and web extension 302he. The web extension 302we is slightly longer for a receiver slot hole 129sh so the hook receiver 129 with its L-shape end and abrasive edge or also referred to as a fixation means that would grip a support member placed against it. The interior side of the web extension 302we the anchor space 355 and the receiver slot hole 129sh along with the hook tongue 128 become the third connection means.

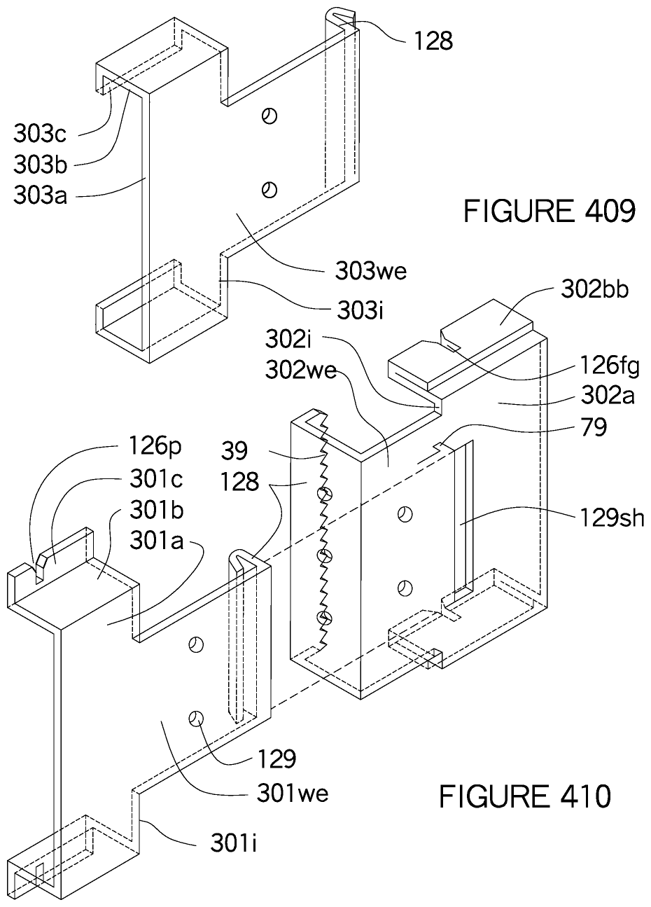

FIG. 409 is similar to FIG. 408 except the web extension 302we is longer and extends over the wood framing element 68 (not shown). The end of the web extension 302we has a hook tongue 128 having a J-shape where the “J” portion extends forward able to wrap around a ledge 79 within a receiver slot hole 129sh of an another U shaped spacer brace 302 having double flanges 302bb.

FIG. 410 is similar to FIGS. 408 & 409 except the hook tongue 128 also has the “J” shape, but the “J” portion is extending back toward the web 302a so the “J” portion can wrap around the ledge 79 of the receiver slot hole 129sh.

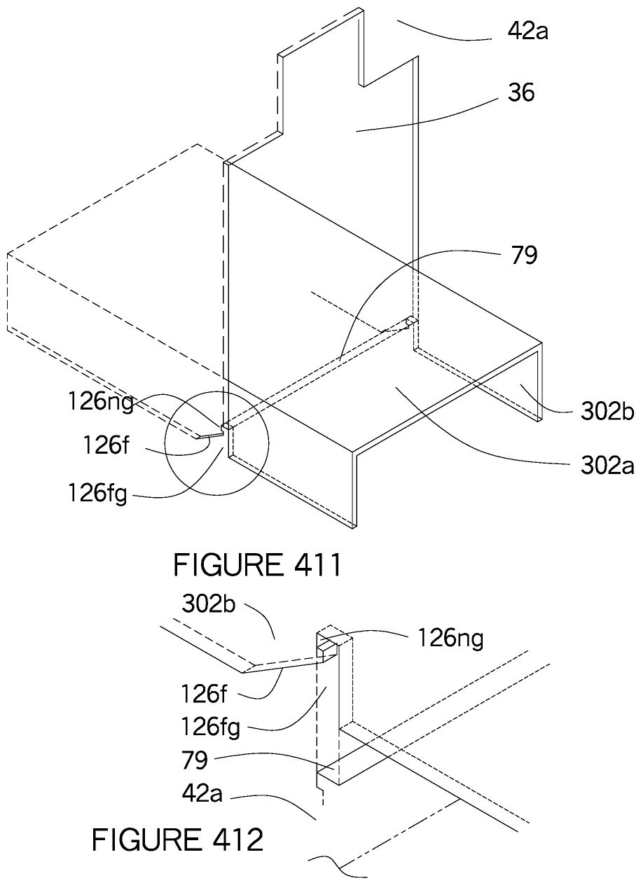

FIG. 411 also shows the shows the U shaped spacer brace 302 fitting into the hole 36 having the outside of the web 302a facing upward with the flanges 302b extending downward against the hole bottom edge 36be, The flanges 302b have flange notches 126fg that extend midway into the flanges 302b having a flare edge 126f on one edge when engaging the ledges 79. The enlargement in FIG. 412 shows the flanges 302b with the flange notches 126fg extending from the hole bottom edge 36be having notches flanges 126ng at the blunt end for the ledge 79 engages the flanges notches 126fg securing the U shaped spacer brace 302 to the ledge 79 of the support member.

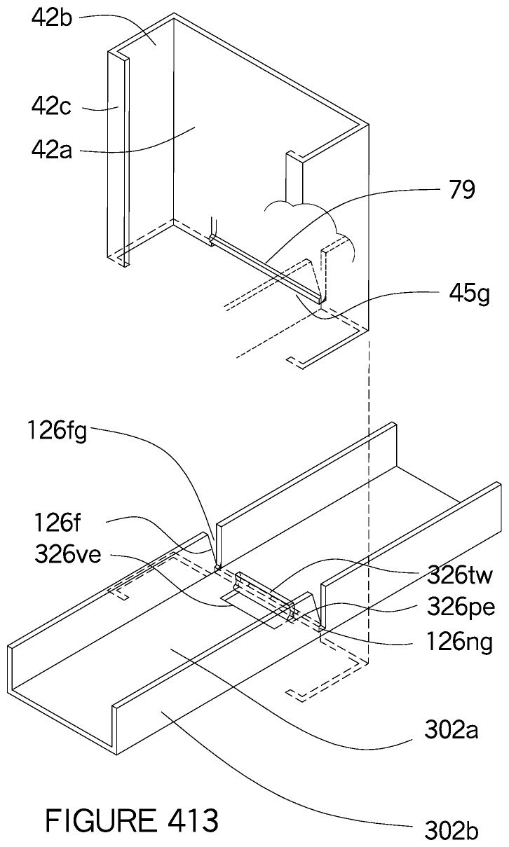

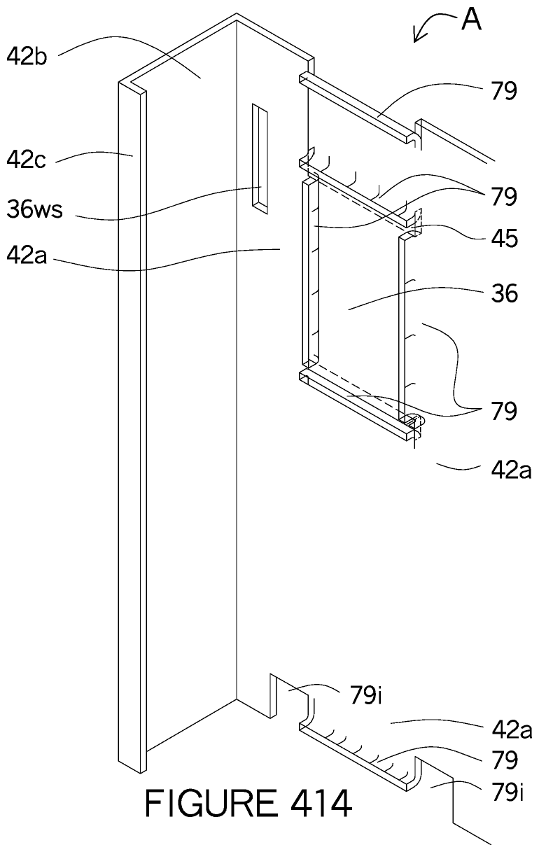

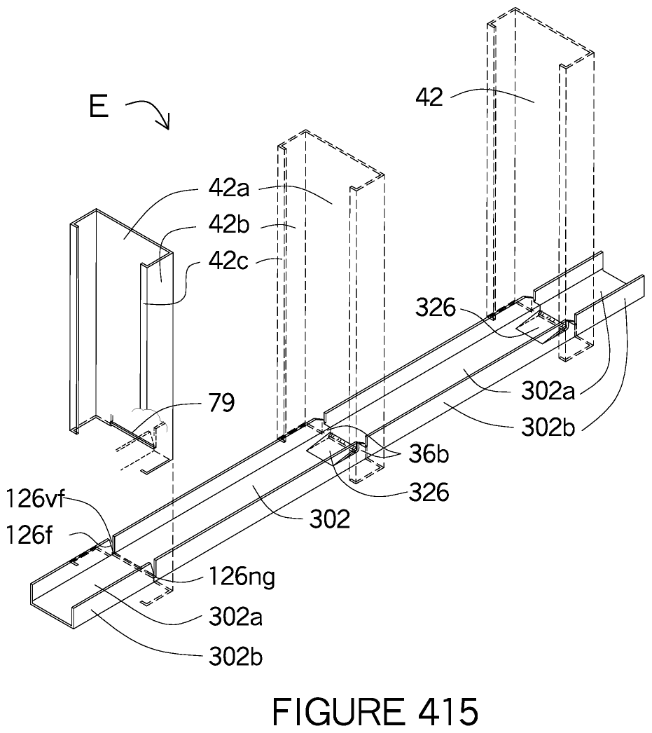

FIG. 413 is similar to FIGS. 415 & 416 where the U shaped spacer brace 302 has the exterior side facing downward and intermediate support members intersect the U shaped spacer brace 302. The ledge 79 is shown protruding outwardly from the web 42a in the direction of the flanges 42b at the end of the support member. The length of the ledge 79 is shown the width of the U shaped spacer brace 302 and shown in FIG. 414 having a ledge gap 45g, however the ledge 79 can be any length in order for the web 302a of the U shape spacer brace 302 to fit into the flanges 302b. The flanges 302b has a vertical-flange notch 126vf for the web 42a to fit into and a notched groove 126ng for the ledge 79 to fit into when inserted into the U shaped spacer brace 302. The vented edge 326ve of the punched out tab 326 is located on the protruding side of the ledge 79 so the pivot edge 326pe can have the wrap-around tab 326tw extend over and under the protruding top, front and bottom edge of the ledge 79. The web 302a of one U shaped spacer brace 302 shows the web 302a having a wrap-around tab 326tw from the punched out tab 326 with the vented edge 326ve close to the ledge 79 so the wrap-around tab 326tw can be installed under the ledge 79.

FIG. 414 shows an isometric view of a support member shown as a C channel 42 having a web 42a with flanges 42b extending ventrally inward with lips 42c extending ventrally parallel to the web 42 which is also shown in Cloud A & D in FIG. 402. The web 42a shows ledges 79 at the top, bottom and on all four edges of the hole 36. The ledge 79 at the top of the support member extends ventrally inward with the width shown as wide as the hole 36 below; however the length of the ledge 79 can be any length as shown in other figures. The ledge 79 at the bottom of the web 42a in the support member is shorter and has a ledge indentation 79i on both sides of the punched out tab 326 extending ventrally inward located in the center of the web 42a, also shown in FIG. 415. The ledge indentation 79i are shown on both sides of the ledge 79 to allow the flanges 302b of the U shaped spacer brace 302 to pass through. The ledge 79 in the hole 36 shows the ledge 79 the top and bottom edge to be longer than the hole 36 width. The ledge 79 shown vertically at the hole 36 initially starts to bend at the side edges of the top and bottom ledges 79. The overlapping edges of the ledges 79 allow the ledges 79 to extend to each corner of the hole 36 rather than having a gap of no ledges 79 in the corners of the hole 36. Another hole shown as a vertical oriented web-slot hole 36ws is installed in the web 42a the edge of the lip 42c is setback the same distance from the web 42a.

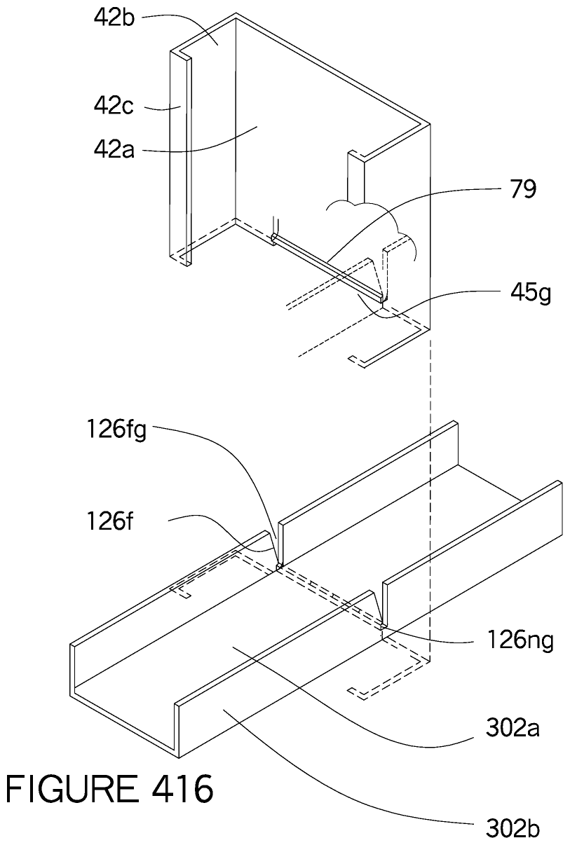

FIG. 415 is similar to FIG. 402 highlighted as Cloud D. The bottom edge of the support member shows the ledge 79 the full width of the U shaped spacer brace 302 and shown in the enlargement in FIG. 416. The U shaped spacer brace 302 is shown with the U-shape facing upward with the outside plane of the web 302a against a floor. The flanges 302b have vertical-flange notches 126vf on both flanges 302b with one side edge having a flared edge 126f with a notched flange 126ng for the ledge 79 to fit into. The ledge 79 is shown at the bottom edge of the web 42a of the support member. In FIG. 416 the underside of the ledge 79 is supported at the anchor space 355 on the web 302a of the U shaped spacer brace 302 leaving a ledge gap 45g between the underside of the ledge 79 and the bottom edge of the support member. As stated earlier the ledge 79 can be short, the depth of the treaded screw or greater depending on the pressure exerted on the ledge 79. If the ledge 79 is too long, then the ledge 79 would have to be longer than the support member in order for the ledge 79 to bear directly onto the 42a of the C channel 42. The pending application U.S. Ser. No. 15/430,781 in FIGS. 403-413 the web at the hole bottom edge 36be or at the longitudinal ends of the support member show additional configurations for ledges 79 or hook tongues 128 that could be an additional variable to connect the framing members together.

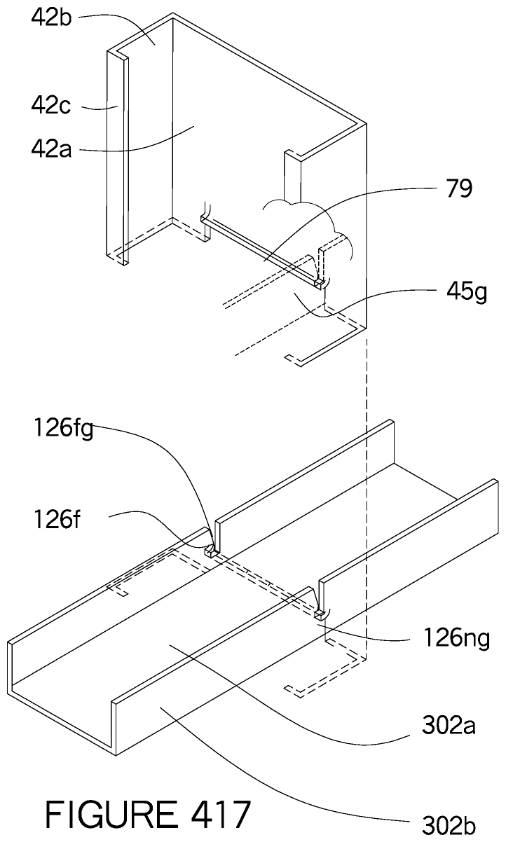

FIG. 416 is similar to FIG. 417, however the vertical-flange notch 126vf extends only partially into the flange 302b leaving a larger ledge gap 45g than in FIG. 417. The ledge 79 is elevated above the web 302a so the ledge 79 only has the two side flanges 302b at the notch flange 126ng to rest onto. The ledge 79 shown in FIG. 414 shows an indentation 79i in the web 42a so the web 42a of the support member at the ledge indentations 79i could rest onto the vertical-flange notches 126vf. An additional ledge 79 would have to be installed at the ledge indentation 79i in order for the ledge 79 to be installed into the notch flange 126ng.

FIGS. 398 & 399 shown are now referred to as FIGS. 416 & 417 in this present application. FIG. 416 is similar to FIG. 415, however the flange notch 126ng extends only partially into the flange 302b leaving a larger ledge gap 45g than in FIG. 415. The ledge 79 is elevated above the longitudinal end of the web 302a in the support member so the ledge 79 will engage the two side flanges 302b with the notch flange 126ng at the blunt end of the flange notch 126ng. The ledge 79 shown in FIG. 435 shows an indentation 79i in the web 42a so the web 42a of the support member at the ledge indentations 79i could rest onto the flange notches 126fg. An additional ledge 79 would have to be installed at the ledge indentation 79i in order for the ledge 79 to be installed into the notch flange 126ng.

FIG. 417 also shows the shows the U shaped spacer brace 302 fitting into the hole 36 having the exterior side facing upward with the flanges 302b extending ventrally downward and where the flanges 302b with flange notches 126fg extend about half the width between the web 302a and the longitudinal edged of the flanges 302b. The longitudinal ends of the support member shown as a C channel with ledge 79 extend outward toward the flanges 42b and lips 42c of the C channel with a ledge gap 45g below the ledge 79 allowing the web 42a, flanges 42b and lips 42c to be support on the U shaped space brace 302 and on the surface where the underside of the web 302a is installed and fastened too. The flange notches 126fg on both flanges 302b has a flare edge 126f so the U shaped spacer brace 302 will easily slide into the flange notches 126fg.

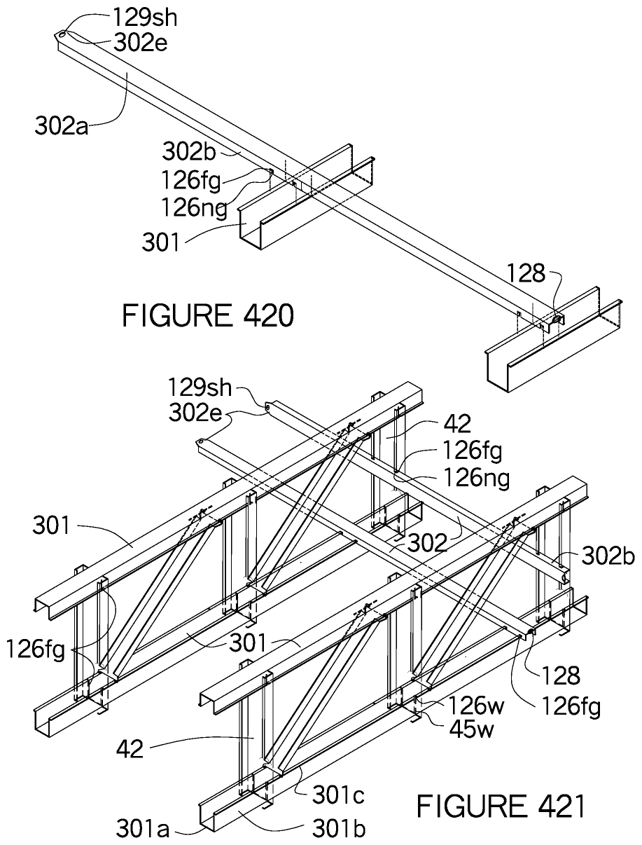

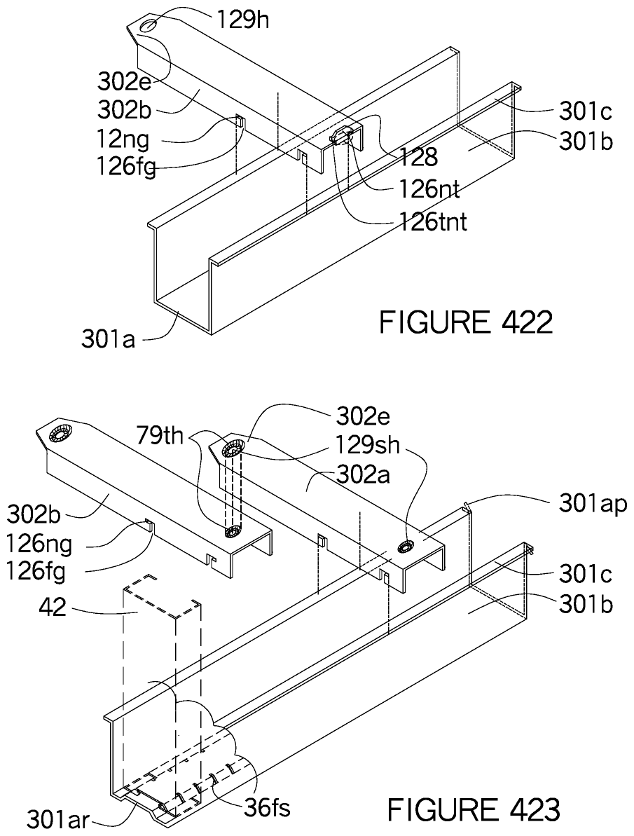

FIGS. 420 & 421 shows a horizontal longitudinal lateral bracing member crossing the bottom chord of two trusses and long enough to be connected to a notched-tab 126nt at one longitudinal lateral bracing member of a adjacent U shaped spacer brace 302 with the opposing end having a web extension 302 having a receiver hole 129h for the notched-tab 126nt to fit into. FIG. 422 shows an enlargement of the intersection of the bottom chord with the exterior side of the web 301a facing downward and the longitudinal flanges 301b and longitudinal lips 301c extend the full length of the truss. The horizontal bracing member crosses and interlocks the bottom chord and is oriented so its exterior side is facing upward and the longitudinal flanges 302b extend downward toward the bottom chord of the truss. Since the lips 301c are located on the bottom chord, the flanges 301b and the lips 301c will extend into the flange gaps 45fg and the lips 301c will extend into the flange notches 126fg on both flanges 302b making four interlocking connections at the intersection. The short horizontal bracing member will probably be installed when the trusses are installed, while a longer length horizontal bracing member would be installed after many trusses are installed in place. Diagonal bracing members can be used, however the flanges gaps 45fg and flanges notches 126fg would be spaced differently plus lip notches 126p can be installed.

FIG. 423 shows one of the methods used in connecting a vertical support member to a horizontal bracing member. In FIG. 438 the horizontal bracing member shown as a reverse lip spacer brace 301 installed in the web 42a of the support member while in FIG. 423 the web 42a & flanges 42b are installed between the flanges 301b of the reverse lip spacer bracer 301 and a raised web 301ar. The flange notches 126fg as shown are similar to the web notches 126w used in the webs 42a of the support member. Since the U shaped spacer brace 302 has two flanges 302b and the crossing member a reverse lip spacer brace 301 having 2 lips 301c, then four connections occur at the crossing of the two members together.

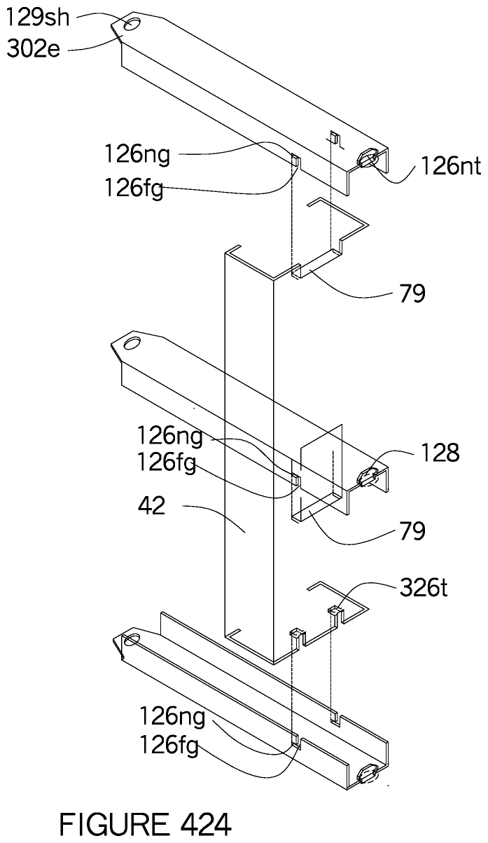

FIG. 424 is similar to FIGS. 422-423 as the flanges 302b of the top, middle and bottom U shaped spacer braces 302 all use the flange gap 45fg and the flange notch 126fg at the flanges 302b to make the connection into the crossing member. The top and middle spacer braces us the ledge 79 at the web 42a to form the ledge 79 and the middle U shaped spacer brace 302 is using the ledge at the hole bottom edge 36be to connect into the notches. On the other hand, the tabs 326t of the punched out tabs 326 act as a ledge 79 when the tabs 326t fit into the L-shaped gap 45e and the tab 326t get inserted into the web notches 126w.

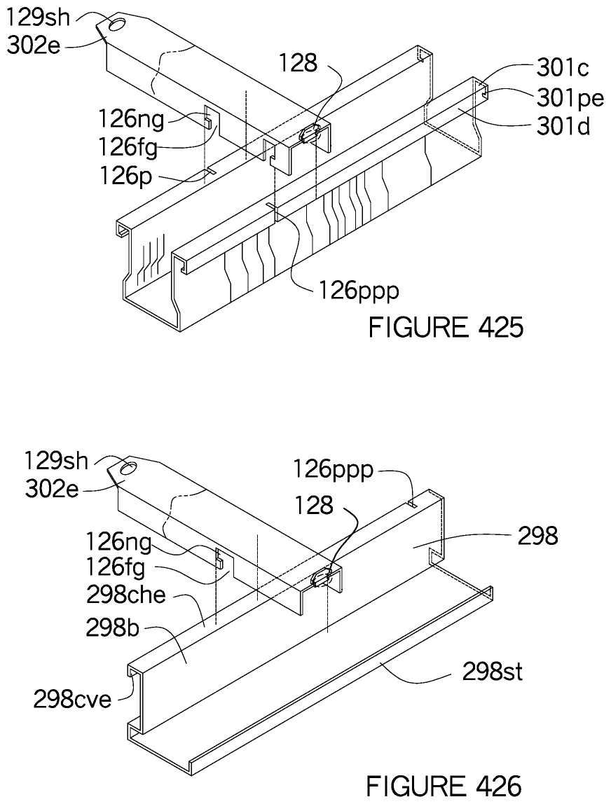

FIG. 425 show an alternative shape for a reverse lip spacer brace 301 presently being manufactured for the longitudinal length of the top and bottom chords of trusses. The lips 301c have a longitudinal vertical lip extension 301d extending down and a horizontal lip extension 301pe extending the full length of the chords. The larger shaped lips 301c corresponds to the larger shaped flange notches 126fg in the flanges 302b of the U shaped spacer brace 302. Lip notches 126p are shown extending through the various lips 301c, 301d & 301pe forming a continuous lip notch 126ppp.

FIG. 426 shows the same U shaped spacer brace 302 crossing a single faced spacer brace 298 also being manufactured here in the US, having a web 298a, with one short leg flange 298sf, and a multi-leg flange 298b with a lip 298c extending from the longitudinal multi-leg flange 298b having a horizontal lip 298che along with a vertical lip edge 298. The vertical lip edge 298cve and the horizontal lip edge 298che both extend into the flange notches 126fg shown in FIG. 425, however only one flange gap 45fg is required at each flange 302b. Lip notches 126p could also be installed similar to FIG. 425. FIGS. 425 & 426 presently do not have lip notches 126p or longitudinal lateral bracing members. Both FIG's do not have a longitudinal lateral bracing members with flange notches 126fg that interlock to the lips 302c of top or bottom chord of the trusses.

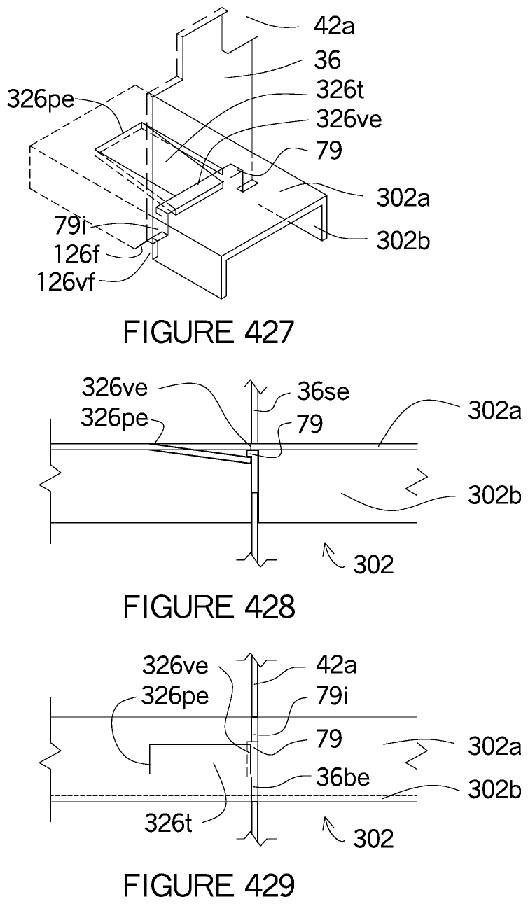

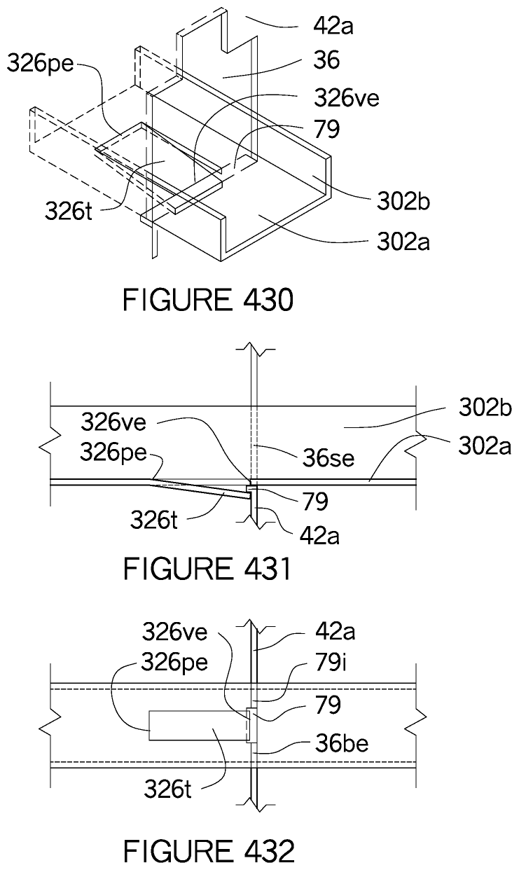

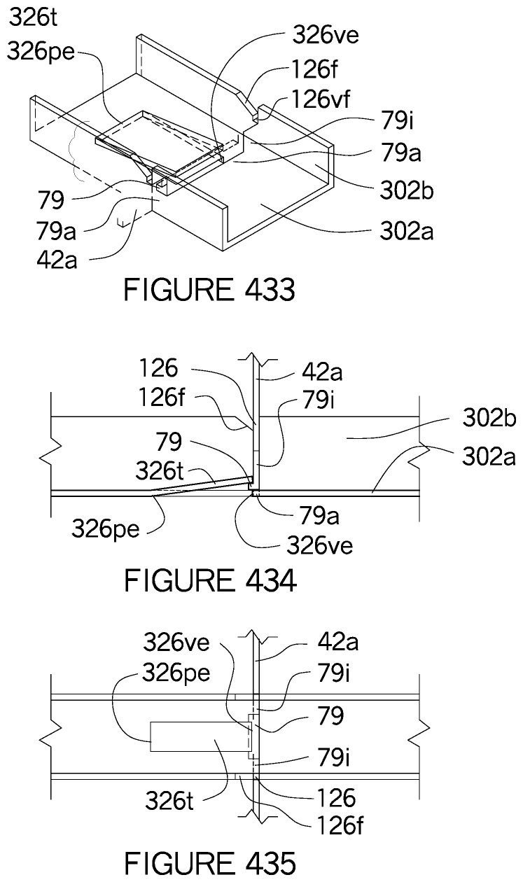

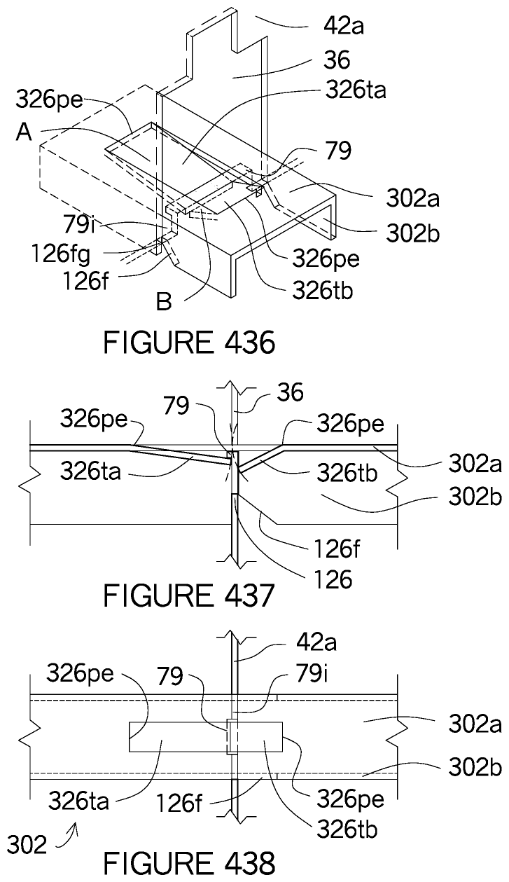

FIGS. 427 through 438 are similar as each group of three figures where each group shows an isometric drawing followed by a cross section and a plan view. FIG. 427 shows a U shaped braces 302 with the longitudinal side edges of the flanges 302b engaging the hole bottom edge 36be where a full width ledge 79 is shown. In addition, the flanges 302b are shown having the flange notches 126fg the full depth of the flanges 302b to the depth of the top of the ledge 79 and a flare edge 126f. FIGS. 427 & 436 show the U shaped spacer brace 302 with the flanges 302b extending downward to the hole bottom edge 36be secured in a flange notch 126fg with one edge having a flare edge 126f. FIG. 427 shows one punch out tab 326 in the web 302a with the vented edge 326ve extended under the ledge 79 in the support member. In FIG. 436 shows two punch out tabs 326 where one vented edge 326ve extends under the ledge 79 and a second opposing vented edge 326ve for the ledge 79 should the ledge 79 protrude in the opposing direction toward the second opposing vented edge 326ve. Other FIG's show a wider width ledge 79 than the width of the hole 36 so the ledge 79 is above the bottom edge of the hole 36 so the flanges 302b can slide into the flare 126f and secured into flange notch 126fg. The FIG's associated with FIGS. 430 & 433 both show the U shaped spacer brace 302 having the web 302a engaging the hole bottom edge 36be with a ledge 79 extending from the web 42a of the support member and where the punch out tab 326 has the vented edge 326ve extend under the ledge 79 of the support member. FIG. 430 shows the ledge 79 between the flanges of the U shaped spacer brace 302 and FIG. 433 shows the flanges notches 126fg with the flare edge 302f. The flange notches 126fg can fit into the web notches 126w in the extended hole side edges as shown in FIGS. 446-448. and in FIGS. 426-432. Any of the U shaped spacer braces 302 can have a ledge indentation 79i located close to the ledge 79 so the tab 326t from the punched out tab 326 can easily penetrate under the ledge 79 and the vertical-flange notches 126vf will not have to penetrate as high into the flange 302b.

FIGS. 433-435 shows an intermediate connection between the support member shown in FIG. 429 only as the web 42a of a C channel 42 and a spacer brace shown as a U shaped spacer brace 302. There can be several support members between the end of the hook receiver 129 of one spacer brace and the hook tongue 128 of an adjacent spacer brace form a longer spacer brace connection as shown in FIG. 402. FIG. 429 shows an isometric drawing of an intermediate connection of a U shaped spacer brace 302 intersecting a C channel 42 shown with only a portion of the web 42a shown. The U shaped spacer brace 302 is shown with the exterior side down facing a floor with the flanges 302b extending upward. The web 42a shows a ledge 79 at the bottom edge of the support member where a ledge space 79a when the ledge 79 is bent to form the ledge 79. The ledge space 79a is occupied by the web 302a of the U shaped spacer brace 302 and the ledge space 79a has a ledge indentation 79i on both sides of the ledge 79 and is indented to the height of the bottom edge of the vertical flange notch 126vf at the flanges 302b. The ledge indentation 79i can be the thickness of the flanges 302b allowing the ledge 79 to be wider between the two flanges 302b or narrower as shown here. Both flanges 302b show the flange notches 126fg with a flare 126f at one side edge of the flange notch 126fg where the web 42a is inserted into the flange notches 126fg. When the U shaped spacer brace 302 is slid into the flange notches 126fg, the tab 326t of the punched out tab 326 extends over the top side of the ledge 79. The U shaped spacer brace 302 is secured when the tab 326t is over the ledge 79 and the web 302a is under the ledge 79 and is additional secured when the web 42a is secured into the flange notches 126fg and the side edges of the ledge indentation 79i is secured to the outside sides of the flanges 302b. FIG. 434 33 shows a section of the connection and FIG. 435 34 shows a plan view of the connection.

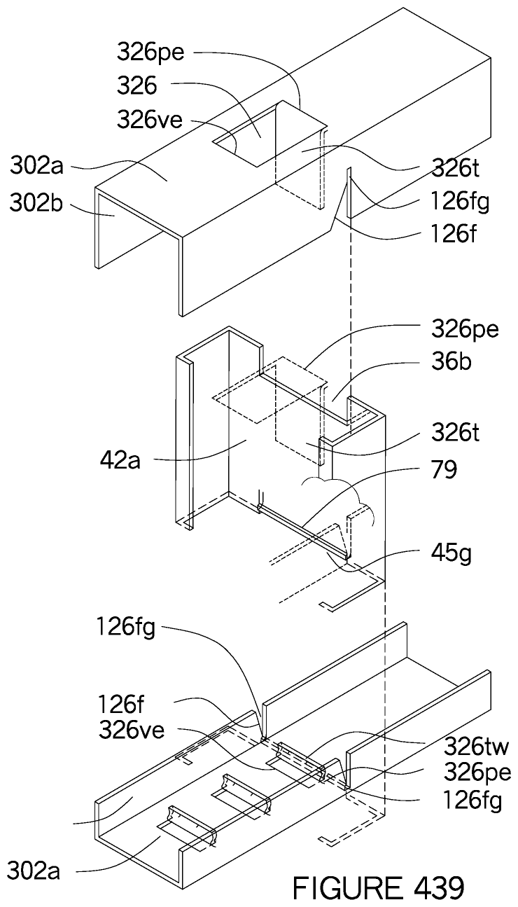

FIG. 436 is similar to FIG. 427, but shows a larger punched out tab 326 having two different tabs 326t as shown. The tab A 326ta is shown on the left side of the hole 36 having a pivot edge 326pe on the left side of the web 42a where the tab A 326ta with the end of the pivot edge 326pe end is installed under the ledge 79 shown protruding outward to the left side. The tab B 326tb shown on the right side has its pivot edge 326pe on the right side of the web 42a and the end of the tab B 326tb also extends downward so the end of the tab B 326tb abuts the right side of the web 42a. Both the tabs A 326ta and tabs B 326tb have their side edges aligned and their front edge abut one another prior to being bent downward to their aligned positions as shown in section FIG. 433. Also shown in FIG. 437 the flanges 302b of the U shaped spacer brace 302 having flares 126f at an angle to allow for the bottom edge of the hole 36 to fit into the flange notches 126fg on both sides. The flange notches 126vf are installed midway from the bottom edge of the flanges 302b so the top side of the ledge 79 can extend slightly higher to align to the ventral side of the U shaped spacer brace at the web 302a. The flares 126f are installed on the opposite side of the hole 36 in FIGS. 427 & 430. The U shaped spacer brace 302 will likely be installed with a side motion so the tab A 326ta can be slide under the ledge 79 while at the same time the tab B 326tb can be pushed downward. If the U shaped spacer brace 302 was reversed with the back side of the web 302a facing downward resting on the ledge 79, the tabs A 326ta and tabs B 326tb would have their vented side edges abut both sides of the web 42a eliminating any horizontal movement between support members and the flange notches 126fg would not be required. The tabs A 326ta and tabs B 326tb can also be consider a ledge 79 when the tabs A & B are considered a receiver slot hole 129sh and a hook tongue 128 (not shown) is inserted into the hole created by the tabs A & B or when only one tab A or tab B is used to form that receiver slot hole 129sh as shown in FIG. 439.

FIG. 439 shows the U shaped spacer brace at the floor with the exterior side of the web 42a facing the floor and the interior side shows the flanges 302b extending upward from the web 302a. At the center of the U shaped spacer brace 302 shows a wrap-around tab 326tw extending from the pivot edge 326pe of the punch out tab 326 wrapping around the ledge 79 extending from the web 42a of the support member shown as a C channel 42. The ledge 79 is shown the same width as the U shaped spacer brace 302. The ends of the ledge 79 get inserted into the flange notches 126fn on both flanges 302b and the end of the ledge 79 is inserted into a notch gap 126ng. The one side of the flange notches 126fn has flare edges 126f so the web 42a can more easily fit into the flange notches 126fn. The wrap-around tab 326tw wraps around the ledge 79 just enough so that the inner side closed the web 42a can extend pass the ledge 79 than veer away from the ledge 79 leaving a sort of angular shape so the web 42a can extend past the wrap-around tab allowing the wrap-around tab to slight bend so the ledge 79 can become lodged into the flange notches 126fg and the notch flange 126ng. After the U shaped spacer brace 302 is installed at the floor another U shaped spacer brace 302 can be installed at the opposing end of the support members. The upper U shaped spacer brace 302 is shown so the support member can move vertically within the wall framing structure. The top end of the C channel 42 shows the web 42a having a bracing hole 36b which is the same width as the U shaped spacer brace 302. The U shaped spacer brace 302 shows its flanges 302b extending ventrally downward from the web 302a. The flanges 302b have flange notches 126fg that extends from the longitudinal side edges of the flanges 302b with one side having a flare edge 126f and the straight edge on the opposite side for a simple and easy connection. The U shaped spacer brace 302 is inserted into the bracing hole 36b so that the flanges 302b are inserted between the side edges of the bracing hole 36b, so the flange notches 126fn engage the bottom edge of the bracing hole 36b. When inserting the U shaped space brace 302, the web 302a has a punch out tab 326 with the tab 326t extending ventrally downward so that the tab 326t is against the web 42a on one side and the opposing side of the web 42a rests against the straight edge of the flange notch 126fg. When the U shaped spacer brace 302 has the exterior side web 302a secured to a floor joist above, the floor joist above (not shown) can bend due to earthquakes or increase floor loading (by live or dead loads) the U shaped spacer brace 302 will slid up and down between the tab 326t and the straight edge of the flange notch 126fn and will also not move sideways as the U shaped spacer brace 302 is wedged between the side edges of the bracing hole 36b of the support member. If the tab 326t was longer in length at the punch-out hole 326, fasteners (not shown) could secure the tabs 326t to the web 42a and if the wall framing structure would be panelized.

FIG. 440 is similar to FIG. 439 the U shaped spacer brace 302 at the top of the support member shown as a C channel 42 having a web 42a with extending flanges 42b, however in FIG. 39 the U shaped spacer brace 302 has a wider web 302a for the flanges 42b of the support member can be installed between the flanges 302b of the U shaped spacer brace 302. The top edges of the support member shows the web 302a being connected to two adjacent overlapping U shaped spacer braces 302. The web 302b of the right U shaped spacer brace 302 shows ledges 79 extending upward from the web 302a of the right receiver slot hole 129sh for the adjacent U shaped spacer brace 302 with an extension 302e and a receiver slot hole 129sh for the ledges of the right U shaped spacer brace 302 to fit into. The ledges 79 at the right receiver slot hole 129sh can overlap onto the receiver slot hole 129sh of the adjacent U shaped spacer brace 302 shown at the extension 302e. The receiver slot holes 129sh can have larger shaped ledges 79 so as to extend around the adjacent ledges 79 of the smaller shaped ledges 79 and receiver slot hole 129sh forming a locked connection or just into a receiver slot hole 129sh without ledges 79. A U shaped spacer brace 302 could have extensions 302e with slot holes 129sh receiver at both longitudinal ends with or without ledges 79 for connection to adjacent U shaped spacer braces 302 having receiver slot holes 129sh with or without ledges 79 to interlock together. The ledges 79 at the receiver slot hole 129sh can function as a locking method when the ends of the hook tongues extends through the receiver slot holes 129sh so the ends of the hook tongue wrap around the ledges to form a secure connection. The function between the hook tongue 128 and hook receiver 129 are reversed as the receiver slot hole 129sh with the ledges 79 are now functioning as a hook tongue 128. In addition, an alternative connection between the hook tongue 128 and hook receiver 129 is shown as the receiver slot hole 129sh is an oval shape where the ledges 79 are short segments as shown in FIGS. 284-289. The curvilinear shape of the receiver slot hole 129sh allows the extension to pivot horizontally as well as vertically. In addition, the U shaped spacer brace 302 can be reversed having the U-shape turned upward or the flanges turned downward against the hole bottom edge 36be. The application shows lips 301c with lip notches 126p that can function the same when the location of the ledges 79 coincide as shown in FIG. 440. In addition as mentioned in previous applications, the curvilinear shape of the receiver slot hole 129sh allow the adjacent reverse lip spacer brace 301 or U shaped spacer brace 302 to be rotated vertically or horizontally at the connections between adjacent spacer braces. The flanges 302b of the U shaped spacer brace 302 show the web 302a with the flanges 302b overlapping the longitudinal end with the flanges 302a overlap and abutting the flanges 42b of the support member. The flanges 302b have flange bulges 302bg where the flange bulge 302bg extends toward the web 302a. When the flange bulges 302bg intersects the flanges 42b of the support member flange-bulge notches 126gf has two vertical cuts per flanges 302b equal to the width of the support member flange 42b, so the flange-bulge notches will flex away the web 302a allowing the flanges 42b to fit between the side edges of the flange-bulge notches 126gf. Depending on the strength required for that intersection, fasteners (not shown) can be installed in the flange-bulge notches 126gf into the flanges 42a of the support member. The opposing end of the support members shows a narrow width U shaped spacer brace 302 as described in FIG. 439.

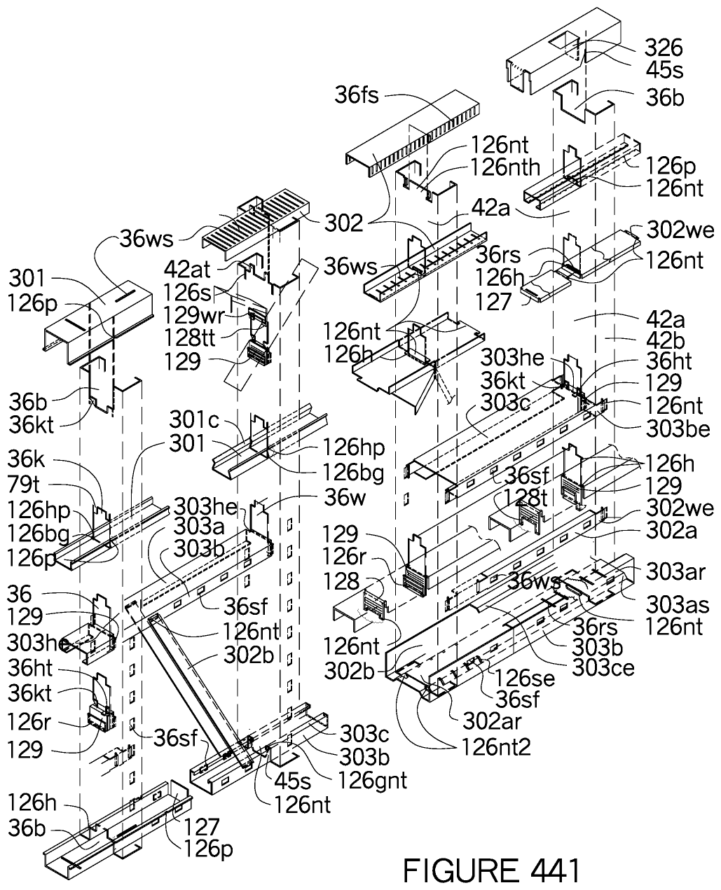

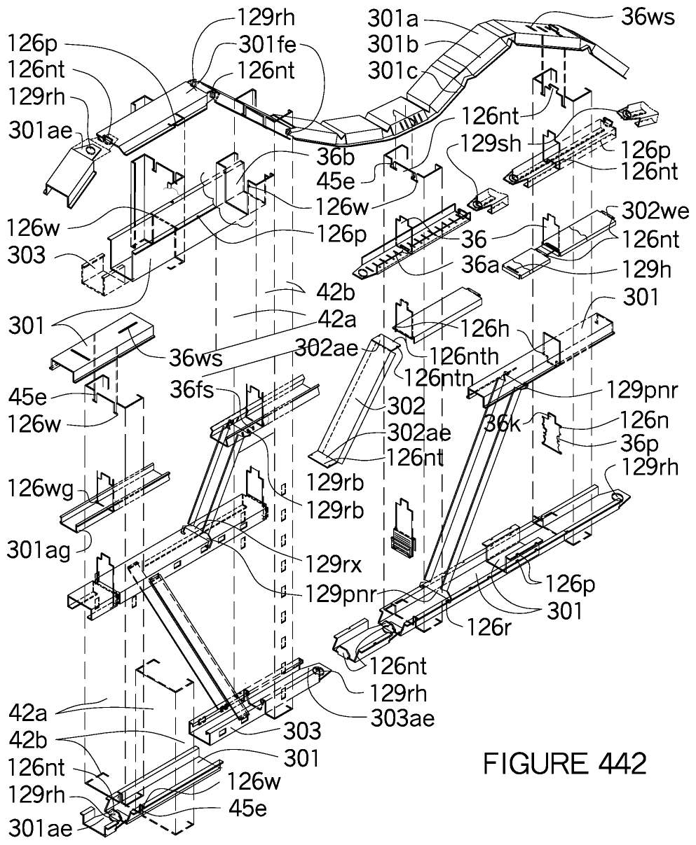

FIGS. 441 and 442 are isometric drawings of various spacing bracing members shown between metal support members and are shown here as reference drawings (0867) In FIGS. 98, 99, 117, 119 & 120 punched hole teeth 70 & jagged edges 74 as well as FIG. 69 or shown as FIG. 220 in this application. The receiver slot holes 129sh, hook tongues 128, notched tab 126nt can all have various types of endings as shown FIG. 284-289 in this application The flange 302b can have a gap 45 with a flange-notch 126fg that can be used to connect to lips 301c or webs having gaps 45 with web-notches 129w use in support members or webs of spacer braces.

The present invention presents a unique self-locking metal framing connection system that is so versatile that spacer braces and vertical support members can be installed easier and quicker than other metal framing systems. It is understood that the invention is not to be limited to the exact details of operation or structures shown and describing in the specification and drawings, since obvious modifications and equivalents will be readily apparent to those skilled in the art. The flexibility of the described invention is very versatile and can be used in many different types of building applications.

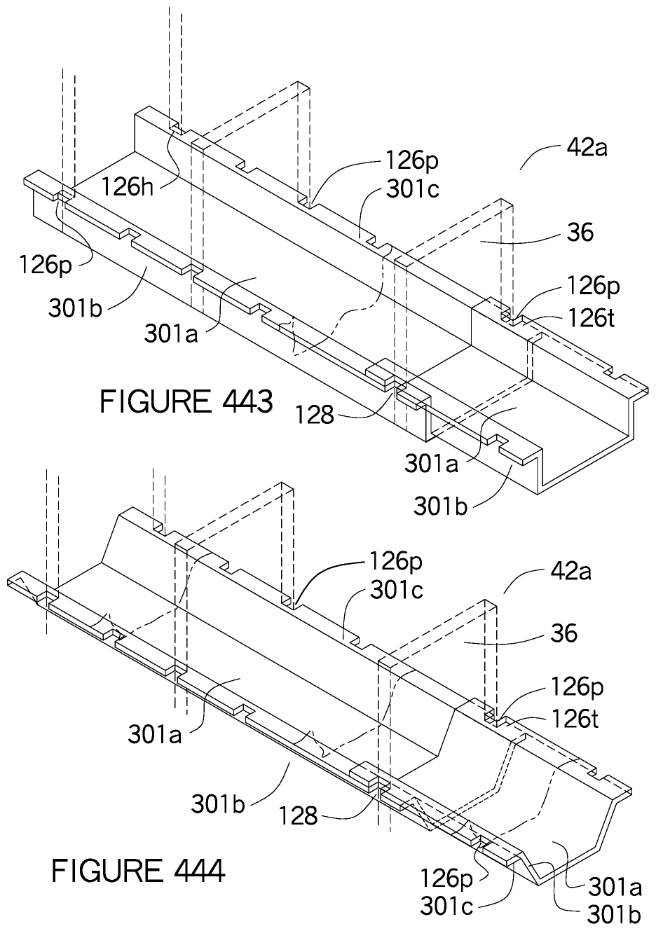

A DESCRIPTION OF THE PREFERRED EMBODIMENTS in FIG. 443 through FIG. 471 having various types of overlapping spacer braces used to connect spacer braces through the holes in the support members as well as various configurations of the spacer braces to interlock the spacer braces together to make the connections to the support members.

FIG. 443 shows a reverse lip spacer brace 301 having a web 301a with flanges extending vertically approximately coplanar to the holes side edges 36se with lips 301c having lip notches 126p and where an adjoining second reverse lip spacer brace 301 overlaps the first reverse lip spacer brace 301. In order to overlap each other the reverse lip spacer braces 301 the width of the web 301a, the length of the flanges 301b or the lips 301c will vary depending on shape and snugness between reverse lip spacer braces 301. FIGS. 386, 389, 390 & 458 show the hole notches 126h at the hole side edges 36se. The lip notches 126p at the left support member show the lips 301c with the lip notches 126p shorter while the hole notches 126h have a deeper depth so the lip notches 126p will extend deeper into the hole notch 126h therefore eliminating any vertical and horizontal movement within the hole notch 126h. All the holes 36 can have hole notches 126h to eliminate vertical movement at the holes 36 or maybe installed at the hole side edges 36se without the hole notch 126h. At the right no hole notches 126h are shown as the hole notches 126h can be a double lip notch 126dp or a double hole notch 126dh as shown in FIGS. 375 & 377. If the hole notch 126h is wide enough for only one lip notch 126p the lower reverse lip spacer braces 301 would have its lip notch 126p not fit into the hole notch 126h and only the upper reverse lip spacer brace at the lip notch 126p would only engage the hole notch 126h keeping the lower spacer brace 301 tight against the hole bottom edge 36be. The width of upper oriented spacer brace has a narrower width web 301 with longer flanges 301b and longer lips 201c to fit into the lower reverse lip spacer brace 301.

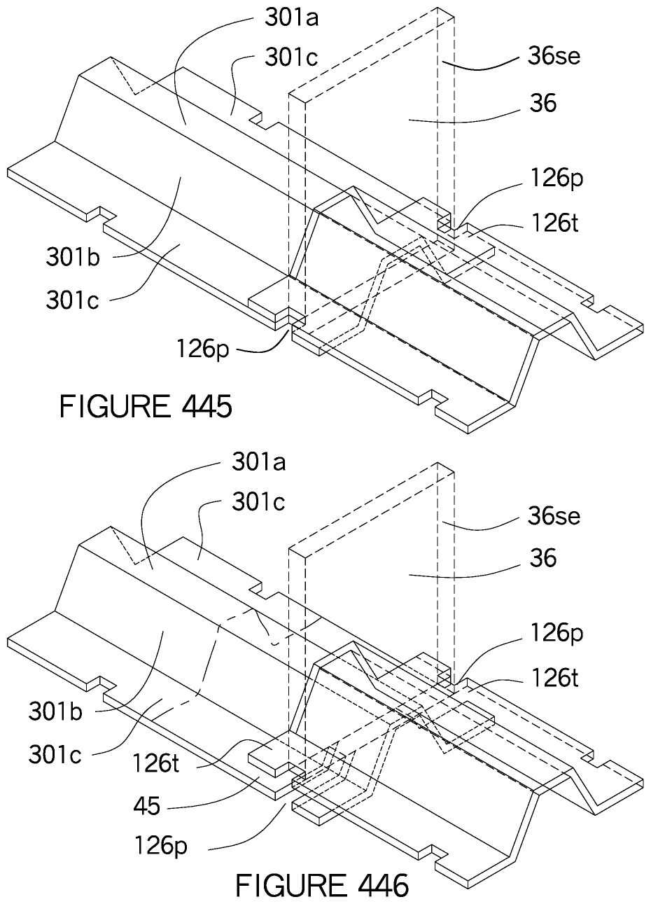

FIG. 444 is similar to FIG. 443 except the flanges 301b are angular allowing two overlapping reverse lip spacer braces 301 to fit against each other. The web 301a, flanges 301b and lips dimensions can vary depending how the upper reverse lip spacer brace 301 wants to fit into the lower reverse lip spacer brace 301. The hole notches 126h can be a double hole notch 126dh and the lips 301c can be double requiring a double lip notch 126dp as for FIG. 443. FIG. 445 like FIGS. 443 & 444 does not show a gap 45 between the lips 301c because the web 301a is narrower, the flanges 301b are longer in length and the lips 301c are wider in width as the longitudinal edges of the lips 301c are shown aligned.

FIG. 445 is similar to FIG. 444 except the two overlapping reverse lip spacer braces 301 is shown face down with the left reverse lip spacer brace 301 having the lips 301c supported by the hole bottom edge 30be. The lips 301c have lip notches 126p that extend inward from the longitudinal edge of the lips 301c so the web 42a of the support member fits against the back edge of the lip notches 126p with the side edges of the lip notch 126p abut both side planes of the web 42a of the support member. The second reverse lip spacer brace 301 also extends through the hole 36 overlapping the first reverse lip spacer brace 301 at a slight angle, in order to have the longitudinal edges of the lips 301c fit through the hole 36 and have the back edge of the lip notches 126p engage the hole side edges 36se. As in FIG. 443 the width of the web 301a and the width of the flanges 301b and lips 301c will be wider in order to have both reverse lip spacer braces 301 fit tightly together and may have fasteners (not shown) to additionally secure the reverse lip spacer braces 301 together. As discussed earlier hole notches 126h may be installed at the hole side edges 36se either as a single notched hole 126h or as a double wide notched hole 126dh.

FIG. 446 shows the same profile as shown in FIG. 445, however the first reverse lip spacer brace 301 shows the lip notch 126p starting at the longitudinal edge of the lip 301c extending the full width of the lip 301c with the lip notch 126p continuing into the flange 301b or flange notch 126fg forming a continuous lip-flange notch 126pf. The lip-flange notches 126p at the first reverse lip spacer brace 301 is installed at a slight angle so one lip-flange notch 1216pf has the hole side edge 36se installed into the lip-flange notch 126pf allowing the side edges of the lip-flange notch 126pf to engage the longitudinal planes of the web 42a of the support member. When the lip-flange notches 126pf extends below the hole bottom edge 36be another adjacent reverse lip spacer brace 301 with only lip notches 126p at both lips 301c can overlap the first reverse lip spacer brace 301. The second reverse lip spacer brace 301 can be identical in shape and size, that is the web 301a, flanges 301b and lips 301c can be the same width and length and still form a secure connection between two adjoining reverse lip spacer braces 301. To form a tighter connection between the first and second reverse lip spacer braces 301, the web 301a of the overlapping reverse lip spacer brace 301 should be wider in order to have a tight connection at the webs 301a using fasteners between the first and second reverse lip spacer braces 301. In U.S. Ser. No. 15/430,781 hole notches 126h are used at the corner of the hole side edges 36se and hole bottom edge 36be for the lips notches 126p to fit into or the hole notches 126h can have protrusions to also secure the reverse lip spacer brace 301 from vertical movement.

Many different longitudinal overlapping end configurations from U shaped spacer braces 302 or reverse lip spacer braces 301 are shown where a first metal framing member end configuration is secured in a hole 36 of adjacent support members and a second metal framing member having the same or different end configuration overlaps the first metal framing member and secured to the first metal framing member and/or to the hole 36 of the support member.

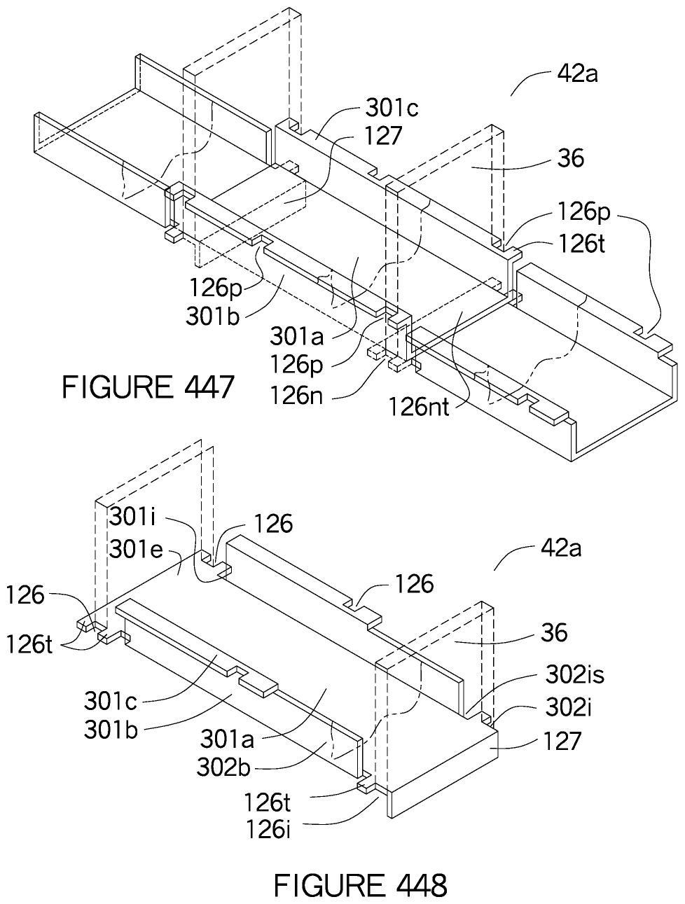

FIG. 447 shows two solutions for connecting the longitudinal ends of two reverse lip spacer braces 302 to the hole 36 opening in the web 42a of the support member. The right reverse lip spacer brace 301 is shown face-up where the bottom side of the web 301a extends over the hole bottom edge 36be with the flange 301b extending upward from the web 301a with lips 301c extending from the distal side of the flanges 301b outward so the lip notches 126p can extend into the holes side edges 36se. The web 301a is shown having an extension 301e with a notch tab 126nt longitudinal end where the notch 126 fits against the hole side edges 36se and the side edges of the tab 126t extends against both side planes formed by the web 42a of the hole 36 in the support member. After the right reverse lip spacer brace 301 is installed into the hole side edges 36se, the middle reverse lip spacer brace 301 shown having the web 301a, flanges 301b with lips 301c and having lip notches 126p is inserted into the hole 36. The reverse lip spacer brace 301 is inserted into the hole at a slight angle in order to have the lips 301c fit between the hole side edges 36se and the lip notches 126p fit into the hole side edges 36se. The third space brace is shown as a U shaped spacer brace 302 which has the same configuration as the reverse lip spacer brace 301 except without the lips 301c. The connection at the hole 36 shows the longitudinal end at the web 302a having a notched tab 126nt end with a notch 126 engaging the hole side edges 36se with one tab 126t bracing one plane of the web 42a and the other tab 126t shown bent downward over the hole bottom edge 36be forming a hook finger with the extension 302e of the hook finger 127 is support at the hole bottom edge 36be and the finger portion support the at the opposing side plane of the web 42. The middle reverse lip spacer brace 301 shows the web 301a support by the extension 302e and secured by the lip notches 126p of the middle reverse lip spacer brace 301.

FIG. 448 shows the left longitudinal end as described as the longitudinal end in the first reverse lip spacer brace 301 at FIG. 447 5. The right longitudinal end in FIG. 448 shows the web 302a having the same configuration as the third spacer brace as shown in FIG. 447 where the hook finger 127 uses the extension 302i to extend across the hole bottom edge 36be and the tab 126t being the end of the hook finger 127.

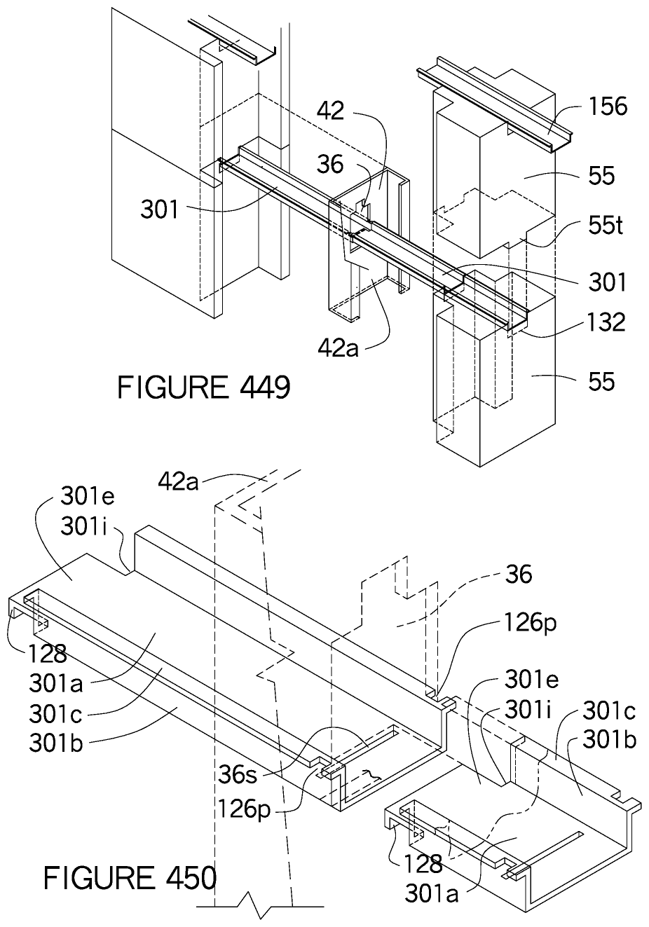

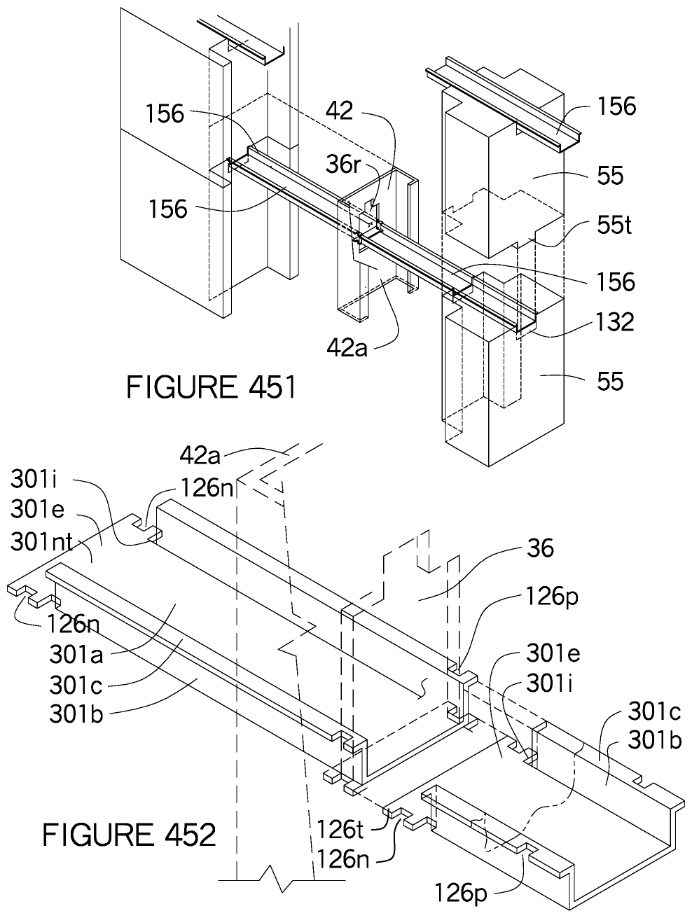

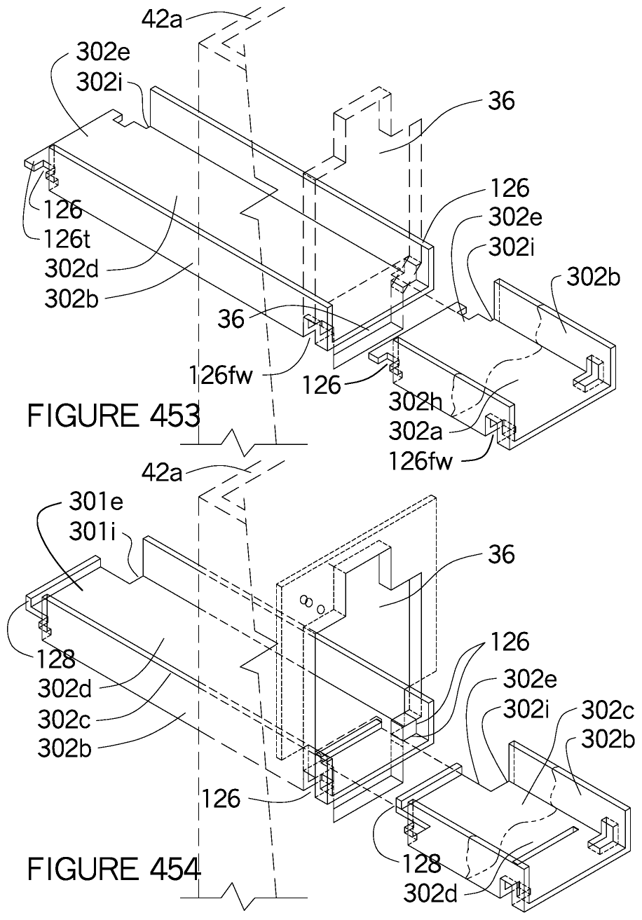

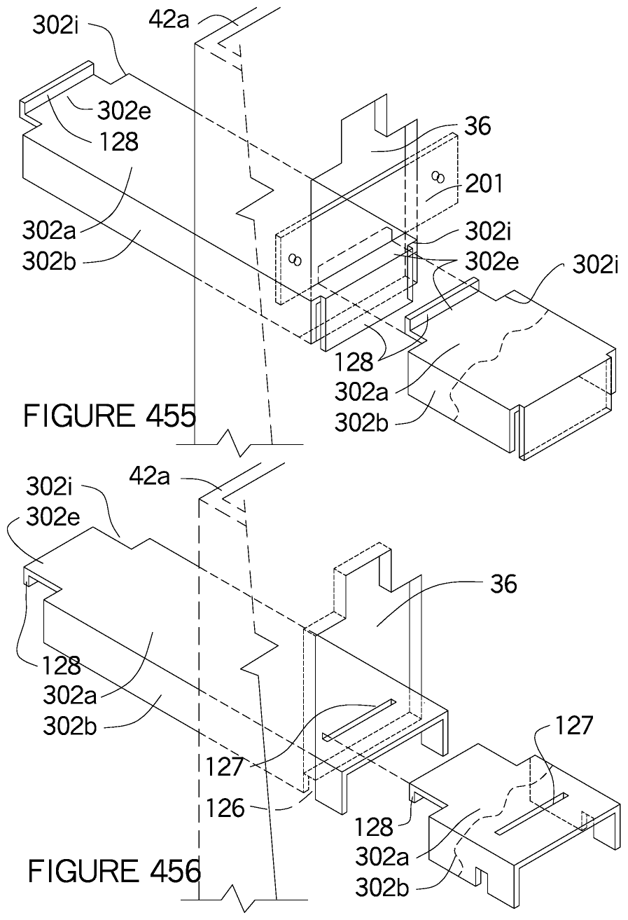

FIGS. 449, 450 & 457 shows an exploded view of a reverse lip spacer brace 301 shown in FIG. 450 installed between insulated spacer blocks 55. The support member shown as a C channel 42 has a web 42a with a hole 36 where two horizontal reverse lip channels 156 overlapping the hole 36 connecting both horizontal reverse lip channels 156 together. Some of the early FIG's showed the horizontal reverse lip channels 156 originally described then later referred to as reverse lip spacer braces 301. The reverse lip spacer brace 301 has a web 301a with upward oriented flanges 301b extending from the web 301a connected to lips 301c having lip notches 126p where the back edge of the lip notches 126p abut the hole side edge 36se with the side edges of the lip notches 126p abutting the side planes of the web 42a of the support member 42. The lip notches 126p shown on the right side of the reverse lip spacer brace 301 are installed into the hole side edges 36se prior to installing the adjacent reverse lip spacer brace 301. The lip notches 126p are indented from the longitudinal ends of the lips 301c and the web 301a has a receiver slot hole 129sh. The opposing longitudinal end of the adjacent reverse lip spacer brace 301 has an indentation at the web 301a and flanges 301b for the web 301a for a hook tongue 128 with an extension 301e that extends over the longitudinal end indentation, over the hole bottom edge 36be for the hook tongue 128 to extend into the receiving slot hole 129sh of the first reverse lip spacer brace 301. The receiver slot hole 129sh can be located between the hole bottom edge 36be and longitudinal end of the web 301a or on opposite side of the hole bottom edge 36be. In later FIG's the lip notches 126p has been expanded and holes notches 126h and hole protrusions 36p have been added to eliminate horizontal and lateral movement between the reverse lip spacer braces 301 and the support members. In later application the receiver slot hole 129sh shows many shapes, extending ledges 79 along with hook tongues 128 where the tongue ends have curvilinear configurations, notched tabs 126nt or irregular shaped ends to swivel within the receiver slot hole 129sh and where the extension portion of the hook tongue 128 is able allow the spacer brace to be oriented into a different direction. In addition later applications have changed the shape of the spacer braces by the addition of bulges, notches, ledges and protrusions all still maintaining the rigid connection between metal framing members.

FIG. 451 shows the same configuration is in FIG. 452 where an earlier patent showed an exploded view of a reverse lip channel 156 now referred in FIG. 452 as reverse lip spacer brace 301 having a web 301a or 156a, flanges 301b or 156b with lips 301c or 156c having notches 126 now referred to as lip notches 126p shown between spacer blocks 55. FIG. 452 shows the same configuration as FIG. 447 where one longitudinal end is showing the notched tab 126nt engaging the hole side edges 36se at one support member with the lip notches 126p at the opposing end engaging second support member with intermediate lip notches 126p engaging intermediate support members (not shown). By installing the longitudinal end with the notched tab 126nt into the hole bottom edge 36be first the notched tab 126nt is now secured into the hole 36. The second reverse lip spacer brace 301 can now be installed over the notched tab 126nt end. The size of the reverse lip spacer brace 301 does not require a smaller or larger configuration as the reverse lip spacer brace 301 is not overlapping the flanges 301b and lips 301c but only at the web 301a at the notched tab 126nt. The typical lip notches 126p are indented from the end of the reverse lip spacer 301 so the lip notch 126p will have a rigid extension past the lip notches.

FIGS. 453 & 454 both show a U shape spacer brace 302 having a web 302a being support at the hole bottom edge 36be of a support member with flanges 302b extending upward where the web 302a. The right longitudinal end of the U shape spacer brace 302 shows a flange-web notch 126fw at the intersection of the web 302a and flange 302b forming a continuous notch between the web 302a and flange 302b. FIG. 453 shows the flange-web notch 126fw support at a hole bottom edge 36be having a diagonal bottom edge. FIG. 454 shows a key hole 36k at the hole bottom edge 36be where a smaller size hole is connected to the larger hole. The back edge of the flange portion of the flange-web notch 126fw is support at the hole bottom edge 36be of the larger hole 36 and the web portion of the flange-web notch 126fw has the side edges of the key hole 36k securing the web portion of the flange-web notch 126fw. FIG. 453 shows the left longitudinal end configuration having a notched-tab 126nt as described in FIG. 452 and where the notched-tab 126nt longitudinal end is installed at the hole bottom edge 36be with the notches 126 secured at the hole side edges 36se prior to the flange-web notches 126fw longitudinal end of the adjacent U shaped spacer brace 302 is installed in the hole 36 of the support member. FIG. 454 shows a hook tongue 128 having an extension 302e with the tongue portion extending upward from the hole bottom edge 36be requiring the hook tongue longitudinal end to be installed prior to adjoining the second U shaped spacer brace 302 shown to the left with the flange-web notch 126fw into the hole 36. The hook tongue 128 is shown extending upward for a vertical plate or separation can be installed across the hole 36 opening. The same configuration can also have the tongue end of the hook tongue 128 extending downward.

FIG. 455 shows two U shaped spacer braces 302 having a web 302a with flanges 302b extending downward from the longitudinal side edges of the web 302a with the left longitudinal end has indentations in the flanges 302b and web 302a with the remaining portion of the web 302a having an extension 302e being the arm of the hook tongue 128 with the end of the hook tongue extending upward as also described previously. The right longitudinal end of the U shaped spacer brace 302 also has the indentation at the flanges 302b and web 302a with the remaining portion of the web 302a having an extension 302e that extends over the hole bottom edge 36be and being the arm of a hook finger 127 that extends against the web 42a of the support member while the longitudinal ends of the flanges 302b supports the opposing plane of the web 42a. The tongue end of the hook tongue 128 extends upward against a flat plate 201 that completes the U shaped spacer braces 302 from moving laterally as well as vertically as the flat plate 201 has fasteners to secure the web 42a and U shaped spacer braces 302 together. As mentioned earlier the flat plate 201 can be used as a fire stop separating the air gap that exists between adjacent support members.

FIG. 456 shows an isometric view of two U shaped spacer braces 302 having a web 302a with flanges 302b extending downward from the longitudinal side edges of the web 302a with the left longitudinal end with the flanges 302b and web 302a being indented with an extension 302e forming the arm of a hook tongue 128 where the tongue end extends downward along with the flanges 302b. The opposing longitudinal end of the U shaped spacer brace 302 shows flange notches 126fg with the opening beginning at the longitudinal edges of the flanges 302b with the side edges extending toward the web 302a and indented from the right longitudinal end allowing the side edges of the flange 302b have enough bearing support at the right longitudinal end of the flange 302b. In addition the right longitudinal end shows a receiver slot hole 129sh to the left of the hole 36. The right longitudinal end of the left U shaped spacer brace 302 is installed in the hole 36 by first installing the U shaped spacer brace 302 at a slight angle so the flange notches 126fg can engage the hole bottom edges 36be before the adjacent U shaped spacer brace 302 with the hook tongue 128 with the tongue end can be inserted into the receiver slot hole 129sh. As stated earlier the U shaped spacer brace 302 or reverse lip spacer brace 301 can have various shapes as well as various types of receivers, notches and hook tongues to form additional configurations.

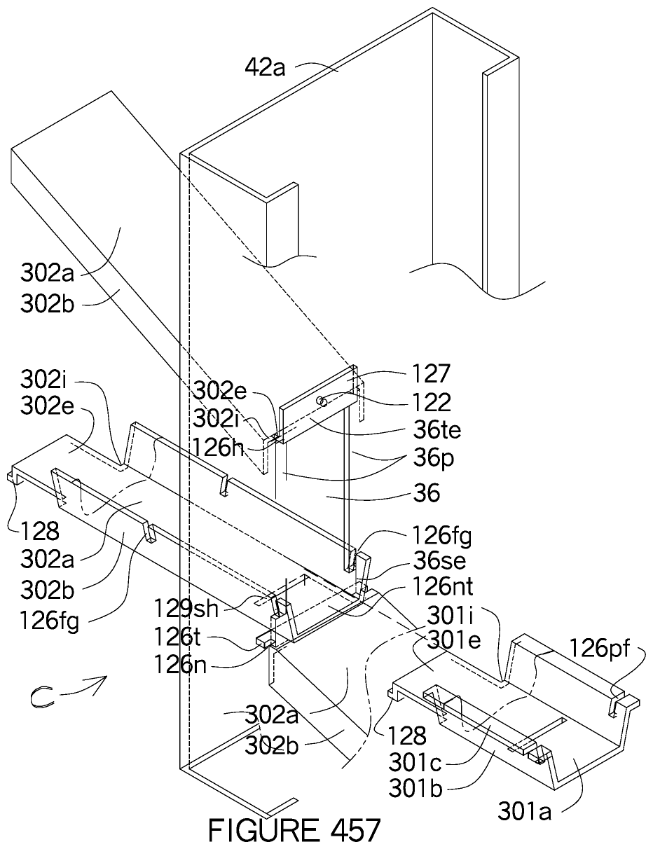

FIG. 457 shows two horizontally oriented U shaped spacer braces 302 intersecting at hole 36 where the right longitudinal end of the web 302a is supported at the hole bottom edge 36be with the longitudinal side edges have flanges 302b that extend upward away from the hole bottom edge 36be. The left end has the hook tongue 128 in the web 302a and the right end has the receiver shot hole 129sh for the hook tongue 128 to extend into when connecting adjacent U shaped spacer braces 302 together as previously described. The right longitudinal end has flange notches 126fg where the flange notches 126fg that extend into the hole side edges 36se and the hole protrusion 36p. The hole protrusions 36p are used and are shown here extending into the flanges notches 126fg that secures the U shaped spacer brace 302 from moving laterally as well as vertically. Many different shapes of spacer braces with and without lips can restrict the horizontal and vertical movement within support members. At the hole top edge 36te shows a diagonal oriented U shaped spacer brace 302 where the flanges 302b and web 302a are indented with a hook finger 127 extending from the web 302a across the hole top edge 36te with the finger end extending upward so a fastener 122 can be connected to the web 42a. The extension 302e is inserted into a hole notch 126h or a hole protrusion 36p where the extension 302e so as to form a hole notch 126h to accomplish the same function of preventing horizontal and vertical movement as well as the hook finger 127 and the longitudinal end edge also securing the web 42. At the hole bottom edge 36be the U shaped spacer brace 302 is shown intersecting the hole bottom edge 36be at a diagonal where the longitudinal end of the web 302a shows the notched tab 126nt end fitting against the hole side edges 36se or into a hole notch 126h (not shown). In this case the downward oriented diagonal U shaped spacer brace 302 is inserted into the hole bottom edge 36be first where the longitudinal end has notch tab 126nt where the notches 126n fit against the hole side edges 36se with the tabs 126t and the longitudinal edges of the flanges 302b engage both sides of the web 42a of the support member. After the lower U shaped spacer brace 302 is installed over the hole bottom edge 36be, the first horizontal U shaped spacer brace 302 previously described is installed over the longitudinal end of the notched tab 126nt of the diagonal U shaped spacer brace by installing the U shaped spacer brace 302 at an angle then turned so the flange notches 126fg can engage the underside of the hole protrusion 36p first. The previously mentioned identical U shaped spacer brace 302 with the hook tongue on the left longitudinal end can then be inserted into the receiver slot hole 129sh of the second U shaped spacer brace 302. Obviously different longitudinal ending connections can be used to form a rigid connection between the metal framing members.

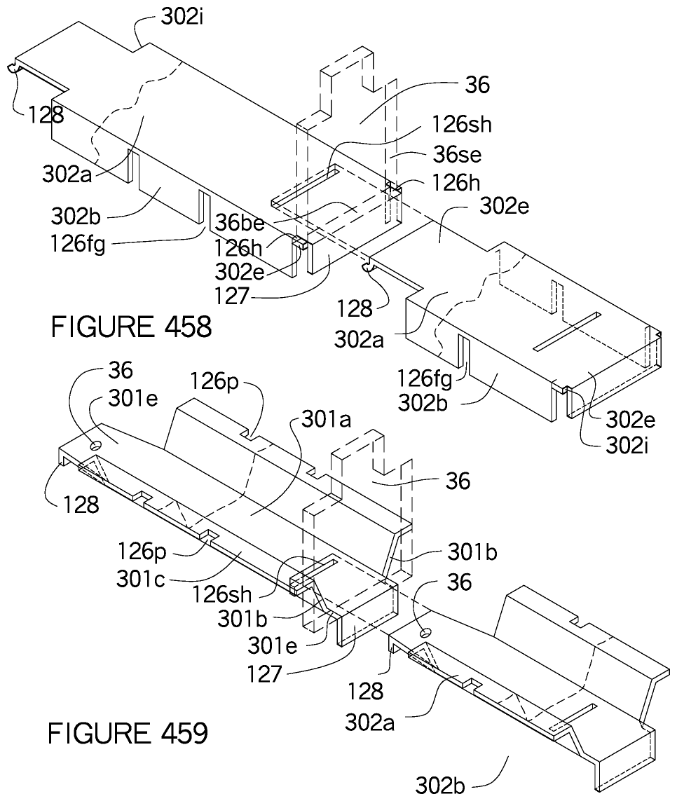

FIG. 458 shows two U shaped spacer braces 302 having a web 302a with two longitudinal side edges having flanges 302b that extend downward with a first end having flanges 302b and web 302a with a web extension 302e shown inserted into the hole notches 126h at the finger end of the hook finger 127 with the longitudinal ends of the flanges 302b engaging both side planes of the web 42a of the support member. Flange notches 126fg are also shown as intermediate connections between support members with the flange notches 126fg extending the full height of the flanges 302b so the side edges of the web 302a can be inserted into the hole notches 126h. The left longitudinal end of the U shaped spacer braces 302 also has the flanges 302b and web 302a indented, however the indentation 302i at the web 302a is deeper as the extension 302e at the web 302a is narrower as the extension 302i passes through the hole 36 where the tongue end shown having a curvilinear hook of the hook tongue 128 will be inserted into the receiver slot hole 129sh shown in the web 302a near the right longitudinal end. Since the extension 302e at the right longitudinal end is being inserted into the hole notches 126n, the U shaped spacer brace 302 will be installed at an angle having the extensions 302e engaging the hole notches 126h.

FIG. 459 shows the two reverse lip channels shown in FIG. 443 however the longitudinal end configurations as similar to FIG. 443. The lip 301c is wider than the hole 36 therefore the longitudinal ends of the lips 301c abut one side plane of the web 42 and the web 301a has an extension 301e where the hook finger 127 extends over the hole bottom edge 36be with the finger end securing the opposing plane of the web 42a at the hole 36. The opposing longitudinal end of an identical reverse lip spacer brace 301 has the left longitudinal end with the extension 301e of the web 301a extended through the hole 36 where the extension 301e rests on the web 301a of the first reverse lip spacer brace with the hook portion extending through the receiver slot hole 129sh.

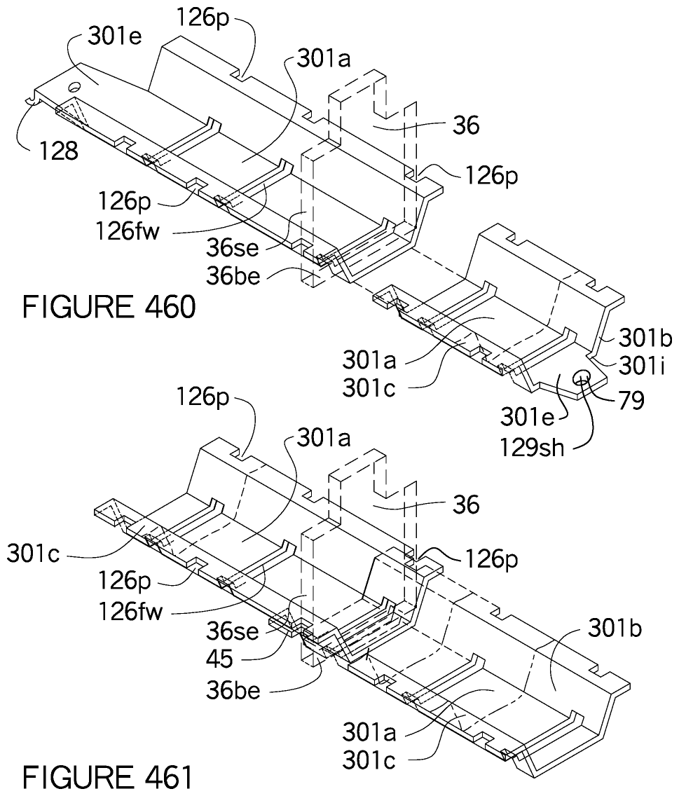

FIGS. 460-463 are similar to each other as two reverse lip spacer braces 301 each having a web 301a with the longitudinal side edges distal to the flanges 301b where the longitudinal edges of the flanges 301b have lip 301c extending outward away from the web 301a with the lips 301c have lip notches 126p extending inward toward the web 301a from the longitudinal edges of the lips 301c. The first reverse lip spacer brace 301 shown at the right side of the hole 36 with the right longitudinal end extending into the hole 36 engaging the hole side edges 36se at the lip notches 126p and where the web 301a and the flanges 301b have continuous flange-web notches 126fw. The flange-web notch 126fw engages the hole bottom edge 36be so the back edge of the flange-web notch 126fw at the flanges 301b is secured to the hole bottom edge 36be. When the second reverse lip spacer brace 301 has the right longitudinal end fit into the hole 36 the flange-web notch 126fw from the first reverse lip spacer brace 301 fits lower into the hole bottom edge 36be allowing the second reverse lip spacer brace 301 at the right longitudinal end to overlap the first reverse lip spacer brace 301 as shown in FIG. 444. FIG. 460 also shows an alternative overlapping end connection solution where the right reverse lip spacer brace 301 has an extension 301e extend from the web 301a with a receiver slot hole 129sh having a ledge 79 extending down where the opposing end of an adjacent reverse lip spacer brace 301 having a hook tongue 128 with an extension 301e extending from the web 301a for the tongue end having a curvilinear end to wrap around the ledges 79 at the receiver slot hole 129sh.

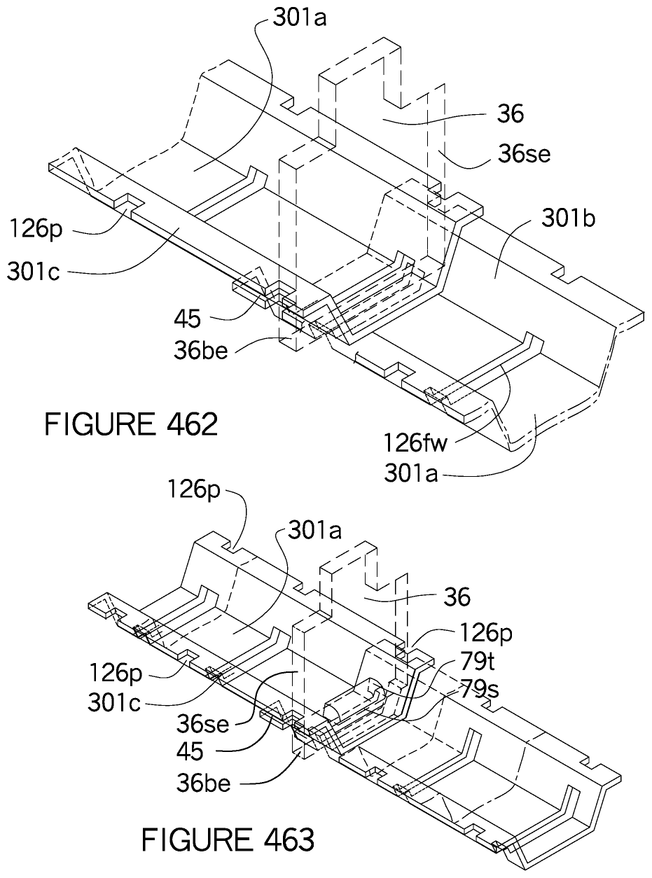

FIG. 462 shows an enlargement of FIG. 461 where the first reverse lip spacer brace 301 has the hole bottom edge 36be being inserted into the flange-web notch 126fw where the web 301a is below the hole bottom edge 36be allowing the second reverse lip spacer brace also having the flange-web notch 126fw to also be inserted into the hole bottom edge 36be. In FIG. 463 the hole bottom edge 36be can now extend above the second overlapping reverse lip spacer brace 301 where a ledge shaft 79s with a ledge tab 79t is bent over the web 301a of the second overlapping reverse lip spacer brace 301 as well as the first reverse lip spacer brace 301 connecting both spacer braces together. In earlier FIG's the ledge tab 79t being bent over the web 302a of a U shaped spacer brace 302 as well as a notched tab 126nt being extended from the hole bottom edge 36be.

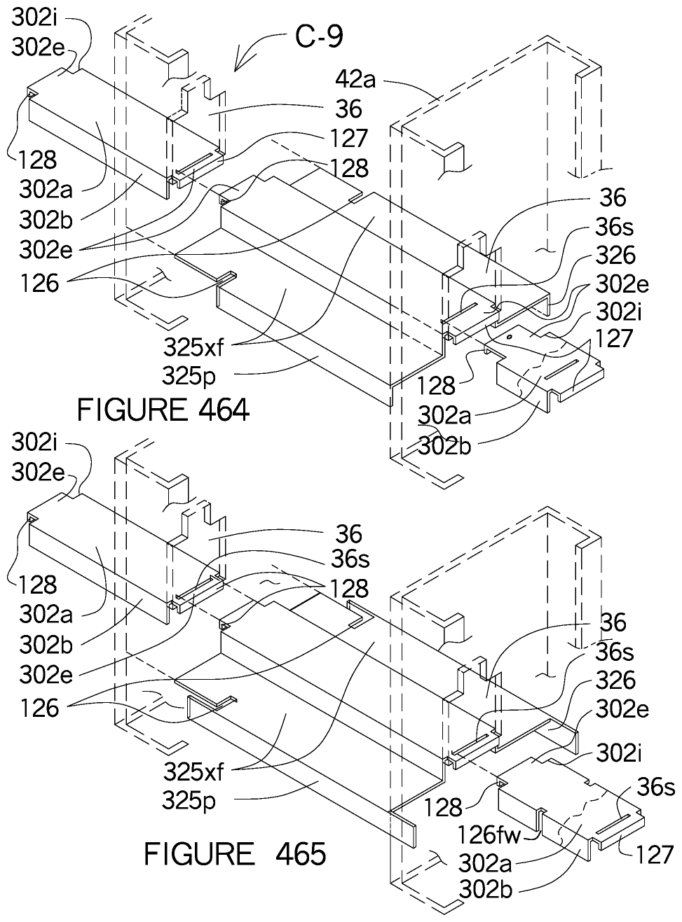

FIG. 464 shows an isometric view of a spacer brace showing the width of the C shaped channels 42 having a web 42a, flanges 42b and lips 42c are equal to the width of the web 42a of the support member. In addition the extension 302e at the web 302a are shown with a hook tongue 128 with the tongue end extending into a receiver slot hole 129sh shown at the opposing end and also shown in FIG. 452 as well as the present application. FIG. 465 shows a similar configuration as a U shaped spacer brace 302 shown in FIG. 458, however the extra flanges 325xf abut the webs 42a of two adjacent support members and the lips 325p overlap the flanges 42b of the support member at the flanges 42b of the right support member and also can be extended to overlap the flanges 42b of the left support member.

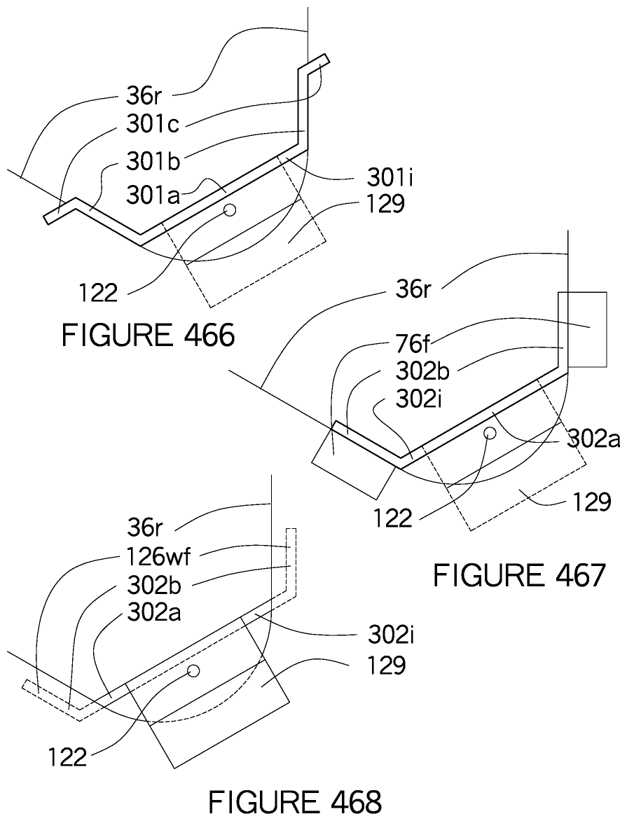

FIGS. 466-468 shows the reverse lip spacer brace 301 or the U shaped spacer brace 302 are braced on both sides of the web 42a of the support member. In FIG. 466 the lips 301c and the hook receiver 129 are shown supporting both sides of the web 42a with the hole side edges 36se supporting the flanges 301b. In FIG. 467 the flanges 302b are also being supported by the hole side edges 36se with the flanges 302b having flaps 76f extending from the flanges 302b and the hook receiver 129 are shown supporting both sides of the web 42a. Fasteners 122 can be installed into the web 42a to keep the spacer braces from lateral or vertical movement.

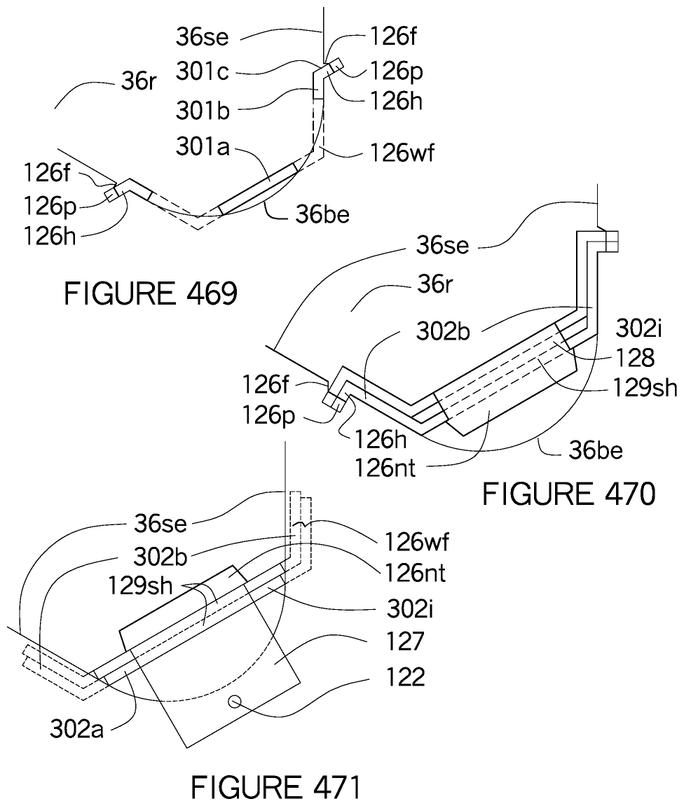

FIGS. 469-471 correspond to FIGS. 466-468, however the spacer braces are shown overlapping the ends of the adjacent spacer braces not the entire length of the adjacent spacer brace. FIG. 469 shows a reverse lip spacer brace 301 where the lips 301c and lip notches 126p and where the back edge of the lip notches 126p abut the hole side edges 36se with the side edges of the lip notches 126p extend on the sides of the web 42a of the support member. The flanges 301b are braced against the hole side edges 36se and the flanges 301b and the web 301a have a continuous web-flange notch 126wf where a portion of the web 301a and a portion of the flange 301b extend into the web-flange notch 126wf securing both sides of the web 42a by the web-flange notch 126wf. When a second reverse lip spacer brace 301 (not shown) being the same dimensions overlaps the first reverse lip spacer brace 301 a gap 45 (shown in previous FIG's) will existing between the first and second reverse lip spacer braces 301. FIG. 470 is similar to FIG. 469 as they both have lip notches 126p that engage the hole side edges 36se, however the upper or second reverse lip spacer brace 301 has a hook tongue 128 where the tongue end shown as a notched tab 126nt extends downward through the receiver slot hole 129sh in the web 301a of the lower or first reverse lip spacer brace 301 with the notched tab 126nt extending and engage the bottom edge of the web 301a and having a similar profile as FIG. 459. In addition the first and second reverse lip spacer braces 301 has the second profiles abut the first profile required the second reverse lip spacer brace 301 to have a narrower width web 301a, a taller flange 301b and a wider lip 301c so the lip notches 126p are in alignment with the hole side edges 36se. FIG. 471 is similar to FIG. 468 where the flange 302b and the hook finger 127 engage both sides of the web 42a at the first longitudinal end of the lower U shaped spacer brace 302 with the second end of the lower U shaped spacer brace 302 having a hook tongue 128 extending upward from the web 302a into and through the receiving slot hole 129sh of the upper U shaped spacer brace 302 where the notched tab 126nt tongue end extends through the receiver slot hole 129sh of the upper U shaped spacer brace 302. In addition the web 302 as in FIG. 470 is shorter at the upper U shaped spacer brace 302 in order to have the flanges 302b abut both U shaped spacer braces 302. The web-flange notch 126wf of the U shaped spacer brace 302 engages both sides of the web 42a when connecting to intermediate support member between the longitudinal ends of the U shaped spacer brace 302. The ledges 79 that extend from the receiver slot holes 129sh (shown in other FIG's can also be used in FIGS. 470 & 471.

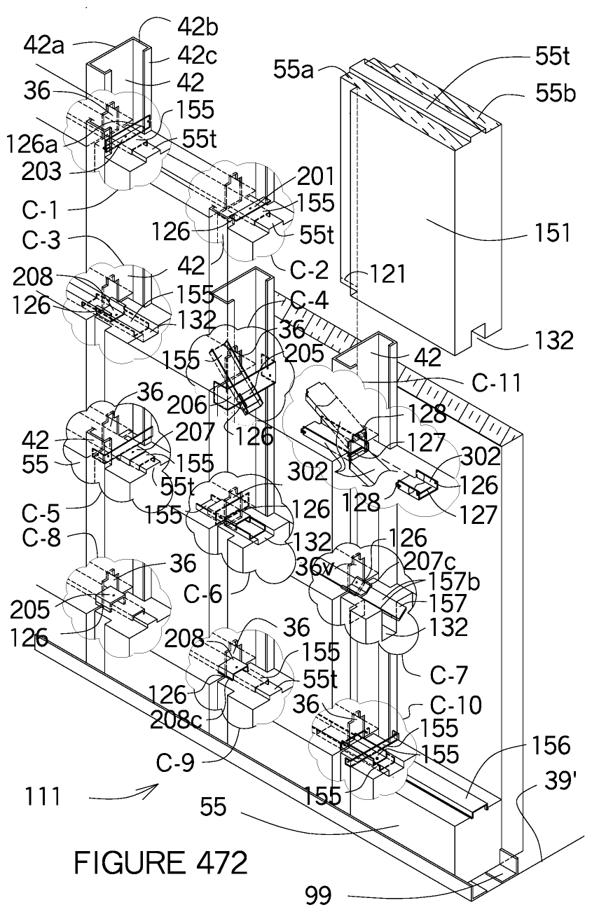

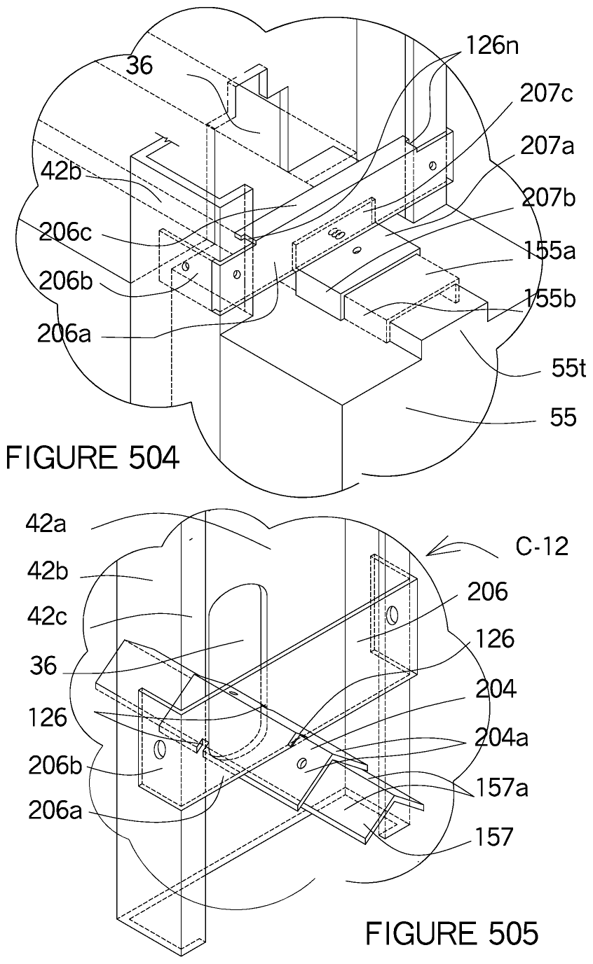

A BRIEF DESCRIPTION OF THE PREFERRED EMBODIMENT in FIG. 472 through FIG. 506 shows some of the various types of brackets and short spacer braces used to connect several spacer braces together.

The drawing show various types of spacer braces that span from a hole 36 of one support member to a hole 36 of an adjacent support member. The interlocking ends of the spacer braces can have the same configuration at both ends, however the spacer braces are typically used in tandem with adjacent spacer braces and therefore the opposite end of the spacer braces requires a different interlocking end configuration in order for adjacent spacer braces to interlock to each other or interlock at the hole 36 in the support member. Some figures show two spacer braces where one end of the spacer brace configuration is installed within the hole 36 of the support member and another spacer brace with the same configuration being installed into the opposite end of the first spacer brace. In addition, some figures show two spacer braces where one end of the spacer brace configuration is installed within the hole 36 of the support member and another spacer brace with a different configuration also being installed into the same hole 36. A third option shows two spacer braces being connected by two spacer braces connected with a flat plate. The spacer braces will have a U shape, V shape and a reverse lip shape similar to the one and two piece braces and oriented either face up or face down; a hole 36 having a horizontal bottom flat edge or diagonal side edges; and different locations of notches and ½ notches. The spacer braces can be wider than the hole 36 in the support member, requiring only the top or bottom side to pass through the hole 36. The spacer braces can be used as diagonal bracing to form shear walls, trusses or other interlocking connections.

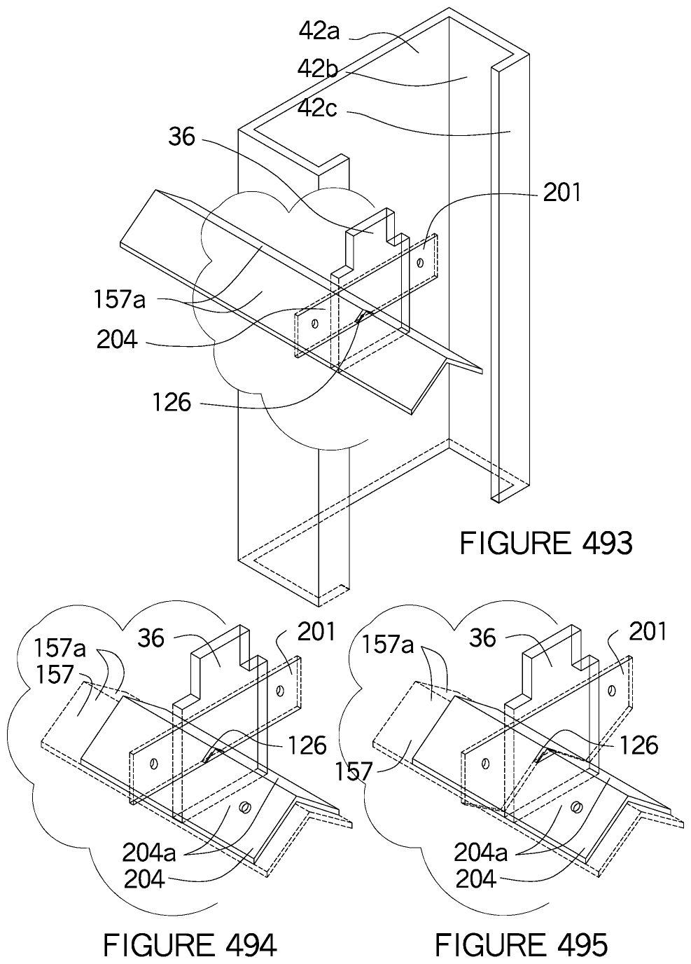

FIG. 472 shows an elevation of a metal framed wall showing various clouds or cut away areas of the spacer brace configurations explained in the various figure noted in the drawing. On the right side of the wall shown as C-3 and enlarged in FIG. 488 23 Drawing B, are diagonally oriented U shaped spacer braces 302 installed parallel to each other between the support members without the horizontally oriented spacer braces and in C-4 and shown enlarged in FIG. 488 Drawing C shows space between the parallel diagonally oriented U shaped spacer braces 302 for a horizontal bracing member or horizontal spacer brace to pass through and connected to the hole 36 in the support member. The left side of the metal framed wall shows C-5 which is enlarged in FIG. 490 with a right sloping and left sloping diagonally oriented U shaped spacer braces 302 intersecting at a hole 36 forming an arrow like configuration along with horizontal bracing members passing through the hole 36. The diagonally oriented U shaped spacer braces 302 reduce the lateral structural load forces due to wind or earthquake movement within a wall framing structure creating what is known in the construction industry as a shear wall. In addition to the right of the window, the horizontal spacer braces are not continuous but alternating connections between the holes in support channels. The alternating connections can work as a starter spacer or as a shear wall when the spacer braces are connected close together as shown in the elevation C-1 or when a flat plate 201 is used to strengthen the intersections as shown in some later figures. Many times wall framing is required to have a fire break to reduce fires from spreading within a wall structure as shown in C-9 and the isometric FIG. 493. An opening is shown in the middle of the wall representing a window and the cross bracing above are the diagonally oriented spacer braces 302 forming a structural truss or truss joist 401 framing above the window as shown in C-7 and in FIG. 494. The truss joists can be used as a floor or ceiling joist as shown in C-8 and enlarged in FIG. 494. The diagonally oriented U shaped spacer braces 302 can also be used as horizontal and diagonal lateral bracing shown in C-8.

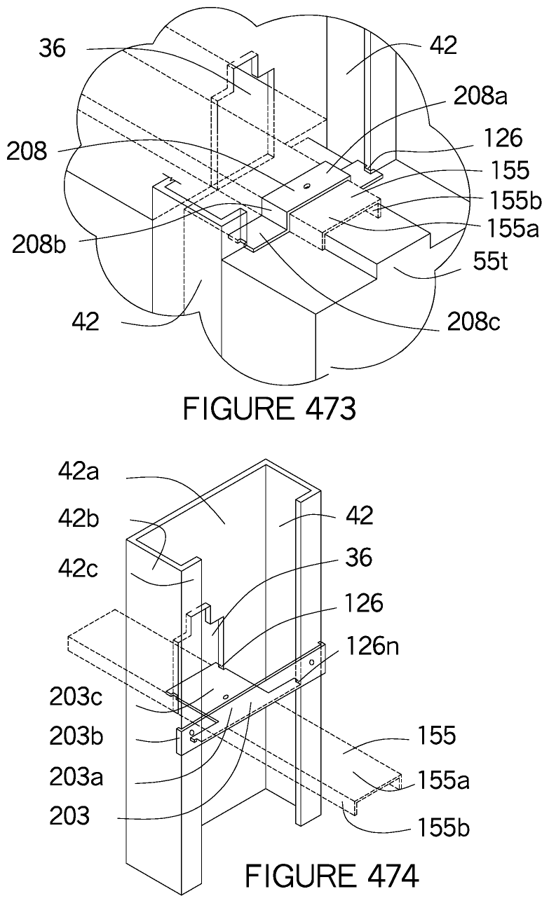

FIG. 473 shows another single spacer brace shown as C-1 in FIG. 472 which is an isometric view of an upward oriented reverse lip spacer brace 301 on the left side having a bottom side 301d two parallel sides 301b extending upward and a lip 301c extending horizontally from the parallel sides 301d. The right side shows an upward oriented U shaped spacer brace 302 having a bottom side 302d and two parallel sides 302b extending upward. The configuration of the notches 126 on both the bottom side of 301d & 302d are interchangeable. The notches 126 in 301d has an indentation 301i, extension 301e with notches 126 having tabs 126t of both sides of the notch 126 that is secured to the hole 36 in the support member. On the right side the bottom side 302d has an indentation 302i, extension 301e with a tab 126t on the spacer brace side, a notch 126 and a bent tab 126bt that is bent downward engaging the web 42a below the hole 36 in the support member.

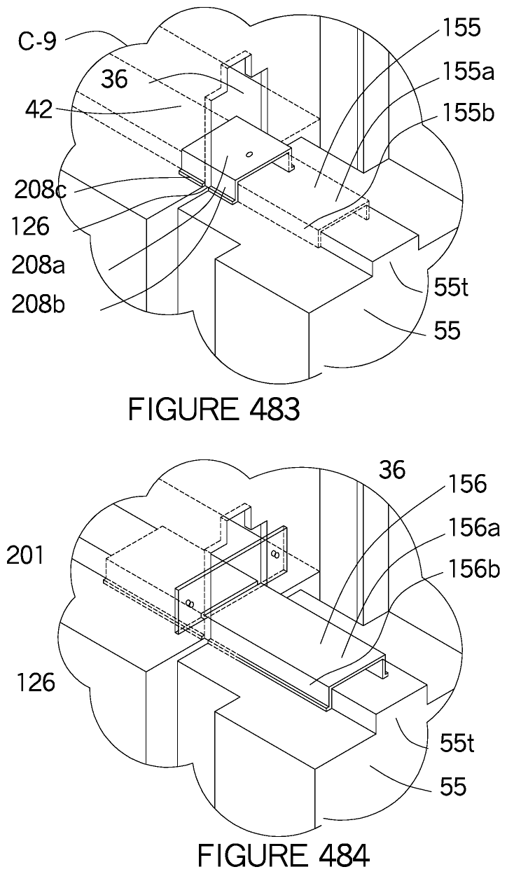

FIG. 474 shows an exploded isometric view of two spacer blocks 55 with two spacer braces shown as reverse lip shaped spacer braces 301 (similar to FIG. 483 showing the reverse lip channel 156) on both sides of the support member shown as a C shaped channel 42 and connected at hole 36.

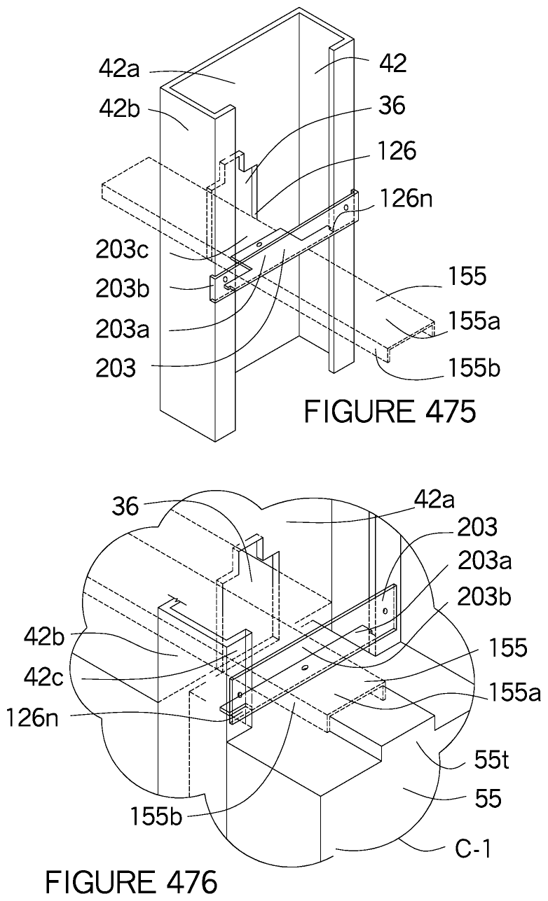

FIG. 475 shows the same isometric view as FIG. 484; however one leg is secured by a fastener to the web of the bracing members.

FIG. 476 shows a multi-plane one piece bracket connecting to the U shaped bracing members facing downward and the opposite end of the bracket is a U shaped bracket attached at the lip or flange of the support member.

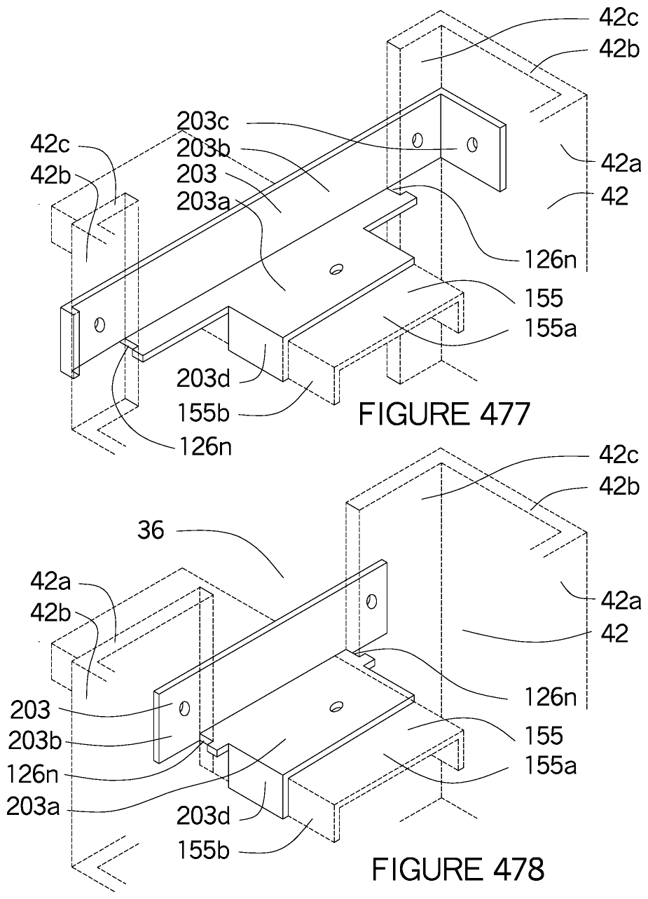

FIG. 477 shows the multi-plane one piece bracket without the spacer blocks as shown in FIG. 476 and the isometric view is from the interior of the support member.

FIG. 478 shows an exploded isometric view of two upward facing reverse lip shaped spacer braces 301 on both sides of the support member shown as a C shaped channel 42 and connected at hole 36 where the left side has the bottom side 301d have an extension 301e with a ½ notch 126n so the tab 126t of the ½ notch 126n extends further than the ½ notch 126n and the right side has a ½ notch 126 at the lip 301c and the bottom side 301d has an extension 301e with an upward oriented hook shape 128. The left side of the right reverse lip shaped spacer brace 301 is installed into and past the hole 36 so the tab 126t engages the side edge of the hole 36 and the right side of the left reverse lip shaped spacer brace 301 fits on to the bottom edge 301d of the right reverse lip shaped spacer brace 301 so the upward edge of the hook shape 128 engages a flat plate 201 that fits over the hole onto the hook shape 128. Fasteners are installed into the flat plate 201 and into the web 42a of the support member. The flat plate 201 holds both reverse lip spacer braces in place. In FIG. 473 the right end shows the bottom side 301d having a bent tab 126bt in lieu the tab 126t being straight in line with the extension 301e.

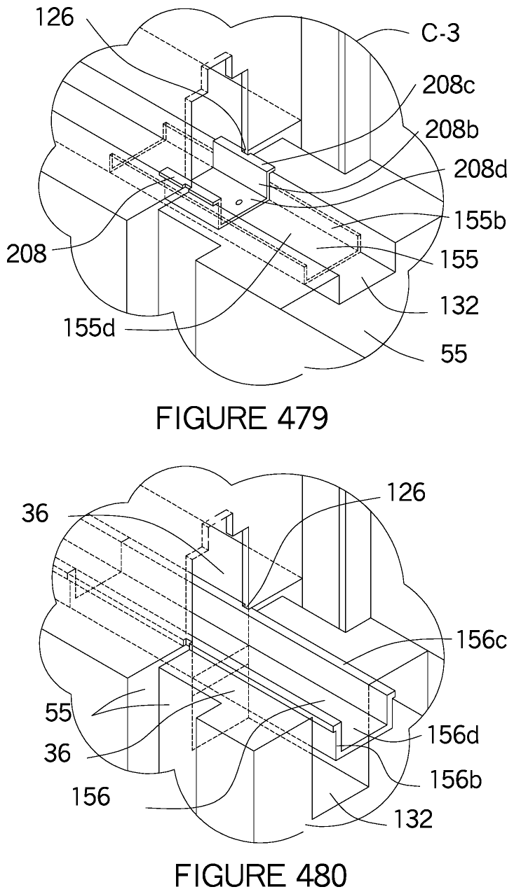

FIG. 479 shows an exploded isometric view of two upward facing reverse lip shaped spacer braces 301 on both sides of the support member shown as a C shaped channel 42 and connected at hole 36 where the left side has the bottom edge 301d have an extension 301e with a downward oriented hook shape 128 and the right side has a ½ notch 126n at the outside edge of the lip 301c with shelf notches 126s at the side edges 301b and a slot hole 127 on the bottom side 301d. The right side of the left reverse lip shaped spacer braces 301 is installed into the hole 36 so the lip 301c edge is against the web 42a of the support member leaving the sides 301b and bottom side extend beyond the hole so the right reverse lip shaped channel 301 with its extension 301e and downward oriented hook shape 128 can fit into the slot hole 127 and a flat plate 201 can be inserted into the shelf notches 126s at the side edges 301b. The reverse lip shaped spacer braces can be connected without the flat plate 201; however the flat plate 201 keeps the connection stable in a vertical direction from any movement like an earthquake.

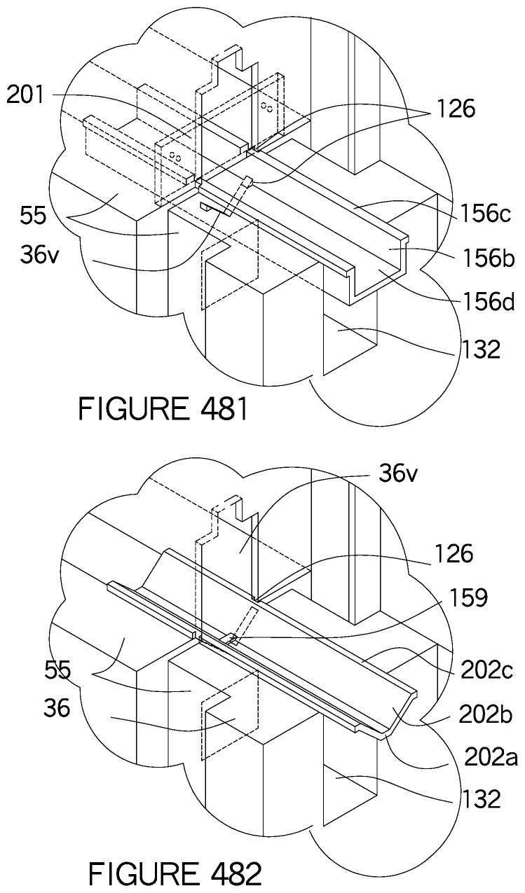

FIGS. 480 & 481 both show an exploded isometric view of two upward facing U shaped spacer braces 302 having a bottom side 302d and two parallel sides 302b extending upward on both sides of the support member shown as a C shaped channel 42 and connected at the hole 36 and both show the bottom side 302d on the left side having an indentation 302i and an extension 302e with a downward oriented hook shape 128. The right side of FIG. 481 has notches 126 at the top edge of the side edges 302b and a slot hole 127 on the bottom side 302d. When the right side is installed into the hole 36 a flat plate 201 is installed into the notches 126. The hook shape 128 on the left side fits over the edge 302d of the left U shaped spacer brace 302 and into the hole 127.

FIG. 482 both show an exploded isometric view of two upward facing U shaped spacer braces 302 having a bottom side 302d and two parallel sides 302b extending upward on both sides of the support member shown as a C shaped channel 42 and connected at the hole 36 and both show the right side having notches 126 in the corner partially formed on the bottom side 302d and parallel sides 302b. The left side of the U shaped spacer brace 302 has an extension 302e with an indentation 302i having the extension 302e be the width interior surfaces of the two parallel sides with notches 126 on both side edges leaving a tab 126t extending beyond the notches 126. After the right side of the U shaped spacer brace 302 is secured in the notches to the side edges of the hole 36, then the left side extension 302e of the adjacent U shaped spacer brace 302 is installed over the first U shaped spacer bracket into the same side edges of the hole 36. The overlapping notches secures the U shaped spacer braces 302 to the hole 36.

FIG. 483 shows an exploded isometric view of two downward facing U shaped spacer braces 302 having a top side 302a and two parallel sides 302b extending downward on both sides of the support member shown as a C shaped channel 42 and connected at the hole 36. In FIG. 480 the U shaped spacer brace 302 does not fit into the hole 36. The right side has the extension 302 that passes through the hole 36 with the inside edge of the hook shape 127 extending through and over the hole 36 and the left side of the adjoining U shaped spacer brace 302 with its extension 302e and hook shape 127 pass through the hole 36 inserting the hook shape 127 into the slot hole 128 and have its hook shape extending downward enough to fit adjacent to the opposite side surface of the hole 36. Therefore both hook shapes 127 have their inside edges securing both side surfaces of the web 42 of the support member. In FIG. 12 the left side has an indentation 302e with the extension 302e; however the hook shape 127 is extending upward from the extension 302e. In FIG. 483 the U shaped spacer brace 302 fits into the hole 36 so the downward hook shape on the right side is longer in order to engage the web 42a of the support member and the upward hook shape 127 on the left side from the adjacent U shaped spacer brace passes over and through the hole 36 so a flat plate 201 can be installed between the hook shape 127 and the web 42a of the support member. Therefore the flat plate 201 fastened to the web 42a and the downward oriented hook shape 127 firmly support the U shaped spacer brace 302 from moving horizontally within the wall framing.

FIG. 484 both show an exploded isometric view of two downward facing U shaped spacer brace 302 having a top side 302a and two parallel sides 302b extending downward on both sides of the support member shown as a C shaped channel 42 and connected at the hole 36. In FIG. 18 the left side of the U shaped spacer braces have an extension 302e with an indention 302i extending from the top side 302a with an upward oriented hook shape 127 and the right side has a flange 302f that is bent outwardly at a right angle from the parallel sides 302b. The right side of the U shaped spacer brace 302 is installed into the hole 36 so the flanges 302f wrap around the sides of the hole 36 and the left side of the adjacent U shaped spacer brace 302 with the extension 302e and hook shape 127 is installed over the right side so the flat plate 201 engages the hook shape 127 and the side edges of the right U shaped spacer brace 302 fits firmly against the flanges 302f after the flat plate 201 is secured to the web 42a of the support member. In addition, a tab 253 is located on the top edge of the flat plate 201 to be able to push the flat plate 201 into position. Therefore the hook shape 127 and flat plate 201 fit tightly to the flanges 302f and the side edges of the parallel sides 302b.

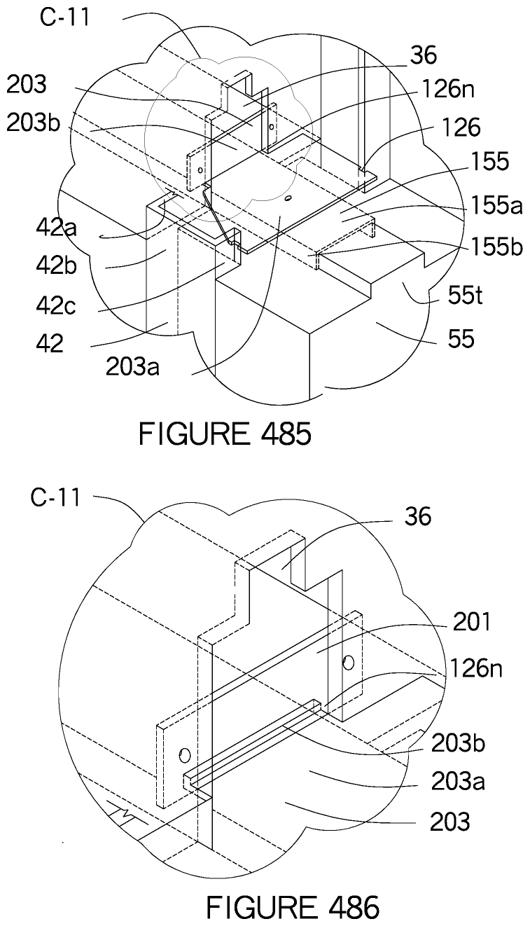

FIG. 485 show an exploded isometric view of an upward pointing V shaped spacer brace 303 having diagonally oriented sides 303a forming a vertex and where the left and right side have a notch 126 at the upper portion of each diagonally oriented sides 303a forming a continuous notch at the vertex. The V shaped spacer brace 303 is placed between the holes 36 in the web 42 of the support member and the adjacent V shaped spacer brace 303 is installed over the adjacent spacer brace 303 so the notches 126 align so a flat plate 201 can be installed into the notches 126 of both V shaped spacer braces 303 and secured to the web 42a of the support member.

FIG. 486 shows an exploded isometric view of a downward pointed V shaped spacer brace 303 having diagonally oriented sides 303a forming a vertex. In FIG. 484 the downward pointed V shaped spacer brace 303 passes through a hole 36 with a downward pointing V shaped bottom edge and the diagonally oriented sides 303a each have a notch 126 at the top edge. When an adjacent V shaped spacer brace is inserted into the hole 36 a flat plate 201 is also inserted into the notches 126 of both V shaped spacer brace and then the flat plate is secured to the web 42a of the support member.

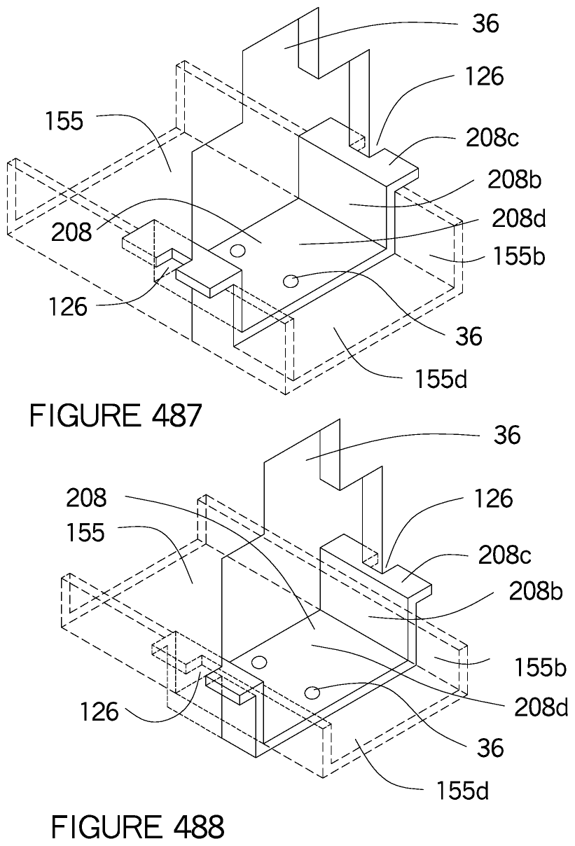

FIG. 487 is an enlargement of C-3 in FIG. 472 where a bracing member shown as a U shaped channel 155 facing upwards spanning between the holes 36 in the support members shown as C channel 42. The one piece multi-plane bracket is shown as a reverse lip bracket 208 fitting between the parallel sides 155b of the bracing member shown as a U shaped channel 155 so that the notches 126 on both sides of the lips 208c engage the side edges of the hole 36 and extend past the edge of the hole 36 to fully engage the hole 36 from moving. The bracing member and the reverse lip bracket 208 are additionally secured by fasteners between the bottom sides 155d & 208d thereby connecting the bracing member, the reverse lip bracket 208 and the hole 36 together within the support member. When two bracing members meet the one piece multi-plane bracket shown in FIG. 487 can be used to secure two adjacent bracing members together as well as some of the other one piece brackets. FIG. 488 is similar to FIG. 487, however the reverse lip bracket 208 shown with its notches 126 are installed in the hole 36 of the support members first, then the bottom side 155d of the U shaped channel 155 are installed between the two parallel sides 208b of the reverse lip bracket 208 are secured together at their bottom side 155d & 208d.

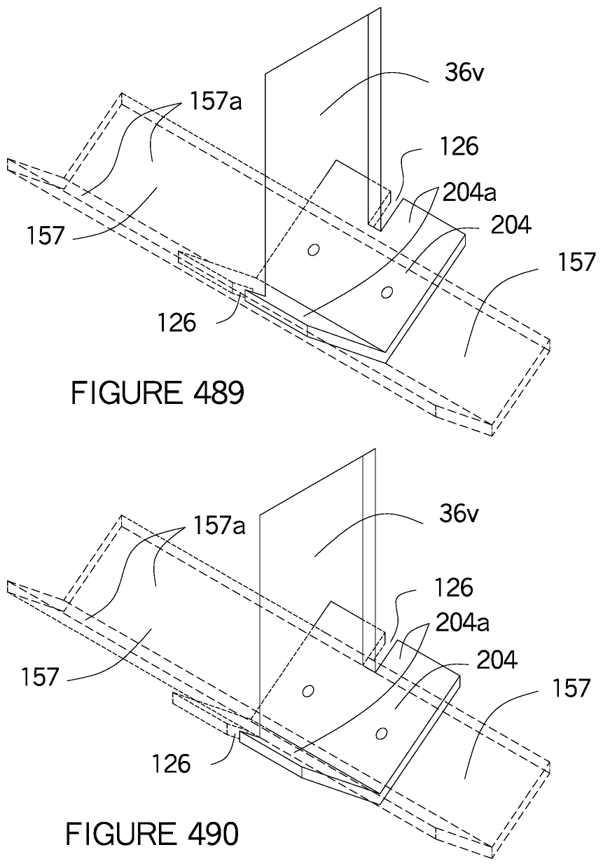

FIGS. 489 & 490 shows a one piece multi-plane bracket and bracing members are V shaped with a V shaped hole 36v with the V pointing downward. In FIG. 489 the V shaped channel 157 spans between the V shaped holes 36v in the support member. The one piece multi-plane bracket is shown as a V shaped bracket 204 consisting of two angular sides 204a connected at a point and where the V shape points downward and has notches 126 in each angular side 204a that engages the V shaped hole 36v and extends past the V shaped hole 36v forming the notch 126. The V shaped bracket 204 and the V shaped channel 157 are connected at their angular sides to eliminate any horizontal movement between support members. FIG. 489 shows the bracing member passing through the V shaped hole 36v and then the V shaped bracket 204 is installed into the angular sides 157a of the V shaped channel 157 and connected with fasteners to the angular sides 204a & 157a. In FIG. 490 the V shaped bracket 204 is inserted into the V shaped hole 36v first then the V shaped channel 157 is installed into angular sides 204a of the V shaped bracket 204 and connected with fasteners to the angular sides 204a & 157a.

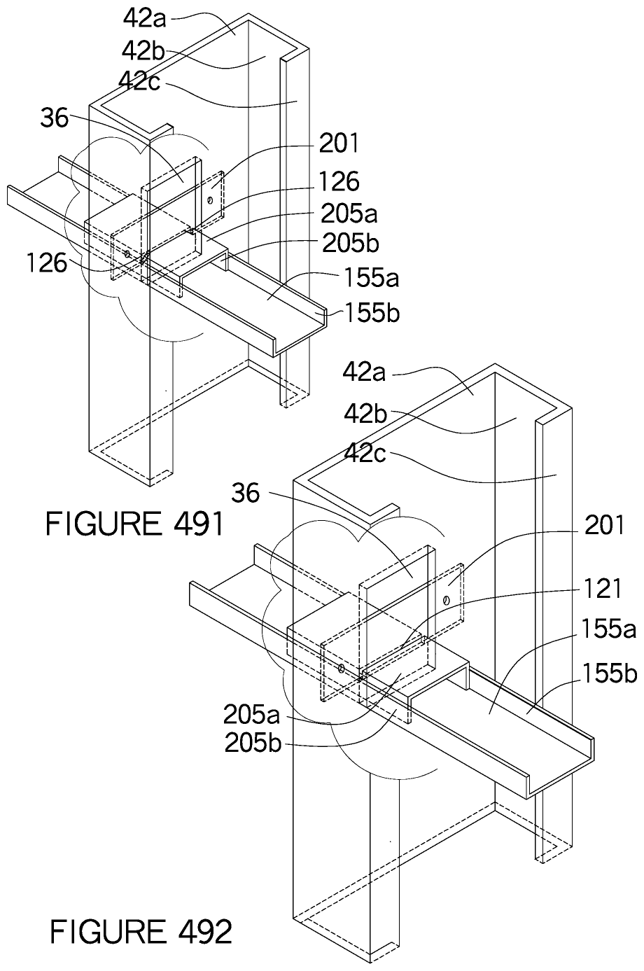

FIG. 491 shows an upward oriented U channel 155 having a bottom side 155d and two parallel sides 155b passing through the hole 36 in the web 42a of the support member shown as a C channel 42. In FIGS. 490 &491 the two piece bracket consists of a downward facing U shaped bracket 205 having a top side 205a and two parallel sides 205b extending downward and a flat plate 201. The two parallel sides 205b of the downward facing U shaped bracket 205 fit into the side edges of the parallel sides 155b of the bracing member. The flat plate 201 has a length longer than the width of the hole 36 in the support member in FIG. 491 and shows a continuous groove 121 on the top side 205a of the U shaped bracket with the groove 121 extending into the two parallel sides 205b to secure the flat plate 201 having a horizontal edge that fits into the groove 121 and where the flat plate 201 is then connected by fasteners to the web 42a of the support member. In FIG. 490 notches are cut on both sides of the top side 205a and on each of the two parallel sides 205b of the U shaped bracket 205 so the angular side edges at the bottom edge of the flat plate 201 can fit into the notches 126 and the flat plate 201 is connected by fasteners to the web 42a of the support members. The U shaped bracket also protects any electrical wires should the bracing channel be used as an electrical chase, in fact the a continuous U shape bracket could be used as a conduit to protect any mechanical means passing through the wall framing and spacer blocks.

FIGS. 493, 494 & 495 show a bracing member V shaped channel 157 pointing upwards having two angular sides 157a engaging the side edges of the hole 36 in the web 42a of the support member and connected at the vertex. In FIG. 493 the angular sides 157a at the vertex has a notch 126 where a one piece bracket shown as a flat plate 201 fits into and is connected by fasteners to the web 42a of the support member. In FIGS. 494 & 495 show a two piece bracket where the first piece is a short V shaped bracket 204 having two angular sides 204a fit over the V shaped channel 157 with a notch 126 at the vertex. FIG. 494 shows a rectangular shape flat plate 201 fitting into the notch 126 and connected by fasteners to the web 42a of the support member. FIG. 495 is similar to FIG. 4941 except the flat plate 201 is multi-sided where two sides conform to the angular sides 204a of the V shaped bracket 204 to eliminated air passage between the holes 36 in the support members.

FIG. 493 shows an exploded isometric view of downward facing fire block spacer braces 303 having a top side 303a and two parallel sides 303b extending downward with projecting horizontal wings 303w from the bottom edge on both sides and two parallel side 303f extending downward from the horizontal wings 303w and spanning between support members shown as a C shaped channel 42 and connected at the holes 36. The left side has an extension 303e extending from the top side 303a with a hook shape 127 extending downward and the right side has a slot hole 128 one the top side that the downward oriented hook shape 127 fits into plus an extension 303e with a downward oriented hook shape 127 that fits over the lower edge of hole 36. The projection horizontal wings 303w can be extended from the parallel sides from an upward oriented U shaped spacer brace 302 as well as the reverse lip spacer brace 301. The two parallel sides 303f are not necessary for the fire block spacer braces 303, but does add an additional edge to block a fire should one occur within a wall framing structure.

FIG. 494 is a isometric view of a horizontally oriented truss joist 401 which can be used as a window or door header shown as vertical wall framing as shown in the elevation of FIG. 472. The horizontally oriented truss joist 401 is shown having diagonally oriented U shaped spacer braces 302 span between holes 36 in the horizontally oriented support members shown as a C shaped channel 42 having a horizontally oriented web 42a with two vertically oriented parallel sides 42b with lips 42c extending inwardly from the parallel sides for additional strength if required. The width of the U shaped spacer braces 302 are wider than the width of the hole 36 and only the extension 302e and the hook shape extend through the hole 36 where the hook shape 127 braces the web 42a on one side and the ends of the top side 302a or bottom side 302d of the U shaped spacer brace 302 plus the ends of the two parallel sides secures the U shaped spacer brace 302 to the horizontally oriented support member. A vertically oriented U shaped spacer brace 302 (shown in ghost) is required to be wider than the diagonally oriented U shaped spacer braces 302 in order to fit around the two parallel sides 302b with the extensions 302e and hook shape 127 fitting through the holes 36 and engaging the hole 36 at the hook shape 127 and the edges of the top sides 302a or bottom side 302d and the two parallel sides fitting against the web 42a. The vertical spacer brace is sometimes required to distribute the structural load forces within the truss joist.

FIG. 495 shows an isometric view of the structural insulating core 111 where the depth of the spacer blocks 55 are the same as the width of the support members shown as C shaped channels 42. Previous figures have shown the spacer blocks 55 with different thicknesses, some overlapping and or protruding the C shaped channels 42. The left side of the spacer blocks 55 is referred to as the tongue side 56a where the spacer blocks 55 are installed against the lip 42c extending the depth of the flange 42b and abuts the web 42a of the C shape channel 42 and the opposite side or groove side of the groove side 55b abuts the web 42a of an adjacent C shaped channel 42. Since not all spacer blocks 55 may not extend the full height of the structural insulating core 111, the spacer blocks 55 can abut between each other by connecting together the horizontal tongue 56t of one spacer block 55 fits into a trough 132 of another spacer block 55. The trough 132 can be the depth of the horizontal tongue 55t or can be extended deeper to allow of mechanical/utilities to pass through the trough 132 which is larger in size. The spacer blocks 55 shown in FIG. 495 use different heights spacer blocks 55. The spacer blocks 55 are shown at the concrete floor 39′ between each of the support members are short in height and all have a flat bottom with a horizontal tongue 55t on the top of the spacer block 55. Various horizontal and diagonal spacer bars are shown integrated in the middle of the spacer blocks 55. At the concrete floor 39′ a spacer brace is shown in C-1 in FIG. 472 and is used as a starter at the bottom of the C shaped channel 42. Another spacer brace also shown as C-1 is shown as a downward facing U shaped spacer brace 302 having a downward oriented hook shape 128 for an adjacent support member to be connected. Just above is an area C-2 where several adjacent spacer braces are connected to each other and the holes 36 in the support members as shown in FIGS. 475-487. On the left side the spacer blocks 55 are cut at an angle for diagonal spacer braces can be installed as shown in C-5. The U shaped spacer brace 302 and the reverse lip spacer braces 301 have parallel sides 302b & 301b that fit over the sides of the horizontal tongue 55t and passing through the hole 36 in the web 42a of the C shaped channel 42 and onto the horizontal tongue 55t of the adjacent spacer block 55. The adjacent spacer block 55 also shows a medium height spacer block 55 above between support members and connected together with another U shaped spacer brace 302 on top of the spacer block 55. All the spacer blocks 55 have a trough 132 and a horizontal tongue 55t that fit into the trough 132. The U shaped spacer braces can fit with the trough 132 or the U shape fits into horizontal tongue 55t of the spacer blocks 55. The spacer block 55 above the first spacer block 55 shows a horizontal hole 36h in the middle of the spacer block 55 spanning the length of the spacer block 55 between the support members. The horizontally orient hole 36 is located where the adjacent spacer blocks 55 have the horizontal bracing channel passing between spacer blocks 55. The horizontal bracing members can be installed on one spacer block 55 and extended through the holes 36 of the C shaped channels 42 and on to the horizontal tongue 55t of the adjacent spacer block 55. The extending horizontal bracing members only need to be secured to the horizontal tongue 55t a short distance, just enough to secure the adjacent spacer blocks 55 on either side of the extending horizontal bracing members. Horizontal bracing members can be installed in short segments that is staggered every other spacer block 55 just enough to secure the spacer blocks 55 together. The spacer block 55 can be reversed as discussed earlier that is with the trough 132 on top of the spacer block 55 and the horizontal tongue 55t located at the bottom of the spacer block 55. The horizontally oriented holes 36 can be cut with a hot wire or can be molded with the hole 36 formed into the spacer block 55 at the time of molding the spacer block 55.

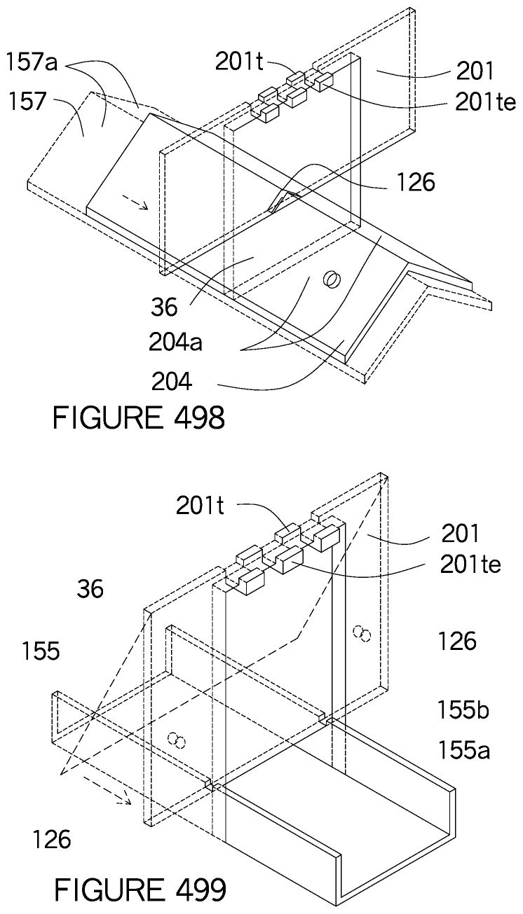

FIG. 497 and FIG. 498 is similar to C-10 in FIG. 472 except the second piece of the two piece bracket has teeth 201t and extended teeth 201te shown on the top edge of the flat plate 201. The teeth 201t are projections that protrude from the top edge of the flat plate 201 and the extended teeth 201te are alternating projections that extend outward from the flat plate 201 so the teeth 201t & extending teeth 201te are separated enough so that teeth 201t is on one side of the top edge of the hole 36 and the extending teeth 201te are on the opposite side of the top edge of the hole 36 in the web 42a of the support member shown as a C channel 42. FIG. 39 is an enlargement of FIG. 498 where the spacer block 55 has the trough 132 showing the bracing member shown as U shaped channel 155. The flat plate 201 with its teeth 201t and extended teeth 201te are aligned so the flat plate 201 is partially inserted into the notches 126 on the U shaped bracket 205 and the teeth 201t are aligned with the top edged of the hole 36. The U shaped bracket 205 is moved in the direction of the hole 36 into a vertical position so to allow the extended teeth 201te to protrude under the top edge of the hole 36 and fit tight against the web 42a of the C channel 155. The U shaped bracket 205 is then connected by fasteners to the bottom side 155d of the bracing member. The same method for installing the flat plate 201 with the teeth 201t & extended teeth 201te.

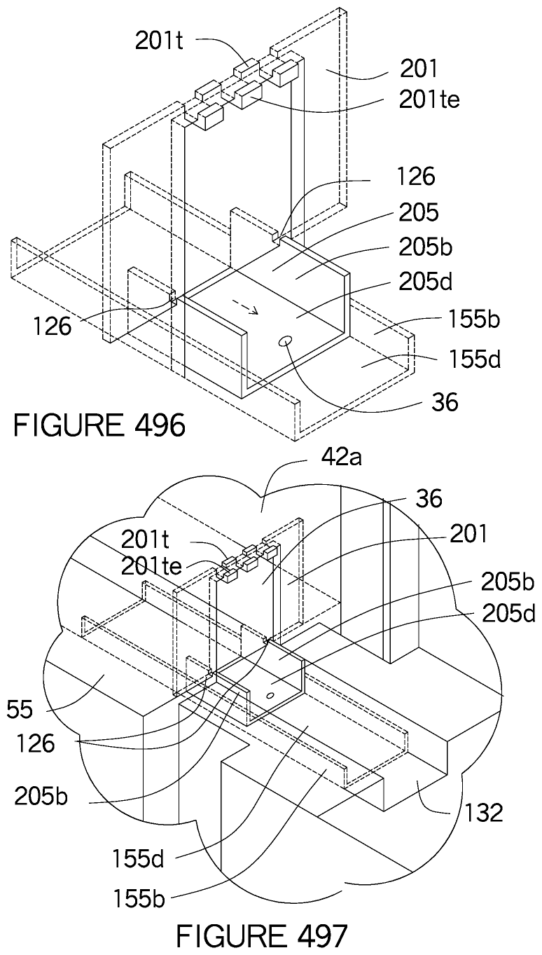

FIG. 498 is similar to FIG. 494 except the flat plate 201 also has the teeth 201t and extended teeth 201te on the top edge. The same method of installation to install the flat plate 201 into the hole 36 that was used in FIGS. 496 & 497 would be used in FIG. 4921. That flat plate 201 is shown installed in the notch 126 at the vertex of the V shaped bracket 204 and fitting over the bracing member shown as a V shaped channel 157. The flat plate 201 with its teeth 201t and extended teeth 201te are aligned so the flat plate 201 is partially inserted into the notches 126 on the V shaped bracket 204 and the teeth 201t are aligned with the top edged of the hole 36. The V shaped bracket 204 is moved in the direction of the hole 36 into a vertical position so to allow the extended teeth 201te to protrude under the top edge of the hole 36 and fit tight against the web 42a of the C channel 42. The V shaped bracket 204 is then connected by fasteners to the angular sides 157a of the bracing member. The same method for installing the flat plate 201 with the teeth 201t & extended teeth 201te can be used in FIG. 34, even though the notches 126 are on the edges of the angular sides 204a of the V shaped bracket 204.

FIG. 499 shows a different method for installing the flat plate 201 in a bracing member shown as a U channel 155 having a bottom side 155d and two parallel sides 155b with notches 126 on both side ends is different than in FIG. 490. Since a bracing member spans between support channels, the flat plate 201 is installed on the edges of the two parallel sides 155b and the teeth 201t is placed at the top edge of the hole 36 so the extended teeth 201te can slide underneath the top edge of the hole 36 as the flat plate 201 is pressured to move toward the hole 36 by using a hammer or other means to force the flat plate 201 into a vertical position against the web 42 of the support member.

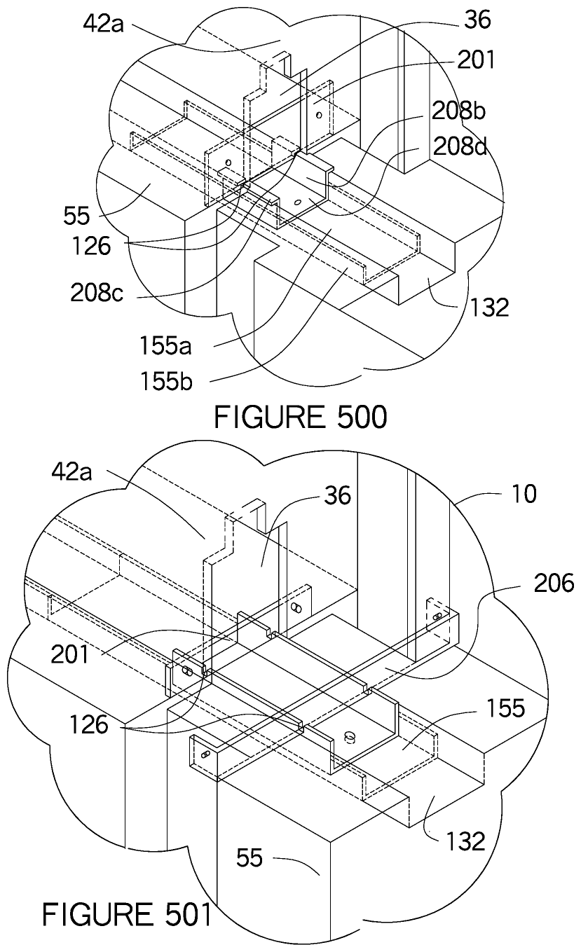

FIG. 500 shows a similar profile as FIG. 479 where the trough 132 is on top of the spacer block 55 with a bracing member shown as U shaped channel 155 facing upward with the bottom side 155d installed at the bottom of the trough 132 and the two parallel sides 155b against both sides of the trough. The first piece of the two piece bracket is a multi-plane bracket shown as a reverse lip bracket 208 having a bottom side 208d with two vertically parallel side 208b with lips 208c extending outwardly. The parallel sides 208b are installed between the parallel sides 155b of the bracing member. The lips 208c of the reverse lip bracket 208 has ½ notches 126n engaging the sides of the hole 36 of the support member shown as a C channel 42 and another ½ notch 126n at each lip 208c and extending into the parallel sides 208b so the second piece of the two piece bracket shown as a flat plate 201 can be inserting into the ½ notch 126. The flat plate 201 is also fastened to the web 42a of the support member and the first piece can be connected to the bottom side 155d of the bracing member if the additional fastener is required for additional strength.

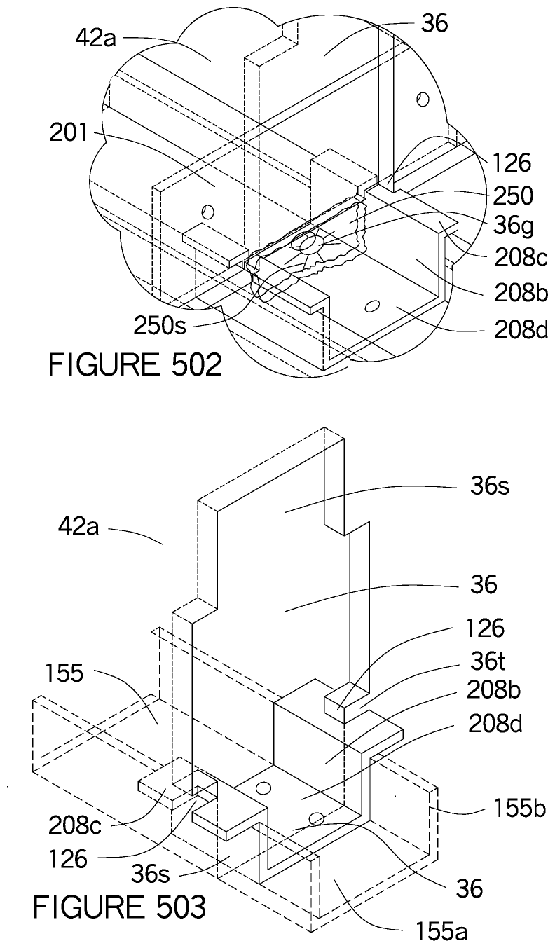

FIG. 501 is an enlargement of C-10 in FIG. 472. The two piece bracket shown in FIG. 501 has the same first piece a U shaped bracket 205 supporting the second pieces shown as a flat plate 201.

FIG. 502 has the same bracing member and two piece bracket construction is shown in FIG. 500 except a grommet 250 has been added. The grommet 250 is shaped so the top edge of the grommet 250 is concave, where the upper edges will extend on both sides of the bottom edge of the flat plate 201 and the remaining sides abut the parallel sides and bottom side of the reverse lip bracket 208. The grommet 250 has a hole 36g in the middle with slots 250s around the edges of the hole 36g in order for the hole 36g to be expanded larger to accommodate electric wiring (not shown) or other utilities to pass through.

FIG. 503 shows a one piece multi-plane bracket connecting the hole 36 in the support member as shown in FIG. 86 however with the reverse lip bracket 208 and bracing member are smaller in width. FIG. 503 shows a hole 36 that is wider in middle with smaller size holes 36s at the top and bottom edges of the hole 36 which is a standard size hole produced by metal stud manufactures. The reverse lip bracket 208 is installed in the smaller width portion of the hole 36 so the bottom side 208d and the parallel sides 208b fit within the smaller area of the hole 36. The lips 208c with its notches 126 at the ends, are installed so the notches 126 extend on both sides of the throat 36t of the hole 36. The reverse lip channels 156 shown in FIGS. 480 & 484 can also be smaller in width to fit into the smaller size holes 36s.

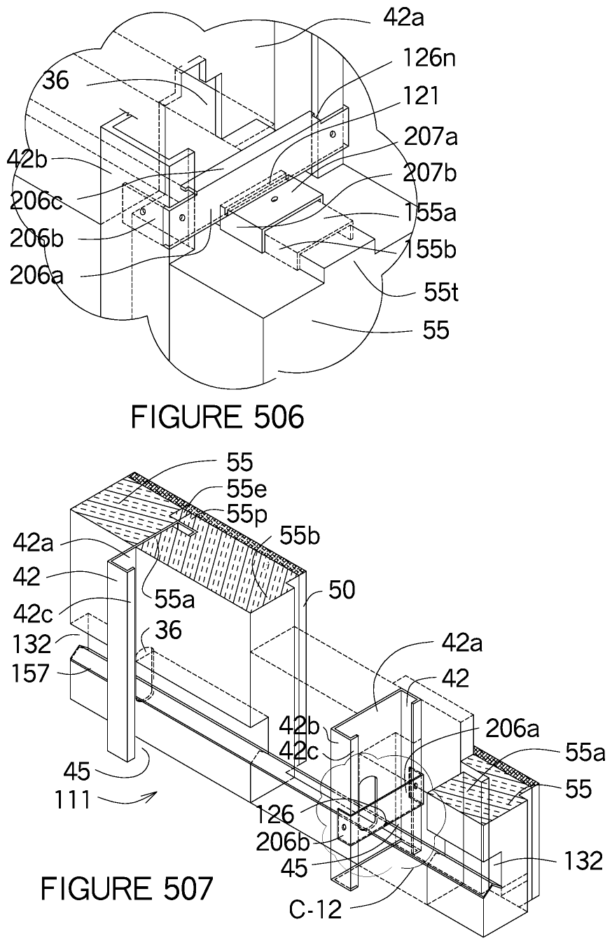

FIG. 506 is a one piece bracket that fits over a bracing member and FIG. 7 which is also a one piece bracket that is an L-shaped bracket 203 that fits over the U shaped channel 155. FIG. 506 shows the bracing member as a U shaped channel 155 with the parallel sides 155b and a top side 155a fitting over the horizontal tongue 55t of the spacer block 55. The first piece of the two piece bracket is a multi-sided bracket 207 where one side 207a is horizontal and installed over the top side 155a and has two parallel sides 207b that is vertical and fits over the two parallel sides 155b of the U shaped channel 155 and has a groove 121 on the side 207a with notches 126 on both parallel sides 207b. A U shaped clip 206 shown vertically fits into the groove 121 and the notches 126 at the web 206a and is connected to the flanges 42b of the support member to the U shaped clip 206 at the lips 206c.

FIG. 507 show the bracing members as V shaped channels 157 with the vertex of the V pointing upward passing through the hole 36 in the web 42a of the C channel 42. In FIG. 507 the spacer block 55 and the horizontal tongue 55t are shown at the top of the spacer block 55 and the V shaped channel 157 is resting on the horizontal tongue 55t. The V shaped channel 157 shows a notch 126 formed at the vertex of the angular sides 157a and a U shaped clip 206 is installed vertically into the notch 126 at the side 206a and the two parallel sides 206b wrap around and are secured at the flanges 42b of the C channel 42. In FIG. 507 the spacer blocks 55 are shown with a gap 45 between the open side of the trough 132 and the flange 42b the C channels 42. The opposite side of the spacer block 55 has a projection 55p that passes over the flange 42b of the C channel 42 and the extension 55ex extends past the flange 42b onto the adjacent spacer block 55. At the trough 132 a gap 45 occurs between the bottom of the U shaped clip 206 and the back side of the V shaped channel 157 for mechanical utilities to pass. In FIG. 507 the V shaped channel 157 passing through the holes 36 in the support member shown as C channel 42. Many of the other bracing members or bracket connections can be used in lieu of the V shaped channel 157. The V shaped bracket 204 and the V shaped channel 157 are connected at the angular sides 204a & 157a. The web 206a of the U shaped clip 206 is installed vertically into the notch 126 and the flanges 206b wrap around and are secured at the flanges 42b of the C channel 42. In addition, notches 126 can also be installed at the bottom of the angular sides 157a so the notches 126 can engage the hole 36, but are really not required especially since the U shaped clip 206 is connected to the flanges 42b of the C channel 42.

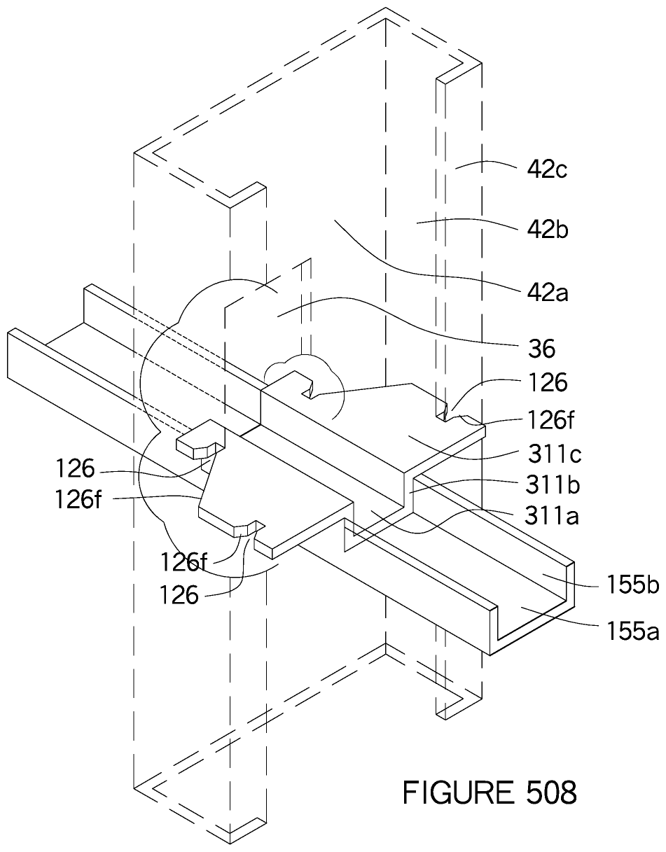

FIG. 508 shows a butterfly bracket 311 being attached to a support member shown as a C channel 42 and a horizontal bracing channel shown as a U-shaped channel 155 where the web 155a of the U-shaped channel 155 rests on the bottom edge of the hole 36 and the flanges 155b fit against the side edges of the hole 36 in the web 42a of the support member. The butterfly bracket 311 shown having a web 311a and flanges 311b fit tight against the ventral side of the horizontal bracing channel 155 and the lips 311c extend outwardly from its flanges 311b. The lips 311c extend outwardly having notches 126 with flares 126f that are angular where the notches 126 engage both sides of the vertical side edges of the hole 36 and the side edge of the lips 42c of the support member. The lips 311c extend longer away from the flanges 311b as the distance to the lips 42c varies depending on the width of the web 42a and the length of the lips 42c of the support member.

FIG. 509 shows a double reverse clip bracket 312 being attached to two support members shown as a C channel 42 and a horizontal bracing channel shown as a U-shaped channel 155 where the web 155a of the U-shaped channel 155 rests on the bottom edges of the holes 36 and the flanges 155b fit against the side edges of the holes 36 in the webs 42a of the support members. The double reverse clip bracket 312 is shown having a web 312a and flanges 312b fits tight against the ventral side of the horizontal bracing channel 155 and the lips 311c extend outwardly from its flanges 311b. The lips 311c extend outwardly having notches 126 with flares 126f that are angular where the notches 126 engage both sides of the vertical side edges of the holes 36 of two adjoining and adjacent support members thereby engaging two support members using the same double reverse clip bracket 312.

The various brackets shown in FIG. 472 through FIG. 509 all very in shape and size and brackets show notches 126 at various locations on the brackets. Since this application was originally filed other provisional patent applications has shown notches 126 in the side edges of the holes, notches in the side edges of the lips of the support member or notches in the web. These notches are all vertical oriented notches and the notches shown in this provisional patent application are horizontal oriented notches 126. When the vertical notches as described above intersect the vertical notches 126 then the two notches interlock so the notches to not allow the brackets to move vertically or laterally forming a self-locking connection without requiring fasteners to make the connection.

On the other hand, should the notches 126 referred to in this provisional application only be installed at the vertical location and the bracket has horizontal supports similar to FIG. 478 that extend on both sides of the hole, then be bracket would not require a notch. The vertical notch (hole notch 126h, web notch 126w—in previous applications) would support the bracket from vertical movement and the projections extending wider than the hole would prevent the bracket from a horizontal movement.

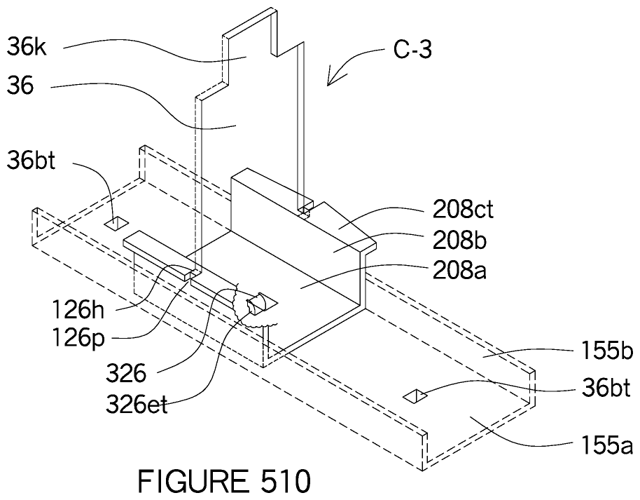

FIG. 510 is an isometric view of a reverse lip bracket 208 installed over a horizontal bracing channel 155 where the ventral side is facing upward with the web 155a resting on the bottom edge of the hole 36 with the flanges 155b against the hole side edges 36se. The dorsal side of the reverse lip bracket 208 has the web 208a and flanges 208b abutting the ventral sides of the horizontal bracing channel 155 with the lips 208c extending outward with lip notches 126p shown inserted into the hole notches 126h so that the horizontal oriented lip notches 126p interlock with the vertical oriented hole notches 126h. In addition, tab holes 36t in the web 155a of the horizontal bracing channel 155 and the punch out tabs 326 in the web 208a of the reverse lip bracket 208 are aligned so the downward oriented extended tab 326t can intend into the tabs holes 36t interlocking the reverse lip bracket 208 and horizontal bracing channel 155 together forming a self-locking screw-less framing connection.

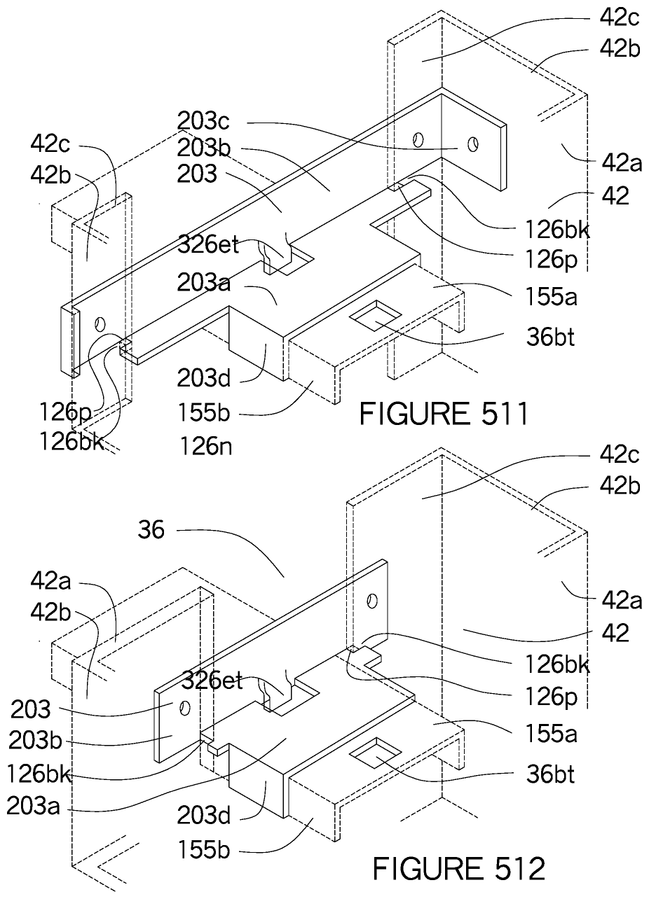

FIG. 511 shows an isometric view a one piece bracket shown as an L-shaped bracket 203 where one side is connected to the horizontal bracing channel 155, connected by a ½ notch 126a that engages the lip of the support member and the vertical side becomes the opposite side of the ½ notch 126a engaging the outer side of the lip as shown in FIGS. 475-478. The U-shape horizontal bracing channel 155 is shown with its dorsal side facing upwards passing between the lip 42c of a support member and where the dorsal side is the web 155a having an array of tab holes 36t with the ventral side having the bottom longitudinal edges of the flanges 155b resting on the bottom edge of the hole 36 in the support member. The L-shaped bracket 203 is shown having a horizontal leg 203a resting on the dorsal side of the horizontal bracing channel 155a with a vertical leg 203b that extends over the dorsal side of the lips 42c of the support member having the ends 203c wrap around the flanges 42b of the support member. The vertical leg 203a is shown having an extending tab 326t extend vertically downward from the punch out tab 326 so the extending tab 326t can extend into a tab hole 36t shown in an array in the web 155a of the horizontal bracing channel 155. The vertical oriented lips 42c of the support member have lip notches 126c that interest the ½ notches 126n and the vertical leg 203b so that the notches 126n and vertical leg 203b extend beyond the lip notches 126c so the two notches interlock between each other forming a self-locking connection between the L-shaped bracket 203 and the support member. In addition the vertical leg 203a with the extending tab 326t extends into the tab hole 36t forming another self-locking connecting between the L-shaped bracket 203 and the horizontal bracing channel 155.

FIG. 512 is similar to FIG. 511 except here the L-shaped bracket 203 has the vertical leg 203b spanning the hole 36 in a support member and the vertical leg 203b is connecting the web 42a.

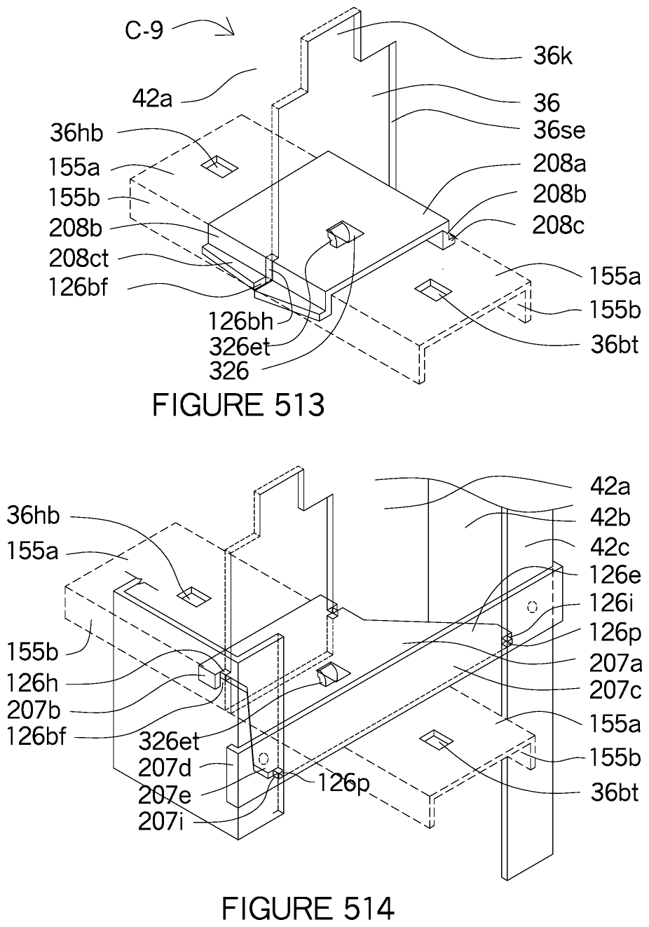

FIG. 513 is similar to FIG. 483 shown as a U shaped channel 155 facing downward where a one piece multi-plane bracket shown as reverse lip shape bracket 208 has lip notches 126p into the hole side edges 36se of the support member where vertical oriented holes notches 126h intersect the flanges 208b on both sides of the web 42a of the support member. In addition the web 208a has a punch out tab 326 with an extend tab 326t projected downward into the tab hole on the web of the U shaped channel 155.

FIG. 514 shows the same L-shaped bracket 203 as shown in FIG. 511 58 except the one piece multi-plane bracket shown as an L-shaped butterfly bracket 207 so here the horizontal leg 207a is longer and tapered compared to the L-shaped bracket 203 so the horizontal leg 207a can extend through the hole 36 of the support member. The web 207a passes through the hole 36 having and have a butterfly flange notch 126bf at the web 201a that also extends a

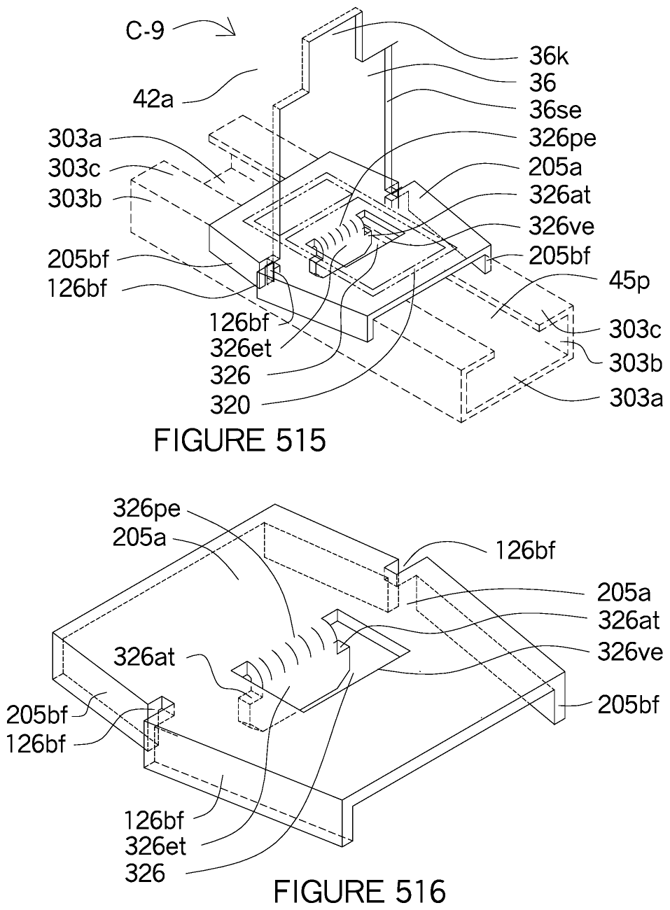

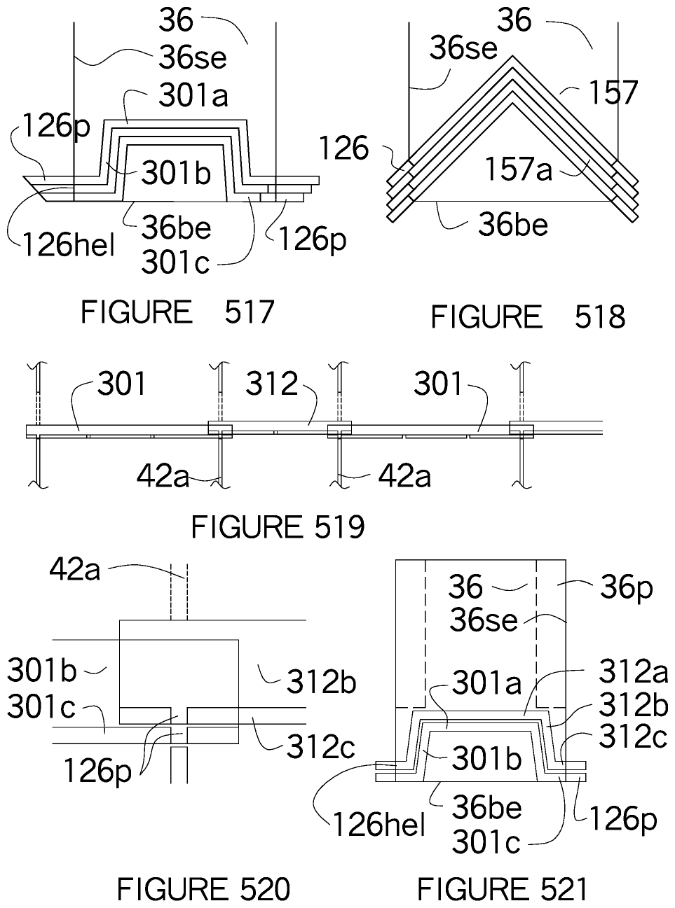

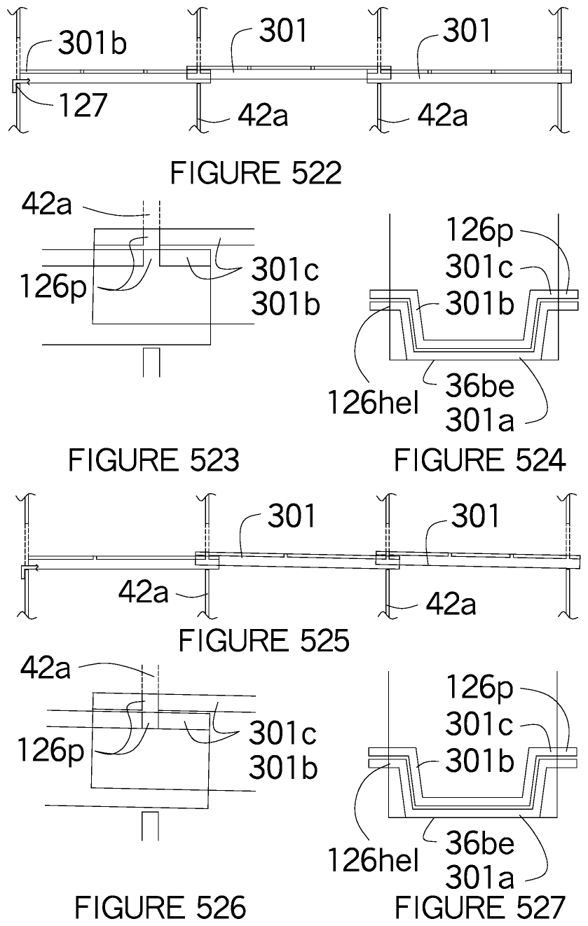

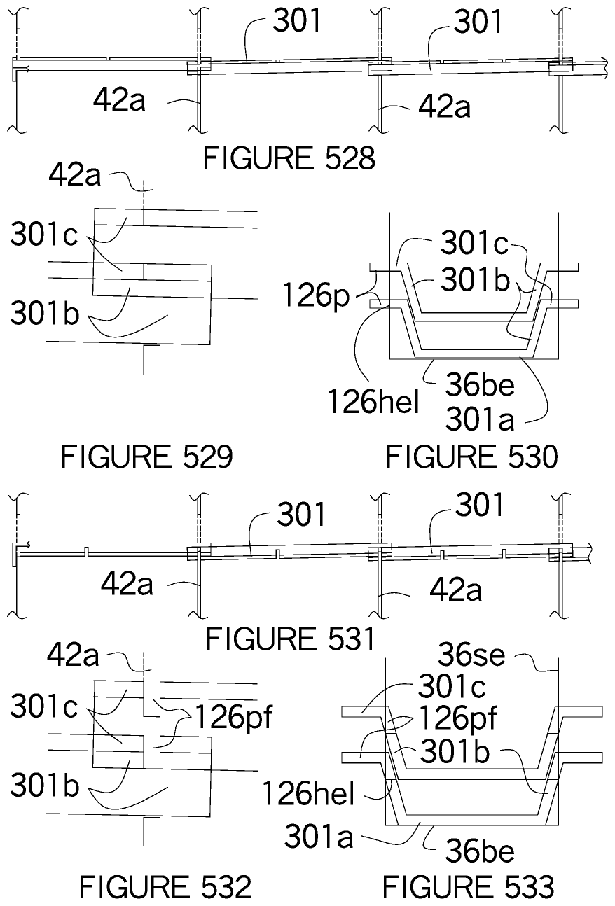

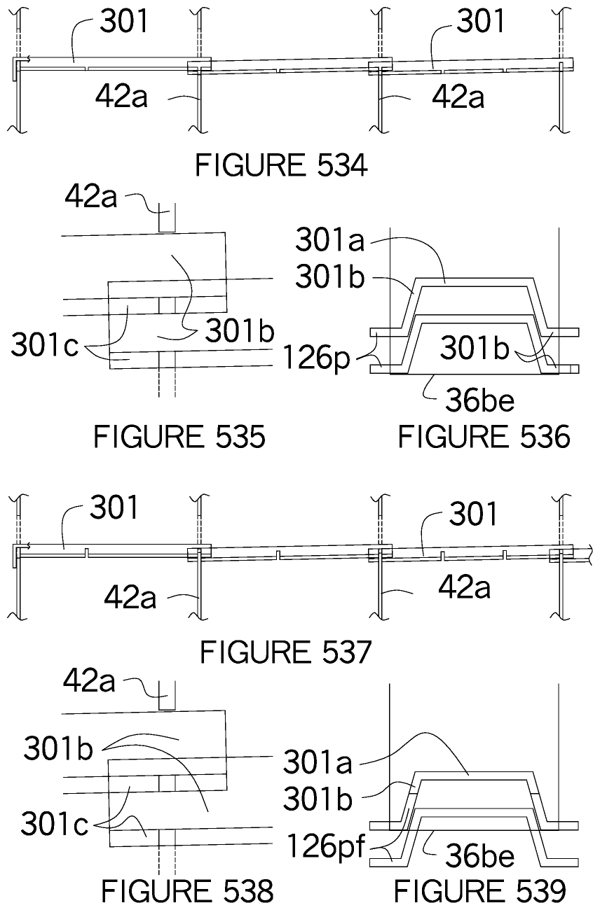

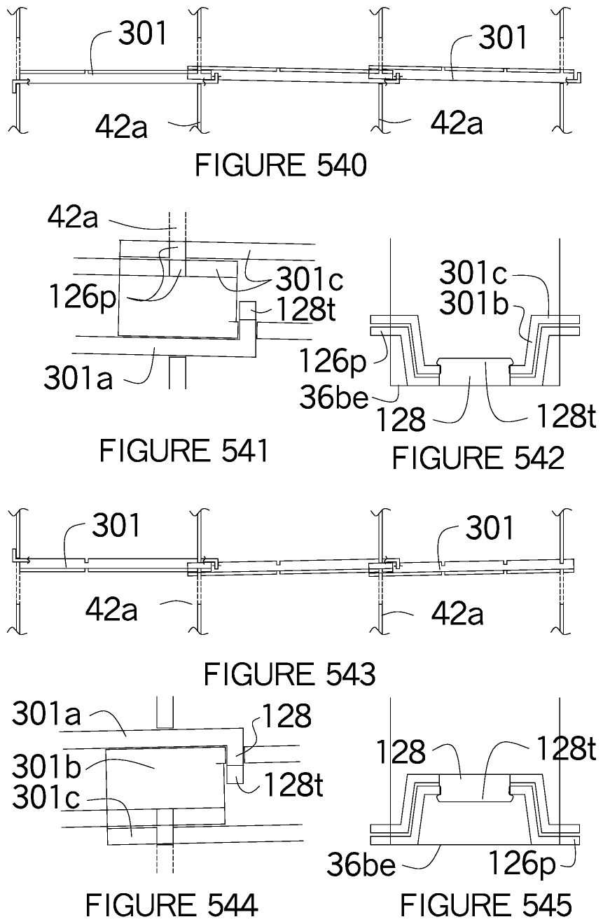

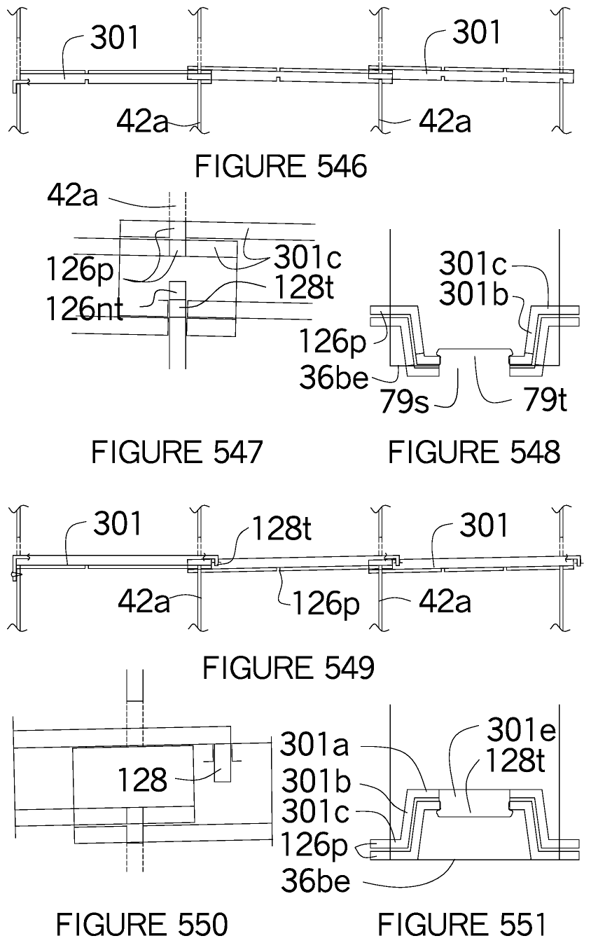

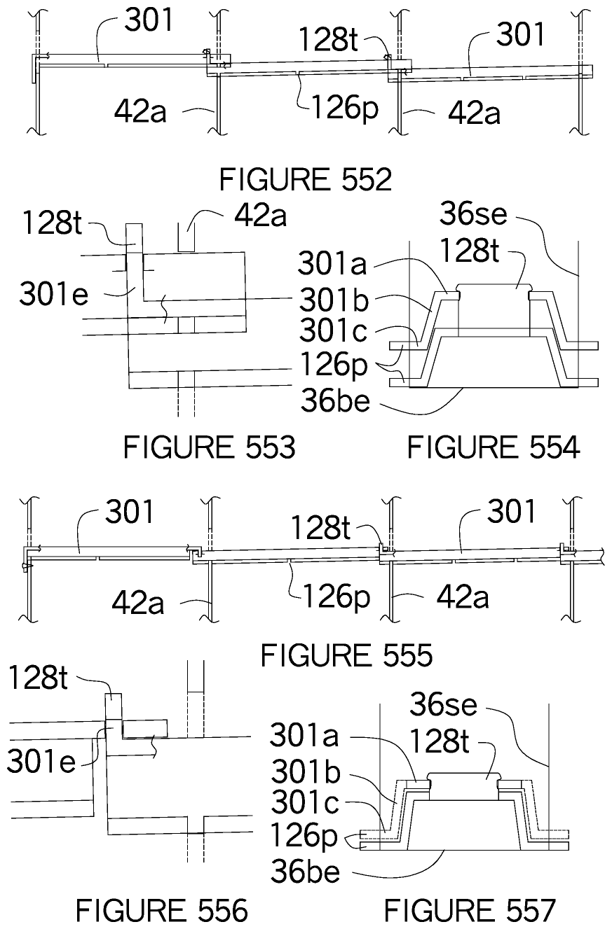

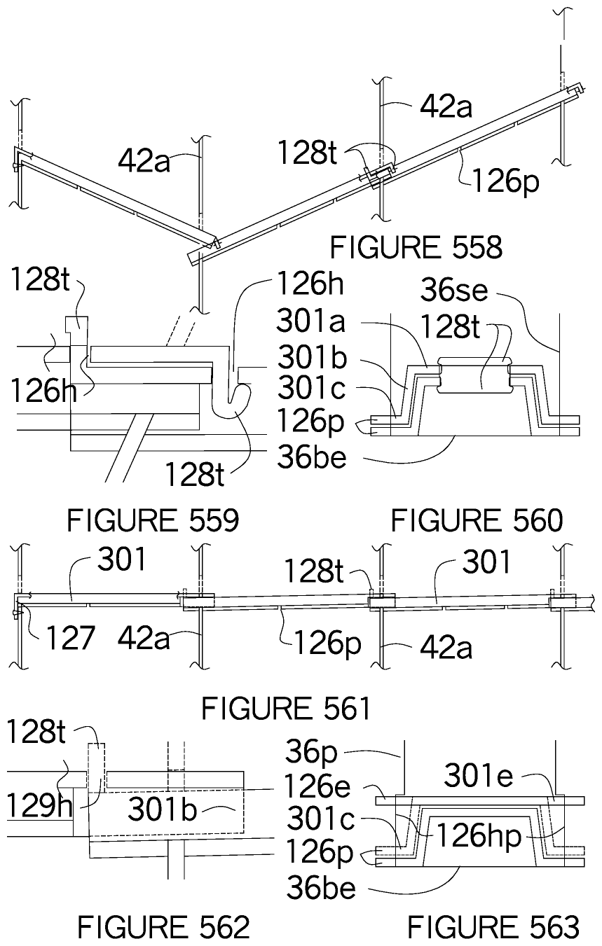

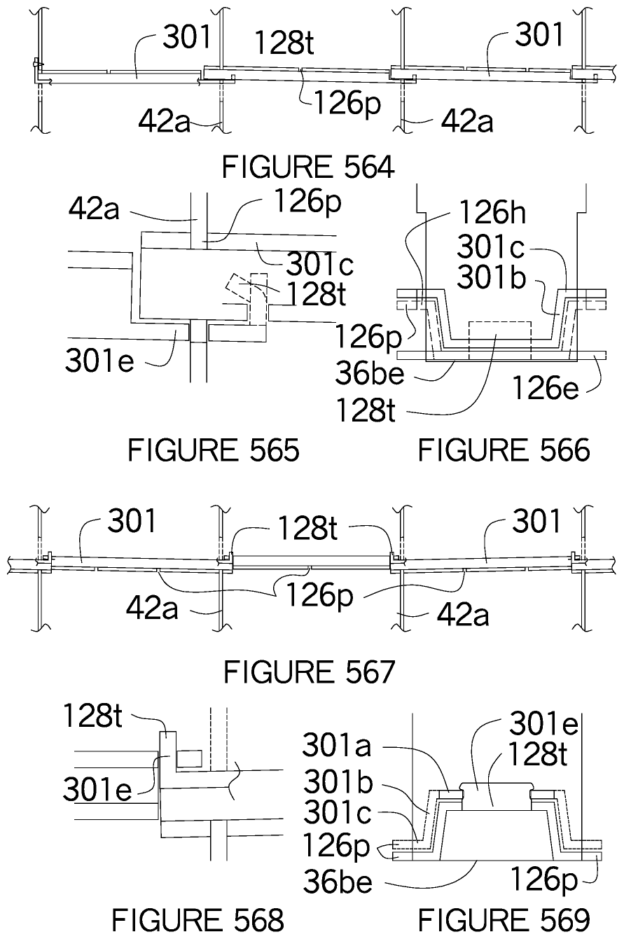

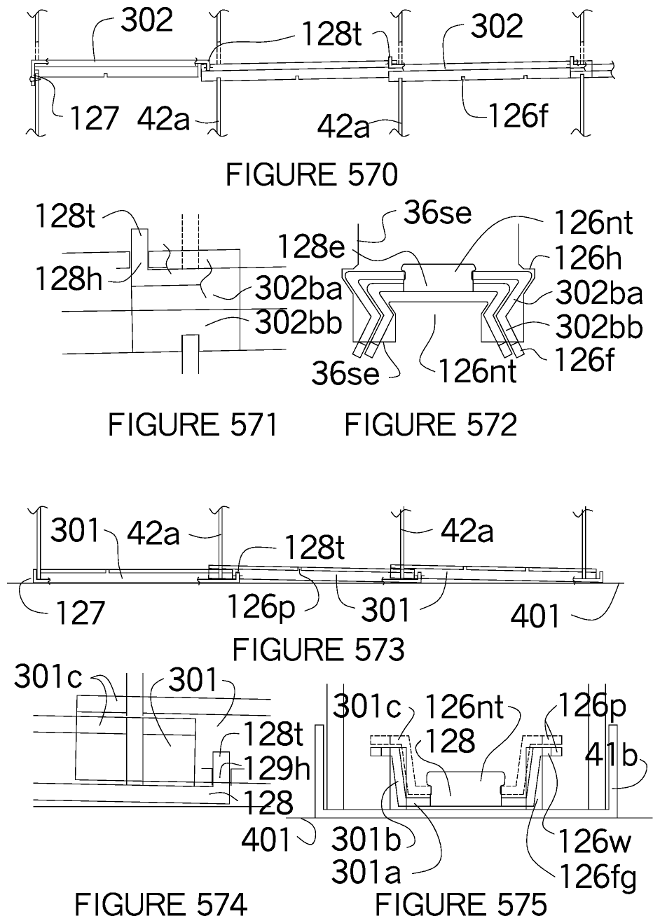

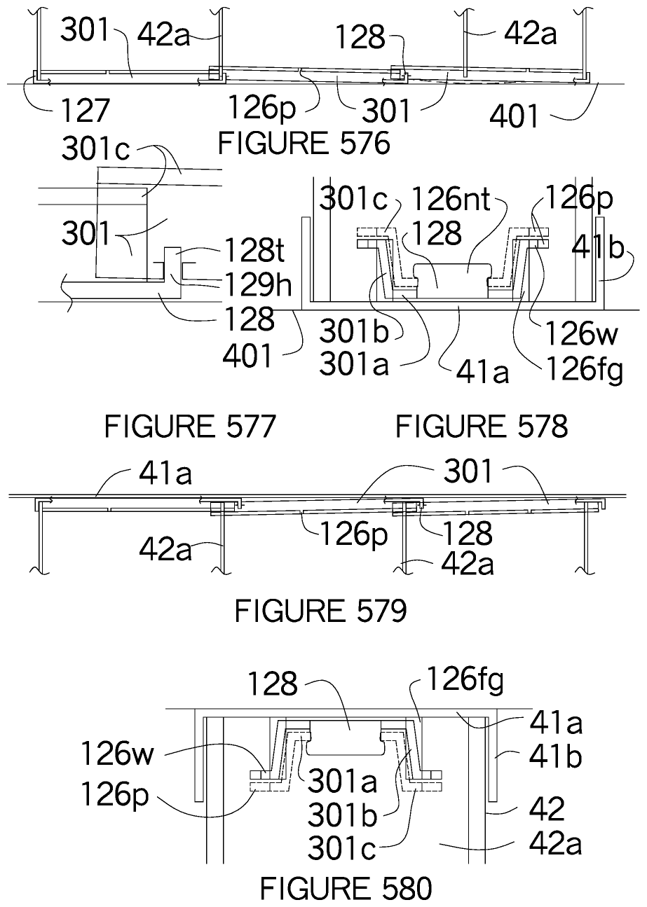

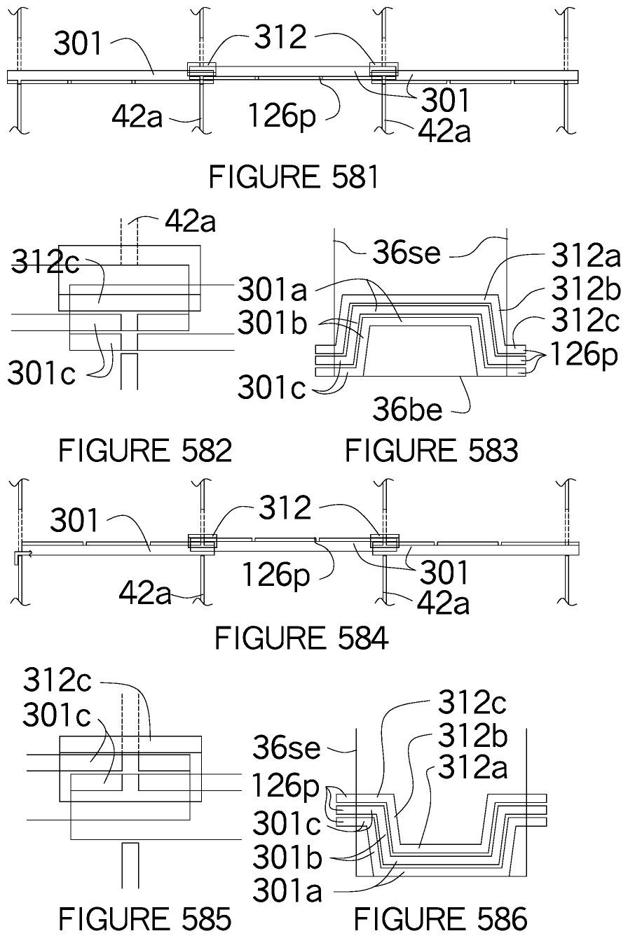

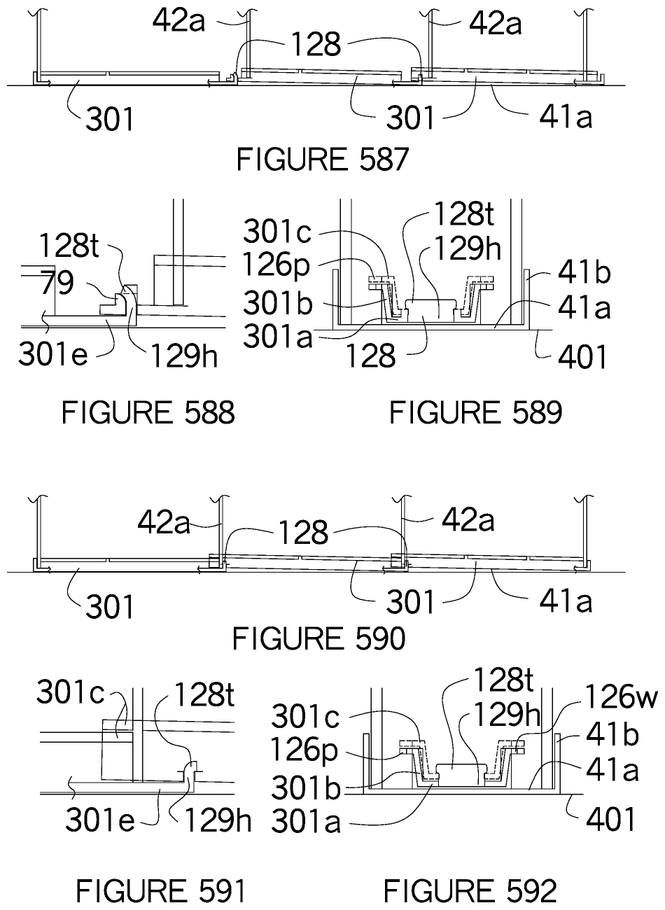

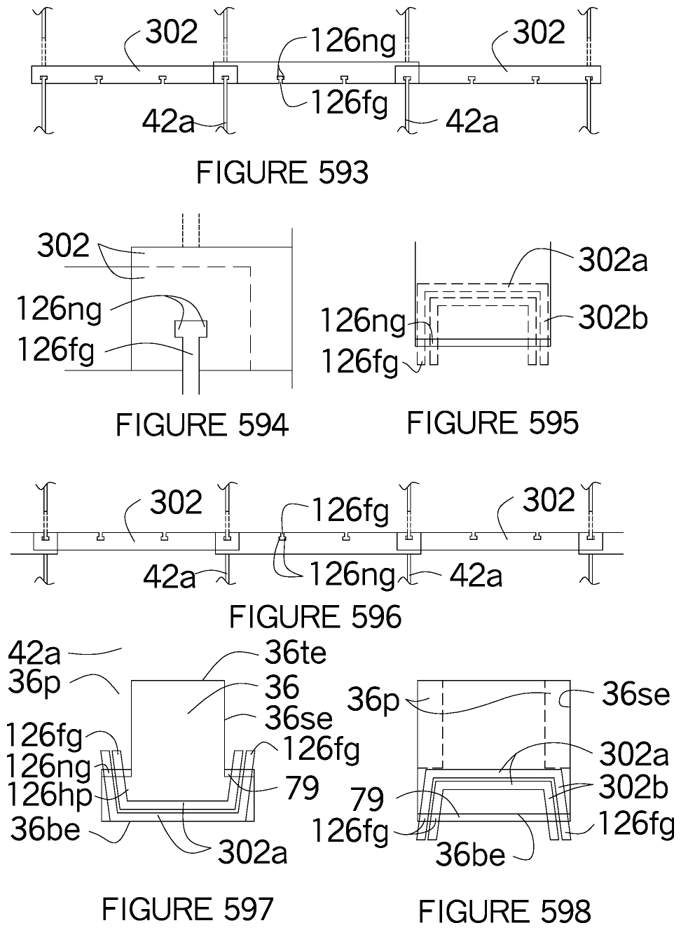

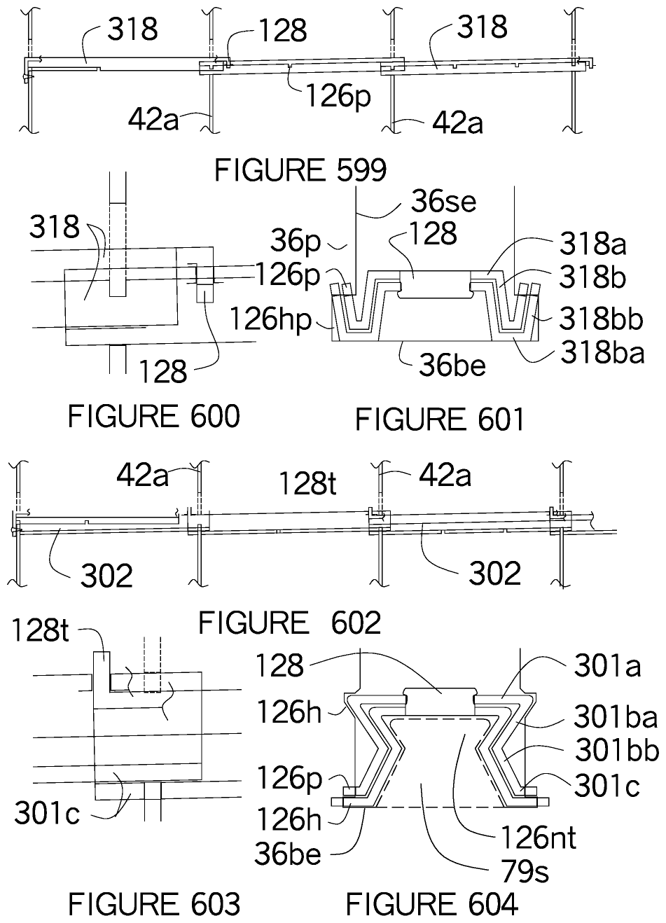

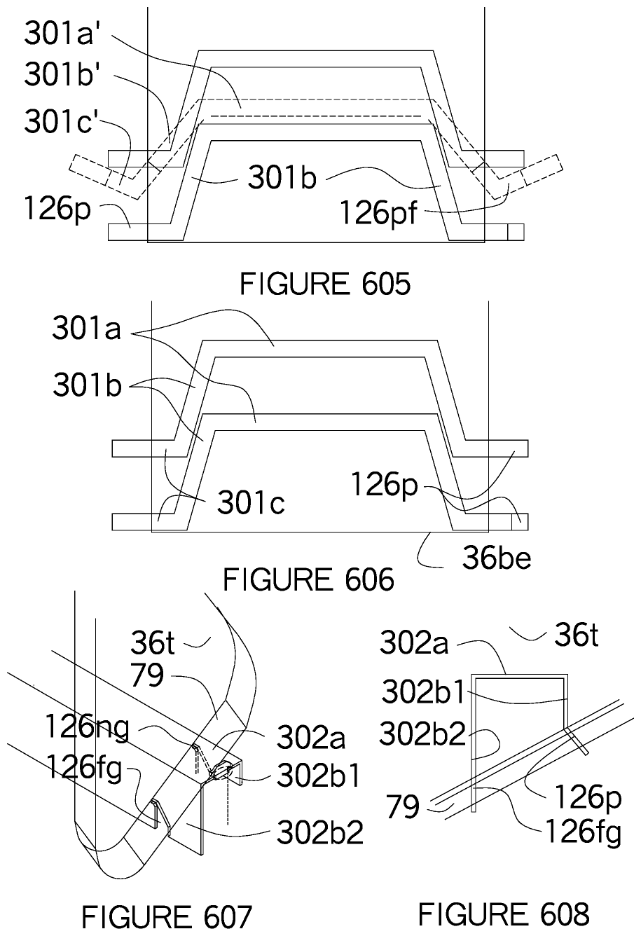

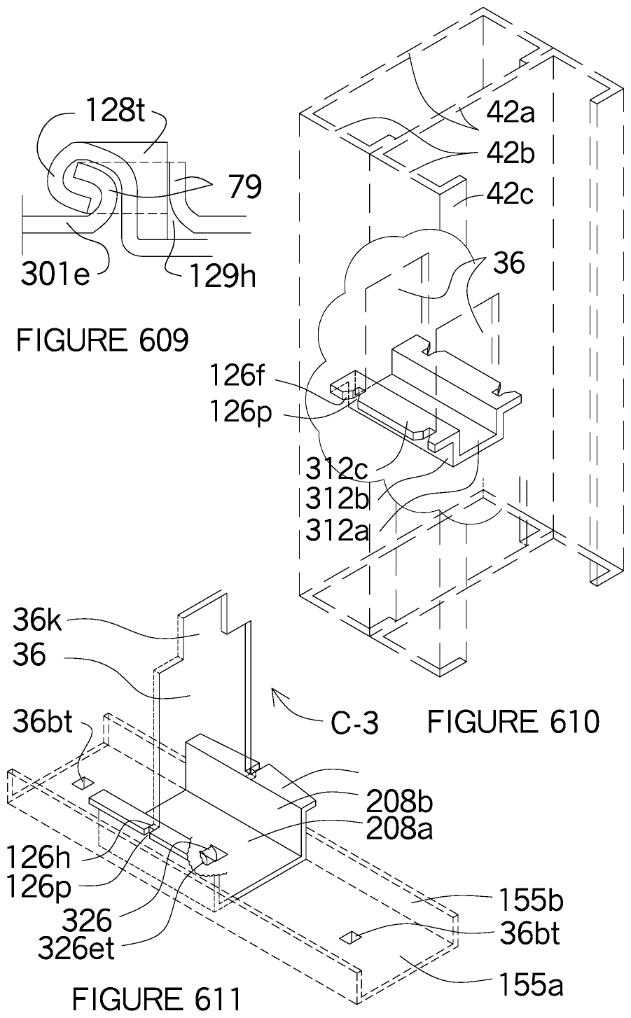

FIG. 515 shows a horizontal oriented C shaped spacer brace 303 spanning between the holes 36 of an array of support members where the dorsal side is a web 303a that rests on the bottom edge of the hole 36 with flanges 303b extending upward from the web 303a and lips 303c extending from the flanges 303b forming a C shape spacer brace 303. A butterfly bracket 205 also shown in FIG. 516 extends over a C shaped spacer brace 303 where the ventral side of the butterfly bracket 205 extends over the lip gap 45p and the lips 303c of the C shaped spacer brace 303 with its flanges 205b extending over the flanges of the C shaped spacer brace 303. The butterfly bracket 205 having a U-shape where the web 205a and flange 205b are notched to form a butterfly flange notch 126bf and where the butterfly flange notches 126bf is inserted into the hole notches 126h at the hole side edges 36se so the hole side edges 36se support the top and bottom planes of the web 205a and the butterfly flange notches 126bf support the vertical planes of both sides of the web 42a at the hole 36. The web 205a of the butterfly bracket 205 is shown having a punch out tab 326 with a vertically downward extending tab 326t inserted into the lip gap 45p between the lips 303c of the C shaped spacer brace 303. The extending tab 326t has arm tabs 326at that are formed from the punch out tab 326 and extend outward so the arm tabs 326at and the width of the extending tabs 326t are slightly greater than the distance in the lip gap 45p. The arm tabs 326at extend under the lip 303 of the C shaped spacer brace 303. The arm tabs 326at become lodged under the lips 303c and against the sides of the extending tab 326t. Another alternate solution is lip notches 126p shown previously in a C channel 42 support member can be installed in the lip 303c of the C shaped spacer brace. When the lip notches 126p are installed in the lip 303c and the extended tab 326t has arm tabs 326at the lip notches 126p and the extended tab 326t become interlocked that allows the butterfly bracket 205 to be secured to the C shaped spacer brace 303 without using fasteners. If the hole notches 126h and the butterfly-flange notch 126bf interlock together, then only the extending tab 326t is required to have a self-locking connection without using screws.

### Additional Comments Made in the Specification for FIG. 472-FIG. 506

The present invention shows many metal framing components forming many variations of construction assemblies. Some of the various components include: different shaped horizontal bracing channels configurations; different shaped holes for the horizontal bracing channels to fit into; notches installed on the horizontal bracing channels or braces to engage the holes in the support channel, lips on the support channel or engage clips or other braces; braces that are single or multi-plane braces; orientation of different shaped holes in the support channel, orientation of the horizontal bracing channel, orientation of braces that fit into or over the horizontal bracing channel; grooves in braces for clips to fit into; brace to brace connections; support channel hole with blunt end and clip connections. The notches can occur at the lip of a reverse lip channel or U shaped channel at the corners of the web and the flanges or at the vertex of a V shaped horizontal bracing channel where a blunt corner occurs at a V shaped hole.

An elongated horizontal bracing channel can have numerous notches on the horizontal bracing channel to be secured to a minimum of two support channels at the same time.

When a short support channel and a short bracing channel are secure together, a brace is formed to secure spacer insulation blocks together to form a connection between spacer blocks.

Any of the notch configurations in the horizontal bracing channel can be used as a brace. The brace is a short horizontal bracing channel with notches than fit into a larger configuration of the horizontal bracing channel and the notches connect to the sides of hole in the support channel and each end on either side of the notch can be connected to the larger horizontal bracing channel.

The various holes shapes and notches that are shown in the support channels and the horizontal bracing channels can be reversed to achieve different configurations.

Different types of wall forming supports, horizontal bracing channels and the holes within the support channel are shown as a wall structure. Spacer blocks are used between the wall structure interlocking the spacer blocks together. The tongue space and groove space within the spacer blocks interlock the spacer blocks together, along with the foam spacers projections and extensions hold the spacer blocks and support channels together.

The various holes shapes are shown in the support channels and the horizontal bracing channels, holes and trough locations within the spacer block can be reversed to achieve different configurations. The spacer blocks interlock with overlapping flanges at the support channels.

Another structural insulating core wall is when the spacer block does not cover the support channels forming a gap between the spacer blocks for a better thermal break from the support channels.

A DESCRIPTION OF THE PREFERRED EMBODIMENTS in this pending application shows the spacing-bracing members in FIG. 517 through FIG. 611 having different spacing-bracing longitudinal end combinations of many of the eight previous CIP patent applications mentioned in the first paragraph as domestic priority for this patent application. Many different overlapping end configurations are shown between spacing-bracing members and between metal framing supports where the size, shape, orientation and overlapping end configurations will be the same or different size, shape, and overlapping end configurations between the opposing ends of the same spacing-bracing members. The spacing-bracing members are shown overlapping in a checker board pattern using the same interior or exterior configuration. Other spacing-bracing member configurations are shown having the Domino Effect or chain reaction being the cumulative effect produced when one event sets off a chain of similar events. The spacing-bracing members have the mechanical effect as one spacing-bracing member overlaps another adjacent spacing-bracing member having an inside/outside connection where the end configuration is on the inside of an above spacing-bracing member at one metal framing support, while the opposing end is connected over the overlapping lower spacing-bracing member in the same hole of another adjacent metal framing support. Brackets configurations are shown to be interchangeable with spacing-bracing members.

FIG. 518 shows V channel 157 having equal length angled legs used as horizontal bracing members between metal framing supports all having the same dimensions and stacked above each other by overlapping one another with the angled legs intersecting the hole side edges 36se of the hole 36 with V-leg notches 126vg indented at the angled legs. FIG. 517 shows the reverse lip spacer braces 301 overlapping and stacked above other reverse lip spacer braces 301. When overlapping another reverse lip spacer brace 301 the reverse lip spacer brace at the top of the stack have a wider width web 301a in order to fit around another reverse lip spacer brace 301 stacked below with the flanges 301b being the same length and shown at a slight angle for a faster assembly. The lips 301c extending from the bottom edge of the flanges 301b extend outward away from the web 301a having lip notches 126p. In order to maintain an equal width between the lip 301c the heel 126hel of the lip notch 126p shown in FIG. 80 is also referred to as the back edge of the notch 126 as many notches 126 are described through the various applications. The width of the lip 301c will vary to correspond to the hole 36 width and he distance between the side edges 36se at the hole 36 of the metal framing support also referred to as a C channel.

FIG. 519-604 shows many variations of metal framing elevations using different spacer brace configurations with lips having notches as shown in a corresponding sectional view of the overlapping spacer braces connected to support members by lip notches 301c while overlapping and stacked above each other.

FIG. 519-521 shows an elevation, enlargement and section of metal framing connected by reverse lip spacer braces 301 having two different widths at the web 301a for the larger reverse lip spacer brace 301 stacked above a narrower reverse lip spacer brace 301 having a narrower width web 301a. As explained in FIG. 517 when the reverse lip spacer braces 301 have flanges 301b extending downward the web 301a, the larger width web 301a extends over the lower oriented reverse lip spacer brace 301. The flanges 301b will remained the same width, however the lip 301c at the lower reverse lip spacer brace 301 will have a wider width lip 301c so the lip notches 126p at both the upper and lower spacer braces 301 will have the back edge 301bep be aligned with the hole side edges 36se. The elevation shown in FIG. 519 shows the upper reverse lip spacer brace 301 shown as a reverse lip bracket 312 which is the same as a spacer brace 301 except being shorter in length as shown in FIGS. 508 & 509 as well as in FIG. 605 where the reverse lip spacer brackets 312 or reverse lip spacer braces 301 span between metal framing supports or reverse lip spacer braces 301 in FIG. 361 & FIGS. 443-446. The elevation shows the reverse lip spacer bracket 312 having both longitudinal ends overlapping and fitting above a smaller width web 301a of the adjacent reverse lip spacer brace 301, however the reverse lip bracket 312 can also be used independently as shown in FIG. 605. The overlapping of the spacing-bracing members form a checker board pattern where both longitudinal ends have smaller widths installed between alternating metal framing support with the larger width end configurations overlapping the alternating locations of the smaller spacing-bracing members. The cross section at the hole 36 in FIG. 521 shows a hole protrusion 36p (shown in ghost) extending away from the hole side edges 36se above the reverse lip spacer brace 301 leaving a hole protrusion notch 126hp formed by the hole bottom edge 36be, hole side edge 36se and the bottom edge of the hole protrusion 36p and also shown in FIG. 597 & FIG. 598.

FIG. 522-524 shows the elevation, enlargement and section of metal framing is similar to FIGS. 519-521 except the reverse lip spacer braces have the web 301a resting at the hole bottom edges 36be with the flanges 301g extending upward from the web 301a with the lips 301c with the lip notches 126p extending around the hole side edges 36se. Since the overlapping reverse lip spacer braces 301 are reverse the narrower width web 301a from the upper reverse lip spacer brace 301 is fitting between the flanges 301b of the lower reverse lip spacer braces 301 with the lips 301c being wider at the upper reverse lip spacer brace 301 having the back edges 301bep being aligned with the lower reverse lip spacer brace 301. When adjacent metal framing supports are closer together, the reverse lip spacer braces 301 are referred to as reverse lip brackets 312. The upper or lower reverse lip spacer braces 301 as mentioned above can be referred to as reverse lip spacer brackets 312. The middle spacer brace 301 is spanning over both longitudinal ends of both adjacent spacer braces 301.

FIGS. 525-527 shows the enlargement and section of FIGS. 523 & 524 to be similar to FIGS. 526 & 527 except one end of the reverse lip spacer brace 301 shows the web 301a having a wider width web 301a resting on the hole bottom edge 36be with the opposing end of the reverse lip spacer brace 301 having a narrower width web 301a so the narrower width web 301a can overlap the adjacent reverse lip spacer brace 301 having a wider width web 301a so the narrower width web 301a can overlap and fit between the flanges 301b of the lower reverse lip spacer brace 301 allowing the upper width web 301a to overlap into the wider width web 301. The over/under pattern of installing spacing-bracing members is similar to a row of spaced i dominoes where when one domino falls, the top end of the domino lands over the bottom end of the adjacent domino. The over/under pattern has the first longitudinal end of a first spacing-bracing member installed in the opening of the metal framing support as the lower (domino) spacing-bracing member while the opposing end overlaps an adjacent second spacing-bracing member having been previously installed in another metal framing support allowing the second end of the first spacing-bracing member to be installed over the second spacing-bracing members. Other FIG's will be showing the spacing-bracing members inverted and where the second end of the first spacing-bracing member has a wider or narrow profile depending on the orientation of the spacing-bracing member.

FIGS. 528-539 show the same width web 301a and lips 301c at the overlapping reverse lip spacer braces 301 with the FIGS. 528-533 having the web 301a resting on the hole bottom edge 36be while FIGS. 534-539 have the lips 301c extending downward toward the hole bottom edge 36be. In the sections in FIG. 530 & FIG. 536 both sections show the lip notch 126p extending from the longitudinal edges of the lip 301 having the side edges of the lip notches 126p engage both hole side edges 36se and the sloped flanges of the upper reverse lip spacer braces 301 will engage the lower sloped flange of the lower reverse lip spacer braces 301 whether having the flanges 301b extending upward or downward from the web 301a. The sloped flanges of a furring channel or the sloped flanges of the reverse lip spacer braces 301b will both bind against the sloped flanges 301b of the overlapping reverse lip spacer bracer 301 of each other. The thickness or gauge of the metal of the reverse lip spacer braces 301 can vary, so the thinner the metal framing, the more easily the metal will bend and therefore allow the flanges 301b to fit tighter together. In fact, when the sloped flanges 301b fit too tight, a person will need a screw driver, pliers to disengage the flanges 301b apart. In reverse a hammer can be used to force thinner metal together and then apply a screw to fasten non-fitting sections together. FIGS. 533 & 539 show the notches to be lip-flange notches 126pf. When the lip extends over the hole bottom edge 36be as shown in FIG. 536 the flanges 301b still bind together were the flanges 301b converge together to bind between the upper and lower flanges 301b.

FIGS. 540-545 & FIGS. 549-560 all show the various reverse lip spacer braces 301 having the flanges 301b extending upward or downward from their webs 301a as previously described. The lips 301c have the lip notches 126 extend on both sides of the hole side edges 36se near the longitudinal end of the longitudinal reverse lip spacer brace 301 while the opposing end of the reverse lip spacer brace 301 having a hook tongue 128 extends from the longitudinal end of the web 301a with a tongue 128t that extends upward or downward from the extension 301e. The hook tongue 128 overlaps the web 301a of an adjacent reverse lip spacer brace 301 where the extension 301e overlaps the web 301a from the outside surface of the web 301a or the interior surface of the web 301a between the inner surface of the flanges 301b that will vary depending on the orientation of the flanges 301b. The opposing end of the web 301a has a receiving hole 36r for the tongue 128t to fit into. The tongue 128t can have a notch 126 at the sides of the tongue 128t to engage the receiver hole 129h along with the tongue 128t being long enough to withstand any force pressure from exiting the receiver hole 129h. In FIG. 554 the extension 301e is longer in length with the extension 301e oriented vertically as there is a gap between lips 130c of the overlapping reverse lip spacer braces 301 with both overlapping reverse lip spacer braces 301 engaged in the hole side edges of the metal framing support. In FIG. 556 the extension 301e is also longer however the extension is oriented horizontally between adjacent reverse lip spacer braces 301 having a gap between the web 301a, flanges 301 and lips 301c of the adjacent reverse lip spacer brace 301 in order for the hook tongue 128 can have the tongue 128t rotate within the receiver hole 129h in the web 301a of the adjacent reverse lip spacer brace 301 therefore allowing the adjacent reverse lip spacer brace 301 or U shape spacer brace to rotate horizontally as shown in FIG. 558 & FIGS. 361-384.

FIG. 546-548 shows an elevation, enlargement and section of metal framing with the webs 301a of the overlapping reverse lip spacer braces 301 having different web 301a widths and where the web 42a of the support member has the hole bottom edge 36be extend through receiver holes 129h in the webs 301a of the upper and lower reverse lip spacer braces 301 having the hole bottom edge 36be extend through the web receiver holes 129rh connecting both reverse lip spacer braces 301. The hole bottom edge 36be has a similar shape as the hooked tongue 128 having an extension 128e with a notch 126 at the sides of the tongue 128t to engage the receiver hole 129h along with the tongue 128t being long enough to withstand any force pressure from exiting the receiver hole 129h. FIG. 548 also shows the a web-flange notch 126wf where the web 301a has a continuous notch that extends into the flanges 301b allowing the hole bottom edge 36be to extend into the web 301a with the web flange notches 126wf having the notch ends rest at the hole bottom edge 36be and still have the lip notches 126p extend around the hole side edges 36se for extra strength.

FIGS. 558-560 shows an elevation, enlargement and section of metal framing where two reverse lip spacer braces 301 having different width ends overlap each other and where each longitudinal end has a receiver hole 129h in the web 301a where a hook tongue 128 overlaps the adjacent reverse lip spacer brace 301 with the tongue 128t engaging the receiver hole 129h of the adjacent reverse lip spacer brace 301 having the tongue 128t extending upward or downward engaging both ends of the overlapping reverse lip spacer braces 301 and with both lips notches 126p engaging around the hole side edges 36se at the metal framing supports. The receiver holes 129h can have ledges 79 extending around the perimeter and the tongue 128t of the hook tongue 128 can have many configurations as shown in FIGS. 153, 221, 223-224, 242, 279, 284-291, 340-341, 350, 383-384, 406, 540-545 & 587-589. Additional hole notches 126h & hole protrusions 36p both not shown in these FIG's but shown in FIGS. 564-566,570-572 & 596-604.

FIGS. 561-563 shows an elevation, enlargement and section of metal framing where the reverse lip spacer braces 301 are oriented downward with the flanges 301b extending toward the hole bottom edge 36be with one end of the lower reverse lip spacer brace 301 having the lips 301c resting on the hole bottom edge 36be with the lip notches 126p extending against the hole side edges 36se and where the web 301a having a hook tongue 128 with the tongue 128t end extending upward into the receiver hole 129h in the web 301a of the upper reverse lip spacer brace 301. The upper reverse lip spacer brace 301 with the receiver hole 129h in the web 301a also has the web 301a with the web 301 having an extension notch 126e with a notched tab 126nt ending with the extension notches 126e extending horizontally along the plane of the web 301a with the extension notches 126e extending around the hole side edges 30se plus the reverse lip spacer braces 301 are located under the protrusion 36p against the web 301a of the reverse lip spacer braces 301 and against the hole bottom edge 36be encasing the reverse lip spacer braces 301 forming a hole protrusion notches 126hp for any shape spacer brace to fit into.

FIGS. 564-566 shows an elevation, enlargement and section of metal framing where the reverse lip spacer braces 301 are oriented upward opposite to FIGS. 561-563 where the lower reverse lip spacer brace 301 has the web 301 supported at the hole bottom edge 36be, however the hole bottom edge 36be is support the extension 301 from the web 301a and another option is shown with the longitudinal end of the extension 301 having a hook tongue 129 with the tongue 129t extending into a receiver hole 129h where the tongue 128t fits into and the notched tab 126nt at the extension 301e has the web notches 126w extend around the hole side edges 36se. The upper reverse lip spacer brace 301 is narrower in width having the web 301a and the flanges 301b fit into the lower reverse lip spacer brace 301 with the web 301a having the receiver hole 129h for the tongue 128t to fit into and long enough for the tongue 128t to be bent or formed to have a notch 126 at the tongue 128 to form a secure connection from vertical movement. The lip notch 126p of the lips 301c at the upper reverse lip spacer brace 301 is also engaged at the hole side edges 36se.

FIGS. 567-569 shows an elevation, enlargement and section of metal framing where the flanges 301b extend downward from the web 302a with the lips 301c extending around the hole side edges 36se. The lower reverse lip spacer brace 301 has the an extension 301e with a hook tongue 128 having the tongue 128t extending upward through the receiver hole 129h located in the extension 301e of the upper reverse lip spacer brace 301. The web 301a and flange 301b at the upper reverse lip spacer brace 301 can be wider in width than the lower reverse lip spacer brace 301 to encase the lower reverse lip spacer brace 301 or the flanges 301b and lips 301c can be removed allowing the upper reverse lip spacer brace 301 to pivot at the tongue 128t or where a crossing reverse lip spacer brace 301 can also be attached to the same tongue 128t allowing two additional reverse lip spacer braces 301 attached to the same tongue 128t. The reverse lip spacer braces 301 are shown stacked above each other therefore both longitudinal ends have the same width rather than having a larger width end a smaller width end at the same reverse lip spacer brace 301. The middle reverse lip spacer brace 301 is shown having the larger width web 301a at both longitudinal ends with receiver holes 129h for the hook tongue 128 can have the tongue 128t pass thru the receiver hole 129h also allowing both longitudinal ends to pivot in the same manner at both ends.

FIGS. 570-572 shows an elevation, enlargement and section of metal framing similar to FIGS. 567-569 except U shaped spacer braces 302 are used with the web 302a having bent flanges 302ba & 302bb similar to FIG. 386 however in FIG. 386 the bend between the web 302a and the first flange 302fa has flange bulges 302g located between the hole bottom edge 36be and the hole side edge 36se and large enough for the flange bulges 302g to fit into (only one side showing the flange bulges 302g) the hole notches 126h. The bent flanges and flange bulges form an undulating configuration where the configuration could be curvilinear in shape rather than described as individual sections. The U shaped spacer braces 302 in FIGS. 570-572 are reversed that is the web 302a has the flanges extending downward toward the hole bottom edge 36be with the first flange 302ba bent at an acute angle to the web 302a with the second flange 302bb bent at an obtuse angle to the first flange 302ba. The hole notch 126h at the web 302a and the first flange 302ba should be large enough to accommodate the acute angle bend. The lower U shaped spacer brace 302 has a narrower web 302a with shorter first flanges 302ba so as to fit under the larger U shaped spacer brace 302 above that is the U shaped spacer braces 302 can have one longitudinal end be larger with the opposing end being narrower in width. On the other hand a larger width reverse lip spacer brace 301 can fit over narrower width reverse lip spacer braces 301 shown similarly in FIGS. 519-521. FIG. 572 shows the hole bottom edge 36be extending upward from the web 42a of the metal framing supports forming an extension of the hole bottom edge 36be being a notched tab 126nt that extends between the first flange 302ba and the second flange 302bb at both sides of the U shaped spacer brace 302 allowing the head or tongue 126t extend around the second flange 302bb so the tongue 126t has a greater width than the distance between the second flanges 302bb. The variation in distance will resist any upward force between the tongue 128t of the hook tongue 128 and the interior surfaces of the second flanges 302bb. The U shaped spacer braces 302 are overlapped at the hole 36 and both the upper and lower U shaped spacer braces have their lip notches engage the hole bottom edges. Another overlapping solution is when the upper spacing-bracing member having the larger width longitudinal end overlaps the longitudinal end of the narrower width U shaped spacer brace 302 the flanges 302bb and the flange notches 126f can be eliminated as the hook tongue 128 with the tongue 126t end from one spacing-bracing member overlaps and extends into the receiver hole 129h of the adjacent spacing-bracing member. The acute angle produced by intersecting the web 302a and flange 302ba of the wider U shaped spacer brace 302 overlapping and fitting over the smaller acute angle of the narrower width U shaped spacer brace 302 will also eliminate any vertical movement between the spacing-bracing members.

FIGS. 573-575 shows an elevation, enlargement and section of metal framing where reverse lip spacer braces 301 are installed in a U shaped channel 41 that is mounted to the floor 401 rather than having the web 301a installed at the hole bottom edge 36be between metal framing support as shown in FIGS. 564-566. In FIGS. 573-575 the web 301a of the first reverse lip spacer brace 301 is installed against the web 41a of the metal framing support with the lip notches 126p of the reverse lip spacer brace 301 being aligned to the desired spacing of the metal framing supports. The web extension 301e with the hook tongue 128 has the tongue 128t extending upward and installed into the receiver hole 129h of the adjoining second reverse lip spacer brace 301 with the lip notches 126p being aligned to the first reverse lip spacer brace 301. The web 301a of the second reverse lip spacer brace 301 has a narrower width and the first reverse lip spacer brace 301. The first and second reverse lip spacer braces 301 have the lip notches 126p aligned so the longitudinal end of the web 42a of the metal framing support can fit into the lip notches 126p of both the upper and lower reverse lip spacer braces 301. The second reverse lip spacer brace has lip flange notches 126pf so the lip 301c and flanges 301b can extend around the web 42a of the metal framing support. After the first and second reverse lip spacer braces 301 are connected together at the web 42a at the longitudinal end of the metal framing support where the reverse lip spacer brace 301 has the flanges 301b and lip 301c extend into the flange gap notch 126fg with the lip notches 126p engaging into the web notches 126w of the metal framing support. The flange gap notch 126fg in the metal framing support is wide enough so the flanges 301b can bend slightly allowing the flange 301b and lip 301c to extend into the flange gap notch 126fg and allowing the lip notch 126p to engage into the web notch 126w. When two adjacent reverse lip spacer braces 301 overlap at the same flange gap notch 126fg the first reverse lip spacer brace 301 is installed into that flange gap notch 126fg with the lip notches 36p installed into the web notch 126w with the heel of the lip notch 126p fitting tight against the heel 126hel of web notch 126w. The thinner the gauge of the reverse lip spacer brace 302 the more the flanges 301b will bend when installing and removing the flanges 301 from the gap 45 and the web notches 126w. In addition, the thicker the gauge the more difficult it becomes when installing in the gaps. In fact, the easiest method to removing the reverse lip spacer braces at the floor or within the hole 36 in the web 42a of the metal framing support is to apply pressure to the flanges 301b allowing the lip notches 126p to disengage from the web side edges at the holes 36 or within the web gaps. Also see FIGS. 338-343, FIGS. 346 & 348-349 & FIG. 400.

FIGS. 576-578 shows an elevation, enlargement and section of metal framing that is similar to FIGS. 564-566 and FIGS. 573-575 except the hook tongue 128 with the extension 301e and tongue 128t connects to the upper reverse lip spacer brace 301 not at the metal framing support but anyway in between metal framing supports. The lower reverse lip spacer brace 301 has the hook receiver 128 having the extension 301e extend from the web 301a so the tongue 128t can extend up through the hole receiver 129h in the web 301a of an overlapping reverse lip spacer brace 301. The overlapping connection can connect any shaped two adjacent spacer braces. In fact, the hook tongue 128 of one spacer brace connecting into receiving holes 129h of an adjacent spacer brace are used to connect adjacent framing member together whether the adjacent framing member are intersecting longitudinally end to end, perpendicular with the longitudinal end intersecting a mid-point between the longitudinal ends or having the hooked tongue 128 being a pivot point within the receiver hole 129h. The connection in these FIG's are shown having a U channel base 41, however the connection is used in many other metal framing connections.

579-580 shows an elevation, enlargement and section of metal framing shows the same framing connection in FIGS. 573-575 however the U channel base 41 is located at the ceiling rather than the floor 401 and the configuration is reversed. When the reverse lip spacer brace 301 is installed face down with the flanges 301b extending downward from the web 301a similar to FIG. 521 except the web 301b with the lips 301c and lip notches 126p extend into the web notch 126fg and the lip notches 126p extend into the web notch 126w and the U channel base 41 is installed after the reverse lip spacer brace 301 installed into the longitudinal ends of the metal framing supports. The connection in FIGS. 579-580 is much easier and faster than when the same connection is made at the floor 401. The hooked tongue 128 with the receiver holes 129h can be used in the same manner as described previously in FIGS. 576-578.

FIGS. 581-583 shows an elevation, enlargement and section of metal framing shows the same framing connection as FIGS. 522-524 or FIGS. 519-521 however the reverse lip spacer brace 301 has a reverse lip bracket 312 with its flanges 312b fitting over the overlapping lower two reverse lip spacer braces 301 and still having the lip notches 126p of the bracket 312 engaging the metal framing support at the hole side edges 36se. The same reverse lip bracket 312 can be used and adjusted to fit the profile of other spacer braces allow the lip notches 126p engage the hole side edges 36se between metal framing supports. The width of the reverse lip spacer braces 301 and the width of the bracket 312 will vary depending on the width of the hole 36. For example in FIG. 513-515 the bufferfly bracket 208 later referred to as a reverse lip spacer brace 301 has the web 208a, flange 208b and lip 208c elements of the butterfly bracket all notched 126 so the notched elements will fit into the hole notch 126h in the metal framing support. The butterfly bracket 208 like the reverse lip bracket 312 can have a longitudinal length where the notches fit into an array of metal framing supports or connected similar to FIG. 610 and can be overlapped with adjacent reverse lip spacer braces 301 as shown in the previous FIG's. The reverse lip bracket 312 can be similar in size as shown in the reverse lip spacer braces 301 in FIG. 605 & FIG. 606 all one has to do to form a compatible spacer brace bracket 312 is use a light gauge metal, a hammer to force the reverse lip bracket 312 to bend around the reverse lip spacer brace 301 below and connect the reverse lip bracket 312 with screws to force the bracket 312 and many other configurations of spacer braces to fit compatibly together.

FIGS. 584-586 shows an elevation, enlargement and section of metal framing having the same framing connection as FIGS. 528-530 and similar to FIGS. 581-583 however the reverse lip spacer brace 301 has the flanges 301b extending upward from the web 301a with another reverse lip spacer brace 301 having a narrow width web 301a, longer extending flanges 301b and wider width lips 301c and lip notches 126p. The reverse lip bracket 312 is shown fitting between the flanges 301b with the lips 312c of the reverse lip bracket 312 extending over the lips 301c of the second reverse lip spacer brace 301 so the lip notches 126p of the bracket 312 engaging the hole side edges 36se of the metal framing support. Various shapes of the reverse lip spacer braces 301 are shown throughout this application and any of the other shapes can be used to form an alternate configuration of the reverse lip bracket having the lip notches engaging metal framing support members.

FIGS. 587-589 shows an elevation, enlargement and section of metal framing having a similar framing connection as FIGS. 564-568 however the lower reverse lip spacer brace 301 has an extension 301e from the web 301a with the tongue 126t extending upward from the floor 401 with the upper reverse lip spacer brace 301 having a receiver hole 129h with a ledge 79 that extends upward from the ledge 79 away from the web 301a for the tongue 126t extending from the extension 301e to pass through the receiver hole 129h and wrap around the ledge 79, in addition the upper reverse lip spacer brace 301 with its lip notches 126p extends into the web notches 126w in the metal framing support leaving the lower reverse lip spacer braces 301 to rotate horizontally at the tongue 128t within the hole receiver 129h. In FIGS. 408 & 409 ledges 79 extend outward from a receiving hole 129h and the tongue 128t of the hook tongue 128 is bent allowing the bent side to wrap around the ledge 79. In FIG. 609 shows an enlargement of a curvilinear shaped receiver hole 129h being a curved J-shaped ledge 79 with the J-shaped curve facing away from the receiver hole 129h with a tongue 128t extending upward into the receiver hole 129h with the tongue 129t end having a reverse J-shape so the J-shape will interlock into the J-shape of the ledge 79. The interlocking J-shapes allows the curvilinear shape of the J-shape ends to interlock between each other eliminating any vertical and horizontal movement between reverse lip spacer braces 301 or other shaped spacer bracing using a similar interlocking metal bracing connections. 408,409

FIGS. 590-592 shows an elevation, enlargement and section of metal framing that is similar framing connection as FIGS. 587-589 however the lower reverse lip spacer brace 301 has a shorten extension 301e and the flanges 301b and lips 301c abut one side of the web 42a of the metal framing support and the tongue 128t extends past the metal framing support with the tongue 128t extending upward into the receiving hole 129h of the adjacent reverse lip spacer brace 301 and the tongue 128t is shown having a bent end so the bent end overhangs the side edges of the receiving hole 129h allowing the bent end to have resistance from being removed from the receiving hole 129h. Since the metal framing supports rest on the web 41a of the U shaped channel 41 the lower reverse lip spacer brace 301 is installed directly onto the U shape channel with the upper reverse lip spacer brace 301 installed over the lower reverse lip spacer brace 301. The upper reverse lip spacer brace 301 has the lip notches 126p engage the side edges of the web 42a and the weight of the metal framing supports and an anchor bolt (not shown) mounted to the floor 401 keep the reverse lip spacer braces 301 and the metal support members from vertical movement. When the anchor bolt 354 shown in FIGS. 140 & 143 is installed into the reverse lip spacer brace 301 and then through the U shaped channel 41 secured to the floor 401 the combined structural capacity of the U shaped channel 41 having fastener into the support member and the lip notches 126p of the reverse lip spacer brace 301 engaging the web notches 126 of the support member creates a very strong connection. The bracing hole 36b in FIG. 334 or the flange gaps 126fg in FIGS. 573-580 allow access for the lip 301c to engage the web 42a of the support member or the hole perimeter 36p of a hole 36. The receiver hole 129h and the tongue 128t can be added to the reverse lip spacer brace 301 or the U shaped channel 41 to secure the longitudinal ends of the connector to an adjoining connector.

FIGS. 593-598 shows elevations, enlargements and sections of metal framing uses a U shape spacer brace 302 having a web 302a with flanges extending from the longitudinal web 302a and with flange gap notches 126fg that extend from the longitudinal open edges toward the web 302a having a T-shape notched gap 126ng extending horizontally from the longitudinal open edges of the flanges. FIGS. 593-595 show the U shape spacer brace 302 having the flanges 302b extending downward to the hole bottom edge 36be in the web 42a of the metal framing support. The hole bottom edge 36be has a ledge 79 extending from the hole bottom edge 36 so the T-shape notched gap 126ng can extend into the ledge 79 where the metal framing support has the ledge 79 facing either left or right giving the U shaped spacer brace 302 more flexibility during the installation. One end of the U shaped spacer brace 302 would have a larger width or narrow web 302a allowing for the U shaped spacer brace 302 to overlap the adjacent U shape spacer brace 302. FIG. 596 & FIG. 598 are similar however the flanges 302b are angular allowing for a possible faster assembly. FIG. 598 shows protrusions 36p extending from the hole side edges 36se forming a protusion hole notch 36ph where the hole bottom edge 36be, hole side edge 36se and the bottom edge of the hole protrusion 36p to keep the U shaped spacer brace from moving within the hole 36. As mentioned previously when overlapping the longitudinal ends, one longitudinal end will have a wider width to overlap the adjacent U shaped spacer brace 302. In addition, the wider width longitudinal end will have a web flange notch 126wf so the hole protrusion will fit tight against the smaller U shaped spacer brace 302 as well as the larger U shaped spacer brace 302. FIG. 597 has the same U shaped spacer brace 302 profile the U shaped spacer brace 302 has the web 302a resting on the hole bottom edge 36be. The bottom edge of the protrusion 36p is shown have a ledge 79, however that is not required to secure the metal framing support to the U shaped spacer brace 302. The protrusions 36p extend into the flange notches 126f at the flanges 302b. As shown in other overlapping solutions a smaller U shaped spacer brace 302 will fit into and between the flanges 302b of the larger U shaped spacer brace 302.

FIGS. 599-601 shows an elevation, enlargement and section of metal framing having a W-shape spacer brace 318 which is a combination of FIG. 597 & FIG. 598 where the end of the flanges 318bb have a flange notch 126f and where the flange notches 126f extend into the bottom edge of the ledges 79 extending from the hole side edges 36se. The W-shape spacer brace 318 has a web 318a with the first flange 318b extending downward away from the web 318a, then having the flange turn substantially parallel to the web 318 toward the hole side edges 36se with the last bend of the first flange 318b extending upward with the flange notch a 126f having the open end engage the bottom edge of the protrusion 36p. A smaller width longitudinal end profile as required as explained above when adjacent W-shaped spacer braces 318 overlap each other. This configuration eliminates horizontal and vertical movement between the W-shaped spacer braces 318, however an extension 318e with a hook tongue 128 having a tongue 128t extend into a hole receiver 129h of the adjacent W-shape spacer brace 318 will also increase the connection strength between the two members. The W shape spacer brace 318 is described as having seven (7) multiple planes, but could also be described as an curvilinear or undulating contour having a W-shaped configuration. In FIGS. 205-210 the W-shaped clip 307 was also referred to as a curvilinear shape where the W-shaped clip 307 fit into the hole 36 of the support member. Due to the undulating shape of the W-shaped spacer brace 318 the configuration of the overlapping W-shape spacer brace 318 will vary in width in order to have a snug fit when overlapping each other.

FIGS. 602-604 shows an elevation, enlargement and section of metal framing is a combination of several spacer braces as the shape is similar to a reverse lip spacer brace 301 having bent flanges with the first flange 301ba extends downward toward the hole bottom edge 36be having an acute angle to the web 301a. The web/flange acute angle connect has the acute angle penetrating the hole side edges forming a hole notch 126h. The first flange 301ba is further extended having an obtuse angle between the first flange 301ba and the second flange 301bb with lips extending outward toward the hole side edges 36se with lip notches 126p extending inward at the longitudinal side edges of the lips 301a. Two adjacent reverse lip spacer braces 301 are shown overlapping each other at their longitudinal ends and where a smaller narrower reverse lip spacer brace 301 is installed into the hole 36 first with the lips 301c having lip notches 126p engaging the hole notches 126h at the hole bottom edge 36be allowing the lip notches 126p to be supported vertically at the top edge of the hole notches. A larger reverse lip spacer brace 301 is installed over the lower reverse lip spacer brace 301 where the acute angle connection described above occurs connecting the larger reverse lip spacer brace 301 to the hole notch 126h. On the other hand in FIG. 597, when the U shape is facing upward, the larger U shaped spacer brace 302 in installed first and the smaller (narrow web 302a) U shaped spacer brace 302 is installed into the larger U shaped spacer brace 302. The hole side edges 36se and the hole bottom edge 36be have another hole notch 126p for the lip notches 126p to extend into while the upper reverse lip spacer brace uses only the lip notches 126p to engage the hole side edges 36se. In addition the lower reverse lip spacer brace 301 has an extension 301e at the web 301a with an upward extending tongue 126t to engage the opposing end of the adjacent spacer brace having a hole receiver 129h in the web 301a for the tongue 128t to fit into. An alternative spacing-bracing member connection to the metal framing support is to have the hole bottom edge 36be with a ledge shaft 79s having a notched tab configuration 126nt (shown dashed lines) at the head extending into the longitudinal concave shape of the larger reverse lip spacer brace 301, so the larger side edge profile of the spacing-bracing members extend into the continuous notched tab notch 126cnt forming a concave relationship where the web 301a is in relationship to the top edge of the head of the notch tab 126nt, then having the flanges 301ba bent inwardly in an acute angle to the web 301a then the flanges 301bb are bent away from the flange 301ba forming an obtuse angle or a notch having an equivalent shape of the notched-tab notch 126ntn with the hole bottom edge 36be extending becoming the part the notched tab 126nt at the hole 36. The reverse lip spacer brace 301 having a notched tab profile as just explained is similar to the continuous notched tab profile as previously shown in FIGS. 386, 390, 400 & 572. The unusual shape configuration could be curvilinear or have an undulating configuration.

FIG. 606 shows two adjacent reverse lip spacer braces 301 having sloped flanges 301b being of equal width and overlapping at the hole 36 of a metal framing support. When this occurs the friction of the sloped flanges 301b of the upper reverse lip spacer brace 301 binds the slopped flanges 301b of the lower reverse lip spacer brace 301 together than the upper reverse lip spacer brace 301 cannot fit tight against the lips 301c leaving a gap between the webs 301a and lips 301c of both reverse lip spacer braces 301. On the other hand in FIG. 605 a light gauge material is used to form the reverse lip spacer braces 301 and when a force like a hammer is applied to the web 301a′ of the upper reverse lip spacer brace 301 the flanges 301b′ will bend outward as well as the lips 301c′ requiring that the upper reverse lip spacer brace have deeper notches or lip flange notches 126fp that extend into the flanges 301b′ in order to secure the upper reverse lip spacer brace 301′ to the hole side edges 36se.

FIG. 607 and FIG. 608 show a U shaped spacer brace 302 inserted into a triangular shape hole 36t in a metal framing support where the U shaped spacer brace 302 has a web 302a with a long width flange 302b2 and a short width flange 302b1 where the flanges extend downward to the hole bottom edge 36be and where the hole bottom edge 36be have ledges 79 extending typically at an angle to the plane of the web 42a of the metal framing support. The hole bottom edges 36be are shown at an angle with the flanges 301b1 & 301b2 having flange gaps 126fg with flange notch gaps 126ng at the blunt end for the ledge 79 to extend into the flange notch gaps 126ng and for the flange gaps 126fg to engage the ledge 79 as shown similarly to in FIG. 575 and others when the lip notch 126p is connecting to the web notch 126w.

FIG. 610 shows smaller reverse lip spacer braces 301 or also referred to as reverse lip brackets 312 are used to connect metal framing supports together. The reverse lip brackets 312 can be overlapped and connected at the lips 302c with lip notches 126p as previously shown in other FIG's. In FIG. 509 the reverse lip brackets 312 have been used to reinforce the U shaped bracing channel 155 connection between two metal framing supports. When the reverse lip brackets 312 are longer in length, the reverse lip spacer brackets 312 are referred to as reverse lip spacer braces 301.

FIG. 611 shows a reverse lip bracket 312 inserted into a U shaped bracing channel 155 shows the reverse lip bracket 312 with its lip notches 126p engage the hole side edges 36se and a punch out tab 326 in the web 312a with a notched tab tongue 126nt is shown engaging a slot hole 36s in the U shaped bracing channel 155 interlocking the reverse lip bracket 312 to the metal framing support.

It is understood that the invention is not to be limited to the exact details of operation or structures shown and describing in the specification and drawings, since obvious modifications and equivalents will be readily apparent to those skilled in the art. The flexibility of the described invention is very versatile and can be used in many different types of building applications.

The Glossary Terms listed below are a combination of the many terms used throughout the various patent applications. Sometimes the term early during some of the earlier applications might be very general while later applications are more specific in location or detail regarding a specific term.

### FIGURE NUMBER GLOSSARY OF TABLE OF CONTENTS ALL PENDING APPLICATIONS

36 hole: 36be—hole bottom edge, 36se—hole side edge, 36te—hole top edge, 36r—hole rim, 36s—slot hole, 36tr—triangular shaped hole, 36k—key hole, 36ws—web slot holes, 36bf—bent flange edge, 36b—bracing hole, 36kt—key tab, 36fs—flange slot holes, 36p—hole protrusion, 36pt—hole protrusion tab, 36pts—hole protrusion shaft, 36bt—bracket-tab hole, 36ht—hole tab, 36htp—hole tab pivot edge, 36htv—hole tab vented edge, 36bn—hole notched tab, 36th—tab holes, 36sf—spacer brace slot hole, 36rs—raised slot hole, 36a—web hole, 36t—tooth hole, 36v—V-shaped hole 36pfs—profile slot hole
36r rim
39′ concrete floor
41 U shape channel: 41a—web, 41b—flange
42 C channel 42a—web, 42b—flange, 42c—lip, 42at—web tab. 42ai—web indentation, 42s—web shaft, 42nte—notched-tab extension, 42nti—notched-tab indentation
42x metal stud X direction
42y metal stud Y direction
45 gap: 45j—J-shaped gap, 45e—L-shaped gap, 45w—web gap, 45s—slide gap, 45jt—J-shaped gap tab, 45fg—flange gap
55 spacer block: 55a—tongue side, 55b—groove side, 55p—projection, 55i—indentation, 55s—knife cut
68 wood framing member
68d depth
68w width
68x Wood stud X direction
68y Wood stud Y direction
70 punched hole teeth: 70t—teeth, 70h—punched hole
74 jagged edges
76 flap: 76f—flange flap, 76s—support flap, 76b—bent flap
79 ledge: 79a—ledge space, 79i—ledge indentation, 79t ledge tab, 79s—ledge shaft, 79cp ledge cap, 79cr cap rim, 79bg—bent ledge, 79th—ledge teeth
98 bent angle: 98e—extension
111 structural insulated core
120 knife slots
121 groove
122 fasteners
125 dimples
126 notches: 126n—½ notch (bracket) 126f—flare edge, 126ng—notch gap, 126c—clip notch, 126r—receiver notch, 126h—hole notches, 126rm—rim notch, 126p—lip notch, 126w—web notch, 126g—bulge notch, 126wg—web-bulge notch, 126fw—flared-web notch, 126wh—web-hole notch, 126sg—slot bulge notch, 126—shaft notch, 126pn—protrusion notch, 126e—extension notch, 126bf—butterfly flanged notch, 126bk—bracket-flange notch, 126tn—tab notch (same as shaft w/an indentation), 126nt2—½ notched-tab, 126se—sloped edge notch, 126gtn—grooved notched-tab, 126ce—extended lip notch, 126nt—notched-tab, 126ntn—notched-tab notch, 126hp—hole lip notch, 126fg—flange notch, 125s—slide notch, 126c—clip notch. 126eg—leg notch, 126fw—flange-web notch, 126se—sloped edges notches, 126ng—notch gap (sb3c), 126vf—vertical—flange notch (sb3c), 126tnt—twisted notch tab, 126pf—lip-flange notch, 126gf—flange-bulge notch, 126hp—hole protrusion notch, 126cnt—continuous notched tab notch
127 hook finger: 127a—first side, 127b—second side, 127c—third side, 127f—flare, 127e—abrasive edge, 127k—kurl, 127nt—notched hooked finger tab
128 hook tongue: 128a—first side, 128b—second side, 128w wide hook tongue, 128f—flare, 128tf—tongue flap, 128tt—tongue tab, 128s—tongue shaft, 128i—tongue indentation.
129 hook receiver: 129a—first leg, 129b—second leg, 129c—third leg, 129d—slanted leg, 129e—extension side, 129s—end stop, 129f—flare, 129k—kink, 129eg—elongated, 129rb—receiver elbow, 129ra—receiver arm, 129rx—receiver extension X, 129ry—receiver extension Y, 129sh—receiver slot hole, re-wide hook receiver, 129fr—flange receiver, 129wr—web hook receiver, 129t—hook receiver tab, 129pnr—lip notched-receiver, 129nrm—notched receiver arm, 129rx—receiver extension, 129pp—double lip notched—receiver clip, 129rh—receiver round hole
131 punched out hooks: 131ve—vented edge, 131pe—pivot edge, 131h—hook, 131se—side edge,
155 U shaped channel: 155a—web, 155b—flange
156 reverse lip channel; 156a, 156b—flange, 156c—lip, 156r—ribs
159 blunt end-not used in this submission
201 flat plate
203 L-shaped bracket 203a horizontal leg, 203b vertical leg
205 C shaped bracket 205a, web, 205bf—flared flange
207 L-shaped butterfly bracket 207a—horizontal leg
208 reverse lip bracket 208a—web, 208b—flange, 208c—lip, 208ct—tapered lip, 208bt—tapered flange,
251 tab forming cut
298 Single flange spacer brace: 298a—web, 298sf—short leg flange, 298b—multi-leg flange, lip—298c, 298che— horizontal lip edge, 298cve—vertical lip edge.
299 V-shaped spacer brace, 299a—angular leg
301 reverse lip spacer brace: 301a—web, 301b—flange, 301c—lip, 301p—punchout hole, 301b— bulge, 301he—hole extension, 301i—indentation, 301fe—flange extension, 302he—hole extension, 301cc—double lip, 301bx—flange x-plane, 301by—flange y-plane, 301bf—flange fold, (the continuous band is the combination of the flange & the x&y planes), 301ce—cut edge, 301fc—flexible lip, 301ap—angled lip,
302 U shaped spacer brace: 302a web, 302b flange, 302c lip, 302bb—double flange, 302sb—sharp budge, 302fc—flared lip, 302we—web extension, 302fe—flange extensions, 302he—hole extension, 302re—receiver extension, 302e—extension (general),302nte—notched-tab extension, 302i—notched-tab indentation, 302i—indentation, 302bg—flange bulge, Change previous sb 2,3,4 for 302r (ribs) to 320—ridges
303 C shaped spacer brace: 303a—web, 303b—flange, 303c—lip, 303g—bulge, 303ar—raised web, 303s—sloped ledge, 303ce—lip extension, 303be—flange extension, 303ar—raised web, 303as—sloped web edge
304 adjustable spacer brace
305 I shaped spacer brace: 305a—web, 305b—flange, 305bb—double flange, 305he—hole extension, 305i—indentation
306 J shaped space brace: 305a—web, 305b—flanges, 305i—indentation, 306he—hole extension
307 W-shaped clip: 307a—web, 307b—flange, 307e—elongated W-shaped clip
308 U-shaped clip: 308a—web, 308b—flange
W309 hold-down spacer brace: 309a—web, 309b—flange, 309e—extension, 309i—indentation, 309we—web extension
310 hold—down bracket: 310a—web, 310b—flange, 310f—end plate, 310i—indentation
311 butterfly bracket; 311a—web, 311b—flange, 311c—lip-similar to #208 reverse lip bracket
312 double reverse clip bracket: 312a—web, 312b—flange, 312c—lip
313 add-on connector: 313a—web, 313b—flange, 313ae—add-on extension, 313we—web extension, 313i—indentation
314 strap brace: 314a—web, 314b—flange, 314re—receiver extension
315 electrical box bracket 315a—vertical plate, 315b—hole clip extension, 315c—clip extension, 315he—bracket hole extension, 315st—bracket spacer tab
316tp bracket— top plate bracket 316, 316a—vertical leg, 316b—horizontal leg, 316u—U-shaped body,
318 W shaped spacer brace 318a—web, 318b—flange, 318bb—double flange,
320 ridges
321 dimples
322 one piece hold-down spacer brace-bracket: 322a—web, 322b—web
325 special channel: extra flange 325xf, lip 326p
326 punched out tabs: 326ve—vented edge, 326se—side edge, 326pe—pivot edge, 326t—tab, 326et—extended tab, 326ht—hook tab, 326tw— wrap-around tab, 326at—arm tab
330 hole notched-clip: 330a—first leg, 330b—second leg, 330c—third leg, 330f—flare, 330g— 5^{th} leg, 330h—hook
331 fire rated material,
332 fire rated caulk
336 slug holes
337— acoustic insulation 337a— vertical side, 337b—horizontal side
338 expansion joint
339 double spacer bracket 339a—vertical leg 339he—hole extension, 319tt—T-shaped tab (changed to notchet-tab-319nt)
341 double spacer plate 341a—vertical leg, 341b—horizontal leg
340s starting position, 340e—ending position,
   342 sound deadening channel 342—vertical support plane, 342a—angular plane, 342r—resilient plane
346 sound deadening material
347 metal insulating panel 347a—facing skin, 347b—return side, 347c—rib/indentation, 347d—interior metal facing, 347i—insulation
351 structural steel column
352 structural steel angle
353 metal strut: J-J shaped, C-shaped, U-shaped
354 anchor bolt
355 anchor space
356pc punch cut groove
357 fastening bolt
401 floor 401
402 truss joist—chords (no numbers)

1. A structural framing system comprising:
a longitudinal spacing-bracing member comprising a web lying in a plane, said web having a first side and a second side opposite said first side, a first end and a second end, a first side edge and a second side edge, a first longitudinal wall connected to said first side edge of said web and a second longitudinal wall connected to said second side edge of said web;
said web having a configuration of multiple planes connected longitudinally together forming a web with said planes being parallel to said multi-plane spacing-bracing member with said web and said first longitudinal wall having a configuration of multiple planes connected longitudinally together forming a said first longitudinal wall and said second longitudinal wall having a configuration of multiple planes connected longitudinally together forming a said second longitudinal wall with a channel shape with each said longitudinal wall having distal edges with said distal edges comprising a plurality of connector wall notches spaced along a longitudinal length of said spacing-bracing member, said connector wall notches indented in said longitudinal wall toward said web;
said multiple plane spacing-bracing member connecting between a first structural member and a second structural member substantially identical to said first structural member, each said structural member having a web and flanges, each said structural member having an aperture extending through said respective webs, said apertures being defined by a perimeter, whereby said perimeter has a first perimeter notch to engage said first longitudinal wall and a second perimeter notch to engage said second longitudinal wall or said first perimeter notch and said second perimeter notch to engage said web along with said first longitudinal wall with said perimeter notches and said web along with said second longitudinal wall with said perimeter notch engage said apertures configured to engage a respective one of said perimeters a connection among said longitudinal spacing-bracing member, said first structural member and said second structural member; and
whereby said multiple plane longitudinal spacing-bracing member is configured to be connected to a second substantially identical second multiple plane longitudinal spacing-bracing member by having said configuration of said second multiple plane longitudinal spacing-bracing member having a smaller or larger said first end configuration and second end configurations by smaller end configuration to a larger end configuration; or
whereby said multiple plane longitudinal spacing-bracing member is configured to be connected to a second substantially identical second multiple plane longitudinal spacing-bracing member by having said first multiple plane longitudinal spacing-bracing member having a low profile longitudinal end configuration for said second multiple plane longitudinal spacing-bracing member will overlap said second longitudinal spacing-bracing member with said first longitudinal spacing-bracing member having connector notches that recesses said first longitudinal spacing-bracing member below said perimeter notches of said aperture where said aperture has said opening large enough for only one said spacing-bracing member to overlapped said larger or smaller configuration over said longitudinal wall of said lower profile configuration; or
whereby said first and second multiple plane longitudinal spacing-bracing members have said connector wall notches setback from said first end and second end to engage said perimeter of said apertures of said first and second structural members with said first end of first multiple plane longitudinal spacing bracing member having said web extend past said longitudinal side walls having a tongue end for said second end of said second multiple plane longitudinal spacing-bracing member engage into a receiver hole in said web near said first structural member; or
whereby said first multiple plane longitudinal spacing-bracing member has said connector wall notches engage said aperture of said first structural member aperture in said web in close proximity to said first end for said second multiple plane longitudinal spacing-bracing member having a tongue extension at said second end for said tongue extension to engage said receiving aperture and whereby said first multiple plane longitudinal spacing-bracing member is configured to be connected to a second substantially identical second multiple plane longitudinal spacing-bracing member by having said configuration of said second multiple plane longitudinal spacing-bracing member having said smaller or larger said first end configuration overlapping said smaller or larger said second end configuration from said second end configuration; or
whereby said longitudinal multiple plane spacing-bracing member connecting between said first structural framing member and said second structural member with said apertures have said perimeter notches, whereby perimeter notches engage said first longitudinal wall and said perimeter notch engage said second longitudinal wall or said perimeter notches engage the said web along with said first longitudinal wall with said perimeter notches and said web along with said second longitudinal wall with said perimeter notches engage said apertures configured to engage a respective one of said perimeters forming a connection among said longitudinal spacing-bracing member, said first structural member and said second structural member, and a U shape channel having a web having inside plane and an outside plane with flange side walls extending from said inside plane with a first end and a second end for said longitudinal multiple plane spacing-bracing member to engage said inside plane of said U channel for said first structural framing member and said second structural member engaging said web and said flange side walls and for said first longitudinal wall and said second longitudinal wall to engage said perimeter notches, and with said web of said longitudinal multiple plane spacing-bracing member and said web of said U shape channel having web holes for an anchor bolt to extend through into a floor; or
whereby said first multiple plane longitudinal spacing-bracing member is configured to be connected to a second substantially identical second multiple plane longitudinal spacing-bracing member by having said first multiple plane longitudinal spacing-bracing member having said web extension being wider than said aperture for side edge notches to engage side apertures of said support members with said second multiple plane longitudinal spacing-bracing member with said web extension and said side edge notches overlapping said first said multi-plane longitudinal spacing-bracing member at said aperture; or
whereby said first multiple plane longitudinal spacing-bracing member said first end and said second end with said first end and second end having a web-flange notch with said first longitudinal wall and said second longitudinal wall having a continuous notch extending into said web at said first and second longitudinal wall with the longitudinal ends of said first and second longitudinal walls abut said first structural member and said second structural member with said first end having said web extending across said perimeter of said aperture with said web extension bent to the opposing side of said first structural member and with the web of said longitudinal spacing-bracing member inserted into the perimeter notches of said aperture connected to a second substantially identical multiple plane longitudinal spacing-bracing member having said web from said second end overlap said first end of said web and said perimeter of said aperture into a slot hole in said web of said first side of said web; or
whereby said multiple plane longitudinal spacing-bracing member is configured to be connected to said second substantially identical second multiple plane longitudinal spacing-bracing member by having said first multiple plane longitudinal spacing-bracing member have bulges in said first longitudinal wall and said second longitudinal wall that extend outward forming a continuous bump in said first and second longitudinal walls where said bulge intends into said perimeter notches in said aperture of said first structural member and connected to a second substantially identical multiple plane longitudinal spacing-bracing member having said web from said second end overlap said first end of said web and said perimeter of said aperture into a slot hole in said web of said first side of said web; or
whereby said multiple plane longitudinal spacing-bracing member is configured to be connect to said second substantially identical second multiple plane longitudinal spacing-bracing member by having said first multiple plane longitudinal spacing bracing member have extensions on said first wall and said second wall with said extensions being tapered with the tapered ends having an extension notch with a taper end being larger width than said tapered extension tab so the second end of said second multiple plane longitudinal spacing-bracing member has said first longitudinal wall and said second longitudinal wall have extension with receiving holes for said extension tab to be received in said receiver holes if said first and second longitudinal walls.

2. The structural framing system according to claim 3 wherein the width of said webs of said overlapping longitudinal multiple plane spacing-bracing members the same width size.

3. The structural framing system of the overlapping first and second longitudinal framing elements according to claim 1 wherein longitudinal walls having angled sides.

4. The structural framing system according to claim 1 wherein said first and said second longitudinal spacing-bracing member with said web and said first and second longitudinal walls have lips extending from said distal edges of said first and second longitudinal walls with said lips extending away from said web with a plurality of lip notches spaced along said lips engaging said perimeter of said aperture.

5. The structural framing system of the first and second longitudinal framing elements according to claim 4 wherein the lip notches from the lips extend continuously into said longitudinal walls and said web.

6. The structural framing construction of the first and second longitudinal framing elements according to claim 1 wherein the first and second longitudinal framing elements according to claim 1 wherein the said lip notches engage the web opening at said side edge and bottom edge of said web opening.

7. The structural framing system according to claim 1 wherein said first and second longitudinal framing member have narrow width webs, wider width longitudinal sides with wider width lips when said first framing member has a wider width web, narrow width longitudinal side and narrower width lips when said first longitudinal framing member overlaps second longitudinal framing member by nestling said smaller longitudinal member into a larger longitudinal member and vise versa for said lips with lip notches to engage said perimeter of said apertures when connecting said first and second longitudinal member to said first structural member and said second structural member.

8. The structural framing system according to claim 1 wherein said first and second structural members have said apertures for said longitudinal spacing bracing member to engage and where said perimeters having a first side edge and a third side edge having said first side edge opposite said third side edge with said fourth side edge between side first side edge and said third side edge with a second side edge being the bottom side edge of a first hole protrusion extending from said first side edge and a second hole protrusion extending from said second side edge with a gap in said aperture between said first hole protrusion and the second hole protrusion for said aperture in said first and second structural members to engage the exterior perimeter of the larger overlapping longitudinal spacing bracing member with said smaller longitudinal spacing bracing member encased within the interior perimeter of said larger overlapping spacing bracing member.

9. The structural framing system according to claim 1 wherein said first longitudinal spacing bracing member and said second longitudinal member having a first end and a second end with said web having a web extension with said tongue end bent to extend from said web overlapping said web of said second end of adjacent said second longitudinal spacing-bracing member for said tongue end to extend into said receiver hole in said web of said second longitudinal spacing-bracing member.

10. The structural framing system according to claim 9 wherein said web extension has a first side edge and a second side edge with a first side and a second side for said tongue end having a tongue notch indented at said first side edge and said second side edge between said web extension and said tongue end with said tongue end being tapered wider than said web extension for said tongue end to be received in said receiver hole to engage the said receiver hole.

11. The structural framing system according to claim 10 wherein the said tongue end configuration is bent over the receiver hole engaging said tongue notch and tongue end against said receiver hole and said web.

12. The structural framing system according to claim 9 wherein the longitudinal ends of said first longitudinal spacing bracing member has a web extension with a tongue end extending from said web overlapping said adjacent second longitudinal spacing bracing member for said tongue end to extend upward into said receiver hole in said web of second longitudinal spacing bracing member and the second longitudinal framing element has a web extension with a tongue end extending from said web overlapping said adjacent first longitudinal framing element for said tongue end to extend downward into the receiver hole of said web of first longitudinal framing element with said tongue ends extending in opposite directions.

13. The structural framing system according to claim 1 wherein said longitudinal spacing bracing member has a first end and a second end having said web having an extension with said extension having a first side edge and a second side edge with said side edges having notches indented from said first and said second side edges for said extension notches to engage said web of said structural framing member at said perimeter of said aperture with said extension overlapping said second longitudinal spacing bracing member.

14. The structural framing system according to claim 10 wherein said metal framing supports with said aperture in said web has said perimeter with a raised perimeter edge extending into said aperture with said raised perimeter having a shaft with indentations being notches in said indentations between the raised perimeter edge and the continuous edge of said aperture for said receiving hole in said web of said longitudinal spacing bracing member to have said shafts extending through receiving holes in said webs of said first and second longitudinal framing elements for said shafts to engage said web of said longitudinal spacing bracing members.

15. The structural framing system of the overlapping first and second longitudinal spacing bracing members according to claim 14 wherein the said longitudinal spacing bracing members being oriented with said U-shape configuration having said longitudinal walls wrapping around the configuration of said raised perimeter of said aperture.

16. The structural framing system according to claim 1 wherein said first longitudinal spacing bracing members have said longitudinal walls with multiple planes and said lips having multiple planes with said lips having said lip notches aperture forming an irregular shape configuration or a W-shape or when reversed an M-shape configuration with said lip notches extending inward from the free edges of said first wall and second wall of engaging said perimeter of said aperture at said structural member for said second longitudinal spacing bracing member having a smaller or larger longitudinal second end to overlap said first end of said first longitudinal spacing bracing member.

17. The structural framing system according to claim 1 wherein the said perimeter of said aperture will encase said longitudinal multiple plane spacing bracing member from moving vertically and horizontally within the web plane of said structural framing member and horizontally within the longitudinal directions of said longitudinal spacing bracing member when said longitudinal spacing bracing member has an indentation in the longitudinal axis forming a notch in said longitudinal spacing bracing member from moving laterally along the longitudinal spacing bracing member axis.

18. The structural framing system of claim 4 wherein said structural members have said apertures at the top end and bottom end of said structural member with said apertures having a first side and a third side opposite said first side with a third side between the said first side and said third side at said web with an open end fourth side at the ends of said structural members for said longitudinal spacing bracing member having said U shaped longitudinal spacing bracing member with said web at said open end has said longitudinal walls abut said first side edge and said third side edge of said aperture with said lips extending away from said web extend into said first perimeter notch at said first perimeter edge and a second perimeter notch connected by said third perimeter edge with said lips having lip notches to engage in said perimeter notches.

19. The structural framing system according to claim 1 wherein said
first longitudinal spacing bracing member having a first end and an opposing second end with said web having said first side and said second side opposite said first side, with said first longitudinal wall being attached to a third longitudinal wall and said second longitudinal wall attached to a fourth longitudinal wall with said first longitudinal wall and said second longitudinal wall extend inwardly from said web forming an acute angle with said web and said third longitudinal wall and said fourth longitudinal wall extend outwardly away from said web forming an obtuse angle to said third and fourth longitudinal walls with said lips having lip notches indented for said lip notches to engage said perimeters of said aperture in said structural member and said aperture having said web to extend into said perimeter of said aperture with the side edges of said perimeter extension engages said bottom side of said web of said first longitudinal spacing bracing member having an enlarged end to engage said first longitudinal wall and said second longitudinal wall.

20. (canceled)
